(19) United States
(12) Patent Application Publication
(10) Pub. No.: US 2026/0105438 A1
(43) Pub. Date: Apr. 16, 2026

(54) ARTIFICIAL INTELLIGENCE DRIVEN SYSTEMS OF SYSTEMS FOR CONVERGED TECHNOLOGY STACKS

(71) Applicant: Strong Force TX Portfolio 2018, LLC, Fort Lauderdale, FL (US)

(72) Inventors: Charles H. Cella, Pembroke, MA (US); Brent Bliven, Austin, TX (US); Andrew Bunin, Lakewood Ranch, FL (US); Taylor Charon, Troy, MI (US); Joshua Dobrowitsky, Birmingham, MI (US); Teymour S. El-Tahry, Detroit, MI (US); Jenna Parenti, Broomfield, CO (US); Andrew Locke, Farmington, MI (US); David Stein, Fairfax, VA (US)

(21) Appl. No.: 19/277,299

(22) Filed: Jul. 22, 2025

Related U.S. Application Data
(63) Continuation of application No. PCT/US25/12942, filed on Jan. 24, 2025.
(60) Provisional application No. 63/625,605, filed on Jan. 26, 2024.
(60) Provisional application No. 63/638,593, filed on Apr. 25, 2024.
(60) Provisional application No. 63/639,914, filed on Apr. 29, 2024.
(60) Provisional application No. 63/724,878, filed on Nov. 25, 2024.

(51) Int. Cl. G06Q 20/36; G06Q 20/38

(52) U.S. Cl. CPC G06Q 20/36; G06Q 20/3825; G06Q 2220/00

(57) ABSTRACT

An artificial intelligence driven system of systems may include a layered architecture for providing transaction support to various types of enterprises. A governance layer implements automated governance and policy enforcement through specialized governance modules utilizing generative AI technology. An enterprise layer supports enterprise functions by integrating management and control platforms with digital infrastructure. An offering layer creates and manages system offerings via content generation, personalization, and smart product modules. A transactions layer enables automated transaction orchestration through API integration, execution, and fulfillment modules. An operations layer manages AI systems through generation, training, verification and orchestration modules. A network layer provides adaptive networking capabilities through routing, protocol selection and communication modules. A data layer processes fused data from multiple sources using machine learning and AI systems. A resource layer manages computing, storage, and other resources through specialized resource modules.

### CROSS-REFERENCE TO RELATED APPLICATIONS

This application is a continuation of International Application No. PCT/US25/12942, filed 24 Jan. 2025 which claims the benefit of priority to the following U.S. Patent Applications: Ser. No. 63/625,605, filed 26 Jan. 2024; Ser. No. 63/638,593, filed 25 Apr. 2024; Ser. No. 63/639,914, filed 29 Apr. 2024; and Ser. No. 63/724,878 filed 25 Nov. 2024.

The patent applications referenced above are hereby incorporated by reference as if fully set forth herein in their entirety.

### FIELD

The present disclosure relates to artificial intelligence driven systems of systems including a layered architecture for providing transaction support.

### BACKGROUND

Traditional enterprise operations rely on separate, disconnected layers of technology infrastructure. Governance is largely manual, requiring significant human oversight to enforce policies, monitor compliance, and manage digital rights. Organizations struggle to maintain consistent oversight across different operational domains and often faced challenges in adapting to changing regulatory requirements.

Enterprise systems typically operate with rigid, predefined offerings that lack the ability to dynamically adapt to user needs or environmental conditions. Content and services are generally standardized rather than personalized, and organizations have limited capability to customize experiences based on real-time user states, behaviors, or contextual factors.

Transaction management is predominantly handled through isolated systems with limited automation capabilities. Organizations face challenges in coordinating complex digital transactions across multiple platforms and struggle to maintain secure integration with various financial institutions and marketplaces. Digital asset management and payment systems operate with minimal intelligence, often requiring manual intervention for optimization and security enforcement.

Enterprise operations suffer from fragmented management of AI systems and technological resources. Organizations lack sophisticated capabilities for AI system generation, training, verification, and deployment. The absence of coordinated operations modules mean that AI systems were developed and deployed in isolation, without proper governance or optimization across the enterprise. Companies struggle with inefficient training data generation, inadequate model verification, and suboptimal deployment strategies that fail to leverage the full potential of their AI investments.

Enterprise networks can be characterized by static, inflexible infrastructure that often fails adapt to changing conditions. Traditional networking approaches lack intelligent routing capabilities and efficient data flow management. Organizations are unable to effectively leverage edge computing or implement dynamic network configurations, resulting in suboptimal performance and resource utilization. Network security is often reactive rather than proactive, and systems lack the ability to automatically detect and respond to potential disruptions.

Data handling is historically limited by fragmented data management approaches and isolated intelligence services. Organizations struggle to implement effective sensor and data fusion systems, resulting in incomplete or inconsistent data analysis. The absence of sophisticated machine learning systems and neural networks mean that enterprises can't fully leverage their data assets for strategic insights. Data sources remain disconnected, making it difficult to generate comprehensive intelligence or enable cross-functional data analysis.

Traditional enterprise resource optimization is characterized by manual and inefficient resource allocation processes. Organizations lack intelligent systems for optimizing the provisioning of various resources, from computational and networking resources to material and energy resources. Traditional resource management approaches are not able to effectively handle the dynamic nature of modern enterprise operations, leading to inefficient resource utilization and increased operational costs. The absence of AI-driven optimization means that organizations often fail to balance resource allocation across different operational contexts and requirements.

The lack of intelligent integration between different technological layers created significant inefficiencies in enterprise operations. Organizations struggle to maintain coherent governance across platforms, optimize resource allocation, and deliver personalized experiences at scale. This fragmented approach limits the ability to leverage emerging technologies effectively and restricts the potential for innovation in enterprise service delivery.

These limitations in traditional enterprise systems create a clear need for a more integrated, intelligent approach to technology infrastructure.

### SUMMARY

In embodiments, the techniques described herein relate to a system including: memory hardware configured to store instructions; and processor hardware configured to execute the instructions from the memory hardware, wherein the instructions include: configuring a workflow system to automate transaction steps using artificial intelligence (AI) agents; implementing an operations layer that includes: an AI system orchestration module configured to coordinate AI workflow operations; an AI system monitoring module configured to track workflow execution; and an AI system analyzing module configured to evaluate workflow performance; generating, using the AI system orchestration module, a transaction workflow by: determining a sequence of transaction processing steps; configuring AI agents to execute the transaction processing steps; and establishing monitoring parameters for the workflow; executing the transaction workflow using the configured AI agents by: automatically processing transaction data through defined workflow stages; monitoring execution progress using the AI system monitoring module; and analyzing workflow performance using the AI system analyzing module; and dynamically adjusting the workflow based on the analysis.

In embodiments, the techniques described herein relate to a system, wherein the AI agents are configured to: monitor a set of conditions; detect fulfillment of the conditions; and take responsive actions based on the detected fulfillment.

In embodiments, the techniques described herein relate to a system, wherein executing the transaction workflow includes: implementing robotic process automation (RPA) to streamline procurement processes; automating repetitive tasks and data handling; and interfacing with vendor management systems.

In embodiments, the techniques described herein relate to a system, wherein the workflow system includes: a workflow definition system for creating functional diagrams of workflows; a workflow library system for storing workflow templates; and a workflow management system for executing workflows.

In embodiments, the techniques described herein relate to a system, wherein the instructions further include: testing workflows using digital twin simulations; executing workflows with respect to simulated scenarios; and providing results of the workflow execution for scenario testing.

In embodiments, the techniques described herein relate to a system, wherein dynamically adjusting the workflow includes: analyzing transaction patterns; identifying workflow bottlenecks; and automatically modifying workflow parameters to optimize performance.

In embodiments, the techniques described herein relate to a system, wherein the instructions further include: implementing a governance system to enforce governance standards; monitoring compliance with regulatory requirements; and automatically adjusting workflows to maintain compliance.

In embodiments, the techniques described herein relate to a system, wherein executing the transaction workflow includes: processing payments using fiat currency or cryptocurrency; supporting multiple blockchain protocols; and automatically adjusting contract terms based on regulatory requirements.

In embodiments, the techniques described herein relate to a system, wherein the instructions further include implementing machine learning algorithms to: refine workflow personalization based on user interactions; optimize transaction routing; and enhance workflow efficiency.

In embodiments, the techniques described herein relate to a system, wherein the AI system orchestration module is configured to: coordinate multiple AI systems for complex transactions; manage resource allocation; and optimize workflow execution paths.

In embodiments, the techniques described herein relate to a method including: configuring, by a processing system, a workflow system to automate transaction steps using artificial intelligence (AI) agents; implementing, by the processing system, an operations layer that includes: an AI system orchestration module configured to coordinate AI workflow operations; an AI system monitoring module configured to track workflow execution; and an AI system analyzing module configured to evaluate workflow performance; generating, by the processing system using the AI system orchestration module, a transaction workflow by: determining a sequence of transaction processing steps; configuring AI agents to execute the transaction processing steps; and establishing monitoring parameters for the workflow; executing, by the processing system, the transaction workflow using the configured AI agents by: automatically processing transaction data through defined workflow stages; monitoring execution progress using the AI system monitoring module; and analyzing workflow performance using the AI system analyzing module; dynamically adjusting, by the processing system, the workflow based on the analysis.

In embodiments, the techniques described herein relate to a method, wherein configuring the AI agents includes: implementing monitoring capabilities for a set of conditions; enabling detection of condition fulfillment; and configuring responsive actions based on detected fulfillment.

In embodiments, the techniques described herein relate to a method, wherein executing the transaction workflow includes: implementing robotic process automation (RPA) to streamline procurement processes; automating repetitive tasks and data handling; and interfacing with vendor management systems.

In embodiments, the techniques described herein relate to a method, further including: creating functional diagrams of workflows using a workflow definition system; storing workflow templates in a workflow library system; and executing workflows using a workflow management system.

In embodiments, the techniques described herein relate to a method, further including: testing workflows using digital twin simulations; executing workflows with respect to simulated scenarios; and analyzing results of the workflow execution for scenario testing.

In embodiments, the techniques described herein relate to a method, wherein dynamically adjusting the workflow includes: analyzing transaction patterns; identifying workflow bottlenecks; and automatically modifying workflow parameters to optimize performance.

In embodiments, the techniques described herein relate to a method, further including: implementing a governance system to enforce governance standards; monitoring compliance with regulatory requirements; and automatically adjusting workflows to maintain compliance.

In embodiments, the techniques described herein relate to a method, wherein executing the transaction workflow includes: processing payments using fiat currency or cryptocurrency; supporting multiple blockchain protocols; and automatically adjusting contract terms based on regulatory requirements.

In embodiments, the techniques described herein relate to a method, further including implementing machine learning algorithms to: refine workflow personalization based on user interactions; optimize transaction routing; and enhance workflow efficiency.

In embodiments, the techniques described herein relate to a method, wherein the AI system orchestration module: coordinates multiple AI systems for complex transactions; manages resource allocation; and optimizes workflow execution paths.

In embodiments, the techniques described herein relate to a system including: memory hardware configured to store instructions; and processor hardware configured to execute the instructions from the memory hardware, wherein the instructions include: implementing a data fusion architecture for high-throughput processing including: a sensor integration module configured to combine transaction-related data streams; a data processing module configured to normalize and validate transaction flows; and a machine learning module configured to optimize processing efficiency; configuring the sensor integration module to: collect data from distributed transaction processing nodes; synchronize multi-source transaction streams; and implement data integrity validation protocols; processing integrated data using the data processing module by: vectorizing transaction parameters and metadata; applying natural language processing to transaction content; and identifying processing optimization opportunities; analyzing processed data using machine learning models trained to: detect processing anomalies and bottlenecks; generate predictive throughput insights; and optimize processing resource allocation.

In embodiments, the techniques described herein relate to a system, wherein the sensor fusion system implements: data normalization techniques; temporal alignment of sensor streams; and data quality validation protocols.

In embodiments, the techniques described herein relate to a system, wherein collecting data includes integrating: real-time sensor measurements; historical sensor data; and contextual environmental data.

In embodiments, the techniques described herein relate to a system, wherein the machine learning system includes: supervised learning models; unsupervised clustering algorithms; and deep learning neural networks.

In embodiments, the techniques described herein relate to a system, wherein processing fused sensor data includes: implementing distributed processing architectures; utilizing edge computing resources; and optimizing computational resource allocation.

In embodiments, the techniques described herein relate to a system, wherein the instructions further include: implementing digital twin simulations; validating sensor fusion accuracy; and optimizing fusion algorithms.

In embodiments, the techniques described herein relate to a system, wherein the data services system: implements data streaming protocols; manages data storage systems; and coordinates data access controls.

In embodiments, the techniques described herein relate to a system, wherein analyzing the processed data includes: implementing real-time pattern recognition; generating predictive models; and optimizing sensor fusion parameters.

In embodiments, the techniques described herein relate to a system, wherein the instructions further include: implementing data encryption protocols; managing access permissions; and ensuring data privacy compliance.

In embodiments, the techniques described herein relate to a system, wherein the machine learning models are trained using: historical sensor data; synthetic training data; and validated fusion outputs.

In embodiments, the techniques described herein relate to a system including: memory hardware configured to store instructions; and processor hardware configured to execute the instructions from the memory hardware, wherein the instructions include: implementing a consensus protocol system for high-throughput transaction processing, the consensus protocol system including: a distributed computing module configured to process cryptographic proofs; a validation module configured to verify data integrity; and a proof verification module configured to validate computational results; configuring the distributed computing module to: manage peer-to-peer network topology; synchronize distributed state machines; and optimize node communication protocols; processing cryptographic proofs using the validation module by: verifying zero-knowledge proofs for transactions; validating digital signatures and attestations; and ensuring data immutability; implementing the proof verification module to: validate proof-of-work computations; verify proof-of-stake commitments; and confirm proof-of-storage claims.

In embodiments, the techniques described herein relate to a system, wherein the distributed computing module implements: node discovery protocols; network partition handling; and Byzantine fault tolerance.

In embodiments, the techniques described herein relate to a system, wherein processing cryptographic proofs includes: implementing elliptic curve cryptography; managing public key infrastructure; and validating cryptographic commitments.

In embodiments, the techniques described herein relate to a system, wherein the proof verification module: measures computational complexity; validates consensus participation; and verifies state transitions.

In embodiments, the techniques described herein relate to a system, wherein implementing consensus includes: coordinating distributed timestamps; managing state replication; and resolving network conflicts.

In embodiments, the techniques described herein relate to a system, wherein the instructions further include: implementing hardware security modules; managing secure enclaves; and validating trusted execution environments.

In embodiments, the techniques described herein relate to a system, wherein the consensus protocol system: implements homomorphic encryption; manages threshold signatures; and ensures data privacy.

In embodiments, the techniques described herein relate to a system, wherein processing proofs includes: validating merkle tree structures; verifying hash chains; and optimizing proof generation.

In embodiments, the techniques described herein relate to a system, wherein the instructions further include: implementing distributed key generation; managing secure multiparty computation; and optimizing cryptographic operations.

In embodiments, the techniques described herein relate to a system, wherein the proof verification includes: validating computational difficulty; verifying resource commitments; and ensuring proof uniqueness.

In embodiments, the techniques described herein relate to a system including: memory hardware configured to store instructions; and processor hardware configured to execute the instructions from the memory hardware, wherein the instructions include: implementing a network optimization system for transaction processing including: an adaptive networking module configured to optimize transaction network parameters; a quality of service module configured to manage transaction throughput; and a resource allocation module configured to distribute processing resources; configuring the adaptive networking module to: monitor transaction network patterns; identify processing bottlenecks; and dynamically adjust routing for transaction flows; managing transaction performance using the quality of service module by: measuring transaction latency and throughput; implementing error detection and recovery; and optimizing transaction delivery; allocating network resources using the resource allocation module to: distribute transaction processing loads; optimize bandwidth for high-volume transactions; and manage transaction network congestion.

In embodiments, the techniques described herein relate to a system, wherein the adaptive networking module implements: dynamic transaction routing algorithms; traffic shaping for transaction flows; and load balancing across processing nodes.

In embodiments, the techniques described herein relate to a system, wherein monitoring network patterns includes: analyzing transaction flow patterns; measuring network utilization during peak transaction periods; and detecting transaction processing anomalies.

In embodiments, the techniques described herein relate to a system, wherein the quality of service module: implements transaction priority queuing; manages bandwidth allocation for critical transactions; and ensures transaction processing service levels.

In embodiments, the techniques described herein relate to a system, wherein managing transaction performance includes: implementing forward error correction for transaction data; optimizing transaction packet scheduling; and managing transaction processing buffers.

In embodiments, the techniques described herein relate to a system, wherein the instructions further include: implementing edge computing for local transaction processing; optimizing transaction data caching; and managing distributed transaction processing.

In embodiments, the techniques described herein relate to a system, wherein the network optimization system: implements network coding for transaction data; manages multipath routing for transaction flows; and optimizes protocol parameters for transaction processing.

In embodiments, the techniques described herein relate to a system, wherein allocating resources includes: implementing transaction resource reservation protocols; managing quality of service for transaction processing; and optimizing transaction processing resource utilization.

In embodiments, the techniques described herein relate to a system, wherein the instructions further include: implementing transaction security protocols; managing transaction access controls; and optimizing encryption for transaction data.

In embodiments, the techniques described herein relate to a system, wherein the resource allocation includes: dynamic scaling of transaction processing resources; predictive provisioning for transaction volumes; and automated optimization of processing resources.

In embodiments, the techniques described herein relate to a system including: memory hardware configured to store instructions; and processor hardware configured to execute the instructions from the memory hardware, wherein the instructions include: executing a transaction orchestration agent configured to orchestrate a set of tasks of a transaction workflow on behalf of an enterprise having a plurality of digital wallets, wherein each digital wallet executes transactions on behalf of the enterprise using a respective transaction channel; determining, by the transaction orchestration agent, a transaction orchestration workflow corresponding to a transaction to be executed on behalf of the enterprise; interfacing, by the transaction orchestration agent, with one or more of the digital wallets of the enterprise through respective application programming interfaces (APIs) of the one or more respective wallets; receiving, via the respective APIs, respective account data indicating an account balance and transaction capabilities of a respective digital wallet; selecting, by the intelligent agent, an enterprise digital wallet from the plurality of digital wallets based on the respective account data received from the respective APIs of the one or more digital wallets of the enterprise based on the real-time data; generating a configured transaction for the selected enterprise digital wallet; and instructing the selected enterprise digital wallet to execute the configured transaction via its API.

In embodiments, the techniques described herein relate to a system, wherein interfacing with a respective digital wallet includes: providing account credentials of the enterprise via the respective API of the digital wallet; and providing transaction information including destination account, payment source, transaction amount, and payment date to the digital wallet via the API using robotic process automation.

In embodiments, the techniques described herein relate to a system, wherein interfacing with a respective digital wallet includes: initiating a new API session with a third-party wallet application; and issuing commands to the digital wallet applications on behalf of the enterprise.

In embodiments, the techniques described herein relate to a system, wherein the transaction orchestration agent interfaces with one or more of payment service providers, banks, and blockchain networks.

In embodiments, the techniques described herein relate to a system, wherein the transaction orchestration agent: maintains secure integration with financial institutions and marketplaces; implements security protocols through AI-driven authentication systems; and automatically detects and responds to potential disruptions.

In embodiments, the techniques described herein relate to a system, wherein interfacing with a respective digital wallet includes: interfacing with a blockchain digital wallet that controls a blockchain account of the enterprise on a blockchain network, wherein the blockchain digital wallet is configured to communicate with and execute blockchain transactions on a blockchain network; retrieving a private key associated with enterprise blockchain accounts; and digitally signing a blockchain transaction using the private keys.

In embodiments, the techniques described herein relate to a system, wherein interfacing with a respective digital wallet includes: interfacing with a hybrid wallet configured to perform both blockchain transactions and fiat currency transactions.

In embodiments, the techniques described herein relate to a system, wherein the transaction orchestration agent: controls the selected digital wallet in a wallet-of-wallets configuration; provides a unified interface to enterprise users; and includes additional layers managing permissions, account selection, wallet selection, and transaction execution.

In embodiments, the techniques described herein relate to a system, wherein interfacing with a respective digital wallet includes: securely interfacing with virtual infrastructure of a respective financial institution using a respective API of the respective financial institution and account credentials of the enterprise to transfer funds.

In embodiments, the techniques described herein relate to a system, wherein interfacing with a respective digital wallet includes: interfacing with a digital marketplace using a respective API of the digital marketplace, wherein the respective digital wallet facilitates transactions on the digital marketplace using a digital marketplace account of the enterprise.

In embodiments, the techniques described herein relate to a method including: executing, by one or more processors, a transaction orchestration agent configured to orchestrate tasks of a transaction workflow on behalf of an enterprise; establishing, by the transaction orchestration agent, API connections with multiple digital wallet systems; receiving, by the transaction orchestration agent, real-time wallet data through the API connections regarding account balances and transaction capabilities; determining, by the transaction orchestration agent, a set of transaction parameters for executing a transaction; selecting, by the transaction orchestration agent, an enterprise digital wallet from the multiple digital wallet systems based on analyzing the real-time wallet data and transaction parameters; configuring, by the transaction orchestration agent, the transaction for the selected enterprise digital wallet; and executing, by the transaction orchestration agent, the configured transaction by communicating instructions to the selected enterprise digital wallet through its API.

In embodiments, the techniques described herein relate to a method, further including: maintaining respective balances of enterprise cash reserves across the multiple digital wallet systems; querying digital wallets and bank portals using their APIs to determine total cash positions; and maintaining an internal ledger of all cash transactions.

In embodiments, the techniques described herein relate to a method, wherein establishing API connections includes: implementing standardized reconciliation protocols; supporting various data formats for automated reconciliation processes; and comparing transaction records across internal and external systems.

In embodiments, the techniques described herein relate to a method, further including: interfacing with blockchain systems to verify cryptocurrency transactions; interfacing with smart contract systems to verify smart contract executions; and ensuring comprehensive reconciliation across traditional and digital asset transactions.

In embodiments, the techniques described herein relate to a method, further including: implementing automated governance through embedded policy and governance AI capabilities; ensuring continuous compliance monitoring; and generating automated compliance reports.

In embodiments, the techniques described herein relate to a method, wherein executing the configured transaction includes: communicating with payment service providers to process payments; coordinating with acquirers to settle transactions; and interfacing with banks to transfer funds.

In embodiments, the techniques described herein relate to a method, further including: maintaining secure integration with financial institutions; implementing AI-driven authentication systems; and automatically detecting and responding to potential security disruptions.

In embodiments, the techniques described herein relate to a method, wherein establishing API connections includes: implementing a common point of access for multiple markets, marketplaces, exchanges, and platforms.

In embodiments, the techniques described herein relate to a method, further including: tokenizing digital assets to digitally represent transactions within an enterprise ecosystem; and employing blockchain technology to manage and secure the transactions.

In embodiments, the techniques described herein relate to a method, wherein configuring the transaction includes: automatically determining transaction routing; optimizing transaction fees; and managing transaction timing across multiple networks and marketplaces.

### BRIEF DESCRIPTION OF THE FIGURES

The disclosure and the following detailed description of certain embodiments thereof may be understood by reference to the following figures:

FIG. 1 is a schematic diagram of components of a platform for enabling intelligent transactions in accordance with embodiments of the present disclosure.

FIGS. 2A and 2B are schematic diagrams of additional components of a platform for enabling intelligent transactions in accordance with embodiments of the present disclosure.

### Intelligence Services System FIGS.

FIG. 3 is a schematic view of an example of an intelligence services system according to some embodiments.

FIG. 4 is a schematic view of an example of a neural network according to some embodiments.

FIG. 5 is a schematic view of an example of a convolutional neural network according to some embodiments.

FIG. 6 is a schematic view of an example of a neural network according to some embodiments.

FIG. 7 is a diagram of an approach based on reinforcement learning according to some embodiments.

FIG. 8 depicts a block diagram of exemplary features, capabilities, and interfaces of a robust generative artificial intelligence platform.

### Enterprise Access Layer FIGS.

FIG. 9 is a schematic view of an example of an enterprise ecosystem including an enterprise access layer.

FIG. 10 is a functional block diagram of an example implementation of an enterprise access layer.

FIG. 11 is a schematic view of examples of how the enterprise access layer of FIG. 10 may be integrated with portions of an enterprise ecosystem.

FIG. 12 is a schematic view of an example market orchestration system that includes an enterprise access layer.

FIG. 13 is a functional block diagram of an example implementation of an intelligence system.

FIG. 14 is a functional block diagram of an example implementation of a data pool system.

FIG. 15 is a functional block diagram of an example implementation of a scoring system.

FIG. 16 is a simplified diagram of a determination of attention by a machine learning model in accordance with some embodiments.

FIG. 17 is a simplified diagram of a transformer model in accordance with some embodiments.

Integrated AI convergence System of Systems FIGS.

FIG. 18 is a simplified diagram of financial infrastructure systems in accordance with some embodiments.

FIG. 19 is a schematic view of an example AI convergence system of systems.

FIG. 20 is a schematic view of an example offering layer.

FIG. 21 is a schematic view of an example transactions layer.

FIG. 22 is a schematic view of an example operations layer.

FIG. 23 is a schematic view of an example network layer.

FIG. 24 is a schematic view of an example data layer.

FIG. 25 is a schematic view of an example data layer.

FIG. 26 is a schematic view of an example intelligent data layer architecture.

FIG. 27 is a schematic view of an example network layer.

FIG. 28 is a schematic view of an example AI subsystem integrator system.

FIG. 29 is a schematic view of an example multiplatform attention management system.

Like reference symbols in the various drawings indicate like elements.

### DETAILED DESCRIPTION

### Transaction Platform

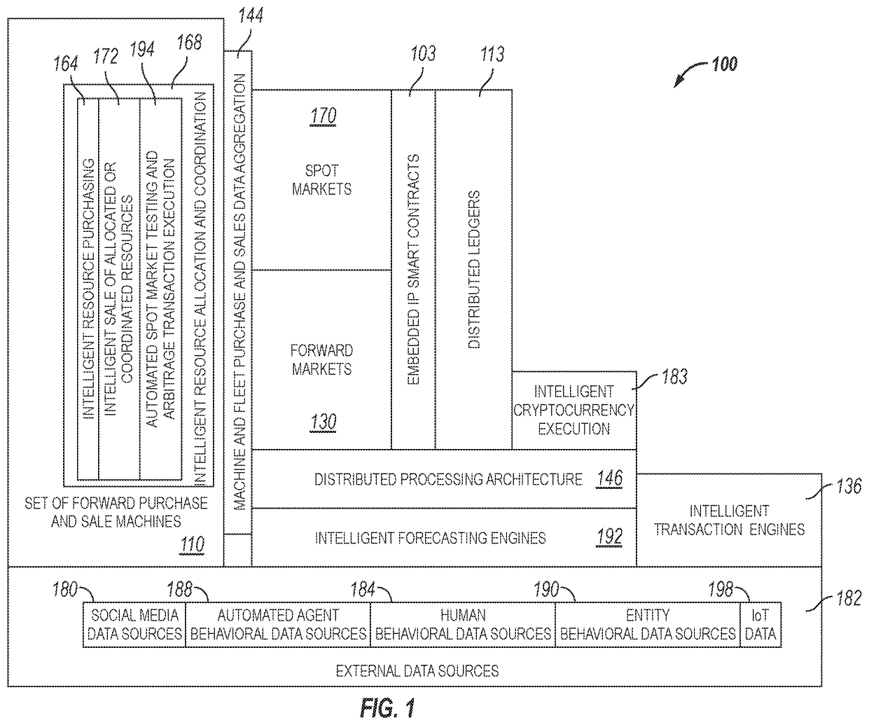

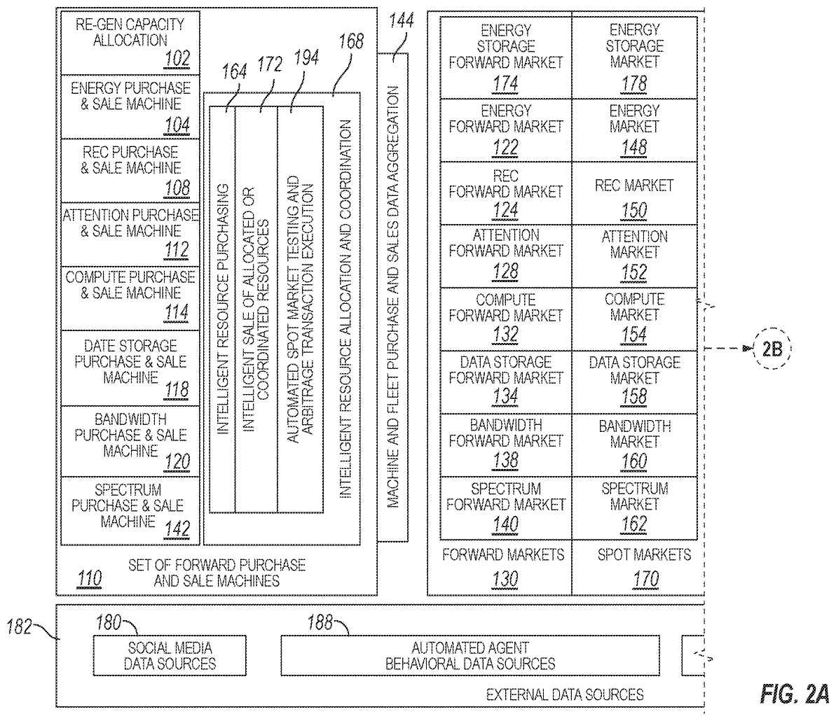

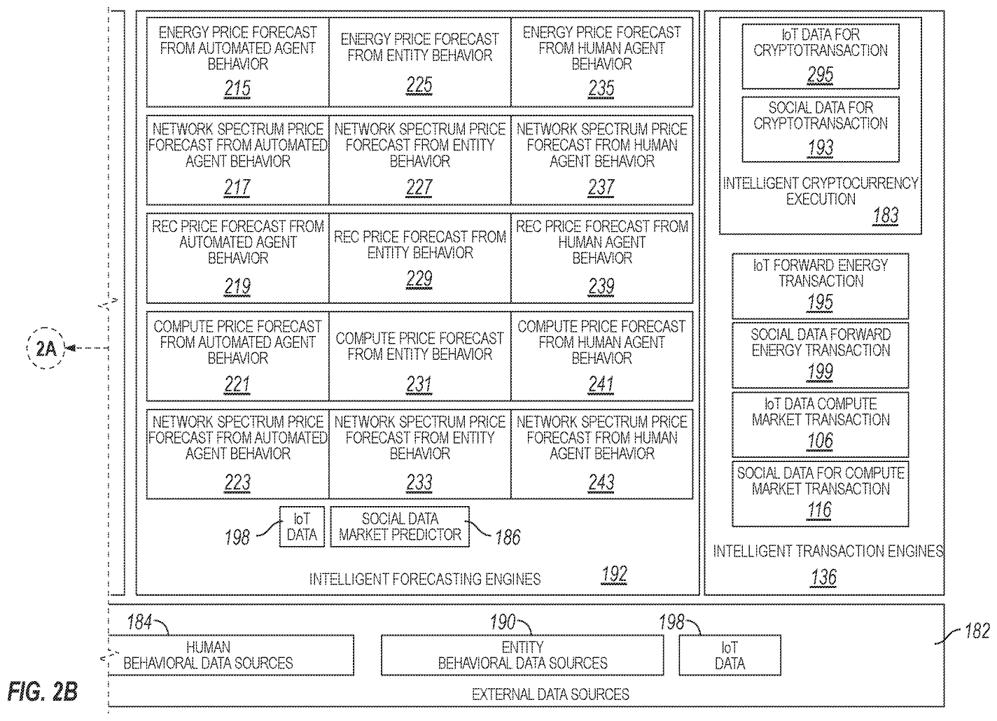

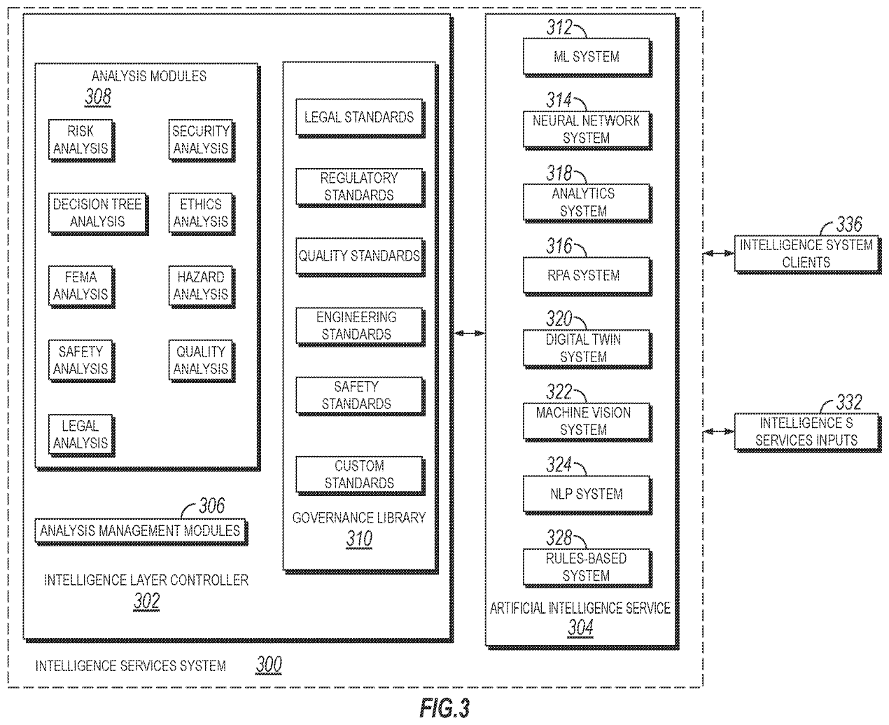

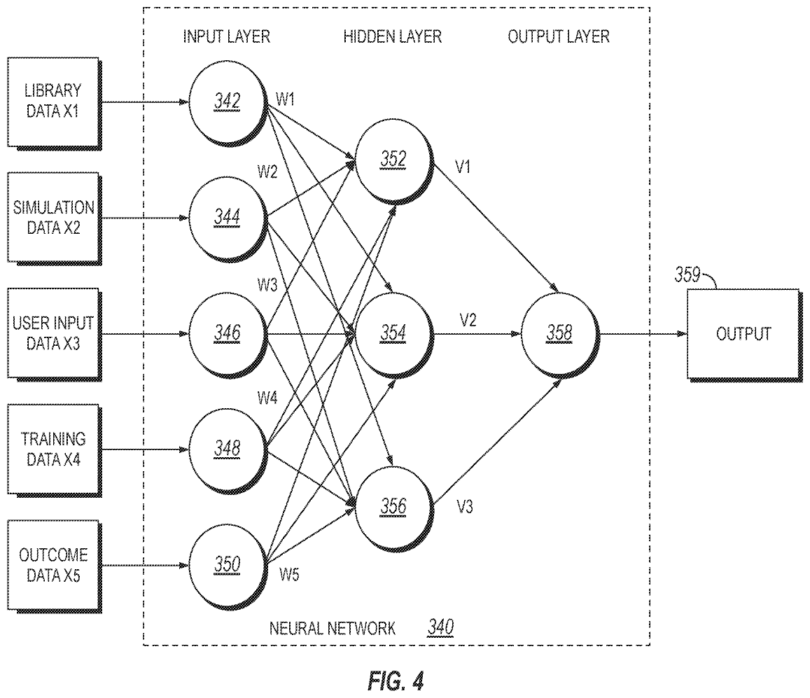

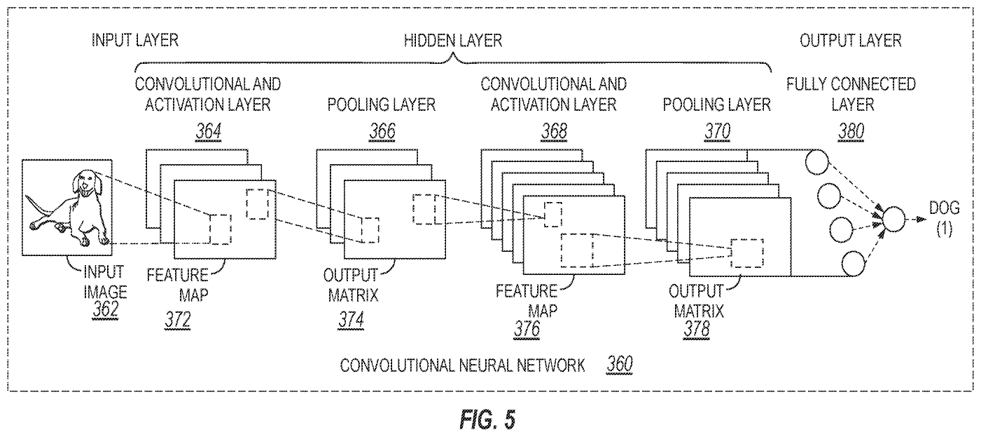

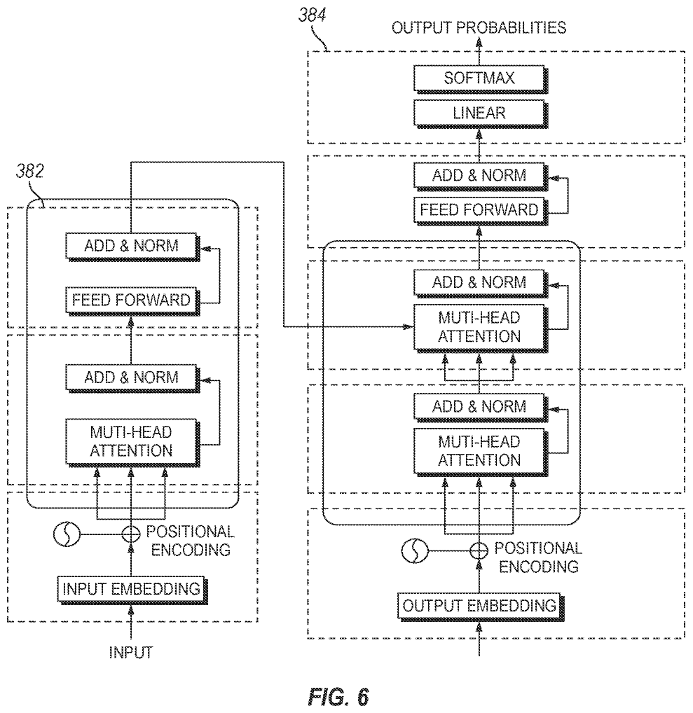

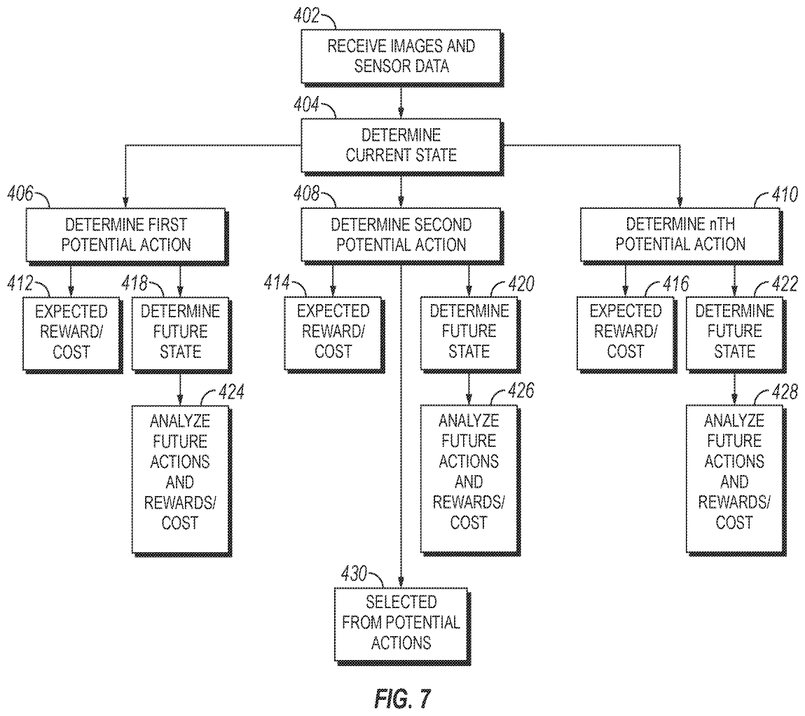

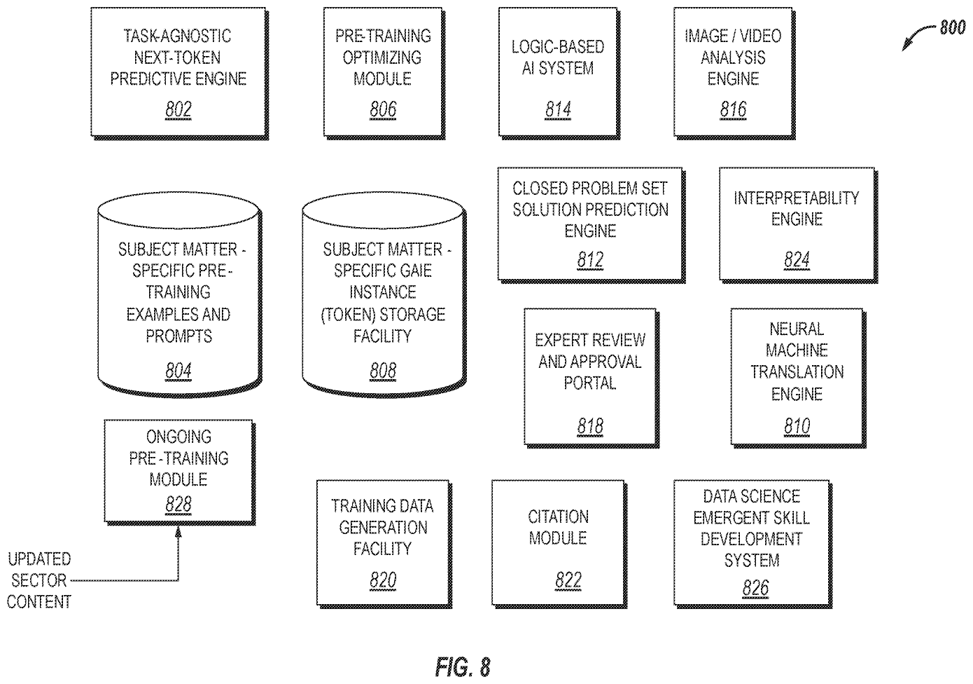

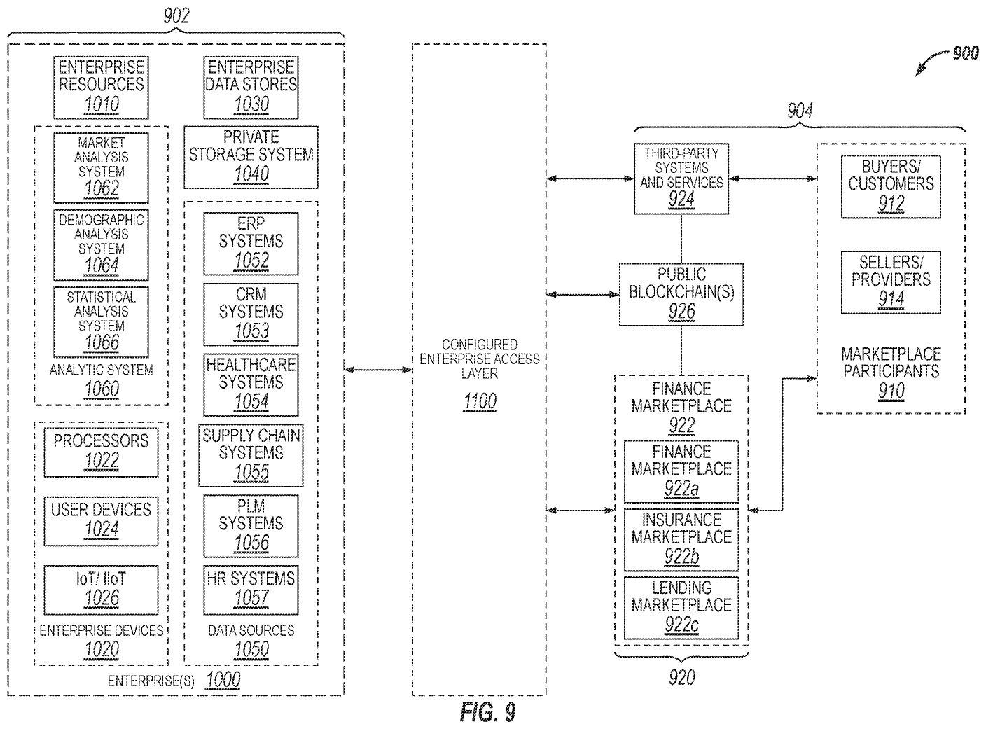

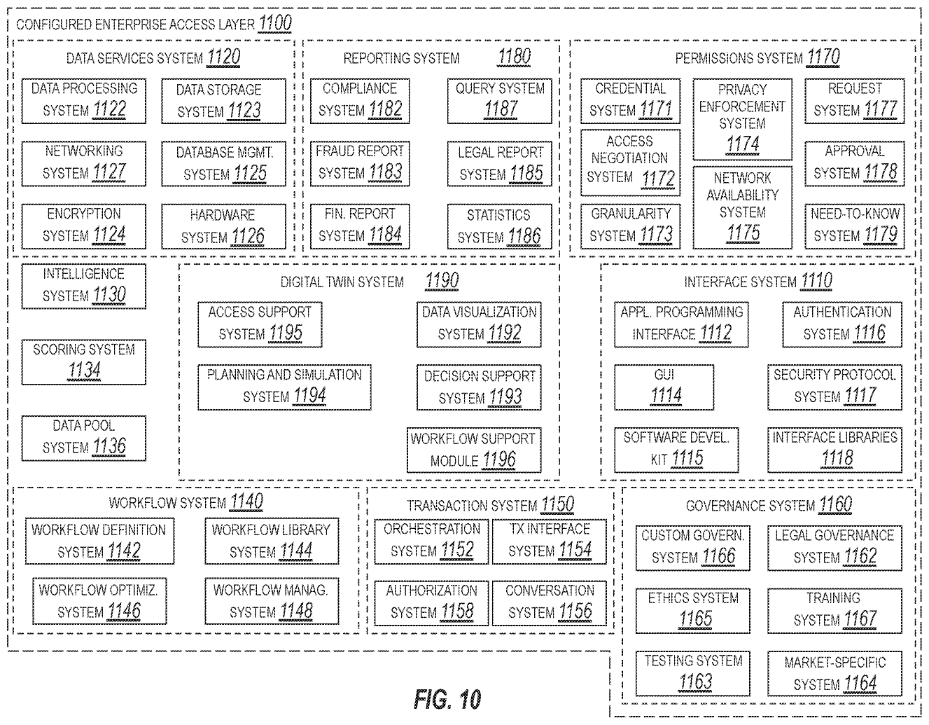

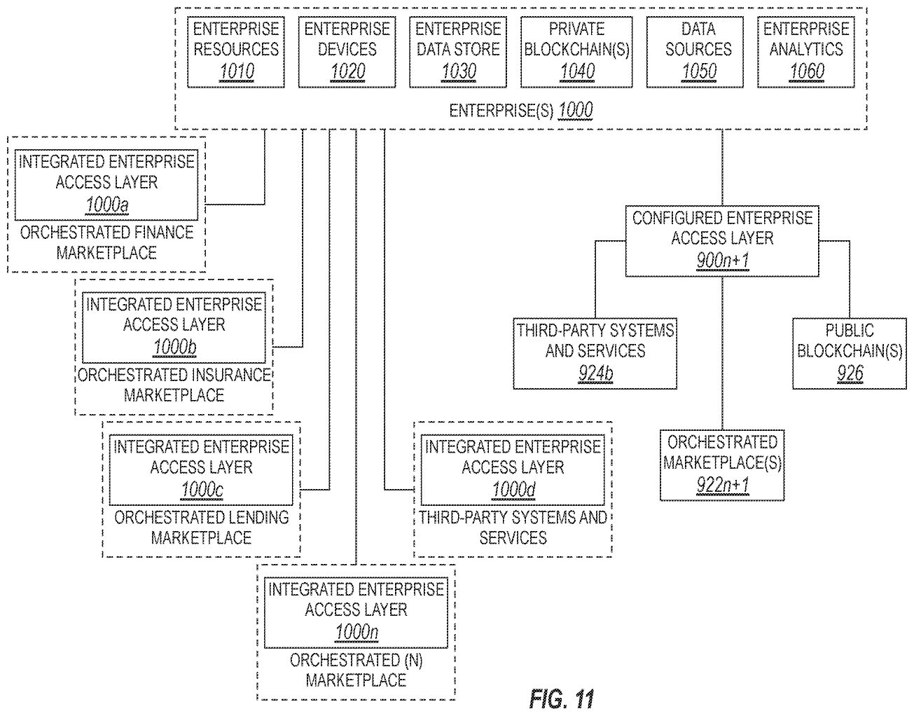

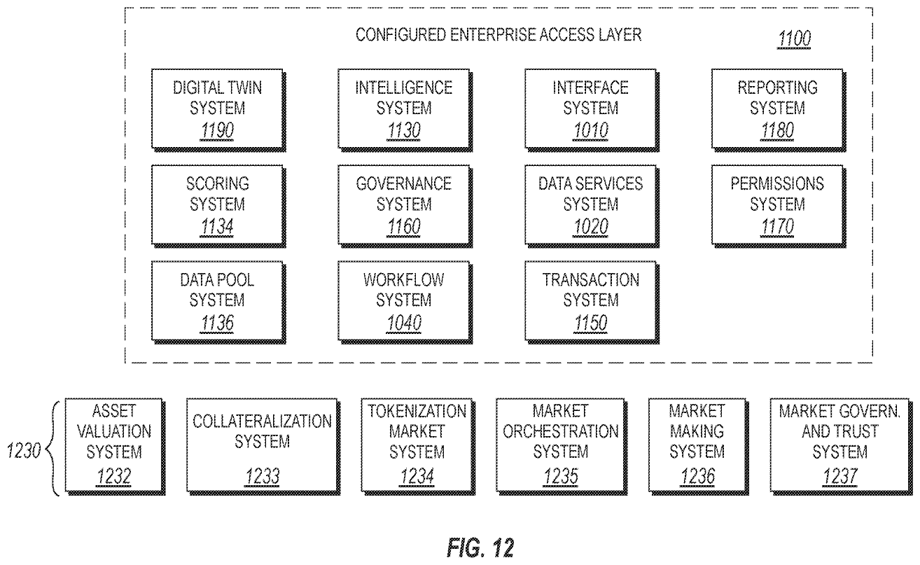

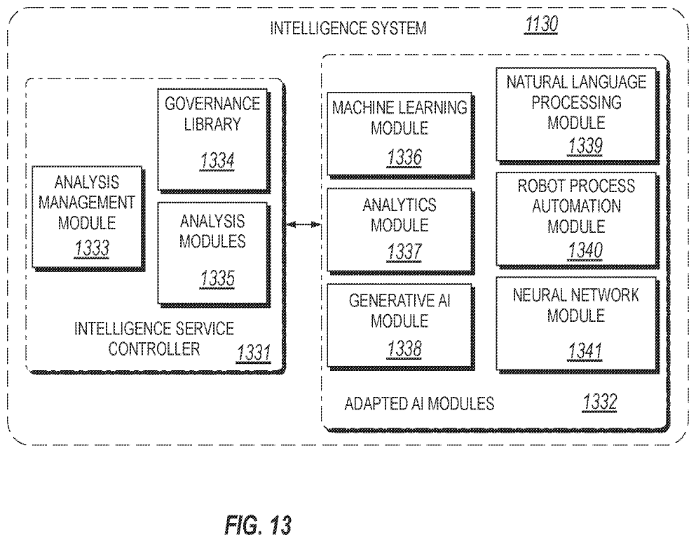

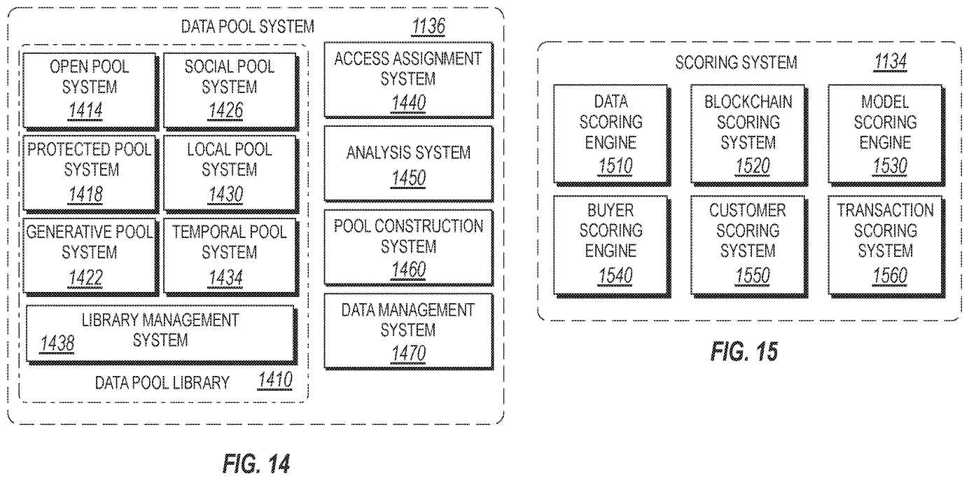

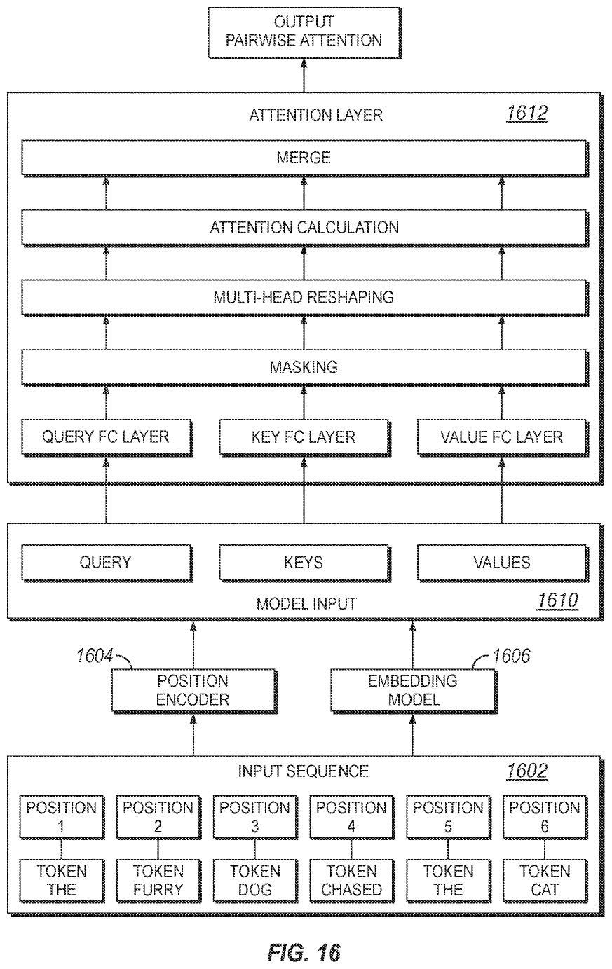

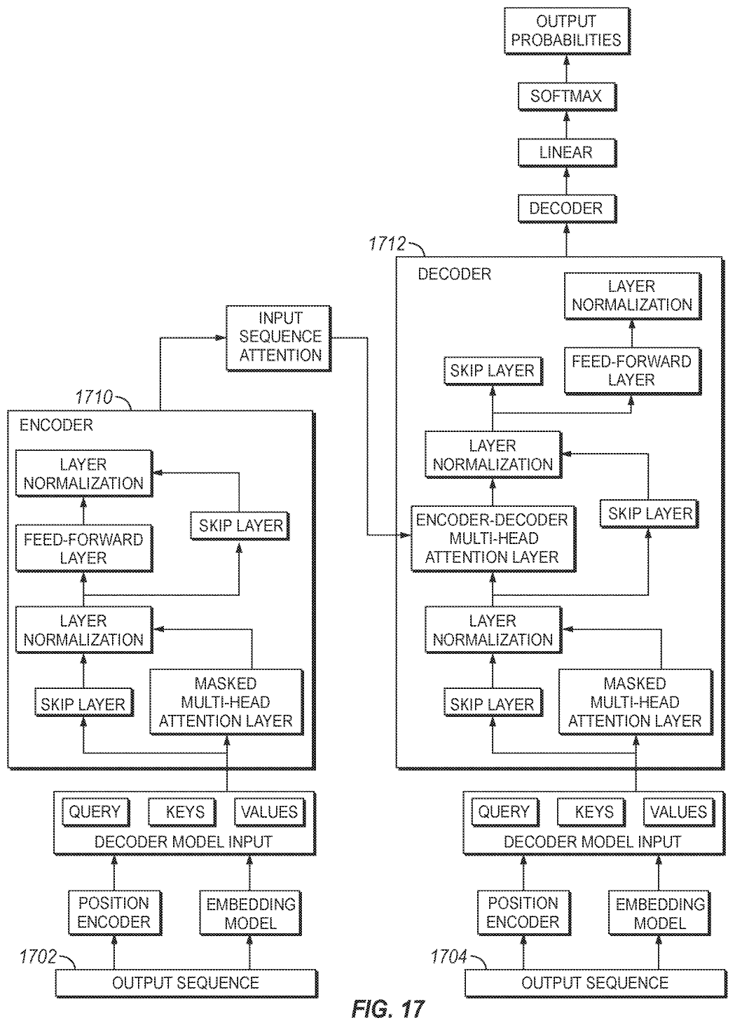

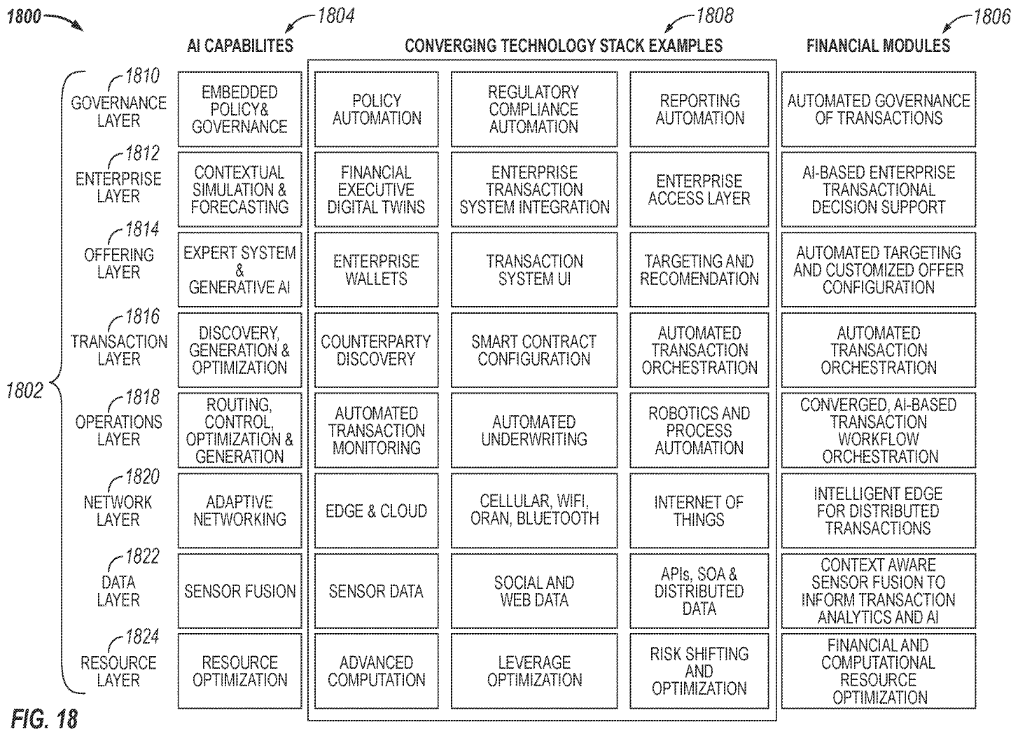

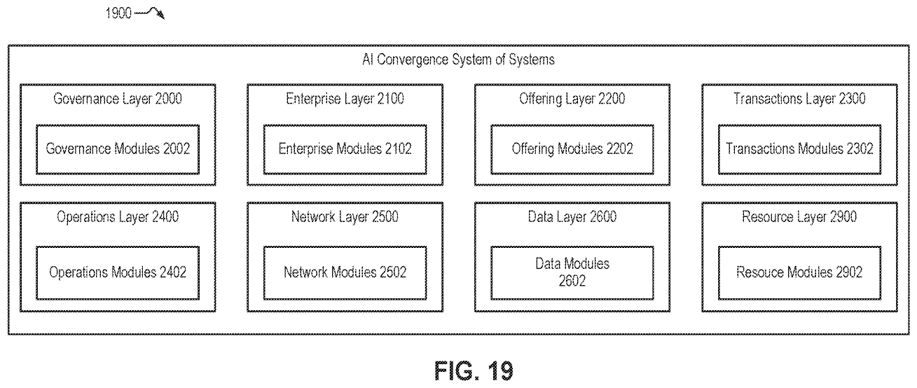

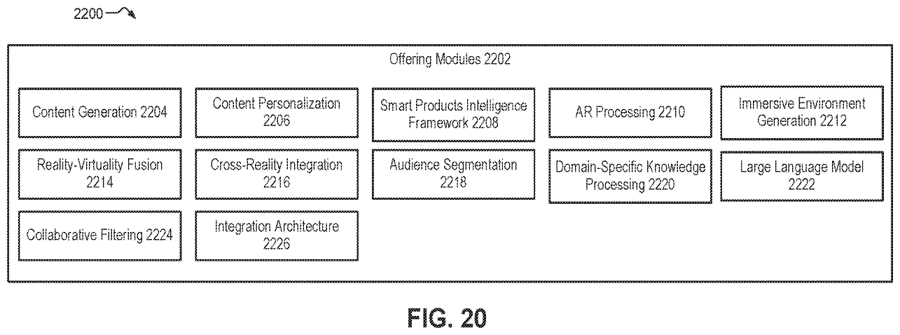

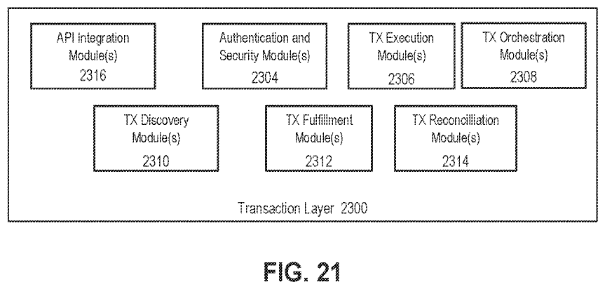

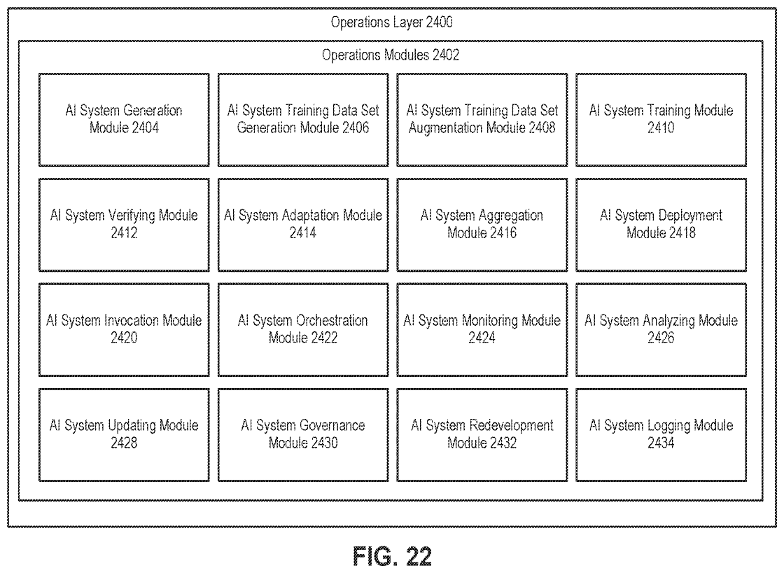

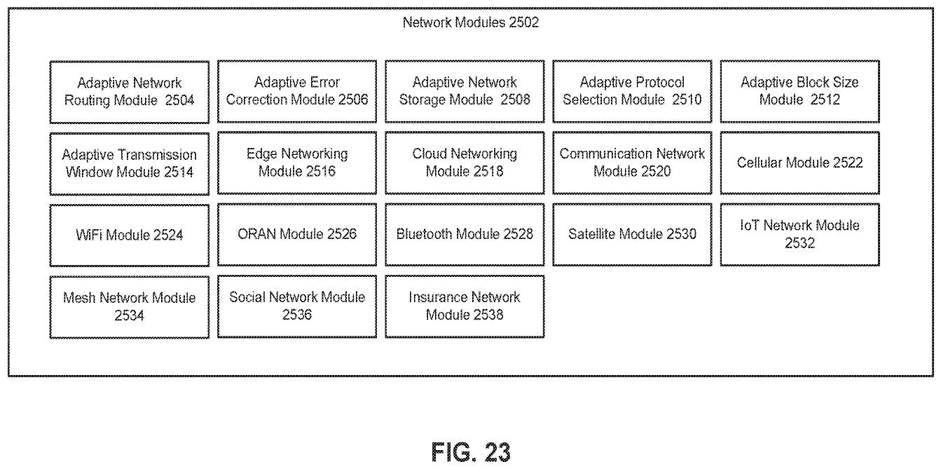

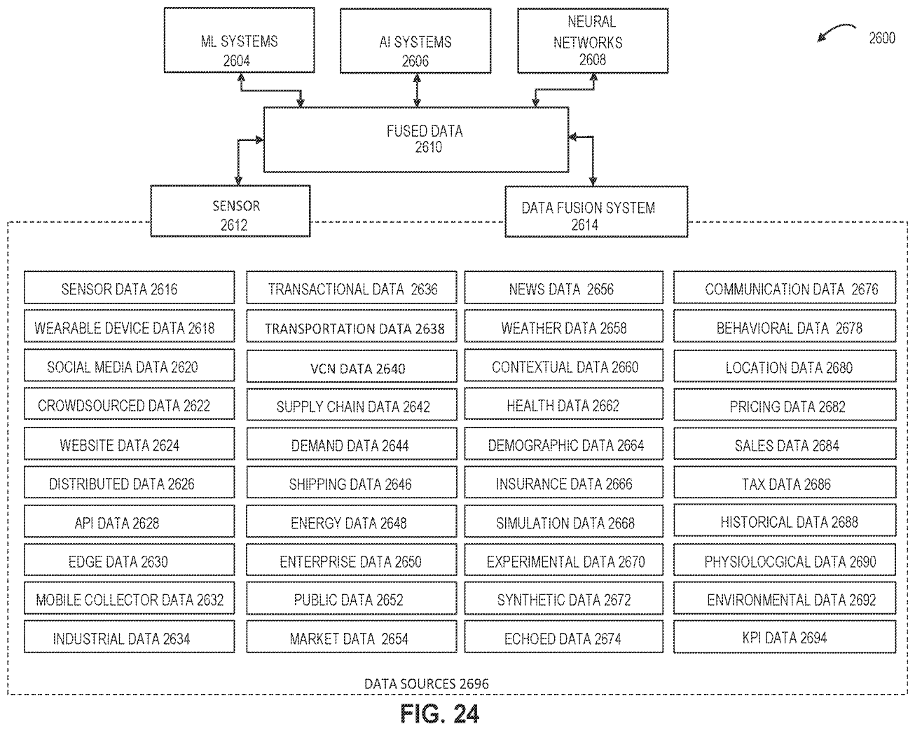

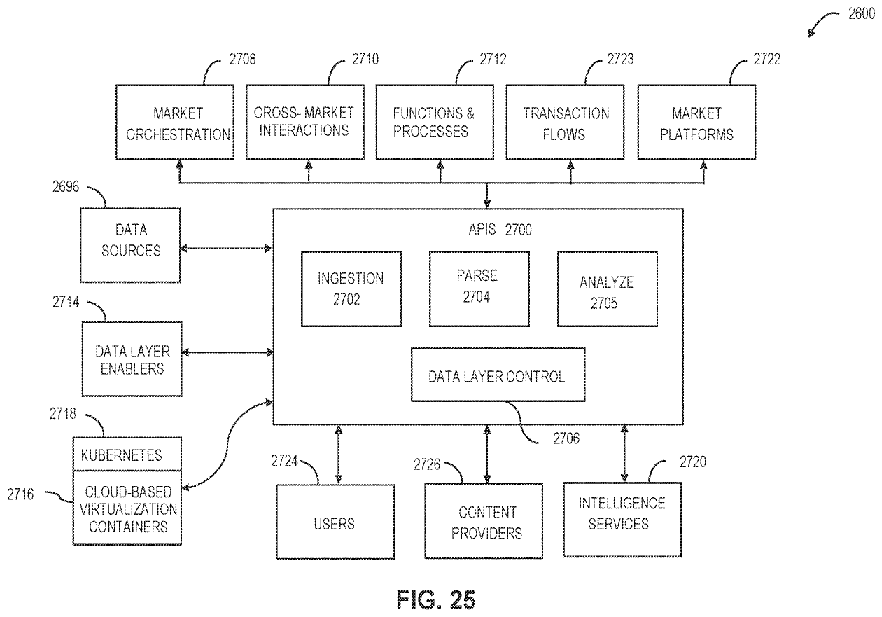

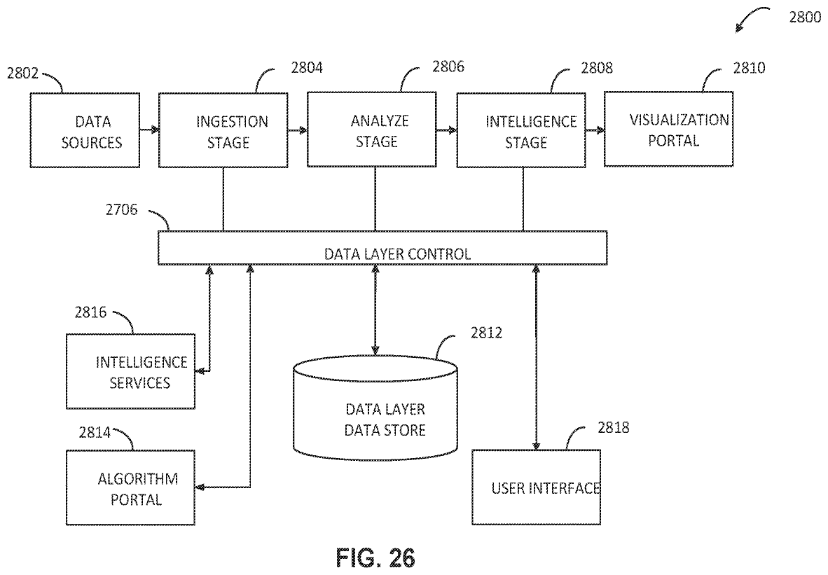

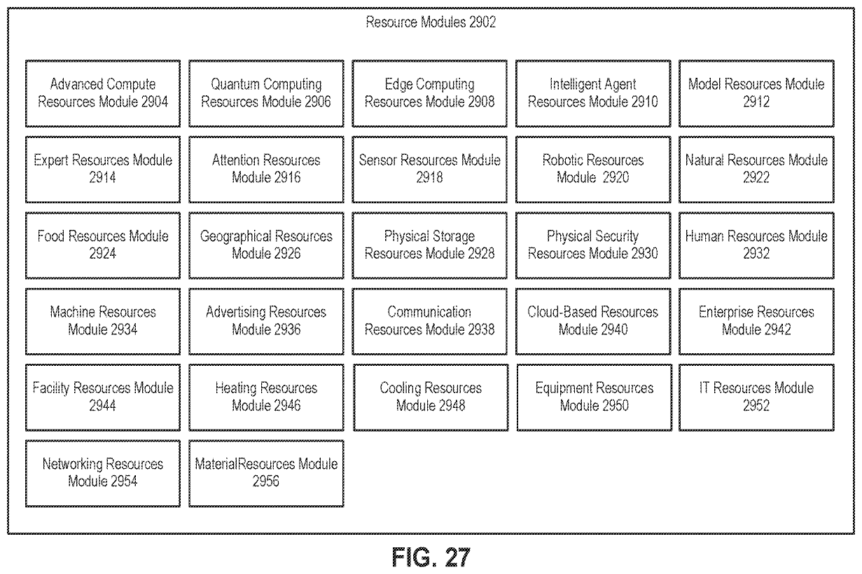

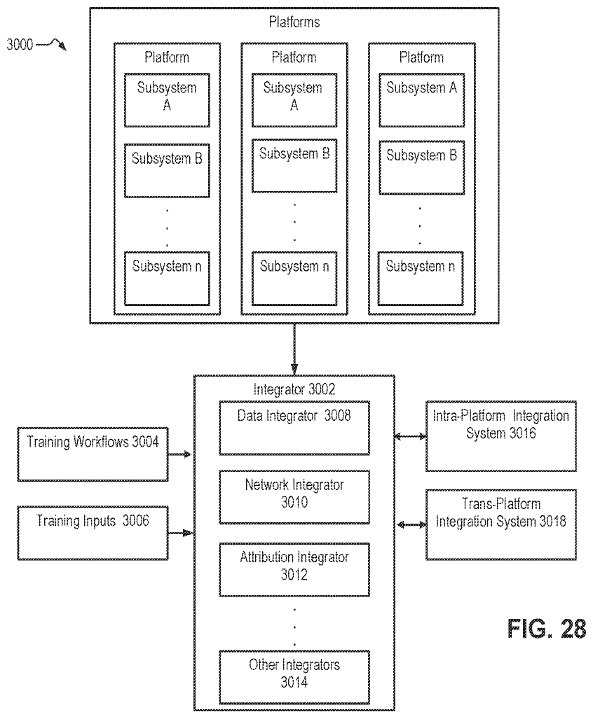

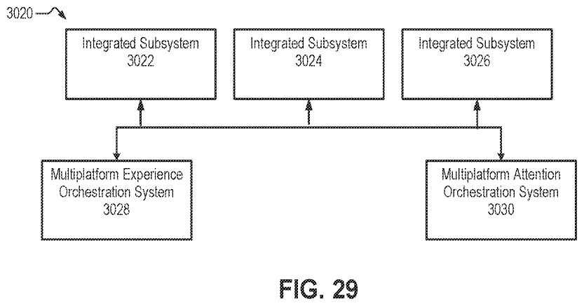

Referring to FIGS. 1, 2A and 2B, a set of systems, methods, components, modules, machines, articles, blocks, circuits, services, programs, applications, hardware, software and other elements are provided, collectively referred to herein interchangeably as the system or the platform 100, The platform 100 enables a wide range of improvements of and for various machines, systems, and other components that enable transactions involving the exchange of value (such as using currency, cryptocurrency, tokens, rewards or the like, as well as a wide range of in-kind and other resources) in various markets, including current or spot markets 170, forward markets 130 and the like, for various goods, services, and resources. As used herein, “currency” should be understood to encompass fiat currency issued or regulated by governments, cryptocurrencies, tokens of value, tickets, loyalty points, rewards points, coupons, and other elements that represent or may be exchanged for value. Resources, such as ones that may be exchanged for value in a marketplace, should be understood to encompass goods, services, natural resources, energy resources, computing resources, energy storage resources, data storage resources, network bandwidth resources, processing resources and the like, including resources for which value is exchanged and resources that enable a transaction to occur (such as necessary computing and processing resources, storage resources, network resources, and energy resources that enable a transaction). The platform 100 may include a set of forward purchase and sale machines 110, each of which may be configured as an expert system or automated intelligent agent for interaction with one or more of the set of spot markets 170 and forward markets 130. Enabling the set of forward purchase and sale machines 110 are an intelligent resource purchasing system 164 having a set of intelligent agents for purchasing resources in spot and forward markets; an intelligent resource allocation and coordination system 168 for the intelligent sale of allocated or coordinated resources, such as compute resources, energy resources, and other resources involved in or enabling a transaction; an intelligent sale engine 172 for intelligent coordination of a sale of allocated resources in spot and futures markets; and an automated spot market testing and arbitrage transaction execution engine 194 for performing spot testing of spot and forward markets, such as with micro-transactions and, where conditions indicate favorable arbitrage conditions, automatically executing transactions in resources that take advantage of the favorable conditions. Each of the engines may use model-based or rule-based expert systems, such as based on rules or heuristics, as well as deep learning systems by which rules or heuristics may be learned over trials involving a large set of inputs. The engines may use any of the expert systems and artificial intelligence capabilities described throughout this disclosure. Interactions within the platform 100, including of all platform components, and of interactions among them and with various markets, may be tracked and collected, such as by a data aggregation system 144, such as for aggregating data on purchases and sales in various marketplaces by the set of machines described herein. Aggregated data may include tracking and outcome data that may be fed to artificial intelligence and machine learning systems, such as to train or supervise the same. The various engines may operate on a range of data sources, including aggregated data from marketplace transactions, tracking data regarding the behavior of each of the engines, and a set of external data sources 182, which may include social media data sources 180 (such as social networking sites like Facebook™ and Twitter™), Internet of Things (IoT) data sources (including from sensors, cameras, data collectors, and instrumented machines and systems), such as IoT sources that provide information about machines and systems that enable transactions and machines and systems that are involved in production and consumption of resources. External data sources 182 may include behavioral data sources, such as automated agent behavioral data sources 188 (such as tracking and reporting on behavior of automated agents that are used for conversation and dialog management, agents used for control functions for machines and systems, agents used for purchasing and sales, agents used for data collection, agents used for advertising, and others), human behavioral data sources (such as data sources tracking online behavior, mobility behavior, energy consumption behavior, energy production behavior, network utilization behavior, compute and processing behavior, resource consumption behavior, resource production behavior, purchasing behavior, attention behavior, social behavior, and others), and entity behavioral data sources 190 (such as behavior of business organizations and other entities, such as purchasing behavior, consumption behavior, production behavior, market activity, merger and acquisition behavior, transaction behavior, location behavior, and others). The IoT, social and behavioral data from and about sensors, machines, humans, entities, and automated agents may collectively be used to populate expert systems, machine learning systems, and other intelligent systems and engines described throughout this disclosure, such as being provided as inputs to deep learning systems and being provided as feedback or outcomes for purposes of training, supervision, and iterative improvement of systems for prediction, forecasting, classification, automation and control. The data may be organized as a stream of events. The data may be stored in a distributed ledger or other distributed system. The data may be stored in a knowledge graph where nodes represent entities and links represent relationships. The external data sources may be queried via various database query functions. The external data sources 182 may be accessed via APIs, brokers, connectors, protocols like REST and SOAP, and other data ingestion and extraction techniques. Data may be enriched with metadata and may be subject to transformation and loading into suitable forms for consumption by the engines, such as by cleansing, normalization, de-duplication, and the like.

The platform 100 may include a set of intelligent forecasting engines 192 for forecasting events, activities, variables, and parameters of spot markets 170, forward markets 130, resources that are traded in such markets, resources that enable such markets, behaviors (such as any of those tracked in the external data sources 182), transactions, and the like. The intelligent forecasting engines 192 may operate on data from the data aggregation systems 144 about elements of the platform 100 and on data from the external data sources 182. The platform may include a set of intelligent transaction engines 136 for automatically executing transactions in spot markets 170 and forward markets 130. This may include executing intelligent cryptocurrency transactions with an intelligent cryptocurrency execution engine 183 associated with IoT data for crypto transaction 295 and social data for crypto transaction 193. The platform 100 may make use of asset of improved distributed ledgers 113 and improved smart contracts 103, including ones that embed and operate on proprietary information, instruction sets and the like that enable complex transactions to occur among individuals with reduced (or without) reliance on intermediaries. These and other components are described in more detail throughout this disclosure.

Referring to the block diagrams of FIGS. 2A and 2B, further details and additional components of the platform 100 and interactions among them are depicted. The set of forward purchase and sale machines 110 may include a regeneration capacity allocation engine 102 (such as for allocating energy generation or regeneration capacity, such as within a hybrid vehicle or system that includes energy generation or regeneration capacity, a renewable energy system that has energy storage, or other energy storage system, where energy is allocated for one or more of sale on a forward market 130, sale in a spot market 170, use in completing a transaction (e.g., mining for cryptocurrency), or other purposes. For example, the regeneration capacity allocation engine 102 may explore available options for use of stored energy, such as sale in current and forward energy markets that accept energy from producers, keeping the energy in storage for future use, or using the energy for work (which may include processing work, such as processing activities of the platform like data collection or processing, or processing work for executing transactions, including mining activities for cryptocurrencies). In embodiments, energy storage capacity may be transacted on an energy storage forward market 174 or an energy storage market 178.

The set of forward purchase and sale machines 110 may include an energy purchase and sale machine 104 for purchasing or selling energy, such as in an energy spot market 148 or an energy forward market 122. The energy purchase and sale machine 104 may use an expert system, neural network or other intelligence to determine timing of purchases, such as based on current and anticipated state information with respect to pricing and availability of energy and based on current and anticipated state information with respect to needs for energy, including needs for energy to perform computing tasks, cryptocurrency mining, data collection actions, and other work, such as work done by automated agents and systems and work required for humans or entities based on their behavior. For example, the energy purchase machine may recognize, by machine learning, that a business is likely to require a block of energy in order to perform an increased level of manufacturing based on an increase in orders or market demand and may purchase the energy at a favorable price on a futures market, based on a combination of energy market data and entity behavioral data. Continuing the example, market demand may be understood by machine learning, such as by processing human behavioral data sources 184, such as social media posts, e-commerce data and the like that indicate increasing demand. The energy purchase and sale machine 104 may sell energy in the energy spot market 148 or the energy forward market 122. Sale may also be conducted by an expert system operating on the various data sources described herein, including with training on outcomes and human supervision.

The set of forward purchase and sale machines 110 may include a renewable energy credit (REC) purchase and sale machine 108, which may purchase renewable energy credits, pollution credits, and other environmental or regulatory credits in a spot market 150 or forward market 124 for such credits. Purchasing may be configured and managed by an expert system operating on any of the external data sources 182 or on data aggregated by the set of data aggregation systems 144 for the platform. Renewable energy credits and other credits may be purchased by an automated system using an expert system, including machine learning or other artificial intelligence, such as where credits are purchased with favorable timing based on an understanding of supply and demand that is determined by processing inputs from the data sources. The expert system may be trained on a data set of outcomes from purchases under historical input conditions. The expert system may be trained on a data set of human purchase decisions and/or may be supervised by one or more human operators. The renewable energy credit (REC) purchase and sale machine 108 may also sell renewable energy credits, pollution credits, and other environmental or regulatory credits in a spot market 150 or forward market 124 for such credits. Sale may also be conducted by an expert system operating on the various data sources described herein, including with training on outcomes and human supervision.

The set of forward purchase and sale machines 110 may include an attention purchase and sale machine 112, which may purchase one or more attention-related resources, such as advertising space, search listing, keyword listing, banner advertisements, participation in a panel or survey activity, participation in a trial or pilot, or the like in a spot market for attention 152 or a forward market for attention 128. Attention resources may include the attention of automated agents, such as bots, crawlers, dialog managers, and the like that are used for searching, shopping, and purchasing. Purchasing of attention resources may be configured and managed by an expert system operating on any of the external data sources 182 or on data aggregated by the set of data aggregation systems 144 for the platform. Attention resources may be purchased by an automated system using an expert system, including machine learning or other artificial intelligence, such as where resources are purchased with favorable timing, such as based on an understanding of supply and demand, that is determined by processing inputs from the various data sources. For example, the attention purchase and sale machine 112 may purchase advertising space in a forward market for advertising based on learning from a wide range of inputs about market conditions, behavior data, and data regarding activities of agent and systems within the platform 100. The expert system may be trained on a data set of outcomes from purchases under historical input conditions. The expert system may be trained on a data set of human purchase decisions and/or may be supervised by one or more human operators. The attention purchase and sale machine 112 may also sell one or more attention-related resources, such as advertising space, search listing, keyword listing, banner advertisements, participation in a panel or survey activity, participation in a trial or pilot, or the like in a spot market for attention 152 or a forward market for attention 128, which may include offering or selling access to, or attention or, one or more automated agents of the platform 100. Sale may also be conducted by an expert system operating on the various data sources described herein, including with training on outcomes and human supervision.

The set of forward purchase and sale machines 110 may include a compute purchase and sale machine 114, which may purchase one or more computation-related resources, such as processing resources, database resources, computation resources, server resources, disk resources, input/output resources, temporary storage resources, memory resources, virtual machine resources, container resources, and others in a spot market for compute 154 or a forward market for compute 132. Purchasing of compute resources may be configured and managed by an expert system operating on any of the external data sources 182 or on data aggregated by the set of data aggregation systems 144 for the platform. Compute resources may be purchased by an automated system using an expert system, including machine learning or other artificial intelligence, such as where resources are purchased with favorable timing, such as based on an understanding of supply and demand, that is determined by processing inputs from the various data sources. For example, the compute purchase and sale machine 114 may purchase or reserve compute resources on a cloud platform in a forward market for compute resources based on learning from a wide range of inputs about market conditions, behavior data, and data regarding activities of agent and systems within the platform 100, such as to obtain such resources at favorable prices during surge periods of demand for computing. The expert system may be trained on a data set of outcomes from purchases under historical input conditions. The expert system may be trained on a data set of human purchase decisions and/or may be supervised by one or more human operators. The compute purchase and sale machine 114 may also sell one or more computation-related resources that are connected to, part of, or managed by the platform 100, such as processing resources, database resources, computation resources, server resources, disk resources, input/output resources, temporary storage resources, memory resources, virtual machine resources, container resources, and others in a spot market for compute 154 or a forward market for compute 132. Sale may also be conducted by an expert system operating on the various data sources described herein, including with training on outcomes and human supervision.

The set of forward purchase and sale machines 110 may include a data storage purchase and sale machine 118, which may purchase one or more data-related resources, such as database resources, disk resources, server resources, memory resources, RAM resources, network attached storage resources, storage attached network (SAN) resources, tape resources, time-based data access resources, virtual machine resources, container resources, and others in a spot market for storage resources 158 or a forward market for data storage 134. Purchasing of data storage resources may be configured and managed by an expert system operating on any of the external data sources 182 or on data aggregated by the set of data aggregation systems 144 for the platform. Data storage resources may be purchased by an automated system using an expert system, including machine learning or other artificial intelligence, such as where resources are purchased with favorable timing, such as based on an understanding of supply and demand, that is determined by processing inputs from the various data sources. For example, the compute purchase and sale machine 114 may purchase or reserve compute resources on a cloud platform in a forward market for compute resources based on learning from a wide range of inputs about market conditions, behavior data, and data regarding activities of agent and systems within the platform 100, such as to obtain such resources at favorable prices during surge periods of demand for storage. The expert system may be trained on a data set of outcomes from purchases under historical input conditions. The expert system may be trained on a data set of human purchase decisions and/or may be supervised by one or more human operators. The data storage purchase and sale machine 118 may also sell one or more data storage-related resources that are connected to, part of, or managed by the platform 100 in a spot market for storage resources 158 or a forward market for data storage 134. Sale may also be conducted by an expert system operating on the various data sources described herein, including with training on outcomes and human supervision.

The set of forward purchase and sale machines 110 may include a bandwidth purchase and sale machine 120, which may purchase one or more bandwidth-related resources, such as cellular bandwidth, Wi-Fi bandwidth, radio bandwidth, access point bandwidth, beacon bandwidth, local area network bandwidth, wide area network bandwidth, enterprise network bandwidth, server bandwidth, storage input/output bandwidth, advertising network bandwidth, market bandwidth, or other bandwidth, in a spot market for bandwidth resources 160 or a forward market for bandwidth 138. Purchasing of bandwidth resources may be configured and managed by an expert system operating on any of the external data sources 182 or on data aggregated by the set of data aggregation systems 144 for the platform. Bandwidth resources may be purchased by an automated system using an expert system, including machine learning or other artificial intelligence, such as where resources are purchased with favorable timing, such as based on an understanding of supply and demand, that is determined by processing inputs from the various data sources. For example, the bandwidth purchase and sale machine 120 may purchase or reserve bandwidth on a network resource for a future networking activity managed by the platform based on learning from a wide range of inputs about market conditions, behavior data, and data regarding activities of agent and systems within the platform 100, such as to obtain such resources at favorable prices during surge periods of demand for bandwidth. The expert system may be trained on a data set of outcomes from purchases under historical input conditions. The expert system may be trained on a data set of human purchase decisions and/or may be supervised by one or more human operators. The bandwidth purchase and sale machine 120 may also sell one or more bandwidth-related resources that are connected to, part of, or managed by the platform 100 in a spot market for bandwidth resources 160 or a forward market for bandwidth 138. Sale may also be conducted by an expert system operating on the various data sources described herein, including with training on outcomes and human supervision.

The set of forward purchase and sale machines 110 may include a spectrum purchase and sale machine 142, which may purchase one or more spectrum-related resources, such as cellular spectrum, 3G spectrum, 4G spectrum, LTE spectrum, 5G spectrum, cognitive radio spectrum, peer-to-peer network spectrum, emergency responder spectrum and the like in a spot market for spectrum resources 162 or a forward market for spectrum/bandwidth 140. Purchasing of spectrum resources may be configured and managed by an expert system operating on any of the external data sources 182 or on data aggregated by the set of data aggregation systems 144 for the platform. Spectrum resources may be purchased by an automated system using an expert system, including machine learning or other artificial intelligence, such as where resources are purchased with favorable timing, such as based on an understanding of supply and demand, that is determined by processing inputs from the various data sources. For example, the spectrum purchase and sale machine 142 may purchase or reserve spectrum on a network resource for a future networking activity managed by the platform based on learning from a wide range of inputs about market conditions, behavior data, and data regarding activities of agent and systems within the platform 100, such as to obtain such resources at favorable prices during surge periods of demand for spectrum. The expert system may be trained on a data set of outcomes from purchases under historical input conditions. The expert system may be trained on a data set of human purchase decisions and/or may be supervised by one or more human operators. The spectrum purchase and sale machine 142 may also sell one or more spectrum-related resources that are connected to, part of, or managed by the platform 100 in a spot market for spectrum resources 162 or a forward market for spectrum/bandwidth 140. Sale may also be conducted by an expert system operating on the various data sources described herein, including with training on outcomes and human supervision.

In embodiments, the intelligent resource allocation and coordination system 168, including the intelligent resource purchasing system 164, the intelligent sale engine 172 and the automated spot market testing and arbitrage transaction execution engine 194, may provide coordinated and automated allocation of resources and coordinated execution of transactions across the various forward markets 130 and spot markets 170 by coordinating the various purchase and sale machines, such as by an expert system, such as a machine learning system (which may model-based or a deep learning system, and which may be trained on outcomes and/or supervised by humans). For example, the intelligent resource allocation and coordination system 168 may coordinate purchasing of resources for a set of assets and coordinated sale of resources available from a set of assets, such as a fleet of vehicles, a data center of processing and data storage resources, an information technology network (on premises, cloud, or hybrids), a fleet of energy production systems (renewable or non-renewable), a smart home or building (including appliances, machines, infrastructure components and systems, and the like thereof that consume or produce resources), and the like. The platform 100 may optimize allocation of resource purchasing, sale and utilization based on data aggregated in the platform, such as by tracking activities of various engines and agents, as well as by taking inputs from external data sources 182. In embodiments, outcomes may be provided as feedback for training the intelligent resource allocation and coordination system 168, such as outcomes based on yield, profitability, optimization of resources, optimization of business objectives, satisfaction of goals, satisfaction of users or operators, or the like. For example, as the energy for computational tasks becomes a significant fraction of an enterprise's energy usage, the platform 100 may learn to optimize how a set of machines that have energy storage capacity allocate that capacity among computing tasks (such as for cryptocurrency mining, application of neural networks, computation on data and the like), other useful tasks (that may yield profits or other benefits), storage for future use, or sale to the provider of an energy grid. The platform 100 may be used by fleet operators, enterprises, governments, municipalities, military units, first responder units, manufacturers, energy producers, cloud platform providers, and other enterprises and operators that own or operate resources that consume or provide energy, computation, data storage, bandwidth, or spectrum. The platform 100 may also be used in connection with markets for attention, such as to use available capacity of resources to support attention-based exchanges of value, such as in advertising markets, micro-transaction markets, and others.

Referring still to FIGS. 2A and 2B, the platform 100 may include a set of intelligent forecasting engines 192 that forecast one or more attributes, parameters, variables, or other factors, such as for use as inputs by the set of forward purchase and sale machines, the intelligent transaction engines 136 (such as for intelligent cryptocurrency execution) or for other purposes. Each of the set of intelligent forecasting engines 192 may use data that is tracked, aggregated, processed, or handled within the platform 100, such as by the data aggregation system 144, as well as input data from external data sources 182, such as social media data sources 180, automated agent behavioral data sources 188, human behavioral data sources 184, entity behavioral data sources 190 and IoT data sources 198. These collective inputs may be used to forecast attributes, such as using a model (e.g., Bayesian, regression, or other statistical model), a rule, or an expert system, such as a machine learning system that has one or more classifiers, pattern recognizers, and predictors, such as any of the expert systems described throughout this disclosure. In embodiments, the set of intelligent forecasting engines 192 may include one or more specialized engines that forecast market attributes, such as capacity, demand, supply, and prices, using particular data sources for particular markets. These may include an energy price forecasting engine 215 that bases its forecast on behavior of an automated agent, a network spectrum price forecasting engine 217 that bases its forecast on behavior of an automated agent, a REC price forecasting engine 219 that bases its forecast on behavior of an automated agent, a compute price forecasting engine 221 that bases its forecast on behavior of an automated agent, a network spectrum price forecasting engine 223 that bases its forecast on behavior of an automated agent. In each case, observations regarding the behavior of automated agents, such as ones used for conversation, for dialog management, for managing electronic commerce, for managing advertising and others may be provided as inputs for forecasting to the engines. The intelligent forecasting engines 192 may also include a range of engines that provide forecasts at least in part based on entity behavior, such as behavior of business and other organizations, such as marketing behavior, sales behavior, product offering behavior, advertising behavior, purchasing behavior, transactional behavior, merger and acquisition behavior, and other entity behavior. These may include an energy price forecasting engine 225 using entity behavior, a network spectrum price forecasting engine 227 using entity behavior, a REC price forecasting engine 229 using entity behavior, a compute price forecasting engine 231 using entity behavior, and a network spectrum price forecasting engine 233 using entity behavior.

The intelligent forecasting engines 192 may also include a range of engines that provide forecasts at least in part based on human behavior, such as behavior of consumers and users, such as purchasing behavior, shopping behavior, sales behavior, product interaction behavior, energy utilization behavior, mobility behavior, activity level behavior, activity type behavior, transactional behavior, and other human behavior. These may include an energy price forecasting engine 235 using human behavior, a network spectrum price forecasting engine 237 using human behavior, a REC price forecasting engine 239 using human behavior, a compute price forecasting engine 241 using human behavior, and a network spectrum price forecasting engine 243 using human behavior.

Referring still to FIGS. 2A and 2B, the platform 100 may include a set of intelligent transaction engines 136 that automate execution of transactions in forward markets 130 and/or spot markets 170 based on determination that favorable conditions exist, such as by the intelligent resource allocation and coordination system 168 and/or with use of forecasts form the intelligent forecasting engines 192. The intelligent transaction engines 136 may be configured to automatically execute transactions, using available market interfaces, such as APIs, connectors, ports, network interfaces, and the like, in each of the markets noted above. In embodiments, the intelligent transaction engines may execute transactions based on event streams that come from external data sources, such as IoT data sources 198 and social media data sources 180. The engines may include, for example, an IoT forward energy transaction engine 195 and/or an IoT compute market transaction engine 106, either or both of which may use data from the Internet of Things to determine timing and other attributes for market transaction in a market for one or more of the resources described herein, such as an energy market transaction, a compute resource transaction or other resource transaction. IoT data may include instrumentation and controls data for one or more machines (optionally coordinated as a fleet) that use or produce energy or that use or have compute resources, weather data that influences energy prices or consumption (such as wind data influencing production of wind energy), sensor data from energy production environments, sensor data from points of use for energy or compute resources (such as vehicle traffic data, network traffic data, IT network utilization data, Internet utilization and traffic data, camera data from work sites, smart building data, smart home data, and the like), and other data collected by or transferred within the Internet of Things, including data stored in IoT platforms and of cloud services providers like Amazon, IBM, and others. The intelligent transaction engines 136 may include engines that use social data to determine timing of other attributes for a market transaction in one or more of the resources described herein, such as a social data forward energy transaction engine 199 and/or a social data compute market transaction engine 116. Social data may include data from social networking sites (e.g., Facebook™ YouTube™, Twitter™, Snapchat™, Instagram™, and others), data from websites, data from e-commerce sites, and data from other sites that contain information that may be relevant to determining or forecasting behavior of users or entities, such as data indicating interest or attention to particular topics, goods or services, data indicating activity types and levels such as may be observed by machine processing of image data showing individuals engaged in activities, including travel, work activities, leisure activities, and the like. Social data may be supplied to machine learning, such as for learning user behavior or entity behavior at a social data market predictor 186, and/or as an input to an expert system, a model, or the like, such as one for determining, based on the social data, the parameters for a transaction. For example, an event or set of events in a social data stream may indicate the likelihood of a surge of interest in an online resource, a product, or a service, and compute resources, bandwidth, storage, or like may be purchased in advance (avoiding surge pricing) to accommodate the increased interest reflected by the social data stream.

### Neural Net Systems

Embodiments of the present disclosure, including ones involving expert systems, self-organization, machine learning, artificial intelligence, and the like, may benefit from the use of a neural net, such as a neural net trained for pattern recognition, for classification of one or more parameters, characteristics, or phenomena, for support of autonomous control, and other purposes. References to a neural net throughout this disclosure should be understood to encompass a wide range of different types of neural networks, machine learning systems, artificial intelligence systems, and the like, such as feed forward neural networks, radial basis function neural networks, self-organizing neural networks (e.g., Kohonen self-organizing neural networks), recurrent neural networks, modular neural networks, artificial neural networks, physical neural networks, multi-layered neural networks, convolutional neural networks, hybrids of neural networks with other expert systems (e.g., hybrid fuzzy logic—neural network systems), Autoencoder neural networks, probabilistic neural networks, time delay neural networks, convolutional neural networks, regulatory feedback neural networks, radial basis function neural networks, recurrent neural networks, Hopfield neural networks, Boltzmann machine neural networks, self-organizing map (SOM) neural networks, learning vector quantization (LVQ) neural networks, fully recurrent neural networks, simple recurrent neural networks, echo state neural networks, long short-term memory neural networks, bi-directional neural networks, hierarchical neural networks, stochastic neural networks, genetic scale RNN neural networks, committee of machines neural networks, associative neural networks, physical neural networks, instantaneously trained neural networks, spiking neural networks, neocognitron neural networks, dynamic neural networks, cascading neural networks, neuro-fuzzy neural networks, compositional pattern-producing neural networks, memory neural networks, hierarchical temporal memory neural networks, deep feed forward neural networks, gated recurrent unit (GCU) neural networks, auto encoder neural networks, variational auto encoder neural networks, de-noising auto encoder neural networks, sparse auto-encoder neural networks, Markov chain neural networks, restricted Boltzmann machine neural networks, deep belief neural networks, deep convolutional neural networks, de-convolutional neural networks, deep convolutional inverse graphics neural networks, generative adversarial neural networks, liquid state machine neural networks, extreme learning machine neural networks, echo state neural networks, deep residual neural networks, support vector machine neural networks, neural Turing machine neural networks, and/or holographic associative memory neural networks, or hybrids or combinations of the foregoing, or combinations with other expert systems, such as rule-based systems, model-based systems (including ones based on physical models, statistical models, flow-based models, biological models, biomimetic models, and the like).

In embodiments, exemplary neural networks have cells that are assigned functions and requirements. In embodiments, the various neural net examples may include back fed data/sensor cells, data/sensor cells, noisy input cells, and hidden cells. The neural net components also include probabilistic hidden cells, spiking hidden cells, output cells, match input/output cells, recurrent cells, memory cells, different memory cells, kernels, and convolution or pool cells.

In embodiments, an exemplary perceptron neural network may connect to, integrate with, or interface with the platform 100. The platform may also be associated with further neural net systems such as a feed forward neural network, a radial basis neural network, a deep feed forward neural network, a recurrent neural network, a long/short term neural network, and a gated recurrent neural network. The platform may also be associated with further neural net systems such as an auto encoder neural network, a variational neural network, a denoising neural network, a sparse neural network, a Markov chain neural network, and a Hopfield network neural network. The platform may further be associated with additional neural net systems such as a Boltzmann machine neural network, a restricted BM neural network, a deep belief neural network, a deep convolutional neural network, a deconvolutional neural network, and a deep convolutional inverse graphics neural network. The platform may also be associated with further neural net systems such as a generative adversarial neural network, a liquid state machine neural network, an extreme learning machine neural network, an echo state neural network, a deep residual neural network, a Kohonen neural network, a support vector machine neural network, and a neural Turing machine neural network.

The foregoing neural networks may have a variety of nodes or neurons, which may perform a variety of functions on inputs, such as inputs received from sensors or other data sources, including other nodes. Functions may involve weights, features, feature vectors, and the like. Neurons may include perceptrons, neurons that mimic biological functions (such as of the human senses of touch, vision, taste, hearing, and smell), and the like. Continuous neurons, such as with sigmoidal activation, may be used in the context of various forms of neural net, such as where back propagation is involved.

In many embodiments, an expert system or neural network may be trained, such as by a human operator or supervisor, or based on a data set, model, or the like. Training may include presenting the neural network with one or more training data sets that represent values, such as sensor data, event data, parameter data, and other types of data (including the many types described throughout this disclosure), as well as one or more indicators of an outcome, such as an outcome of a process, an outcome of a calculation, an outcome of an event, an outcome of an activity, or the like. Training may include training in optimization, such as training a neural network to optimize one or more systems based on one or more optimization approaches, such as Bayesian approaches, parametric Bayes classifier approaches, k-nearest-neighbor classifier approaches, iterative approaches, interpolation approaches, Pareto optimization approaches, algorithmic approaches, and the like. Feedback may be provided in a process of variation and selection, such as with a genetic algorithm that evolves one or more solutions based on feedback through a series of rounds.

In embodiments, a plurality of neural networks may be deployed in a cloud platform that receives data streams and other inputs collected (such as by mobile data collectors) in one or more transactional environments and transmitted to the cloud platform over one or more networks, including using network coding to provide efficient transmission. In the cloud platform, optionally using massively parallel computational capability, a plurality of different neural networks of various types (including modular forms, structure-adaptive forms, hybrids, and the like) may be used to undertake prediction, classification, control functions, and provide other outputs as described in connection with expert systems disclosed throughout this disclosure. The different neural networks may be structured to compete with each other (optionally including use evolutionary algorithms, genetic algorithms, or the like), such that an appropriate type of neural network, with appropriate input sets, weights, node types and functions, and the like, may be selected, such as by an expert system, for a specific task involved in a given context, workflow, environment process, system, or the like.

In embodiments, methods and systems described herein that involve an expert system or self-organization capability may use a feed forward neural network, which moves information in one direction, such as from a data input, like a data source related to at least one resource or parameter related to a transactional environment, such as any of the data sources mentioned throughout this disclosure, through a series of neurons or nodes, to an output. Data may move from the input nodes to the output nodes, optionally passing through one or more hidden nodes, without loops. In embodiments, feed forward neural networks may be constructed with various types of units, such as binary McCulloch-Pitts neurons, the simplest of which is a perceptron.

In embodiments, methods and systems described herein that involve an expert system or self-organization capability may use a capsule neural network, such as for prediction, classification, or control functions with respect to a transactional environment, such as relating to one or more of the machines and automated systems described throughout this disclosure.

In embodiments, methods and systems described herein that involve an expert system or self-organization capability may use a radial basis function (RBF) neural network, which may be preferred in some situations involving interpolation in a multi-dimensional space (such as where interpolation is helpful in optimizing a multi-dimensional function, such as for optimizing a data marketplace as described here, optimizing the efficiency or output of a power generation system, a factory system, or the like, or other situation involving multiple dimensions. In embodiments, each neuron in the RBF neural network stores an example from a training set as a “prototype.” Linearity involved in the functioning of this neural network offers RBF the advantage of not typically suffering from problems with local minima or maxima.

In embodiments, methods and systems described herein that involve an expert system or self-organization capability may use a radial basis function (RBF) neural network, such as one that employs a distance criterion with respect to a center (e.g., a Gaussian function). A radial basis function may be applied as a replacement for a hidden layer, such as a sigmoidal hidden layer transfer, in a multi-layer perceptron. An RBF network may have two layers, such as where an input is mapped onto each RBF in a hidden layer. In embodiments, an output layer may comprise a linear combination of hidden layer values representing, for example, a mean predicted output. The output layer value may provide an output that is the same as or similar to that of a regression model in statistics. In classification problems, the output layer may be a sigmoid function of a linear combination of hidden layer values, representing a posterior probability. Performance in both cases is often improved by shrinkage techniques, such as ridge regression in classical statistics. This corresponds to a prior belief in small parameter values (and therefore smooth output functions) in a Bayesian framework. RBF networks may avoid local minima, because the only parameters that are adjusted in the learning process are the linear mapping from hidden layer to output layer. Linearity ensures that the error surface is quadratic and therefore has a single minimum. In regression problems, this may be found in one matrix operation. In classification problems, the fixed non-linearity introduced by the sigmoid output function may be handled using an iteratively re-weighted least squares function or the like. RBF networks may use kernel methods such as support vector machines (SVM) and Gaussian processes (where the RBF is the kernel function). A non-linear kernel function may be used to project the input data into a space where the learning problem may be solved using a linear model.

In embodiments, an RBF neural network may include an input layer, a hidden layer, and a summation layer. In the input layer, one neuron appears in the input layer for each predictor variable. In the case of categorical variables, N−1 neurons are used, where N is the number of categories. The input neurons may, in embodiments, standardize the value ranges by subtracting the median and dividing by the interquartile range. The input neurons may then feed the values to each of the neurons in the hidden layer. In the hidden layer, a variable number of neurons may be used (determined by the training process). Each neuron may consist of a radial basis function that is centered on a point with as many dimensions as a number of predictor variables. The spread (e.g., radius) of the RBF function may be different for each dimension. The centers and spreads may be determined by training. When presented with the vector of input values from the input layer, a hidden neuron may compute a Euclidean distance of the test case from the neuron's center point and then apply the RBF kernel function to this distance, such as using the spread values. The resulting value may then be passed to the summation layer. In the summation layer, the value coming out of a neuron in the hidden layer may be multiplied by a weight associated with the neuron and may add to the weighted values of other neurons. This sum becomes the output. For classification problems, one output is produced (with a separate set of weights and summation units) for each target category. The value output for a category is the probability that the case being evaluated has that category. In training of an RBF, various parameters may be determined, such as the number of neurons in a hidden layer, the coordinates of the center of each hidden-layer function, the spread of each function in each dimension, and the weights applied to outputs as they pass to the summation layer. Training may be used by clustering algorithms (such as k-means clustering), by evolutionary approaches, and the like.

In embodiments, a recurrent neural network may have a time-varying, real-valued (more than just zero or one) activation (output). Each connection may have a modifiable real-valued weight. Some of the nodes are called labeled nodes, some output nodes, and others hidden nodes. For supervised learning in discrete time settings, training sequences of real-valued input vectors may become sequences of activations of the input nodes, one input vector at a time. At each time step, each non-input unit may compute its current activation as a nonlinear function of the weighted sum of the activations of all units from which it receives connections. The system may explicitly activate (independent of incoming signals) some output units at certain time steps.

In embodiments, methods and systems described herein that involve an expert system or self-organization capability may use a self-organizing neural network, such as a Kohonen self-organizing neural network, such as for visualization of views of data, such as low-dimensional views of high-dimensional data. The self-organizing neural network may apply competitive learning to a set of input data, such as from one or more sensors or other data inputs from or associated with a transactional environment, including any machine or component that relates to the transactional environment. In embodiments, the self-organizing neural network may be used to identify structures in data, such as unlabeled data, such as in data sensed from a range of data sources about or sensors in or about in a transactional environment, where sources of the data are unknown (such as where events may be coming from any of a range of unknown sources). The self-organizing neural network may organize structures or patterns in the data, such that they may be recognized, analyzed, and labeled, such as identifying market behavior structures as corresponding to other events and signals.

In embodiments, methods and systems described herein that involve an expert system or self-organization capability may use a recurrent neural network, which may allow for a bi-directional flow of data, such as where connected units (e.g., neurons or nodes) form a directed cycle. Such a network may be used to model or exhibit dynamic temporal behavior, such as involved in dynamic systems, such as a wide variety of the automation systems, machines and devices described throughout this disclosure, such as an automated agent interacting with a marketplace for purposes of collecting data, testing spot market transactions, execution transactions, and the like, where dynamic system behavior involves complex interactions that a user may desire to understand, predict, control and/or optimize. For example, the recurrent neural network may be used to anticipate the state of a market, such as one involving a dynamic process or action, such as a change in state of a resource that is traded in or that enables a marketplace of transactional environment. In embodiments, the recurrent neural network may use internal memory to process a sequence of inputs, such as from other nodes and/or from sensors and other data inputs from or about the transactional environment, of the various types described herein. In embodiments, the recurrent neural network may also be used for pattern recognition, such as for recognizing a machine, component, agent, or other item based on a behavioral signature, a profile, a set of feature vectors (such as in an audio file or image), or the like. In a non-limiting example, a recurrent neural network may recognize a shift in an operational mode of a marketplace or machine by learning to classify the shift from a training data set consisting of a stream of data from one or more data sources of sensors applied to or about one or more resources.

In embodiments, methods and systems described herein that involve an expert system or self-organization capability may use a modular neural network, which may comprise a series of independent neural networks (such as ones of various types described herein) that are moderated by an intermediary. Each of the independent neural networks in the modular neural network may work with separate inputs, accomplishing subtasks that make up the task the modular network as whole is intended to perform. For example, a modular neural network may comprise a recurrent neural network for pattern recognition, such as to recognize what type of machine or system is being sensed by one or more sensors that are provided as input channels to the modular network and an RBF neural network for optimizing the behavior of the machine or system once understood. The intermediary may accept inputs of each of the individual neural networks, process them, and create output for the modular neural network, such an appropriate control parameter, a prediction of state, or the like.

Combinations among any of the pairs, triplets, or larger combinations, of the various neural network types described herein, are encompassed by the present disclosure. This may include combinations where an expert system uses one neural network for recognizing a pattern (e.g., a pattern indicating a problem or fault condition) and a different neural network for self-organizing an activity or workflow based on the recognized pattern (such as providing an output governing autonomous control of a system in response to the recognized condition or pattern). This may also include combinations where an expert system uses one neural network for classifying an item (e.g., identifying a machine, a component, or an operational mode) and a different neural network for predicting a state of the item (e.g., a fault state, an operational state, an anticipated state, a maintenance state, or the like). Modular neural networks may also include situations where an expert system uses one neural network for determining a state or context (such as a state of a machine, a process, a workflow, a marketplace, a storage system, a network, a data collector, or the like) and a different neural network for self-organizing a process involving the state or context (e.g., a data storage process, a network coding process, a network selection process, a data marketplace process, a power generation process, a manufacturing process, a refining process, a digging process, a boring process, or other process described herein).

In embodiments, methods and systems described herein that involve an expert system or self-organization capability may use a physical neural network where one or more hardware elements is used to perform or simulate neural behavior. In embodiments, one or more hardware neurons may be configured to stream voltage values, current values, or the like that represent sensor data, such as to calculate information from analog sensor inputs representing energy consumption, energy production, or the like, such as by one or more machines providing energy or consuming energy for one or more transactions. One or more hardware nodes may be configured to stream output data resulting from the activity of the neural net. Hardware nodes, which may comprise one or more chips, microprocessors, integrated circuits, programmable logic controllers, application-specific integrated circuits, field-programmable gate arrays, or the like, may be provided to optimize the machine that is producing or consuming energy, or to optimize another parameter of some part of a neural net of any of the types described herein. Hardware nodes may include hardware for acceleration of calculations (such as dedicated processors for performing basic or more sophisticated calculations on input data to provide outputs, dedicated processors for filtering or compressing data, dedicated processors for de-compressing data, dedicated processors for compression of specific file or data types (e.g., for handling image data, video streams, acoustic signals, thermal images, heat maps, or the like), and the like. A physical neural network may be embodied in a data collector, including one that may be reconfigured by switching or routing inputs in varying configurations, such as to provide different neural net configurations within the data collector for handling different types of inputs (with the switching and configuration optionally under control of an expert system, which may include a software-based neural net located on the data collector or remotely). A physical, or at least partially physical, neural network may include physical hardware nodes located in a storage system, such as for storing data within a machine, a data storage system, a distributed ledger, a mobile device, a server, a cloud resource, or in a transactional environment, such as for accelerating input/output functions to one or more storage elements that supply data to or take data from the neural net. A physical, or at least partially physical, neural network may include physical hardware nodes located in a network, such as for transmitting data within, to or from an industrial environment, such as for accelerating input/output functions to one or more network nodes in the net, accelerating relay functions, or the like. In embodiments, of a physical neural network, an electrically adjustable resistance material may be used for emulating the function of a neural synapse. In embodiments, the physical hardware emulates the neurons, and software emulates the neural network between the neurons. In embodiments, neural networks complement conventional algorithmic computers. They are versatile and may be trained to perform appropriate functions without the need for any instructions, such as classification functions, optimization functions, pattern recognition functions, control functions, selection functions, evolution functions, and others.

In embodiments, methods and systems described herein that involve an expert system or self-organization capability may use a multilayered feed forward neural network, such as for complex pattern classification of one or more items, phenomena, modes, states, or the like. In embodiments, a multilayered feed forward neural network may be trained by an optimization technique, such as a genetic algorithm, such as to explore a large and complex space of options to find an optimum, or near-optimum, global solution. For example, one or more genetic algorithms may be used to train a multilayered feed forward neural network to classify complex phenomena, such as to recognize complex operational modes of machines, such as modes involving complex interactions among machines (including interference effects, resonance effects, and the like), modes involving non-linear phenomena, modes involving critical faults, such as where multiple, simultaneous faults occur, making root cause analysis difficult, and others. In embodiments, a multilayered feed forward neural network may be used to classify results from monitoring of a marketplace, such as monitoring systems, such as automated agents, that operate within the marketplace, as well as monitoring resources that enable the marketplace, such as computing, networking, energy, data storage, energy storage, and other resources.

In embodiments, methods and systems described herein that involve an expert system or self-organization capability may use a feed-forward, back-propagation multi-layer perceptron (MLP) neural network, such as for handling one or more remote sensing applications, such as for taking inputs from sensors distributed throughout various transactional environments. In embodiments, the MLP neural network may be used for classification of transactional environments and resource environments, such as spot markets, forward markets, energy markets, renewable energy credit (REC) markets, networking markets, advertising markets, spectrum markets, ticketing markets, rewards markets, compute markets, and others mentioned throughout this disclosure, as well as physical resources and environments that produce them, such as energy resources (including renewable energy environments, mining environments, exploration environments, drilling environments, and the like, including classification of geological structures (including underground features and above ground features), classification of materials (including fluids, minerals, metals, and the like), and other problems. This may include fuzzy classification.

In embodiments, methods and systems described herein that involve an expert system or self-organization capability may use a structure-adaptive neural network, where the structure of a neural network is adapted, such as based on a rule, a sensed condition, a contextual parameter, or the like. For example, if a neural network does not converge on a solution, such as classifying an item or arriving at a prediction, when acting on a set of inputs after some amount of training, the neural network may be modified, such as from a feed forward neural network to a recurrent neural network, such as by switching data paths between some subset of nodes from unidirectional to bi-directional data paths. The structure adaptation may occur under control of an expert system, such as to trigger adaptation upon occurrence of a trigger, rule, or event, such as recognizing occurrence of a threshold (such as an absence of a convergence to a solution within a given amount of time) or recognizing a phenomenon as requiring different or additional structure (such as recognizing that a system is varying dynamically or in a non-linear fashion). In one non-limiting example, an expert system may switch from a simple neural network structure like a feed forward neural network to a more complex neural network structure like a recurrent neural network, a convolutional neural network, or the like upon receiving an indication that a continuously variable transmission is being used to drive a generator, turbine, or the like in a system being analyzed.

In embodiments, methods and systems described herein that involve an expert system or self-organization capability may use an autoencoder, autoassociator or Diabolo neural network, which may be similar to a multilayer perceptron (MLP) neural network, such as where there may be an input layer, an output layer and one or more hidden layers connecting them. However, the output layer in the auto-encoder may have the same number of units as the input layer, where the purpose of the MLP neural network is to reconstruct its own inputs (rather than just emitting a target value). Therefore, the auto encoders may operate as an unsupervised learning model. An auto encoder may be used, for example, for unsupervised learning of efficient codings, such as for dimensionality reduction, for learning generative models of data, and the like. In embodiments, an auto-encoding neural network may be used to self-learn an efficient network coding for transmission of analog sensor data from a machine over one or more networks or of digital data from one or more data sources. In embodiments, an auto-encoding neural network may be used to self-learn an efficient storage approach for storage of streams of data.

In embodiments, methods and systems described herein that involve an expert system or self-organization capability may use a probabilistic neural network (PNN), which, in embodiments, may comprise a multi-layer (e.g., four-layer) feed forward neural network, where layers may include input layers, hidden layers, pattern/summation layers and an output layer. In an embodiment of a PNN algorithm, a parent probability distribution function (PDF) of each class may be approximated, such as by a Parzen window and/or a non-parametric function. Then, using the PDF of each class, the class probability of a new input is estimated, and Bayes' rule may be employed, such as to allocate it to the class with the highest posterior probability. A PNN may embody a Bayesian network and may use a statistical algorithm or analytic technique, such as Kernel Fisher discriminant analysis technique. The PNN may be used for classification and pattern recognition in any of a wide range of embodiments disclosed herein. In one non-limiting example, a probabilistic neural network may be used to predict a fault condition of an engine based on collection of data inputs from sensors and instruments for the engine.

In embodiments, methods and systems described herein that involve an expert system or self-organization capability may use a time delay neural network (TDNN), which may comprise a feed forward architecture for sequential data that recognizes features independent of sequence position. In embodiments, to account for time shifts in data, delays are added to one or more inputs, or between one or more nodes, so that multiple data points (from distinct points in time) are analyzed together. A time delay neural network may form part of a larger pattern recognition system, such as using a perceptron network. In embodiments, a TDNN may be trained with supervised learning, such as where connection weights are trained with back propagation or under feedback. In embodiments, a TDNN may be used to process sensor data from distinct streams, such as a stream of velocity data, a stream of acceleration data, a stream of temperature data, a stream of pressure data, and the like, where time delays are used to align the data streams in time, such as to help understand patterns that involve understanding of the various streams (e.g., changes in price patterns in spot or forward markets).

In embodiments, methods and systems described herein that involve an expert system or self-organization capability may use a convolutional neural network (referred to in some cases as a CNN, a ConvNet, a shift invariant neural network, or a space invariant neural network), wherein the units are connected in a pattern similar to the visual cortex of the human brain. Neurons may respond to stimuli in a restricted region of space, referred to as a receptive field. Receptive fields may partially overlap, such that they collectively cover the entire (e.g., visual) field. Node responses may be calculated mathematically, such as by a convolution operation, such as using multilayer perceptrons that use minimal preprocessing. A convolutional neural network may be used for recognition within images and video streams, such as for recognizing a type of machine in a large environment using a camera system disposed on a mobile data collector, such as on a drone or mobile robot. In embodiments, a convolutional neural network may be used to provide a recommendation based on data inputs, including sensor inputs and other contextual information, such as recommending a route for a mobile data collector. In embodiments, a convolutional neural network may be used for processing inputs, such as for natural language processing of instructions provided by one or more parties involved in a workflow in an environment. In embodiments, a convolutional neural network may be deployed with a large number of neurons (e.g., 100,000, 500,000 or more), with multiple (e.g., 4, 5, 6 or more) layers, and with many (e.g., millions) of parameters. A convolutional neural net may use one or more convolutional nets.

In embodiments, methods and systems described herein that involve an expert system or self-organization capability may use a regulatory feedback network, such as for recognizing emergent phenomena (such as new types of behavior not previously understood in a transactional environment).

In embodiments, methods and systems described herein that involve an expert system or self-organization capability may use a self-organizing map (SOM), involving unsupervised learning. A set of neurons may learn to map points in an input space to coordinates in an output space. The input space may have different dimensions and topology from the output space, and the SOM may preserve these while mapping phenomena into groups.

In embodiments, methods and systems described herein that involve an expert system or self-organization capability may use a learning vector quantization neural net (LVQ). Prototypical representatives of the classes may parameterize, together with an appropriate distance measure, in a distance-based classification scheme.

In embodiments, methods and systems described herein that involve an expert system or self-organization capability may use an echo state network (ESN), which may comprise a recurrent neural network with a sparsely connected, random hidden layer. The weights of output neurons may be changed (e.g., the weights may be trained based on feedback). In embodiments, an ESN may be used to handle time series patterns, such as, in an example, recognizing a pattern of events associated with a market, such as the pattern of price changes in response to stimuli.

In embodiments, methods and systems described herein that involve an expert system or self-organization capability may use a Bi-directional, recurrent neural network (BRNN), such as using a finite sequence of values (e.g., voltage values from a sensor) to predict or label each element of the sequence based on both the past and the future context of the element. This may be done by adding the outputs of two RNNs, such as one processing the sequence from left to right, the other one from right to left. The combined outputs are the predictions of target signals, such as ones provided by a teacher or supervisor. A bi-directional RNN may be combined with a long short-term memory RNN.

In embodiments, methods and systems described herein that involve an expert system or self-organization capability may use a hierarchical RNN that connects elements in various ways to decompose hierarchical behavior, such as into useful subprograms. In embodiments, a hierarchical RNN may be used to manage one or more hierarchical templates for data collection in a transactional environment.

In embodiments, methods and systems described herein that involve an expert system or self-organization capability may use a stochastic neural network, which may introduce random variations into the network. Such random variations may be viewed as a form of statistical sampling, such as Monte Carlo sampling.

In embodiments, methods and systems described herein that involve an expert system or self-organization capability may use a genetic scale recurrent neural network. In such embodiments, an RNN (often an LSTM) is used where a series is decomposed into a number of scales where every scale informs the primary length between two consecutive points. A first order scale consists of a normal RNN, a second order consists of all points separated by two indices and so on. The Nth order RNN connects the first and last node. The outputs from all the various scales may be treated as a committee of members, and the associated scores may be used genetically for the next iteration.

In embodiments, methods and systems described herein that involve an expert system or self-organization capability may use a committee of machines (CoM), comprising a collection of different neural networks that together “vote” on a given example. Because neural networks may suffer from local minima, starting with the same architecture and training, but using randomly different initial weights often gives different results. A CoM tends to stabilize the result.

In embodiments, methods and systems described herein that involve an expert system or self-organization capability may use an associative neural network (ASNN), such as involving an extension of a committee of machines that combines multiple feed forward neural networks and a k-nearest neighbor technique. It may use the correlation between ensemble responses as a measure of distance amid the analyzed cases for the kNN. This corrects the bias of the neural network ensemble. An associative neural network may have a memory that may coincide with a training set. If new data become available, the network instantly improves its predictive ability and provides data approximation (self-learns) without retraining. Another important feature of ASNN is the possibility to interpret neural network results by analysis of correlations between data cases in the space of models.

In embodiments, methods and systems described herein that involve an expert system or self-organization capability may use an instantaneously trained neural network (ITNN), where the weights of the hidden and the output layers are mapped directly from training vector data.

In embodiments, methods and systems described herein that involve an expert system or self-organization capability may use a spiking neural network, which may explicitly consider the timing of inputs. The network input and output may be represented as a series of spikes (such as a delta function or more complex shapes). SNNs may process information in the time domain (e.g., signals that vary over time, such as signals involving dynamic behavior of markets or transactional environments). They are often implemented as recurrent networks.

In embodiments, methods and systems described herein that involve an expert system or self-organization capability may use a dynamic neural network that addresses nonlinear multivariate behavior and includes learning of time-dependent behavior, such as transient phenomena and delay effects. Transients may include behavior of shifting market variables, such as prices, available quantities, available counterparties, and the like.

In embodiments, cascade correlation may be used as an architecture and supervised learning algorithm, supplementing adjustment of the weights in a network of fixed topology. Cascade-correlation may begin with a minimal network, then automatically trains, and adds new hidden units one by one, creating a multi-layer structure. Once a new hidden unit has been added to the network, its input-side weights may be frozen. This unit then becomes a permanent feature-detector in the network, available for producing outputs or for creating other, more complex feature detectors. The cascade-correlation architecture may learn quickly, determine its own size and topology, and retain the structures it has built even if the training set changes and requires no back-propagation.

In embodiments, methods and systems described herein that involve an expert system or self-organization capability may use a neuro-fuzzy network, such as involving a fuzzy inference system in the body of an artificial neural network. Depending on the type, several layers may simulate the processes involved in a fuzzy inference, such as fuzzification, inference, aggregation and defuzzification. Embedding a fuzzy system in a general structure of a neural net as the benefit of using available training methods to find the parameters of a fuzzy system.

In embodiments, methods and systems described herein that involve an expert system or self-organization capability may use a compositional pattern-producing network (CPPN), such as a variation of an associative neural network (ANN) that differs the set of activation functions and how they are applied. While typical ANNs often contain only sigmoid functions (and sometimes Gaussian functions), CPPNs may include both types of functions and many others. Furthermore, CPPNs may be applied across the entire space of possible inputs, so that they may represent a complete image. Since they are compositions of functions, CPPNs in effect encode images at infinite resolution and may be sampled for a particular display at whatever resolution is optimal.

This type of network may add new patterns without re-training. In embodiments, methods and systems described herein that involve an expert system or self-organization capability may use a one-shot associative memory network, such as by creating a specific memory structure, which assigns each new pattern to an orthogonal plane using adjacently connected hierarchical arrays.

In embodiments, methods and systems described herein that involve an expert system or self-organization capability may use a hierarchical temporal memory (HTM) neural network, such as involving the structural and algorithmic properties of the neocortex. HTM may use a biomimetic model based on memory-prediction theory.

HTM may be used to discover and infer the high-level causes of observed input patterns and sequences.

### Machine Learning System

In embodiments, the machine learning system may train models, such as predictive models (e.g., various types of neural networks, regression based models, and other machine-learned models). In embodiments, training can be supervised, semi-supervised, or unsupervised. In embodiments, training can be done using training data, which may be collected or generated for training purposes.

A facility output model (or prediction model) may be a model that receive facility attributes and outputs one or more predictions regarding the production or other output of a facility. Examples of predictions may be the amount of energy a facility will produce, the amount of processing the facility will undertake, the amount of data a network will be able to transfer, the amount of data that can be stored, the price of a component, service or the like (such as supplied to or provided by a facility), a profit generated by accomplishing a given tasks, the cost entailed in performing an action, and the like. In each case, the machine learning system optionally trains a model based on training data. In embodiments, the machine learning system may receive vectors containing facility attributes (e.g., facility type, facility capability, objectives sought, constraints or rules that apply to utilization of resources or the facility, or the like), person attributes (e.g., role, components managed, and the like), and outcomes (e.g., energy produced, computing tasks completed, and financial results, among many others). Each vector corresponds to a respective outcome and the attributes of the respective facility and respective actions that led to the outcome. The machine learning system takes in the vectors and generates predictive model based thereon. In embodiments, the machine learning system may store the predictive models in the model datastore.

In embodiments, training can also be done based on feedback received by the system, which is also referred to as “reinforcement learning.” In embodiments, the machine learning system may receive a set of circumstances that led to a prediction (e.g., attributes of facility, attributes of a model, and the like) and an outcome related to the facility and may update the model according to the feedback.

In embodiments, training may be provided from a training data set that is created by observing actions of a set of humans, such as facility managers managing facilities that have various capabilities and that are involved in various contexts and situations. This may include use of robotic process automation to learn on a training data set of interactions of humans with interfaces, such as graphical user interfaces, of one or more computer programs, such as dashboards, control systems, and other systems that are used to manage an energy and compute management facility.

### Artificial Intelligence (AI) Systems

In embodiments, the AI system leverages the predictive models to make predictions regarding facilities.

Examples of predictions include ones related to inputs to a facility (e.g., available energy, cost of energy, cost of compute resources, networking capacity and the like, as well as various market information, such as pricing information for end use markets), ones related to components or systems of a facility (including performance predictions, maintenance predictions, uptime/downtime predictions, capacity predictions and the like), ones related to functions or workflows of the facility (such as ones that involved conditions or states that may result in following one or more distinct possible paths within a workflow, a process, or the like), ones related to outputs of the facility, and others. In embodiments, the AI system receives a facility identifier. In response to the facility identifier, the AI system may retrieve attributes corresponding to the facility. In some embodiments, the AI system may obtain the facility attributes from a graph. Additionally or alternatively, the AI system may obtain the facility attributes from a facility record corresponding to the facility identifier, and the person attributes from a person record corresponding to the person identifier.

Examples of additional attributes that can be used to make predictions about a facility or a related process of system include: related facility information; owner goals (including financial goals); client goals; and many more additional or alternative attributes. In embodiments, the AI system may output scores for each possible prediction, where each prediction corresponds to a possible outcome. For example, in using a prediction model used to determine a likelihood that a hydroelectric source for a facility will produce 5 MW of power, the prediction model can output a score for a “will produce” outcome and a score for a “will not produce” outcome. The AI system may then select the outcome with the highest score as the prediction. Alternatively, the AI system may output the respective scores to a requesting system.

### Intelligence Services System

FIG. 3 illustrates an example intelligence system 300 (also referred to as “intelligence services,” an “intelligence services system,” or an “intelligence system”) according to some embodiments of the present disclosure. In embodiments, the intelligence system 300 provides a framework for providing intelligence services to one or more intelligence service clients 336. In some embodiments, the intelligence system 300 framework may be adapted to be at least partially replicated in respective intelligence clients 336 (e.g., an enterprise access layer, a wallet system, a market orchestration system, a digital lending system, an asset-backed tokenization system, and/or the like). In these embodiments, an individual client 336 may include some or all of the capabilities of the intelligence system 300, whereby the intelligence system 300 is adapted for the specific functions performed by the subsystems of the intelligence client. Additionally or alternatively, in some embodiments, the intelligence system 300 may be implemented as a set of microservices, such that different intelligence clients 336 may leverage the intelligence system 300 via one or more APIs exposed to the intelligence clients. In these embodiments, the intelligence system 300 may be configured to perform various types of intelligence services that may be adapted for different intelligence clients 336. In either of these configurations, an intelligence service client 336 may provide an intelligence request to the intelligence system 300, whereby the request is to perform a specific intelligence task (e.g., a decision, a recommendation, a report, an instruction, a classification, a prediction, a training action, an NLP request, or the like). In response, the intelligence system 300 executes the requested intelligence task and returns a response to the intelligence service client 336. Additionally or alternatively, in some embodiments, the intelligence system 300 may be implemented using one or more specialized chips that are configured to provide AI assisted microservices such as image processing, diagnostics, location and orientation, chemical analysis, data processing, and so forth. Examples of AI-enabled chips are discussed elsewhere in the disclosure.

In embodiments, an intelligence system 300 may include an intelligence service controller 302 and artificial intelligence (AI) modules 304. In embodiments, an artificial intelligence system 300 receives an intelligence request from an intelligence service client 336 and any required data to process the request from the intelligence service client 336. In response to the request and the specific data, one or more implicated artificial intelligence modules 304 perform the intelligence task and output an “intelligence response”. Examples of intelligence modules 304 responses may include a decision (e.g., a control instruction, a proposed action, machine-generated text, and/or the like), a prediction (e.g., a predicted meaning of a text snippet, a predicted outcome associated with a proposed action, a predicted fault condition, and/or the like), a classification (e.g., a classification of an object in an image, a classification of a spoken utterance, a classified fault condition based on sensor data, and/or the like), and/or other suitable outputs of an artificial intelligence system.

### Artificial Intelligence Modules

In embodiments, artificial intelligence modules 304 may include an ML module 312, a rules-based module 328, an analytics module 318, an RPA module 316, a digital twin module 320, a machine vision module 322, an NLP module 324, and/or a neural network module 314. It is appreciated that the foregoing are non-limiting examples of artificial intelligence modules, and that some of the modules may be included or leveraged by other artificial intelligence modules. For example, the NLP module 324 and the machine vision module 322 may leverage different neural networks that are part of the neural network module 314 in performance of their respective functions.

It is further noted that in some scenarios, artificial intelligence modules 304 themselves may also be intelligence clients 336. For example, a rules-based module 328 for intelligence may request an intelligence task from an ML module 312 or a neural network module 314, such as requesting a classification of an object appearing in a video and/or a motion of the object. In this example, the rules-based module 328 for intelligence may be an intelligence service client 336 that uses the classification to determine whether to take a specified action. In another example, a machine vision module 322 may request a digital twin of a specified environment from a digital twin module 320, such that the ML module 312 may request specific data from the digital twin as features to train a machine-learned model that is trained for a specific environment.

In embodiments, an intelligence task may require specific types of data to respond to the request. For example, a machine vision task requires one or more images (and potentially other data) to classify objects appearing in an image or set of images, to determine features within the set of images (such as locations of items, presence of faces, symbols or instructions, expressions, parameters of motion, changes in status, and many others), and the like. In another example, an NLP task requires audio of speech and/or text data (and potentially other data) to determine a meaning or other element of the speech and/or text. In yet another example, an AI-based control task (e.g., a decision on movement of a robot) may require environment data (e.g., maps, coordinates of known obstacles, images, and/or the like) and/or a motion plan to make a decision as to how to control the motion of a robot. In a platform-level example, an analytics-based reporting task may require data from a number of different databases to generate a report. Thus, in embodiments, tasks that can be performed by an intelligence system 300 may require, or benefit from, specific intelligence service inputs 332. In some embodiments, an intelligence system 300 may be configured to receive and/or request specific data from the intelligence service inputs 332 to perform a respective intelligence task. Additionally or alternatively, the requesting intelligence service client 336 may provide the specific data in the request. For instance, the intelligence system 300 may expose one or more APIs to the intelligence clients 336, whereby a requesting client 336 provides the specific data in the request via the API. Examples of intelligence service inputs may include, but are not limited to, sensors that provide sensor data, video streams, audio streams, databases, data feeds, human input, and/or other suitable data.

In embodiments, intelligence modules 304 includes and provides access to an ML module 312 that may be integrated into or be accessed by one or more intelligence clients 336. In embodiments, the ML module 312 may provide machine-based learning capabilities, features, functions, and algorithms for use by an intelligence service client 336 such as training ML models, leveraging ML models, reinforcing ML models, performing various clustering techniques, feature extraction, and/or the like. In an example, a machine learning module 312 may provide machine learning computing, data storage, and feedback infrastructure to a simulation system (e.g., as described above). The machine learning module 312 may also operate cooperatively with other modules, such as the rules-based module 328, the machine vision module 322, the RPA module 316, and/or the like.

The machine learning module 312 may define one or more machine learning models for performing analytics, simulation, decision making, and predictive analytics related to data processing, data analysis, simulation creation, and simulation analysis of one or more components or subsystems of an intelligence service client 336. In embodiments, the machine learning models are algorithms and/or statistical models that perform specific tasks without using explicit instructions, relying instead on patterns and inference. The machine learning models build one or more mathematical models based on training data to make predictions and/or decisions without being explicitly programmed to perform the specific tasks. In example implementations, machine learning models may perform classification, prediction, regression, clustering, anomaly detection, recommendation generation, and/or other tasks.

In embodiments, the machine learning models may perform various types of classification based on the input data. Classification is a predictive modeling problem where a class label is predicted for a given example of input data. For example, machine learning models can perform binary classification, multi-class or multi-label classification. In embodiments, the machine-learning model may output “confidence scores” that are indicative of a respective confidence associated with classification of the input into the respective class. In embodiments, the confidence scores can be compared to one or more thresholds to render a discrete categorical prediction. In embodiments, only a certain number of classes (e.g., one) with the relatively largest confidence scores can be selected to render a discrete categorical prediction.

In embodiments, machine learning models may output a probabilistic classification. For example, machine learning models may predict, given a sample input, a probability distribution over a set of classes. Thus, rather than outputting only the most likely class to which the sample input should belong, machine learning models can output, for each class, a probability that the sample input belongs to such class. In embodiments, the probability distribution over all possible classes can sum to one. In embodiments, a Softmax function, or other type of function or layer can be used to turn a set of real values respectively associated with the possible classes to a set of real values in the range (0, 1) that sum to one. In embodiments, the probabilities provided by the probability distribution can be compared to one or more thresholds to render a discrete categorical prediction. In embodiments, only a certain number of classes (e.g., one) with the relatively largest predicted probability can be selected to render a discrete categorical prediction.

In embodiments, machine learning models can perform regression to provide output data in the form of a continuous numeric value. As examples, machine learning models can perform linear regression, polynomial regression, or nonlinear regression. As described, in embodiments, a Softmax function or other function or layer can be used to squash a set of real values respectively associated with a two or more possible classes to a set of real values in the range (0, 1) that sum to one. For example, machine learning models can perform linear regression, polynomial regression, or nonlinear regression. As examples, machine learning models can perform simple regression or multiple regression. As described above, in some implementations, a Softmax function or other function or layer can be used to squash a set of real values respectively associated with a two or more possible classes to a set of real values in the range (0, 1) that sum to one.

In embodiments, machine learning models may perform various types of clustering. For example, machine learning models may identify one or more previously-defined clusters to which the input data most likely corresponds.

In some implementations in which machine learning models performs clustering, machine learning models can be trained using unsupervised learning techniques.

In embodiments, machine learning models may perform anomaly detection or outlier detection. For example, machine learning models can identify input data that does not conform to an expected pattern or other characteristic (e.g., as previously observed from previous input data). As examples, the anomaly detection can be used for fraud detection or system failure detection.

In some implementations, machine learning models can provide output data in the form of one or more recommendations. For example, machine learning models can be included in a recommendation system or engine. As an example, given input data that describes previous outcomes for certain entities (e.g., a score, ranking, or rating indicative of an amount of success or enjoyment), machine learning models can output a suggestion or recommendation of one or more additional entities that, based on the previous outcomes, are expected to have a desired outcome

As described above, machine learning models can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, machine learning models can be or include one or more classifier models such as, for example, linear classification models; quadratic classification models; etc. Machine learning models may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning models can be or include one or more decision tree-based models such as, for example, classification and/or regression trees; chi-squared automatic interaction detection decision trees; decision stumps; conditional decision trees; etc.

Machine learning models may be or include one or more kernel machines. In some implementations, machine learning models can be or include one or more support vector machines. Machine learning models may be or include one or more instance-based learning models such as, for example, learning vector quantization models; self-organizing map models; locally weighted learning models; etc. In some implementations, machine learning models can be or include one or more nearest neighbor models such as, for example, k-nearest neighbor classifications models; k-nearest neighbors regression models; etc. Machine learning models can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

Machine learning models may include one or more clustering models such as, for example, k-means clustering models; k-medians clustering models; expectation maximization models; hierarchical clustering models; etc.

In some implementations, machine learning models can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine learning models can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In embodiments, artificial intelligence modules 304 may include and/or provide access to a neural network module 314. In embodiments, the neural network module 314 is configured to train, deploy, and/or leverage artificial neural networks (or “neural networks”) on behalf of an intelligence service client 336. It is noted that in the description, the term machine learning model may include neural networks, and as such, the neural network module 314 may be part of the machine learning module 312. In embodiments, the neural network module 314 may be configured to train neural networks that may be used by the intelligence clients 336. Non-limiting examples of different types of neural networks may include any of the neural network types described throughout this disclosure and the documents incorporated herein by reference, including without limitation convolutional neural networks (CNN), deep convolutional neural networks (DCN), feed forward neural networks (including deep feed forward neural networks), recurrent neural networks (RNN) (including without limitation gated RNNs), long/short term memory (LTSM) neural networks, and the like, as well as hybrids or combinations of the above, such as deployed in series, in parallel, in acyclic (e.g., directed graph-based) flows, and/or in more complex flows that may include intermediate decision nodes, recursive loops, and the like, where a given type of neural network takes inputs from a data source or other neural network and provides outputs that are included within the input sets of another neural network until a flow is completed and a final output is provided. In embodiments, the neural network module 314 may be leveraged by other artificial intelligence modules 304, such as the machine vision module 322, the NLP module 324, the rules-based module 328, the digital twin module 320, and so on. Example applications of the neural network module 314 are described throughout the disclosure.

A neural network includes a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

In embodiments, the neural networks can be or include one or more feed forward neural networks. In feed forward networks, the connections between nodes do not form a cycle. For example, each connection can connect a node from an earlier layer to a node from a later layer.

In embodiments, the neural networks can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of the input data sequence to a subsequent portion of the input data sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc. In some example embodiments, recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, neural networks can be or include one or more non-recurrent sequence-to-sequence models based on self-attention, such as Transformer networks. Details of an exemplary transformer network can be found at http://papers.nips.cc/paper/7181-attention-is-all-you-need.pdf.

In embodiments, the neural networks can be or include one or more convolutional neural networks. In some instances, a convolutional neural network can include one or more convolutional layers that perform convolutions over input data using learned filters. Filters can also be referred to as kernels. Convolutional neural networks can be especially useful for vision problems such as when the input data includes imagery such as still images or video.

However, convolutional neural networks can also be applied for natural language processing.

In embodiments, the neural networks can be or include one or more generative networks such as, for example, generative adversarial networks. Generative networks can be used to generate new data such as new images or other content.

In embodiments, the neural networks may be or include autoencoders. In some instances, the aim of an autoencoder is to learn a representation (e.g., a lower-dimensional encoding) for a set of data, typically for the purpose of dimensionality reduction. For example, in some instances, an autoencoder can seek to encode the input data and then provide output data that reconstructs the input data from the encoding. Recently, the autoencoder concept has become more widely used for learning generative models of data. In some instances, the autoencoder can include additional losses beyond reconstructing the input data.

In embodiments, the neural networks may be or include one or more other forms of artificial neural networks such as, for example, deep Boltzmann machines; deep belief networks; stacked autoencoders; etc. Any of the neural networks described herein can be combined (e.g., stacked) to form more complex networks.

FIG. 4 illustrates an example neural network with multiple layers. Neural network 340 may include an input layer, a hidden layer, and an output layer with each layer comprising a plurality of nodes or neurons that respond to different combinations of inputs from the previous layers. The connections between the neurons have numeric weights that determine how much relative effect an input has on the output value of the node in question. Input layer may include a plurality of input nodes 342, 344, 346, 348 and 350 that may provide information from the outside world or input data (e.g., sensor data, image data, text data, audio data, etc.) to the neural network 340. The input data may be from different sources and may include library data x1, simulation data x2, user input data x3, training data x4 and outcome data x5. The input nodes 342, 344, 346, 348 and 350 may pass on the information to the next layer, and no computation may be performed by the input nodes. Hidden layers may include a plurality of nodes, such as nodes 352, 354, and 356. The nodes 352, 354, and 356 in the hidden layer may process the information from the input layer based on the weights of the connections between the input layer and the hidden layer and transfer information to the output layer. Output layers may include an output node 358 which processes information based on the weights of the connections between the hidden layer and the output layer and is responsible for computing and transferring information as an output 359 from the network to the outside world, such as recognizing certain objects or activities, or predicting a condition or an action.

In embodiments, a neural network 340 may include two or more hidden layers and may be referred to as a deep neural network. The layers are constructed so that the first layer detects a set of primitive patterns in the input (e.g., image) data, the second layer detects patterns of patterns and the third layer detects patterns of those patterns. In some embodiments, a node in the neural network 340 may have connections to all nodes in the immediately preceding layer and the immediate next layer. Thus, the layers may be referred to as fully-connected layers. In some embodiments, a node in the neural network 340 may have connections to only some of the nodes in the immediately preceding layer and the immediate next layer. Thus, the layers may be referred to as sparsely-connected layers. Each neuron in the neural network consists of a weighted linear combination of its inputs and the computation on each neural network layer may be described as a multiplication of an input matrix and a weight matrix. A bias matrix is then added to the resulting product matrix to account for the threshold of each neuron in the next level. Further, an activation function is applied to each resultant value, and the resulting values are placed in the matrix for the next layer. Thus, the output from a node i in the neural network may be represented as:

$$y i = f ( \sum x i w i + b i )$$

where f is the activation function, Σxiwi is the weighted sum of input matrix and bi is the bias matrix.

The activation function determines the activity level or excitation level generated in the node as a result of an input signal of a particular size. The purpose of the activation function is to introduce non-linearity into the output of a neural network node because most real-world functions are non-linear and it is desirable that the neurons can learn these non-linear representations. Several activation functions may be used in an artificial neural network. One example activation function is the sigmoid function σ(x), which is a continuous S-shaped monotonically increasing function that asymptotically approaches fixed values as the input approaches plus or minus infinity. The sigmoid function σ(x) takes a real-valued input and transforms it into a value between 0 and 1:

$$σ ( x ) = 1 / ( 1 + exp ( - x ) ) .$$

Another example activation function is the tanh function, which takes a real-valued input and transforms it into a value within the range of [−1, 1]:

$$tanh ( x ) = 2 σ ( 2 x ) - 1$$

A third example activation function is the rectified linear unit (ReLU) function. The ReLU function takes a real-valued input and thresholds it above zero (i.e., replacing negative values with zero):

$$f ( x ) = max ( 0 , x ) .$$

It will be apparent that the above activation functions are provided as examples and in various embodiments, neural network 340 may utilize a variety of activation functions including (but not limited to) identity, binary step, logistic, soft step, tan h, arctan, softsign, rectified linear unit (ReLU), leaky rectified linear unit, parameteric rectified linear unit, randomized leaky rectified linear unit, exponential linear unit, s-shaped rectified linear activation unit, adaptive piecewise linear, softplus, bent identity, soft exponential, sinusoid, sine, gaussian, softmax, maxout, and/or a combination of activation functions.

In the example shown in FIG. 4, nodes 342, 344, 346, 348 and 350 in the input layer may take external inputs x1, x2, x3, x4 and x5 which may be numerical values depending upon the input dataset. It will be understood that even though only five inputs are shown in FIG. 4, in various implementations, a node may include tens, hundreds, thousands, or more inputs. As discussed above, no computation is performed on the input layer and thus the outputs from nodes 342, 344, 346, 348 and 350 of input layer are x1, x2, x3, x4 and x5 respectively, which are fed into hidden layer. The output of node 352 in the hidden layer may depend on the outputs from the input layer (x1, x2, x3, x4 and x5) and weights associated with connections (w1, w2, w3, w4 and w5). Thus, the output from node 352 may be computed as:

$${Y}_{352} = f ( x 1 w 1 + x 2 w 2 + x 3 w 3 + x 4 w 4 + x 5 w 5 + {b}_{352} ) .$$

The outputs from the nodes 354 and 356 in the hidden layer may also be computed in a similar manner and then be fed to the node 358 in the output layer. Node 358 in the output layer may perform similar computations (using weights v1, v2 and v3 associated with the connections) as the nodes 352, 354 and 356 in the hidden layers:

$${Y}_{358} = f ( {y}_{352} v 1 + {y}_{354} v 2 + {y}_{356} v 3 + {b}_{358} ) ;$$

where Y₃₄₀ is the output of the neural network 340.

As mentioned, the connections between nodes in the neural network have associated weights, which determine how much relative effect an input value has on the output value of the node in question. Before the network is trained, random values are selected for each of the weights. The weights are adjusted during the training process and this adjustment of weights to determine the best set of weights that maximize the accuracy of the neural network is referred to as training. For every input in a training dataset, the output of the artificial neural network may be observed and compared with the expected output, and the error between the expected output and the observed output may be propagated back to the previous layer. The weights may be adjusted accordingly based on the error. This process is repeated until the output error is below a predetermined threshold.

In embodiments, backpropagation (e.g., backward propagation of errors) is utilized with an optimization method such as gradient descent to adjust weights and update the neural network characteristics. Backpropagation may be a supervised training scheme that learns from labeled training data and errors at the nodes by changing parameters of the neural network to reduce the errors. For example, a result of forward propagation (e.g., output activation value(s)) determined using training input data is compared against a corresponding known reference output data to calculate a loss function gradient. The gradient may be then utilized in an optimization method to determine new updated weights in an attempt to minimize a loss function. For example, to measure error, the mean square error is determined using the equation:

$$E = {( target - output )}^{2} \qquad ( eq . 1 )$$

To determine the gradient for a weight “w,” a partial derivative of the error with respect to the weight may be determined, where:

$$gradient = \partial E / \partial w \qquad ( eq . 2 )$$

The calculation of the partial derivative of the errors with respect to the weights may flow backwards through the node levels of the neural network. Then a portion (e.g., ratio, percentage, etc.) of the gradient is subtracted from the weight to determine the updated weight. The portion may be specified as a learning rate “a.” Thus an example equation of determining the updated weight is given by the formula:

$${w}_{new} = {w}_{old} - α \partial E / \partial w \qquad ( eq . 3 )$$

The learning rate must be selected such that it is not too small (e.g., a rate that is too small may lead to a slow convergence to the desired weights) and not too large (e.g., a rate that is too large may cause the weights to not converge to the desired weights).

After the weight adjustment, the network should perform better than before for the same input because the weights have now been adjusted to minimize the errors.

As mentioned, neural networks may include convolutional neural networks (CNN). A CNN is a specialized neural network for processing data having a known, grid-like topology, such as image data. Accordingly, CNNs are commonly used for classification, object recognition and computer vision applications, but they also may be used for other types of pattern recognition such as speech and language processing.

A convolutional neural network learns highly non-linear mappings by interconnecting layers of artificial neurons arranged in many different layers with activation functions that make the layers dependent. It includes one or more convolutional layers, interspersed with one or more sub-sampling layers and non-linear layers, which are typically followed by one or more fully connected layers.

Referring to FIG. 5, a CNN 360 includes an input layer with an input image 362 to be classified by the CNN 360, a hidden layer which in turn includes one or more convolutional layers, interspersed with one or more activation or non-linear layers (e.g., ReLU) and pooling or sub-sampling layers and an output layer—typically including one or more fully connected layers. Input image 362 may be represented by a matrix of pixels and may have multiple channels. For example, a colored image may have a red, a green, and blue channels each representing red, green, and blue (RGB) components of the input image. Each channel may be represented by a 2-D matrix of pixels having pixel values in the range of 0 to 255. A gray-scale image on the other hand may have only one channel. The following section describes processing of a single image channel using CNN 360. It will be understood that multiple channels may be processed in a similar manner.

As shown, input image 362 may be processed by the hidden layer, which includes sets of convolutional and activation layers 364 and 368, each followed by pooling layers 366 and 370.

The convolutional layers of the convolutional neural network serve as feature extractors capable of learning and decomposing the input image into hierarchical features. The convolution layers may perform convolution operations on the input image where a filter (also referred as a kernel or feature detector) may slide over the input image at a certain step size (referred to as the stride). For every position (or step), element-wise multiplications between the filter matrix and the overlapped matrix in the input image may be calculated and summed to get a final value that represents a single element of an output matrix constituting a feature map. The feature map refers to image data that represents various features of the input image data and may have smaller dimensions as compared to the input image. The activation or non-linear layers use different non-linear trigger functions to signal distinct identification of likely features on each hidden layer. Non-linear layers use a variety of specific functions to implement the non-linear triggering, including the rectified linear units (ReLUs), hyperbolic tangent, absolute of hyperbolic tangent and sigmoid functions. In one implementation, a ReLU activation implements the function y=max(x, 0) and keeps the input and output sizes of a layer the same. The advantage of using ReLU is that the convolutional neural network is trained many times faster. ReLU is a non-continuous, non-saturating activation function that is linear with respect to the input if the input values are larger than zero and zero otherwise.

As shown in FIG. 5, the first convolution and activation layer 364 may perform convolutions on input image 362 using multiple filters followed by non-linearity operation (e.g., ReLU) to generate multiple output matrices (or feature maps) 372. The number of filters used may be referred to as the depth of the convolution layer. Thus, the first convolution and activation layer 364 in the example of FIG. 5 has a depth of three and generates three feature maps using three filters. Feature maps 372 may then be passed to the first pooling layer that may sub-sample or down-sample the feature maps using a pooling function to generate output matrix 374. The pooling function replaces the feature map with a summary statistic to reduce the spatial dimensions of the extracted feature map thereby reducing the number of parameters and computations in the network. Thus, the pooling layer reduces the dimensionality of the feature maps while retaining the most important information. The pooling function can also be used to introduce translation invariance into the neural network, such that small translations to the input do not change the pooled outputs. Different pooling functions may be used in the pooling layer, including max pooling, average pooling, and l2-norm pooling.

Output matrix 374 may then be processed by a second convolution and activation layer 368 to perform convolutions and non-linear activation operations (e.g., ReLU) as described above to generate feature maps 376. In the example shown in FIG. 5, second convolution and activation layer 368 may have a depth of five. Feature maps 376 may then be passed to a pooling layer 370, where feature maps 376 may be subsampled or down-sampled to generate an output matrix 378.

Output matrix 378 generated by pooling layer 370 is then processed by one or more fully connected layer 380 that forms a part of the output layer of CNN 360. The fully connected layer 380 has a full connection with all the feature maps of the output matrix 378 of the pooling layer 370. In embodiments, the fully connected layer 380 may take the output matrix 378 generated by the pooling layer 370 as the input in vector form, and perform high-level determination to output a feature vector containing information of the structures in the input image. In embodiments, the fully-connected layer 380 may classify the object in input image 362 into one of several categories using a Softmax function. The Softmax function may be used as the activation function in the output layer and takes a vector of real-valued scores and maps it to a vector of values between zero and one that sum to one. In embodiments, other classifiers, such as a support vector machine (SVM) classifier, may be used.

In embodiments, one or more normalization layers may be added to the CNN 360 to normalize the output of the convolution filters. The normalization layer may provide whitening or lateral inhibition, avoid vanishing or exploding gradients, stabilize training, and enable learning with higher rates and faster convergence. In embodiments, the normalization layers are added after the convolution layer but before the activation layer.

CNN 360 may thus be seen as multiple sets of convolution, activation, pooling, normalization and fully connected layers stacked together to learn, enhance and extract implicit features and patterns in the input image 362. A layer as used herein, can refer to one or more components that operate with similar function by mathematical or other functional means to process received inputs to generate/derive outputs for a next layer with one or more other components for further processing within CNN 360.

The initial layers of CNN 360 e.g., convolution layers, may extract low level features such as edges and/or gradients from the input image 362. Subsequent layers may extract or detect progressively more complex features and patterns such as presence of curvatures and textures in image data and so on. The output of each layer may serve as an input of a succeeding layer in CNN 360 to learn hierarchical feature representations from data in the input image 362. This allows convolutional neural networks to efficiently learn increasingly complex and abstract visual concepts.

Although only two convolution layers are shown in the example, the present disclosure is not limited to the example architecture, and CNN 360 architecture may comprise any number of layers in total, and any number of layers for convolution, activation and pooling. For example, there have been many variations and improvements over the basic CNN model described above. Some examples include Alexnet, GoogLeNet, VGGNet (that stacks many layers containing narrow convolutional layers followed by max pooling layers), Residual network or ResNet (that uses residual blocks and skip connections to learn residual mapping), DenseNet (that connects each layer of CNN to every other layer in a feed-forward fashion), Squeeze and excitation networks (that incorporate global context into features) and AmobeaNet (that uses evolutionary algorithms to search and find optimal architecture for image recognition).

### Training of Convolutional Neural Network

The training process of a convolutional neural network, such as CNN 360, may be similar to the training process discussed in FIG. 4 with respect to neural network 340.

In embodiments, all parameters and weights (including the weights in the filters and weights for the fully-connected layer are initially assigned (e.g., randomly assigned). Then, during training, a training image or images, in which the objects have been detected and classified, are provided as the input to the CNN 360, which performs the forward propagation steps. In other words, CNN 360 applies convolution, non-linear activation, and pooling layers to each training image to determine the classification vectors (i.e., detect and classify each training image). These classification vectors are compared with the predetermined classification vectors. The error (e.g., the squared sum of differences, log loss, softmax log loss) between the classification vectors of the CNN and the predetermined classification vectors is determined. This error is then employed to update the weights and parameters of the CNN in a backpropagation process which may use gradient descent and may include one or more iterations. The training process is repeated for each training image in the training set.

The training process and inference process described above may be performed on hardware, software, or a combination of hardware and software. However, training a convolutional neural network like CNN 360 or using the trained CNN for inference generally requires significant amounts of computation power to perform, for example, the matrix multiplications or convolutions. Thus, specialized hardware circuits, such as graphic processing units (GPUs), tensor processing units (TPUs), neural network processing units (NPUs), FPGAs, ASICs, or other highly parallel processing circuits may be used for training and/or inference. Training and inference may be performed on a cloud, on a data center, or on a device.

### Region Based CNNs (RCNNs) and Object Detection

In embodiments, an object detection model extends the functionality of CNN based image classification neural network models by not only classifying objects but also determining their locations in an image in terms of bounding boxes. Region-based CNN (R-CNN) methods are used to extract regions of interest (ROI), where each ROI is a rectangle that may represent the boundary of an object in image. Conceptually, R-CNN operates in two phases. In a first phase, region proposal methods generate all potential bounding box candidates in the image. In a second phase, for every proposal, a CNN classifier is applied to distinguish between objects. Alternatively, a fast R-CNN architecture can be used, which integrates the feature extractor and classifier into a unified network. Another faster R-CNN can be used, which incorporates a Region Proposal Network (RPN) and fast R-CNN into an end-to-end trainable framework. Mask R-CNN adds instance segmentation, while mesh R-CNN adds the ability to generate a 3D mesh from a 2D image.

Referring back to FIG. 3, in embodiments, the artificial intelligence modules 304 may provide access to and/or integrate a robotic process automation (RPA) module 316. The RPA module 316 may facilitate, among other things, computer automation of producing and validating workflows. The RPA module 316 provides automation of tasks performed by humans, such as receiving and reviewing written information, entering data into user interfaces, converting or otherwise processing data such as files or records, recording observations, generating documents such as reports, and communicating with other users by mechanisms such as email. In some cases, the tasks involve a workflow that includes a number of interrelated steps, contextual information that relates to the task, and interactions with other applications and humans. The RPA module 316 can be configured to receive or learn one or more such workflows on behalf of the human and in a manner similar to the actions and logic of the human, and can thereafter perform such workflows in response to various triggers such as events. Examples of RPA modules 316 may encompass those in this disclosure and in the documents incorporated by reference herein and may involve automation of any of the wide range of value chain network activities or entities described therein.

In embodiments, an RPA module 316 is configured to receive or learn a robotic process automation workflow in a variety of ways. As a first example, in embodiments, the RPA module 316 can include a graphical user interface (GUI) that enables a user to specify the details of the robotic process automation workflow. The GUI can include components that represent different types of actions, such as an action of receiving input from a user or application, an action of converting or otherwise processing data, and an action of providing input to an application. The GUI can receive, from the user, a selection of components representing actions that correspond to the steps of the workflow when performed by a human. The GUI can also receive, from the user, an interconnection of the selected components, such as a logical order in which the corresponding actions are to be performed, or a dependency of one component upon another component (e.g., a first component can output data that is received as input by another component). The GUI can include one or more templates, such as one or more sequences of actions that are performed together to complete a common workflow. The GUI can receive, from the user, a selection of a template, optionally including one or more details that adapt the selected template to a particular workflow performed by the human. Based on the input received from the user, the RPA module 316 can generate a robotic process automation workflow that can be executed to perform the workflow. The RPA module 316 can store the generated workflow for future use. For example, the RPA module 316 can execute the compiled code or interpret the generated script to perform the workflow in a similar manner as performed by the human.

As a second example, in embodiments, an RPA module 316 is configured to receive or learn a workflow based on a set of rules. For example, the RPA module 316 can include a GUI that enables a user to specify the details of the robotic process automation workflow as a set of conditions and responsive actions. The GUI includes a set of components that respond to conditions to be monitored, such as a status of a resource or an occurrence of an event. The GUI for designing the workflows can include a set of components that represent actions to be taken in response to an occurrence of one of the conditions. The GUI can receive, from the user, a selection of components representing one or more of the conditions of a workflow, and a selection of one or more components representing the actions to be taken in response to the conditions. In some embodiments, the GUI can include one or more templates, such as one or more conditions associated with one or more actions that correspond to a common workflow. The GUI can receive, from the user, a selection of one of the templates, including one or more details that adapt the selected template to a particular workflow performed by the human. Based on the input received from the user, the RPA module 316 can generate a robotic process automation workflow that automates a set of tasks in response to one or more detected events. The RPA module 316 can store the generated workflow for future use. For example, the RPA module 316 can monitor the selected conditions and perform the selected actions in response to an occurrence of the selected actions, in a similar manner as performed by the human.

As a third example, in embodiments, an RPA module 316 is configured to learn a workflow by recording a set of actions performed by a human to complete the workflow. For example, the RPA module 316 can receive, from the user, an indication of a start of the workflow involving a device, such as a selection of a Start Recording button. The RPA module 316 can receive user input from the user, such as input to one or more human interaction devices (HIDs) such as a keyboard, a mouse, a touchscreen, a camera, or a microphone. Alternatively or additionally, the RPA module 316 can receive user input as a series of human interaction events reported by a device, such as an input layer of an operating system that receives and aggregates user input from one or more human input devices. Alternatively or additionally, the RPA module 316 can receive user input as a series of events reported by one or more applications, such as a web browser that reports a set of user input events. The RPA module 316 can record the user input as a sequence of inputs. The RPA module 316 can associate the recorded user input with contextual information, such as an identification of the application to which the user input was directed. The RPA module 316 can associate the recorded user input with other events, such as preceding events of an application that receives the user input (e.g., an indication by a web browser that a web page has been rendered and is available to receive user input) and/or responsive events of the application in response to receiving the user input (e.g., an action performed by a web page in response to receiving user input). The RPA module 316 can associate the recorded user input with other events occurring within the device, such as an action performed by another application or an operating system of the device in response to the user input. The RPA module 316 can receive, from the user, an indication of an end of the workflow, such as a selection of a Stop Recording button. The RPA module 316 can generate a workflow that includes a record of the observed user input, optionally in association with other data. The RPA module 316 can store the generated workflow for future use. For example, the RPA module 316 can replay the sequence of recorded user input to perform the workflow in a similar manner as performed by the human.

As a fourth example, in embodiments, an RPA module 316 is configured to learn a workflow by watching an interaction between a human and a device. For example, a human can perform a number of workflows using the device over a period of time, such as a business day. The RPA module 316 can monitor the user input of the human and can identify, in the user input, one or more patterns of actions that are repeatedly performed by the human. The RPA module 316 can determine that a pattern of actions corresponds to a workflow performed by the human. In some embodiments, the RPA module 316 can identify variations among various instances of the actions when performed by the human during the workflow, such as different types of data entry that occur in different instances of the actions.

The RPA module 316 can associate an action in the workflow with one or more parameters, wherein the parameters correspond to the different variations among the various instances of the action when performed by the human. In various embodiments, the RPA module 316 can determine a basis of each of the variations of the action that are associated with different variations of the action in the workflow. For example, the RPA module 316 can determine that when the workflow is performed by the human on behalf of a first user, the action is to be performed with a first data entry value, such as data entry including the name of the first user. When the workflow is performed by the human on behalf of a second user, the action is to be performed with a second data entry value, such as data entry including the name of the second user. The data entry can be represented in the workflow as a data entry parameter (e.g., a name of a user on whose behalf the workflow is performed), optionally with specific values that correspond to a context of the workflow (e.g., the names of the users on whose behalf the workflow can be performed). The RPA module 316 can generate a workflow that includes a sequence of commands that correspond to the pattern of actions performed by the user during the workflow, and, optionally, the parameters and/or parameter values of various actions of the workflow. The RPA module 316 can store the generated workflow for future use. For example, the RPA module 316 can replay the sequence of commands to replicate the pattern of actions that correspond to the workflow when performed in a similar manner as by the human.

In embodiments, the RPA module 316 can be implemented in a variety of architectures. As a first example, the RPA module 316 can be implemented on the same device as a human uses to perform a workflow, and/or that a user uses to specify the details of a workflow. The RPA module 316 can store one or more generated workflows on the device, and can perform the workflow on the same device. As a second example, the RPA module 316 can be implemented on a first device to replicate a workflow performed by a human on a second device. The RPA module 316 can monitor the interaction of the human with the second device while performing a task, generate and store a workflow on the first device, and execute the workflow on the first device to perform the task on the first device in a similar manner as performed by the user on the second device. As a third example, the RPA module 316 can be implemented on a first device to generate a workflow that corresponds to a task performed by the human on the first device, and can transmit the workflow to a second device. The workflow can cause the second device to perform the task on the second device in a similar manner as performed by the user on the first device. As a fourth example, the RPA module 316 can be implemented on a second device to receive a workflow that corresponds to a task performed by the human on a first device. The RPA module 316 workflow can execute the workflow on the second device to perform the task on the second device in a similar manner as performed by the user on the first device. In some embodiments, the RPA module 316 can be distributed over a set of two or more devices, such as a first portion of the RPA module 316 that executes on a first device to generate a workflow based on an interaction between a human and the first device, and a second portion of the RPA module 316 that executes on a second device to perform the workflow on the second device. In some embodiments, at least a portion of the RPA module 316 can be replicated over a plurality of devices, such as two or more devices that each perform (e.g., concurrently and/or consecutively) a workflow that was generated based on an interaction between a human and a first device. In some embodiments, different RPA modules 316 executing on each of a plurality of devices can interact to execute one or more workflows (e.g., a first RPA module 316 that executes on a first device to perform a first portion of a workflow, and a second RPA module 316 that executes on a second device to perform a second portion of the same workflow). Each RPA module 316 can operate in a particular role while performing at least a portion of a workflow, such as a first RPA module 316 that executes on a cloud edge device to receive an input of a workflow, a second RPA module 316 that executes on a cloud server to process the input of the workflow, and a third RPA module 316 that executes on another cloud edge device to present an output of the workflow.

In embodiments, an RPA module 316 can perform a workflow in response to a variety of triggers. The RPA module 316 can perform a workflow in response to a request of a user, such as a request to execute code or run a particular script in order to perform a learned workflow. The RPA module 316 can perform a workflow in response to a detection of a pattern of activity by a human (e.g., a second workflow that is to be performed by the RPA module 316 in response to a completion of a first workflow by a human). The RPA module 316 can perform at least a portion of a workflow in lieu of a human performing at least a portion of the workflow. For example, the RPA module 316 can detect a start of a workflow by a human, and can suggest to the human that the RPA module 316 perform the rest of the workflow. Upon receiving an acceptance of the suggestion, the RPA module 316 can perform the entire workflow in lieu of the human, and/or one or more remaining steps of the workflow following the initial steps performed by the human. The RPA module 316 can perform a workflow in response to an occurrence of a type of data (e.g., the device receiving a file that includes particular data type, such as a particular type of document or a particular type of image). The RPA module 316 can perform a workflow in response to receiving a message through a communication channel such as email, telephone, text message, gesture input received by a camera or haptic input device, or voice input received by a microphone. The RPA module 316 can perform a workflow in response to receiving a request from an operating system or an application executing on the device (e.g., a request from a spreadsheet application in response to a user entering a certain type of data). The RPA module 316 can perform a workflow in response to a detected event. For example, when a device recognizes a presence of a particular human (e.g., when a camera of a device recognizes a face of the human), the RPA module 316 can perform a workflow that involves displaying a report for the human. The RPA module 316 can perform a workflow at a scheduled interval, such as once per hour or once per day. The RPA module 316 can perform a workflow in response to a request received from another workflow executed on the same device or another device (e.g., a second workflow that is to be performed upon completion of a first workflow).

In embodiments, an RPA module 316 can perform a workflow based on a variety of inputs. The RPA module 316 can perform a workflow based on one or more details of a trigger of the workflow. For example, if the workflow is being performed in response to a request of a user to perform the workflow, the RPA module 316 can perform the workflow based on one or more details of the request. For example, if the workflow was triggered by a request of a user to process a particular document, the RPA module 316 can perform the workflow based on one or more details of the document. If the workflow is being performed in response to a message or telephone call, the RPA module 316 can perform the workflow based on an identity of the sender of the message or the identity of the caller. If the workflow is being performed as a daily instance based on a schedule, the RPA module 316 can perform the workflow based on the day of the week on which the workflow is being performed. If a workflow is being performed in response to a detection of a condition, the RPA module 316 can perform the workflow based on one or more details of the condition. For example, if the condition is a storage capacity of a device that exceeds a storage capacity threshold, the RPA module 316 can perform the workflow based on a severity of the storage capacity condition (e.g., a remaining storage capacity of the device). The RPA module 316 can perform a workflow based on a data source, such as one or more files of a file system, one or more rows or records of a database, or one or more messages received by a network interface. If the RPA module 316 is performing a workflow in response to one or more events, the RPA module 316 can perform the workflow based on one or more details of the event. For example, if the RPA module 316 is performing a second workflow in response to a completion of a first workflow on the same device or another device, the RPA module 316 can perform the workflow based on a date or time of the completion of the first workflow, a result of the first workflow, and/or an output of the first workflow. The RPA module 316 can perform a workflow based on one or more contextual details. For example, the RPA module 316 can perform a workflow based on a detected number and identities of humans who are present in the proximity of a device. The RPA module 316 can perform a workflow based on data associated with an application executing on the device. For example, if the RPA module 316 performs the workflow based on a loading of a web page, the RPA module 316 can perform the workflow based on data scraped from the contents of the web page. The RPA module 316 can perform the workflow based on observation of human actions that involve interactions with hardware elements, with software interfaces, and with other elements.

Observations may include field observations as humans perform real tasks, as well as observations of simulations or other activities in which a human performs an action with the explicit intent to provide a training data set or input for the RPA module 316, such as where a human tags or labels a training data set with features that assist the RPA module 316 in learning to recognize or classify features or objects, among many other examples.

In embodiments, an RPA module 316 can interact with one or more applications while performing the workflow. For example, the RPA module 316 can extract data from a variable or an object of an application, such as text content of a textbox in a web form or the contents of cells in a spreadsheet. The RPA module 316 can extract data stored within an application (e.g., by inspecting a memory space of the application). The RPA module 316 can analyze data generated as output by the application (e.g., one or more files generated by the application, one or more rows or records of a spreadsheet generated by the application, or one or more network communication messages received and/or transmitted by the application over a network). The RPA module 316 can invoke an application programming interface (API) of the application to request data from the application, and can receive and analyze data provided by the application in response to the invocation of the API. The RPA module 316 can examine one or more properties of the device on which the application is executing (e.g., a portion of a display of the devices that includes a graphical user interface of the application) to extract data from the application. Alternatively or additionally, the RPA module 316 can provide data to an application and/or modify a behavior of an application while performing the workflow. For example, the RPA module 316 can generate user input that is directed to an application (e.g., simulating a human interaction device (HID), such as a keyboard, to generate keystrokes that are delivered to the application as user input). The RPA module 316 can directly transmit and/or modify data of the application (e.g., altering HTML data stored in a rendered web page to modifying the contents of the textbox, or directly modifying data in the memory space of an application). The RPA module 316 can request the operating system to interact with and/or modify the behavior of an application (e.g., requesting that the device start, activate, suspend, resume, close, or terminate an application). The RPA module 316 can invoke an API of the application to provide data to the application (e.g., invoking an API of a spreadsheet to request the entry of data into a particular cell). The RPA module 316 can invoke code associated with an application to provide data and/or modify the behavior of the application (e.g., executing code that is encoded in an application-specific programming language and embedded in a document used by an application or invoking a stored procedure of a database associated with the application). The RPA module 316 can cause or allow an interaction with an application to be visible to a human (e.g., the RPA module 316 can provide user input that simulates a user visually activating a spreadsheet application and visually typing data into various cells of the spreadsheet application). The RPA module 316 can hide an interaction with an application from a human (e.g., visually hiding a window of an application while entering data into one or more textboxes of the window of the application).

In embodiments, an RPA module 316 can utilize a variety of logical processes while performing a workflow.

The RPA module 316 can retrieve, interpret, analyze, convert, validate, aggregate, partition, render, store, and/or otherwise process data that was received and/or is associated with the workflow. The RPA module 316 can transmit the data to another workflow, application, or device for processing or storage, and/or can query or receive the data from another workflow, application, or device. The RPA module 316 can apply an optical character recognition (OCR) process to an image (e.g., a picture of a form or a document) to determine and extract text content from the image. The RPA module 316 can apply a computer vision process to an image (e.g., a photograph captured by a camera) to determine and extract image data from the image, such as detecting, recognizing, classifying, and/or localizing one or more objects. The RPA module 316 can apply a speech recognition process to a sound input (e.g., a voice input from a telephone call or a microphone) to determine and extract voice content from the image, such as one or more voice commands. The RPA module 316 can apply a gesture recognition process to an input device (e.g., a camera, proximity sensor, or inertial measurement unit that detects movement of a hand) to determine one or more gestures performed by a human. The RPA module 316 can apply a pattern recognition process to data to detect one or more patterns in the data (e.g., analyzing sensor data from a machine to detect one or more occurrences of an event associated with the machine, such as a movement of a moving part of the machine).

In embodiments, the RPA module 316 performs a workflow in cooperation with a human or another workflow.

For example, a workflow can include one or more human portions to be performed by a human and one or more automated portions to be performed by the RPA module 316. The RPA module 316 can first perform an automated portion and deliver a result of the automated portion to the human so that the human can perform a human portion based on the result. The RPA module 316 can receive a result of a human portion of the workflow and can perform an automated portion of the workflow on the result of the human portion of the workflow. The RPA module 316 can perform the automated portion of the workflow concurrently with a human performing a human portion of the workflow, and can then combine a result of the automated portion of the workflow with a result of the human portion of the workflow. The RPA module 316 can perform a first automated portion of the workflow, present a result of the first automated portion to a human for review and validation, and can perform a second automated portion of the workflow based on the review and validation of the result of the first automated portion based on a result of the review and validation by the human.

In embodiments, an RPA module 316 may learn to perform certain tasks based on the learned patterns and processes. The RPA module 316 can use one or more artificial intelligence modules 304 to perform one or more steps of a workflow. For example, an RPA module 316 can perform a data classification step on input data by applying a classification neural network to the input data. An RPA module 316 can perform a pattern recognition step on input data by applying a pattern recognition neural network to the input data. An RPA module 316 can perform a computer vision processing step and/or an optical character recognition step of a workflow by applying one or CNNs 360 to an image. An RPA module 316 can perform a sequential analysis step involving time series data by applying one or more recurrent neural networks (RNNs) to the time series data. An RPA module 316 can perform one or more natural language processing steps on a natural-language expression (e.g., a natural-language document or a natural-language voice input) by applying one or more transformer-based neural networks to the natural-language expression.

In various embodiments, the RPA module 316 uses one or more artificial intelligence modules 304 that are untrained. For example, the one or more artificial intelligence modules 304 can include a k-nearest-neighbor model that determines a classification of a received input based on a proximity of the received input to a collection of other inputs with known classifications. The k-nearest-neighbor model then classifies the received input according to a majority of the known classifications of the determined k inputs that are closest to the received input.

In various embodiments, the RPA module 316 uses one or more artificial intelligence modules 304 that are trained in an unsupervised manner. For example, the workflow can include an anomaly detection step, such as determining a portion of a form that includes handwritten text. An anomaly detection algorithm can partition the form into a collection of symbols, and can compare the symbols to distinguish between symbols that occur with a high frequency (e.g., machine-printed characters in a font) from symbols that occur with a low frequency (e.g., hand-printed characters that are unique or at least highly variable). The anomaly detection algorithm can therefore partition the form into regions that include machine-printed characters and regions that include hand-printed characters. The RPA module 316 can then process each region of the document with either an OCR module that is configured to recognize machine-printed characters in a font or an OCR module that is configured to recognize hand-printed characters.

In various embodiments, the RPA module 316 uses one or more artificial intelligence modules 304 that are specifically designed and/or trained for the workflow. For example, the workflow can be associated with a training data set, and the RPA module 316 can train one or more machine learning models to perform the processing of the workflow based on the training data set. In various embodiments, the RPA module 316 uses one or more pretrained artificial intelligence modules 304 to perform the processing of the workflow. For example, the RPA module 316 can receive a partially pretrained natural language processing (NLP) machine learning model that is generally trained to recognize sentence structure and word meaning. The RPA module 316 can adapt the partially pretrained NLP machine learning model based on natural-language expressions that are more specifically associated with the workflow. The adaptation can involve applying transfer learning to an artificial intelligence module 304 (e.g., more specifically training one or more classification layers in a classification portion of the NLP machine learning model while holding other portions of the NLP machine learning model constant). The adaptation can involve retraining an artificial intelligence module 304 (e.g., retraining an entirety of an NLP machine learning model based on natural-language expressions that are associated with a workflow). The adaptation can involve generating an ensemble of artificial intelligence modules 304 to perform the workflow (e.g., two or more artificial intelligence modules 304, each of which performs classification of data in a different way, wherein an output classification of the workflow is based on a consensus of the two or more artificial intelligence modules 304). The artificial intelligence modules 304 can include a random forest, in which each of one or more decision trees analyses an input data according to different criteria, and an output of the random forest is based on a consensus of the decision trees. The artificial intelligence modules 304 can include a stacking ensemble, in which each of two or more machine learning models processes data to generate an output, and another machine learning model determines which output, among the outputs of the two or more machine learning models, is to be used as the output of processing the data.

In embodiments, the RPA module 316 generates one or more outputs or results of a workflow. The RPA module 316 can generate, as output, data that can be stored by the device (e.g., as a file in a file system or as a row or record in a database). The RPA module 316 can generate, as output, data that is included in another data set (e.g., text entered into fields of a form, numbers entered into cells of a spreadsheet, or text entered into textboxes of a web page). The RPA module 316 can generate, as output, data that is transmitted to another device (e.g., a submission of form data of a web page to a webserver). The RPA module 316 can generate, as output, data that is communicated to one or more users (e.g., a visual notification of a result displayed for a user of the device, or a message that is transmitted to a user by a communication channel such as email, text message, or voice output). The RPA module 316 can generate, as output, data that modifies a behavior of an application (e.g., a command to start, activate, suspend, resume, close, or terminate an application). The RPA module 316 can generate, as output, data that modifies a behavior of the device or another device (e.g., a command that controls a machine, such as a printer, a camera, a device, or an industrial manufacturing device). The RPA module 316 can generate, as output, data that reflects an initial, current, or final status of the workflow (e.g., a dashboard that shows a progress of the workflow to completion, or a result of the workflow in combination with the results of other workflows). The RPA module 316 can generate, as output, one or more events (e.g., notifications to a human, an application, an operating system of the device, or another device as to the progression, completion, and/or results of the workflow). The events can be received and further processed by the RPA module 316 or another RPA module executing on the same device or another device. For example, upon completion of a first workflow, the RPA module 316 can initiate a second workflow based on a result and/or output of the first workflow. The RPA module 316 can generate, as output, documentation of one or more results of the workflow. For example, the RPA module 316 can update a log to document the results and/or output of the workflow, including one or more errors, exceptions, validation failures that occurred during the workflow.

In embodiments, the RPA module 316 modifies a workflow based on a performance of the workflow. For example, the RPA module 316 can request review, by a user, of one or more results of the workflow, including one or more errors, exceptions, validation failures that occurred during the workflow. The RPA module 316 can deactivate one or more steps or modules of the workflow that resulted in an error, exception, or validation failure. The RPA module 316 can automatically adjust the workflow to perform future instances of the workflow based on the completed instance of the workflow. For example, the RPA module 316 can update the workflow to improve an efficiency of the workflow, to add or remove functions to the workflow, to adjust functions of the workflow to perform differently, to log one or more instances and/or parameters of the workflow, and/or to eliminate or reduce one or more logical faults in the workflow. The RPA module 316 can update one or more artificial intelligence modules 304 associated with the workflow. For example, the RPA module 316 can generate or add one or more machine learning models to the workflow to improve processing of the workflow. The RPA module 316 can remove one or more machine learning models to improve efficiency of the workflow. The RPA module 316 can redesign and/or retrain one or more machine learning models based on a result of the workflow. The RPA module 316 can add one or more machine learning models to an existing ensemble of machine learning models.

### Analytics Module

In embodiments, the artificial intelligence modules 304 may include and/or provide access to an analytics module 318. In embodiments, an analytics module 318 is configured to perform various analytical processes on data output from value chain entities or other data sources. In example embodiments, analytics produced by the analytics module 318 may facilitate quantification of system performance as compared to a set of goals and/or metrics. The goals and/or metrics may be preconfigured, determined dynamically from operating results, and the like. Examples of analytics processes that can be performed by an analytics module 318 are discussed below and in the document incorporated herein by reference. In some example implementations, analytics processes may include tracking goals and/or specific metrics that involve coordination of value chain activities and demand intelligence, such as involving forecasting demand for a set of relevant items by location and time (among many others).

### Digital Twin Module

In embodiments, artificial intelligence modules 304 may include and/or provide access to a digital twin module 320. The digital twin module 320 may encompass any of a wide range of features and capabilities described herein In embodiments, a digital twin module 320 may be configured to provide, among other things, execution environments for and different types of digital twins, such as twins of physical environments, twins of robot operating units, logistics twins, executive digital twins, organizational digital twins, role-based digital twins, and the like. In embodiments, the digital twin module 320 may be configured in accordance with digital twin systems and/or modules described elsewhere throughout the disclosure. In example embodiments, a digital twin module 320 may be configured to generate digital twins that are requested by intelligence clients 336. Further, the digital twin module 320 may be configured with interfaces, such as APIs and the like for receiving information from external data sources. For instance, the digital twin module 320 may receive real-time data from sensor systems of a machinery, vehicle, robot, or other device, and/or sensor systems of the physical environment in which a device operates. In embodiments, the digital twin module 320 may receive digital twin data from other suitable data sources, such as third-party services (e.g., weather services, traffic data services, logistics systems and databases, and the like. In embodiments, the digital twin module 320 may include digital twin data representing features, states, or the like of value chain network entities, such as supply chain infrastructure entities, transportation or logistic entities, containers, goods, or the like, as well as demand entities, such as customers, merchants, stores, points-of-sale, points-of-use, and the like. The digital twin module 320 may be integrated with or into, link to, or otherwise interact with an interface (e.g., a control tower or dashboard), for coordination of supply and demand, including coordination of automation within supply chain activities and demand management activities.

In embodiments, a digital twin module 320 may provide access to and manage a library of digital twins. Artificial intelligence modules 304 may access the library to perform functions, such as a simulation of actions in a given environment in response to certain stimuli.

### Machine Vision Module

In embodiments, artificial intelligence modules 304 may include and/or provide access to a machine vision module 322. In embodiments, a machine vision module 322 is configured to process images (e.g., captured by a camera) to detect and classify objects in the image. In embodiments, the machine vision module 322 receives one or more images (which may be frames of a video feed or single still shot images) and identifies “blobs” in an image (e.g., using edge detection techniques or the like). The machine vision module 322 may then classify the blobs. In some embodiments, the machine vision module 322 leverages one or more machine-learned image classification models and/or neural networks (e.g., convolutional neural networks) to classify the blobs in the image. In some embodiments, the machine vision module 322 may perform feature extraction on the images and/or the respective blobs in the image prior to classification. In some embodiments, the machine vision module 322 may leverage classification made in a previous image to affirm or update classification(s) from the previous image. For example, if an object that was detected in a previous frame was classified with a lower confidence score (e.g., the object was partially occluded or out of focus), the machine vision module 322 may affirm or update the classification if the machine vision module 322 is able to determine a classification of the object with a higher degree of confidence. In embodiments, the machine vision module 322 is configured to detect occlusions, such as objects that may be occluded by another object. In embodiments, the machine vision module 322 receives additional input to assist in image classification tasks, such as from a radar, a sonar, a digital twin of an environment (which may show locations of known objects), and/or the like. In some embodiments, a machine vision module 322 may include or interface with a liquid lens. In these embodiments, the liquid lens may facilitate improved machine vision (e.g., when focusing at multiple distances is necessitated by the environment and job of a robot) and/or other machine vision tasks that are enabled by a liquid lens.

### Natural Language Processing Module

In embodiments, the artificial intelligence modules 304 may include and/or provide access to a natural language processing (NLP) module 324. In embodiments, an NLP module 324 performs natural language tasks on behalf of an intelligence service client 336. Examples of natural language processing techniques may include, but are not limited to, speech recognition, speech segmentation, speaker diarization, text-to-speech, lemmatization, morphological segmentation, parts-of-speech tagging, stemming, syntactic analysis, lexical analysis, and the like. In embodiments, the NLP module 324 may enable voice commands that are received from a human. In embodiments, the NLP module 324 receives an audio stream (e.g., from a microphone) and may perform voice-to-text conversion on the audio stream to obtain a transcription of the audio stream. The NLP module 324 may process text (e.g., a transcription of the audio stream) to determine a meaning of the text using various NLP techniques (e.g., NLP models, neural networks, and/or the like). In embodiments, the NLP module 324 may determine an action or command that was spoken in the audio stream based on the results of the NLP. In embodiments, the NLP module 324 may output the results of the NLP to an intelligence service client 336.

In embodiments, the NLP module 324 provides an intelligence service client 336 with the ability to parse one or more conversational voice instructions provided by a human user to perform one or more tasks as well as communicate with the human user. The NLP module 324 may perform speech recognition to recognize the voice instructions, natural language understanding to parse and derive meaning from the instructions, and natural language generation to generate a voice response for the user upon processing of the user instructions. In some embodiments, the NLP module 324 enables an intelligence service client 336 to understand the instructions and, upon successful completion of the task by the intelligence service client 336, provide a response to the user. In embodiments, the NLP module 324 may formulate and ask questions to a user if the context of the user request is not completely clear. In embodiments, the NLP module 324 may utilize inputs received from one or more sensors including vision sensors, location-based data (e.g., GPS data) to determine context information associated with processed speech or text data.

In embodiments, the NLP module 324 uses neural networks when performing NLP tasks, such as recurrent neural networks, long short term memory (LSTMs), gated recurrent unit (GRUs), transformer neural networks, convolutional neural networks and/or the like.

FIG. 6 illustrates an example neural network for implementing NLP module 324. In the illustrated example, the example neural network is a transformer neural network. In the example, the transformer neural network includes three input stages and five output stages to transform an input sequence into an output sequence. The example transformer includes an encoder 382 and a decoder 384. The encoder 382 processes input, and the decoder 384 generates output probabilities, for example. The encoder 382 includes three stages, and the decoder 384 includes five stages. Encoder 382 stage 1 represents an input as a sequence of positional encodings added to embedded inputs. Encoder 382 stages 2 and 3 include N layers (e.g., N=6, etc.) in which each layer includes a position-wise feedforward neural network (FNN) and an attention-based sublayer. Each attention-based sublayer of encoder 382 stage 2 includes four linear projections and multi-head attention logic to be added and normalized to be provided to the position-wise FNN of encoder 382 stage 3. Encoder 382 stages 2 and 3 employ a residual connection followed by a normalization layer at their output.

The example decoder 384 processes an output embedding as its input with the output embedding shifted right by one position to help ensure that a prediction for position i is dependent on positions previous to/less than i. In stage 2 of the decoder 384, masked multi-head attention is modified to prevent positions from attending to subsequent positions. Stages 3-4 of the decoder 384 include N layers (e.g., N=6, etc.) in which each layer includes a position-wise FNN and two attention-based sublayers. Each attention-based sublayer of decoder 384 stage 3 includes four linear projections and multi-head attention logic to be added and normalized to be provided to the position-wise FNN of decoder 384 stage 4. Decoder 384 stages 2-4 employ a residual connection followed by a normalization layer at their output. Decoder 384 stage 5 provides a linear transformation followed by a softmax function to normalize a resulting vector of K numbers into a probability distribution including K probabilities proportional to exponentials of the K input numbers.

Additional examples of neural networks may be found elsewhere in the disclosure.

### Rules-Based Module

Referring back to FIG. 3, in embodiments, artificial intelligence modules 304 may also include and/or provide access to a rules-based module 328 that may be integrated into or be accessed by an intelligence service client 336. In some embodiments, a rules-based module 328 may be configured with programmatic logic that defines a set of rules and other conditions that trigger certain actions that may be performed in connection with an intelligence client. In embodiments, the rules-based module 328 may be configured with programmatic logic that receives input and determines whether one or more rules are met based on the input. If a condition is met, the rules-based module 328 determines an action to perform, which may be output to a requesting intelligence service client 336. The data received by the rules-based engine may be received from an intelligence service input 332 source and/or may be requested from another module in artificial intelligence modules 304, such as the machine vision module 322, the neural network module 314, the ML module 312, and/or the like. For example, a rules-based module 328 may receive classifications of objects in a field of view of a mobile system (e.g., robot, autonomous vehicle, or the like) from a machine vision system and/or sensor data from a lidar sensor of the mobile system and, in response, may determine whether the mobile system should continue in its path, change its course, or stop. In embodiments, the rules-based module 328 may be configured to make other suitable rules-based decisions on behalf of a respective client 336, examples of which are discussed throughout the disclosure. In some embodiments, the rules-based engine may apply governance standards and/or analysis modules, which are described in greater detail below.

### Intelligence Services Controller and Analysis Management Module

In embodiments, artificial intelligence modules 304 interface with an intelligence service controller 302, which is configured to determine a type of request issued by an intelligence service client 336 and, in response, may determine a set of governance standards and/or analyses that are to be applied by the artificial intelligence modules 304 when responding to the request. In embodiments, the intelligence service controller 302 may include an analysis management module 306, a set of analysis modules 308, and a governance library 310.

In embodiments, an intelligence service controller 302 is configured to determine a type of request issued by an intelligence service client 336 and, in response, may determine a set of governance standards and/or analyses that are to be applied by the artificial intelligence modules 304 when responding to the request. In embodiments, the intelligence service controller 302 may include an analysis management module 306, a set of analysis modules 308, and a governance library 310. In embodiments, the analysis management module 306 receives an artificial intelligence module 304 request and determines the governance standards and/or analyses implicated by the request. In embodiments, the analysis management module 306 may determine the governance standards that apply to the request based on the type of decision that was requested and/or whether certain analyses are to be performed with respect to the requested decision. For example, a request for a control decision that results in an intelligence service client 336 performing an action may implicate a certain set of governance standards that apply, such as safety standards, legal standards, quality standards, or the like, and/or may implicate one or more analyses regarding the control decision, such as a risk analysis, a safety analysis, an engineering analysis, or the like.

In some embodiments, the analysis management module 306 may determine the governance standards that apply to a decision request based on one or more conditions. Non-limiting examples of such conditions may include the type of decision that is requested, a geolocation in which a decision is being made, an environment that the decision will affect, current or predicted environment conditions of the environment and/or the like. In embodiments, the governance standards may be defined as a set of standards libraries stored in a governance library 310. In embodiments, standards libraries may define conditions, thresholds, rules, recommendations, or other suitable parameters by which a decision may be analyzed. Examples of standards libraries may include, legal standards library, a regulatory standards library, a quality standards library, an engineering standards library, a safety standards library, a financial standards library, and/or other suitable types of standards libraries. In embodiments, the governance library 310 may include an index that indexes certain standards defined in the respective standards library based on different conditions. Examples of conditions may be a jurisdiction or geographic areas to which certain standards apply, environmental conditions to which certain standards apply, device types to which certain standards apply, materials or products to which certain standards apply, and/or the like.

In some embodiments, the analysis management module 306 may determine the appropriate set of standards that must be applied with respect to a particular decision and may provide the appropriate set of standards to the artificial intelligence modules 304, such that the artificial intelligence modules 304 leverages the implicated governance standards when determining a decision. In these embodiments, the artificial intelligence modules 304 may be configured to apply the standards in the decision-making process, such that a decision output by the artificial intelligence modules 304 is consistent with the implicated governance standards. It is appreciated that the standards libraries in the governance library may be defined by the platform provider, customers, and/or third parties. The standards may be government standards, industry standards, customer standards, or other suitable sources. In embodiments, each set of standards may include a set of conditions that implicate the respective set of standards, such that the conditions may be used to determine which standards to apply given a situation.

In some embodiments, the analysis management module 306 may determine one or more analyses that are to be performed with respect to a particular decision and may provide corresponding analysis modules 308 that perform those analyses to the artificial intelligence modules 304, such that the artificial intelligence modules 304 leverage the corresponding analysis modules 308 to analyze a decision before outputting the decision to the requesting client. In embodiments, the analysis modules 308 may include modules that are configured to perform specific analyses with respect to certain types of decisions, whereby the respective modules are executed by a processing system that hosts the instance of the intelligence system 300. Non-limiting examples of analysis modules 308 may include risk analysis module(s), security analysis module(s), decision tree analysis module(s), ethics analysis module(s), failure mode and effects (FMEA) analysis module(s), hazard analysis module(s), quality analysis module(s), safety analysis module(s), regulatory analysis module(s), legal analysis module(s), and/or other suitable analysis modules.

In some embodiments, the analysis management module 306 is configured to determine which types of analyses to perform based on the type of decision that was requested by an intelligence service client 336. In some of these embodiments, the analysis management module 306 may include an index or other suitable mechanism that identifies a set of analysis modules 308 based on a requested decision type. In these embodiments, the analysis management module 306 may receive the decision type and may determine a set of analysis modules 308 that are to be executed based on the decision type. Additionally or alternatively, one or more governance standards may define when a particular analysis is to be performed. For example, the engineering standards may define what scenarios necessitate a FMEA analysis. In this example, the engineering standards may have been implicated by a request for a particular type of decision and the engineering standards may define scenarios when an FMEA analysis is to be performed. In this example, artificial intelligence modules 304 may execute a safety analysis module and/or a risk analysis module and may determine an alternative decision if the action would violate a legal standard or a safety standard. In response to analyzing a proposed decision, artificial intelligence modules 304 may selectively output the proposed condition based on the results of the executed analyses. If a decision is allowed, artificial intelligence modules 304 may output the decision to the requesting intelligence service client 336. If the proposed configuration is flagged by one or more of the analyses, artificial intelligence modules 304 may determine an alternative decision and execute the analyses with respect to the alternate proposed decision until a conforming decision is obtained.

It is noted here that in some embodiments, one or more analysis modules 308 may themselves be defined in a standard, and one or more relevant standards used together may comprise a particular analysis. For example, the applicable safety standard may call for a risk analysis that can use or more allowable methods. In this example, an ISO standard for overall process and documentation, and an ASTM standard for a narrowly defined procedure may be employed to complete the risk analysis required by the safety governance standard.

As mentioned, the foregoing framework of an intelligence system 300 may be applied in and/or leveraged by various entities of a value chain. For example, in some embodiments, a platform-level intelligence system may be configured with the entire capabilities of the intelligence system 300, and certain configurations of the intelligence system 300 may be provisioned for respective value chain entities. Furthermore, in some embodiments, an intelligence service client 336 may be configured to escalate an intelligence system task to a higher-level value chain entity (e.g., edge-level or the platform-level) when the intelligence service client 336 cannot perform the task autonomously. It is noted that in some embodiments, an intelligence service controller 302 may direct intelligence tasks to a lower-level component. Furthermore, in some implementations, an intelligence system 300 may be configured to output default actions when a decision cannot be reached by the intelligence system 300 and/or a higher or lower-level intelligence system. In some of these implementations, the default decisions may be defined in a rule and/or in a standards library.

### Reinforcement Learning to Determine Optimal Policy

Reinforcement learning (RL), is a machine learning technique where an agent iteratively learns optimal policy through interactions with the environment. In RL, the agent must discover correct actions by trial-and-error so as to maximize some notion of long-term reward. Specifically, in a system employing RL, there exist two entities: (1) an environment and (2) an agent. The agent is a computer program component that is connected to its environment such that it can sense the state of the environment as well as execute actions on the environment. On each step of interaction, the agent senses the current state of the environment, s, and chooses an action to take, a. The action changes the state of the environment, and the value of this state transition is communicated to the agent by a reward signal, r, where the magnitude of r indicates the desirability of an action. Over time, the agent builds a policy, π, which specifies the action the agent will take for each state of the environment.

Formally, in reinforcement learning, there exists a discrete set of environment states, S; a discrete set of agent actions, A; and a set of scalar reinforcement signals, R. After learning, the system creates a policy, π, that defines the value of taking action aεA in state sεS. The policy defines Qπ(s, a) as the expected return value for starting from s, taking action a, and following policy π.

The reinforcement learning agent is trained in a policy through iterative exposure to various states, having the agent select an action as per the policy and providing a reward based on a function designed to reward desirable behavior. Based on the reward feedback, the system may “learn” the policy and becomes trained in producing desirable actions. For example, for navigation policy, RL agent may evaluate its state repeatedly (e.g., location, distance from a target object), select an action (e.g., provide input to the motors for movement towards the target object), evaluate the action using a reward signal, which provides an indication of the of the success of the action. (e.g., a reward of +10 if movement reduces the distance between a mobile system and a target object and −10 if the movement increases the distance). Similarly, the RL agent may be trained in grasping policy by iteratively obtaining images of a target object to be grasped, attempt to grasp the object, evaluate the attempt, and then execute the subsequent iteration using the evaluation of the attempt of the preceding iteration(s) to assist in determining the next attempt.

There may be several approaches for training the RL agent in a policy. Imitation learning is a key approach in which the agent learns from state/action pairs where the actions are those that would be chosen by an expert (e.g., a human) in response to an observed state. Imitation learning not just solves sample-inefficiency or computational feasibility problems, but also makes the training process safer. The RL agent may derive multiple examples of the state/action pairs by observing a human (e.g., navigating towards and grasping a target object), and uses them as a basis for training the policy. Behavior cloning (BC), that focuses on learning the expert's policy using supervised learning is an example of imitation learning approach.

Value based learning approach aims to find a policy comprising a sequence of actions that maximizes the expectation value of future reward (or minimizes the expected cost). The RL agent may learn the value/cost function and then derives a policy with respect to the same. Two different expectation values are often referred to: the state value V(s) and the action value Q (s,a) respectively. The state value function V(s) represents the value associated with the agent at each state whereas the action value function Q(s,a) represents the value associated with the agent at state s and performing action a. The value-based learning approach works by approximating optimal value (V* or Q*) and then deriving an optimal policy. For example, the optimal value function Q*(s, a) may be identified by finding the sequence of actions which maximize the state-action value function Q (s, a). The optimal policy for each state can be derived by identifying the highest valued action that can be taken from each state.

$${π}^{*} ( s ) = argmax {Q}^{*} ( s , a )$$

To iteratively calculate the value function as actions within the sequence are executed and the mobile system transitions from one state to another, the Bellman Optimality equation may be applied. The optimal value function Q*(s,a) obeys Bellman Optimality equation and can be expressed as:

$${Q}^{*} ( {s}_{t} , {a}_{t} = E [ {r}_{t + 1} + γ max {Q}^{*} ( {s}_{t + 1} , {a}_{t + 1} ) ] \qquad ( eq . 4 )$$

Policy based learning approach directly optimizes the policy function n using a suitable optimization technique (e.g., stochastic gradient descent) to fine tune a vector of parameters without calculating a value function. The policy-based learning approach is typically effective in high-dimensional or continuous action spaces.

FIG. 7 illustrates an approach based on reinforcement learning and including evaluation of various states, actions and rewards in determining optimal policy for executing one or more tasks by a mobile system.

At 402, a reinforcement learning agent (e.g., of the intelligence services system 300) receives sensor information including a plurality of images captured by the mobile system in the environment. The analysis of one or more of these images may enable the agent to determine a first state associated with the mobile system at 404. The data representing the first state may include information about the environment, such as images, sounds, temperature or time and information about the mobile system, including its position, speed, internal state (e.g., battery life, clock setting) etc.

At 406, 408, and 410, various potential actions responsive to the state may be determined. Some examples of potential actions include providing control instructions to actuators, motors, wheels, wings flaps, or other components that controls the agent's speed, acceleration, orientation, or position; changing the agent's internal settings, such as putting certain components into a sleep mode to conserve battery life; changing the direction if the agent is in danger of colliding with an obstacle object; acquiring or transmitting data; attempting to grasp a target object and the like.

At 412, 414 and 416, expected rewards may be determined for each of the potential actions based on a reward function. For each of the determined potential actions, an expected reward may be determined based on a reward function. The reward may be predicated on a desired outcome, such as avoiding an obstacle, conserving power, or acquiring data. If the action yields the desired outcome (e.g., avoiding the obstacle), the reward is high; otherwise, the reward may be low.

The agent may also look to the future to analyze whether there may be opportunities for realizing higher rewards in the future. At 418, 420, and 422, the agent may determine future states resulting from potential actions respectively at 406, 408, and 410.

For each of the future states predicted at 418, 420, and 422, one or more future actions may be determined and evaluated. At 424, 426, and 428, for example, values or other indicators of expected rewards associated with one or more of the future actions may be developed. The expected rewards associated with the one or more future actions may be evaluated by comparing values of reward functions associated with each future action.

At 430, an action may be selected based on a comparison of expected current and future rewards.

In embodiments, the reinforcement learning agent may be pre-trained through simulations in a digital twin system. In embodiments, the reinforcement agent may be pre-trained using behavior cloning. In embodiments, the reinforcement agent may be trained using a deep reinforcement learning algorithm selected from Deep Q-Network (DQN), double deep Q-Network (DDQN), Deep Deterministic Policy Gradient (DDPG), soft actor critic (SAC), advantage actor critic (A2C), asynchronous advantage actor critic (A3C), proximal policy optimization (PPO), trust region policy optimization (TRPO).

In embodiments, the reinforcement learning agent may look to balance exploitation (of current knowledge) with exploration (of uncharted territory) while traversing the action space. For example, the agent may follow an ε-greedy policy by randomly selecting exploration occasionally with probability ε while taking the optimal action most of the time with probability 1−ε, where ε is a parameter satisfying 0<ε<1.

### Generative AI Systems

In example embodiments, a generative artificial intelligence engine (GAIE) may be combined with a machine learning system in a transaction environment. Input to the GAIE may include images, video, audio, text, programmatic code, data, and the like. Outputs from a GAIE may include structured and organized prose, images, video, audio content, software/programming source code, formatted data (e.g., arrays), algorithms, definitions, context-specific structures (e.g., smart contacts, transaction platform configuration data sets, and the like), machine language-based data (e.g., API-formatted content), and the like. For GAIE instances in which the models are designed to process text data, the GAIE may interface to other programmatic systems (such as traditional machine learning engines) to process other forms of data into text data. In example embodiments, the other programmatic systems, including systems executing machine learning algorithms, may produce textual based (optionally at volume) that may be consumed by GAIE. For example, consider such another system building a series of one thousand text-based observations on the other-formatted data; this may be a useful input for a GAIE model to learn and process (e.g., summarize) into text-formatted output information. In example embodiments, an interface between the GAIE and its combined machine learning system may be extended to include a dialogue between the systems, where the GAIE includes and/or accesses a capability to ask the machine learning system specific questions to facilitate the refining of its knowledge. For example, the dialogue capability may include a request of the machine learning system to provide an assessment of current market trading positions. In another example, the dialogue capability may encode numeric outputs from the machine learning engine into text (e.g., words, such as high, medium, low) that may be input for interpretation by the GAIE.

In example embodiments, the data processed by a GAIE may include one or more types of content. For example, a GAIE may receive, as input, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Input to the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be received as various forms of data. For example, a natural-language expression received as input by a GAIE could be encoded as one or more of: encoded text, an image of a writing, a sound recording of human speech, a video of an individual exhibiting sign language, an encoding according to a machine learning model embedding, or the like, or any combination thereof. In example embodiments, an input received and processed by the GAIE can include an internal state of the GAIE, such as a partial result of a partial processing of an input, or a set of weights and/or biases of the GAIE as a result of prior processing (e.g., an internal state of a recurrent neural network (RNN)).

In some embodiments, the data and/or content received and processed by a GAIE originates from one or more individuals, such as a person speaking a natural-language expression. In some embodiments, the data and/or content received and processed by a GAIE originates from one or more natural sources, such as patterns formed by nature. In some embodiments, the data and/or content received and processed by a GAIE originates from one or more other devices, such as another machine learning model executing on another device, or from another component of the same device executing the GAIE, such as output of another machine learning model executing on the same device executing the GAIE, or a sensor in an Internet-of-Things (IoT) and/or cloud architecture. In some embodiments, the data and/or content received and processed by a GAIE is artificially synthesized, such as synthetic data generated by an algorithm to augment a training data set. In some embodiments, the data and/or content received and processed by a GAIE is generated by the same GAIE, such as an internal state of the GAIE in response to previous and/or concurrent processing, or a previous output of the GAIE in the manner of a recurrent neural network (RNN).

In some embodiments, at least some or part of the data and/or content received and processed by a GAIE is also used to train the GAIE. For example, a variational GAIE could be trained on an input and a corresponding acceptable output, and could later receive the same input in order to output one or more variations of the acceptable output. In some embodiments, at least some or part of the data and/or content received and processed by a GAIE is different than data and/or content that was used to train the GAIE. In some such embodiments, the data and/or content received and processed by the GAIE is different than but similar to the data and/or content that was used to train the GAIE, such as new inputs that are exhibit a similar statistical distribution of features as the training data. In some such embodiments, the data and/or content received and processed by the GAIE is different than and dissimilar to the data and/or content that was used to train the GAIE, such as new inputs that exhibit a significantly different statistical distribution of features than the training data. In scenarios that involve dissimilar inputs, one or more first outputs of the GAIE in response to a new input may be compared to one or more second outputs of the GAIE in response to inputs of the training data set to determine whether the first outputs and the second outputs are consistent. The GAIE may request and/or receive additional training based on the new inputs and corresponding acceptable outputs. In scenarios that involve dissimilar inputs, the GAIE may present an alert and/or description that indicates how the new inputs and/or corresponding outputs differ from previously received inputs and/or corresponding outputs.

In example embodiments, the output of a GAIE may include one or more types of content. For example, a GAIE may generate, as output, data that represents one or more natural-language expressions, single- or multidimensional shapes or models, real-world and/or virtual scene representations, LIDAR point-cloud representations, sensor inputs and/or outputs, vehicle and/or machine telemetry, geographic maps, authentication credentials, financial transactions, smart contracts, processing directives and/or resources such as shaders, device configurations such as HDL specifications for programming FPGAs, databases and/or database structural definitions, or the like, including metadata associated with any such data types. Output of the GAIE may also include data that represents one or more features of another machine learning model, such as a configuration (e.g., model type, parameters, and/or hyperparameters), input, internal state (e.g., weights and biases of at least a portion of the model), and/or output of the other machine learning model. These and other forms of content may be generated by the GAIE as various forms of data. For example, a natural-language expression generated as output by the GAIE could be encoded as one or more of: encoded text, an image of a writing, a sound recording of human speech, a video of an individual exhibiting sign language, an encoding according to a machine learning model embedding, or the like, or any combination thereof. In example embodiments, an output of the GAIE can include an internal state of the GAIE, such as a partial result of a partial processing of an input, or a set of weights and/or biases of the GAIE as a result of prior processing (e.g., an internal state of a recurrent neural network (RNN)).

In example embodiments, a language-based dialogue-enabled GAIE may be configured to produce (e.g., write) new machine learning models that may process various types of data to provide new and extended text input for processing by the GAIE. In example embodiments, humans may observe and interact with this ongoing dialogue between the two systems. In example embodiments, the dialogue is initiated by an expression of a conversation partner (e.g., a human or another device), and the GAIE generates one or more expressions that are responsive to the expression of the conversation partner. In example embodiments, the GAIE generates an expression to initiate the dialogue, and further responds to one or more expressions of the conversation partner in response to the initiating expression. In example embodiments, the ongoing dialogue occurs in a turn-taking manner, wherein each of the conversational partner and the GAIE generating an expression based on a previous expression of the other of the conversation partner and the GAIE. In example embodiments, the ongoing dialogue occurs extemporaneously, with each of the conversation partner and the GAIE generating expressions irrespective of a timing and/or sequential ordering of previous and/or concurrent expressions of the conversation partner and/or the GAIE.

In example embodiments, the dialogue occurs between a GAIE and a plurality of conversation partners, such as two or more humans, two or more other GAIEs, or a combination of one or more humans and one or more other GAIEs. In some such example embodiments, the GAIE and each of the other conversation partners take turns generating expressions in response to prior expressions from the GAIE and the other conversation partners. In some such embodiments, one or more sub-conversations occur among one or more subsets of the GAIE and the plurality of conversation partners. Such sub-conversations may occur concurrently (e.g., the GAIE concurrently engages in a first conversation with a first conversation partner and a second conversation with a second conversation partner) and/or consecutively (e.g., the GAIE concurrently engages in a first conversation with a first conversation partner, followed by a second conversation with a second conversation partner). Such sub-conversations may involve the same or similar topics or expressions (e.g., the GAIE may present the same or similar conversation-initiating expression to each of a plurality of conversation partners, and may concurrently engage each of the plurality of conversation partners in a separate conversation on the same or similar topic). Such sub-conversations may involve different topics or expressions (e.g., the GAIE may present different conversation-initiating expressions to each of a plurality of conversation partners, and may concurrently engage each of the plurality of conversation partners in a separate conversation on different topics). In example embodiments, a first conversation among a first subset of the GAIE and conversation partners may be related to a second conversation among a second subset of the GAIE and conversation partners (e.g., the second subset may engage in a second conversation based on content of the first conversation among a first subgroup).

In example embodiments, one or more of the GAIE and the conversation partner may embody one or more roles. For example, the GAIE may generate expressions based on a role of a conversation starter, a conversation responder, a teacher, a student, a supervisor, a peer, a subordinate, a team member, an independent observer, a researcher, a particular character in a story, an advisor, a caregiver, a therapist, an ally or enabler of a conversation partner, or a competitor or opponent of a conversation partner (e.g., a “devil's advocate” that presents opposing and/or alternative viewpoints to a belief or argument of a conversation partner). In example embodiments, at least one of the one or more conversation partner embodies one or more aforementioned roles or other rules. In example embodiments, a role of a GAIE is relative to a role of a conversation partner (e.g., the GAIE may embody a superior, peer, or subordinate role with respect to a role of a conversation partner). In example embodiments, a role of a GAIE in a first conversation among a first subset of the GAIE and a plurality of conversation partners may be the same as or similar to a role of a GAIE in a second conversation among a first subset of the GAIE and the plurality of conversation partners. In example embodiments, a role of a GAIE in a first conversation among a first subset of the GAIE and a plurality of conversation partners may differ from a role of a GAIE in a second conversation among a first subset of the GAIE and the plurality of conversation partners (e.g., the GAIE may embody a role of a teacher in a first conversation and a role of a student in a second conversation). In example embodiments, a role of a GAIE in a conversation may change over time (e.g., the GAIE may first embody a role of a student in a conversation, and may later change to a role of a teacher in the same conversation). In example embodiments, a GAIE may embody two or more roles in a conversation (e.g., the GAIE may exhibit two personalities in a conversation that respectively represent one of two characters in a story). In example embodiments, a GAIE generates expressions between two or more roles in a conversation (e.g., the GAIE may generate a dialogue between each of two characters in a story). In example embodiments, a GAIE may engage in each of multiple conversations in a same or similar modality (e.g., engaging in multiple text-based conversations concurrently). In example embodiments, a GAIE may engage in each of multiple conversations in different modalities (e.g., engaging in a first conversation via text and a second conversation via voice).

In example embodiments, a GAIE participating in a conversation is associated with an avatar (e.g., a name, color, image, two- or three-dimensional model, voice, or the like). Expressions generated by the GAIE may be presented as if originating from the GAIE (e.g., in the voice associated with the GAIE, or in a speech bubble that is displayed near a visual position of a GAIE in a virtual or augmented-reality environment). In example embodiments, an avatar of a GAIE may be based on a role of the GAIE (e.g., a GAIE embodying a role of a teacher may be associated with an avatar depicting a teacher). In example embodiments, an avatar of a GAIE may be included in a real-world actor, such as a robot in a real-world environment such as a stage performance.

In example embodiments, a GAIE may include generative pretrained transformer elements that may be configured as a language model designed to understand various types of input and produce chat commands for a chat-type interface system. These commands may include software development tasks, API calls, and the like. In example embodiments, such a language model may include input functions that support receiving images, including video, to build textual output, functions, and additional questions that may be injected into the dialogue between the two systems in the dialogue embodiment described above. In example embodiments, this multimodal support may allow for contextual analysis of images and other media formats. In an example, users/customers may upload images or other media into a GAIE enabled platform. Based on aspects of a corresponding input prompt, a multi-modal GAIE may be configured for use in a valuation workflow to identify both macro and micro attributes and their correlated effects on valuation from a plurality of perspectives. In this example, photographs/images of an old car may be input along with a valuation-related prompt. In response, the GAIE may identify one or more typical values based on detected attributes of the car, such as the make/model, etc. The GAIE may further take into account finer details in the image to suggest potential value-altering metrics. In one example, a finer detail in the image such as damaged body panels may reduce the car value below a typical value. In another example, a finer detail in the image that shows a marking consistent with a limited production run may increase the valuation.

In example embodiments, a subject matter GAIE may be adapted to facilitate transaction forensics. As more transactions are carried out by AI, the need for humans to understand how and why specific transactions were initiated and carried out is likely to increase. For example, a transaction may be generated in response to a user request, such as “please send me a new circuit board for my broken refrigerator.” When the requested circuit board arrives configured with, for example, hostile government tracking devices, it may be beneficial for the AI system to reveal how the AI system conducted the transaction that procured the circuit board. It may also be beneficial for the AI system to participate in establishing AI system control actions and/or steps that may be taken to prevent future occurrences of unacceptable procurement.

For transactions that involve collateral and/or insurance coverage, a GAIE may be configured to assist in valuation of the collateral, defining and/or meeting insurance needs and the like.

A transaction subject matter pretrained GAIE may respond to a token acquisition-related prompt from an investor with a stated set of goals, a set of candidate opportunities for acquiring new tokens, a set of comparative advantages relative to other tokens, and a potential nexus between the strengths of a token and the goals of an investor. In example embodiments, a system having a portfolio analysis engine may discover an investment opportunity based on an investment goal of a user and may be combined with a conversation engine that generates a summary of the investment opportunity for presentation to the user, the summary including a reason that the investment opportunity promotes the investment goal of the user. In various embodiments, the summary may be based on one or more properties of the user, such as a user's financial condition, a user's demographic traits, a sophistication level of the user's understanding of the transaction, portfolio, market, and/or economy, and/or the user's history of previous transactions associated with the portfolio, market, and/or economy.

An adapted GAIE may facilitate the generation of synthetic data for and/or about transactions, such as from a disposable training model that may be scrapped after training. Synthetic data from the original source, now embedded in the trained GAIE, may be regenerated without personally identifying information and the like to overcome privacy concerns and facilitate data sharing and/or pooling among transaction entities (e.g., banks and third parties). In example embodiments, an area of focus for application of a GAIE may include operation with a transaction engine using GAIE-generated synthetic data derived from a training set of historical transaction data to transact between two or more entities. In example embodiments, data that is used to train the GAIE may be stored for future use. For example, training data may be subsequently examined to determine a reason for an output and/or behavior of the GAIE. For example, when a GAIE exhibits a bias or deficiency, the training data may be examined to determine a property in the training data that results in the bias or deficiency of the GAIE, and additional training data could be provided to continue training or to retrain the GAIE, wherein the additional training data supplements the property of the training data that results in the bias or deficiency of the GAIE.

In example embodiments, a transaction subject matter fine-tuned GAIE may provide rich improvements in capabilities, such as transaction subject matter related search, digital wallet search, and the like. In example embodiments, a generative AI conversational agent may be configured to search a set of digital wallets.

In example embodiments, a GAIE may be pre-trained to perform financial system management functions, such as “Smart Treasury Management,” in an Enterprise Access Layer (EAL) system. As an example, an EAL-pretrained GAIE may describe, project and/or determine likely yield generation across different accounts, independent of interactions impacting the yield being on and off-chain. A smart treasury management pre-trained GAIE may set parameters of risk taking and/or goals and partner learning systems through pretraining on transaction (e.g., treasury) data pools. In example embodiments, such a pre-trained GAIE may not be limited to treasury management; it may be applicable to operating on any asset that looks to generate yield with a set of parameters across systems. In example embodiments, such a GAIE may include and/or interface with a presentation layer capability (e.g., of data story engine and the like) to provide a user with asset management information in a concise manner across accounts. In example embodiments, such a GAIE may produce content, such as a data story, based on simulated information on different event-based outcomes aggregated across a multitude of accounts.

In example embodiments, an EAL-pretrained GAIE may be trained to create, configure, or manage enterprise data pools for use all throughout a transaction system of (or on behalf of) the enterprise. Other capabilities of an EAL-pretrained GAIE may include workflow development, transaction workflow configuration, workflow and task use, reuse and/or creation, fraud analysis, employee training at a range of levels up to an including an expert training level, transaction complexity reduction, and the like.

In example embodiments, such a GAIE may facilitate workflow orchestration for a process that uses a conversational, generative AI agent and another AI-supported process in an orchestrated sequence. In example embodiments, a GAIE may generate, perform, maintain, and/or supervise one or more workflows in a robotic process automation (RPA) environment. For example, a GAIE may be trained to monitor expressions and/or actions of an individual during interaction with other individuals, and may generate similar expressions and/or perform similar actions during similar interactions between the GAIE and other individuals. In some such scenarios, the GAIE passively observes the individual during the interactions with other individuals and self-trains to behave similarly to the individual in similar interactions with other individuals. In some such scenarios, the individual actively trains and/or teaches the GAIE to generate expressions and/or actions (e.g., by creating and/or performing example or pedagogical interactions the GAIE), and based on the training and/or teaching, the GAIE behaves similarly during subsequent interactions between the GAIE and other individuals. In example embodiments, the GAIE is trained and/or taught by an individual to perform a behavior while interacting with individuals, and subsequently performs the behavior while interacting with the same individual who provided the training and/or teaching.

In example embodiments, an enterprise access layer may have an intelligent agent that learns workflows performed by a set of users in a semi-supervised manner based on interactions of the users, wherein the intelligent agent performs at least one step in a learned workflow. In example embodiments, the intelligent agent automatically solicits feedback from one or more of the users to complete the workflow step and reinforce the training of the intelligent agent.

Application areas of an EAL-pretrained GAIE platform may include: data pools, intelligence system management, workflow development, expert training, fraud analysis, request refinement, governance; examples of these areas follow.

For a data pools application area, an EAL-pretrained GAIE may configure, curate, construct, and manage access to static or travelling data pools that facilitate use-case, customer, agent, or other EAL workflow needs. For an intelligence system management application area, the GAIE may enhance the intelligence system with a supervisory generative AI capability that decides how and when to apply various AI tools and modules. For a workflow development application area, a pretrained GAIE may identify, refine, and/or create various transaction (e.g., data or financial) workflows that may be modularized, re-used, and further refined based on data. For an expert training application area, a GAIE may interact with experts, approvers, etc. to build domain-specific capabilities that may be used to enhance workflows, governance, fraud detection, and the like. For a fraud analysis application area, the GAIE may interact with fraud experts, criminal records, people previously convicted of fraud, and the like to enhance detection capability. For a request refinement application area, the GAIE may refine any request or transaction to reduce computing and data transmission resources. For a governance application area, a pre-trained GAIE may facilitate determining when, where, and what in relation to governance requirements.

In example embodiments, a GAIE may be pre-trained for know-your-customer/know-your-transactor utilization. In example embodiments, such a pre-trained GAIE may generate a summary of customer profiles based on contextual analysis of information sourced, for example, from social media. Such a pre-trained GAIE may facilitate iterating between conversation and user behavior tracking/observation to determine how conversational parameters influence user behavior (group/cohort level). Also, it may facilitate iterating between conversation and user behavior tracking/observation to determine how conversational parameters influence user behavior, such as at an individual level.

From a perspective of smart contracts within and/or associated with transaction environments, a pre-trained GAIE may facilitate building out the terms of a smart contract based on interactive dialogue with a customer. Such a pre-trained GAIE may also generate, and optionally negotiate, intellectual property licensing terms. In example embodiments, a system for generating a smart contract may include a GAIE-based system configured to ingest and interpret contract-related terms (e.g., dictated by an individual) and to generate a corresponding smart contract configuration data structure, wrapper, and the like. A system that may flag non-standard smart contract terms/conditions may include a generative AI conversational agent configured to process contract terms and to flag non-standard aspects of smart contract terms and/or conditions. In example embodiments, a system based on a pretrained GAIE may develop sets of work scope definitions for smart contracts and/or connect work scope definitions to proprietary standards and data.

In an example, a pre-trained GAIE may include intelligent recursive use of AI assistants based on the outcome of an initial query (e.g., prompt) that may require use of proprietary or purchased standards and data access. Such AI assistants may embody one or more of a variety of roles, for example, a personal data assistant (PDA), a teacher, a student, a supervisor, a peer, a subordinate, a team member, a coach, an independent observer, a researcher, a particular character in a story, an advisor, a caregiver, a therapist, an ally or enabler of a conversation partner, or a competitor or opponent of a conversation partner. In this example, a GAIE may receive a prompt that requests the GAIE to provide a scope of work for a smart contract that includes chemical compatibility testing for a family of plastics used in flow batteries. The initial query may be adapted and/or regenerated (e.g., from the pre-trained GAIE and the like) as a prompt to identify appropriate plastic chemical compatibility testing standards that require access rights. In response to gaining access rights, the GAIE may develop a revised scope of work based on the regenerated query and write a smart contract to execute testing based on the revised scope of work.

In example embodiments, a pretrained GAIE system may have a smart contract analysis engine that determines one or more features of a smart contract that is under consideration by a user. The GAIE may further have a conversation engine that explains the features of the smart contract to the user, including summarizing contents of smart contracts.

In example embodiments, a GAIE may be pre-trained to perform prompt generation based on a data story or a plurality of sources across systems. Example generated prompts may include instructing and/or requesting the pre-trained GAIE to tell a story about a journey of a product, a business relationship, an event, a service provider, a smart container fleet, a robotic fleet, and the like.

In example embodiments, the GAIE may receive a plot or outcome of the story, and may generate content that is content with the plot or that produces the outcome. In example embodiments, the GAIE may generate a plot or outcome of the story, and may also generate content that is consistent with the GAIE-generated plot or outcome of the story. In example embodiments, the GAIE may receive a world or environment of a story, and may generate content that occurs within the given world or environment. In example embodiments, the GAIE may generate a world or environment of a story, and may also generate content that occurs within the GAIE-generated world or environment.

In example embodiments, the GAIE may receive a character or event to be included in a story, and may generate content that includes the given character or event in the story. In example embodiments, the GAIE may generate a character or event to be included in a story, and may also generate content that includes the GAIE-generated character or event in the story. In example embodiments, the GAIE may generate a world, environment, character, event, or the like “from scratch” (e.g., based on randomized inputs). In example embodiments, the GAIE may generate a world, environment, character, event, or the like based on a given world, environment, character, event, or the like (e.g., a story that is based on a real-world public figure or event).

In example embodiments, the GAIE may receive a first story and may generate a second story that is related to the first story. For example, the GAIE may generate a second story that is an alternative retelling of the first story (e.g., a second story that includes a retelling of the first story from a perspective of a different character than a narrating character of the first story). The GAIE may generate a second story that occurs in a same or similar world or environment as the first story, or a different world or environment that is related to a world or environment of the first story. The GAIE may generate a second story that features a character or event of the first story, or a different character or event that is related to a character or event of the first story.

In example embodiments, the GAIE may generate a story from the perspective of a narrator or independent observer of the story (e.g., a third-person story). In example embodiments, the GAIE may generate a story from the perspective of a character or point of view within the story (e.g., a first-person story), including a character generated and/or embodied by the GAIE. In example embodiments, the GAIE may generate a story from the perspective of a listener or audience member to whom the story is presented (e.g., a second-person story). In example embodiments, the GAIE may generate a story from multiple perspectives, such as a first part of a story generated from a perspective of a first character, a second part of the story generated from a perspective of a second character, and a third part of a story generated from a perspective of a narrator. In example embodiments, the GAIE may generate a story involving a sequence of two or more events (e.g., a story that involves two or more events observed by a character). In example embodiments, the GAIE may generate a story involving an event that is portrayed from multiple perspectives (e.g., a story that describes an event from a perspective of a first character, and that also describes the same event from a perspective of a second character).

In example embodiments, a GAIE may generate a static story that remains the same upon retelling. In example embodiments, the GAIE may generate a dynamic story that changes upon retelling (e.g., adding more detail to a story upon each retelling). In example embodiments, a GAIE may change a story based on an input of a user (e.g., based on a choice of outcomes selected by one or more receivers of the story). In example embodiments, a GAIE may generate a story based on one or more inputs received from one or more receivers of the story (e.g., based on a prompt of a user, such as a request to create a story that includes a certain event specified by the user). In example embodiments, a GAIE may receive feedback from a receiver about a story (e.g., an expression of pleasure, displeasure, approval, disapproval, delight, dissatisfaction, confusion, or the like regarding a character, event, or property of the story), and the GAIE may update the story based on the feedback (e.g., adding, removing, or clarifying an event in the story, or switching a perspective of an event from a first character in the story to a second character in the story).

In example embodiments, a GAIE may be trained by loading data (such as structured and un-structured data that may be dominated by numerical or non-text values) to the GAIE. Examples of such training data may include one or more database schemas. Techniques for curation and integration of purpose-specific data, including curation of models as inputs to a GAIE may include curating domain-specific data, data and model discovery.

Candidate areas of innovation enabled by and/or associated with GAIE advances may include user behavior models (optionally with feedback and personalization), group clustering and similarity, personality typing, governance of inputs and process, explaining the basis of GAIE knowledge and proof points, genetic programming with feedback functions, intelligent agents, voice assistants and other user experiences, transactional agents (counterparty discovery and negotiation), agents that deal with other agents, opportunity miners, automated discovery of opportunities for agent generation and application, user interfaces that adapt to the user and context, hybrid content generation, collaboration units of humans and generative AI, purpose-specific data integration, a selected set of data sources, curation of data as models as input to generative AI, and the like.

In embodiments of a GAIE-enabled system, such as one for robotic process automation, the GAIE system may summarize a set of actions being subjected to robotic automation and describe context for the actions, such as, “I found these properties as fitting your criteria because of the following features. Which ones are most attractive?” In this way, a process automation system enabled with GAIE may solicit feedback for faster feedback-based training.

In example embodiments, emerging capabilities of GAIE technology may greatly improve upon earlier versions in terms of, for example, integration of domain-specific knowledge (e.g., math) with a chat interface. Further emerging capabilities may include being better informed about and for processing prompts of complex topics. Yet further, knowledge organization is becoming much improved as GAIE systems evolve. In example embodiments, updated GAIEs may correctly answer a prompt asking about today's date, whereas prior versions may answer that today's date (e.g., the current date) may be the date on which the GAIE was last trained.

In example embodiments, a context pretrained (e.g., subject matter focused) GAIE may provide better personalization than a base GAIE instance. In general, while a base GAIE, if explicitly informed of details of the user may attempt to personalize its responses, a subject matter focused or other pre-trained GAIE may be configured with and/or with access to structured information about users (e.g., determined based on user identification and/or prompt-based clues, and the like) to provide inherent, latent context for a dialogue that includes user personalized responses.

In example embodiments, a GAIE is configured to support interpretability and/or explainability of its outputs. In example embodiments, a GAIE provides, along with an output, a description of a basis of the output, such as an explanation of the reason for generating this particular output in response to an input. In example embodiments, a GAIE provides, along with an output, a description of an internal state of the GAIE that resulted in the output, such as a set of variational parameters of a variational encoder that were processed in combination with an input to produce an output, and/or an internal state of the GAIE due to a previous processing of the GAIE that resulted in the output (e.g., similar to a recurrent neural network (RNN)). In example embodiments, a GAIE provides, along with an output, an indication of one or more subsets of features of an input that are particularly associated with the output (e.g., in a GAIE that outputs a caption or summary of an image, the GAIE can also identify the particular portions or elements of the image that are associated with the caption or portions of the summary).

In example embodiments, an advanced GAIE, such as one pretrained for subject matter specific operation, may be trained for improved epistemology, to help determine evidence of the content that it represents as facts in responses that it provides. One example of improved epistemology may include citing sources of knowledge pertinent to facts in a response as a step toward proof of facts of a response—essentially a way of the GAIE “showing its work,” or at least where its work originates. In example embodiments, a GAIE generates output based on information received from one or more external sources (e.g., one or more messages in a message set, or one or more websites on the Internet), and the GAIE indicates one or more portions of the information that are associated with the output (e.g., one or more websites on the Internet that provided information that is included in the output of the GAIE).

An advanced GAIE as described and envisioned herein may maintain contextual awareness across chat (user-prompt/GAIE-response) interactions. Maintaining contextual awareness may help avoid the GAIE beginning each chat session from scratch, with no context as to prior chats with the same user. Maintaining contextual awareness may also enable picking up and resuming a conversation from earlier interactions between the GAIE and a user. Yet further maintaining contextual awareness and awareness of passage of time between interaction sessions may facilitate adapting responses to prompts in a later resumed chat session based on trained knowledge of the intervening passage of time and/or changing circumstances. In an example, a GAIE may determine that a deadline described in an earlier chat has expired, a consequential intervening event has occurred (your home-town team lost the big game), and the like. Further, contextual awareness across time-separate chat sessions may be highly valuable when being employed for projects that may have real-world physical constraints on time (e.g., smart contract negotiation may involve human evaluation, discussion, and decision making that may take time based, for example on other priorities seeking involvement of the human). This may determine the difference between treating each conversation as individual/compartmentalized/isolated, and treating ongoing, time-separated conversations as resumable, optionally as if (almost) no time had passed. In example embodiments, a GAIE may be configured with a contextualization module that maintains some notion of conversation sessions and interconnections that may be referred (e.g., a conversation from yesterday) for details and continuity. This contextualization may further enable avoiding repeating responses, making it more efficient to reference a previous conversation. Yet further, a contextualization module may provide context to the GAIE of other conversations between the user and the system, between other users and the system, and the like.

In such a contextually maintained instance, a context-enabled GAIE may provide a response regarding forecasted weather that references an earlier period of time. In an example, a context-enabled GAIE may provide a weather-related response such as, “On Monday, we discussed the weather, you asked if you would need an umbrella on Wednesday, and I answered ‘probably not’ based on the forecast at that time. I need to inform you that the updated weather forecast indicates that rain may be more likely on Wednesday, so you probably may need an umbrella.”

Other capabilities of emerging GAIE systems may include adapting a GAIE to the generation and operation of digital avatars. In example embodiments, digital avatars may be programmed with their own visual representations. To accomplish greater similarity between an avatar and its owner based on visual and audio interpretation of users, a GAIE training and/or pre-training data set may require information about body language and nonverbal cues, such as gaze, posture, speech pitch and volume, and the like.

Emerging GAIE systems may include determining and adapting responses with variations and nuances based on, for example, user activities. A user's physical disposition may influence content production by a GAIE (e.g., presenting different cues) based on if the user is sitting, walking, driving, exercising, and the like. Further, a GAIE system may adapt responses to prompts based on variations and nuances of real-life interactions versus voice interfaces versus virtual reality. Other aspects that may impact GAIE responding to prompts may include variations and nuances of different cultures, demographics, and the like. Yet further, in example embodiments, methods and systems for advanced GAIE training and operation may include recognition of higher-level communication features of users (humor, sarcasm, dishonesty, double entendre, etc.) and user emotional state, for example.

In example embodiments, methods and systems for enhancing GAIE platforms, such as those described herein, may include configuring a GAIE to participate in multi-user dialogue, where strict turn-taking interaction with one person might be difficult in a group setting, where the context of who may be speaking to whom matters for each expression. The more fluid multi-user conversational structure vs. turn-taking structure may indicate advances to a GAIE may include developing understanding of: social interactions and cues, such as to whom each expression may be directed; group dynamics (e.g., who may be the group leader?) and interpersonal relationships; the notion of threaded discussions with branches; concurrent discussions between various sub-groups of a group; when to chime in with input so as to avoid interrupting other users; some notion about conversational balance, to avoid dominating the conversation; tact: users' sensitivity about personal information, and when it may and cannot be shared in a group setting based on context, relationships with other users, and the like.

Independent of whether interactions are one-on-one or multi-user, it is envisioned that a GAIE may be adapted to evolve beyond a turn-taking paradigm. In an example, a GAIE may currently create media (images, music, video, and the like) based on a user prompt (that itself may be one or more types of media), and may refine the created media based on user interactions, such as changing the content in certain ways or extending the boundaries of an image with more content that may be consistent with the existing content (e.g., outpainting). A more sophisticated version of generative AI may flexibly and continuously adapt its generated content to contextual user input and interactions. In an example, generating media may be adapted by the GAIE in response user integration with the generated media content, such as in response to allowing a user to virtually walk around inside the content to interact with and/or react to content items. Such a media-adapting GAIE may generate new content or update the content based on the user input/content virtual interactions. Yet further to facilitate a user to virtually interact immersively with generated content details about the user may be considered part of the criteria for newly generating and/or updating the media.

In example embodiments, a media-output enabled GAIE without user immersive interaction and feedback may generate media (e.g., a first image) based on a prompt in which a user specifies a theme for a story. The user may then specify a series of scenes that follow, and the GAIE generates an image for each scene, leading to a storyboard series for the story.

When a media-out enabled GAIE is teamed with user immersive capabilities, the user may control, for example, an avatar that may walk around within the scene and interact with generated media objects. Based, for example, on an order and manner with which the user traverses the scene and interacts with the objects, the generative algorithm may generate new content (e.g., the user looks at a particular painting on the wall of a gallery and then opens the curtains of a window). Outside the window may be an entire world that may be consistent with the particular painting that the user viewed. If the user chooses to move the avatar into that world, the painting on the wall updates to reflect the user's interactions.

In another example of immersive user-generated media content engagement, a user may request a science fiction story. In addition to generating a story based on tropes that are generally relevant to science fiction, the GAIE may include tropes that are likely familiar to the user, such as based on the user's age, culture, other interests, etc. (such as science fiction versions of characters that are well-known in the oeuvre of myth and literature to which the user belongs). In some cases, the algorithm may even include individuals in the created story that are analogous to celebrities or public figures in the user's culture or generation, or even the user's own friends and acquaintances.

In example embodiments, a GAIE may be pretrained for market orchestration including configuring a new marketplace, discovery of counterparties, ecosystem-based transactions, aggregation of demand and/or supply, negotiation of contract terms, configuring a smart contract, brokering deals, generating simulations for an exchange digital twin, personalizing financial/trading advice, and the like.

In an example of a GAIE adapted for market orchestration responses, a generative AI interactive agent may enable the configuration of a new marketplace. In another example of a GAIE adapted for market orchestration responses, a generative AI interactive agent may be configured for the discovery of counterparties, assets, and/or marketplaces.

In an example of a GAIE adapted for market orchestration responses, a generative AI interactive agent may be configured to present ecosystem-based transactions. In an example of a GAIE adapted for market orchestration responses, a generative AI interactive agent may be configured to aggregate demand and/or supply. In an example of a GAIE adapted for market orchestration responses, a GAIE may be configured to negotiate contract terms. In an example of a GAIE adapted for market orchestration responses, a GAIE may enable the configuration of a smart contract. In an example of a GAIE adapted for market orchestration responses, a generative AI interactive agent and the like may be configured to broker deals. In an example of a GAIE adapted for market orchestration responses, a generative AI interactive agent may be configured to generate simulations for an exchange digital twin. In an example of a GAIE adapted for market orchestration responses, a generative AI interactive agent may be configured to generate personalized financial and/or trading advice.

In an example of a GAIE adapted for a gaming environment, a generative AI interactive agent that may be configured to generate a gaming environment and/or experience (e.g., such as by using a gaming engine). In an example a GAIE adapted for a gaming environment may be configured to generate a personalized gaming environment and/or experience. In an example, a GAIE adapted for a gaming environment may generate NPC text/conversation so that a gaming environment having a non-player character text generator may use AI/machine learning to interactively pass relevant game objective advancing data to a human player of the game. In example embodiments, a GAIE adapted for a gaming environment may include an interactive agent that navigates a customer journey using a gaming engine and contextual, generative interactive AI based on comparison of a dialogue with a script for the customer journey. In embodiments, a GAIE may be integrated with a gaming engine.

In example embodiments, a superintelligence system may be based on a pre-trained GAIE that facilitates automated discovery of relevant domain-specific knowledge and examples. The superintelligence system may further leverage pre-trained advanced GAIE to leverage domain-specific examples to generate content. Yet further the superintelligence system may include a genetic programming capability to create novel variation. In example embodiments, a superintelligence system may further include feedback systems (e.g., collaborative filtering and automated outcome tracking) to prune variation to favorable outcomes (financial, personalization, group targeting, and the like).

In example embodiments, a GAIE may be pre-trained for use by and/or in cooperative operation with a digital twin engine, such as an instance of an executive digital twin and the like. In an exemplary deployment, a GAIE may interact with a digital twin to provide a narrative about a topic of the digital twin to give to a viewer. In this example, the digital twin may interact with the GAIE (e.g., through an API and the like) to generate a narrative summary for a CEO and a detailed narrative for a CFO.

Executive digital twins may be configured for a particular role or user. Therefore, a GAIE system with a digital twin interface may improve executive digital twin capabilities by curating the data for and populating content for consumption by executive digital twins for different roles. In an example a GAIE may receive information about the executive digital twin as well as about the intended human being represented by the executive digital twin (e.g., the role of the user). The GAIE may determine a degree of narrative detail for each executive digital twin. This may be based on generic executive digital twin/user role criteria and/or refined through interaction with a particular user for the executive digital twin. In example embodiments, a CEO with a tech focus may receive more “in-depth” narrative relating to tech or R&D, whereas a CEO with a financial background may end up receiving narratives that are more focused on financial analysis but less granular on tech-related features.

In example embodiments, a GAIE system that interacts with a digital twin engine (e.g., an executive digital twin instance and/or engine) may determine of the potential universe of content on which it is trained, what may be relevant and what may be noise or unrelated for the specific narrative topic, the target human consumer, and the like. Based on this relevance determination, the GAIE system may generate the output data based on the relevant data and the determined degree of detail.

Further, the GAIE system may also select real time data sources to connect to a target/requesting executive digital twin. The GAIE may further configure consumption pipelines for those sources on the spot (e.g., data source identification, data requests for identified data sources, API configuration, and the like). Therefore, in this example the GAIE system would be identifying data sources and connecting them to an executive digital twin instance/engine.

An example use case may include an executive digital twin that has access to full financial data from a previous time-frame (e.g., a previous year/quarter/month, and the like). The executive digital twin may enable access by the GAIE to all of this data. The GAIE may determine a degree of detail of the data for the intended viewer (e.g., target consumer of a narrative regarding a topic captured in the full financial data).

In the case of a target consumer/view having a role of CEO, the GAIE may determine that the narrative for the CEO will include key insights but not full details. The GAIE may then generate a narrative of the top insights for a target time-frame (e.g., a current quarter) from at least the received data.

A pre-trained GAIE may be used to generate, manage, and/or manipulate digital twins, such as by describing attributes of a digital twin, describing interactions with other digital twins or environments, describing simulations, using digital twin simulation data to generate content, enabling context-adaptive executive digital twins, facilitating development of narratives about ongoing, real time operations, tuned to the preferred conversation style of a user represented by a digital twin, and the like. In example embodiments, a context-adaptive executive digital twin integrated with a generative conversational AI system may be configured to generate a set of narratives about operations of an enterprise based on an input data set of real-time sensor data from the operations of the enterprise. The digital twin (or human user) may prompt the GAIE and/or conversational AI system to compare financials with real-time sensor data.

A GAIE may be adapted (e.g., pre-trained) to facilitate enhancement of AI training data associated with a digital twin application. In example embodiments, a method may include using an AI conversational agent to create synthetic training data.

Further in association with digital twin technology, a GAIE may be adapted for summarizing highly granular data for consumption by an executive digital twin. In this regard, an executive digital twin system may include an intelligent agent that receives a set of customization features from a user (e.g., an executive represented by the digital twin) that include a role of the user within an organization. The intelligent agent may also determine a respective granularity level of a report based on the customization features. In example embodiments, the set of customization features include granularity designations for different types of reports. Yet further, the intelligent agent determines the granularity level of a report based on the role of the user within an organization. Further, the subject matter of the report may be generated based on the role of the user within the organization.

In example embodiments, a speech-based user interface for customizing a level of specificity for generating executive digital twin reports may be operatively coupled to a customized GAIE that processes the speech into a set of report instructions (and optionally report content) based on aspects of the user(s). An example of a speech-based request that may be processed as described may include, “I'd like an executive-summary level report on predictive maintenance” or “I'd like a detailed report on competitor analysis.” The speech-based user interface may respond to such a request by directing a corresponding executive digital twin system to feed a specificity level for parameters to a generative AI engine (e.g., GAIE) as additional input along with the data. In this example, IoT data from manufacturing facilities may be used in predictive maintenance. A response to a prompt regarding preventive maintenance may be customized with a level of specificity based on target report consumer role(s), such as for an operations-based role. A level of specificity may include what are the costs, when is the maintenance needed by, what may be the predicted downtime, how to offset and/or time the maintenance activity, and the like. For a financial-based role, specificity levels may be adapted to address what may be the disruption going to do for the bottom line in the short term; how does this impact our supply; what may the disruption do to our market-share; will it impact our stock price, and the like.

When a digital twin may be used to model an individual, a fine-tuned GAIE may be used to coordinate the digital twin with the human for improved fidelity (e.g., when the human behaves or reacts differently than the digital twin predicts, a GAIE may initiate a dialogue with the user to determine why, and the results may be used to update the digital twin model for the individual). Instead of having a human expert occasionally participate in automated digital twin model training (e.g., to correct errors or provide new examples, and the like), a corresponding GAIE may be occasionally querying the user to solicit more information to update the digital twin model of the individual. As an example, a system may include a digital twin that models an individual, and may further include a conversation engine that facilitates determining an update of the digital twin based on a conversation with the individual that is associated with a difference between an action of the individual and a corresponding action prediction by the digital twin.

In example embodiments, a GAIE system may be configured for use in an automated manufacturing environment. In one example, a user may prepare a descriptive prompt of a desired product to have it 3D printed. The GAIE system may generate a 3D printing set of instructions, such as a configuration of an automated 3D printing machine and a rendering indicative of a result of the 3D printing machine following the instructions. In another example, a user may include a photo/video of product as a prompt along with a request for instructions to 3D print an improved version, such as “I want this bike but I want different tires and I want it to be red.”

Another exemplary use of a pre-trained GAIE may include using user behavioral data to generate guiding recommendations for energy conservation, usage shifting, and the like. In particular, a recommendation system for energy conservation, usage shifting, or optimization may include an integrated generative, conversational AI system that adapts generated output based on user behavior from a user behavior data set.

In example embodiments, an adapted GAIE may facilitate management of energy resources. An energy resource management system may be enhanced to provide advanced intelligence (e.g., superintelligence) to plan, manage, and/or govern DERs and energy generation, storage, consumption, and transmission facilities. Elements of a superintelligent energy management system may include automated discovery of relevant domain-specific knowledge and examples, generative AI to leverage domain-specific examples to generate content, genetic programming to create novel variation, feedback systems (e.g., collaborative filtering and automated outcome tracking) to prune variation to favorable outcomes (financial, personalization, group targeting, etc., etc.), and the like. In an example, a superintelligent AI-enabled management system may be configured to manage a plurality of systems of an energy edge platform via automated discovery, generative AI, genetic programming, and feedback systems.

In example embodiments, a GAIE may be adapted (e.g., trained, pre-trained, and the like) for the field of patents to generate patent claims responsive to being provided a patent disclosure. An enabled GAIE may receive patent claims as a prompt and may generate a supportive patent disclosure therefrom. In example embodiments, an enabled GAIE may be trained to understand a patent structure and a claim structure for a plurality of jurisdictions.

In example embodiments, a GAIE may be pretrained (e.g., finetuned) with a private instance of an enterprise's intellectual property data (e.g., products, business goals, competitive considerations, core inventive ideas, and the like). In example embodiments, a private instance of enterprise data for patent generation may be configured (e.g., as prompt-response pairs) for finetuning the GAIE instance.

Beyond patent disclosure and figure preparation, a GAIE may be fine-tuned to generate figures, disclosure from figures, claims from figures, office action responses, evidence of use (EOU) for patent monetizing, preparing a matrix of patent claims across a portfolio, high level landscape search strings, enhancement of search strings, and the like. Finetuning may include preparation of prompt-response sets for a range of IP-related actions, such as patent claim assertion, infringement analysis and discovery, claim (term) acceptance and/or rejection, estimate of claim scope broadness, claim quality, and the like. In example embodiments, an IP-tuned GAIE may be pre-trained with information from proceedings related to infringement cases to understand the likelihood of infringement, and the like.

GAIE training and IP-integration may facilitate elaboration of broadly stated inventive concepts into disclosure that reflects robust enablement and/or support. In an example, an outline may be an input prompt for the purposes of drafting a patent application (e.g., disclosure, figures, summary, abstract, and optionally claims). A generated result may become a portion of a subsequent prompt along with a description of the general theme, category, focus area and/or other categorization or classification of innovation. In an example, one may describe a transaction environment processing platform and ask for examples of a technical implementation, system, and/or method design, such as: “In the context of a transaction environment processing platform as previously described, what types of hardware and software might be used to implement a governance engine for the transaction environment?”

Regarding an intellectual property (e.g., patent) monetization-focused development process, a GAIE may facilitate predicting, from a market development view, which domains to select and which categories within domains to emphasize based on the ability to determine where business may be shifting over a longer time (e.g., beyond short-term trends). This may include analyzing historical data and current data for one or more IP domains, optionally in near-real time. An IP-monetization-focused GAIE may tie historical and/or current data to investments and actions having occurred in the IP world for, among other things, patent sales and licensing. An IP-monetizing trained GAIE may also develop particular leads and domain categories with the highest probability of success based on previous sales and/or licensing and/or where the market may be heading. There may be risk in making these decisions but using a trained GAIE may lower this risk so that these decisions become more predictable in the future, especially with company data increasing and likely accessible through various channels.

A GAIE may be configured, trained, and/or fine-tuned for a range of functions, including, for example, ingestion of proprietary data, determination of a route, determination of an outcome, approval of release/access to data, making a prediction, pattern recognition, and the like. Yet another example application of a fine-tuned GAIE may include layering of voice and visual commands that may be graduated in sound, volume, or spacing similar to flight avionics, thereby generating scripts for voice over of data and/or presentation material. This may enable the development of synthetic speech technology that generates lifelike (AI-generated) voices for podcasts, slideshows, and professional presentations. This may mitigate needs for hiring a voice artist or using any complex recording equipment (e.g., background noise separation, dubbing, and the like).

In example embodiments, GAIE systems may be configured for facilitating news delivery from NPC-type avatars to adapt current “clickbait” content to conversationally conveyed world news/happenings. In this example, a metaverse environment may include a news-based GAIE conversation agent configured to conversationally inform users of recent events.

Further in context of metaverse technology, a generative AI conversational agent may be configured to populate the metaverse.

Yet further within a context of metaverse technology, a GAIE system may be enabled to augment training data for a customized conversational agent with real-time sensor data sets through collecting information from real-world sensors. In an example, a training data augmentation system may be configured for augmenting training of a conversational agent with data from a real-time sensor data set. Further, a metaverse-associated GAIE system may facilitate augmenting training data for a customized conversational agent with process outcome data. A training data augmentation system may be configured for augmenting training of a conversational agent with process outcome data from a process outcome data set, user behavior data, and the like. In example embodiments, a training data augmentation system based on a GAIE may be enabled (e.g., pre-trained) for augmenting training of a conversational agent with user behavior data from a user behavior data set.

In example embodiments, application of fine-tuned GAIE systems in the field of governance may facilitate advances in automation of governance, such as governing use of copyrighted material. GAIE-based governance systems may further enhance governing AI training, such as conversational AI training data sets for bias and error, governing conversational AI for contextual appropriateness and other stylistic requirements, and the like. A fine-tuned GAIE system may further improve governing secrecy, such as a progression of what elements of secret, proprietary or confidential information are allowed based on a depth of conversation. Governance may further apply to individuals.

Therefore, a governance fine-tuned GAIE system may enhance and/or automate determining a measure of trustworthiness of a user that may be interacting with a generative conversational AI system. Further a governance fine-tuned GAIE system may enrich governance for a generative AI system, such as determining a measure of trustworthiness of a generative conversational AI system. In general, governance use cases may be expanded further in light of GAIE topic-targeting training capabilities.

A fine-tuned GAIE system may play a role in systematic risk identification, management. and opportunity mining. GAIE-based risk identification systems may respond to risk-related prompts, such as “What may else might we know and should be paying attention to?” by curating data sets and automating the processes of identification of systemic risks, identifying a set of likely scenarios and the risks and opportunities arising from those scenarios, identifying paths for resolution and recommending resolutions.

In a real-world example, a GAIE-based risk identification system may have responded to the above prompt with findings for market players and regulators that some U.S. banks were sitting on a combined $600B+ in unrealized Treasury losses. Further such a system may have responded with specificity about any such bank that was a major outlier due at least in part to its size and concentrations that posed a significant systemic risk. Such a system may be configured to inform system-wide warnings so that the worst outcomes may be avoided across the risk pool, not just for outliers. In example embodiments, a risk-enabled GAIE system that may identify hidden and/or not well known risks may be applied to other domains than financial. However, even within a financial domain such a fine-tuned GAIE may facilitate surfacing, with sufficient context, these hidden and/or not-well know risks along with options for resolving these out-sized risks.

Yet another area of risk identification and/or management may involve security concerns with GAIE systems that are configured to generate computer executable code. At the least relying on computers to write computer code raises questions about what security measures are effective and what measures are able to be circumvented by the AI.

A further area of risk identification, management and/or opportunity harvesting may apply to copyright material. Automated computer code generation may inadvertently introduce copyrighted material, such as algorithms. A risk-finetuned copyright GAIE may assist in detecting candidate copyright violations in any programmatic code, including machine generated code.

Risk identification of visual training sets (e.g., images, graphs, and the like) may be enhanced by a fine-tuned GAIE that can process these visual training data sets for authenticity indicators that are coded as non-visual data. This may be similar to tail voltage devices providing messages on the end of sine waves. Visual training sets may be coded with non-visual indicators of authenticity that may be detectable by a fine-tuned GAIE.

Yet another risk-identification related area includes fraud detection. Integrating customer fraud reporting and questioning into pretraining data may enrich holistic scoring, which may comprise a composite score that bridges customer evidence, transactions, and environmental trends. In an example, an AI based fraud detection system may integrate customer fraud reports and questioning into a training/query data set to produce a holistic scoring system, utilizing a composite score that combines customer evidence, transaction data, and environmental trends to provide a comprehensive approach to fraud detection.

Imaging applications may benefit from fine-tuned GAIE systems. In example embodiments, optical content (e.g., screen shots and the like) may be processed by machine vision systems so that the GAIE may describe a scene in the optical content using a generative conversational AI agent. In example embodiments, a GAIE may be configured as a first AI/NN sub-system in a Dual Process Artificial Neural Network (DPANN) architecture. Such a DPANN architecture may include, as a second NN sub-system, a formal logic-based and/or fuzzy-based system. Together these DPANN systems may implement learning processes, model management, and the like. In example embodiments, a DPANN architecture may include features that describe building and managing large scale models.

Referring to FIG. 8, a platform 800 for the application of generative AI may include a robust task-agnostic next-token prediction AI engine 802 that operates to predict a next token given a set of inputs encoded as embedded tokens. A robust task-agnostic next-token prediction AI engine 802 may include deep learning models, which use multi-layered neural networks to process, analyze, and make predictions with complex data, such as language. An objective of the robust next-token prediction AI engine 802 may include data science modeling through, among other things, use of topic-specific embeddings, attention mechanisms, and decoder-only transformer models. Capabilities of such an engine 802 may include a pre-training capability to facilitate configuring next-token prediction for specific subject matter (e.g., marketplace item valuation), a tokenizing capability to facilitate converting complex terms into actionable tokens (e.g., converting compound chemical names into fundamental elements), access to distributed training (e.g., data-parallel training and/or model-parallel training, and the like), few-shot learning to reduce training demand for updates, such as new business intelligence data, and the like. In general the next-token prediction AI engine 802 may combine large language modeling techniques and decoder-only transformer models to generate powerful foundation models for next-token prediction AI content generation.

In example embodiments, the next-token prediction AI engine 802 may be structured with an machine learning (sparse Multi-Layer Perceptron) architecture configured to sparsely activate conditional computation using, for example mixture-of-experts (MoE) techniques. A machine learning architecture may be configured with expert modules that may be used to process inputs and a gating function that may facilitate assigning expert modules to process portion(s) of input tokens. A machine learning architecture may further include a combination of deterministic routing of input tokens to expert modules and learned routing that uses a portion of input tokens to predict the expert modules for a set of input tokens.

A GAIE may be trained to operate within a domain, such as written language, computer programming language, subject matter-specific domains (e.g., a software orchestrated marketplace domain), and the like to generate content (constructs) that comply with rules of the domain. In general, a GAIE may generate content for any topic for which the GAIE is trained. So, for example, a GAIE may be trained on a topic of pig farmers and may therefore generate language-based descriptions, images, contracts, breeding guidance, textual output, and the like for any of a potentially wide range of pig farmer sub-topics.

Adapting a generative AI engine for subject matter-specific applications may include pretraining a next-token prediction AI model-based system through the use of, for example, in-context (e.g., application, domain, topic-specific) examples that are responsive to a corresponding prompt. While the next-token predictive capabilities of the underlying next-token prediction AI engine may remain unaffected by this pre-training, subject matter-specific pre-trained instances may be developed/deployed.

In example embodiments, a platform 800 for the application of generative AI may include a set of subject matter-specific pretrained examples and prompts 804. This set of examples and prompts 804 may be configured by analyzing (e.g., by a human expert and/or computer-based expert and/or digital twin) information that characterizes various aspects of the domain to generate example prompts and preferred and/or correct responses. Pretraining may also include training the next-token prediction AI engine 802 by sampling some text (e.g., prompt/response sets) from the set of subject matter-specific pretrained examples and prompts 804 and training it to predict a next word, object, and/or term. Pretraining may also include sampling some images, contracts, architectures, and the like to predict a next token. These prompt-response sub-sets may facilitate pre-training the prediction AI engine 802 for predicting a next token (e.g., word, object, image element, and the like) for various aspects.

When an instance is implemented for textual generation, such a GAIE instance may be referred to as a natural language generation system that constructs words (e.g., from sub-word tokens), sentences, and paragraphs for a target subject and/or domain.

In example embodiments, real-world instances of the platform 800 may require ongoing updates to facilitate the platform 800 being responsive as aspects of a domain (e.g., a business entity in the domain) change, such as business goals change, new products are released, competitors merge, new markets emerge, and the like. In this regard, training the platform 800 with in-context prompts and examples may be automated and repeated as new data is released for an enterprise to prevent snapshot-in-time data aging-based errors. The platform 800 for the application of generative AI may include an ongoing pre-training module 828 that processes new and updated content into prompt and/or response sets and interactively iterates through rounds of pre-training. New and updated data and/or information may regularly be found in various subject matter specific information sets, such as: a dataset of medical records (e.g., to assist with medical diagnoses), a dataset of legal documents and court decisions (e.g., to provide legal advice), a release of a new product (e.g., images of the product), or a financial dataset such as SEC filings or analyst reports. In example embodiments, uses of the platform 800 may include applying the pre-training and optimizing techniques to a range of different domains (e.g., medical diagnosis, business operation, marketplace operation, and the like) to produce a fine-tuned domain specific token-predictive engine including ongoing refinement through (daily) in-context pretraining.

In example embodiments, an ongoing pre-training module 828 may work with the next-token prediction AI engine 802 to update a set of subject matter specific tokens that may be maintained in a subject matter specific instance token storage facility 808. This subject matter specific instance token storage facility 808 may be referenced by a subject matter specific instance of the next-token prediction AI engine 802 during an operational mode (e.g., when processing inputs/prompts). In example embodiments, the platform 800 may include a plurality of sets of subject matter specific tokens that may be maintained by corresponding ongoing pre-training modules 828.

Training, however, may not ensure that the responses to prompts are correct every time. In general, a business entity is likely to be less interested in a tool that provides answers that are probably right and may differ from time to time. A product that can provide accurate responses (e.g., including taking actions) based on what the end-user wants vastly increases the potential use cases and product value. A high level of accuracy and integration with operational systems may enable such a tool to go beyond just generating new content to be more productive; through integration with workflows, it may facilitate automating workflow actions. In this regard, the platform 800 for the application of generative AI may also include a pre-training optimizing engine 806 that may work cooperatively with the ongoing pre-training module 828 to further refine accuracy of responses to prompts for a domain. The pre-training optimizing engine 806 may facilitate improved accuracy of in-context responses, task-specific fine-tuning, and for sparse model variants of the platform 800, enrich few-shot learning capabilities. In example embodiments, fine tuning may further benefit the platform by reducing bias that may be present in the training data. This may be essential to ensure subject matter specific jargon is adapted as training data changes (e.g., in the digital marketing/promotional space, ensure that “influencer” is replaced with “creator”). Further, a pre-training optimizing engine 806 may provide a wider range of prompts and responses based on user preferences (e.g., speaking styles) to enrich the platform's ability to provide user-centric responses. In example embodiments, user-centric responses may include fine tuning the platform 800 for different roles in an organization. As an example, when a user in a financial planning role inquires about a business development topic, responses may be directed toward the financial planning role (e.g., as compared to a customer/client inquiry about that topic).

A platform 800 for the application of generative AI may be used to produce text-based content for a multi-national entity with employees who speak different languages. While the platform 800 may be trained (and pre-trained) to operate interactively in a plurality of languages, generating automated content may benefit from use of a neural machine translation module 810. In example embodiments, a portion of the entity in a first jurisdiction may produce content in a first language and resulting recurring generated output (e.g., types of reports and the like) may be generated in the first language. However, employees who speak a second language may benefit from the type of report when translated into the employee's native language. Therefore, associating the neural machine translation module 810 with the platform may prove valuable while reducing compute demand for the platform 800.

Emerging next-token prediction AI systems feature increasingly adaptable next token prediction capabilities. These capabilities may be further adapted to assist in closed problem set solution prediction, such as allocation of resources, deployment of a robotic fleet and the like. To achieve greater prediction capabilities, a subject matter specific next-token prediction AI-based engine, such as the platform 800 for the application of generative AI, may include a solution-predictive engine 812 that leverages next-token (e.g., next word) predictive capabilities to predict a most-likely solution to a closed solution-set problem. This may be accomplished optionally through use of sets of problem domain-specific pre-training prompts and examples. Such examples may be adapted for different user preferences. In example embodiments, each user in a closed problem set environment may generate prompts and responses that may enable the platform 800 to respond to the user based on the user's inquiry style. Alternatively, the solution prediction engine 812 may adapt a user's prompt and/or configure a prompt based on user preferences to attempt to deliver responses that are consistent with a user's preferences (e.g., engineering-based responses for an engineer role-user and legal-based responses for a lawyer).

For more complex analysis and decision making/predicting, a formal logic-based AI system 814 may be incorporated into and/or be referenced by the subject matter specific platform 800.

Further, the basic concepts of next-token prediction of a generative AI engine, such as the platform 800 for subject matter based application of generative AI may be applied to analyzed expressions of images, audio (e.g., encoded text), video (e.g., sequences of related images), programmatic code (domain-specific text with readily understood rules), and the like. Therefore, a next-token prediction AI platform (e.g., platform 800) may further include an image/video analysis engine 816 (optionally NN-based) that adds a spatial aspect to the next-token predictive capabilities of a next-token prediction AI system. Images used for training may include 3D CAD images (for a domain that includes physical devices such as vehicles), radiologic images (for a medical analysis domain), business performance graphs, schematics, and the like. In example embodiments, aspects of the underlying task-agnostic next-token prediction AI engine 802 may be adapted (e.g., different embeddings, neural network structures and the like) for different input formats, such as images, temporal-spatial content, and the like.

The platform 800 may further include an expert review and approval portal 818 through which an expert (e.g., human/digital twin, and the like) can review, edit, and approve content generated. Examples include review and adaptation by a subject matter specific data story expert; a data scientist, and the like. The expert review and approval portal 818 may operate cooperatively with, for example, the pre-training optimizing engine 806 that may receive and analyze expert feedback (e.g., edits to the content and the like) for opportunities to further optimize the platform 800.

The platform 800 may further include a training data generation facility 820 that may generate natural language prompts, such as subject matter specific prompts that may be applied by, for example, the pre-training optimizing engine 806 to increase platform response accuracy and/or efficiency while fine tuning a subject matter specific instance.

In example embodiments, the platform 800 may further be configured to access a corpus of domain and/or problem relevant content as a step in responding to a prompt. In example embodiments, the platform may be pre-trained on the content of the corpus. While the content of the corpus may not be directly included in the response, such as if it provides a level of detail beyond what the platform 800 has been trained to provide in a response, it may be cited in the response to facilitate identifying and expressing sources from which a response is derived. These external source references may be handled via a citation module 822.

Business decisions are often context-based. Understanding both the context for a decision and aspects and/or assumptions of the decision process may prove highly valuable for evaluating, for example, competing decisions and/or recommendations. Context may include both tangible and intangible factors. An intangible factor may include historical interactions between parties involved in the evaluation process, for example. A decision process may include not only assumptions on which a decision or recommendation is based, but also criteria by which tangible factors are processed, evaluated, analyzed, and the like. To provide such context for generated output of the platform 800, an interpretability engine 824 may be incorporated into and/or be accessible to the platform 800. An objective of use of the interpretability engine 824 may be to generate additional content that reflects context for, among other things, how the next-token prediction AI instance operates and/or generates a corresponding output.

In example embodiments, the next-token predictive capabilities of a next-token prediction AI engine 802 may be utilized for developing a set of emergent data science predictive and/or interpretive skills. While such a platform may be trained directly on various data sets, context for elements and results in such data sets may be a rich source of complementary training data. By associating data elements with descriptions thereof, the platform 800 may gain data science capabilities, such as to group by or pivot categorical sums, infer feature importance, derive correlations, predict unseen test cases, and the like. In this regard, a data science emergent skill development system 826 may be utilized by the platform to enhance further subject matter specific applicability and utility.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices.

In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like.

These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

### Enterprise Access Layer

### Introduction

One environment that can utilize the functionality of an access layer is an enterprise. An enterprise generally refers to an organization with a particular overarching purpose, goal, or objective. For instance, a purpose may be to produce and market a particular set of one or more product lines, to undertake a charitable activity, to provide a public service, or other purpose. To achieve its purpose, an enterprise may have a structure that includes various business units, such as executive officers, a board of trustees or directors, divisions, departments, managers and other job roles, facilities and other assets, a wide array of projects, activities, processes and workflows, etc. Some enterprises span multiple business sectors and therefore have business units, such as divisions, that can be dedicated to a particular business sector.

Enterprises, usually by their size and nature, can have a wide array of resources and assets. For instance, their resources may include raw materials, equipment, devices, systems, products (e.g., parts, components, sub-assemblies, assemblies), capital, knowledge, and technology among others. Some examples of knowledge resources include resources that are customer-based (e.g., customer lists or customer transactional history such as order history, contact information, demand frequency, etc.), vender/supplier-based (e.g., suppliers, procurement information, supply transactional history, etc.), process-based (e.g., formulations, procedures such as standard operating procedures, technical data sheets, process reports such as material compliance reports or quality reports, or other memorialized process expertise), and research-based (e.g., research and development information or reports). Enterprise resources may also include human resources, including expertise and knowledge of enterprise personnel and contractors, or personnel and contractors of customers, suppliers, vendors, partners, etc. Technology resources may include resources such as inventions, trade secrets, designs, proprietary information of the enterprise (e.g., proprietary software or processes), etc.

In some embodiments, some or all of the resources of the enterprise may be represented in some digital form (e.g., a particular file format), such that these resources may undergo management and processing actions such as being copied, edited, shared, transferred, exchanged, updated, recorded, monitored, accessed, extracted, transformed, loaded, compressed, decompressed, deleted, obsoleted or otherwise processed, such as in digital form or between digital form and another form (such as where knowledge of an expert worker or other individual is accessed by querying the worker through a crowdsourcing system). Even resources that have not had a conventional digital format (e.g., physical goods or equipment) may be represented in a digital format. For example, a non-fungible token may be used to represent resources that are not digital. Additionally or alternatively, some aspect of a resource (e.g., a physical good) can be represented as a digital form or via a digital proxy. For instance, a physical resource may have an associated digital certificate of authenticity, proof of purchase, deed, or a title.

Due to the expanding evolution of digital assets, it is inevitable that enterprises demand an efficient and robust manner of managing digital assets. For example, just as enterprises have historically and efficiently engaged in the transaction of physical goods and the logistics involved in those transactions, enterprises will likely need to address similar aspects for digital transactions. Furthermore, with digital assets, there may be different issues that need to be addressed due to the digital nature of these assets when compared to physical assets. For instance, although unauthentic copies of physical goods are feasible, often, depending on the physical good, the energy, expertise, or equipment needed to generate a copy of physical goods can by itself inhibit copying and help promote the authenticity of a physical asset. In comparison, a digital asset may be easier to replicate. For example, computing has predominantly evolved with a particular simplicity to read/write functionality; making digital files/formats in many cases effortless to duplicate often with minimal loss. Ease of duplication can result in complications, such as where a digital asset is copied and widely distributed and some copies are subsequently modified, making it difficult to determine which versions, among many, are valid. Problems of provenance and validity are compounded with the increasing presence of dynamic digital such as smart contracts and dynamic objects, that are serially updated without human intervention through a network, often by linkage to other dynamic objects that are of uncertain provenance.

Another aspect that is different between physical assets and digital assets is interoperability. Interoperability refers to the ability of systems to exchange and use information. For a physical asset, supply chains are typically structured by participating enterprises to facilitate structural interoperability (such as among the component parts of a system), chemical operability (such as among constituent ingredients in a recipe), etc. For digital assets (such term including physical assets that have a digital component or capability (such as smart devices and systems)), interoperability may have a variety of different issues. For example, having the computing resources to interact with a digital asset may not be cost prohibitive. Therefore, there may be a large number of entities that are able to cooperate with regard to a digital asset. Additionally, the number of entities is fairly elastic because it may quickly increase or decrease depending on the scarcity or demand for the digital asset (e.g., due to its low-cost barrier to entry). Yet a potential outgrowth of the large number of entities that are able to interact with a digital asset is that the access point should have the capability to accommodate for variance between the entities and/or the volume of entities; as a result, communication protocols, authentication protocols, validation protocols, formatting protocols, etc. need to consider the many actors that are able to participate in the digital asset ecosystem.

The management of digital assets and the transactions they involve may also be able to capitalize on their digital ecosystem. That is, the mechanism involved in transactions for digital assets may leverage computing resources to promote optimal transactions. In other words, with digital assets being digital, they are inherently associated with computing resources and therefore a transaction ecosystem can utilize the associated computing capabilities to potentially enhance the circumstances of a transaction involving a digital asset. As an example, it is not uncommon for an asset to have some inventory period where the owner or controller of the asset has the asset available but needs to identify a receiving party and/or terms for the transaction of the asset.

With the computing resources associated with the digital asset or available to the holder of the digital asset, a transactional ecosystem can be configured that can provide autonomy and/or self-promotion for transactions or asset management actions for a digital asset; that is, instead of the manual execution or facilitation of agreements regarding the transactions of digital assets, a transactional ecosystem for the digital asset can automate and/or facilitate one or more phases associated with digital asset transactions. These phases may include a discovery/identification phase that identifies a candidate transaction opportunity involving a digital asset, a diligence/evaluation phase that may evaluate the parameters of the transaction opportunity, a configuration phase that may configure the proposed terms of the transaction (e.g., an exchange rate or a time for the transaction), a negotiation phase that may adjust the terms of the transaction through one or more rounds of negotiation, an execution phase that executes the configured transaction for the digital asset and/or a performance phase that executes performance of one or more actions called for by the terms of the transaction (e.g., delivery of a digital asset to a defined address at a defined time). In this sense, the transactional ecosystem may be capable of self-promoting because the transactional systems can identify candidate transactions for a digital asset without potentially needing human intervention. Although this level of autonomy is feasible, the digital ecosystem may also operate as a hybrid such that certain aspects of the transaction request require some form of authorization prior to automatic execution (e.g., authorization from external source such as a manual input). Additional aspects of various phases of digital asset transactions, such as relating to counterparty discovery, monitoring of collateral, automation of underwriting, automated negotiation, and many others are described in the documents incorporated herein by reference and are intended to be encompassed herein except where context prevents) and/or direct instruction to perform one or more of the phases associated with a digital asset transaction.

To address the growing demands for effective digital asset ecosystems, the approach described herein may include an enterprise access layer. In some implementations, an “enterprise” access layer refers to a network access layer by which an enterprise may access various digital assets and resources (including various entities described in connection with the transaction platforms and systems described herein and in the documents incorporated herein by reference) that may be involved in a set of transactions—such as bilateral or multilateral transactions involving the enterprise, as well as ones enabled by a set of marketplaces, exchanges, etc. that an enterprise interacts with—via a set of network resources. The enterprise may have control (e.g., direct control), management authority, and/or rights to use or access a set of digital assets that are presented to or accessible via the access layer. In embodiments, an enterprise access layer is capable of simplifying transactions for an enterprise (such as reflecting “consumerization”) because it allows an enterprise to interface with multiple markets, marketplaces, exchanges, and/or platforms (e.g., relating to different business segments) through a common point of access.

One advantage of an enterprise access layer is that it may be configured to operate in conjunction with technologies that enterprises deploy in their own environments (i.e., on their private networks, including on-premises and cloud resources and platforms). This may include a wide range of software applications, programs and modules, services and microservices, etc. —including blockchains, distributed ledger technology (DLT), decentralized applications (dApps), intelligent agents, robotic process automation systems, and a wide variety of big data, analytics and artificial intelligence systems. In one non-limiting example, as enterprises deploy DLT and/or dApps, many enterprises will likely want this technology to assimilate with the other systems, structures and workflows of the enterprise.

Throughout an enterprise, different entities may have different roles and responsibilities that can result in varying levels of permission and/or access to enterprise resources. For example, a human resource employee is unlikely to be able to access machinery or equipment of a manufacturing engineer for the same business. Similarly, it is not likely that the manufacturing engineer can access other employee's personnel files like the human resource employee.

Based on such differences, technology deployed internally for an enterprise is likely to have some level of permissioning. In embodiments, an enterprise may prefer for the permissioning of technologies like DLTs and dApps to be similar to or aligned with the physical resource access that is customary to a particular role. For example, when a resource is authenticated and stored on an enterprise's blockchain, that human resource employee would not be an authentication stakeholder for an operations-based resource (e.g., a manufacturing resources), or vice versa.

Generally speaking, a permissioned distributed ledger (e.g., a blockchain) refers to a ledger design where the ledger is not open for everyone to participate in a similar manner like a permissionless ledger (e.g., a public blockchain). Rather, a permissioned ledger may be configured such that participants have particular control/access rights. Enterprises may tend to deploy permissioned systems in their private networks to have access safeguards for enterprise resources while public distributed ledgers attempt to be wholly decentralized and allow anyone to participate with the ledger. For example, enterprises may prefer to deploy permissioned systems because these systems can shield sensitive information, ensure member compliance, and ease the rollout of particular, member-level deployments such as updates and reconfigurations.

### Enterprise Ecosystem

FIG. 9 is an example of a general structure for an enterprise 900 ecosystem. In embodiments, the enterprise 900 ecosystem is an ecosystem where market participants 910 are able to utilize public or third-party services 920 to interface with an enterprise 900 via an enterprise access layer (EAL) 1000. In some embodiments, the market participants 910 may be any entity that interacts with the enterprise 900, such as buyers, sellers, vendors, suppliers, manufacturers, service providers, partners, distributors, resellers, agents, retailers, brokers, promotors, advertisers, clients, escrow agents, advisors, customers, bankers, insurers, regulatory entities, hosts (e.g., of marketplaces, exchanges, platforms or infrastructure, among others), logistics and transportation providers, infrastructure providers, platform providers, and others (including various entities described elsewhere herein and/or in the documents incorporated by reference herein). As shown in FIG. 9, some market participants 910 may be buyers 912 (also referred to as purchasers or customers) when the enterprise 900 is the asset provider (e.g., the enterprise is the selling, giving, or sharing party). Market participants 910 may also be sellers 914 (also referred to as venders or providers) when the enterprise 900 is the receiving party or asset acquirer.

The EAL 1000 may be configured to interact with the market participants 910 (and the ecosystem(s) in which they interact) in a variety of ways. For example, the EAL 1000 may be integrated or associated with one or more marketplaces 922 such that the EAL 1000 functions as its own market participant on behalf of the enterprise 900. By being associated with potentially numerous marketplaces (e.g., marketplaces that correspond to the type or nature of the enterprise assets), the EAL 1000 can perform complex or multi-stage transactions with enterprise assets (e.g., in a series or sequence of timed stages, simultaneously in a set of parallel transactions, or a combination of both).

In an example of a multi-stage transaction, the enterprise 900 may perform a sequence of transactions. For example, the sequence of transactions may be for the purpose of acquiring or accessing a resource from another source (e.g., one of the sellers 914). For instance, the enterprise 900 demands resource ALPHA. However, the enterprise 900 may not have any assets that are directly exchangeable for resource ALPHA. Therefore, the EAL 1000 may be configured to recognize how to acquire one or more assets that are exchangeable for resource ALPHA using the available digital assets of the enterprise 900. To illustrate, the enterprise 900 may have resources BETA and GAMMA.

To acquire resource ALPHA, the EAL 1000 identifies that resource DELTA is directly exchangeable for resource ALPHA. In this example, the EAL 1000 may perform transactions with BETA and GAMMA to acquire DELTA in order to finally acquire resource ALPHA. For instance, the EAL 1000 exchanges resource BETA with a first asset source for resource EPSILON and then is able to exchange both resources GAMMA and EPSILON for resource DELTA from a second asset source. With the acquisition of resource DELTA, the EAL 1000 exchanges resource DELTA with a third asset source for resource ALPHA. Without an EAL 1000, acquiring resource ALPHA may be rather difficult because it demands access to multiple sources (e.g., across multiple marketplaces) and mapping how resources associated with those sources can be leveraged to obtain a target resource. Yet with the EAL 1000 that has access to multiple marketplaces 922 and market participants 910, the EAL 1000 can configure and/or execute a transaction sequence or routine that maps how to obtain the target resource (e.g., resource ALPHA). This may occur regardless of relationship between marketplaces 922 and/or market participants 910 such that the EAL 1000 may leverage disparate and independent markets to perform a transaction for a target resource. In other words, resource E may be offered or available in a marketplace 922 that is a different and distinct marketplace 922 from the marketplace 922 that offers the target resource, resource ALPHA.

In embodiments, elements of a multi-stage sequence may be conditional, such that a contingent condition must be satisfied in order for a later stage to commence after completion of a prior stage. Conditions may include ones based on pricing, timing, and other transaction parameters.

In addition to marketplaces 922, the EAL 1000 may interact with market participants 910 via third-party systems 924 (some or all of which may be implemented as third-party services). Some examples of third-party systems 924 include various financial services/systems such as operated by banks, insurers, lending institutions, valuation services, trading services, or escrow services, authentication services/systems, auditing services/systems, security system/services, etc.

In some examples, the market participants 910 and/or marketplaces 922 may use or be associated with a storage system 926 (which may be implemented as a storage service). In some configurations, the storage system 926 may include an append-only persistent storage system such as a blockchain (e.g., as labelled in FIG. 9). An append-only persistent storage system refers to a storage system that, when storing data, appends blocks of the newest data to be stored to the most recent block previously stored. In this sense, the chain of storage blocks may function as a time sequence, which may be cryptographically secured to form an immutable time sequence. This structure may be advantageous because someone who has access to the storage system may be able to determine a history of data storage transactions with relative ease. A blockchain storage system may be a permissionless storage system that is open to all of its members (e.g., all or some portion of participants 910 in a marketplace 922) or a permissioned storage system depending on the nature of the marketplace 922 or the third-party system 924 associated with the storage system 926.

As described previously, the enterprise 900 may include enterprise devices 1020 (e.g., enterprise equipment such as user devices, on-premises, cloud and other network infrastructure, general and/or specialty processors (e.g., edge processors), internet of things (IOT) and industrial internet of things (IIoT) devices), systems, processes, etc.) that generate, interface, or generally impact enterprise resources 1010.

As with the non-enterprise aspect of the enterprise 900 ecosystem (for example, a market-participant side 904 shown in FIG. 9), in some examples the enterprise 900 includes a private storage system 1040. In various implementations, the private storage system 1040 may include one or more private append-only storage systems, such as private blockchains. The private storage system 1040 may be considered private in that the enterprise 900 controls the access and permission for the private storage system 1040. For example, the private storage system 1040 may be only accessible to devices that have access to a private network associated with the enterprise 900, such as a WAN. In some implementations, the enterprise 900 has more than one private blockchains in order to tailor to, for example, the organizational structure of the enterprise 900. For instance, the enterprise 900 may have (i) one private blockchain that corresponds to a storage system for operations or a product-generating portion of the enterprise 900 and (ii) another private blockchain that corresponds to storage systems for administrative portions of the enterprise 900. As another example, the enterprise 900 may have a single blockchain with a set of sidechains for components or organizational units of the organizational structure of the enterprise 900.

In addition to a private blockchain, the enterprise 900 may include an enterprise data store 1030. When compared to a blockchain, a data store refers to a set of data storage types that is not limited to an append-only persistent data storage structure. Rather, an enterprise data store 1030 may be any one or combination of a relational database (e.g., a structured query language (SQL) database), a non-relational database (e.g., a non-SQL database), a key-value store (that is, a map from keys to values), a full-text search engine, a distributed database, a set of network-attached storage resources, a message queue, or other data storage system or service of any of the many types described herein or in the documents incorporated by reference herein.

The enterprise data store 1030 may store enterprise data that is obtained from enterprise resources 1010 or from other various data sources 1050 of the enterprise 900. For example, FIG. 10 depicts that the enterprise 900 may include internal or private enterprise systems that generate data specific to the enterprise 900 (which may be referred to as enterprise data). While the enterprise 900 may have few or even zero of these private enterprise systems that function as data sources 1050, examples of the data sources 1050 include enterprise resource planning (ERP) systems 1052, customer relationship management (CRM) systems 1053 that contain customer-related information, healthcare systems 1054, supply chain systems (e.g., supply chain management (SCM) systems) 1055 that include intra-organizational and/or inter-organizational supply chain information, product life cycle management (PLM) systems 1056 that include product or service lifecycle information (e.g., data characterizing items, parts, products, documents, product/service requirements, engineering change orders, and quality information), human resources (HR) systems 1057, accounting systems (not shown), and research and development (R&D) systems (not shown).

In some examples, as shown in FIG. 10, the enterprise 900 includes a set of analytic systems 1060. The analytic systems 1060 may refer to tools deployed by the enterprise 900 to perform analysis for various processes or systems associated with the enterprise 900. For instance, an enterprise 900 may find it pertinent to their operations to perform market analytics (e.g., for advertising, new product development, and/or marketing purposes), so the analytic systems 1060 may include a market analysis system 1062. Another type of analytics that the enterprise 900 may perform is demographic analytics, so the analytic systems 1060 may include a demographic analysis system 1064. Demographic analytics may aid an enterprise to understand relevant demographic, psychographic, location, behavioral and other information about customers, venders, employees, potential employees, or a target marketplace. For instance, an enterprise 900 uses demographic analytics to determine how a new product can reach a particular target demographic or how an existing product/service is perceived by various demographics. Additionally or alternatively to market analytics and/or demographic analytics, the analytic systems 1060 of the enterprise 900 may be configured to perform an array of statistical analysis, so the analytic systems 1060 may include a statistical analysis system 1066. This statistical analysis may be used to support many different activities throughout the enterprise 900 including analytics performed by other systems of the enterprise 900 or of the analytic systems 1060 themselves (e.g., supporting the market analytics, the demographic analytics, or any of a wide variety of other analytics described herein or in the documents incorporated by reference herein).

FIG. 9 and FIG. 10 illustrate examples of the EAL 1000. In both of these examples, the EAL 1000 is shown to include a number of EAL systems (also referred to as modules or EAL modules) that enable the functionality of the EAL 1000. In some examples, these EAL systems are deployed in a container that is specific to the EAL 1000. When deployed in a container for the EAL 1000, this containerized instance means that the EAL 1000 includes the necessary tools and computing resources to operate (i.e., host) the EAL systems without reliance on other computing resources associated with the enterprise 900 (e.g., computing resources such as processors and memory dedicated to the EAL 1000). For example, the container for the EAL 1000 may include a set of one or more systems, such as software development kits, application programming interfaces (APIs), libraries, services (including microservices), applications, data stores, processors, etc. to execute the functions of the EAL systems that may enable the EAL 1000 to provide enterprise asset transactional management and other functions and capabilities described throughout this disclosure. References herein to “EAL systems” should be understood to encompass any of the foregoing except where context dictates otherwise.

In some implementations, a set of the EAL systems leverages computing resources considered to be external to the EAL 1000 (e.g., separate from computing resources that have been dedicated to the EAL 1000, such as, in embodiments, computing resources shared with other enterprise applications or systems). In these implementations, the set of EAL systems leveraging external computing resources may be in communication with computing resources specific to the EAL 1000. This type of arrangement may be advantageous when one or more of the EAL systems are computationally expensive and would increase the computational requirements for an entirely contained EAL 1000, such as when one or more of the EAL systems causes the EAL 1000 to be a relatively expensive EAL deployment.

For instance, an arrangement leveraging external (e.g., shared) systems may be beneficial for EAL systems that are infrequently utilized. To illustrate, a first enterprise may rarely use an EAL system, such as a reporting system. Here, instead of ensuring that the EAL 1000 has the computational capacity to support a reporting system by itself, the enterprise 900 configures the reporting system to be hosted by and/or supported by computing resources external to the EAL 1000 to deploy a relatively lean form of the EAL 1000 (i.e., an EAL container that does not include resources dedicated to a reporting system or that includes only limited resources dedicated to the reporting system with the capability to access additional, external resources as needed).).

In some configurations, the EAL 1000 or a set of the EAL systems leverages computing resources considered to be external to the EAL 1000 for support. An example of this support may be that the EAL 1000 or the set of EAL systems demands greater computing resources at some point in time (e.g., over a resource intensive time period) —for instance, greater may mean more computing resources than a normal or baseline operation state. In this example, for instance, the enterprises resource not dedicated to the EAL 1000 or EAL systems can assist or augment the services provided by some aspect of the EAL 1000. To illustrate, the EAL leverages enterprise resources to assist or augment the performance of analysis, such as managing and/or analyzing governance for health care data associated with clients of a particular enterprise.

In embodiments, the deployment of the EAL 1000 may be configurable. For example, the enterprise 900 or some associated developer can function as a type of architect for the EAL 1000 that best serves the particular enterprise 900. Additionally, or alternatively, the deployed location of the EAL 1000 may influence its configuration. For instance, the EAL 1000 may be embedded within an enterprise (e.g., non-dynamically) where it can be specifically configured using various module libraries, interface tools, etc. (e.g., as described in later detail). In some examples, the configuring entity is able to select what EAL systems will be included in its EAL 1000. For instance, the enterprise 900 selects from a menu of EAL systems. Here, when an EAL system is selected by the configuring entity, a configuration routine may request the appropriate resources for that EAL system including SDKs, computing resources, storage space, APIs, graphical elements (e.g., graphical user interface (GUI) elements), data feeds, microservices, etc. In some implementations, in response to the request, the configuring entity can dedicate the identified resources of each selected EAL system. For instance, the configuring entity associates the dedicated resources to a containerized deployment of the EAL 1000 that includes the selected EAL systems.

### EAL Systems

Referring specifically to FIG. 10, the EAL 1000 includes a set of EAL systems. The set includes an interface system 1110, a data services system 1120, an intelligence system 1130, a scoring system 1134, a data pool system 1136, a workflow system 1140, a transaction system 1150 (also referred to as a wallet system or a digital wallet system), a governance system 1160, a permissions system 1170, a reporting system 1180, and a digital twin system 1190. Additionally, although particular types of EAL systems are described herein, the functionality of one or more EAL systems is not limited to only that particular EAL system, but may be shared or configured to occur at another EAL system. For instance, in some configurations, some functionality of the transaction system 1150 may be performed by the data services system 1120 or functionality of the governance system 1160 may be incorporated with the intelligence system 1130. In this respect, the EAL systems may be representative of the capabilities of the EAL 1000 more broadly. In embodiments, the set of EAL systems involved in any particular configuration of the EAL 1000 may include any of the systems described throughout this disclosure and the documents incorporated by reference herein, such as systems for counterparty discovery, opportunity mining, automated contract configuration, automated negotiation, automated crowdsourcing, automated facilitation of robotic process automation, one or more intelligent agents, automated resource optimization, resource tracking, and others.

In some embodiments, one or more of these systems can be configurable (much like an ERP, a CRM, or the like). The configurations can be done by selecting pre-defined configurations/plugins, by building customized modules, and/or by connecting to third party services that provide certain functionalities.

As will be discussed, in some embodiments, certain aspects of a configured EAL may be dynamically reconfigured/augmented. In some examples, reconfiguration/augmentation may include updating certain data pool configurations, redefining certain workflows, changing scoring thresholds, or the like. Reconfiguration may be initiated autonomously (for example, the EAL periodically tests configurations of certain aspects of the EAL configuration using the digital twin simulation system and analytics system) or may be expert-driven (e.g., via interactions between an EAL “expert” and an interactive agent via a GUI of the interface system 1110).

### Interface System

The interface system 1110 communicates on behalf of the EAL 1000 and/or enables communication with the EAL 1000 by one or more entities, which may include human operators and/or machines. To communicate on behalf of the EAL 1000, the interface system 1110 is capable of communicating with some or all portions of the enterprise 900: for example, enterprise devices 1020, representatives (not depicted graphically) of the enterprise 900, and/or private storage systems 1040 of the enterprise 900. The enterprise devices 1020 may include processors 1022, user devices 1024, and internet of things (IoT) devices 1026, including industrial IoT (IIoT) devices.

In some examples, to communicate with the enterprise 900, the EAL 1000 is configured with access rights to the private network of the enterprise 900. With access to the private network of the enterprise 900, the interface system 1110 can function as a communication conduit to call a system or device of the enterprise 900 in order to support another EAL system. Additionally, the interface system 1110 enables there to be a central communication hub that members of an enterprise 900 may use to engage with functions of the EAL 1000. For instance, a business unit decides to offer a set of the enterprise resources 1010 as a digital enterprise asset that is available to market participants 910. Here, a member of the enterprise 900 or an enterprise device 1020 responsible for the set of the enterprise resources 1010 communicates the set to the transaction system 1150 via the interface system 1110.

As a central communication hub, the interface system 1110 may be used by the EAL systems to communicate with endpoints at the enterprise side (for example, shown as an enterprise side 902 in FIG. 9) or the market-participant side (for example, shown as the market-participant side 904 in FIG. 9). For example, the interface system 1110 operates in conjunction with the EAL systems of the EAL 1000 to ensure that the interface system 1110 includes the appropriate APIs, links, brokers, connectors, bridges, gateways, portals, services, data integration systems or other ways of translating communications (e.g., data packets or data messages) of intra-EAL systems (e.g., between EAL systems) and/or from the EAL systems to an endpoint on the enterprise side (e.g., one of the enterprise devices 1020) or the market-participant side (e.g., a marketplace 922, the storage system 926, or market participant 910).

For example, the interface system 1110 may include an application programming interface (API) 1112 that the enterprise 900 uses to receive or to obtain reports from the reporting system of the EAL 1000. The interface system 1110 may implement a graphical user interface (GUI) 1114, such as via a web server, for use by actors on the enterprise side 902 or the market-participant side 904. Developers associated with the enterprise side 902 or the market-participant side 904 may connect to the interface system 1110 by using a software development kit (SDK) 1115.

As shown in FIG. 10, the interface system 1110 may include an authentication system 1116 and/or a security protocol system 1117 as a way to enforce who has the ability to use the EAL 1000. For instance, an entity that is able to use to use the EAL 1000 may receive credentials that indicate the entity's access permission(s) with respect to the EAL 1000. These credentials may be login credentials, an authentication token, digitized cards/documents, biometric feature(s), one-time passwords, or any other information that functions as proof that the entity has a right to access the EAL 1000 via the interface system 1110. In embodiments, credentials may be managed by an identity-as-a-service platform or other identity management systems. The credentials may be handled by the permissions system 1170. Authentication of an entity may include authentication of human users and/or authenticating specific devices/software systems that are authorized to interact with the EAL 1000.

In various implementations, a set of credentials simply attests to the identity of the individual; then, a back-end system, such as the permissions system 1170, maps that identity to specific access rights. In some examples, the set of credentials also identifies the access rights of the entity. When the set of credentials identifies the access rights of the entity, the interface system 1110 may be able to determine the access rights and tailor which portions of the interface system 1110 that the entity can access. In embodiments, the interface system 1110 is capable of restricting portions of various interfaces or communication channels to EAL systems of the EAL 1000 using the information contained or indicated by credentials that have been associated or issued to an entity.

The interface libraries 1118 may be supplemented in order to allow the interface system 1110 to connect to new actors or data sources on the enterprise side 902 or the market-participant side 904. The GUI 1114 may allow for expert training, client requests, provider response interaction, authentication, machine-to-machine (M2M) communication (through a machine using an agent, such as a scripted web agent, to interact with a graphical user interface), programming, and servicing. The GUI 1114 may present an interface for configuring workflows in the workflow definition system 1142, for configuring the capabilities, such as by selecting subsystems, of the EAL 1000, for defining data pool templates in the data pool system 1136, etc. The GUI 1114 may also provide access to the reporting system 1180 by regulators, auditors, government entities, etc.

### Data Services System

The data services system 1120 performs data services for the EAL 1000, which may include a data processing system 1122 and/or a data storage system 1123. This may range from more generic data processing and data storage to specialty data processing and storage that demands specialty hardware or software. In some examples, the data services system 1120 includes a database management system 1125 to manage the data storage services provided by the data services system 1120. In some configurations, the database management system 1125 is able to perform management functions such as querying the data being managed, organizing data for, during, or upon ingestion, coordinating storage sequences (e.g., chunking, blocking, sharding), cleansing the data, compressing or decompressing the data, distributing the data (including redistributing blocks of data to improve performance of storage systems), facilitating processing threads or queues, etc. In some examples, the data services system 1120 couples with other functionality of the EAL 1000. As an example, operations of the data services system 1120, such as data processing and/or data storage, may be dictated by decision-making or information from other EAL systems such as the intelligence system 1130, the workflow system 1140, the transaction system 1150, the governance system 1160, the permissions system 1170, the reporting system 1180, and/or some combination thereof.

In some implementations, the data services system 1120 includes an encryption system 1124 offering encryption/decryption capabilities that pair with the data processing/storage. For instance, the encryption system 1124 may decrypt data when encrypted data is retrieved from its data store(s). In other situations, the data services system 1120 may encrypt data that is being used, processed, and/or stored at the EAL 1000. For instance, the encryption system 1124 receives data to be stored, determines that the received data includes one or more characteristics that satisfy an encryption rule, and encrypts the data prior to, during, or after the data is transferred to a storage location. In this respect, the encryption system 1124 may receive an encryption or decryption request that specifies data associated with the data services system 1120 and the data services system 1120 is capable of fulfilling the request and providing the encrypted/decrypted data to the requesting entity. The encryption system 1124 may be configured to provide symmetrical encryption, asymmetrical encryption, or other suitable types of encryption. Some encryption algorithms that the data services system 1120 may use are Advanced Encryption Standard (AES), Rivest-Shamir-Adleman (RSA), and variations of Data Encryption Standard (DES) (e.g., 3DES), among others. Additionally or alternatively, the encryption system 1124 may also perform hashing or other cryptographic functions to verify data that it manages for the EAL 1000. Operation of the encryption system 1124 may be controlled according to the permissions system 1170.

The data services system 1120 may include a hardware system 1126 that provides the computing and storage for the other elements of the data services system 1120. The hardware system 1126 may include processors, memory, cache, secondary storage, etc. The data services system 1120 may also rely on cloud-hosted storage and compute services, whether public or private. A networking system 1127 allows for interfacing with cloud-hosted storage and compute services. The networking system 1127 may also facilitate transfer of instructions and data within elements of the EAL 1000 as well as with other actors.

### Intelligence System

In FIG. 13, an example implementation of the intelligence system 1130 may include an intelligence service controller 1331 and a plurality of adapted AI modules 1332, among others. In some examples, the intelligence service controller 1331 may include an analysis management module 1333, a governance library 1334, and/or a set of analysis modules 1335, among others. The analysis management module 1333 may include similar features and/or may be configured to carry out similar operations as one or more other management modules described herein. The governance library 1334 may include similar features and/or may be configured to carry out similar operations as one or more other libraries described herein. The set of analysis modules 1335 may include similar features and/or may be configured to carry out similar operations as one or more other analysis modules described herein. In some implementations, the adapted AI modules 1332 may include a machine learning module 1336, an analytics module 1337, a generative AI module 1338, a natural language processing module 1339, a robot process automation module 1340, and/or a neural network module 1341, among others. The machine learning module 1336 may include similar features and/or may be configured to carry out similar operations as one or more other machine learning modules described herein. The analytics module 1337 may include similar features and/or may be configured to carry out similar operations as one or more other analytics modules described herein. The generative AI module 1338 may include similar features and/or may be configured to carry out similar operations as one or more other generative AI modules described herein. The natural language processing module 1339 may include similar features and/or may be configured to carry out similar operations as one or more other natural language processing modules described herein. The robot process automation module 1340 may include similar features and/or may be configured to carry out similar operations as one or more other robot modules described herein. The neural network module 1341 may include similar features and/or may be configured to carry out similar operations as one or more other neural network modules described herein.

The intelligence system 1130 of the EAL 1000 functions to provide intelligent functionality to the EAL 1000.

Among other aspects, the intelligence system 1130 is a system that the EAL 1000 can use for decision-making regarding transactions for enterprise digital assets. For instance, the intelligence system 1130 may recruit and/or coordinate a set of EAL systems (e.g., including enterprise sources) as necessary to provide a set of outputs in response to one or more intelligent requests (i.e., decision-making request). Some intelligent or decision-making functionality that the intelligence system 1130 is capable of providing includes peer or counterparty discovery (i.e., identifying parties for a transaction, such as one using enterprise assets or assets that are desired to be acquired by or for an enterprise, among others), automated asset allocation and position maintenance (e.g., automated acquisition or disposition of assets to maintain a desired allocation of assets across asset classes, such as to maintain a desired balance of risk and return across the asset classes), automated asset management (e.g., determining which wallets of the wallet system that an available enterprise asset should be associated with), automated transaction configuration (e.g., assembling smart contract and/or smart contract terms for a set of digital asset transactions), automated negotiation of transaction terms, automated settlement (e.g., by execution of on-chain transfers), modeling or analysis of a set of transactions or a transactions strategy, forecasting or predicting asset or transaction parameters (e.g., prices, trading volumes, trading timings, etc.), automated prioritization (e.g., prioritization of transactions among a set of transactions, of assets among a set of assets, of workflows (e.g., prioritizing a set of workflows among others for access to available resources of the EAL 1000), configuration of transaction timing, and/or automated management of a set of policies (e.g., enterprise governance policies, regulatory or legal policies, risk management policies, and others).

In embodiments, the intelligence system 1130 is capable of learning from prior transactions to inform future transactions. To have this learning capability, the intelligence system 1130 may include a set of learning models that identify data and relationships in transactional data, such as transactional training data set consisting of historical training data (which, in embodiments, may be augmented by generated or simulated training data). Models may include financial, economic, econometric, and other models described herein or in the documents incorporated by reference herein. Learning may use an expert system, decision tree, rule-based workflow, directed acyclic workflow, iterative (e.g., looping) workflow, or other transaction model. Some examples of learning models include supervised learning models, unsupervised learning models, semi-supervised learning models, deep learning models, regression models, decision tree models, random forest or ensemble models, etc. Learning models may use neural networks (e.g., feedback and/or feedforward neural networks, convolutional neural networks, recurrent neural networks, gated recurrent neural networks, long short-term memory networks, or other neural networks described in this disclosure or in the documents incorporated herein by reference). Learning may be based on outcomes (e.g., financial yield and other metrics of enterprise performance), on supervisory feedback (e.g., from a set of supervisors, such as human experts and/or supervisory intelligent agents), or on a combination.

In some examples, the learning models of the intelligence system 1130 may train using enterprise data that relates to transactions for digital enterprise assets. In this case, training data sets may be proprietary to the enterprise. By having enterprise specific training data sets (that is, with enterprise training examples), the enterprise 900 learns how to predict transactional behavior with data tailored specifically to the enterprise 900 and characteristics of its assets (such term including, except where context indicates otherwise, assets controlled by the enterprise as well as other assets that may be involved in the workflows of the enterprise, such as assets being pursued for acquisition, borrowing, lending, etc.). In some examples, the learning models may train first from a larger corpus of training data (e.g., public training data set) and then undergo a fine-tuning process that trains with a specialized data set that is particular to digital enterprise assets. In these examples, the weights or biases that are configured during the first stage of training with the larger corpus may then be fine-tuned or adjusted during the second stage. In some examples, the fine-tuning of the second stage also assists to prune nodes that have low impact on enterprise-specific data that would not have been pruned by solely training with the larger corpus. In other words, the enterprise-specific data of the second stage of training that fine-tunes the model reduces nodes that do not influence (e.g., the probability) a transaction event regarding an enterprise digital asset.

In some configurations, the intelligence system 1130 includes one or more modules that function to gather data for purposes of training a model of the intelligence system 1130. For example, the intelligence system 1130 includes data pipelines that include data that characterizes digital enterprise assets that are available in a wallet system (e.g., the transaction system 1150), data that characterizes historical, current or predicted state/status data about entities involved in enterprise transactions or workflows, data that characterizes historical, current or predicted state/status data about enterprise assets or resources, etc. In some examples, these modules that function to gather data for purposes of training a model of the intelligence system 1130 gather, derive, or generate training data from information associated with one more EAL systems. For instance, the training data may be governance/compliance information, such as rules, that can be used to develop models that provide decision-making compliance or predictive compliance. In this example, the governance/compliance data may be translated into enterprise-specific data for the second state of training when the governance/compliance data is specific to the enterprise.

In some implementations, each model, module, service, etc. of the intelligence system 1130 may correspond to a particular marketplace 922 or type of marketplace 922. For instance, the training data to train a marketplace's specific model may consist of transactional data for that marketplace 922 or type. By having a model that is specific to a particular marketplace 922 or type, the model can be capable of predicting transactional information or transactional events for the marketplace 922 or type. Therefore, the EAL 1000 can leverage the prediction from the model to inform transactional actions for a digital enterprise asset available to the particular marketplace 922 or type.

In embodiments, the intelligence system 1130 may include search functionality, such as enabling searching for assets within a wallet of the enterprise or searching within other data resources of the enterprises for assets that may be appropriate for inclusion in the wallet. The search function may use similarity algorithms (e.g., k-means clustering, nearest neighbor algorithms, or others) to discover assets that may be of interest by virtue of similarity to other transacted assets and/or ones presented in a wallet. A search algorithm may be trained, such as based on outcomes of transactions or enterprise or user actions, to identify relevant assets for wallet inclusion and or to identify relevant assets within a wallet for a possible transaction. In embodiments, the search functionality may enable recommendations, such as recommendations of assets for inclusion in wallet, for inclusion in a transaction, for presentation, etc. Recommendations may, in embodiments, be based on algorithms, including clustering and similarity algorithms that recommend similar transactions to similar parties, collaborative filtering algorithms in which users indicate preferences as to types of assets or transactions and based thereon are associated with other similar users whose actions and transactions inform recommendations, deep learning algorithms, that are trained on transaction outcomes, and many others.

In embodiments, the intelligence system 1130 may facilitate prioritization, such as by alignment of functions and capabilities according to a set of prioritization rules, such as rules that prioritize certain enterprise entities (such as particular workgroups), that prioritize certain types of transactions (such as time-sensitive trading versus long-term resource acquisition), etc. In embodiments, the prioritization rules may be linked to and/or derived from a set of enterprise plans, such as strategic plans, resource plans, etc. This may include optionally translating a set of strategic or resource goals into a set of priorities that are applied as rules to transactions. In embodiments, prioritization rules are dynamically and automatically updated based on changes to resource plans, strategic plans, etc. by virtue of integration between the intelligence system 1130 and one or more enterprise planning systems. For example, if a resource plan indicates a need to acquire a critical input resource for an operating function, the intelligence system 1130 may prioritize discovery of candidate sources for that resource. As another example, if a strategic plan indicates a need to dispose of an asset to reduce exposure to market volatility, the intelligence system 1130 may prioritize presentation of the asset in wallet or other interface in order to facilitate rapid disposal of the asset.

Additionally, or alternatively, the intelligence system 1130 may be capable of configuring other EAL systems (for example, via an intelligence service controller shown in FIG. 10). For example, the intelligent functionality of the intelligence system 1130 may provide configuration details or configuration inputs to other EAL systems. When the intelligence system 1130 configures other EAL systems, the intelligence system 1130 enables the EAL 1000 to operate autonomously or semi-autonomously. That is, the EAL 1000 is capable of operating without human intervention (that is, partially or fully autonomously) such that the EAL 1000 coordinates, controls, and/or executes transactions regarding digital enterprise assets on its own accord. Configuration itself may be autonomous, such as using robotic process automation (where an agent is trained to undertake configuration based on training on a set of expert configuration actions), by learning on outcomes, or by other learning processes described herein or in the documents incorporated herein by reference.

In some configurations, a set of models of the intelligence system 1130 functions to predict or recommend configurations for other EAL systems of the EAL 1000. That is, each EAL system may have a configuration protocol that includes parameters that enable a respective EAL system to perform a particular function. Here, a model of the intelligence system 1130 may be trained to generate an output that serves as a configuration parameter for an EAL system. In this respect, one or more models of the intelligence system 1130 may be used to generate predictions or recommendations to configure one or more EAL systems to perform a particular transaction for an enterprise digital asset. Prediction of configuration of one EAL system can be used in the configuration of another EAL system, such as to harmonize configurations across the systems (e.g., to allow development of a logical or efficient sequence of transactions that are governed by the respective systems, to allow effective coordination of EAL resource utilization, to avoid conflicts (e.g., where different systems seek to undertake inconsistent actions with respect to the same resource or asset), etc. Additional examples of intelligence systems and services are described elsewhere in the disclosure.

### Scoring System

In FIG. 15, an example implementation of the scoring system 1134 includes a data scoring engine 1510, a blockchain scoring system 1520, a model scoring engine 1530, a buyer scoring engine 1540, a seller scoring system 1550, and a transaction scoring system 1560.

The blockchain scoring system 1520 may assess the reliability of data and smart contracts stored on a distributed ledger (such as blockchain). The buyer scoring engine 1540 may leverage know-your-customer technology to determine the identity of a buyer and then determine the reliability of the buyer in the buying role (for example, based on credit score, past and pending payments to the enterprise 900 and third parties, etc.). Similarly, the seller scoring system 1550 may, once the identity of a seller is established, determine the reliability of the seller in the role of a seller (for example, based on quality history, timeliness of delivery, and warranty performance). In other words, it is possible that a single entity may have different seller and buyer scores according to respective performance in those roles. As the reliability of an entity decreases, the level of approval for a transaction with that entity may increase and/or a different approval workflow may be triggered.

The transaction scoring system 1560 may assess a risk level of a transaction, as discussed elsewhere in this disclosure, including taking into account risks associated with currency fluctuations and liquidity of assets. As the predicted risk exposure of a transaction increases—for example, making a payment in a currency whose value may increase before the transaction is completed, or receiving an asset whose value cannot be easily recognized due to illiquidity in the relevant market—the level of approval may increase and/or a different approval workflow may be triggered.

The scoring system 1134 can be configured to monitor and score data, data sets, and data sources to assess reliability and accuracy. For example, the data scoring engine 1510 may generate a score, which is a comprehensive term encompassing, as examples, a numeric value or a classification. In various implementations, a numeric value may be an indication of reliability on a scale of 0 to 100. A classification may include an enumerated set of “reliable,” “apparently reliable,” “apparently unreliable,” “unreliable,” “manipulated,” and “unknown.” Manipulated data may include data that is malicious, fake, misleading, unreliable, or biased. Examples of manipulated data include bot-generated transaction requests, bot-generated data, certain crowd-sourced data (i.e., comments, reviews, social media interactions, etc.), astroturfing, sockpuppeting, false flag information, etc.

A score may be assigned to each datum, to each data set, and to each data source. Any object, such as a data pool, relying on data may store the score as well. In various implementations, data in a data pool may have respective scores; depending on the type of request made to the data pool, data from the data pool may be filtered according to the respective scores. For example, a data request to the data pool may specify a source threshold and a data threshold; only data from the data pool that is derived from a data source having a score above the source threshold will potentially be available and then only those data whose individual scores are above the data threshold will actually be available. Beyond filtering, the score may allow for weighting. For example, all data below a first threshold may be excluded, while data between the first threshold and a second threshold may be weighted less than data above the second threshold; continuing this example, data with scores between the first threshold and the second threshold may be weighted along a sliding scale (which may be linear, logarithmic, etc.) such that data with scores near the first threshold have very low weightings and data with scores near the second threshold have very high weightings; meanwhile, all data with scores above the second threshold may have the same weighting (where the weighting is expressed as a percentage, this data may have a weight of 100%).

Thresholds may vary based on the purpose—in various implementations, data used to train machine learning models may require higher thresholds to avoid poisoning or biasing the model. Even for a single purpose (like training a neural network or other machine learning model), the thresholds may also depend on the use of the model: a model that informs a safety-related decision may have much higher thresholds than a model that determines consumer sentiment for advertisement purchasing decisions.

In addition to allowing for filtering and weighting, the score may be used as an input for decision making by the EAL 1000, including the workflow system 1140 and the data pool system 1136. For example, certain data sources may be excluded from certain or all data pools depending on their score. The level of reliability of data and data sources may be specified by a template from the data pool library 1410 as part of the data pool configuration.

Scores may be stored separately, such as in a relational database of the data management system 1470, or incorporated into the data itself, such as prepended or appended to each data file (for example, as a header). In various implementations, a metadata object including the score may be cryptographically signed by the scoring system 1134, so that any entity with access to the public key of the scoring system 1134 can verify the provenance of the metadata object (in other words, that the metadata object has not been tampered with). In various implementations, the data itself may be cryptographically signed as well, either with the same or another signature.

Reliability of data may be determined from intrinsic attributes (the data itself) and extrinsic attributes (for example, the source of data, the type of data, etc.). Intrinsic attributes may be determined from patterns in data values. As an example, survey data received from human subjects may be expected to have wide variability; if many sets of incoming survey data are identical, this may be an indication of bot-generated content or of a more innocuous situation, such as an error that led to duplication of one survey response. The data may include identifying information, such as geography, IP (internet protocol) address, MAC (medium access control) address, mobile network, browser type, browser fingerprint, etc. A large chunk of data from a single IP address or range may be an indication of unreliability of that data. However, an IP address or range may be used by many more devices being a network address translation (NAT) router, so historical attributes of those IP addresses may also be assessed.

In various implementations, for computational efficiency, data is sampled such that only some data is checked for reliability. The checked data may be randomly sampled (without replacement) and the level of sampling may be dependent on reliability or confidence in the data source—that is, a larger percentage of data will be sampled from less-reliable data sources or from data sources where there is less confidence in their reliability.

As another example, data may include not just values but also timestamps. When a spike of activity indicates many more data points than usual, this may also be evidence of bot-generated content. Further, there may be natural patterns in the data, such as time-of-day and day-of-week—for example, data points generated by a business may generally be less frequent before normal work hours begin and after normal work hours end, and also be less frequent on holidays and weekends. In such an example, the work hours may be known a priori or inferred based on historical data; they are generally region-specific, with different time zones corresponding to different ranges of work hours. When a set of data aligns with work hours from the wrong time zone (that is, a time zone not associated with the entity location that is supposed to be producing the data), this may be an indication of the data being injected from another country: for a U.S. business, data coinciding with working hours in Russia may be an indication of unreliability.

The data scoring engine 1510 may include multiple intrinsic machine learning models. In various implementations, each intrinsic machine learning model may be trained on historical data from sources having a reliability score above a threshold. Then, new data from sources having a reliability score below the threshold are inputted to the machine learning model—the machine learning model can identify whether the data is anomalous, which might be an indication of unreliability. The model may also be configured with a priori data, such as if there is a known or expected distribution of values, such as a Gaussian distribution. While the data scoring engine 1510 may be configured to automatically assume that data generated within the enterprise 900 and the EAL 1000 is completely reliable, for some or all data—such as sensor data (such as from the IoT/IIoT devices 1026) —data scoring may be applied.

Data may be tagged or otherwise associated with a data source and the data source may have an associated score. The score may be known a priori—for example, the reliability score of data generated by the EAL 1000 itself may be associated with a high reliability score. In various implementations, the data may be provided by or derived from a machine learning model—such a score may come from the model scoring engine 1530. The model scoring engine 1530 may generate a score for a model based on the reliability of data being ingested by the model as well as parameters of the model. For example, a model that evidences bias over time may receive a lower score. The model scoring engine 1530 may also use features such as accuracy (general or specific sub-class), speed, cost, availability, and compute requirements (which, in various implementations, overlaps with cost). The model score may be used for general model selection (e.g., for inclusion into a configuration) or can be used in real time by a higher-tier intelligence controller, such as the intelligence system 1130. For example, the higher-tier intelligence controller can receive or determine a set of input considerations (such as importance of the task, budget per API call, speed requirements, etc.) and may select a model to use based on the considerations and outputs from the model scoring engine 1530.

Extrinsic attributes of data may also be used in assessing the reliability of data. For example, the reliability of a data source may be determined. This source reliability may be used in assessing the reliability of any set of data. Credible data or data sources can be scored higher than their counterparts. For example, social media or crowd sourced data may be scored lower than financials generated or received from a financial institution. In various implementations, a machine learning model may be trained to generate a prediction indicative of reliability of a source. The source reliability model may include features provided by the intrinsic data scores; data that seems to have intrinsic unreliability (for example, as described above, deviations from an expected distribution or unexpected timing patterns) will lead to the source being considered less reliable.

In various implementations, one feature, which may be weighted strongly in the machine learning model, is whether the data source is internal—by default, data developed within the EAL 1000 or the enterprise 900 may be associated with a high reliability. However, in various implementations, some data developed by the EAL 1000 may be associated with inherent reliability risks, such as sensor data. Therefore, there may be multiple classifications applied to internal data with respect to this feature.

Another feature for the data source machine learning model may be the provenance of the data from the data source. When the data of a data source is obtained from other parties, their reliability may need to be assessed. In some cases, the other parties are too numerous to individually assess, such as in the case of crowdsourced data. When reliability of multiple parties cannot be practically or even conceivably assessed, this may lead to the data source being considered less reliable. In other words, the data source machine learning model may have a feature related to the extent of the data being derived from crowdsourcing. This feature, or another feature, may reflect parameters of the crowdsourcing that may lead to inferences of reliability. For example, the level of anonymity of data provided by numerous parties may be a feature—generally, the more anonymous the data, the less reliable the data source. Other parameters may also impact this or other features, such as whether the data source curates the data or the parties in any way. As one specific example among many, customer reviews on an ecommerce platform may have reliability indicia of the review, such as whether the review is associated with a confirmed purchase and whether the review is associated with a reviewer's real name. Some of these features may not strongly impact the source reliability score—in the ecommerce example, tying a review to an actual purchase does not protect against the seller from using cutouts to make purchases and then provide reviews, while simply receiving the products back, losing out on only the ecommerce platform's overhead.

The reliability score for a data source may be based on historical reliability of the data source, with historical data weighted (for example, linearly or exponentially) such that more recent reliability data is more important than older reliability data. The data source reliability score may also be impacted by the relationship of the enterprise to the data source—for example, customers or sellers with a high number of amount of transactions with the enterprise 900 may be a feature that leads to a higher assessment of the reliability of their data. Still further, the data source machine learning model may take into account data generated by subject matter experts about the reliability of the specific data source, the class of data source, the industry of the data source, etc.

The data source reliability score may take into account external data about the data source, such as whether and how recently they have suffered a data breach, how long they have been in business, how long they have been offering this type of data, etc. In addition to the reliability score, or incorporated into the reliability score, may be a confidence measure. Although a data source may appear to have high reliability, if the data source is new and unvetted, the confidence in that high reliability may be lower.

### Data Pool System

In FIG. 14, an example implementation of the data pool system 1136 includes a data pool library 1410, an access assignment system 1440, an analysis system 1450, a pool construction system 1460, and a data management system 1470. The data pool system 1136 manages, defines, creates, stores and provides access to datasets to systems of the EAL 1000 in response to a data request. The data pool system 1136 may process the data request and provide access to a data pool with relevant data to the data services system 1120, the permissions system 1170, the transaction system 1152, and/or component(s) thereof from the data pool library 1410. In various implementations, the data may actually be stored by the data services system 1120 while the data pool library 1410 provides management and access services—in this respect, the data pool system 1136 may act like an interface layer or a materialized view of a database.

The data pool system 1136 may configure datasets to streamline predefined functions, for example, using workflows obtained from a workflow system 1140. A data pool may be a structured datastore configured and instantiated to respond to a particular request. The data pool may store training data for a machine-learning model, whether that machine-learning model is part of the EAL 1000 or a third party; when a third party, the data may be exchanged for compensation or in trade for third party training data. A data pool may also be used to collect and provide data for use the digital twin system 1190, including data gathered from the IoT/IIoT devices 1026. A data pool may be used for each reporting or audit process. In some instances, a data pool may be instantiated just at the time of creating a report or conducting an audit, and in other instances, a data pool may persist for an entire reporting interval, gathering data to allow for reporting.

A data pool may include data from one or more sources (e.g., entities, EAL systems, enterprises, IoT networks, digital products network, etc.) structured for the particular purpose of responding to a request (i.e., query). For example, a data pool for reporting expenses for an enterprise may for a data pool that multiple employees or entities within an enterprise may add to and/or read from. The pool construction system 1460 of the data pool system 1136 may structure the data into a format according to a set of rules. For example, newer data may be given higher prevalence than older data, data with higher trust scores may be presented in a more optimal position than other data, older data may be aggregated in the data pool, crowdsourced data may be added in a less optimal position than data from other sources, etc. In various implementations, newer data may be stored in a more preferential manner—for example, cached in lower latency storage; meanwhile, older or less reliable data may be stored in slower storage media and perhaps stored in compressed form, with the level of acceptable loss for lossy compression increasing based on age. In addition to traditional compression, data may be aggregated based on age; for example, older data may not be stored as daily values but as monthly values, while even older data may be aggregated into annual values.

In various implementations, the analysis system 1450 is configured to analyze a request and obtain one or more data files from the data pool library 1410 that can be used to respond to the request. The data pool library 1410 includes a repository of data files, and a plurality of pool systems, including one or more of an open pool system 1414, a social pool system 1426, a protected pool system 1418, a local pool system 1430, a generative pool system 1422, a temporal pool system 1434, and a library management system 1438. In some example embodiments, each of the pool systems may be configured to allow the deployment of data files contained therein based on a set of permission rules to comply with internal and external requirements (e.g., government requirements, security requirements, regulations, internal enterprise compliance policies, etc.) defined by an entity associated with an enterprise. The set of permission rules may include access rules (e.g., entity type permissions, authorization rules, location rules, etc.), scoring thresholds, restrictions on type of use, encryption/decryption rules, request/transaction type rules, workflow type rules, device type rules, etc.

The pool construction system 1460 generates and/or configures a data pool based on a set of requirements and/or access rules by applying the rules to each data set (such as data file) within the pool. The pool construction system 1460 may obtain relevant data from any source within the EAL 1000 or outside of the EAL 1000. For example, the pool construction system 1460 may access any of the data sources 1050 of the enterprise 900 as well as external data sources, including those on the market-participant side 904 such as public blockchain storage systems 926. In constructing the data pool, the pool construction system 1460 may create data structures using data types specified by templates, such as ones defined by the library management system 1438. Each template may specify data structures (such as arrays, linked lists, etc.), data types—whether a programming language built-in type (such as integer, string, enumerated set, etc.) or a type that may be more complex (such as date, time, currency, etc.) —granularity of data, metadata fields for each datum (such as time of incorporation into the data pool, last access time), metadata fields for the data pool (such as date of creation, permission structure, etc.), reporting requirements, and audit requirements (such as the need to log all changes).

In some examples, the data pool library 1410 includes a library management system 1438 to manage the data pools provided/generated by the data pool system 1136. In some configurations, the library management system 1438 is able to perform management functions such as querying the data pools being managed, organizing data pools for, during, or upon ingestion, coordinating storage sequences (e.g., chunking, blocking, sharding), cleansing the data pools, compressing or decompressing the data pools, distributing the data pools (including redistributing blocks of data pools to improve performance of storage systems) and/or facilitating processing threads or queues, and the like.

In some examples, the data pool system 1136 couples with other functionality of the EAL 1000. As an example, operations of the data pool system 1136, such as data pool processing and/or data pool storage, may be dictated by decision-making or information from other EAL systems such as the data services system 1120, the intelligence system 1130, the workflow system 1140, the transaction system 1150, the governance system 1160, the permissions system 1170, the reporting system 1180, the scoring system 1134, and/or some combination thereof.

The data pool library 1410 includes a repository of data pools and may include one or more of an open pool system 1414, a social pool system 1426, a protected pool system 1418, a local pool system 1430, a generative pool system 1422, a temporal pool system 1434, and a library management system 1438. A data pool may include a series of files configured for a particular purpose. In some example embodiments, each data pool may be configured to allow the deployment of data files contained therein based on a set of permission rules to comply with internal and external requirements (e.g., government requirements, security requirements, regulations, internal enterprise compliance policies, etc.) defined by an entity associated with an enterprise. The set of permission rules may include access rules (e.g., entity type permissions, authorization rules, location rules, etc.), scoring thresholds, restrictions on type of use, encryption/decryption rules, request/transaction type rules, workflow type rules, device type rules, etc. A pool construction system 1460 of the data pool system 1136 may generate and/or configure the data pools based on the set of requirements/access rules by applying the rules to each data file within the pool.

The data pool system 1136 may further include an access assignment system 1440, an analysis system 1450, a pool construction system 1460 and a data management system 1470. In some implementations, the analysis system 1450 may receive a data request from the workflow system 1140. The analysis system 1450 may analyze the data request to determine the types of data required to respond to the data request. For example, a data pool constructed for processing of an auto loan application may include local data stored on the EAL 1000 (e.g., automobiles owned by a user, financial institution used by user, etc.), payment history stored at a third-party EAL, prediction data generated by machine learning applications predicting future payment potential for the user, etc. Based on the data required to respond to the request, analysis system 1450 may send data requests to the data pool library 1410 or subsystems thereof for data collection. For example, the analysis system 1450 may extract user identification data and send it to the data pool library 1410 for collecting relevant data instances for creation of the data pool by the pool construction system 1460. In the auto loan example, the analysis system 1450 may send a request to the local pool system 1430 for the local data, to the temporal pool system 1434 for payment history, and to the generative pool system 1422 for prediction data. The data pool library 1410 may then send the relevant requested data to the pool construction system 1460 to construct a data pool responsive to the request from workflow system 1140. The pool construction system 1460 may aggregate the data into a data pool based on rules associated with each portion of data received from the data pool library 1410. The pool construction system 1460 may provide access to the data pool to the workflow system 1140 as a response to the data request.

Access to the data pool system 1136 library may be governed by the permissions system 1170. Access may be controlled both at the source data level and at the data pool level. For example, the permissions system 1170 may dictate which data sources which entities are allowed to access. If a data pool draws from a source that an entity is not allowed to access, the entity may be prevented from accessing that data pool, or the data pool may need to be filtered before or as part of the access. Further, the permissions system 1170 dictates which entities are permitted to construct data pools, and which types of data pools can be constructed; for example, some entities may be restricted to a proper subset of the available data pool templates, while other entities are restricted to the entire set of available data pool templates and are simply not permitted to specify a custom data pool template.

The open pool system 1414 may allow for configuration of an open data pool such that any entity internal to or external to the EAL 1000 can access the open data pool without restrictions. In this example, the data pool may be configured such that any number of enterprises, users, devices, and/or digital agents may contribute specific type(s) of data to the data pool. In some example implementations, the open pool system 1414 may apply rules to configure data pools based on manual input from an entity of the EAL 1000 responsible for that data pool indicating that the data pool may be shared without restrictions. In other example implementations, the open pool system 1414 may determine whether the data pool being configured includes data of a type that can be configured as an open data pool based on open pool requirements provided by the entity of the enterprise. The analysis system 1450 may analyze a data pool to determine whether a data pool may be configured as an open data pool based on the open pool requirements specifying the type of data pools that may be made available to the public and/or other entities without restriction. The analysis system 1450 may analyze the data pool to determine, for example, whether any portion of the data pool includes a type of data that should be subject to restrictions (e.g., personally identifiable information, credit card information, medical information, etc.). If the data pool includes such information that may need to be restricted, the analysis system 1450 may invoke the protected data pool system 1136 to configure the data pool. Otherwise, the analysis system 1450 may send the data pool to the open pool system 1414 for processing, configuration, and storage.

The protected pool system 1418 offers data protection for data pools within the data pool library 1410, including encryption/decryption capabilities and/or role-based access capabilities that pair with data pool processing/storage/access. The protected pool system 1418 may configure data pools based on permission rules defined by the entity of the enterprise. A data pool may be configured with permission rules that differ for different entities with access to the data pool. For example, a data pool including credit scores may be accessible by a bank, a financial entity, and an automobile dealer, with each having different requirements for accessing the data in the credit score data pool, including who can access the data, where the data can be accessed, data rights (e.g., read, write, etc.), etc. Each data pool may be associated with a set of permission rules per entity allowed access to that data pool.

The access assignment system 1440 may determine that a data pool within the protected pool system 1418 may be included in a response to the received request. The access assignment system 1440 may also be invoked by the network availability system 1175 to create a data pool of data that will be needed in the absence of network connectivity. The access assignment system 1440 may determine which entities can have access to the data pool so that when a data request is made, the data is present and the permission are defined even without being able to make external network requests.

In embodiments, permission rules may include an authorization rule indicating that access to a data pool requested by an entity requires authorization from one or more other entities. For example, the protected pool system 1418 may configure a data pool with a set of authorization rules that define which types of users and/or request types must have explicit authorization to access certain types of data. These authorization rules may define an authorization hierarchy that indicates which types of employees can authorize an access request, which employees or types of employees must have their requests authorized, request types that require authorization, etc. The protected pool system 1418 may associate the authorization rules with the data pool such that the permissions system 1170 may determine whether a transaction request requires further authorization based on the entity data and the authorization rules defined by the enterprise. In these embodiments, the authorization rules may define rules that define the roles or identities of enterprise entities that are able to authorize data access for certain business units, users, and/or third-party entities. For example, access requested by a certain business unit may require a manager or director of the business unit to authorize the transactions. In another example, access requests meeting certain criteria may require authorization from a person having a specified title, such as the CEO, CFO, or a manager in the finance department. In various implementations, the workflow system 1140 may manage obtaining this authorization. In various implementations, the access assignment system 1440 may provide the data pool along to the permissions system 1170 for analysis of the associated permission rules and execution (or non-execution) of access provision to the requestor.

In some example implementations, the permission rules may include encryption rules for encryption of certain data fields within the data pool (e.g., payment information such as card numbers, routing numbers, communication addresses, personal identification information, regulated medical information, etc.) prior to sharing the data pool with an entity. In such implementations, the permission rules for the data pool may include encryption types (e.g., private encryption, public encryption, data scrubbing, symmetric encryption, asymmetric encryption, hashing, etc.) associated with each data field to be encrypted, encryption key(s) and/or decryption keys that may be used by the transaction system 1150 and/or the permissions system 1170 to encrypt/decrypt the associated data fields of the data pool prior to communicating the data pool with the requested entity. In this way, the protected pool system 1418 may assign rules to a data pool to control access to the data pool in order to comply with requirements of the entity controlling the data pool.

In some implementations, the permission rules may include scoring rules, such as a scoring threshold, for determining whether a data pool can be used to respond to a certain type of request by a certain entity. In an example implementation, each data file may be configured to include a trust score obtained from the scoring system 1134. Pool construction system 1460 may analyze each potential data file obtained from the data services system 1120 to be included in a data pool based on its trust score obtained from the scoring system 1134 to determine whether the trust score for the potential data file meets the required scoring threshold prior to being added to the corresponding data pool. Different rules for data pools may be based on request types (e.g., medical data request, social media request, HR request, financial transaction request, etc.), workflow types, device types (e.g., personal device, through enterprise API, enterprise device, etc.), location types (e.g., foreign country, within the United States, embargoed countries, within permitted enterprise locations, etc.), employee security levels, employee groups/teams, etc. Other non-limiting examples of authorization rules are described elsewhere throughout the disclosure.

The social pool system 1426 may configure data pools received from internet-based sources, such as, crowdsourcing, social media applications, reviews, comments, IoT, etc. The social data pool system 1136 may include rules for applying a scoring algorithm to each data file received from an internet-based source. In some implementations, social data pool system 1136 may determine whether a data file is from a trusted source based on a variety of factors, such as but not limited to, IP address of the device used to generate the data, user identification of the data creator, spoofing algorithms, etc. In this implementation, the social data pool system 1136 may prevent a data pool from including data that is untrustworthy or malicious, such as fake data injected by devices into the data pool, bot-generated reviews, comments, social media interactions, enterprise data that contains latent bias, etc. The data pool system 1136 may trigger the data management system 1470 to monitor the data in the social pool system 1426 periodically for untrustworthy/malicious data. In some implementations, the data pool system 1136 may automatically trigger the data management system 1470 to monitor a new data file for untrustworthy/malicious data when the new data file is first injected into the data pool system 1136. The social pool system 1426 may attach the monitoring rules to any portion of data it provides to pool construction system 1460 for generation of a data pool to be shared with other EAL systems.

The local pool system 1430 allows an entity to configure data pools from a fixed data repository stored only within a datastore of the EAL 1000 (or within the combination of the EAL 1000 and the enterprise 900). The local pool system 1430 may monitor the local data store on a periodic basis for any new data files/instances stored in the data store. In some implementations, the local pool system 1430 may continuously monitor the local data store for updates. The local pool system 1430 may associate enterprise level access rules that are specific to sharing data located in the local datastore. The rules may specify entities of the enterprise that may access the data within the datastore, the access capabilities (such as read, write, aggregate into a report, delete, etc.) for different entities, compliance requirements, regulatory requirements, etc. Newly received data files/instances may be vetted and/or scored using the scoring engine prior to being added to a data pool by pool construction system 1460 in order to respond to a data request.

The temporal pool system 1434 may be configured to interact with the market participants 910 (and the ecosystem(s) in which they interact) to gather data to respond to the request in full. For example, the temporal pool system 1434 may be integrated or associated with one or more of the marketplaces 922 such that the EAL 1000 functions as its own market participant on behalf of the enterprise 900. By being associated with potentially numerous marketplaces (e.g., marketplaces that correspond to the type or nature of the enterprise assets), the temporal pool system 1434 can perform complex or multi-stage data transactions with enterprise assets (e.g., in a series or sequence of timed stages, simultaneously in a set of parallel transactions, or a combination of both).

The analysis system 1450 may determine that a portion of data required to respond to a data request is not present in the data pool library 1410 and, in response, it may trigger temporal pool system 1434 to collect, in real time, resources/data files from third-party market participants 910. The temporal pool system 1434 may determine a data file required to respond to the quest and the third-party market participant that may be able to provide access to that data file. The temporal pool system 1434 may determine a sequence of data transactions to receive the required data file. In some instances, the temporal pool system 1434 may determine that multiple data files from multiple market participants are required to respond to the data request and generate a sequence of data transactions including sequential tasks, parallel tasks, and/or combination thereof to be performed to collect the required data files.

In an example of a sequence generated by the temporal pool system 1434, in response to a request for an auto loan execution, the analysis system 1450 may determine that a data pool to respond to the request requires data from third-party market place participants 910. The analysis system 1450 may trigger the temporal pool system 1434 to collect the requisite data files from the third-party marketplace participants 910. The temporal pool system 1434 may determine that the requisite data files may be requested from a financial institution, an auto dealership, and the loan requestor. For example, the temporal pool system 1434 may request an initial set of information from a loan requester using a loan requester device (e.g., user device, kiosk, web-based user interface, etc.). The information requested can include name, salary, car model, financial institution of the loan requester, etc. Contingent on receiving the information from the loan requester device, the temporal pool system 1434 may send a request for an auto loan to the auto dealer selling the automobile. The request may include a request for information regarding financing the automobile and the initial set of information. The auto dealer may be allowed to access the information and add additional data regarding the automobile, and the loan requester's purchase and payment history, financial entities used for previous purchases, etc. to the data. The temporal pool system 1434 may also include in a request an instruction for the auto dealer to provide financial entity data for executing the data loan. The auto dealer may include another configured EAL system that may then send the information for the auto loan (e.g., loan amount, loan requester information, purchase history, etc.) to a financial entity, which may add additional data to the collected data pool such as previous loan history, other collateral, credit score, etc., one or more of which may be collected from other entities. In some implementations, the temporal pool system 1434 may instruct the auto dealer and in turn the financial entity to encrypt, for example based on compliance requirement(s) of the EAL 1000, a portion of the loan requestor's personal identification information prior to sending the collected data pool to one or more bidding entities to bid for the auto loan. The bidding entities may each provide a data file including bid information to the financial entity. The financial entity may determine a winning bid and provide the bid information as a data file to the auto dealer for executing the auto loan. The auto dealer may then provide the data files from the financial entity along with the winning bid to the temporal pool system 1434. The temporal pool system 1434 may decrypt any encrypted data portions prior to sending the data files to pool construction system 1460 for generating the data pool. Each of the auto dealer, the financial entity, and the bidding entities in the above example may refer to respective configured EAL systems rather than personnel at the enterprise/entity. However, each EAL system may assign the corresponding task to a sub-entity or specific personnel to complete, according to their respective defined or dynamic workflows.

In an example of a multi-stage transaction, the temporal pool system 1434 may perform a sequence of data transactions. For example, the sequence of transactions may be for the purpose of acquiring or accessing a resource from another source (e.g., one of the sellers 914). For instance, the data request requires data file A. However, the data pool library 1410 and/or portions thereof may not have any data files that are directly exchangeable for data file A. Therefore, the temporal pool system 1434 may be configured to recognize how to acquire one or more data files that are exchangeable for data file A using the available digital files of the enterprise 900. To illustrate, the enterprise 900 may have data files B and C. To acquire data file A, the temporal pool system 1434 identifies that data file D is directly exchangeable for data file A. In this example, the temporal pool system 1434 may perform transactions with data files B and C data to obtain file D in order to finally acquire data file A. For instance, the temporal pool system 1434 exchanges data file B with a first asset source for data file E and then is able to exchange both data file B and C for data file D from a second asset source. With the acquisition of data file D, the temporal pool system 1434 exchanges data file D with a third asset source for data file A. Without the temporal pool system 1434, acquiring data file A may be difficult because it demands access to multiple sources (e.g., across multiple marketplaces) and mapping how resources associated with those sources can be leveraged to obtain a target resource. Yet with the temporal pool system 1434 that has access to multiple marketplaces 922 and market participants 910, the temporal pool system 1434 can configure and/or execute a transaction sequence or route that maps how to obtain the target data file (e.g., data file A). This may occur regardless of relationship between marketplaces 922 and/or market participants 910 such that the temporal pool system 1434 may leverage disparate and independent markets to perform a transaction for a target data file in real time. In other words, data file E may be offered or available in a marketplace 922 that is a different and distinct marketplace from the marketplace 922 that offers the target data file, data file A. Real time simply means that the markets are accessed at the time of the transaction rather than in a batch at some periodic interval, such as hourly or nightly. Real time also generally means that a person or process is waiting on the result of the real-time action, rather than initiating the action and expecting the action would be completed at some point in the future. In embodiments, elements of a multi-stage sequence may be conditional, such that a contingent condition must be satisfied in order for a later stage to commence after completion of a prior stage. Conditions may include ones based on pricing, timing, and other parameters.

At each level, a current entity's EAL system may decide to outsource a portion of its requested information to other entities (e.g., subcontractors) while meeting access requirements for each layer of requesting entities and protecting appropriate fields of data (e.g., PII, pricing, etc.) from other entities via encryption. The temporal pool system 1434 may determine the order in which entities get access to the data collection such that the step in the sequence that includes interaction with sensitive data is towards the end of the sequence.

In some example implementations, the sequence may be generated in real time in response to a request as different entities respond to requests for information at each level. An entity asked for a data via the sequence may send additional request to additional entities for to answer a portion(s) of its information request and apply its own compliance rules to the request in addition to the requirements flowed down from the temporal pool system 1434.

In some implementations, the temporal pool system 1434 may be configured to delete the data files once the request has been executed. In other implementations, the temporal pool system 1434 may remove data files from the data pool library 1410 that were generated by the temporal pool system 1434 on a periodic basis.

The generative pool system 1422 may use generative artificial intelligence, such as a large language model, to generate some or all data in a data pool. This generated data may be combined with other data depending on the structure dictated by the pool construction system 1460. In embodiments, the generative pool system 1422 is capable of learning from prior instances of data to generate new and unique data instances. To have this learning capability, the generative pool system 1422 may include a set of learning models that identify data and relationships between data, such as training data set consisting of historical training data (which, in embodiments, may be augmented by generated or simulated training data). Models may include financial, economic, econometric, and other models described herein or in the documents incorporated by reference herein. Learning may use an expert system, decision tree, rule-based workflow, directed acyclic workflow, iterative (e.g., looping) workflow, or other transaction model. Some examples of learning models include supervised learning models, unsupervised learning models, semi-supervised learning models, deep learning models, regression models, decision tree models, random forest or ensemble models, etc. Learning models may use neural networks (e.g., feedback and/or feedforward neural networks, convolutional neural networks, recurrent neural networks, gated recurrent neural networks, long short-term memory networks, or other neural networks described in this disclosure or in the documents incorporated herein by reference). Learning may be based on outcomes (e.g., financial yield and other metrics of enterprise performance), on supervisory feedback (e.g., from a set of supervisors, such as human experts and/or supervisory intelligent agents), or on a combination.

In some examples, the learning models may include similar features and/or may be configured to carry out similar operations as one or more other machine learning modules described herein. In some implementations, the generative pool system 1422 may use learning models to predict future data based on historical data. For example, the generative pool system 1422 may generate additional data instance indicating a loan requester's potential to pay back a requested loan based on historical payment data and income data for the loan requester. The pool construction system 1460 uses the predicted/generated data as additional data in the data pool for responding to a request.

The data management system 1470 of the data pool system 1136 may manage the data in stored and/or generated data pools. In an example, the data management system 1470 may be configured to monitor an open data pool that aggregates data used in machine learning applications. In this example, the open pool system 1414 may include a set of data monitoring rules to be used by the pool construction system 1460 to monitor the data pool for malicious or unreliable data sources (e.g., devices potentially injecting fake data into the data pool, bot-generated reviews, comments, social media interactions, enterprise data that contains latent bias, or the like). In example embodiments, the data monitoring rules may include a data sampling task, a data scoring task, and a resolution task. In embodiments, the data monitoring rules instruct the data processing system to sample a data set periodically or upon detection of a triggering event, such as a new, unvetted, or recently inactive data source providing data to the data pool, detecting anomalous data reporting patterns (e.g., too many reporting instances received over a particular period of time or from a particular location or IP address), a request from a human user, or the like. The data monitoring workflow may define a manner by which the data is sampled. For example, if the data being monitored is sensor or reporting data being provided by IoT devices, the data monitoring rules may instruct the data processing system to sample each instance provided by a particular IoT device or set of IoT devices (e.g., devices providing the same type of data, devices that are using the same IP address, or devices in the same facility and/or IoT network) over a period of time or multiple periods of time (e.g., recently collected data and data collected weeks, months, or years ago). In another example, if the data being monitored is crowd-sourced data provided by human commenters (e.g., reviews, reports, surveys, or the like), the data monitoring workflow may instruct the data processing system to sample data from a particular commenter, a random group of commenters, a specific group of commenters, or all commenters. A data monitoring workflow may define additional or alternative data sampling tasks. In some embodiments, the scoring system may be provided the data sampled during the data collection task to initiate a data scoring task.

In an example of a medical device enterprise, in response to a request for pricing to manufacture a medical device, the workflow system 1140 may determine that a workflow exists that includes, as a task, generating a data request to the data pool system 1136 for data including, for example, target population, target population's access to diagnostic equipment, prices of similar devices, etc. The data pool system 1136 may determine that the data pool library 1410 of the EAL 1000 already has some of the requested data available and add an initial portion of data available in the data pool library 1410 to the request. The data pool system 1136 may then send requests to some of the third-party systems 924 (e.g., additional downstream entities) for the rest of the requested data. An initial one of the third-party systems 924 may also obfuscate or scrub some of the data within the request in such a way that different downstream third-party systems have access to it at different levels based on compliance configurations of the EAL 1000. A downstream third-party system of a manufacturer may be requested to add manufacturing cost data to the data pool for the medical device. In another example, the request may be sent to several bidders to add bids to manufacture the medical device. This information may then be added to the data pool and sent to the EAL 1000 as a completed output of the request. In this way, at each level, the current entity's EAL may decide to outsource a portion of its requested information to other entities (e.g., subcontractors) while meeting access requirements for each layer of requesting entities and protecting appropriate fields of data (e.g., personal identification information, parts pricing, etc.) from other entities via encryption. In various implementations, the contents of the data pool are actually transmitted to each of the other systems (such as other configured EALs) from which data is requested. This may be referred to as a traveling data pool. The contents of a traveling data pool may be protected against unauthorized access by further recipients using encryption. In various implementations, encryption—for a traveling data pool or for other data transmission—may be asymmetric. For example, data intended for the EAL 1000 may be encrypted with a public key of the EAL 1000 so that only the EAL 1000 can then decrypt the information. The public-private key pair may be managed by the credential system 1171.

### Workflow System

In embodiments, the EAL is a software system that facilitates transactions and data exchanges on behalf of respective enterprises and entities thereof. Facilitation of transactions and data exchange on behalf of an enterprise may include monitoring data sources and entities, decision making in connection with transactions, data exchange, and other related functions, and applying governance standards to decisions made on behalf of the enterprise and requests to or by the enterprise.

In embodiments, the EAL may include a workflow system 1140. In some embodiments, the workflow system 1140 provides tools and capabilities for defining, selecting, deploying, and/or managing workflows that are executed on behalf of respective enterprises. A workflow may be a computer-executed and/or computer-facilitated process arranged in a set of tasks that are executed by an EAL on behalf of the enterprise. It is appreciated that workflows may be linear (such as involving an invariant sequence of steps), contingent (such as following a decision tree through a series of decision points that depend on inputs, such as defined by a directed, acyclic graph), looping/iterative (such as where steps are repeated until a threshold, goal or other conclusion is met), or a combination of the above. In embodiments, workflows may include default workflows, custom workflows configured by the enterprise into an EAL, and/or learned workflows that are learned by the EAL on behalf of the enterprise (e.g., via robotic process automation of tasks performed by enterprise users) and may be deployed to perform any number of scenarios. Workflows may be workflows that are provided by the EAL to support default core functionality of enterprise EAL configurations, domain-specific workflows available as add-on features (e.g., transaction-specific workflows, data monitoring-specific workflows, data sharing-specific workflows, industry-specific workflows, and/or the like), or custom workflows defined and implemented using inherent EAL configuration capabilities. To create, manage, and implement workflow processes, the workflow system 1140 may include a workflow definition system 1142, a workflow library system 1144, a workflow optimization system 1146, and a workflow management system 1148.

Custom workflows may refer to workflows that are configured by or on behalf of an enterprise to extend or enhance a capability or function of the EAL to suit the needs of the enterprise. In embodiments, custom workflows may be customized by the enterprise from existing workflows of the EAL (e.g., by defining one or more aspects of an existing EAL workflow, such as defining specific data sources, digital wallets, models, applications, users, or the like that are implicated by the workflow) and/or may be provided by the enterprise (e.g., as a hard-coded module that is added to the EAL deployment of an enterprise or entity thereof). In embodiments, learned workflows are workflows that are learned by the EAL as enterprise users interact with the EAL. In embodiments, learned workflows can be learned in a supervised or semi-supervised manner. It is appreciated that learned workflows that are learned by the EAL at the direction of an enterprise may be considered customer workflows as well.

In embodiments, the workflow system 1140 may integrate with other systems (e.g., other EAL systems, EAL clients, third party services, and/or other enterprise resources) using APIs (e.g., via the interface system 1110) and/or via other software interfaces. In embodiments, the workflow system 1140 may include a workflow definition system, workflow libraries, a workflow management system, and/or a workflow optimization system. In embodiments, the workflow definition system is configured to define workflows involved with any number of EAL processes. In some embodiments, the workflow definition system may include a set of tools that allow an enterprise to configure, define, and deploy workflows. In some embodiments, the workflow definition system provides GUIs that assist a user (e.g., an enterprise user) in selecting existing default workflows and/or defining custom workflows. In the case of selecting default workflows, the workflow definition system may allow authorized users to select from a menu of available workflows that can be used to perform respective tasks. In some scenarios, the authorized user may have to provide enterprise-specific information to parameterize a selected workflow. For example, if a default workflow includes a data collection task, the user may provide information used to access a particular data source (e.g., API address, network address, access credentials, and/or the like) in furtherance of the data collection task. In another example, if a default workflow includes a transaction step that is executed from an enterprise wallet, the user may provide information used to process transactions from the wallet (e.g., wallet address (if a Web3.0 wallet), private keys or passwords, transaction limits, transaction permissions, and/or the like).

In embodiments, the workflow definition system receives workflow configurations from a user and generates executable workflows based thereon. In some of these embodiments, the workflow definition system includes a workflow builder that provides an interface where users can build workflows based on pre-defined or configured business rules and processes, transaction models, or the like. In some embodiments, the workflow builder may include a GUI that allows users to configure new workflows. In configuring a new workflow, a user may use the GUI to define name of the new workflow, when the new workflow is executed and/or a set of one or more conditions that trigger the new workflow, a set of tasks that are performed by the new workflow, decision points that trigger respective tasks within the new workflow, data sources that are implicated by defined tasks and/or decision points, data repositories that are written as part of a respective task (e.g., data pools, databases, file paths, and/or the like), files or other data that is used in connection with a particular task (e.g., text that is sent to a recipient of an automated email or text message, a pdf file that is sent to a customer at the completion of a workflow, forms that are sent to counter parties, and/or other data that may be used in completion of a task), users or roles of users that are implicated by the workflow (e.g., to whom a notification is sent, to whom a message is sent, a user that is responsible for approving a task or reviewing a task, etc.), and/or the like. In embodiments, the workflow definition system may provide a visual workflow definition environment where users can create functional diagrams of workflows that are converted into executable workflows. Additionally or alternatively, a user may configure an executable workflow in a different environment and may upload the configured workflow to the workflow definition system. Furthermore, in some embodiments, a user may test workflows using the digital twin system 1190. For instance, the digital twin system may simulate various scenarios that implicate a given workflow and may execute given workflow with respect to the simulated various scenarios. As the workflow is executed, the user may be provided with the results of the given workflow in response to the simulated scenarios. Furthermore, the user may provide input into the various scenarios, so as to test the workflow in scenarios that are relevant to the enterprise. In this way, the user may fine tune, adjust, and/or otherwise optimize the given workflow ahead of deploying the workflow.

In some embodiments, the workflow definition system may be configured to generate workflows using a generative AI system. In some of these examples, an LLM may be trained on existing workflows (which may be specific to the enterprise, default workflows, and/or a pool of shared workflows from different enterprises). In some examples, the workflows used to train the LLM may include a name or description which is used as a label of the workflow. Optionally, rules and/or actions defined in the workflows may also be provided with labels. In some embodiments, the workflow definition system may provide an interactive interface that allows a user to provide instruction to the workflow definition system regarding a new workflow and the workflow definition system provides the instruction to the generative content system. For example, a user may request that the workflow definition system propose a new workflow for approving and paying in-bound invoices for a particular business unit. In this example, the workflow definition system may provide the request to the LLM that was trained on the workflows, as well as any other suitable input for defining the request (e.g., roles or individuals within the business unit that can approve invoices, an org chart, enterprise rules for invoice processing, and/or the like). In response, the LLM may output a proposed workflow that includes example tasks such as vetting the invoice (e.g., matching the invoice to a work order), obtaining approval from a designated employee within the business unit by providing the invoice to a designated along with any information used to vet the invoice, executing the transaction from a specific enterprise wallet or account in response to obtaining the approval, and recording the payment with any supporting documentation in a specified data repository. This example workflow may include conditional logic, such as conditional logic that triggers the approval task in response to successfully vetting the invoice and/or conditional logic that triggers the payment execution task in response to obtaining the approval. In this example, the workflow may include contingent tasks as well, such as notifying the designated employee if the invoice cannot be vetted automatically or requesting a reason for denying payment if the invoice is vetted. In embodiments, a user may approve a proposed workflow or may provide feedback relating to the proposed workflow, such as adding, removing, refining, or adjusting certain tasks within the workflow. For example, in this example, the user may refine the vetting task by providing additional criteria for vetting an invoice (e.g., must comply with certain invoicing requirements) and/or may add another task that triggers a notification being sent to another department.

In some embodiments, the workflow definition system may interface with the generative content system to automate workflows that are currently being done manually on behalf of an enterprise. In these embodiments, the workflow definition system may allow a user (e.g., a manager) to designate one or more employees to be monitored while performing a manual task. In this example, the workstation (e.g., desktop or laptop computer) of the designated users may be monitored when performing the manual task. The workflow definition system may collect monitoring data (e.g., which applications the user interacted with, what types of documents were created, opened, written to by the user, and/or other suitable monitoring data). After sufficient monitoring data has been collected, the workflow definition system may provide the monitoring data to the LLM, which outputs a proposed workflow. As discussed above, the requesting user may provide feedback relating to the workflow, such as removing, refining, or adjusting certain tasks within the workflow. For instance, in response to the proposed workflow having a data collection task, the user may refine a task by specifying certain data sources to be pulled from during the data collection task (e.g., a specific data pool, specific data databases, a particular credit agency, a particular API, a specific 3rd party data service, certain news feeds, certain blockchain oracles, or the like); the types of data sources that can report data (e.g., certain IoT networks, only registered app users, devices or application usage of enterprise users or certain enterprise users, etc.); and certain governance applied to the data collection task (e.g., encryption standards, privacy standards, internal standards, etc.). In some scenarios, the workflow definition system may explicitly request that the user provide such refinements to a task (e.g., data collection task). Alternatively, the workflow definition system may receive a user response that provides the refinements to the proposed workflow definition. In response, the workflow definition system may provide the input to feedback to the LLM, which then updates the proposed workflow definition.

In embodiments, the workflow system stores executable workflows in a workflow library. In embodiments, the workflow library stores the workflows that are executed by the EAL for an instance of the EAL.

The workflow management system may execute workflows defined in the workflow library. In embodiments, the workflow management includes a workflow engine that monitors various event streams and/or states of the EAL to determine if a workflow is triggered. In some of these embodiments, the workflow engine may deploy listening threads that monitor respective components of an EAL instance and/or external enterprise resources for specific events or states, such that when a specific event or state is detected the workflow engine may trigger one or more workflows corresponding to the detected event or state. For example, a first listening thread may monitor the transaction system for certain types of transaction requests. If such a transaction request is detected, the workflow engine may deploy a transaction workflow corresponding to the detected transaction request, whereby the transaction workflow may be configured to ensure a set of conditions are met before the transaction system executes the requested transaction. In another example, a second listening thread may monitor the intelligence system for specific types of predictions made by intelligence system. If such a prediction is made by the intelligence system, the workflow engine may deploy an outcome monitoring workflow that collects outcome data relating to the prediction that is provided as feedback to the model that was used to automate a decision that was made on behalf of the enterprise. In some examples, the outcome monitoring workflow may automatically solicit feedback from a human user relating to the outcome (e.g., was the outcome of the prediction satisfactory to the enterprise), whereby the user's feedback is provided as the outcome data.

Additionally or alternatively, an outcome monitoring workflow may monitor one or more data sources for outcome data relating to the prediction. For example, if the intelligence service predicted a forward market price for a resource (e.g., a compute resource, a networking resource, an energy resource, or the like), the outcome monitoring thread may monitor one or more resource markets for the price of the resource on a particular day or over a particular time period. In this example, the price of the resource and the set of features that were used to make the prediction can be provided as feedback data to the model that predicted the price of the resource. In another example, a third example listening thread may monitor access requests by external devices attempting to access (e.g., read or write) a particular data pool maintained by the EAL. In response to detecting the access request, the workflow engine may deploy a data pool workflow. Depending on the type of data pool and the type of access requested, the workflow engine may deploy a data pool workflow corresponding to the access request. For example, an example data pool workflow may determine whether an entity (e.g., user, third-party enterprise, or the like) associated with the device has requisite permissions to access the data pool. If the entity has access, the example data pool workflow may grant the device access to the data pool. If the entity does not have the requisite permissions, the data pool workflow may initiate a set of tasks to determine whether to grant access to the requesting device (e.g., seeking approval from an enterprise user that oversees the data pool, obtaining a risk score associated with the entity and/or device that requested access, sending access requests forms to the requesting user/device, or the like). Upon executing the set of tasks to determine whether to grant access, the data pool workflow may include conditional logic that determines whether to grant the requesting device access, such that the device is approved or denied access depending on the outcome of the set of tasks. It is appreciated that the foregoing are examples of listening threads and workflows that may be triggered by the listening threads and that any number of workflows and listening threads may be deployed by a workflow management system of an EAL. Furthermore, it is appreciated that in some embodiments, the workflow system may be configured to deploy multiple alternate workflows in connection with certain scenarios, whereby the workflow system monitors respective outcomes of each alternate workflow for the scenario and provides the outcomes as feedback to the intelligence system. In these example embodiments, the intelligence system may use this feedback data to optimize the selection of workflows for certain scenarios.

In embodiments, the workflow engine may trigger certain workflows in response to detecting a state of another workflow. For example, a specific scoring workflow may be triggered when another workflow requires a certain type of score to proceed to a “next” stage of the workflow. For instance, an example banking workflow may be configured to facilitate a lending transaction involving a new customer. In this example, the banking workflow may include a KYC stage that requires a KYC score to be determined for the new customer before progressing to a next stage of the workflow. In this example, the example banking workflow may trigger a KYC workflow. In response, the workflow engine may initiate a KYC workflow that is executed with respect to the new customer. In this example, the KYC workflow may include requesting particular types of data from the user (e.g., email address, phone number, social security number, photo of state ID, and/or the like) and then collecting data from one or more external data sources before requesting a KYC score relating to the user from the scoring system. In example implementations, the banking workflow may then determine whether to proceed with the lending transaction based on the KYC score.

In some examples, data monitoring workflows may be deployed by an EAL to monitor data sources, data sets, or individual instances of data to identify potentially malicious data (e.g., data sources part of fake data injection schemes, intentionally misleading data sets, or instances of fake data), unreliable data (e.g., unvetted data sources, data sets containing bot-generated content, instance of data from an anonymous source), and/or biased data (e.g., data sets having latent bias). Data monitoring workflows can be deployed to support a number of different EAL applications and/or workflows. Example EAL applications that may integrate data monitoring workflows may include payment automation applications (e.g., monitoring data used to automatically trigger transactions, vetting crowd-sourced data before issuing reward payments, monitoring IoT data used in connection with transactions, and/or the like); intelligence applications (e.g., data monitoring workflows that monitor: data being used to train models; data being input to those models; data being provided as outcome or other feedback data; and/or the like); data pool applications; blockchain applications (e.g., monitoring data sources that report to blockchain oracles); and the like.

In an example of a data monitoring workflow, a data monitoring workflow may be configured to monitor a data pool that aggregates data used in machine learning applications. In this example, the data pool may be an open data pool, such that any number of enterprises, users, devices, and/or digital agents may contribute specific type(s) of data to the data pool. In this example, a data monitoring workflow may be configured to monitor the data pool for malicious or unreliable data sources (e.g., devices potentially injecting fake data into the data pool, bot-generated reviews, comments, social media interactions, enterprise data that contains latent bias, or the like). In example embodiments, the data monitoring workflow may include a data sampling task, a data scoring task, and a resolution task. In embodiments, the data monitoring workflow may instruct the data processing system to sample a data set periodically or upon detection of a triggering event, such as a new, unvetted, or recently inactive data source providing data to the data pool, detecting anomalous data reporting patterns (e.g., too many reporting instances received over a particular period of time or from a particular location or IP address), a request from a human user, or the like. The data monitoring workflow may define a manner by which the data is sampled. For example, if the data being monitored is sensor or reporting data being provided by IoT devices, the data monitoring workflow may instruct the data processing system to sample each instance provided by a particular IoT device or set of IoT devices (e.g., devices providing the same type of data, devices that are using the same IP address, or devices in the same facility and/or IoT network) over a period of time or multiple periods of time (e.g., recently collected data and data collected weeks, months, or years ago). In another example, if the data being monitored is crowd-sourced data provided by human commentors (e.g., reviews, reports, surveys, or the like), the data monitoring workflow may instruct the data processing system to sample data from a particular commentor, a random group of commentors, a specific group of commentors, or all commentors. It is appreciated that a data monitoring workflow may define additional or alternative data sampling tasks. In some embodiments, the scoring system may be provided the data sampled during the data collection task to initiate a data scoring task.

As mentioned, example data monitoring workflows may include a data scoring task. In examples, a data scoring task may refer to the generation of one or more data scores based on the sampled data. Data scores may be determined with respect to a respective data source (e.g., a third party data provider, a user, a database, an application, a device, or the like) or for an instance of data (e.g., a sensor reading, an audio, image, or video file, a geolocation of a user/device, a review, a comment, a rating, a transaction request, a search query, or the like). In some scenarios, a data score may be indicative of a degree of reliability of a data source or an instance of data therefrom (which may be referred to as “reliability scores”). For example, data sources having relatively low reliability scores (e.g., scores falling below a certain threshold) may indicate that the data source may provide data containing inaccuracies, misrepresentations, and/or latent bias. Similarly, an instance of data having a low reliability score may indicate that the particular instance of data may be inaccurate or fake (e.g., bot-generated data, misleading human generated data, and/or the like). In some scenarios, a data score may be indicative of a risk associated with relying on the data source or individual data instances (which may be referred to as “risk scores”). For example, a data source having a high-risk score may indicate that the data source (or a group of data sources) is/are likely providing malicious data (e.g., fake data injection that is used to influence the training of an AI model or a decision by an AI-model). In example embodiments, a respective data monitoring workflow may instruct the scoring system to generate a data score for a data source, a data set, or for an instance of data. Different examples of data and data source scoring are described in greater detail elsewhere in the disclosure.

As mentioned, some example data monitoring workflows may include a resolution task. In embodiments, a resolution task may include one or more conditional actions that are performed in response to the scoring task. The conditional logic that triggers respective actions and the type of actions will vary depending on the purpose of the data monitoring workflow. For example, if a data monitoring workflow is deployed to prevent malicious data sources are adding data to a certain data pool, the data monitoring workflow may instruct a data pool management system to permit a new data source to participate in the data pool if the data score (e.g., risk score) of the data source is below a threshold. If the data score is above the threshold, the data monitoring workflow may initiate one or more risk prevention actions. Examples of risk prevention actions in this context may include denying the data source write permission to the data pool, sending a notification to a human user that may determine whether or not to grant the data source write permission to the data pool, and/or initiating a set of tasks that may allow an entity controlling the data source to rectify any issues that resulted in the data source being denied write access. It is appreciated that the foregoing type of data monitoring workflows may be deployed in a number of different scenarios, such as the prevention of IoT devices, bots, or the like from writing fake data to a data pool.

In other example embodiments, example data monitoring workflows may be deployed to monitor crowd-source reports generated by reporting users, whereby the resolution tasks include a determination as to whether to rely on respective crowd-sourced reports based on the risk score. For example, an AI service provided by the intelligence system may be configured to receive crowd-sourced reports provided by reporting users to classify a current condition of a collateral item, which is used in part to predict the value of the collateral item. In these examples, the predicted value may be used to determine an interest rate applied to a financial instrument secured by the collateral item and/or as a basis for requiring additional or substitute collateral to securitize the financial instrument. In this example, when a crowd-sourced report is submitted by a reporting user, the instance of the crowd-sourced report may be scored by the scoring system to determine a risk score for the report. If the risk score is above a threshold (e.g., the report is predicted to be intentionally misleading), the resolution task of an example data monitoring workflow may include preventing the crowd-sourced report from being used as input to the AI service, flagging the reporting user as an untrustworthy reporter, and/or providing a notification to an enterprise user overseeing the financial instrument. If the risk score is below the threshold, the resolution task of the data monitoring workflow may include allowing the report to be submitted to the AI service, recording the crowd-sourced report (e.g., in an enterprise data store and/or a blockchain), and/or issuing a reward to the reporting user that provided the report.

In other examples, a data monitoring workflow may be deployed to prevent fake data injections to blockchain oracles. In embodiments, blockchain oracles are software services that provide off-chain data to smart contracts executing on a respective blockchain. In many scenarios, these smart contracts may include conditional logic that may trigger a transfer of funds (e.g., cryptocurrency, NFTs, digital fiat currency, or the like) upon the detection of a condition, whereby the conditional logic is triggered at least partially by the data provided from an oracle. As such, blockchain oracles present a potential vulnerability for smart contracts and blockchain-based ecosystems. According to some embodiments, data monitoring workflows may be deployed to monitor the data being provided to a blockchain oracle. In these embodiments, data received by an oracle may be provided to a scoring system, which may determine a risk score associated with the data. The data monitoring workflow may then instruct the blockchain oracle to either provide the data (or values derived therefrom) to a respective smart contract or prevent the data from being provided to the smart contract based on the risk score. It is appreciated that the foregoing may be implemented in blockchain oracles that report data that can trigger the settlement of gambling transactions, autopayment transactions, triggering of stock options, and/or the like.

It is appreciated that workflows may be deployed in any number of scenarios. Examples of scenarios where workflows may be deployed by an EAL include permission workflows, access workflows, data collection workflows, data pool workflows, machine learning workflows, artificial intelligence workflows, governance workflows, scoring workflows, transaction workflows, governance workflows, industry or vertical-specific workflows, enterprise-specific workflows, and other suitable workflows. It is appreciated that the example types of workflows provided above may overlap (e.g., a governance workflow may be an industry-specific and/or enterprise-specific workflow). Furthermore, some workflows may trigger one or more other workflows. For example, when a certain type of transaction is executed by the transaction system of an EAL, a transaction workflow corresponding to the type of transaction may define a series of tasks that are performed before the transaction is executed. In this example, the transaction workflow may trigger a scoring workflow that obtains a risk score associated with the transaction and/or a counterparty. In another example, as part of a data pool workflow that establishes a data pool that is accessible by third-parties, the data processing workflow may trigger a governance workflow that ensures that any enterprise data being added to the data pool confirms with certain data sharing rules (e.g., obfuscation of sensitive data, complying with privacy rules, scrubbing metadata, and/or the like) and may trigger a scoring workflow that scores each third-party that will access the data pool. Furthermore, all EAL workflows share a common framework for respective EAL functions and scenarios; however, individual workflows deployed with respect to respective EAL instances may vary in complexity from very basic workflow implementations (e.g., configured to execute on a user device or sensor device) to complex workflows with multiple dependencies and/or embedded “sub-workflows” (e.g., configured to execute by a central server system and/or by multiple enterprise devices).

In embodiments, access workflows may define a set of tasks that are performed in response to a device and/or user attempting to access the EAL and/or an enterprise resource (e.g., a data pool, a digital wallet controlled by transaction system, a digital twin maintained by the EAL, an intelligence service of the EAL, and/or the like). In embodiments, the tasks that are performed in an access workflow may depend on the type of access sought. For example, the access system may execute a access workflow in response to a request by a device that is reporting data to the EAL in connection with an intelligence service provided by the EAL. In the example, the access workflow may instruct the access system to determine whether the device is a trusted device (e.g., the MAC address and/or IP address of the device is in a permitted devices list). If the device is not a trusted device, the example access workflow may instruct the access system to initiate one or more scoring tasks to determine whether to grant the device and/or user access the EAL and/or an enterprise resource.

In embodiments, transaction workflows may include transaction compliance workflows that are executed by the transaction system when executing transactions on behalf of an enterprise to ensure that transactions comply with one or more regulatory standards. In some of these embodiments, the transaction system may be configured to access a data pool that maintains current regulatory standards pertaining to a respective type or types of transaction. In these example embodiments, the data pool may be maintained internally by the enterprise or may be a data pool that is accessible by multiple enterprises, whereby the data pool defines a current set of regulatory standards that are applied to one or more types of transactions. In embodiments, the transaction compliance workflow may be triggered periodically (e.g., daily, every hour, every minute, or the like) or in response to an event, such as a transaction request that indicates a transaction to be executed on behalf of the enterprise (this may be in-bound or out-bound). In response, the transaction compliance workflow may instruct the transaction system to access the data pool corresponding to a particular type of transaction to determine whether the data pool has been updated since the last time the workflow was executed. If the data pool has not been updated, a compliance checklist is not updated and in-coming transaction requests are analyzed with respect to the existing compliance checklist. If the data pool has been updated, the transaction compliance workflow may instruct the transaction system to obtain any updated regulatory standards that have been added to the data pool and to update a transaction compliance request based on the updated regulatory standards. This may include re-parameterizing any conditional logic in the compliance checklist with the updated regulatory standards, such that in-coming transaction requests are analyzed with respect to the updated compliance checklist. Examples of regulatory standards that may be maintained in a data pool and subsequently updated in a compliance checklist may be include, but are not limited to: transaction amount limits, transaction reporting requirements, permitted payment methods, permitted payment providers, permitted digital wallets, KYC requirements, enforcement of holding periods, escrow requirements, tax requirements, geographical requirements, security requirements, digital signature requirements, self-imposed requirements, and/or the like.

It is appreciated that more than one compliance checklist may be applied to a particular type of transaction. Furthermore, it is appreciated that regulations enforced by compliance checklists may include government regulations (which may include multiple jurisdictions if the enterprise executes transactions in multiple jurisdictions), industry regulations (e.g., industry or protocol standards), and/or internal/corporate regulations (e.g., self-imposed regulations).

In embodiments, model management workflows may be deployed by the EAL to evaluate and improve models (e.g., machine-learned models, neural networks, LLMs, and/or the like), trained and/or used by the intelligence system 1130. In some examples, a model management module may be executed by a digital agent that monitors one or more models and initiates updating and/or re-training the model(s) based on the monitoring. In an example model management workflow, each time a model provides a prediction (e.g., a classification, a recommendation, a decision, and/or the like) the prediction and any relevant data related to the prediction (collectively referred to as prediction data) may be aggregated in a data lake or a data pool configured for monitoring a respective model. In embodiments, an example model management workflow may instruct the digital agent to collect or otherwise maintain outcome data relating to the model's predictions. The outcome data may be obtained by monitoring one or more data sources for a measured outcome after the prediction or by feeding existing historical data from previous events with known outcomes to the model to obtain a prediction that is compared by the known outcomes.

As new prediction data for a model is aggregated, the model management workflow may instruct the digital agent overseeing the model to determine one or more drift values of the model and may determine whether the model has drifted past a threshold limit. A drift value may refer to a measure of deviation of predictions of the model from the expected result. In some embodiments, the drift value may be determined by comparing a prediction and an actual result (e.g., the model predicts a particular event will occur with a high confidence (e.g., 99% confidence) and the event does not happen, the model predicts a value stemming based on a feature vector corresponding to an event and the measured outcome is a different value that is outside of a tolerance limit). Additionally or alternatively, the drift value may be determined by analyzing outcomes stemming from predictions of the model against one or more governance standards (e.g., a model recommends actions that consistently cause in an intended result, but either individually or in the model's recommended actions violate one or more conditions or limits defined in the governance standards applied to the model). If the digital agent determines that the drift value(s) relating to a model have exceeded one or more limits, the example model management workflow may instruct the digital agent to initiate a cluster analysis that evaluates the labels used to train the model and/or labels generated for net-new data (e.g., feature vectors provided to the model and/or the respective predictions by the model for those feature vectors). In an example model management workflow may instruct the digital agent to evaluate a model for bias based on the cluster analysis and, if bias is detected, to create representative samples of the bias. In some embodiments, the model management workflow may instruct the digital agent to take a corrective action and re-train the model. In some embodiments, the corrective action may include oversampling data from one or more of the underrepresented clusters in the training data set. In some embodiments, the oversampling technique may be synthetic minority oversampling technique (SMOTE). In these embodiments, the feature vectors from the underrepresented are used to synthesize similar but not duplicative feature vectors that are then included in the training data set. In embodiments, the digital agent may initiate the re-training of the model and/or training a new model based on the updated training data set. In some of these embodiments, the model management workflow may instruct the digital agent to inform and/or consult with one or more human users (e.g., sending a notification, an email, a direct message, and/or the like). In some of these embodiments, the digital agent may also provide representative samples that illustrate the measured drift and/or biases to the human users, whereby the human users (e.g., data scientists) may be tasked with ensuring that the model's performance with respect to the one or more imposed governance standards that are applied to the model. It is appreciated that model management workflows may be deployed to monitor enterprise-specific models (e.g., models deployed and/or trained by the enterprise in connection with the core business functions of the enterprise) and/or models provided by the EAL (e.g., models provided and deployed as part of EAL implementations). In this way, model management workflows may be deployed to improve the performance of enterprise-specific models and/or to improve the operation of the EAL itself.

### Transaction System

In embodiments, the transaction system 1150 supports and executes digital transactions on behalf of the enterprise and/or entities thereof. Within the context of the transaction systems, the types of digital transactions that may be executed, or otherwise supported by the transaction system 1150 include out-bound payments (e.g., wire transfers, credit card payments, cash transfers, ACH transfers, and/or the like), invoices/payment requests, blockchain transactions (e.g., transfers of cryptocurrency and other blockchain tokens on a blockchain, tokenization of data on a blockchain, and/or any other blockchain action that requires a digital signature). In embodiments, the transaction system 1150 may be configured to control one or more digital wallets of an enterprise (or an entity thereof). In embodiments, the term “digital wallet” (or “wallet”, “wallet application”, or “digital wallet application”) may refer to a software program that executes one or more respective types of transactions using respective credentials, keys, and/or other transaction parameters corresponding to a respective account of the enterprise. It is appreciated that the term “account” can refer to various types of financial accounts, including bank accounts, credit accounts, accounts on payment platforms, blockchain accounts, and/or the like. Depending on the type of account, the manner by which the account is addressed will vary. For instance, accounts on certain blockchains may be referenced by respective public address/public keys associated with the respective accounts on those blockchains. A third-party platform account may be referenced or accessed by usernames or email addresses of the enterprise or entities associated with the enterprise (e.g., employees of an enterprise) and/or other suitable identifier.

In embodiments, the transaction system 1150 may execute various transactions workflows that include various types of tasks, such as access tasks, scoring tasks, access tasks, permissions tasks, governance tasks, key management tasks, digital signature tasks, tokenization tasks, recordation tasks, and/or the like. The specific configurations and parameterizations of different types of transactions workflows and the respective types of tasks of the transaction workflows may vary for different types of transactions, different EAL implementations (e.g., implementations of different enterprises or entities thereof) and/or types of enterprises (e.g., financial enterprises, banking enterprises, manufacturing enterprises, service providers, government enterprises, and/or the like) and transaction type (e.g., data tokenization, data transactions, blockchain transactions, payments, invoicing, reward distribution, securities transactions, and/or the like).

In embodiments, the digital wallets of an enterprise may include blockchain digital wallets that are configured to communicate with and execute blockchain transactions (e.g., a cryptocurrency transaction, a NFT transfer, a tokenization transaction, or the like) on one or more blockchain networks. In embodiments, a blockchain wallet is associated with one or more blockchain addresses on a blockchain (blockchain addresses may also be referred to as “blockchain accounts”). In embodiments, a blockchain wallet may refer to a digital wallet that is configured to digitally sign blockchain transactions blockchain transactions on behalf of the enterprise using a private key associated with a blockchain account of the enterprise in accordance with the protocol of the particular blockchain. In doing so, the digital wallet stores or otherwise maintains a private key associated with the blockchain account, such that blockchain wallet digitally signs blockchain transactions using the private key and the nodes of blockchain network verify and effectuate the transaction by verifying the digital signature using a public key of the blockchain account. It is noted that in some protocols, the public key of a blockchain account may be the blockchain address of the blockchain account.

It is appreciated that a digital wallet (third-party or the transaction system 1150) may be configured to perform both blockchain transactions and fiat currency transactions. Such digital wallets may be referred to as “hybrid wallets”.

In embodiments, the transaction system 1150 can serve as a storage system while also including increased functionality that allows it to interface with other systems (e.g., third-party applications and EAL systems). To support digital transactions, in some implementations, the transaction system 1150 is configured to hold or to contain (e.g., store) digital assets, such as enterprise digital assets, such as digital objects, tokens, or the like. In some examples, the transaction system 1150 functions as an index for digital assets such that the transaction system 1150 represents the status of digital assets without having to store them. When used as an index, the transaction system 1150 may point to or reference the actual storage location of the digital asset (such as a bank account, stock exchange, custodial account, blockchain, distributed database, or the like). For instance, a digital asset that is available for exchange in the transaction system 1150 may be actually stored in data storage of the data services system 1120. Here, the transaction system 1150 may include some indication that the digital asset is available for exchange (e.g., an asset availability tag) along with information that the digital asset is stored in the data services system 1120 (e.g., a storage location identifier) so that the digital asset can be retrieved from the data services system 1120 to perform a transaction.

In some embodiments, the transaction system 1150 also maintains digitized identity data of the enterprise or entities thereof. For instance, the transaction system 1150 may hold and/or reference identity data such as banking numbers, credit card numbers, coupons, tickets, credentials, tokens, tokenized assets, vital records, biometric data, passwords, private keys, licenses, etc. For the enterprise 900, this identity data may refer to identity information about the enterprise 900 or information about one or more entities associated with the enterprise 900 that is/are responsible for or can access a respective digital asset. For instance, the identity data associated with an asset that is available in the transaction system 1150 identifies information such as the employee at the enterprise 900 who made the digital asset available (e.g., an employee number or an employee name) or a department or business unit that the digital asset originated from at the enterprise 900 or who is responsible for the digital asset. Identity data may be associated with an identity management system or service, an identity-as-a-service platform, or the like. In some embodiments, identity data for the enterprise may be managed based on a structure that represents a set of roles, such as an organizational chart, such as represented by a graph structure (optionally stored in a graph database) pursuant to which some roles are governed by other roles. For example, access layer access policies and other capabilities may be based on the position of a role within a hierarchy, such that access and other capabilities for a role that reports to another role are governed by the entity that holds supervisory role. Role-based governance of workflows allows access policies to be implemented based on the enterprise structure and rapidly updated in cases where the structure changes (e.g., a reorganization) or where individuals change roles.

In embodiments, the transaction system 1150 is configured to generate, manage various date code information for a digital asset. For instance, a digital asset may include a date code that defines the time at which the digital asset was created, a set of date codes for a window of availability for the digital asset, a date code that designates when the digital asset was made available or added to the wallet, etc.

In embodiments, the transaction system 1150 includes at least one wallet storage resource (e.g., a partitioned container, a set of files, and/or a set of databases) for digital/electronic information used in connection with certain types of transactions (e.g., blockchain transactions). In this respect, a wallet may be software-based and referred to as a software wallet or physical hardware and referred to as a hardware wallet (e.g., a dedicated hardware storage device or location within a hardware device—a hardware wallet). Digital wallets, to some degree, have been used with cryptographic currency systems (also referred to as cryptocurrency). In such cases, a digital wallet may provide and/or access a digital ledger that includes references to the assets that are associated with the wallet, rather than being the actual holder of the asset. For instance, enterprise digital assets may be actually stored on a private storage system associated and/or controlled by the enterprise 900. Here, if one of these enterprise assets is associated with a wallet (e.g., made available to market participants via a wallet), instead of transferring the digital asset to the wallet during or following the association (e.g., moving the asset to a storage location dedicated to a wallet), the asset may remain in the private storage location while the wallet includes a record (e.g., an entry in a ledger) of the private storage location. In this configuration, the wallet maintains some type of storage address or identifier of the storage location for the asset (e.g., a type of pointer),

In some types of digital transactions (e.g., wallet-based transactions), there does not necessarily need to be any movement of digital assets (e.g., a change of possession to pair with a change of ownership). Rather, the ownership or controlling information associated with a digital asset can change from one owner to another owner using data entry procedures. For instance, when a digital asset is exchanged from a first entity to a second entity, the ownership information associated with the digital asset is changed from the first entity to the second entity. This change may occur by either overwriting the ownership information in data storage (e.g., a database) or by appending data to non-overwriting storage (e.g., adding blocks to a blockchain, such as in a distributed ledger that maintains transaction records that indicate ownership transfers and other transaction details), in each case akin to deed or title recordation in tangible property, where the deed or title registry is a transaction ledger records a new deed event or record at a later time such that a timeline of the deed events can inform someone as to the changes in ownership over time. A blockchain for digital assets can function similarly such that there is a first block at a first time that indicates that the first entity owned the digital asset and then, when the digital asset is digitally “exchanged,” there is a second block generated at a second time later than the first time that indicates that the second entity owns the digital asset. Accordingly, a query for information related to the digital asset (e.g., ownership information) would return two records that indicate a change of ownership from the first entity to the second entity. In this sense, when the word “exchange(d)” is used with respect to a digital asset, it can mean that the ownership or controlling information of a digital asset is modified without necessarily moving the digital asset in any way. While the asset may remain in place, control may pass to the different owner; for example, an asset may subsequently be managed (e.g., transferred) only by the valid owner who possesses the private key that is needed to initiate a transfer. However, it is also still possible that the “exchange” of a digital asset can encompass some form of digital or physical movement, such as changing the physical storage locations for the digital asset, such as by locating the digital asset in a wallet or other storage location where only the owner of the wallet or storage location has the ability to interact with or transfer the asset.

When the transaction system 1150 creates or initializes a wallet, that wallet may be unique from other wallets in that it has its own set of unique digital keys. In some examples, the transaction system 1150 or another system of the EAL 1000 may generate the set of unique keys for the wallet when the wallet is created or configured. These digital keys can allow the functionality of the wallet to act on behalf of a specific entity (e.g., the enterprise or an enterprise entity, or a set of roles within the enterprise) to perform or orchestrate digital transactions. In other words, to execute a digital transaction such as an ownership change, a unique key associated with wallet signs off ownership to the wallet's address that is dictated by another key (e.g., a key that is cryptographically related to the unique key signing off ownership). In this sense, digital keys are able to serve as ownership attestation such that trust, control, and security is present for a digital transaction. These digital keys may be independent (e.g., completely independent) of other digital protocols and can be generated with or without consideration for particular storage schemes (e.g., agnostic to a particular storage structure like a blockchain or designed for a particular storage structure). In some embodiments, digital keys may be managed by a key management platform. Additionally or alternatively, the transaction system 1150 may manage digital keys on behalf a respective enterprise. It is appreciated that keys may be generated in any suitable manner. For instance, digital keys may be randomly generated or may be generated based on one or more parameters, such as identity of users, roles of users, hierarchy of roles, and/or the like.

As an example, with blockchain wallets configured for blockchain transactions (e.g., cryptocurrency transactions, NFT transactions, smart contract transactions, and/or the like), the set of digital keys functions as secure digital codes needed to interact with a blockchain. For example, in the case of fungible cryptocurrency, a blockchain may maintain a ledger of mined tokens and ownership thereof. In these examples, a digital wallet uses one or more keys from the set (e.g., a public key) to locate a balance of cryptocurrency that is associated with the wallet (e.g., to locate the currency with the wallet's address). In embodiments, the transaction system 1150 and/or a third party digital wallet that is controlled by the transaction system 1150 may execute transactions involving cryptocurrency (e.g., transferring cryptocurrency from one blockchain account to another) by digitally signing the transactions with one or more keys from the set. In some embodiments sense, a digital key can function as an account identifier (e.g., a public key may be the address of an account) and/or an identity to authorize the wallet to perform actions on behalf of an enterprise or entity (e.g., a private key of an account is used to digitally sign a transaction and the public key associated with the account is used by one or more blockchain nodes to verify that the transaction was digitally signed using the private key corresponding to the public key).

In some examples, an account of an enterprise or entity is associated with a pair of cryptographic keys as the set of digital keys. In these examples, one key of the pair may be considered a public key while the other key is considered a private key. Here, a public key refers to a cryptographic key (e.g., an alphanumeric string) associated with a particular entity (e.g., a wallet) that is outward facing such that it may be published and shared with other entities to function as a public unique identifier or address for the particular entity. In other words, the public key may be associated with a digital asset to indicate publicly (or to those who can view the digital asset) who or what controls and/or owns the digital asset. In contrast, a private key refers to a cryptographic key (e.g., an alphanumeric string) that is generally associated with the same entity of the public key, but is kept as a secret. Here, instead of an address function like the public key, the private key may be used to generate a digital signature that proves that the entity associated with the key has the authorization to perform a transaction. As such, a digital wallet having access to a private key associated with an account can serve as the controller for performing digital transactions involving an account indicated by or otherwise associated with a corresponding public key.

In embodiments, the public and private key may be linked to each other in that the public key may be generated from the private key. For example, a random number generator (or alphanumeric generator) generates a private key of X length and then, from the private key, a one-way cryptographic function generates the public key. In some implementations, the public key and private key operate in tandem such that the public key provides an address or destination for the private key holder such that a market participant can request authorization of the private key holder to execute a transaction. In some examples, this cooperation is such that the public key assigned to a wallet must match or prove its relation to the private key to authenticate an asset transaction. Here, this matching may be considered a form of verification for the transaction. In these examples, the public key may be able to “match” or exhibit a relation with the private key because the public key has been generated from the private key.

In some configurations, a digital wallet may be configured to utilize a derivative form of the private key (e.g., a one-way hashing function) as a digital signature to authorize a transaction. Since the private key can authorize transactions on behalf of the owner/controller of an account, if a nefarious party obtained the private key, that nefarious party could remove or disassociate all of the assets from the account; thus, stealing those assets. Therefore, the security of the private key for a wallet can be critical to the security of the assets associated with a wallet. For reasons such as this, it may be advantageous to authorize a transaction with a derivation of the private key (e.g., a value derived by a cryptographic function based on the private key, transaction data of a requested transaction, and a cryptographic function) that indicates that the authorizer (e.g., the entity digitally signing a transaction with the form of the private key) has/controls the private key, but that does not reveal the actual private key to another party. In this example, the public key associated with the private key may be used to verify the public key given the derivation of the private key.

In some implementations, securing the authorizing key, such as the private key, depends on the security of the digital wallet itself. This may be the case when management and/or storage of the private key is performed by the digital wallet. For example, the digital wallet stores the set of keys including the private key. When a wallet stores the authorizing key, the transaction system 1150 may use a variety of security techniques to secure the authorizing key. For example, the transaction system 1150 may configure a digital wallet as a custodial wallet or a non-custodial wallet. A custodial wallet generally refers to a wallet service where custody or digital possession of the wallet is outsourced to a third-party service who provides security for the wallet (or keys associated with a wallet). In some examples, to generate a custodial wallet, the transaction system 1150 transfers the one or more keys of the set of keys (e.g., the private key) to the custodian service provider. In some situations, custodial services may offer a greater degree of protection because a custodian service provider may have key security expertise. At the same time, the owner of the wallet (e.g., the enterprise 900) has to trust the custodian with security responsibility. In some configurations, a custodian service provider may be considered the same as or akin to a key management service (KMS).

In some scenarios, the transaction system 1150 and/or one or more of the digital wallets controlled by the transaction system 1150 may include non-custodial wallets. A non-custodial wallet refers to a blockchain wallet configuration where private key management is not outsourced to a custodian service provider. An enterprise may prefer to use non-custodial wallets when, for example, the enterprise lacks trust in a custodial service provider or perhaps foresees there being a risk of censorship (e.g., limiting the type of transactions or transactions generally for some period of time) from a custodian service provider. In some of these embodiments, the transaction system 1150 may provide key management services for keys (e.g., private keys and/or public keys) for associated enterprise accounts. In this way, the transaction system 1150 serves as the custodian of the private keys that are used in connection with transactions involving certain enterprise accounts. In these embodiments, the transaction system 1150 digitally signs blockchain transactions on behalf of the enterprise using a private key associated with a public key/blockchain account of the enterprise.

In addition to a wallet being custodial or non-custodial, a wallet may also be considered a “hot” wallet or a “cold” wallet. A hot wallet is a wallet that is connected to a gateway to perform transactions. For instance, the gateway is a wide area network (WAN) such as the internet and the hot wallet is a wallet that is connected to the internet. Some examples of hot wallets include web-based wallets, mobile wallets, and desktop wallets. Since a hot wallet is hot or online with the ability to perform transactions, a user of a hot wallet is able to directly issue transactions, for example to a blockchain, in a relatively easy fashion. For this reason, it may be preferable to use a hot wallet for keys that are frequently used for transactions or keys that have low risk of loss (e.g., keys used with only a particular threshold value of assets). Unfortunately, with this ease of use, the keys associated with the hot wallet are generally vulnerable to threat by the mere fact that they exist online (e.g., connected to the internet).

On the other hand, a cold wallet refers to a wallet that is kept off-line or disconnected from a gateway to perform transactions. By being disconnected from a gateway (e.g., the internet), the cold wallet minimizes potential vulnerability attacks. A cold wallet may any storage-capable device that is disconnected or offline from marketplace transactions (e.g., not connected to the internet) including a simple sheet of paper with the keys printed on the paper. When using a set of keys for a transaction that is stored in a cold wallet, the user may temporarily connect the cold wallet to the transaction gateway and provide the necessary keys prior to disconnecting the cold wallet from the gateway. Since a cold wallet is capable of being online, in some instances, what defines the cold wallet is that it is generally offline (e.g., offline a majority of the time) and/or offline at the time when a transaction is requested for an asset associated with the wallet.

In some situations, the user does not connect the cold wallet, but rather accesses the offline keys and transfers them manually or by a transfer operation (e.g., cut and paste) for execution of the transaction. In some configurations, the transfer operation copies the keys from a cold wallet to a hot wallet to perform the transaction. In these configurations, the keys transferred to the hot wallet may be assigned a time of life (e.g., a temporary lifespan to consummate the transaction) when transferred or otherwise undergo a removal procedure following the execution of the transaction such that the hot wallet does not retain the keys. In other configurations, a transaction may use a combination of a hot wallet and a cold wallet. For instance, the transaction is signed entirely on the cold wallet while the hot wallet is used to issue/relay the signed transaction (e.g., to the blockchain). Due to the nature of cold wallets, cold wallets may be better suited for keys that met a certain security threshold (e.g., a security clearance or designated authorization level) or for keys that are infrequently used.

In some examples, whether the transaction system 1150 uses a hot wallet or a cold wallet depends on the value of the asset associated (or to be associated) with the wallet. For instance, the enterprise 900 may set a threshold asset value for an individual asset that, if exceeded, must be stored in a secure cold wallet rather than a hot wallet. Similarly, if the asset value is below the threshold asset value, the EAL 1000 may associate the asset with a hot wallet. In some examples, whether the transaction system 1150 uses a hot wallet or a cold wallet depends on the cumulative value of the assets that are to be available for a given wallet. In other words, rather than the threshold asset value being a threshold for the value (e.g., estimated value) of a single asset, the threshold dictates when a hot or cold wallet should be used based on the aggregate value (e.g., estimated value) of the collection of assets that are or will be associated with the wallet. Furthermore, it is appreciated that blockchain wallets controlled by the transaction system 1150 may be any combination of hot/cold and custodial/non-custodial. In particular, blockchain wallets controlled by the transaction system 1150 may be hot custodial wallets, cold custodial wallets, hot non-custodial wallets, and/or cold non-custodial wallets.

In some configurations of the transaction system, a wallet controlled by the transaction system 1150 has a key backup protocol to safeguard keys and to prevent assets from being inaccessible due to lost or mismanaged keys. In some examples, the type of wallet or value of the set of assets associated with the wallet dictates the key backup protocol for the keys associated with the wallet. Some examples of key backup protocols include: (i) storing a copy of the set of keys in a designated private storage location associated with the enterprise 900 (e.g., backup on enterprise storage resources); (ii) having an agent or employee store a copy of the set of keys in a hardware device such as a Universal Serial Bus (USB) or hardware wallet; or (iii) storing a copy of the keys with a key service management (KSM) system (e.g., a third-party provider). As an example, a particular protocol may be associated with a backup level. For instance, a first backup level may be associated with the key backup protocol (i) while a second backup level is associated with the key backup protocol (ii). Therefore, when a backup level for a wallet is satisfied, the key backup protocol associated with the backup level is implemented as the key backup protocol for the wallet. For example, the first backup level is that the estimated value of the set of assets associated with the wallet is greater than X but less than Y. Here, when this is true, the key backup protocol of (i) that has been associated with the first backup level is implemented as the key backup protocol for the wallet. In this situation, the key backup protocol for the wallet is that a copy of the set of keys is stored in a designated private storage location associated with the enterprise 900.

In embodiments, the ability to control or otherwise manage a plurality of digital wallets in a “wallet-of-wallets” configuration may be advantageous to partition or sandbox some enterprise assets from other enterprise assets (e.g., enterprise accounts, digital funds, or other digital assets). In some of these embodiments, the transaction system 1150 may control multiple digital wallets that manage digital assets having respective sets of specific attributes. When a digital asset is received by the transaction system 1150, the transaction system 1150 is configured to determine a set of attributes of the digital asset and to match the determined attributes to one or more of the plurality of wallets. For instance, respective wallets controlled by the transaction system 1150 may be dedicated to respective business units, marketplaces, business fields, transaction types, asset types, countries or regions, and/or the like. Here, in response to receiving a digital asset that includes attributes that correspond to the particular marketplace or business field, the transaction system 1150 associates the digital asset with the wallet that shares or matches those attributes (e.g., exact match or a fuzzy match) and thus associating the digital asset with the wallet that also corresponds to the respective marketplace, business unit, business field, transaction type, and/or asset type.

As an example, the transaction system 1150 receives two digital assets that are designated as available digital assets. Upon receiving each digital asset, the transaction system 1150 determines that the first digital asset has a first set of attributes that define the first digital asset as a corporate bond and the second digital asset has a second set of attributes that define the second digital asset as an insurance policy data set. In this example, the transaction system 1150 determines that the first set of attributes matches or shares the most attributes with attributes defined for a financial asset wallet. Based on this determination, the transaction system 1150 associates the corporate bond with the financial asset wallet. In some implementations, to associate the digital asset with a particular wallet, the transaction system 1150 generates an identifier such as a label or a tag for the digital asset that indicates the wallet that the digital asset has been assigned to. In some examples, by having an associated identifier, digital assets can be stored together regardless of their attributes, but yet also be retrieved or managed based on the identifier.

In embodiments, the transaction system 1150 may include a transaction interface system 1154 that that controls one more digital wallets of an enterprise (or an entity thereof). In embodiments, the transaction interface system 1154 may be configured as a “wallet-of-wallets”. In these embodiments, the transaction interface system 1154 controls multiple digital wallets of an enterprise or entities thereof. In some of these embodiments, the transaction interface system 1154 may provide a unified interface (e.g., GUI and/or chat-based GUI) to enterprise users and may include additional layers that manage tasks such as permissions, account selection, wallet selection, and transaction execution. In some of these embodiments, the transaction interface system 1154 may determine a list of enterprise wallets that a requesting user is permitted to use and may display a menu of the permitted enterprise wallets from which the user may select the enterprise wallet to perform the transaction. In some of these embodiments, the transaction interface system 1154 may determine the list of wallets based on one or more of the user's permitted applications, the role/title/business unit of the user, the counterparty to the transaction, and/or the transaction amount. For instance, a first user may have access to a first and second enterprise wallet, but not a third or fourth enterprise wallet because the business unit of the first user only uses the first and second wallets. In this example, if the first user wishes to make execute a transaction using an enterprise wallet, the transaction interface system 1154 may display options to use the first or second wallet for the transaction to the user (e.g., via a wallet-of-wallets GUI) and the user can select the wallet that will execute the transaction from the first and second wallet. In another example, a second user may have access to the first, second, third, and fourth wallet but may only have a limit of $1000 on the fourth wallet. In this example, if the second user wishes to make execute a transaction of $1500, the transaction interface system 1154 may display options to use the first, second wallet, or third wallet for the transaction to the user (e.g., via a wallet-of-wallets GUI) and the user can select the wallet that will execute the transaction from the first and second wallet. Note here as the transaction amount was above the fourth wallet's limit, the second user is prevented from using the fourth wallet by the transaction interface system 1154. Additionally or alternatively, the determination as to which wallet for a given transaction may be made by the transaction system (e.g., by the market orchestration system 1152 as described below).

As discussed, the transaction interface system 1154 may be configured to control a plurality of wallets (i.e., a “wallet-of-wallets”), such that in order to access a “child” wallet, an entity must interact with the transaction interface system to control a respective child wallet. Furthermore, in some embodiments, the transaction interface system 1154 may be configured to provide multiple “wallets-of-wallets”, such that each respective wallet-of-wallets is accessible by a different set of entities (which may or may not be overlapping). For example, wallets and accounts that are accessible by a first business unit may be controlled by a first wallet-of-wallets instance, such that the underlying wallets can be accessed by employees within the first business unit, but only if the manager and/or other responsible party of the first business unit who controls access to the wallets of the business unit provides access to those employees (e.g., by issuing a set of keys to the respective employees for the parent wallet or by granting access to the respective employees via a permission system). In embodiments, multiple layers of wallets and sub-wallets may be provided in a hierarchy, such as ones containing all assets, all assets of a given type (e.g., financial, cryptocurrency, non-fungible tokens, intellectual property, or the like), assets controlled by a given workgroup, assets related to a particular marketplace or exchange, or the like. A wallet-of-wallets can address the need for multiparty access control within an enterprise, such as where primary control of wallet usage needs to be governed by a supervisor, such as a manager.

In some implementations, the transaction interface system 1154 may use an API of a third-party wallet application to initiate a session with the wallet application and to issue commands to the digital wallet application on behalf of the enterprise. In the case that the transaction interface system 1154 does not have API access to a digital wallet, the transaction interface system 1154 may access a graphical user interface of the digital wallet application (e.g., by logging in using the credentials of the enterprise or a user associated with the enterprise) and may use robotic process automation to provide the requisite information (e.g., destination account, payment source (e.g., credit card account, bank account, cash reserve, or the like), transaction amount, payment date, and/or other required information) to execute a transaction.

In some configurations, the transaction system 1150 includes a transaction orchestration system 1152. In embodiments, the transaction orchestration is configured to orchestrate digital transactions, including digital payments and transactions involving digital assets. Digital payments may be outbound payments made to third parties (e.g., vendors, suppliers, service providers, utility providers, raw material providers, landlords, government entities, and/or the like) or enterprise entities (e.g., employees, contractors, business units, or the like) and/or inbound payments made to the enterprise (e.g., customers, clients, investors, and/or the like) using a digital interface. Digital asset transactions may include transactions involving cryptocurrency (e.g., Bitcoin, Ethereum, or the like), digital currency (e.g., digital Dollars, digital Yuan, digital Euros, digital Pounds, and/or the like), blockchain tokens (NFTs, tokenized instruction sets, or the like), enterprise data sets, financial instruments (e.g., bonds, stocks, derivative contracts, ETFs, REITs, and/or the like), and/or the like. In some embodiments, the transaction orchestration system 1152 is configured to perform payment perform multi-stage transactions on behalf of the enterprise (or entity thereof). In examples of multi-stage transactions, the transaction orchestration system 1152 may be configured to execute a purchase of an asset followed by a sale of the asset (e.g., an arbitrage transaction), a sale of entity assets that funds, at least in part, a subsequent purchase of one or more other assets, multiple purchases of multiple assets to compile a larger asset, and/or the like.

In embodiments, the transaction orchestration system 1152 may be configured to interface with various EAL systems (e.g., permissions system, workflow system, intelligence system, scoring system, and/or the like) to orchestrate transactions. In some embodiments, the transaction orchestration system 1152 interfaces with the workflow system 1140, which executes transaction orchestration workflows that define the set of tasks that are performed given a set of transaction parameters. The parameters that are provided may vary depending on the type of transaction being performed and other factors. Examples of transaction parameters may include but are not limited to one or more of: the type of transaction (e.g., inbound transaction, outbound transaction); parties to the transactions (e.g., counterparties to the transaction, payment service provider, escrow agent, and/or the like); jurisdictional parameters (where a payment may be/must be executed, where the payment is originating or may originate from); payment methods (e.g., credit/debit card, ACH transfer, cryptocurrency, or the like); currency parameters (currency type being used to make the payment, what currency type(s) is preferred or available to the enterprise), payment amounts (e.g., how much is being paid/received, an upper and/or lower limit for a potential transaction, or the like); payment date parameters (e.g., a date on which a payment must be executed, a date when a transaction must be completed before, a date after which the payment may be completed, and/or the like); tax instructions (e.g., consider tax implications); and/or the like.

Examples of transaction orchestration workflows are discussed in greater detail below.

In some embodiments, the transaction orchestration system 1152 interfaces with an intelligence system 1130 of an EAL 1000 to leverage various intelligence services provided by the EAL. Examples of tasks that may be supported by the intelligence system 1130 within the context of transaction orchestration include, but are not limited to: model-based market predictions (e.g., predictions of currency exchange rates, predictions of future or spot prices for a given resource, good, or service, predictions of transaction volumes, prediction of interest rates, and/or the like); model-based counterparty predictions and discovery (e.g., predicted liquidity of counterparty, predicted likelihood of executing a given transaction with a given party, identification of parties that are likely to buy or sell a given asset, and/or the like); content generation services (e.g., customized offer generation, customized counteroffer generation, document review of offers, counteroffers, and other documents relevant to a transaction, and/or the like); model-based transaction recommendations (e.g., pricing recommendations, timing of offer/counter offer recommendations, timing of transaction recommendations, asset buying or selling recommendations, tax optimization and payment location recommendations, and/or the like). It is appreciated that the foregoing are examples of tasks that may be facilitated by the intelligence system 1130. In these embodiments, the transaction system 1150 (e.g., the transaction orchestration system 1152) is an intelligence client that provides requests to the intelligence system 1130, which in turn services the requests. In some embodiments, the intelligence system 1130 may apply governance standards as part of the servicing of the request (e.g., as discussed above). Additionally or alternatively, governance may be applied to potential actions of the transaction system 1150 independent of the servicing of intelligence requests by the transaction system 1150 to the intelligence system 1130. For example, the transaction system 1150 may interface with a governance system 1160 of the EAL, whereby the governance system 1160 may enforce one or more governance standards (e.g., legal/regulatory standards, industry standards, enterprise standards, or the like) before the transaction system 1150 is permitted to execute a pending transaction.

In embodiments, the transaction orchestration system 1152 interfaces with the permissions system 1170. In some embodiments, the transaction orchestration system 1152 may execute workflows that require the transaction system 1150 to verify that a transaction is permitted. As transactions may be initiated on behalf of an enterprise by entities of the enterprise, including employees, digital agents, AI-enabled robots, and/or the like, the transaction orchestration system 1152 may be configured to verify that the initiating entity of a respective transaction has been granted permission to execute such a transaction by the enterprise. As discussed, the permissions system 1170 may be configured to grant entities (e.g., employees, business units, third parties, contractors, digital agents, AI-enabled robots, and/or the like) with access to enterprise resources and data. In some of these embodiments, the permissions system 1170 is configured to selectively permit entities to perform certain types of transactions and/or perform transactions using certain accounts or digital wallets. For example, in response to a transaction request from an employee to perform an outbound transaction to a third party, the permissions system 1170 may determine whether to allow or deny the transaction request. In this example, permissions system 1170 may make this determination based on the employee's role in the company, the business unit of the employee, the transaction amount, the identity of the recipient of the payment (e.g., an individual, a company, a government department, etc.), the type of transaction (e.g., travel expenses, office supplies, raw materials, manufacturing parts, services for the enterprise, or the like), the employees transaction history, or the like. For instance, the requesting employee may have a role within the enterprise that is not permitted to initiate payments exceeding a limit without express approval from a manager. In another example, the employee may only be permitted to initiate transactions for certain types of services from approved vendors. In another example, the employee may be restricted from initiating any transactions without express approval from the employee's manager. In another example, the employee may be a member of a business unit that is only permitted to initiate transactions using a certain account or digital wallet. In these examples, the permissions system 1170 may be configured to receive transaction data indicating the requesting entity (e.g., an identifier of the employee), the transaction amount, the transaction medium (e.g., digital wallet identifier, account identifier, or the like), an identifier of the payee, and an identifier of the purpose of the payment (e.g., invoice identifier, a description or other identifier of the goods, services, or thing being paid for). In some embodiments, the permissions system 1170 may apply a set of rules defined by the enterprise to determine whether to allow a transaction, to deny the transaction, or to automatically request approval from an approving entity (e.g., business unit manager, CFO, internal accountant, or any other role or individuals designated by the entity). In the case that the permissions system 1170 determines that the transaction is denied or allowed, the permissions system 1170 provides a notification to the transaction system 1150 indicating whether the permission is denied or allowed. In the case that further approval is required, the permissions system may send a notification to an entity designated by the enterprise, whereby a user device of the designated entity displays or otherwise communicates an approval request to the designated entity. In these embodiments, the permissions system 1170 may approve or deny the transaction based on the response of the designated entity. In embodiments, the permissions system 1170 may be provided with a list of designated entities that can approve or deny transaction requests or certain types of requests. Additionally or alternatively, the permissions system 1170 may be provided with hierarchical rules that define the rules based on roles and/or business units (e.g., “managers of a business unit must authorize transactions by employees in the business unit”, “CEO, COO, or CFO must authorize any transaction exceeding a certain amount”, or the like). In these examples, the permissions system 1170 may access an organizational chart of the enterprise or a data store that stores the hierarchies of the enterprise (e.g., an entity graph of the organization) to determine whether to allow a transaction or to identify an appropriate enterprise resource to request authorization for the transaction. It is appreciated that the foregoing are examples of permission rules being applied to transaction execution workflows. Additional examples are provided elsewhere in the disclosure.

In embodiments, the transaction orchestration system 1152 may be configured to integrate, coordinate, manage, and/or otherwise facilitate payment processes that are performed on behalf of an enterprise. In embodiments, this may include end-to-end orchestration of payment transactions. In embodiments, different types of payment transactions may be orchestrated, whereby the various tasks of the orchestration are defined in respective transaction workflows. To facilitate a digital transaction, there may be several types of payment processes that need to be executed. For example, in some digital transactions the payment processes may include payment authorization, transaction routing, transaction settlement/execution, and/or post-transaction tasks. In embodiments, these processes are defined as tasks within a transaction workflow (e.g., payment authorization task, transaction routing task, transaction settlement tasks, and/or other necessitated tasks). In some examples, in order to orchestrate these digital asset transactions, the transaction system 1150 is configured to electronically connect entities involved in these payment processes, such as PSPs, acquirers, and/or banks and to communicate the appropriate information to these entities to facilitate/execute a transaction.

In embodiments, an end-to-end transaction workflow that orchestrates a payment to an entity on behalf of an enterprise may include a payment authorization task, a transaction routing task, and a transaction settlement/execution task. Furthermore, if the payment requires a conversion of currency to a target currency (e.g., a foreign currency to pay a foreign entity), an end-to-end transaction workflow may include a currency conversion task. It is appreciated that tasks of a transaction workflow may implicate additional workflows. For instance, a payment authorization task may implicate a corresponding workflow or a currency conversion task may implicate a currency conversion workflow (examples of which are provided below).

In an example of transaction orchestration system 1152 orchestrating an end-to-end payment transaction, the transaction orchestration system 1152 may receive a transaction request from an enterprise entity (e.g., an employee, an intelligent agent, or the like). In some example scenarios, the transaction request may request payment of a monetary amount to a third-party. The payment request may be initiated in response to an invoice for goods or services, to complete a purchase on behalf of the entity, a tax payment, a subscription payment, or the like. In embodiments, the transaction orchestration system 1152 executes a payment authorization task. In authorizing a payment, the transaction orchestration system 1152 ensures that the transaction system 1150 has requisite authorization to execute the transaction. In embodiments, payment authorization may include confirming that the transaction itself is permitted and that the requesting entity is authorized to request the payment (and if not, potentially obtaining authorization from a designated entity or set of entities).

In embodiments, the transaction orchestration system 1152 interfaces with the permissions system 1170 to determine if certain transactions are permitted and that the requesting entity is authorized to request the payment (and in not, potentially obtaining authorization from a designated entity or set of entities). In some embodiments, the transaction orchestration system 1152 may call the permissions system 1170 when a transaction workflow requires that the transaction system 1150 verify that a transaction is permitted. As transactions may be initiated on behalf of an enterprise by entities of the enterprise, including employees, digital agents, AI-enabled robots, and/or the like, the transaction orchestration system 1152 may be configured to verify that the requested transaction is permitted by the enterprise and that the initiating entity of a respective transaction has been granted permission to execute such a transaction by the enterprise. As discussed, the permissions system 1170 may be configured to grant entities (e.g., employees, business units, third parties, contractors, digital agents, AI-enabled robots, and/or the like) with access to enterprise resources and data. In some of these embodiments, the permissions system 1170 is configured to selectively permit entities to perform certain types of transactions and/or perform transactions using certain accounts or digital wallets. For example, in response to a transaction request from an employee to perform an outbound transaction to a third party, the permissions system 1170 may determine whether to allow or deny the transaction request. In this example, permissions system 1170 may make this determination based on the employee's role in the company, the business unit of the employee, the transaction amount, the identity of the recipient of the payment (e.g., an individual, a company, a government department, etc.), the type of transaction (e.g., travel expenses, office supplies, raw materials, manufacturing parts, services for the enterprise, or the like), the employees transaction history, or the like. For instance, the requesting employee may have a role within the enterprise that is not permitted to initiate payments exceeding a limit without express approval from a manager. In another example, the employee may only be permitted to initiate transactions for certain types of services from approved vendors. In another example, the employee may be restricted from initiating any transactions without express approval from the employee's manager. In another example, the employee may be a member of a business unit that is only permitted to initiate transactions using a certain account or digital wallet. In these examples, the permissions system 1170 may be configured to receive transaction data indicating the requesting entity (e.g., an identifier of the employee), the transaction amount, the transaction medium (e.g., digital wallet identifier, account identifier, or the like), an identifier of the payee, and an identifier of the purpose of the payment (e.g., invoice identifier, a description or other identifier of the goods, services, or thing being paid for).

In some embodiments, the permissions system 1170 applies a set of rules defined by the enterprise to the transaction data to determine whether to allow the transaction, deny the transaction, or require approval from an approving entity designated by the entity (e.g., business unit manager, CFO, internal accountant, or any other role or individuals designated by the entity). In the case that the permissions system 1170 determines that the transaction is denied or allowed, the permissions system 1170 provides a notification to the transaction system 1150 indicating whether the permission is denied or allowed. In embodiments, the permissions system 1170 may maintain a set of transaction rules defined by the enterprise. These rules may indicate the types of transactions that are permitted and/or not permitted by the enterprise. For example, an enterprise may prohibit transactions occurring in certain countries or states, payments made to gambling or adult websites, cash transfers to third parties, purchases on certain retail sites, cryptocurrency transactions on certain exchanges, purchases of certain types of goods (e.g., alcohol). Additionally or alternatively, the enterprise may define a list of permitted transaction types and/or conditions that must be met to permit a type of transaction. For example, an enterprise may designate certain retail platforms for the purchase of office supplies, certain travel companies for travel accommodations, tax payments made in certain time windows, cryptocurrency transactions involving designated cryptocurrency, parts or raw materials from approved vendors upon verifying an invoice from the approved vendor, payment of professional services only if a verified record of an engagement agreement exists, and/or the like. In some embodiments, the rules may require approval of a transaction type from a designated employee or type of employee when a transaction type is not explicitly approved or prohibited. In embodiments, the rules may also designate which employees or types of employees may initiate/request permitted transactions. For example, an enterprise may define rules that permit certain employees or types of employees to: sign up for certain types of software services (e.g., managers of a data science team are permitted to sign up for data warehousing and other big data related services or HR managers are authorized to sign up for payroll software services), to order parts or raw materials used to manufacture products (e.g., designated employees are permitted to transact with approved vendors of parts or raw materials), to pay for consultants or professional services (e.g., in-house attorneys are permitted to authorize payment of invoices for legal services from engaged law firms, the CFO is permitted to authorize payments to third party accounting services, etc.), to make tax payments (e.g., CEO and CFO are permitted to authorize tax payments), and/or the like. In embodiments, the permissions system 1170 may enforce authorization rules defined by the enterprise that designate certain employees or types of employees that can authorize transactions requested by enterprise entities not having sufficient permissions. The authorization rules may dictate who can authorize a transaction when the requesting entity does not have permission to unilaterally initiate a transaction. Examples of authorization rules may be defined by a transaction amount (e.g., any payment over $10,000 must be approved by the CFO), a class of employee (e.g., requests by non-management employees must be approved by a manager in the business unit of the requesting employee); a transaction type (e.g., travel related transaction requests made by members of a business unit must be approved by the head of the business unit; payment of invoices to a professional services company must be approved by the head of the business unit that engaged the professional services company; purchases of stocks, bonds, cryptocurrency, or other financial instruments must be approved by the CFO, etc.) or the like. Additionally or alternatively, the permissions system 1170 may maintain hierarchical rules that define the rules based on roles and/or business units within an enterprise (e.g., “managers of a business unit must authorize transactions by employees in the business unit”, “CEO, COO, or CFO must authorize any transaction exceeding a certain amount”, or the like). It is appreciated that other types of transaction authorization rules may be defined by the enterprise, such that the permissions system 1170 uses the rules to determine whether to allow a transaction, deny a transaction, or require authorization from another entity within the organization.

In embodiments, the permissions system 1170 may analyze the transaction data associated with a transaction request to determine whether the transaction is permissible or not. If the transaction is permissible, the permissions system 1170 may determine if the requesting entity has authorization to request the transaction based on the transaction rules defined by the enterprise. In embodiments, the permissions system 1170 may access an enterprise datastore that entity records of entities associated with an enterprise (e.g., employees, executives, business units, departments, intelligent agents, robots, business units, customers, vendors, service providers, governments, marketplaces, exchanges, and/or the like). In embodiments, the entity datastore may include entity databases, which may include any suitable combination of database types (e.g., SQL databases, graph databases, vector databases, and/or the like. In embodiments, attributes of the entity records include an entity identifier and an entity type of the entity. Furthermore, the relationships between the entity records may be indicative of an organizational structure of the enterprise (e.g., an org chart, business units of the enterprise, roles within the enterprise, reporting structures of roles and/or individuals, and/or the like). Additionally, the relationships may be indicative of relationships between the enterprise and a third-party entity (e.g., seller, buyer, lender, service provider, etc.). In some embodiments, the entity records may store or reference additional information about a respective entity such as a location of an entity, an address of an entity, transaction history of the entity, a title of the entity, and/or the like. In some embodiments, the permissions system 1170 may access a data pool managed by the data pool system 1136 to access some types of entity data (e.g., data shared by a third-party involved in a transaction), such that the entity data in the data pool may be used by the permission system 1170 to determine whether or not to authorize a payment. In embodiments, the permissions system 1170 may obtain the entity data corresponding to a requested transaction based on the transaction data indicated in the transaction request. The permissions system 1170 may determine whether or not to allow the transaction based on the entity data and the permission rules defined by the enterprise. In some scenarios, the permissions system 1170 may further determine whether to require authorization from one or more for employees or other enterprise entities based on the rules defined by the enterprise. It is appreciated that the foregoing are examples of permission rules being applied to transaction execution workflows. Additional examples are provided elsewhere in the disclosure.

In the scenario where the transaction is denied, the transaction orchestration system 1152 may halt the requested transaction. In doing so, the transaction orchestration system 1152 may be configured to notify one or more enterprise entities of the denial (e.g., the requesting user, a supervisor of the requesting entity, a business unit manager, or the like) and/or to initiate recordation of the denial (e.g., by requesting that the reporting system report the denial). In the case that the permissions system approves the transaction request, the transaction orchestration system 1152 proceeds to a subsequent task of the transaction workflow. In some embodiments, the transaction orchestration system 1152 may be configured to initiate recordation of the approval (e.g., by requesting that the reporting system record the approved transaction).

In some embodiments, the permissions system 1170 is configured to determine if a transaction requested by a user requires authorization from one or more other users. For example, the permissions system 1170 may be configured with a set of authorization rules that define which types of users and/or transaction types must have explicit authorization to perform certain types of transactions. These authorization rules may define an authorization hierarchy that indicates which types of employees can authorize a transaction, which employees or types of employees must have their transactions authorized, transaction limits that indicate a transaction threshold amount that when exceeded triggers an authorization requirement, transaction types that require authorization, and/or the like. The permissions system 1170 may determine whether a transaction request requires further authorization based on the entity data and the authorization rules defined by the enterprise. In embodiments, the permissions system 1170 may further identify one or more enterprise entities that can authorize the payment transaction if further authorization is required. As mentioned, the authorization rules may include an authorization hierarchy that define which employees authorize which types of transactions. In these embodiments, the authorization rules may define rules that define the roles or identities of enterprise entities that are able to authorize transactions for certain business units, users, transaction amounts, and/or counterparties. For example, transactions requested from a certain business unit may require a manager or director of the business unit to authorize said transactions. In another example, transactions exceeding certain thresholds may require authorization from the CEO, CFO, or a manager in the finance department. Other non-limiting examples of authorization rules are described elsewhere throughout the disclosure.

In the case that further approval is required, the permissions system 1170 may provide a response to the transaction system 1150 indicating that the requested transaction requires additional approval and one or more entities that can authorize the transaction. In response, the transaction system 1150 may send a notification to one or more entities (e.g., as identified by the permissions systems 1170), whereby a user device of the designated entity displays or otherwise communicates an approval request to the authorizing entity. In embodiments, the transaction system 1150 includes an authorization system 1158 that is configured to obtain authorization from one or more enterprise entities, such that the authorization from the authorizing entity or entities allows the transaction orchestration system 1152 to proceed with the transaction. The authorization system 1158 may interface with the permissions system 1170 to determine which entities have what access. In some embodiments, the authorization system 1158 may send an authorization request to the authorizing users. The authorization request may include a set of transaction parameters, such as the transaction amount, the requesting user that requests the transaction, counterparty of the transaction, and/or the purpose of the transaction (e.g., goods or services being paid for, tax payment, and/or the like). In some of these embodiments, the authorization system 1158 sends the authorization request to the authorizing users and the authorizing user may approve or reject the transaction. In some scenarios, the user device of the authorizing entity may cryptographically sign the approval or rejection (e.g., using a private key associated with the authorizing entity), such that the authorization system 1158 can verify that approval or rejection (e.g., based on a public key associated with the authorizing entity). In the case that the transaction is approved by the authorizing user, the authorization system 1158 may provide authorization to transaction orchestration system 1152, which may then initiate recordation of the approval by the authorizing entity (e.g., on a blockchain, enterprise database, or the like) and proceed to the next stage of the transaction workflow. If the authorizing user rejects the transaction, the authorization system 1158 records the rejection and may prevent the requested transaction from proceeding. In some embodiments, the transaction system may require the authorizing user to provide a reason for rejecting the transaction, such that recordation of the rejection includes the reason why the transaction was rejected.

In addition to verifying that the requesting authority has sufficient the transaction orchestration system 1152 may be configured to determine whether to allow or deny transactions based on one or more scores obtained from a scoring system 1134. In some embodiments, the transaction orchestration system 1152 may be configured to obtain a trust score from a trust system (e.g., such as the trust systems described above) before authorizing a blockchain transaction to proceed. In these embodiments, the transaction orchestration system 1152 may provide the blockchain address of an intended recipient of a payment and a trust system may return a trust score corresponding to the address. If the trust score does not exceed a threshold, the transaction orchestration system 1152 may deny the payment and initiate any post-transaction recordation and/or notification tasks. In some embodiments, the transaction orchestration system 1152 may be configured to obtain a KYC score before proceeding with a payment to an account associated with an individual or unvetted enterprise. For example, the transaction orchestration system 1152 may provide information relating to an intended recipient of a transfer of funds to the scoring system 1134, which may provide a score indicating whether a recipient of a transfer of funds is likely fraudulent and/or participating in illicit activity (e.g., money laundering, phishing, or the like). In the case the score is below a threshold, the transaction orchestration system 1152 may deny the payment and initiate any post-transaction recordation and/or notification tasks. It is appreciated that the transaction orchestration system 1152 may perform additional or alternative scoring tasks before allowing a transaction to proceed to a subsequent task.

In embodiments, the transaction orchestration system 1152 may initiate a payment routing task in response to allowing a transaction to proceed. In embodiments, the transaction orchestration system 1152 may determine a transaction rail and/or digital wallet to use to perform the requested digital transaction. In some embodiments, the transaction orchestration system 1152 determines an optimal transaction rail for a digital transaction based on one or more factors, such as the type of digital transaction (such as by selecting a transaction rail that is capable of executing the type of digital transaction), the volume or size of the digital transaction (such as by selecting a transaction rail that is capable of handling the volume, one that provides a volume-based benefit, such as a discount, credit, or reward, or the like), the format of the digital transaction, the location of the transaction (e.g., the destination of the transaction and/or source of the transaction), the financing of the digital transaction, the cost of the digital transaction (including transaction cost, borrowing cost, processing costs, costs of energy, and the like) and/or the currency involved in the transaction, among others. As an example, the recipient of the payment (e.g., a market participant 910) may indicate the preferred payment method (e.g., payment in a certain currency, requiring ACH transfers, requesting payment in cryptocurrency, and/or the like). In some scenarios, the selection of a transaction rail may be dictated in part by a transaction facilitator (e.g., an e-commerce interface), whereby the requesting entity selects a payment option from a set of options designated by the transaction facilitator. In some embodiments, the transaction orchestration system 1152 selects a transaction rail based on one or more models of the intelligence system 1130. For instance, a model maintained by the intelligence system 1130 may be trained using historical enterprise transaction data to generate a recommendation or prediction of a transaction rail for a given digital transaction based on current enterprise conditions (including enterprise resource plans, transaction plans, strategic plans, policies, and the like), market conditions, and other contextual information. For example, for a particular transaction, the transaction system 1150 determines a payment method or payment rail for a transaction involving the particular asset. Some examples of payment methods include clearing houses (e.g., Automated Clearing House (ACH)), credit card providers (e.g., MASTERCARD®, VISA®), online payment systems (e.g., PayPal®, Venmo®, CashApp®), Real-time Payment (RTP) Network, blockchains, the Society of Worldwide Interbank Financial Telecommunications (SWIFT), Single Euro Payments Area (SEPA), and the like. The transaction system 1150 may automatically determine which payment method to use based on characteristics the type of transaction, the parties involved in the transaction, the location of the transaction (e.g., a country, state, city, jurisdiction where the transaction is executed), and/or the currency of the transaction.

In embodiments, the transaction orchestration system 1152 may additionally or alternatively designate a digital wallet from the set of enterprise wallets to execute the transaction. In some embodiments, the transaction orchestration system 1152 may select the digital wallet based on the identified transaction rail. For example, if only a single enterprise digital wallet can perform transactions on the selected transaction rail or if the requesting entity or business unit of the requesting entity only has permission to access a single enterprise digital wallet that can perform transactions on the selected transaction rail, the transaction orchestration system 1152 may designate the digital wallet to execute the transaction. If there are multiple wallets that can perform the transaction, the transaction orchestration system 1152 may select one of the multiple capable enterprise wallets to execute the transaction. For example, transaction orchestration system 1152 may request that the requesting user select a digital wallet from the capable enterprise wallets (e.g., via a GUI or voice command). Additionally or alternatively, the enterprise may designate certain wallets for certain types of transactions. For example, transactions that are executed in foreign countries, the enterprise may designate a digital wallet that is capable of transacting using in those countries. In another example, for certain crypto transactions, the enterprise may designate a certain digital wallet for performing transactions on a specific blockchain. In some embodiments, the transaction orchestration system 1152 may determine which digital wallet to designate for executing the transaction based on one or more factors such as the cost of a transaction on a respective digital wallet, the transaction speeds of each capable wallet, the reliability of each capable enterprise wallet, the security features of each capable wallet, and/or other suitable factors.

In response to identifying a digital wallet and/or transaction rail on which a transaction will be executed, the transaction orchestration system 1152 may proceed to a transaction settlement/execution task and instruct the transaction interface system 1154 to execute the transaction. In some embodiments, the transaction orchestration system 1152 may provide a configured transaction to the transaction interface system 1154 that indicates transaction details for executing the transaction. In embodiments, the transaction details may indicate the digital wallet to use in the transaction, an account corresponding to the transaction (e.g., an identifier of a bank account, credit card, blockchain address, and/or the like), the transaction amount, transaction routing information (e.g., account identifier and/or any other information needed to transfer funds to the recipient), and/or the like. In embodiments, the transaction interface system 1154 uses the transaction details to execute the transaction and may provide a response indicating the result of the transaction (e.g., was the transaction successfully executed). In the case that the transaction was executed, the transaction orchestration system 1152 may initiate one or more post-transaction tasks. Examples of post-transaction tasks include, but are not limited to, recordation of the transaction, notifications being sent to one or more enterprise entities, outcome monitoring (e.g., monitoring outcomes of transactions for reinforcing models used to make predictions, and/or the like).

In some embodiments, a transaction workflow may include a currency conversion task, whereby the transaction orchestration system 1152 orchestrates a conversion of enterprise reserve of currency into a target currency, such that the target currency is used to complete a transaction. As more enterprises become global or multi-regional market participants (e.g., a multi-regional merchant), many enterprises have to make outbound payments to a counterparty (e.g., payments for supplies, services, raw materials, taxes, utilities, rent, loan servicing, and/or the like). In such examples, the enterprise can integrate with multiple region-specific payment service providers (PSPs) via the transaction orchestration system 1152 of the transaction system 1150.

In embodiments, the conversion system 1156 is configured to convert currencies held by the enterprise into a target currency, such as by automatically purchasing or selling a given currency based on an enterprise forecast of the amount of the currency that will be needed to achieve enterprise objectives that will involve the currency. The forecast of currency needs, which may be continuously updated, may be based on a model of anticipated transaction workflows that are predicted based on historical transactions, current conditions (including market prices of items to be bought or sold using a currency), current cash reserves in the currency, and enterprise objectives (e.g., increasing or decreasing production of a good that requires a part or raw material from a foreign country, the need for services in a foreign country, a tax payment to a foreign country, real estate purchase in a foreign country, and/or the like). As is discussed, automation of may be supported by the intelligence system 1130, whereby one or more machine-learned models and/or other artificial intelligence services may be leveraged to optimize the currency exchange on behalf of the enterprise.

In embodiments, the transaction system 1150 maintains respective balances of enterprise cash reserves in various currencies. In embodiments, these cash reserves may be indicative of total cash in digital wallets (e.g., Venmo, Paypal, Apple Wallet, Google Wallet, etc.) and enterprise bank accounts and may be determined by querying the digital wallets and bank portals (e.g., using APIs thereof) and/or by maintaining an internal ledger of enterprise transactions, including all cash transactions. In embodiments, the conversion system 1156 may determine or receive (e.g., from another EAL system) an amount of foreign currency needed to execute one or more pending and/or upcoming transactions. The amount of foreign currency needed may be a realized amount (e.g., an invoiced amount for goods or services rendered, a tax liability of the enterprise, a purchase price of goods, services, or property, or the like) or a predicted amount (e.g., a projection of future invoiced amounts, a predicted tax liability, a predicted purchase price, or the like). In embodiments, the conversion system 1156 executes a currency exchange workflow in response to the obtained amount of foreign currency needed. In an example currency exchange workflow, the conversion system 1156 may first determine an amount of foreign currency to obtain based on the difference between the amount needed in a foreign currency to complete the transactions and the current enterprise cash reserves in the foreign currency. In some scenarios, regulatory and/or enterprise governance may require that the enterprise maintain minimum levels of cash reserves in certain currencies (e.g., at least one million USD, at least 250,000 Euros, at least two million Chinese Yuan, etc.). In these scenarios, the transaction orchestration system 1152 may determine the amount of foreign currency to obtain based on the difference between the current enterprise cash reserves in the foreign currency and the amount needed in a foreign currency to complete the transactions plus the minimum threshold balance required to be maintained in the foreign currency.

In response to determining an amount of foreign currency to obtain, the conversion system 1156 may determine a type of currency to exchange, an exchange or market to perform the currency exchange transaction, and/or a timing of the currency exchange transaction. In embodiments, the conversion system 1156 may determine the currency to exchange based on the enterprise cash reserve balances of the other currencies held by the enterprise, predicted needs for the other currencies held by the enterprise for future transactions, predicted future price of the other currencies held by the enterprise, and any governance standards controlling minimum balances in certain currencies. For example, if the conversion system 1156 is exchanging for British Pounds and the enterprise has cash reserves in Euros and no longer has a need to transact in Euros, the conversion system 1156 may decide to exchange at least a portion of the remaining enterprise Euro reserves for the needed amount of British Pounds. If, however, in this example the conversion system 1156 predicts that the price of Euros will increase in relation to US dollars in the next year, the conversion system 1156 may decide to exchange US dollars to British Pounds instead of exchanging Euros for Pounds. In embodiments, the conversion system 1156 may also monitor various currency exchanges to identify which currency exchange to use to execute the currency exchange. In some of these embodiments, the transaction system 1150 may provide an analytics request to the intelligence system 1130 that indicates the target currency being exchanged for, the currency being exchanged, and the amount of currency being exchanged.

In embodiments, the conversion system 1156 may select a currency exchange that historically or currently offers exchange rates that are most favorable to the enterprise. In some of these embodiments, the intelligence system 1130 returns market analytics relating to monitored currency exchanges to determine which currency exchange to execute the transaction on. In some of these embodiments, the market analytics may indicate the currency exchanges that can accommodate the transaction, and for each exchange the difference between the offered exchange rate by the exchange and the managed floating exchange rate. The conversion system 1156 may also request additional or alternative metrics to inform the decision of selection of exchange rate, such as a trust score of the exchange, a variability of offered exchange rates, and/or the like.

In some embodiments, the conversion system 1156 may also determine a transaction timing, such as a date and time to execute the currency exchange. In embodiments, the conversion system 1156 may send prediction requests to the intelligence system 1130 to obtain predictions relating to the future exchange rates for the target currency and currency being exchanged. In embodiments, the prediction request may indicate the target currency and the currency being exchanged. In some of these embodiments, the intelligence system 1130 may return. In these embodiments, the intelligence system 1130 may provide one or more predicted exchange rates (e.g., a predicted floating currency exchange rate) on one or more respective dates and/or times. In some embodiments, the conversion system 1156 may determine a date and time to execute the currency exchange transaction based on the predicted exchange rates and any time constraints relating to a subsequent transaction that requires the target currency (e.g., a date when the subsequent transaction needs to be completed by).

In embodiments, the conversion system 1156 executes the currency exchange transaction. In some example embodiments, the conversion system 1156 may instruct the transaction interface system 1154 to transfer to transfer an amount of the currency to be exchanged from the enterprise cash reserves to the currency exchange to purchase the determined amount of target currency. It is appreciated that the transaction interface system 1154 may execute the transaction using one or more of the enterprise digital wallets and/or by initiating a bank transfer (e.g., ACH transfer) from an enterprise bank account that holds the cash reserves. In response the currency exchange transfers the corresponding amount of target currency to an enterprise account (e.g., wallet or bank account).

The foregoing is an example of a currency exchange transaction orchestration. It is appreciated that additional or alternative exchange workflows may be implemented by an EAL deployment. Furthermore, while the provided example describes an examples of “fiat-for-fiat” currency exchanges, transaction orchestration workflows may be modified to accommodate crypto-for-fiat, crypto-for-crypto, or fiat-for-crypto currency exchanges. Furthermore, the example currency conversion workflows described herein may be executed as part of a larger transaction orchestration, such as part of an “end-to-end” transaction orchestration workflow for paying a third-party, such as where the third party requires payment in a certain type of currency that the enterprise does not typically transact in.

In some implementations, the transaction system 1150 functions to optimize a digital transaction. For example, the transaction optimization functions to determine an optimal payment route to conduct (e.g., send) a digital transaction. This optimal payment route may include determining an optimal transaction rail and/or digital wallet to execute the transaction. Here, the best route may depend on the type of digital asset (such as by selecting a transaction route or rail that is compatible with the asset), the volume or size of the digital transaction (such as by selecting a transaction rail that is capable of handling the volume, one that provides a volume-based benefit, such as a discount, credit, or reward, or the like), the format of the digital transaction, the location of the transaction (e.g., the destination of the transaction and/or source of the transaction), the financing of the digital transaction, the cost of the digital transaction (including transaction cost, borrowing cost, processing costs, costs of energy, and the like) and/or the currency involved in the transaction, among others.

In some implementations, the details about the transaction include terms for the transaction, such as transfer terms (e.g., shipping terms), payment terms (e.g., net 30/60/90), interest terms, licensing terms, or other contract terms (e.g., representations and/or warranties). With the transaction details, the transaction system 1150 may be configured to orchestrate the transaction using a payment or transaction gateway. In some configurations, the transaction system 1150 or another system (e.g., a third-party payment system) encrypts/decrypts some portion of the transaction details (e.g., payment information such as card numbers, routing numbers, communication addresses, etc.) prior to or during communication of the transaction detail to a PSP.

In some configurations, the transaction system 1150 configures the transaction details in order to orchestrate a transaction for an enterprise digital asset. When configuring the transaction details, the transaction system 1150 may specify transaction details that represent the interest of the enterprise. In some situations, to represent the interest of the enterprise, the transaction system 1150 generates transactions details by use of one or more models of the intelligence system 1130. For instance, a model of the intelligence system 1130 may be trained using historical enterprise transaction data to generate a recommendation or prediction of transaction details the enterprise 900 would prefer for a particular enterprise digital asset, which may be further based on current enterprise conditions (including enterprise resource plans, transaction plans, strategic plans, policies, and the like), market conditions, and other contextual information. A recommendation or prediction may be further used to configure a set of instructions to initiate the transaction, which may be automatically initiated or triggered by an authorized entity. To illustrate, for a particular asset, the transaction system 1150 determines a payment method or payment rail for a transaction involving the particular asset. Some examples of payment methods include clearing houses (e.g., Automated Clearing House (ACH)), credit card providers (e.g., MASTERCARD®, VISA®), online payment systems (e.g., PayPal®, Venmo®, CashApp®), Real-time Payment (RTP) Network, blockchains, the Society of Worldwide Interbank Financial Telecommunications (SWIFT), Single Euro Payments Area (SEPA), and the like. The transaction system 1150 may automatically determine which payment method to use based on characteristics regarding the asset (e.g., asset attributes), the parties involved in the transaction, the location of the transaction (e.g., a country, state, city, jurisdiction where the transaction is executed), and/or the currency of the transaction.

In some implementations, the transaction system 1150 (and/or other EAL systems) may be configured with an awareness for transactions across sets of assets. For example, in some embodiments, the transaction system 1150 may be configured to identify transactions which would be more efficient to combine or divide. For instance, the transaction system 1150 can determine that instead of selling a first asset in a first marketplace and a second asset in a second marketplace, the enterprise 900 would receive the most value for these assets by bundling the first and second asset together with a third asset and selling these three assets as a package in one of the marketplaces or a third marketplace. Similarly, the transaction system 1150 may combine acquisitions by packaging multiple acquisitions for different enterprise entities and/or workflows into a bundle, such as to access volume discounts or other benefits. In other cases, unbundling purchases or sales may provide benefits, such as where discounts are offered for new or trial users of a set of marketplaces or exchanges up to a maximum threshold of transaction value. In other words, with the transaction system 1150 being able to track multiple available assets (including ones desired to be acquired) for the enterprise 900, the transaction system 1150 can likewise leverage combination or disaggregation of assets to engage in complex transactions that benefit the enterprise 900 more than unmanaged transactions with the assets. As another example, the transaction system 1150 can operate with supply-side knowledge for the enterprise 900 (e.g., the supply rate for enterprise digital assets) while also tracking current and past demand-side knowledge across multiple marketplaces for assets that have characteristics, properties, or attributes similar to enterprise assets used in historical workflows in order to generate a recommendation, prediction or instruction about further acquisition. This may further include adjusting the recommendation, prediction or instruction based on an enterprise plan, contextual conditions, or the like.

Another transaction detail that the transaction system 1150 is capable of determining is payment details. Here, one type of payment detail that the transaction system 1150 may coordinate or control is the type of currency that is exchanged and/or when the exchange involving an enterprise digital asset occurs using a particular currency.

Determining the type of currency or the timing of a transaction with a particular currency may allow the transaction system 1150 to have another approach to optimize value for a transaction. For instance, the value of different types of currencies is capable of fluctuating based on market conditions. That is, conversion rates or exchanges rates may be determined by a floating rate that depends on market forces of supply and demand for foreign exchange or a fixed rate. Due to the fluctuation of conversion rates, the timing of when a transaction occurs can dictate the buying power or selling power of an asset. To illustrate, if the United States Dollar (USD) has an exchange rate greater than one with respect to the British Pound, then the USD, at that time has greater buying power than when the USD has an exchange rate less than one with respect to the United Kingdom Pound. In other words, with a ratio over one, the USD gets a greater return in British Pound than with a ratio less than one. Therefore, if a transaction for a US enterprise 900 was going to occur in British Pounds (e.g., with a British market participant), the transaction system 1150 may track the conversation rates and/or facilitate the execution of the transaction at a time within a particular transaction window (i.e., a permitted time period to execute the transaction) that is most advantageous to the US enterprise (e.g., when the USD has the greatest buying power). To facilitate such activity, the EAL system may access a set of predictions of currency conversion rates, such as one generated based on market factors, such as economic data for respective jurisdictions, central bank interest rates, and the like.

In embodiments, the transaction system 1150 may perform transactions accounting for factors such as environmental factors, market conditions, economic conditions, or weather conditions. For example, if the exchange of a digital asset is associated with a physical good, the transaction system 1150 can coordinate transaction details, such as shipping logistics or the timing of the performance of the transaction, based on influencing factors such as environmental factors, weather factors, and/or political factors. For instance, if the enterprise 900 is aware that a network is going to be offline for maintenance, the transaction system 1150 can recognize this upcoming event, and adjust transaction details based on the recognition (e.g., schedule the transactions to occur outside the time when the network is offline). Similarly, if a resource or asset needed by the enterprise is subject to consistent seasonal or other periodic variations in price or availability, the transaction system 1150 can coordinate transactions to acquire the resource or asset at a favorable time (such as during an annual promotional event of a supplier). In embodiments, an acquisition or disposition plan of an enterprise, or instructions derived therefrom, may be linked to or integrated with or into the transaction system 1150, such that the transaction system 1150 is configured to optimize, and then execute, a series of transactions that accomplish the plan (acquisition of needed resources and assets and disposition of others) while optimizing timing and other transaction parameters as noted above.

In some examples, the transaction system 1150 links to or is integrated with an e-commerce engine that includes one or more interfaces. These interfaces may refer to software modules that execute on hardware to provide a portal or graphical user interface (GUI) to interact with the transaction system 1150. That is, the GUI may be designed such that the GUI represents the wallets of the transaction system 1150 and the functionality that is accessible to a particular entity interacting with the EAL 1000. In some examples, the transaction system 1150 includes an interface for each type of entity that has access to the EAL 1000. In other words, an entity of the enterprise 900 may use an enterprise interface of the transaction system 1150 to facilitate the functionality of the transaction system 1150 for enterprise-based activities (e.g., submitting an enterprise asset available or facilitating transaction details on behalf of the enterprise 900 for an asset). Similarly, the transaction system 1150 may have a marketplace participant interface separate from the enterprise interface that functions to facilitate actions in the transaction system 1150 that are available to the market participant 910. For instance, the marketplace participant interface may include an e-commerce shopping interface to discover what assets are available for transactions, a checkout interface such as a shopping cart as a means to stage a series of assets for purchase, or the like.

In some implementations, instead of having multiple interfaces, the transaction system 1150 uses a single interface that is capable of identifying a user of the interface and configuring, presenting or rendering a GUI that matches the access and/or wallet activity permissions associated with the user. In this sense, the single interface is capable of restricting a user from accessing or executing the functionality associated with windows, menus, or other GUI elements that are tied to certain wallet-based activities that should not be accessible to a particular user. For instance, the GUI elements may include an identifier that designates the access permissions required to render the element for display. In this instance, at runtime, transaction system 1150 determines the access permissions associated with a user and renders the GUI elements that satisfy or match the determined access permissions. For example, a purchasing manager in charge of acquiring semiconductor chips may be presented GUI elements that display data from market participants who offer them while not being presented with GUI elements for other goods or services. In this respect, regardless of whether the transaction system 1150 uses one or more interfaces, the user experience (UX) of the interface(s) for the transaction system 1150 differs depending on the entity that is using the interface(s), such that GUI elements and their rendering is tied to access controls and permissions for the transaction system 1150.

Although the wallet interfaces are described with respect to an enterprise entity and a market participant 910, the wallet interfaces are capable of managing access to the transaction system 1150 (e.g., wallets of the transaction system 1150) at a more granular level such that one enterprise entity may have access to some wallets while another enterprise entity may have access to a different set of wallets (e.g., which may include access to at least one of the same wallets). Similarly, a market participant 910 (e.g., from a first marketplace 922) may have access to some wallets (e.g., a first set of wallets) while another market participant 910 (e.g., a second marketplace 922 different than the first marketplace 922) has access to a different set of wallets (e.g., which may include access to at least one of the same wallets). In this manner, the access to the transaction system 1150 can be managed not only at the enterprise/non-enterprise level, but also at the entity level.

### Governance System

The governance system 1160 is configured to create, track, and/or ensure compliance with various rules (e.g., laws, regulations, standards, and/or practices) that impact an enterprise digital asset and transactions regarding the enterprise digital asset. These rules may be government-imposed rules (e.g., laws or regulations), industry-imposed rules (e.g., industry standards or specifications), enterprise-imposed rules (e.g., dictated by an enterprise's code of conduct, mission statement, governance purpose), or consumer-imposed rules (e.g., rules dictated by consumer advocacy groups or consumer watchdogs). A legal governance system 1162 may monitor compliance of the EAL 1000 with government-imposed rules. The legal governance system 1162 may have a ruleset defined by subject matter experts and/or created based on training data of prior governance activity. A training system 1167 may rely on the intelligence system 1130 to generate a machine learning (ML) model based on governance training data. The training system 1167 may use supervised learning, such as a set of governance decisions made on a set of items (such as assets). The training system 1167 may determine what features of the assets are correlated with governance decisions, such as by using principal component analysis (PCA). In this way, the training system 1167 can infer the rules for governance without an expert having to explicitly define and hone them. The training system 1167 may continue to operate, such as on a periodic basis, to ensure the ML model embodying governance rules stays up to date.

Some types of assets may have testing standards that have to be met for the asset to be considered an exchangeable asset. A testing system 1163 may be responsible for performing tests—such as on a scheduled basis—on specific aspects of the EAL 1000. For example, the testing system 1163 may test—for example, on an hourly basis—an amount of leverage of each interface connected to the transaction interface system 1154. The testing system may also test an enterprise-wide amount of leverage. The amounts of leverage may be compared against thresholds and, if the thresholds are exceeded, transactions may be performed to reduce the amount of leverage. In this context, leverage refers to how much debt is being used to finance an investment in comparison to liquid assets.

In some examples, governance is market-specific, so a market-specific system 1164 governs satisfaction of requirements for a market participant to participate in a marketplace. Other types of governance include financial governance and risk governance. These types of governance may be implemented by the market-specific system 1164, a custom governance system 1166, or another element (not shown) of the governance system 1160. An ethics system 1165 performs ethical governance according to goals of the enterprise—such as maintaining enterprise-wide charitable giving or achieving greenhouse gas emissions targets. In various implementations, these ethical goals may be set by management of the enterprise, such as by the board of directors.

The custom governance system 1166 facilitates custom governance that may be set by a participating party of a transaction and/or an external entity, such as an operator of a marketplace or exchange, a regulatory body, etc. In order to enforce, monitor, and/or track the governance for an enterprise asset, the governance system 1160 may include any number of libraries that include relevant polices, compliance rules, etc. for resources, assets, or activities of the enterprise 900. In embodiments, the libraries may include parameters that define or otherwise correspond to certain rules and/or scenarios. These libraries may be used to construct a custom governance scheme in the custom governance system 1166.

In some configurations, when an enterprise digital asset is made available in the transaction system 1150, the governance system 1160 identifies any governance that is applicable to the asset. Any identified governances may be indicated in information associated with the asset. In some situations, the governance system 1160, besides merely identifying applicable governance, is configured to determine whether the asset complies with the identified governance. Here, for example, if the asset complies with the identified governance, the asset is made fully available to outside market participants 910 (for example, via marketplaces 922). On the other hand, in some implementations, if the asset fails to comply with the identified governance, the asset may be removed from transactional availability.

In some instances, an asset that fails to comply with governance parameters may be offered at some reduction of value that is proportional to the severity of the compliance failure. In some of these instances, an asset that fails to comply with governances may be flagged and include information that identifies the failure such that any failure is conspicuous to a potential customer or investor in the asset. Here, this allows the asset to stay available, but the risk to be borne by the customer or purchaser is displayed in a transparent fashion. In these instances, the governance system 1160 may generate fault-identifying information that includes a disclaimer or the prominent inclusion of contract terms for the transaction.

### Permissions System

In embodiments, the permissions system 1170 may include a credential system 1171, an access negotiation system 1172, a granularity system 1173, a privacy enforcement system 1174, a network availability system 1175, a request system 1177, an approval system 1178, and/or a need-to-know system 1179, among others. The permissions system 1170 assigns, manages, and/or facilitates access controls and permissions for the EAL 1100. In this sense, the permissions system 1170 is capable of performing access control activities for the other EAL systems associated with the EAL 1100. In other words, the permissions system 1170 can be configured to field permission-based or access requests received by any EAL system. For instance, in response to receiving a request to access the transaction system 1150 via a wallet interface, the permissions system 1170 can be informed of the request and determine a set of permissions associated with the requesting entity (e.g., via the request system 1177). In various implementations, the requesting entity may be referred to as a transactor and may be identified by a globally or locally unique transactor identifier (ID). Here, once the permissions system 1170 identifies the set of permissions or access controls associated with the requesting entity, the permissions system 1170 may communicate these permissions to the transaction system 1150 to enable the transaction system 1150 to render the appropriate wallet interface for the requesting user.

The permissions system 1170 may be configured to assign one or more permissions to a user of the EAL 1100 (e.g., via the credential system 1171). A permission generally refers to a rule that defines access to various portions (e.g., functions) of the EAL 1100. Permissions dictate access parameters in order to control who or what is authorized to access resources. Therefore, permissions are traditionally used to secure resources by permitting who, what, when, or how a resource can be utilized. In some examples, the permissions system 1170 uses access controls or access control lists (ACLs) to manage permissions that are associated with various users of the EAL 1100. These access controls may be discretionary access controls (e.g., managed by business stakeholders of the enterprise), mandatory access controls (e.g., access controls that are deployed to comply with required security protocols for a resource), or role-based access controls (e.g., access controls that correspond to a user's role in the enterprise).

In some examples, the permissions system 1170 is capable of managing (e.g., assigning, modifying, removing) permissions that are privacy-based rules (e.g., via the privacy enforcement system 1174). That is, an enterprise asset managed by the EAL 1100 may pose privacy concerns. For instance, the enterprise asset (e.g., a medical record) may include personal/protected health information (PHI) which dictates who and/or how a user of the EAL 1100 may interact with that asset. To illustrate, an enterprise entity submits an enterprise asset that includes PHI to the transaction system 1150. Here, the entity may include an indication that the asset includes private or sensitive information or the EAL 1100 (e.g., via the transaction system 1150) determines that one or more attributes for the asset indicate that the asset pertains to private or sensitive information. Based on this determination and/or the precise attribute identified, the permissions system 1170 applies one or more permissions that correspond to a privacy rule implicated by the determination or attribute.

In some implementations, a privacy rule may dictate not only what types of users should access an asset, but also if further processing by the EAL 1100 should occur prior to making the asset available for a market participant 910 (e.g., in a wallet of the transaction system 1150). For instance, certain assets that include sensitive information may trigger a permission that requires the asset or information included with an asset to be encrypted (e.g., prior to availability of that asset). In this instance, the permissions system 1170 determines that the implicated permission for the asset indicates that the asset (or a portion thereof) should be encrypted. In some configurations, the permissions system 1170 generates an encryption request for the data services system 1120 to enable the data services system 1120 to perform its encryption capabilities (such as by using the encryption system 1124 and/or the request system 1177).

The request may include the asset to be encrypted and the type of encryption being requested for the asset.

Besides implicating privacy rules, the permissions system 1170 can also determine that one or more attributes of the asset or characteristics associated with an entity providing the enterprise asset dictate a particular set of permissions (e.g., via the credential system 1171, the access negotiation system 1172, and/or the granularity system 1173). In some implementations, the characteristics or properties (e.g., entity identifiers) associated with an entity inform the permissions system 1170 which set of permissions should be associated with an asset for which the entity is/was responsible. For instance, when an enterprise entity responsible for an asset seeks to make that asset available via the transaction system 1150, the permissions system 1170 may generate a set of permissions for the asset that correspond to characteristics of the enterprise entity. To illustrate, an enterprise entity may have certain access controls with the enterprise (e.g., a particular level of clearance such as security clearance or confidentiality clearance). The permissions system 1170 may identify that the entity is associated with these access controls and generates permissions for the asset at the EAL 1100 that are similar to or match the access controls associated with the entity at the enterprise. For example, each employee of the enterprise may have an employee identifier. The permissions system 1170 may be configured with a reference table that includes the permissions associated with that employee identifier. Using the table, the permissions system 1170 generates a set of permissions for an asset based on the permissions associated with the employee identifier of an employee who submitted the asset to the EAL 1100 (or an entity identifier in the case of a different type of enterprise entity). In some configurations, there may be another portion of that table or another table that designates which EAL-based permissions correspond to which enterprise permissions such that the EAL-based permissions can mirror or function in a manner similar to the enterprise permissions. As noted above, permissions may be associated with a set of roles that are managed by an identity management system or platform, such that upon a change of role of an employee, the permissions change (such as removing permissions for a departing employee and applying the previous permissions of an employee to the new employee that is taking the same role).

In embodiments, the permissions system 1170 may further be configured to include an approval system (such as the approval system 1178) for an asset transaction; for instance, the permissions system 1170 may receive an asset transaction request (i.e., a request for a transaction involving the asset) and determine whether the requesting entity has the authorization or approval to proceed with and/or execute the transaction of the asset transaction request. To determine whether the requesting entity has the permission to perform the transaction, the permissions system 1170 may perform some level of diligence on the details of the transaction. For example, this due diligence may be performed by the intelligence system 1130 and may include input from one or more of the credential system 1171, the access negotiation system 1172, the granularity system 1173, the approval system 1178, and the scoring system 1134). This diligence may include: determining whether the requesting entity has permission to perform the transaction with the underlying asset(s), determining whether the underlying asset has any conflicts that would inhibit the performance of the transaction, determining whether the transaction is in compliance with one or more plans or policies, etc.

To determine whether the requesting entity has permission to perform the transaction, the permissions system 1170 may examine whether the requested transaction satisfies transactional terms for the asset. For instance, some assets or transactions may have transaction detail requirements, such as particular contract terms, minimum pricing, delivery conditions, or timing constraints. When an asset transaction request implicates an asset or transaction that has transaction detail requirements, the permissions system 1170 may identify these requirements and determine whether the requirements are satisfied (e.g., whether minimum thresholds are reached, whether limits are exceeded, etc.). In response to the permissions system 1170 determining that requirements are satisfied, the permissions system 1170 may communicate its approval of the transaction (e.g., to the transaction system 1150). On the other hand, in response to the permissions system 1170 determining that the requirements are not satisfied, the permissions system 1170 communicates that the EAL 1100 (e.g., the transaction system 1150) should decline the transaction or seek authorization from a designated employee (e.g., manager of the requesting entity, CFO, CEO, a division head, or the like). In embodiments, the permissions system 1170 may determine a modification of an otherwise non-compliant transaction that would render it compliant and may communicate the modification, such that the EAL 1100 may execute a modified transaction, such as by purchasing a reduced amount of an item or discovering an alternative source of an item that has a lower price to keep a transaction below a transaction amount threshold, modifying a time of execution to satisfy a waiting period, obtaining an additional approval to satisfy permissioning requirements, purchasing offsets or credits to allow a transaction to satisfy a sustainability objective, etc.

In embodiments, the permissions system 1170 may also be configured to determine whether the underlying asset has any conflicts that would inhibit the performance of the transaction. This may be important because a large enterprise may have a large portfolio of assets. With a large number of available assets, it is possible that one asset transaction request involves the same underlying asset as another transaction request; for example, both assets may be made subject to requests that they be used as collateral for two different loans, where each loan transaction requires a senior claim to the asset in the case of default. As another example, two transactions may require sale of the same asset to two different counterparties. Due to the possibility of such conflicts, the permissions system 1170, upon receiving the asset transaction request, can determine what transactions are pending or have been requested. From the set of transactions that are pending or have been requested, the permissions system 1170 determines whether any transactions of the set have been authorized for the asset specified by the asset transaction request (e.g., via the credential system 1171, the access negotiation system 1172, the granularity system 1173, and/or the approval system 1178). If a transaction of the set has been authorized for the asset specified by the asset transaction request, the permissions system 1170 may be configured to deny the asset transaction request (e.g., without disclosing the further details regarding the conflict). In some examples, when an asset transaction request is denied, the permissions system 1170 may recommend a similar alternative asset or set of assets as a substitution for the asset. Similarity may be determined by asset type, asset value, etc. Additionally or alternatively, the permissions system 1170 may recommend obtaining authorization to proceed with the transaction from one or more designated entities. In embodiments, the EAL 1100 may access capabilities of the transaction platform described elsewhere herein or in the documents incorporated herein by reference for automatically determining similarity of assets based on their attributes and for automatically determining an alternative or substitute asset set based on such similarity, such as to recommend or instruct a set of assets to be provided as substitute collateral for a lending transaction and/or as substitute items for a purchase or sale.

In another example, the permissions system 1170 may adjust the level of data accessible by an entity based on the role of the entity (e.g., via the granularity system 1173 and/or the need-to-know system 1179). When the entity is a human, the role may correspond to a job title. A job title with more authority may correspond to an increased level of access. For any entity, an increased level of access may correspond to obtaining more and more granular data—a lower level of access may only provide anonymized or deidentified data; in other embodiments, a lower level of access may only provide statistical or other group data, and not individual data. In other configurations, aggregated data may have strategic importance, while individualized data needs to be accessed by lower-level workers—in these configurations, accessing aggregated data may require a higher level of access. In various implementations, a higher level of access is required in order to access personally identifiable information (PII).

The granularity system 1173 may dynamically adjust the number of tiers of access in the permissions system 1170. For example, with respect to role-based permissions, the granularity system 1173 may dynamically increase the number of roles to accommodate the need for more granular permissions; similarly, the granularity system 1173 may dynamically collapse the number of roles when separate roles are no longer required. For example, the granularity system 1173 may periodically monitor the set of roles and their associated permissions to determine whether two roles have converged such that the two roles can be combined into one. When adjusting the number of roles, the granularity system 1173 redefines the criteria for each role such that each requestor can be assigned to one of the adjusted roles.

In embodiments, the “need-to-know” system 1179 continuously (or periodically, or repeatedly but not on a periodic basis) monitors permissions to ensure that a permission structure—for an entity, a role, etc. —does not offer access or approval thresholds that are more generous than necessary. The need-to-know system 1179 may include a machine learning model (for example, from the intelligence system 1130) that is trained on acceptable permissions of existing entities, roles, etc. For example, the intelligence system 1130 may create a feature vector for an entity/role/etc. that includes permissions (for example, transaction limits, number of systems accessible, amount of data accessible, number of transactions per hour, bandwidth allotment, allowed query size, number of queries per hour) and parameters of the entity/role/etc. (for example, the placement of the entity within an organizational hierarchy, the scope of the role, etc.). In various implementations, this feature vector can be input into the machine learning algorithm, which generates a likelihood of the permissions being consonant with the entity or role. When the likelihood is low (below a threshold), the permissions for that entity or role may be automatically adjusted—at least on a temporary basis—to be more strict and a workflow may be initiated in the workflow system 1140 to review whether the permissions can be relaxed again. As a simplistic example, a low-level employee whose permissions indicate that they can execute a transaction of up to 25 Bitcoin without external approval may, when vectorized and supplied to the machine learning model, be identified as a permissions discrepancy. In response to identification of the permissions discrepancy, the limit of 25 bitcoin may be temporarily reduced to a lower number, such as an average of the limits for other similarly-situated entities or a value recommended by the machine learning model. Then, a workflow in the workflow system 1140 can be initiated to determine whether the limit should be raised back to 25 bitcoin.

Vectorization may translate the permission into a normalized format, such as by mathematically converting an amount of cryptocurrency (such as bitcoin) into a common currency (such as US dollars). If the permissions have a set of N limits for various asset types (such as US dollars, cryptocurrency, securities, etc.), the vector may include an element calculated based on a mean of the N limits and an element that is based on a maximum of the N limits.

The network availability system 1175 assesses network connectivity and determines whether an issue with network connectivity is compromising, partially or wholly, an operation of the permissions system 1170. For example, if the approval system 1178 requires communication with an approving entity, a lack of network connectivity may prevent any approvals from proceeding. The network availability system 1175 may initiate a workflow from the workflow system 1140 to attempt to restore network connectivity. In various implementations, restoring network connectivity may include accessing an alternative network route that traverses different network nodes. In some situations, these alternative network nodes may not be under control of the EAL 1100 and therefore the network availability system 1175 may require additional protection for communications, such as minimum encryption standards or use of a virtual private network (VPN).

Some workflows, such as ones relying on digital wallet applications, can be dependent on network availability. However, in certain places and at certain times, there may be limits on network connectivity to assist in a transaction. For example, connectivity may be limited in certain geographical locations, such as by poor signal (in a tunnel, underground, remote from cell coverage, etc.), hardware or software failures, Denial of Service (DoS) attacks, lack of necessary plan (such as when roaming in a foreign country), network limitations imposed by a jurisdiction (such as a deep packet inspection firewall). A workflow can be configured that includes a set of rules that determine what type of transactions can be done and how they can be accomplished in the absence of network connectivity. As an example, when a device is determined to be getting within a pre-determined distance of a network deficient area (e.g., a tunnel), the EAL system may be triggered to fetch and cache certain data for specific transactional workflow(s).

The network availability system can be configured to enable a series of transactions during a network deficiency using the EAL system. The workflow for the enabled transaction may be configured to allow skipping a step(s) before sharing information with other trusted systems. For example, the workflow can allow a transaction to be completed below a predetermined threshold without preauthorization from a banking institution associated with a credit card. Logic can be used to select which enterprise digital wallet of an enterprise's collection of enterprise wallets to use for which transactions, with each enterprise digital wallet controlling a respective set of one or more enterprise accounts and requiring respective permissions and reporting requirements.

As another example, the network availability system may learn that a user trusts a company based on a threshold number of transactions (e.g., purchases from Amazon) with that company in a period of time. The network availability system may therefore allow certain transaction workflow steps to be bypassed when network is unavailable in order for the user to complete transactions within monetary thresholds. Further, the network availability system may cache messages and log entries until the network connectivity is regained (or may instruct another EAL system to do so). Further, the network availability system may be configured to track cumulative authorizations while the network connectivity is compromised and cap the authorizations at a limit. This can prevent a bad-faith actor from compromising network connectivity and executing a series of transactions that add to a substantial amount but each fall below the transaction threshold.

In embodiments, the network availability system 1175 may also initiate a workflow from the workflow system 1140 to allow offline performance of a function of the permissions system 1170. For example, a workflow may handle offline approval of a transaction request. The workflow may rely on a set of rules in the workflow library system 1144 to determine whether the transaction request is approved. The criteria for an offline approval may be more stringent than for a standard approval—for example, the allowed transaction threshold for a particular transaction by a particular entity may be reduced when compared to a normally-approved transaction.

The permissions system 1170 described above is an example permission system that may be used to assign, manage, and/or facilitate access controls and permissions for various enterprise resources. It is appreciated that in some embodiments, one or more subsystems of the permissions system 1170 and/or some of the functionality thereof may be implemented in other EAL systems. Furthermore, a permissions system may be implemented in other enterprise platforms, such as ERPs, CRMs, and/or the like.

### Reporting System

The reporting system 1180 functions to provide reporting to or from the EAL 1000, other EAL systems, non-EAL systems, and/or specified entities of an enterprise. For instance, the reporting system 1180 may include a compliance system 1182 that is configured to generate compliance reports for one or more assets of the EAL 1000. The compliance system 1182 may generate compliance reports on a periodic basis (such as nightly, quarterly, annually, etc.), which can then be provided upon demand to an authorized requestor (such as a government agency). In other implementations, the compliance system 1182 may generate a compliance report in response to a demand from an authorized requestor. Here, the type of compliance report that the compliance system 1182 generates may depend on the type of asset to be reported. For instance, a financial asset and a transaction regarding a financial asset may have compliance reporting requirements for accounting or tax purposes. In that regard, the compliance system 1182 generates a compliance report that fulfills the accounting/tax requirements.

The reporting system 1180 may include a fraud reporting system 1183 that is configured to generate a fraud report identifying transactions that were not authorized or that triggered a fraud alert. Here, a fraud alert may come from a third party (such as a PSP) or from another EAL system (such as the permissions system 1170). The fraud reporting system 1183 may also analyze and report data that is used to detect fraud and, in fact, may itself detect fraud. For example, the fraud reporting system 1183 may generate a report of activity that might be consistent with malicious behavior, such as multiple accounts being emptied into another account that is under independent control. This report may be ingested by the intelligence system 1130 to determine whether some remediation measure is warranted, such as pausing further transfers into the independent account and/or, if technologically possible, preventing outbound transfers from the independent account.

A financial reporting system 1184 may be configured to generate financial reports for financial activity at the EAL 1000. The financial reporting system 1184 may compile financial information regarding transactions that have been executed over some designated or customizable period of time. The financial reporting system 1184 may be used in the production of financial reports and balance statements.

In some implementations, transactions at the EAL 1000 may have legal implications, such as legal or regulatory reporting obligations. In these implementations, a legal reporting system 1185 may be configured to generate a legal or regulatory report that is set up to identify transactions that implicate a legal condition and to include these identified transactions in the legal report that the legal reporting system 1185 generates.

The reporting system 1180 may also include a statistics system 1186 configured to generate statistical reports that include statistics or metrics regarding the assets managed by the EAL 1000 and/or activity (e.g., transaction activity) of the EAL 1000. Statistical reports may be their own standalone reports or may be integrated into other types of reports generated by the reporting system 1180 (e.g., part of a financial report). Similarly, the statistics system 1186 may generate EAL activity reports that set forth instances of a particular activity or set of activities that are performed at the EAL 1000. For instance, among many other statistics and metrics, an EAL report may include how many times a particular asset or type of asset is queried, how many times an asset or type is included in a transaction request, what assets or types are available in which wallets of the transaction system 1150, volumes of asset transactions (purchases, sales, exchanges, loans), prices of asset transactions, characteristics of parties involved, and many others.

A query system 1187 allows the reporting system 1180 to generate arbitrary reports based on a query provided by a requestor. The query system 1187 may consult with the permissions system 1170 to determine what data can be used in a query for the requestor. The query system 1187 may rely on the workflow system 1140 if the provided query requires data not immediately accessible to the reporting system 1180. The query system 1187 may translate the provided query into a set of multiple queries, which may include multiple SQL queries to the same or different SQL databases (which may be maintained by the data services system 1120).

### Digital Twin System

The digital twin system 1190 can be used to create, maintain, and interrogate digital twins of entities within the enterprise 900 as well as the EAL 1000. The digital twin system 1190 includes a data visualization system 1192 that allows a user of the EAL 1000 to view data from the digital twin system 1190, which may also incorporate data from the real-world entities in the enterprise 900 that are twinned in the digital twin system 1190. The digital twin system 1190 includes a decision support system 1193 that can run comparative analyses by performing simulations on digital twins using different parameters. Outcomes of the simulations can be compared and optimized parameters can be chosen. The simulations can be run a single time or may be run iteratively in order to converge on a global or local minimum or maximum. Simulations of digital twins may be performed by a planning and simulation system 1194.

An access support system 1195 works with the permissions system 1170 to determine what data can be reported by the digital twin system 1190 and to which entities. The access support system 1195 also determines what data can be used by the digital twin system 1190—for example, there may be restrictions on systems that are able to provide data to the digital twin system 1190. In addition, there may be restrictions on types of data ingested by the digital twin system 1190. For example, the access support system 1195 may transform data that is being ingested by the digital twin system 1190, such as by stripping out certain types of data, such as personally identifiable information (PII).

A workflow support module 1196 interacts with the workflow system 1140 to allow the digital twin system 1190 to be used to execute one or more workflows from the workflow system 1140. In addition, the workflow support module 1196 allows the digital twin system 1190 to rely on the workflow system 1140 to execute one or more workflows on behalf of the digital twin system 1190.

In various implementations, the digital twin system 1190 incorporates features and characteristics of the digital twin module 320 above.

### Multiple EALs

In embodiments, each business unit in an enterprise may configure a respective EAL according to the unit's needs. For example, the ERP systems 1052, the CRM systems 1053, the healthcare systems 1054, the SCM systems 1055, the PLM systems 1056, the HR systems 1057, accounting systems (not shown), and research and development (R&D) systems (not shown) may each incorporate an EAL configured by their corresponding business units. The EAL of each unit interacts with EALs of the other units based on a set of workflows and rules. The individual EALs are configured to be a part of a hierarchical network of EALs for the enterprise 900, with the enterprise level EAL 1000 being at the highest level. The enterprise level EAL 1000 may promulgate a common set of rules that all EALs at the lower hierarchical level (i.e., unit-level EALs) must follow. The unit-level EALs are nodes in the network, with each node having one or more libraries that may be made available to the other nodes based on the set of rules (e.g., what type of data is in the pool, use case, access requirement, etc.) as configured by the business unit for its EAL. Each unit-level EAL may include libraries that can store different types of data files or data pool structures that are fully or partially available for access by other EALs. In some examples, the libraries can be prepackaged for a particular type of domain (e.g., medical, loan, transactional, etc.), and can be used to respond to different types of requests. For example, data files in a library including medical data can be configured to be a certain file type, and include protections, qualifications, security features, etc. to provide access to any given field of this data based on regulations (e.g., HIPAA, GDPR, etc.) and compliance policies. The libraries can also include references from other places, files, databases (including a relational database), etc.

A unit-level EAL may be configured to allow access to a library to multiple other EALs for different purposes, with access to each EAL defined by different set of rules based on the corresponding purpose for the access. Each unit-level EAL of the enterprise may be configured using its own requirements and workflows. The unit-level EALs from all units can be assembled and nested into complex systems to execute requests by communicating between the unit-level EALs and across different enterprise EALs (e.g., EAL 1000 and third-party EALs). Each unit-level EAL may be configured based on the requirements of that unit, services provided by the unit, the libraries of that unit, access requirements for those libraries, machine learning modes used by that unit, the unit's contribution to execution of various requests, wallets and budgets that the unit has access to, etc. Each nested/unit-level EAL inherits some functionalities and properties of the EAL 1000 when communicating with external entities. The EAL 1000 can be configured to respond to external requests and, based on the internal EAL configurations/hierarchies, communicate the request to internal/unit-level EALs to gather required data to respond to the original external request. This configured system of EALs creates a common layer allowing large enterprises to communicate and transact between internal units in a structured manner.

In an example implementation, an employee of an enterprise unit may have access to a unit-level EAL implementation instance when logged into the enterprise network. This may give the employee access to certain workflows to do specific transactions allowed under that unit-level EAL. However, the employee may not have access to the enterprise-level EAL 1000. In order to access data in a library belonging to a second unit-level EAL, the first unit-level EAL may communicate with the second unit-level EAL and the second unit-level EAL may determine if the employee requesting data from the first unit-level EAL meets the requirements of the second unit-level EAL for accessing the requested data. As an example, an engineering department employee looking for marketing survey information to help drive industrial design for a new product can submit a request to the engineering unit-level EAL implementation instance. The engineering request is vetted by the engineering unit-level EAL to determine whether this employee has requisite permissions based on the employee credentials, location, IP address, etc. and rules of the engineering unit-level EAL. This can be done using a scoring system or permission system of the engineering unit-level EAL. The marketing unit-level EAL can then determine whether to accept the request based on its own configuration, requirements, policies, etc.

In another example implementation, an enterprise searching for a location to build a battery recycling plant may make its decision based on a variety of data including its own business analytics data, marketing and sales data for products using lithium ion batteries (e.g., electric vehicles, etc.), existing battery recycling plants in high-volume areas, potential locations (that is, commercial real estate) for a battery recycling plant, etc. The enterprise may use the EAL 1000 to configure a workflow for a query for a battery recycling plant with inputs and outputs to aid in the decision-making. For example, an input can include an aggregated data pool including data instances such as localized marketing data (e.g., X million people bought Tesla in the greater New York area in a 1-year window 6 years ago), median battery life (e.g., 7 years), closest recycling plant statistics (e.g., one existing plant in New Jersey area that has recycling capability of Y thousand batteries a year), construction and set up costs for a recycling plant, existing factors used by other domain-specific enterprises (e.g., other battery recycling enterprises), etc. The data pool can be generated using data from internal and external sources. The workflow can be developed based on the data pool as input configured using required compliance requirements (e.g., EPA regulations, enterprise internal compliance policies, etc.) and tested for accuracy. In some examples, the workflow can be iteratively trained using artificial intelligence to improve its accuracy. The output of the tests can be compared to the compliance requirements to determine and document compliance. The EAL 1000 can also be configured to develop a digital footprint of compliance of the workflow with the requirements, and can be used to evaluate how the inputs are gathered and how the outputs are generated as a function. Similar processes can be used to develop and train workflow models for other repeatable queries/requests, such as placement of electric charging stations.

In various implementations, an EAL may be configured as a personal EAL to allow a human user to monetize and/or opt into sharing their data. In embodiments, the personal EAL may be associated with, and at least partially instantiated on, a user device, such as a smartphone or tablet. The personal EAL may store and manage data on the user device and/or data stored in a server architecture, such as a cloud-based storage system. Examples of the data include: cookies, browsing history, purchases, interests, financial information, demographic information, survey results, reviews/ratings. In various implementations, unique types of data may be enabled, which may be referred to as reverse solicitation data. As an example of reverse solicitation data, a user might designate items that they are looking to acquire, such as goods or services. The data may include timing, budget, etc. The personal EAL could interact with third-party systems or services to offer this data in return for compensation, such as a microtransaction or a discount coupon.

In embodiments, the personal EAL constructs and manages a personal data pool of the user and allows the user to decide when and how the personal EAL may share their data. As part of the personal EAL onboarding, the user may establish their identity—and perhaps receive some sort of token of that identity, such as from a certificate authority—so that the personal EAL can establish the user's authenticity to third-party systems and services.

FIG. 11 and FIG. 12 depict different examples of how an EAL 1000 may be implemented. For example, as shown in FIG. 11, instead of being integrated with the enterprise side 902, the EAL 1000 may be integrated with different systems on the market-participant side 904 of the enterprise ecosystem. To illustrate, FIG. 11 shows a set of EALs 1000a-n that are integrated with a set of marketplaces 922a-n. When integrated with a particular marketplace 922, some or all computing resources relied upon for the EAL 1000 may be hosted on the computing resources associated with the marketplace 922 (e.g., marketplace servers). Alternatively, when an EAL 1000 is integrated into a particular marketplace 922 there may be portions of the EAL 1000 that remain hosted by enterprise resources to ensure aspects of security and/or privacy for enterprise assets. Referring specifically to FIG. 11, a first EAL 1000a is associated with or integrated with an orchestrated finance marketplace 922a. A second EAL 1000b is integrated with an orchestrated insurance marketplace 922b. A third EAL 1000c is integrated with an orchestrated lending marketplace 922c. A fourth EAL 1000d is integrated with the third-party systems 924. An nth EAL 1000n is integrated with an nth orchestrated marketplace 922 since other types of marketplaces (not shown) can similarly integrate the functionality of the EAL 1000.

In some implementations, the functionality of the EAL 1000 is distributed across market-side systems such that portions of the EAL 1000 that interface with a particular marketplace 922 are integrated with that marketplace 922 while other portions of the EAL 1000 that interface with another marketplace 922 are integrated with the other marketplace 922. An example of this would be that the financial offerings of the EAL 1000 are integrated with the finance marketplace 922a as the first EAL 1000a while insurance offerings of the EAL 1000 are integrated with the insurance marketplace 922b as the second EAL 1000b. In some configurations, the distribution of the EAL 1000 may be such that wallets of the transaction system 1150 are integrated amongst the marketplaces to which they relate. For instance, a wallet that includes financial enterprise assets is integrated with the finance marketplace 922a and is represented by the first EAL 1000a. On the other hand, a wallet that includes insurance-related enterprise assets (e.g., data sets that may be integrated with insurance policies or contracts) is integrated with the insurance marketplace 922b and is represented by the second EAL 1000b.

FIG. 11 also illustrates another scenario on the right side of the figure where an EAL 1000n+1 can be a stand-alone system (e.g., a microservice that enterprises leverage). In other words, the stand-alone system is capable of communicating with both the enterprise 900 and the market-side systems such as the storage system 926, third-party systems 924b, and the orchestrated marketplace 922n+1. As a stand-alone system, the EAL 1000n+1 may be configured such that the resources (e.g., computing resources) that the EAL 1000n+1 relies upon for operation are not hosted by, for example, the enterprise 900 or the orchestrated marketplace 922n+1. This may ensure that computing resources that the EAL 1000 may require are not occupied or being consumed by other resources at its host to compromise or somehow hinder the performance of the EAL 1000. That is, if the EAL 1000 shares resources with a system, that sharing may require priority procedures when resources are occupied or time in queue to wait for a particular resource to be available for utilization.

FIG. 12 is an example of the EAL 1000 integrated with the configured market orchestration system EAL 1100 (e.g., similar to a portion of FIG. 11). The configured market orchestration system EAL 1100 may refer to a system that can control and/or manage a market ecosystem. In some respects, the configured market orchestration system EAL 1100 may be considered a “system of systems” because it is a structure that provides cooperative coordination among a set of market-related systems that are configurable for the execution of various market services/tasks. In some examples, the configured market orchestration system EAL 1100 is a system that can function as a liaison for a set of systems or services. For instance, as shown by FIG. 10, the configured market orchestration system EAL 1100 generally includes a configured intelligence service or intelligence system 1130 and configured system services.

The configured market orchestration system EAL 1100 may also manage a set of transactional systems 1230.

Some examples of the set of transactional systems 1230 include an asset valuation system 1232, a collateralization system 1233, a tokenization market system 1234, a market orchestration system 1235, a market making system 1236, and a market governance and trust system 1237. Some of these systems may be variations of the EAL system described previously. For instance, the market governance and trust system may be functionally similar to a combination of the governance system 1160 and the permissions system 1170 of an example EAL 1000. In embodiments, the set of transactional systems 1230 may be configured for the purpose of generating and/or controlling particular aspects of a market (i.e., transactional execution) while EAL systems may be configured for accessing markets and performing transactions on behalf of an enterprise.

In order to manage the set of transactional systems 1230, the configured market orchestration system EAL 1100 leverages the functionality of the configured intelligence service system 300 and the configured system services. The configured intelligence service system 300 is a framework for providing intelligence services to one or more services, such as the configured system services. In some implementations, the configured intelligence service system 300 receives an intelligence request to perform a specific intelligence task (e.g., a decision, a recommendation, a report, an instruction, a classification, a pattern or object recognition, a prediction, an optimization, a training action, a natural language processing request, etc.). In response, the configured intelligence service system 300 executes the requested intelligence task and returns a response to the intelligence service requestor (e.g., the configured system services).

The configured intelligence service system 300 may include an intelligence service controller 1331 and a set of artificial intelligence (AI) modules 1332. When the configured intelligence service system 300 receives an intelligence request (e.g., from one of the set of transactional systems 1230 or from the configured system services), the request may include any specific/required data to process the request. In response to the request and the specific data, one or more implicated AI modules 1332 perform the intelligence task and output an “intelligence response.” Examples of responses from AI modules 1332 may include a decision (e.g., a control instruction, a proposed action, machine-generated text, etc.), a prediction (e.g., a predicted meaning of a text snippet, a predicted outcome associated with a proposed action, a predicted fault condition, an anticipated state of an entity or workflow relevant to a transaction (such as a future price, interest rate, conversion rate, etc.), etc.), a classification (e.g., a classification of an object in an image, a classification of a spoken utterance, a classified fault condition based on sensor data, etc.), a recommendation (e.g., a recommendation for an action to optimize a transaction parameter), and/or other suitable outputs of an artificial intelligence system.

There may be a variety of AI modules 1332 associated with the configured intelligence service system 300 to have the broad capability to output the many types of intelligence responses that may be requested of the configured intelligence service system 300. Some examples of these AI modules 1332 include ML modules, rules-based modules, expert system modules, analytics modules (e.g., econometric models, behavioral analytics, collaborative filtering, entity similarity and clustering, and others), automation modules, control system modules, robotic process automation (RPA) modules, digital twin modules, machine vision modules, NLP modules, text-to-speech modules, and neural network modules, as well as any other types of artificial intelligence systems described herein or in the documents incorporated herein by reference and encompassing hybrids or combinations thereof (e.g., where an AI modules uses more than one type of neural network). It is appreciated that the foregoing are non-limiting examples of AI modules 1332, and that some of the modules may be included or leveraged by other AI modules.

As shown in FIG. 13, the AI modules 1332 interface with the intelligence service controller 1331, which is configured to determine a type of request issued to the configured intelligence service system 300 (e.g., from an intelligence requestor such as the configured system services or one of the set of transactional systems 1230) and, in response, may determine a set of governance standards and/or analyses that are to be applied by or to the AI modules 1332 when responding to the request. In some examples, the intelligence service controller 1331 may include an analysis management module, a set of analysis modules (e.g., shown as a fraud detection module, a risk analysis module, and a forecasting module), and a governance library.

In some implementations, the analysis management module receives a request from the AI modules 1332 and determines the governance standards and/or analyses implicated by the request. In some examples, the analysis management module may determine the governance standards that apply to the request based on the type of decision that was requested and/or whether certain analyses are to be performed with respect to the requested decision. For example, a request for a control decision that results in the configured system services configuring an action for the set of transactional systems 1230 may implicate a certain set of governance standards that apply, such as safety standards, legal or regulatory standards (e.g., privacy standards, “know your customer” standards, reporting standards, export control standards and many others), financial accounting regulatory standards, legal standards, quality standards, etc., and/or may implicate one or more analyses regarding the control decision, such as a risk analysis, a safety analysis, an engineering analysis, etc. In embodiments, the governance standards may apply to the AI modules; for example, a training data set used for an AI module may be required to be satisfy governance standards, such as representativeness of data, absence of bias, adequacy of statistical significance, absence of inequity in resulting outcomes, etc. As one such example, a training data set of historical transactions used to train an AI module to identify a favorable counterparty may be governed by policy that requires that the training data set include historical transactions that are free of racial, ethnic, or socioeconomic imbalances, compliance analysis, an engineering analysis, etc.

In some instances, the analysis management module may determine the governance standards that apply to a decision request based on one or more conditions. Non-limiting examples of such conditions may include the type of decision that is requested, a location (e.g., geolocation, jurisdiction, data processing location, network location, etc.) in which a decision is being made, a location in which an activity governed by the decision will be executed (e.g., where an asset or resource will be purchased, stored, sold, etc.), an environment or system that the decision will affect, current or predicted conditions of the environment or system, a set of parties to a transaction affected by the decision, etc. The governance standards may be defined as a set of standards, policies, rules, etc. in a governance library, which may include a set of standards libraries. The foregoing may define conditions, thresholds, rules, recommendations, or other suitable parameters by which a decision may be analyzed. Examples of may include, legal standards library, a regulatory standards library, a quality standards library, a financial standards library, a risk management standards library, an environmental standards library, a sustainability standards library, an ethical standards library, a social standards library, and/or other suitable types of standards libraries. In some configurations, the governance library includes an index that indexes certain standards defined in the respective standards library based on different conditions or context. Examples of conditions may be a jurisdiction or geographic area to which certain standards apply, environmental conditions to which certain standards apply, device types to which certain standards apply, materials or products to which certain standards apply, etc.

In some implementations, the analysis management module may determine the appropriate set of standards that must be applied with respect to a particular decision and may provide the appropriate set of standards to the AI modules 1332, such that the AI modules 1332 leverage the implicated governance standards when determining a decision. In these embodiments, the AI modules 1332 may be configured to apply the standards in the decision-making process, such that a decision output by the AI modules 1332 is consistent with the implicated governance standards. It is appreciated that the standards libraries in the governance library may be defined by the platform provider, customers, and/or third parties. The standards may be created, managed, promulgated and/or overseen by various sources, such as government standards, industry standards, customer standards, enterprise standards, non-governmental entity standards (e.g., international agencies), or standards from other suitable sources. Each set of standards may include a set of conditions that implicate the respective set of standards, such that the conditions may be used to determine which standards to apply given a situation. In embodiments, the standards may be embodied in executable logic, such that elements of standards are automatically applied, optionally at the level of an individual workload or service within a workflow or system, such as by prompting workload developers to embed standards compliance (and any other policies) into the workload development and deployment process.

In some embodiments, the analysis management module may determine one or more analyses that are to be performed with respect to a particular decision and may provide corresponding analysis modules that perform those analyses to the AI modules 1332, such that the AI modules 1332 leverage the corresponding analysis modules to analyze a decision before outputting the decision to the requestor. In some examples, the analysis modules may include modules that are configured to perform specific analyses with respect to certain types of decisions, whereby the respective modules are executed by a processing system that hosts the instance of the configured intelligence service system 300. Non-limiting examples of analysis modules may include one or more risk analysis modules, econometric analysis modules, financial analysis modules, behavioral analysis modules (e.g., of user behavior, system behavior, etc.), security analysis modules, decision tree analysis modules, ethics analysis modules, forecasting analysis modules, quality analysis modules, safety analysis modules, regulatory analysis modules, legal analysis modules, and/or other suitable analysis modules, including any of the analysis types described herein or in the documents incorporated herein by reference.

In some configurations, the analysis management module is configured to determine which types of analyses to perform based on the type of decision that was requested to be performed by the configured intelligence service system 300. In some of these configurations, the analysis management module may include an index or other suitable mechanism that identifies a set of analysis modules based on a requested decision type. Here, the analysis management module may receive the decision type and may determine a set of analysis modules that are to be executed based on the decision type. Additionally, or alternatively, one or more governance standards may define when a particular analysis is to be performed. For example, the regulatory standards may define what scenarios necessitate a risk analysis. In this example, the regulatory standards may have been implicated by a request for a particular type of decision and the regulatory standards may define scenarios when a risk analysis is to be performed. In this example, AI modules 1332 may execute a risk analysis module and may determine an alternative decision if the action would violate a respective legal standard. In response to analyzing a proposed decision, AI modules 1332 may selectively output the proposed condition based on the results of the executed analyses. If a decision is allowed, AI modules 1332 may output the decision to the requestor. If the proposed configuration is flagged by one or more of the analyses, AI modules 1332 may determine an alternative decision and execute the analyses with respect to the alternate proposed decision until a conforming decision is obtained.

In embodiments, the configured system services function to configure a set of systems (e.g., the set of transactional systems 1230) corresponding to the configured market orchestration system EAL 1100 to perform a set of services based on intelligence determined for the configured system services. Similar to configured intelligence services system 300, configured system services provide data storage, library management, data handling, and/or data processing services that are tailored to requirements associated with a particular market orchestration system EAL 1100 (e.g., in response to data requests and/or directed market transactions by the EAL 1000). In some examples, the configured system services uses the configured intelligence service system 300 to generate decisions relating to configurations of the set of transactional systems 1230. For instance, if the configured system service is to configure a smart contract as the configured transactional system, the configured system services leverages the intelligence of the configured intelligence service system 300 to formulate an intelligence request that will configure some portion of a smart contract (e.g., determine one or more parameter values corresponding to conditions defined in the smart contract).

In some implementations, the systems services that are configured to become the configured system services are the EAL systems of the EAL 1000. In other words, the configured system services uses intelligence generated by the configured intelligence services to configure aspects of the EAL 1000, such as the transaction system 1150 or the permissions system 1170. In some implementations, the configured system services not only configure input or control parameters of EAL systems that perform (e.g., the transaction system 1150) or evaluate transactions (e.g., the permissions system 1170), but also configure input or control parameters that impact the user experience or user interface of the EAL 1000 (e.g., configuration parameters associated with the interface system 1110). Here, since EAL systems may be associated with the configured system services, an EAL system may function via the configured system services as a requestor for a particular intelligence response.

In some configurations, such as FIG. 12, the configured system services is capable of performing general system services. These general system services may include operations such as data storage, data processing, networking, etc. that are configured for a particular function or set of functions. As shown in FIG. 12, these general system services may be integrated or controlled by the configured system services. However, in some configurations, it may be more advantageous for the general system services to be more widely available to aspects of the configured market orchestration system EAL 1100. Therefore, the general system services may be its own entity that is accessible to both the configured intelligence service system 300 and the configured system services, but not tethered specifically to the functionality or computing resources of either service.

In some configurations, a configured market orchestration system EAL 1100 is configured for a particular marketplace 922. As an example, the configured market orchestration system EAL 1100 is configured for a lending marketplace. For instance, the integrated EAL 1000c of the orchestrated lending marketplace 922c is a part of a configured market orchestration system EAL 1100 for the orchestrated lending marketplace 922c. In this example, the configured market orchestration system EAL 1100 via the set of transactional systems 1230 may perform tasks that may require external information (e.g., current market data) for functions, such as asset valuations, inventory access, business profile management, market analysis, etc. Depending on the task, subsequent tasks or analyses may be handled (e.g., directly handled) by the configured market orchestration system EAL 1100, by the EAL 1000, or some combination of both.

In some implementations for a configured market orchestration system EAL 1100, the workflow system 1140 of the EAL 1000 can manage or assist in managing one or more of the task-based information exchanges, analyses, and/or transactions by assembling workflow components, identifying pre-existing workflows, or developing workflows based on ML and AI methods. Examples of workflow components include: lookup of an asset serial number to determine a date of manufacture, existing service information, verification of ownership, etc. for the task of asset valuation and collateralization; reviewing business credit rating, claims, customer history, collateral to lending ratio, asset liquidity, etc. for the task of risk evaluation; determining minimum requirements for collateral, min/max allowable insurance for certain asset types, specific asset validation/verification requirements, etc. for the task of regulatory compliance; obtaining bid requests and analyses for the task of evaluation of insurance options and recommendations; and determining transaction type based on customer, client, regulation, etc. for the task of negotiation and completion of transactions.

To illustrate by an example, the workflow system 1140 may generate a set of workflow steps that define a task of a business loan request that proposes the use of machine tools as collateral for a loan to expand business. In this example, a first workflow step may be for the configured market orchestration system EAL 1100 to parse loan application information to identify equipment (collateral) types and characteristics. Here, a second workflow step may be that the configured market orchestration system EAL 1100 submits a preconfigured market-specific request to provide information associated with collateral resale value, liquidity, and market depth, including searches of relevant private or public marketplaces. Here, the EAL 1000 may provide a value range to the configured market orchestration system EAL 1100. A third workflow step may be that the configured market orchestration system EAL 1100 submits a preconfigured market-specific require for the EAL 1000 to obtain information associated with the business requesting the loan. In this workflow step, the EAL 1000 may return, for example, credit ratings, outstanding loans, and/or transactions histories. A fourth workflow step may be that the configured market orchestration system EAL 1100 submits a preconfigured market-specific risk analysis request to the EAL 1000 based on government and lender requirements. In some embodiments, this suggested EAL analysis could be automatically selected from a library developed for a type of loan or industry. As an alternative, this fourth workflow step may be completed by the configured market orchestration system EAL 1100 and then verified by the EAL 1000. A fifth workflow step may be based on the internal analyses and/or information provided by the EAL 1000. For instance, in this fifth workflow step, the configured market orchestration system EAL 1100 develops or selects an insurance bid package for submission to market participants. Here, as an example, the configured market orchestration system EAL 1100 may select the best option from among bidders. A sixth workflow step may be that the configured market orchestration system EAL 1100 engages the EAL 1000 to complete the transaction and submit the required documentation. This step may include a series of preconfigured functions selected for bid payment terms and methods, reporting requirements, etc.

With an EAL configuration, assets of an enterprise 900 can be natively integrated into marketplaces 922 without the enterprise 900 having to necessarily conduct advertising or marketing campaigns. That is, the transaction system 1150 in combination with the interface system 1110 can enable enterprise assets associated with wallet(s) to be readily available to marketplaces 922. This allows assets of the enterprise 900 to be market-facing without having to orchestrate product/service offering campaigns. In this respect, the assets can be offered natively on various platforms. Additionally, since the interface system 1110 and/or transaction system 1150 has access to multiple marketplaces, the EAL 1000 can offer assets in marketplaces that are not necessarily the same type of goods/services as the assets, but rather complimentary marketplaces or even marketplaces that are not traditionally offering assets with attributes similar to the available enterprise assets. For instance, an enterprise asset may be a financial asset and yet be offered or integrated into non-financial contexts. To facilitate the market for an asset, in embodiments, a reserve price may be associated with the asset, at which an enterprise is willing to part with the asset if and when it is sought by a market participant in one of the markets in which it can be viewed, such as by the aforementioned via wallet integration.

In some examples, the EAL 1000 allows the securitization and/or tokenization of future revenue streams for the enterprise 900. Here, an enterprise 900 can offer assets such as financial history, futures contracts, or other valuable enterprise insights (e.g., as asset-backed tokens) to secure capital or credit in various lending marketplaces. For instance, the enterprise 900 may request an instant cash advance against the full annual value of the enterprise's subscriptions or source of recurring revenue. This means that the enterprise 900 can leverage its various assets in traditional or non-traditional lending marketplaces that the EAL 1000 has the capability with which to interface. To illustrate, the EAL 1000 may be configured to translate subscription or recurring payment revenue (e.g., future revenue streams) into instant capital (i.e., cash). For example, the EAL may seek to mitigate risk of a substantive portion of expiring revenue streams and engage the available marketplaces 922 via the EAL 1000 to access a lender for these future enterprise assets.

In some configurations, to induce or to support lender transactions against future enterprise assets, the lender is able to request other enterprise assets (e.g., proprietary data sets) to form a basis, collateral, escrow, representation, or warranty against the transaction. As one example, the lender may offer a cash advance for future subscription revenue streams of the enterprise 900 with terms that a new product will launch according to some parameters indicated by enterprise data sets made available to the lender. In situations where the lender executes a transaction based on supporting enterprise data sets, the lender may also receive those enterprise data sets in the transaction, allowing the lender to engage with marketplaces 922 to sell the enterprise data sets if it so chooses. In this respect, lenders and market participants 910 transacting with an enterprise can leverage cross market transactions (e.g., as secondary revenue streams to support primary transactions).

In some implementations, when the enterprise 900 offers its revenue stream as an enterprise asset to secure lending (e.g., an instant cash advance), the result of the lending can be represented digitally by tokenization. In other words, even though the enterprise 900 has received non-digital currency (e.g., cash), the transaction system 1150 may represent that cash in digital form by a token such that the cash can operate as a digital enterprise asset that can participate in digital transactions using the EAL's capabilities. Additionally or alternatively, a smart contract corresponding to the loan/revenue stream may interface with an oracle that receives proof of payment from legacy off-chain systems and that reports verification of the received payment to the smart contract.

By being able to operate in a digital space, the EAL 1000 is able to employ different digital advantages to transactions. For instance, the assets such as operational assets, financial assets, or other assets can utilize tokenization to permit only a particular set of actions by selected stakeholders. The actions permitted by a token can be agreed upon according to consensus mechanisms by a set of stakeholders, or they can be dictated by a governing entity, such as an enterprise manager or executive. In some implementations, because these tokens are functioning to verify agreed upon actions, these tokens may be referred to as “verifiable action tokens.”

In some configurations, the tokenization can occur for any enterprise asset. For instance, certain enterprise assets (e.g., enterprise data sets) may include confidential or private information for (i) individuals associated with the enterprise 900, (ii) clients of the enterprise 900, or (iii) confidential information or actions of the enterprise 900, among others. Enterprise assets that include confidential or private information may be encoded or tokenized (e.g., by the data services system 1120) at the EAL 1000. By encoding the asset or some determined portion thereof, the enterprise 900 can offer assets relating to or including this information without compromising security, confidentiality, or privacy. In some examples, when tokenizing or encoding some or all of an enterprise asset, the reporting system 1180 generates a report or stores a ledger of these encoded events. By generating such as record, the EAL 1000 can allow the enterprise 900 to prove compliance or back trace its operations in case of an audit or other request of concern.

In some configurations, the EAL 1000 is able to facilitate transactions for market enterprise resources that may not be traditionally considered as exchangeable assets to the enterprise 900. It is becoming more common in the age of big data that data sets by themselves can be a valuable asset. For instance, with aspects of artificial intelligence becoming more prevalent, its intelligent capabilities often demand data sets that are used for training, such as to allow the AI to learn to perform some type of task or function. As a large organizational structure, the enterprise 900 can generate vast amount of data sets regarding its workings (e.g., operations, strategy, planning, sales, marketing, finances, human resource management, etc.) that can be valuable in the training of particular types of AI. For instance, an insurance company may be interested in the occupational conditions of workers that it insures, but finding a large, meaningful data set that characterizes occupational conditions may be rather difficult to find, at least publicly. Yet many enterprises 900 track or have data regarding their own occupational conditions. In this example, the insurance company would find it valuable to have access to data sets characterizing the occupational conditions of at least the enterprise 900. The EAL may provide access to such data sets, such as by representing them in a wallet or other system that can be accessed by market participants. Use of the data may be governed by governance and permissions systems as noted herein; for example, the data may be permitted to be accessed only in a machine-readable form that is accessible to a neural network or other AI system being trained. In embodiments, portions of the data, such as representing private information, may be anonymized, obfuscated, deleted, redacted, etc. to allow data to be used for training AI while not being used for other purposes. In embodiments, a set of governance policies for the data set may be configured such that the policies are automatically applied to any AI system that is trained using the data; for example, in order to access the training data set, the AI system may be required to demonstrate that it is governed by code or logic that validates that the AI system will be governed in the way required by the policies. As one example, the AI system may be permitted to operate only for a limited purpose, a limited time, in a limited location, by a limited type of party, etc.

The EAL configuration can allow market participants 910 to request or to form markets to which the enterprise 900 may have assets to contribute or from which the enterprise 900 may wish to obtain assets. For example, an insurance company may request data sets regarding occupational conditions, and the EAL 1000 may parse or receive that request and then determine whether it has the assets available to fulfill that request. When the requested asset is not available at the time of the request, the EAL 1000 may be configured to interface with the enterprise 900 to present the opportunity to the enterprise 900 and give the enterprise 900 the opportunity for fulfillment of the request. In other words, the available enterprise assets may not include an occupational conditions dataset, but when the EAL 1000 presents that request to the enterprise 900, the enterprise 900 determines that it can supply one or more data sets to fulfill that request and makes the one or more data sets available as enterprise assets via the transaction system 1150.

In some implementations, “data-as-a-transaction” (e.g., data sets as transacted entities) can contribute to context-based accommodations to transactions between parties. As an example, access to data (e.g., an enterprise asset) could be used by a party to gain advantages in pricing with an acceptance of an increase in risk. For instance, an insurer may allow a partial premium payment based on the delivery by the insured (e.g., the enterprise 900) of specified data types (i.e., specialized enterprise assets). Here, receipt of the specified data types may automatically trigger a smart contract to adjust or generate one or more terms regarding, for example, pricing, interest rates, conversion rates, deductibles, underwriting requirements, ancillary offerings, promotions, term duration, limits on liability, warranties and representations, etc. To illustrate, a factory of an enterprise may have a liability and workman's compensation policy with some amount of designated coverage. As party of the policy, there may be specified data thresholds regarding, for example, the number of employees on the floor per shift, the number of machine hours of operation per day, the types of machines in operation, the number of sick days, injury reports, and insurance status of employees. When the factory has enough data to satisfy (e.g., surpass or exceed) the specified thresholds, the data may be transferred to the insurer and provisions of the policy affected are adjusted based on the data transferred. For example, the factory sends data (i.e., an enterprise asset) that 83% of its employees are insured. Here, since this 83% exceeds an 80% threshold that allows for a reduction in the policy premium, the transfer of data causes the policy premium adjustment for the factory's policy; in embodiments, the premium may be further reduced if the insurer is permitted to use the data (possibly in anonymized, obfuscated, or otherwise modified form) for its own purposes, such as to facilitate more accurate underwriting or for generation of improved actuarial, economic or predictive models (including predictions of the emergence of insurable risks). In some configurations, the EAL transfers (i.e., a transaction of an enterprise asset) or facilitates the transfer of data along with a protocol request (e.g., a request to adjust the premium). The insurer may also leverage enterprise asset transactions to inform their contracts and policies. For instance, the insurer may generate a query for data from the enterprise (e.g., the factory) to ensure or audit that the conditions of the policy are being met. In other words, the insurer may query or request an enterprise asset transaction for data regarding the number of employees on the floor per shift. Here, if the number increased unbeknownst to the insurer, the query may inform the insurer to adjust the premium (e.g., to increase the premium because the factory has moved to a greater risk level based on the query results for the number of employees on the floor per shift). When enterprise assets are various types of data sets, the enterprise 900 may have difficulty understanding the value of a particular data set. For instance, if an insurer would like to purchase data sets for working conditions of the enterprise 900 to facilitate products or services of the insurer (such as to tailor premium offerings to market participant conditions, to improve underwriting, to improve prediction, etc.), the enterprise 900 may be unable to properly value this enterprise asset due to its unconventional nature or the mere fact that it is not the type of asset with which the enterprise 900 is used to dealing. In these situations, the EAL 1000 may request or generate an evaluation marketplace, such as by sourcing (optionally by crowdsourcing) a set of target consumers (e.g., would-be data utilizers) to determine the estimated value for the data set. To generate an evaluation marketplace, the EAL 1000 may invite a set of would-be data providers (e.g., providers who could produce the type of data sets requiring valuation) and/or a set of would-be data utilizers (e.g., target consumers that could demand the types of data sets requiring valuation). In some examples, the parties that accept the invitations become virtual auction participants in order to provide a near-real market valuation of the data sets. That is, the participating would-be data provider posts or submits their data set (e.g., having one or more characteristics similar to the enterprise data set) and the participating would-be data utilizer(s) bid (e.g., propose an estimated value that they would pay) on the posted data set. In some configurations, this bidding process continues for each available data set from the pool of participating would-be data providers. In these configurations, the EAL 1000 may use statistical inference with the plurality of bids for the available data sets to generate a valuation for the similar data set owned by the enterprise 900. In some examples, the virtual auction house actually performs the offering of the enterprise data set during the auction so that the would-be data utilizers are not biased in their bidding. In embodiments, the EAL may, additionally, or alternatively, facilitate a set of simulations to help assess the value of the data, such as simulations that are informed by historical transactions in data sets having some similarity to available data sets, as well as informed by current marketplace conditions (such as offered prices of other data sets). In some examples, the participants in the virtual auction house engage with the virtual auction for evaluation purposes such that a participant does not receive the enterprise data set, but assists in its valuation for a future market offering. When functioning for a future market offering, it may be advantageous to include a large number of participants to statistically overcome potential bidding biases.

In some situations, following the valuation (such as using a virtual auction house, simulation, or other approached noted above), the EAL 1000 enables the enterprise 900 to further adjust the valuation of the data set. For instance, the EAL 1000 generates a feedback request to the enterprise 900 to authorize the estimated value assigned to the data set and the enterprise 900 provides a message in response to the feedback request that either approves the valuation or adjusts the valuation in some manner. Here, this adjustment feedback loop allows the enterprise 900 to determine if the valuation justifies the offering of the data set or if the enterprise 900 would prefer to offer the data set at a higher or lower transactional value compared to the valuation. For example, the value of the data set to the owner (i.e., the enterprise) may differ from the value of the data set to the market. Depending on the disconnect or gap between the owner value and the market value, the enterprise 900 may adjust the transaction value accordingly. Similarly, being informed by the valuation can also enable the enterprise 900 to opt out of offering the data set.

In some configurations, the EAL 1000 controlled by an enterprise 900 receives a data set from the enterprise 900. Here, the data set may characterize one or more attributes associated with a group of resources privately controlled by the enterprise 900. For instance, the data set may characterize information about a group of employees of the enterprise 900 (e.g., factory workers) or a group of equipment (e.g., production equipment of the enterprise 900). Upon receipt of the data set, the permissions system 1170 determines whether the data set satisfies a set of permission criteria. The permission criteria may refer to criteria that indicates a set of privacy rules, access rules, security rules, compliance rules, or other rules applicable to assets, resources or other entities that are controlled by the enterprise 900. The enterprise 900 or its agent may configure these rules or generate the rules to correspond to industry/legal standards (e.g., dictated by the governance system 1160), such as of acceptable privacy (e.g., to abide by the Health Insurance Portability and Accountability Act (HIPAA) or General Data Protection Regulation (GDPR)), etc.

Depending on the determination of whether the data set satisfies the set of permission criteria, the permissions system 1170 may perform different operations. For instance, in response to the data set failing to satisfy the permission criteria, the permissions system 1170 may communicate the data set to the data services system 1120. In embodiments, the permissions system 1170 recognizes that the data set needs further data processing and cooperates with the data services system 1120 of the EAL 1000 to perform that processing. In these configurations, the further processing may be that the data services system 1120 generates an encoded data set that satisfies the privacy or other rules identified by the permissions system 1170 for the data set. With the encoded data set that complies with the rules identified by the permissions system 1170, the EAL 1000 converts the encoded data set to an exchangeable digital asset. This conversion may occur by the EAL 1000 publishing the encoded data set to the transaction system 1150 and configuring the interface system 1110 with access to the encoded data set in the transaction system 1150 such that market participants 910 can access and/or request transactions for the encoded data set. On the other hand, if the permissions system 1170 determined that the data set satisfies the permission criteria, the EAL 1000 may convert the data set to an exchangeable digital asset in the same manner without the data processing encoding operation. In embodiments, encoding operations may include embedding applicable rules, such as licensing terms and conditions, for use of the data set, such that upon subsequent use of the data set such rules are automatically applied (e.g., to limit the number of seats that can access the data, to monitor and govern the number of queries or other restrictions permitted, to limit access to sensitive data contained in the data set (e.g., to allow aggregate queries but to limit queries from which private information can be deduced), to limit the location of use, to limit duration of use, to govern which systems or types of systems can access the data, etc.).

In embodiments, the EAL 1000 may be set up to operate as a data plane and control plane for the enterprise 900. In embodiments, when operating as a data plane, the EAL 1000 may be configured to exchange assets privately-generated by an enterprise 900 or enterprise entity that operates it. When configured in this manner, the EAL 1000 may receive an asset request from a requesting entity, such as a market participant 910 with access to the EAL 1000 (e.g., via the interface system 1110). Here, the asset request indicates an asset that may be available for transaction, such as discovered in a transaction system 1150 (e.g., is associated with a wallet of the transaction system 1150) or other presentation interface. Based on the request, the permissions system 1170 identifies whether there are any asset controls (e.g., access controls or permissions assigned to an asset) associated with the requested asset. Here, the permissions system 1170 may have configured the asset control for the asset to indicate a control parameter that must be satisfied prior to any transactional action occurring for the asset. In some examples, the intelligence system 1130 is able to determine control parameters for the permissions system 1170 using data derived from the enterprise 900 that privately generated the asset. In other words, the intelligence system 1130 can predict or determine a control parameter based on historical data modeling of controls for assets of the enterprise or for controls of assets similar to the assets of the enterprise.

In response to the permissions system 1170 identifying an asset control condition associated with the requested asset, the permissions system 1170 proceeds to determine whether the asset control condition is satisfied, such as, for example, by one or more parameters of the asset requests and/or by one or more attributes of the requesting entity. For instance, the asset control may designate what type of entity is able to access the asset or some set of requirements that must be met by the asset request and/or requesting entity to gain permission to access the asset (e.g., perform a transaction with the asset). In response to the asset control condition being satisfied, the EAL 1000 may facilitate fulfillment of the asset request. On the other hand, if the permissions system 1170 determines that the asset control condition is not satisfied, the requesting entity/asset request is denied. In some configurations, denial of the request generates a message that indicates the denial. This message may include some amount of information detailing the reasons for denial and/or prompting modifications in the asset request and/or requesting entity that would enable the request to be satisfied.

In some implementations, the EAL 1000 receives an asset request from a requesting entity (e.g., a market participant 910) where the asset request indicates an asset that is available in the transaction system 1150 as an exchangeable digital asset. In these implementations, exchangeable digital assets of the enterprise 900 correspond to one or more assets stored in a private data structure (e.g., a private blockchain) associated with an owner of the exchangeable digital assets (e.g., the enterprise 900). Based on the request, the EAL 1000 identifies whether there are any asset controls (e.g., access controls or permissions assigned to an asset) associated with the requested asset. Here, the permissions system 1170 may have configured the asset control for the asset to indicate a control parameter that must be satisfied prior to any transactional action occurring for the asset. Similar to the prior discussed configurations of the EAL 1000, the intelligence system 1130 is able to determine control parameters for the permissions system 1170 using data derived from the enterprise 900 that privately generated the asset.

In response to the EAL 1000 (e.g., the permissions system 1170) identifying an asset control associated with the requested asset, the permissions system 1170 proceeds to determine whether the asset control is satisfied by at least one of the asset requests or by the requesting entity. For instance, the asset control designates what type of entity is able to access the asset or some set of requirements that must be met by the asset request and/or requesting entity to gain permission to access the asset (e.g., perform a transaction with the asset). In response to the asset control being satisfied, the EAL 1000 may facilitate fulfillment of the asset request. Yet here, fulfillment of the asset request includes storing the asset in a public append-only data structure (e.g., a public blockchain) to represent a transaction involving the asset with the requesting entity. On the other hand, if the permissions system 1170 determines that the asset control fails to be satisfied, the requesting entity/asset request is denied and a denial message (as previously discussed) may be communicated to the requesting entity. With this approach, the EAL 1000 is able to function as a facilitator or executor for transactions that demand operations on both a private data structure (e.g., a private blockchain) and a public data structure (e.g., a public blockchain).

In some examples, the EAL 1000 receives a set of assets generated or controlled by the enterprise 900. For each asset of the set of assets, the EAL 1000 may classify (e.g., using the intelligence system 1130) the respective asset into an asset category, which may include classifying the asset into an asset control category. Here, each asset category is associated with a set of rules, such as assets controls, that dictate one or more transaction parameters for the exchange of the respective asset with a third party (e.g., a market participant 910). Moreover, for each asset of the set of assets, the EAL 1000 (e.g., using the permissions system 1170) may assign the set of asset rules for the access category classified by the EAL 1000 for the respective asset. In these examples, the EAL 1000 then converts the set of assets to exchangeable digital assets by publishing the set of assets to the transaction system 1150 and configuring the interface system 1110 with access to the set of the transaction system 1150. In embodiments, asset categories may be associated with a defined set of marketplaces, exchanges, or other environments in which assets may be transacted, such that a set of rules appropriate for the classified asset may be derived by reference to the governing rules of the applicable transaction environment; for example, assets classified as commodities may be governed by rules of a commodities exchange, assets classified as securities may be governed by rules of a securities exchange, assets classified as cryptocurrencies may be governed by rules of a cryptocurrency exchange, etc. Asset classification may be learned using any of the artificial intelligence or learning techniques described herein, such as on a training data set of historical transactions (e.g., by observing which type of asset objects are traded in which environments), by training on human classification interactions (such as tagging of assets), etc. Training may be seeded or assisted by a model, such as an asset classification model that classifies or clusters assets based on data object parameters. This may include a hierarchical model or graph with classes and subclasses of asset types.

In some embodiments, the EAL 1000 may also function as a type of monitoring system. For example, the EAL 1000 may be configured to automatically monitor or mine for potential deals or transactions that could involve the enterprise assets that it manages and/or to monitor or mine for opportunities to acquire assets that it wishes to acquire. In some configurations, the EAL 1000 monitors (e.g., via its interface system 1110) a plurality of market participants 910. While monitoring the plurality of market participants 910, the EAL 1000 may receive an indication that a monitored market participant 910 requests or offers an asset candidate or type of asset. In the case of a request for an asset or type, the EAL 1000 determines (e.g., via using the intelligence system 1130) whether the asset candidate matches (or is similar to) an asset available in the transaction system 1150 associated with the EAL 1000. If the asset candidate does not match any available assets in the transaction system 1150, the EAL 1000 may continue to perform monitoring services for other asset candidates. In the case of offers, the EAL 1000 may receive an indication of the parameters of an offer of a digital asset or type, compare the offer to a set of desired transaction parameters, and, if the parameters are satisfied, initiate a transaction to acquire the asset.

In response to a request matching an asset available in the transaction system 1150, the EAL 1000 may be configured to perform a set of operations that further analyze whether to engage or to offer to engage in an asset transaction with the monitored market participant 910. These operations may include identifying a set of asset control conditions managed by the permissions system 1170 of the EAL 1000 and determining whether a transaction (e.g., a digital exchange) with the monitored market participant 910 satisfies an asset control criterion corresponding to the asset available in the transaction system 1150 (i.e., the matching asset). For instance, the asset control criterion may indicate that a threshold number has been exceeded. In response to determining that the transaction with the monitored market participant 910 that involves the asset available in the transaction system 1150 satisfies any asset control criteria (e.g., does not violate a threshold), the EAL 1000 may generate a message data packet that proposes an actual transaction with the market participant 910 involving the asset available. In some examples, the interface system 1110 communicates the message data packet on behalf of the EAL 1000 to the market participant 910.

In embodiments, an EAL 1000 may be configured as a multi-tenant EAL 1000, where the functions and capabilities of the EAL 1000 are made available to more than one enterprise (or to more than one business unit of an enterprise), such that processing resources and facilities (e.g., data centers and network infrastructure), operating resources (such as personnel), and others are shared across tenants, while the functions and capabilities of the EAL 1000 are governed and executed with awareness of the access rights and other attributes of each tenant. For example, two (or more) enterprises may share an EAL 1000, such as where the enterprises operate in a similar domain and/or undertake similar transactions, such that the marketplaces, exchanges, or other transactions with which the EAL 1000 are similar for the two enterprises. The EAL 1000 may monitor usage of each tenant, provision resources (such as according to relative priorities), maintain separation of enterprise-specific elements (e.g., wallets of each enterprise), handle billing transactions for usage, etc. In embodiments, transactions across multiple tenants may be aggregated to achieve volume discounts, with discounts being automatically allocated and applied according to a set of rules (such as based on proportionate contribution to transactions). In embodiments, tenancy may be managed in a set of tiers, such as with each tier having a set of service levels associated therewith, such as enabling usage of given sets of functions and capabilities of the EAL 1000, setting relative prioritization (e.g., with higher tiers being given priority where transactions are limited, where resources are limited), etc.

In embodiments, the EAL 1000 may be configured for peer-to-peer connectivity among a set of enterprises (e.g., bilateral connectivity or multilateral connectivity), such that the functions and capabilities of the EAL 1000 are configured to handle the particular types of assets, resources, workflows and transactions that occur among the enterprises. For example, a bank and a manufacturing entity may establish a peer-to-peer EAL 1000 for a set of financial transactions, including working capital loans, trade credit lending, handling of deposits, payroll processing, payments processing, and others. In this example, the assets of the manufacturing enterprise may be presented in a wallet in the EAL 1000 that is on accessible to the manufacturing entity and to lending officers of the bank, such that the lending assets can be configured to be used as collateral for lending transactions. For example, the EAL may facilitate automated generation of sets for collateral for a set of loans among the manufacturing enterprise and the bank. In another example, a third entity, such as a secondary lender, underwriter, insurer, etc. may be added to the EAL 1000, such as to facilitate multi-party transactions. In other embodiments, a multi-party, peer-to-peer EAL 1000 may handle transactions among a set of parties participating in a supply chain, such as tiers of component manufacturers that provide components of systems manufactured by an OEM. A peer-to-peer EAL 1000 may be established between a manufacturer or retailer with a set of preferred customers, such as repeat customers, such that the EAL allows the preferred customers access to view inventories (as presented in a wallet) in a manner that has priority over the access by the general public. The peer-to-peer EAL 1000 may include governing rules that are customized to each party (e.g., setting rules for what assets and transactions are presented or permitted), may provision and prioritize resources (e.g., for storage, processing, networking, etc.) among parties, may allocate costs, etc. The configured services of the EAL 1000 (of any of the types described herein), may include ones that are configured for the needs of each party, such as by learning on historical transactions of that party and/or on similarly situated other parties (such as ones from similar domains). In some embodiments, the peer-to-peer EAL 1000 may be a multi-tenant, peer-to-peer EAL 1000 having features described above.

Although the EAL 1000 has been generally described with respect to digital enterprise asset functionality, the EAL 1000 is not limited to digital assets, but may also perform its functionality for non-digital assets. For example, for a non-digital enterprise asset, the EAL 1000 may facilitate non-asset transactions by: managing transactional parties, permissions, logistics, or recordation of a transaction in some manner; providing intermediary services (e.g., escrow services for a physical transaction, authentication services, etc.); generating a digital object (e.g., a token or a transactional record) to indicate that a non-digital asset transaction has occurred; or processing/storing digital files related to a non-digital asset. As previously described, a physical resource, which may be considered a non-digital enterprise asset, may have associated documentation (e.g., certificate of authenticity, proof of purchase, deed, title, etc.). With associated documentation that can be generated, modified, transferred, processed, and/or stored in a digital context, the EAL 1000 can function to represent and/or manage some of all of these transactional instances.

In some implementations, the EAL 1000 may be configured to perform the transaction and/or to generate a record of the transaction for digital storage. For instance, the EAL 1000 generates a record of the transaction and stores the record on one or more blockchains (e.g., private blockchain associated with the enterprise and/or a public blockchain). In some configurations, similar to a digital asset transaction, when the EAL 1000 is integrated with the performance of a non-digital asset transaction, the capabilities of the EAL 1000 may generate records that store detailed information regarding a transaction. This detailed information may be information such as the enterprise's agent who authorized the transaction, any permissions required or satisfied to perform the transaction, any governance involved to perform the transaction, any decision-making intelligence requested/relied upon to perform the transaction, any data processing/data retrieval involved to perform the transaction, etc. In other words, the detailed information can log or record services performed by EAL systems or entities in cooperation with EAL systems.

### Graph Neural Networks and Transformer Models in Artificial Intelligence Platforms

### Graph Neural Networks—Introduction

In various embodiments, one or more techniques involve the processing of graph data using one or more machine learning algorithms. In some such embodiments, the one or more machine learning algorithms include one or more graph neural networks (GNNs). The following discussion provides an overview of graph data and graph neural networks.

In a graph data set, a set of nodes is interconnected by one or more edges that respectively represents a relationship among two or more connected nodes. In many graph data sets, each edge connects two nodes. In other graph data sets that represent hypergraphs, a hyperedge can connect three or more nodes. In various graph data sets, each of the one or more edges is directed or undirected. An undirected edge represents a relationship that relates two or more nodes without any particular ordering of the related nodes. A first undirected relationship that connects a first node N1 and a second node N2 may be equivalent to a second undirected relationship that also connects a first node N1 and a second node N2. In some such graphs, the relationship represents a group to which the two or more related nodes belong. In some such graphs, the relationship represents an undirected and/or omnidirectional connection between two or more nodes. For example, in a graph representing a geographic region, each node may represent a city, and each edge may represent a road that connects two or more cities and that can be traveled in either direction. By contrast, a directed edge includes a direction of the relationship between a first node and a second node. For example, in a graph representing a genealogy or lineage, each node represents a person, and each edge connects a parent to a child. A first directed edge that connects a first node N1 to a second node N2 is not equivalent to a second directed edge that connects the second node N2 to the first node N1. Some graph data sets include one or more unidirectional edges, that is, an edge with one direction among two or more connected nodes. Some graph data sets include one or more multidirectional edges, that is, an edge with two or more directions among the two or more connected nodes. Some graph data sets may include one or more undirected edges, one or more unidirectional edges, and/or one or more multidirectional edges. For example, in a graph representing a geographic region, each node may represent a city; one or more unidirectional edges may represent a one-way road that connects a first city to a second city and can only be traveled from the first city to the second city; and one or more bidirectional or undirected edges that represent a bidirectional road between the first city and the second city that can be traveled in either direction. Some graph data may include, for two or more nodes, a plurality of edges that interconnect the two or more nodes. For example, a graph data set representing a collection of devices may include nodes that respectively correspond to each device of the collection and edges that respectively correspond to an instance of communication and/or interaction among two or more of the devices. In such a graph data set, a particular subset of two or more devices may engage in a plurality, including a multitude, of instances of communication and/or interaction, and may therefore be connected by a plurality, including a multitude, of edges.

Some directed and/or undirected graph data sets may include one or more cycles. For example, in a graph representing a social network, a first edge E1 may connect a first node N1 (representing a first person) and a second node N2 (representing a second person) to represent a relationship between the first person and the second person. A second edge E2 may connect the second node N2 and a third node N3 (representing a third person) to represent a relationship between the second person and the third person. A third edge E3 may connect the third node N3 and the first node N1 to represent a relationship between the third person and the first person. Such cycles can occur in undirected graphs (e.g., edges in a social network graph that indicate mutual relationships among two or more individuals), directed graphs (e.g., edges in a social network graph that indicate that a first person is influenced by a second person, a second person is influenced by a third person, and a third person is influenced by the first person), and/or hypergraphs (e.g., cycles of relationships among three or more clusters that respectively include three or more nodes). Some cyclic graphs may include one or more cycles that are interlinked (e.g., one or more nodes and/or edges that are included in two or more cycles). Other directed and/or undirected graph data sets may be acyclic (e.g., graphs in which nodes are strictly arranged according to a top-down hierarchy). Still other directed and/or undirected graph data sets may be partially acyclic (e.g., mostly acyclic) but may include one or more cycles among one or more subsets of nodes and/or edges.

In some graph data sets, one or more nodes includes one or more node properties. For example, in a graph representing a geographic area, each node may represent a city, and each node may include one or more node properties that correspond to one or more properties of the city, such as a size, a population, or a latitude and/or longitude coordinate. Each node property may be of various types, including (without limitation) a Boolean value, an integer, a floating-point number, a set of numbers such as a vector, a string, or the like. In some graph data sets, one or more nodes does not include a node property. For example, in a graph data set representing a set of particles, each particle may be identical to each other particle, and there may be no specific data that distinguishes any particle from any other particular. Thus, the nodes of the graph data set may not include any node properties.

In some graph data sets, one or more edges includes one or more edge properties. For example, in a graph representing a geographic area, each edge may represent a road, and each edge may include one or more edge properties that correspond to one or more properties of the road, such as a distance, a number of lanes, a direction, a speed limit, a volume of traffic, a start latitude and/or longitude coordinate, and/or an ending latitude and/or longitude coordinate. In some graph data sets, a direction of an edge may be represented as an edge property. Alternatively or additionally, in some graph data sets, a direction of an edge may be represented separately from one or more edge properties. In some graph data sets, one or more edges does not include an edge property. For example, in a graph data set representing a line drawing of a set of points, each edge may represent a line connecting two points, and the edges may be significant only due to connecting two points. Thus, the edges of the graph data sets may not include any edge properties.

In some graph data sets, the graph includes one or more graph properties. Such graph properties may be global graph properties that correspond to one or more properties of the entire graph. For example, in a graph data set representing a geographic region, the graph may include graph properties such as a total number of nodes and/or cities, a two-dimensional or three-dimensional area represented by the graph, and/or a latitude and/or longitude of a center of the graph. Such graph properties may be global graph properties that correspond to one or more properties of all of the nodes of the graph. For example, in a graph data set representing a geographic region, the graph may include graph properties such as an average population size of the cities represented by the nodes and/or an average connectedness of each city to other cities included in the graph.

Some graph data sets include a single set of data that includes all nodes and all edges. For example, a graph representing a geographic region may include a set of nodes that represent all cities in the geographic region. Some other graph data sets include one or more subgraphs, wherein each subgraph includes a subset of the nodes of the graph and/or a subset of the edges of the graph. For example, a graph representing a geographic region may include a number of subgraphs, each representing a subregion of the geographic region, and the edges that interconnect the cities within each subregion. As another example, a graph representing a geographic region may include a first subgraph representing cities (e.g., groups of people over a threshold population size and/or population density) and a second subgraph representing towns (e.g., groups of people under the threshold population size and/or population density). In some graph data sets, each node and/or each edge belongs exclusively to one subgraph. In some graph data sets, at least one node and/or at least one edge can belong to two or more subgraphs. For example, in a graph representing a geographic region that includes a number of subgraphs respectively representing different geographic subregion, each node representing a city may be exclusively included in one subgraph, while each edge may interconnect two or more cities within one subgraph (i.e., within one subregion) or may interconnect a first city in a first subgraph (i.e., within a first subregion) and a second city in a second subgraph (i.e., within a second subregion).

Graph neural networks can include features and/or functionality that are the same as or similar to the features and/or functionality of other neural networks. For example, graph neural networks include one or more neurons arranged in various configurations. Each neuron receives one or more inputs from the graph data set or another neuron, evaluates the one or more inputs (e.g., via an activation function), and generates one or more outputs that are delivered to one or more other neurons and/or as an output of the graph neural network. Examples of activation functions that can be included in various neurons of the graph neural network include (without limitation) a Heaviside or unit step activation function, a linear activation function, a rectified linear unit (ReLU) activation function, a logistic activation function, a tanh activation function, a hyperbolic activation function, or the like.

As an example, some graph neural networks include only a single neuron, or only a single layer of neurons that is configured to receive graph data as input and to provide graph data as output of the graph neural network. Some graph neural networks are arranged in a series of two or more layers, wherein input is received by neurons included in a first layer. The output of one or more neurons included in the first layer is delivered, as input, to one or more neurons included in a second layer. For example, each neuron in the first layer may include one or more synapses that respectively interconnect the neuron to one or more neurons of the second layer. In many graph neural networks, each neuron N1 of a preceding layer L 1 is connected to each neuron N2 of a following layer by a synapse that includes a weight W. Neuron N2 receives, as input, the output of the neuron N1 multiplied by the weight of the synapse connecting neuron N1 and neuron N2. In many neural networks, layer L 1 includes a bias B, which is added to the product of the output of neuron N1 and the weight W of the synapse connecting neuron N1 and neuron N2. As a result, the input to neuron N2 includes the sum of the bias B of layer L 1 and the product of the output of neuron N1 and the weight W of the synapse connecting neuron N1 and neuron N2. The output of the neurons included in the second layer can be provided as an output of the graph neural network and/or as input to one or more neurons included in a third layer. Each layer of the graph neural network may include a same number of neurons as a preceding and/or following layer of the graph neural network, or a different number of neurons as preceding and/or following layer of the graph neural network.

As another example, some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. For example, some graph neural networks (e.g., graph convolution networks) include one or more convolutional layers, each of which performs a convolution operation to an output of neurons of a preceding layer of the graph neural network.

As another example, some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells.

As another example, some graph neural networks feature recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input. As another example, some graph neural networks may include one or more skip connections, in which at least a portion of an output of a first layer is provided as input to a third layer without being processed by a second layer. That is, the output of the first layer is provided as input both to the second layer (which generates a second layer output) and to the third layer. In some such graph neural networks, the third layer receives, as input, either the output of the first layer or the output of the second layer. That is, the third layer multiplexes between the output of the first layer and the output of the second layer. Alternatively or additionally, in some such graph neural networks, the third layer receives, as input, both the output of the first layer and the output of the second layer (e.g., as a concatenation of the output vectors to generate the input vector for the third layer), and/or an aggregation of the output of the first layer and the output of the second layer (e.g., a sum or average of the output of the first layer and the output of the second layer). Examples of graph neural networks that include one or more skip connections include jump knowledge networks and highway graph neural networks (highway GNNs).

As another example, some graph neural networks include two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In these and other graph neural networks, the number of layers and the configuration of each layer of the graph neural network (e.g., the number of neurons and the activation function used by each neuron of each layer) can be referred to as hyperparameters of the graph neural network that are determined upon generation of the graph neural network. The weights of node synapses and/or the biases of the layers can be referred to as parameters of the graph neural network that are learned through a training or retraining process. Further explanation and/or examples of various concepts of other types of neural networks that can also apply to graph neural networks, and additional concepts that apply to other types of neural networks that can also be included in graph neural networks, are presented elsewhere in this disclosure and/or will be known to or appreciated by persons skilled in the art.

Unlike other types of neural networks, graph neural networks are configured to receive, process, generate, and/or transform one or more graph data sets. Some graph neural networks are configured to receive data representing and/or derived from a graph data set, such as an input vector that includes data representing one or more nodes of the graph (optionally including one or more node properties of one or more nodes), one or more edges of the graph (optionally including one or more edge properties of one or more edges), and/or one or more graph properties of the graph. Some graph neural networks are configured to receive an input vector comprising all of the data of a graph data set (e.g., all of the data representing all nodes, all edges, and the graph). Some graph neural networks are configured to receive an input vector comprising only a portion of the data of a graph data set (e.g., only a subset of the nodes of the graph and/or only a subset of the edges of the graph). For example, some graph data sets include a number of subgraphs, and the input vector to the graph neural network includes the data for all of the nodes and/or all of the edges included in one subgraph of the graph. The entire graph can be processed by processing (e.g., concurrently and/or consecutively) each subgraph and combining the output resulting from the processing of each subgraph. As another example, a graph data set representing a set of users of a social network may be processed by a graph neural network that receives, as input, a subset of nodes that correspond to the most influential users of the social network (e.g., those having more than a threshold number of social network connections) and a subset of edges that interconnect the nodes representing those users. Some graph neural networks are configured to receive, as input, data derived from a graph neural network. For example, a graph data set representing a social network may be processed by a graph neural network that receives, as input, data associated with messages exchanged among users of the social network, and provides, as output, an analysis of the messages. Some graph neural networks are configured to receive, as input, non-graph data (e.g., an input vector including coordinates of roads and/or cities in a geographic region) and generate graph data as output (e.g., a graph including odes that represent the cities, and edges that represent roads interconnecting the nodes representing the cities).

Some graph neural networks are configured to process input data as graph data. As an example, some graph neural networks are configured to receive, as input, data that represents each of one or more nodes of a graph data set and one or more edges that respectively interconnect two or more nodes of the graph data set. The graph neural network may process a state of each node and/or edge of the input graph data in order to generate an updated state of the node and/or edge. The term “message passing” refers to evaluating and updating the state of a node N or an edge E of a graph based on the states of one or more neighboring nodes N and/or connecting edges E. For example, for each node N1, the graph neural network may evaluate the state of node N1 and/or states of a set of nodes N that are connected to node N1 by at least one edge (e.g., a neighborhood of nodes that includes N1) and may determine an updated state of node N1 based on the state of the node N1 and/or the states of the neighboring nodes N. As another example, for each node N1, the graph neural network may evaluate the state of the node N1 and/or the states of a set of edges E that connect node N1 to one or more other nodes of the graph, and may determine an updated state of node N1 based on the state of the node N1 and/or the states of the edges E. As yet another example, for each edge E1 of the input graph, the graph neural network may evaluate a state of the edge E1 and/or the states of a set of nodes N of the graph that are connected to the edge E1 and may determine an updated state of edge E1 based on the state of the edge E1 and/or the states of the connected nodes N. As yet another example, for each edge E1 of the input graph that connects a set of nodes N of the graph, the graph neural network may evaluate the state of the edge E1 and the states of the set of edges E that are also connected at least one of the set of nodes N and may determine an updated state of edge E1 based on the state of the edge E1 and/or the states of the other edges. In these and other scenarios, each node N and/or each edge E is evaluated and updated based on a collection of “messages” corresponding to the states of neighboring nodes N and/or connecting edges E.

In some graph neural networks, each node N1 is updated based a neighborhood of size 1, including only on the states of the edges E that are directly connected to node N1 and/or the states of the other nodes N that are directly connected to node N1 by an edge. In some other graph neural networks, each node N1 is updated based a neighborhood of a size S greater than 1, including the states of other nodes N that are within S edge connections of node N1 and/or edges E that are connected to any such nodes N. In some graph neural networks, each edge E1 is updated based a neighborhood of size 1, including only on the states of the nodes N that edge E1 connects and/or the edges E that are also connected to the nodes N that edge E1 connects. In some other graph neural networks, each edge E1 is updated based a neighborhood of a size S greater than 1, including the states of other nodes N that are within S edge connections of node N1 and/or the set of edges E that are connected to any such nodes N. In some graph neural networks with a neighborhood of size greater than 1, one or more first layers of neurons process each node and/or edge based on the nodes and/or edges within a neighborhood of size 1; a second one or more following layers of neurons further process each node and/or edge based on the nodes and/or edges within a neighborhood of size 2; and so on. That is, the first one or more layers update the state of each node and/or edge based on the states of the directly connected nodes and/or edges, and each following one or more layers further updates the state of each node and/or edge additionally based on the states of indirectly connected nodes and/or edges that are one or more further connections.

In some graph neural networks, the states of nodes N and/or edges E are evaluated and updated concurrently (e.g., the graph neural network may evaluate the features relevant to each node N and/or each edge E to determine an update, and may do so for all nodes N and/or all edges E, before applying the updates to update the internal states of each node N and/or each edge E). In some graph neural networks, the states of nodes N and/or edges E are evaluated and updated consecutively (e.g., the graph neural network may evaluate the features relevant to a first node N1 and update the state of node N1 before evaluating the features relevant to a second node N2 and updating the state of node N2). In some graph neural networks, the states of the nodes N and/or the edges E are consecutively evaluated and updated according to a sequential order (e.g., the graph neural network first evaluates and updates a state of a first node N1 that is of a high priority, and then evaluates and updates a state of a first node N2 that is of a lower priority than N1). In some graph neural networks, a state of a node N2 is evaluated after updating a state of a node N1 and, further, based on the updated state of node N1. In some graph neural networks, a state of an edge E2 is evaluated after updating a state of an edge E1 and, further, based on the updated state of an edge E1. In some graph neural networks, the states of nodes N are concurrently evaluated and updated, and then the states of edges E are concurrently evaluated and updated concurrently. In some graph neural networks, the states of edges E are concurrently evaluated and updated, and then the states of nodes N are concurrently evaluated and updated concurrently. These variations in the order of updating the nodes N and/or edges E can be variously combined with the previously discussed variations in the processing of neighborhoods. For example, a graph neural network may include a first one or more layers that are configured to evaluate and concurrently update the states of all nodes and edges within a neighborhood of size 1, followed by a second one or more layers that are configured to evaluate and concurrently update the states of all nodes and edges within a neighborhood of size 2. Another graph neural network may a graph neural network may include a first one or more layers that are configured to evaluate and concurrently update the states of all nodes within a neighborhood of size 1, followed by a second one or more layers that are configured to evaluate and concurrently update the states of all nodes within a neighborhood of size 2, further followed by one or more layers that are configured to update the states of all edges within a neighborhood of size 1 or more.

Some graph neural networks are configured to evaluate and/or update one or more node properties of one or more nodes of a graph data set. For example, a graph representing a social network may include nodes that represent people, and a graph neural network may evaluate the nodes and/or edges of the graph to predict one or more node properties that correspond to attributes of the person, such as a type of the person, an age of the person, or an opinion of the person. Some graph neural networks are configured to evaluate and/or update one or more edge properties of one or more edges of a graph data set. Some graph neural networks are configured to evaluate and/or update one or more edge properties of one or more edges of a graph data set. For example, a graph representing a social network may include nodes that represent people and edges that represent relationships between people, and a graph neural network may evaluate the nodes and/or edges of the graph to predict one or more edge properties that correspond to attributes of a relationship among two or more people, such as a type of the relationship, a strength of a relationship, or a recency of the relationship. Some graph neural networks are configured to evaluate and/or update one or more graph properties of the graph data set. For example, a graph representing a social network may include nodes that represent people and edges that represent relationships between people, and a graph neural network may evaluate the nodes and/or edges of the graph to predict a feature of a social group to which all of the people belong, such as a common interest or a common demographic trait that is shared by at least many of the people of the social network.

Some graph neural networks are configured to generate graph data as output. The generated graph data may include one or more nodes (optionally including one or more node properties), one or more edges (optionally including one or more edge properties), and/or one or more graph properties. The generated graph data may be based on input graph data. Some graph neural networks may be configured to receive at least a portion of a graph data set as input, and may generate, as output, modified graph data. As an example, the input graph data set may include a number of nodes and a number of edges interconnecting the nodes, and in the output graph data set generated by the graph neural network, each of the nodes and/or edges of the graph may have been updated based on one or more nodes and/or one or more edges of the input graph data. For example, an input graph data set may represent a social network including a nodes representing people and edges representing relationships between people. A graph neural network may be configured to receive at least a portion of the input graph data set, and may output an adjusted graph data set, wherein a state at least one of the nodes and/or at least one of the edges is updated based on the processing of the input data set. For example, various edges representing relationships may be updated to include additional data (e.g., edge properties) to represent an updated relationship between two people represented by nodes. Various nodes may be updated with to include additional data (e.g., node properties) to represent updated information about corresponding people based on the relationships. Various graph properties of the at least a portion of the graph data set may be updated based on the updated edges and/or nodes, e.g., a new common interest that is shared among many of the people in the social network.

Some graph neural networks may be configured to output graph data that includes one or more newly discovered nodes based on the input graph data set. For example, an input graph data set representing travel events may include edges that include routes of travelers and nodes that represent locations of interest. A graph neural network may receive the input graph data set, and based on processing of the routes of the travelers, may output an updated graph data set that includes a new node that represents a new location of interest (e.g., a destination of a large number of recent travelers). The output of the graph neural network may include, for one or more new or existing nodes, one or more new or updated node properties (e.g., a classification of the location of interest based on the travel routes). Alternatively or additionally, some graph neural networks may be configured to output graph data that excludes one or more existing nodes of an input graph data set. For example, based on processing the input data set representing routes of travelers, a graph neural network may output an updated graph data set that excludes one of the nodes of the input graph data set representing a location that is no longer a location of interest (e.g., a destination that travelers no longer visit).

Some graph neural networks may be configured to output graph data that includes one or more newly discovered edges based on the input graph data set. For example, an input graph data set may represent a social network including nodes that represent people and edges that represent connections between people. A graph neural network may receive the input graph data set, and based on processing of the people and connections, may output an updated graph data set that includes a new connection between two people (e.g., a likely relationship based on shared traits and/or mutual relationships with a number of other people representing a social circle). The output of the graph neural network may include, for one or more new or existing edges, one or more new or updated edge properties (e.g., a classification of a relationship between two or more people). Alternatively or additionally, some graph neural networks may be configured to output graph data that excludes one or more existing edges of an input graph data set. For example, based on processing the input data set representing a social network, a graph neural network may output an updated graph data set that excludes one or more of the edges of the input data set representing a relationship that no longer exists (e.g., a lost connection based on a splitting of a social circle).

Some graph neural networks may output graph data that is based on data that does not represent an input graph data set. For example, a graph neural network may be configured to receive non-graph data, such as lists of travel routes of drivers, and may generate and output a graph data set including nodes that represent locations of interest and edges that interconnect the locations of interest. Conversely, some graph neural networks may receive input that includes at least a portion of a graph data set and that outputs non-graph data based on the input graph data. For example, a graph neural network may be configured to receive input including graph data, such as a graph of a social network including nodes that represent people and edges that represent connections, and to output non-graph data based on analyses of the input graph data, such as statistics about the people represented in the social network and activity occurring therein.

### Graph Neural Networks—Properties

Graph neural networks, including (without limitation) those described above, may be subject to various properties and/or considerations of design and/or operation. These considerations may affect their architecture, processing, implementation, deployment, efficiency, and/or performance.

As previously discussed, graph neural networks may include edges with varying directionality, such as undirected edges (e.g., edges that represent distances between pairs of nodes that represent cities in a graph that represents a region), unidirectional edges (e.g., edges that represent parent/child relationships among nodes that represent people in a graph that represents a genealogy or lineage), and/or multidirectional edges (e.g., bidirectional edges that represent bidirectional roads between nodes that represent cities in a graph that represents a region). In some graph data sets, all of the edges have a same directionality (e.g., all edges are undirected). A graph neural network can be configured to receive an input vector corresponding to the input data set and to process the edges according to the uniform directionality of the edges (e.g., processing undirected edges without regard to the order in which the nodes are represented as being connected to the edge). Other graph data sets may include edges with different directionality (e.g., in a graph that represents a region, edges can represent roads between nodes that represent cities, and each edge can be either unidirectional to represent a one-way road or bidirectional to represent a two-way road). A graph neural network can be configured to receive an input vector corresponding to the input data set and to process the edges according to the distinct directionality of each edge (e.g., processing a unidirectional edge in a different manner than a bidirectional edge). As one such example, the graph neural network can interpret a bidirectional edge connecting two nodes N1, N2 as a first unidirectional edge that connects node N1 to N2 and a second unidirectional edge that connected node N2 to node N1. The pair of unidirectional edges can share various edge properties and/or can be evaluated and/or updated in a same or similar manner (e.g., for a pair of unidirectional edges corresponding to a bidirectional road, the graph neural network can process data representing a weather condition in a same or similar manner to both unidirectional edges associated with the bidirectional road).

As previously discussed, some graph neural networks are configured to process nodes according to a “message passing” paradigm, in which the evaluation of each node N1 is based on the states and/or evaluations of other nodes within a neighborhood of the node N1 and/or the edges that connect the node N1 to other nodes in the neighborhood of the node N1. That is, the state of each node in the neighborhood of the node N1 and/or the state of each edge that connects N1 to other nodes of the neighborhood serves as a “message” that informs the evaluation and/or updating of the state of node N1 by the graph neural network. Alternatively or additionally, the evaluation of each edge E1 is based on the states and/or evaluations of other edges within a neighborhood of the edge E1. That is, the state of each node connected by edge E1, and, optionally, the states of other nodes connected to those nodes and/or other edges in such connections, serves as a “message” that informs the evaluation and/or updating of the state of edge E1 by the graph neural network. In each case, the size of the neighborhood can vary; for example, the graph neural network can evaluate each node according to a one-hop neighborhood or a multi-hop neighborhood. Graph neural networks that perform multi-hop neighborhood evaluation can include multiple layers, where a first one or more layers are configured to process a first hop between a node N1 and a one-hop neighborhood including its directly connected neighbors and/or directly connected edges, and a second one or more layers following the first one or more layers are configured to process a second hop between the nodes and/or edges of the one-hop neighborhood and additional nodes and/or edges that are directly connected to the nodes and/or edges of the one-hop neighborhood. In this manner, each node N1 is first evaluated and/or updated based on message passing among the one-hop neighborhood, and is then evaluated and/or updated based on additional messages within the two-hop neighborhood, etc. Other architectures of graph neural networks may perform multi-hop neighborhood evaluation in other ways, e.g., by processing individual clusters of nodes and/or edges to perform message passing among the nodes and/or edges of each cluster, and then performing additional message passing between clusters to update nodes and/or edges of each cluster based on the nodes and/or edges of one or more neighboring clusters.

In some scenarios, a graph may include nodes and/or edges that are stored, represented, and/or provided as input that is not subject to any particular order (e.g., nodes representing points in a line drawing may not have any node properties, and may therefore be represented in arbitrarily different orders in the input graph data set). In such scenarios, a multitude of semantically equivalent input graph data sets may be logically equivalent to one another. That is, a first representation of a graph may include the nodes and/or edges in a particular order, while a second representation of the same graph may include the same nodes and/or edges in a different order. While both representations of the graph are logically equivalent, the different ordering in which the nodes and/or edges are provided as input to the graph neural network may cause the graph neural network to provide different output. In other scenarios, a graph comprising a set of nodes and a set of interconnecting edges may be organized, stored, and/or represented in a particular order. For example, the nodes may be ordered according to a property of the nodes, and/or edges may be ordered according to a property of the edges (e.g., in a social network, nodes representing people may be ordered according to the alphabetical order of their names, and edges representing relationships may be ordered according to the alphabetical order of the names of the related people). In such scenarios, changes to the order and/or the selected subsets of graph data may result in different input data sets that represent the same or similar (e.g., logically equivalent) graphs. Due to the manner in which a graph neural network processes the input graph data set, logically equivalent input graph data sets may result in different and logically distinct output data.

In such scenarios, it may be undesirable for the graph neural network to generate different output for different but logically equivalent representations. That is, it may be desirable for the graph neural network to provide the same or equivalent output for different but logically equivalent representations of a graph. Graph neural networks that exhibit this property can be referred to as “permutation invariant,” that is, capable of providing output that does not vary across permutations in the representation of the input graph data set. A variety of techniques may be used to achieve, improve, and/or promote permutation invariance. Some such techniques involve changing representations of the input data set. For example, before processing an input graph data set, the graph neural network may reorder the input data set (e.g., by reordering the units of an input vector) such that nodes and edges are represented in a consistent order. As one such example, an input graph data set may include nodes that represent cities, and the input graph data set may include the nodes and/or edges in varying orders. Prior to processing the input graph data set, the graph neural network may reorder the nodes based on latitude and longitude coordinates of the cities, and the edges can similarly be reordered based on the latitude and longitude coordinates of the nodes connected by each edge. Thus, any representation of the graph including nodes that represent the same set of cities is processed in a similar manner. Similar reordering may involve various node properties and/or edge properties, including (without limitation) an alphabetic ordering of names in a graph including nodes that represent people, a chronological ordering of dates in a graph including nodes that represent events, a numeric ordering of content-based hashcodes in a graph including nodes that represent objects, and/or a numeric ordering of identifiers in a graph including nodes that possess unique numeric identifiers. Other techniques for achieving, improving, and/or promoting permutation invariance involve transforming an input graph data set into a different, permutation-invariant representation that is provided as input to and processed by the graph neural network. For example, a graph data set representing a two-dimensional image or a three-dimensional point cloud may include nodes that represent pixels and edges that represent spatial relationships (e.g., distances and/or orientations) between respective pairs of pixels of the image or respective pairs of points in the point cloud. Different orderings of the pixels and/or points may result in differently ordered, but logically equivalent, graph data sets for a particular image or point cloud. Instead of processing the graph data sets as input, a graph neural network may be configured to convert the input graph data set into a spectral representation, e.g., based on a spectral decomposition of a Laplacian L of the input graph data set. Instead of encoding information about individual pixels and/or points, the spectral representation instead encodes spectral components of the input graph data sets. The spectral components can be ordered in various ways (e.g., by frequency and/or polynomial order) to generate a permutation-invariant input vector, and the processing of the permutation-invariant input vector by a graph neural network may result in invariant (e.g., identical or at least similar) output of the graph neural network for various permutations of the input graph data set.

Alternatively or additionally, some techniques for achieving, improving, and/or promoting permutation invariance may relate to the structure of the graph neural network. For example, as an alternative or addition to reordering an input graph data set, a graph neural network may include one or more layers of neurons that process an input vector and generate permutation-invariant output. As one such example, a graph neural network may include a pooling layer that receives an input vector (e.g., an input vector corresponding to an input graph data set, and/or an input vector corresponding to an output of one or more previous layers of the graph neural network) and generates output that is pooled over the input, such as a minimum, maximum, or average of the units of the input. Because operations such as a minimum, maximum, and/or average over a data set are permutation-invariant mathematical operations, the graph neural network may therefore exhibit permutation-invariance of output based on the pooling operation for differently ordered but logically equivalent representations of a particular graph data set. As another such example, a graph neural network may include a filtering layer that receives an input vector (e.g., an input vector corresponding to an input graph data set, and/or an input vector corresponding to an output of one or more previous layers of the graph neural network) and generates output that is filtered based on certain permutation-invariant criteria. For example, in a graph representing a social network that includes nodes representing people, a layer of the graph neural network may filter the nodes to limit the input data set based on the top n nodes of the graph neural network that correspond to the most influential people in the social network. Such filtering may be based, e.g., on a count of the edges of each node (i.e., a count of the number of relationships of each person to other people of the social network), or a weighted calculation based on the influence of the nodes to which each node is related and/or the strength of each such relationship. Because such filtering operation are permutation-invariant logical operations, the graph neural network may therefore exhibit permutation-invariance of output based on the filtering operation for differently ordered but logically equivalent representations of the nodes (i.e., people) and edges (i.e., relationships) of the social network. As yet another example, some graph neural networks include an encoding or “bottleneck” layer, in which an output from N neurons of a preceding layer is received as input and processed by a following layer that includes fewer than N neurons. Due to the smaller number of neurons in the following layer, the volume of data that encodes features of the output of the preceding layer is compressed into a smaller volume of data that encodes features of the output of the following layer. This compression of features, based on learned parameters and training of the graph neural network to produce expected outputs, can cause the graph neural network to encode only more significant features of the processed data, and to discard less significant features of the processed data. The reduced-size output of the neurons of the following layer can be referred to as a latent space encoding of the input feature set. For example, whereas an input graph data set may include nodes that correspond to all pixels of an image of a cat, and an output of a previous layer of the graph neural network may include partially processed information about each node (i.e., each pixel) of the image of the cat, the output of the following layer of the graph neural network may include only features that correspond to visually significant features of the cat (e.g., features that correspond to the pixels that represent the distinctively shaped ears, eyes, nose, and mouth of the cat). Thus, the latent space encoding may reduce the processed input of the graph data set into a smaller encoding of nodes that represent significant visual features of the graph data set, and may exclude data about nodes that do not represent significant visual features of the graph data set. Many such graph neural networks include one or more “bottleneck” layers as one or more autoencoder layers, e.g., layers that automatically learn to generate latent space encodings of input data sets. As one such example, deep generative models may be used to generate output graph data that corresponds to various data types (e.g., images, text, video, scene graphs, or the like) based on an encoding, including an autoencoding, of an input such as a prompt or a random seed, Additional techniques for achieving or promoting permeation-invariance are presented elsewhere in this disclosure and/or will be known to or appreciated by persons skilled in the art.

In some scenarios, a graph data set may include a large number of nodes and/or a large number of edges. For example, a graph data set representing a social network may include thousands of nodes that represent people and millions of edges that represent relationships among the people. The size of the graph data set may result in an input vector that is very large (e.g., a very long input vector), and that might require a correspondingly large graph neural network to process (e.g., a graph neural network featuring millions of weights that connect the input graph data set to the nodes of a first layer of the graph neural network). The size of the input data set may result in large and perhaps prohibitive computational resources to receive and/or process the graph data set (e.g., large and costly storage and/or processing to store the input graph data set and/or the parameters and/or hyperparameters of the graph neural network, and/or a protracted delay in completing the processing of an input graph data set by the graph neural network). Further, the graph data set may exhibit properties of sparsity that cause a large portion of the input data set to be inconsequential. For example, a graph data set representing a social network may be encoded as a vector of N units respectively representing each node (i.e., each person) followed by a vector of N×N units that respectively represent a potential relationship between each node N1 and each node N2. Edges that represent a multidimensional mapping of connections between nodes (such as an N×N mapping of edges that represent possible connections between nodes) can be referred to as an adjacency matrix. However, in the social network, most person may have only a small number of relationships (i.e., far less than N−1 relationships with all other people of the social network). Thus, in the vector encoding of the input graph data set, a large majority of the N×N units that respectively represent potential relationships between each pair of nodes N1, N2 (i.e., the adjacency matrix) may be negative or empty (representing no relationship), and only a very small minority of the N×N units that respectively represent potential relationships between each pair of nodes N1, N2 may be positive or non-empty (representing a relationship). As another example, a graph data set representing a region may include N nodes representing cities and N×N edges representing possible roads between cities. However, if each city is only directly connected to a small number of neighboring cities, then a large majority of the N×N edges representing possible roads between cities (i.e., the adjacency matrix) may be negative or empty (representing no road connection), and only a very small minority of the N×N units that respectively represent potential roads between each pair of nodes N1, N2 may be positive or non-empty (representing an existing road). In such cases, the sparsity of an input vector representing the graph neural network may inefficiently consume computational resources (e.g., inefficiently applying storage and/or computation to large numbers of negative or empty units of the input vector) and/or may unproductively delay the completion of processing of the input graph data set.

Various techniques can be applied to reduce the sparsity of graph data sets and the processing of such graph data sets by graph neural networks. As a first example, the graph neural network can be pruned to reduce the number of nodes and/or edges included as an input data set (e.g., filtering the nodes of a graph neural network to a small cluster of densely related nodes, such as a small number of highly interrelated nodes that represent the members of a social circle in a social network). As a second example, the graph neural network can be encoded in a way that reduces sparsity. For example, rather than encoding the input graph data set as an adjacency matrix, the graph neural network may be configured to receive an encoding of the input graph data set as an adjacency list, i.e., as a list of edges that respectively connect two or more nodes of the graph. Due to encoding only information about existing edges, an adjacency list can eliminate or at least reduce the encoding of nonexistent edges. As a result, the size of the adjacency list may therefore be much smaller than a size of a corresponding adjacency matrix, and can therefore eliminate or at least reduce the sparsity of the input graph data set. The adjacency list can include edge properties of the edges of the graph data set. The adjacency list can be limited to a particular size (e.g., the top N most influential connections in a social network). The nodes of the input graph data set can be limited based on the edges included in the adjacency list (e.g., excluding any nodes that are not connected to at least one of the edges included in the adjacency list). As yet another example, rather than encoding an entire set of nodes and edges, a graph neural network can be represented as an encoding of the nodes and edges. For example, a graph data set may include nodes that represent pixels of an image and edges that represent spatial representations of the pixels. However, if large areas of the image are inconsequential (e.g., dark, empty, or not associated with any notable objects in a segmented image), then large portions of the nodes and/or edges would be inconsequential. Instead, the image can be reencoded as a frequency-domain representation as coefficients associated with respective frequencies of visual features within the image. The frequency-domain representation may present greater information density than the adjacency matrix of pixels, and therefore may present an input to the graph neural network that encodes the visual features of the input graph data set with reduced sparsity.

Other techniques for eliminating or reducing sparsity, and therefore increasing efficiency, involve the architecture of the graph neural network. For example, the input graph data set may encode edges as an adjacency matrix, and a first layer of the graph neural network may reencode the edges of the input graph data set as an adjacency list for further processing by the graph neural network. As another example, the graph neural network may include a first one or more layers that is configured to process an entirety or at least a large portion of the nodes and/or edges of an input graph data set, followed by a filtering layer that is configured to limit an output of the first one or more layers of the graph neural network. For example, in a graph data set that includes nodes that represent people and edges that represent connections, a first one or more layers may process all of the nodes and/or edges, and a filtering layer can limit the further processing of the output of the first one or more layers to the nodes and/or edges for which the outputs of the first one or more layers are above a threshold (e.g., an influence and/or relationship significance threshold). As still another example, the graph neural network may receive a sparse graph input data set but may only process a portion of the input graph data set (e.g., one or more random sampling of subsets of nodes and/or edges). In some cases, the graph neural network may compare results of the processing of subsets of the input graph data set (e.g., randomly sampled subsets of the nodes and/or edges) and may aggregate such results until the results appear to converge within a confidence threshold. In this manner, the graph neural network may generate an acceptable output within the confidence threshold while avoiding processing an entirety of the sparse input graph data set. Many such techniques for eliminating and/or reducing sparsity are presented elsewhere in this disclosure and/or will be known to or appreciated by persons skilled in the art.

### Graph Neural Networks—Input, Processing, and Output

Graph data sets may represent a variety of data types, including (without limitation) maps of geographic regions, including nodes representing cities and edges representing roads that connect two or more cities; social networks, including nodes representing people and edges representing relationships between two or more people; communication networks, including nodes representing people or devices and edges representing communication connections between the nodes or edges; economies, including nodes representing companies and edges representing transactions between two or more companies; molecules, including nodes representing atoms and edges representing bonds between two or more atoms; collections of events, including nodes representing individual events and edges representing causal relationships among two or more events; and periods of time, including nodes representing events and edges representing chronological periods among two or more events. Graph data sets may also be represent data types, such as passages of text, including nodes representing words and edges representing relationships among two or more words; images, including nodes representing pixels and edges representing spatial relationships among two or more pixels; object graphs, including nodes representing objects and edges representing dependencies among two or more objects; and three-dimensional spatial maps, including nodes representing three-dimensional objects and edges representing spatial relationships among two or more of the three-dimensional objects. Some graph data sets may include two or more subgraphs. In some such graph data sets, each node and/or each edge is exclusively included in one subgraph. In some other graph data sets, at least one node and/or at least one edge may be included in two or more subgraphs, or in zero subgraphs. Some graph data sets are associated with non-graph data that is also included as input to a graph neural network. For example, a graph neural network that evaluates traffic patterns within a geographic region may receive, as input, both an input graph data set that includes nodes that represent cities and edges that represent roads interconnecting the cities, and also non-graph data representing traffic and/or weather features within the geographic region (e.g., traffic volume estimates and current or forecasted weather conditions that affect the traffic patterns).

As another example, some graph data sets may include an indication of zero or more cycles occurring among the nodes and/or edges of the graph data set. For example, a directed and/or undirected graph data set may include an indication that a particular cycle exists within the graph and includes a particular subset of nodes and/or edges. Alternatively, a directed and/or undirected graph data set may include an indication that the graph is acyclic and does not include any cycles. A graph neural network may be configured to receive, as input, and process a graph data set that includes an indication of zero or more cycles.

As another example, some graph data sets may include nodes for which the edges provide spatial dimensions. As a first example, in a graph representing a geographic region, nodes that represent cities are related by edges that represent distances, wherein the nodes and interrelated edges can form a spatial map of the geographic region. As a second example, in a graph representing a molecule, nodes that represent atoms are related by edges that represent chemical bonds between the atoms, and the arrangement of atoms by the bonds forms a three-dimensional molecular structure. In some such scenarios, the spatial relationships are well-defined by the nodes and edges. In other such scenarios, the spatial relationships can be inferred based on semantic relationships among the nodes and/or edges of the graph data set. For example, in a graph representing a language, nodes that represent words are related by edges that represent semantic relatedness of the words within a high-dimensional language space. A language model can generate an embedding of the words of the language in a multidimensional embedding space, wherein nodes that are close together within the embedding space represent synonyms, closely related concepts, or words that frequently appear together in certain contexts, whereas nodes that are not close together within the embedding space represent unrelated concepts or words that do not commonly appear together in various contexts. A variety of graph embedding models may be applied to this task, including (without limitation) DeepWalk, node2vec, line, and/or GraphSAGE. A graph neural network can be configured to receive, as input, an embedding of a graph data set instead of representations of the nodes and/or edges of the graph data set. Alternatively, a graph neural network can be configured to receive an input graph data set including representations of the nodes and/or edges of the graph data set, generate an embedding based on the input graph data set, and apply further processing to the embedding instead of to the input graph data set. A graph neural network that is configured to process an embedding instead of an input graph data set may exhibit greater permutation invariance (e.g., due to the semantic associations represented by the embedding) and/or increased efficiency due to reduced sparsity of the input.

Some graph data sets include representations of each of one or more nodes and each of one or more edges.

Some graph neural networks are configured to receive and process such representations of graph neural networks. For example, the graph neural network may be configured to receive an input vector including an array of data representing each of the one or more nodes followed by an array of data representing each of the one or more edges, either as an adjacency matrix of possible edges between pairs of nodes or an adjacency list of existing edges. The input vector may encode the nodes and/or edges in a particular order (e.g., a priority order of nodes and/or a weight order of edges) or in an unordered manner. Alternatively or additionally, the graph data set may include and/or encode other types of information about each of one or more nodes and/or each of one or more edges of the graph data set. For example, the graph may include a hierarchical organization of nodes and/or edges relative to one another and/or to a fixed reference point. The graph neural network may be configured to receive and process an input graph data set that includes an indication of the arrangement of one or more nodes and/or one or more edges in the hierarchical organization.

As another example, a graph may include an indication of a centrality of one or more nodes and/or edges within the graph (e.g., a graph of a social network including nodes that are ranked based on a centrality of each node to a cluster). The graph neural network may be configured to receive and process an input graph data set that includes an indication of a centrality of one or more nodes and/or one or more edges in the graph.

As another example, a graph may include an indication of a degree of connectivity of one or more nodes and/or edges within the graph (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). The graph neural network may be configured to receive and process an input graph data set that includes an indication of a degree of one or more nodes and/or one or more edges in the graph.

As another example, a graph may include an indication of one or more clusters occurring within the graph. For example, a graph may include a result of a clustering analysis of the graph, e.g., a determination of k clusters within the graph and an identification of the nodes and/or edges that are included in each cluster. The clusters may be determined by a k-means clustering analysis, a Gaussian mixture model of with variable numbers of clusters and variable Gaussian orders, or the like. A graph may include a clustering coefficient of one or more nodes and/or one or more edges (e.g., a measurement of a degree to which at least some of the nodes and/or edges of a subgraph of the graph are clustered based on similarity and/or activity). The graph neural network may be configured to receive and process an input graph data set that includes an indication of a clustering coefficient of one or more nodes and/or one or more edges in the graph or a subgraph thereof.

As another example, a graph may include an indication of a graphlet degree vector that indicates a graphlet that is represented one or more times in the graph. For example, in a graph representing atoms in a regular structure such as a crystal, the graph may include a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet. The graph neural network may be configured to receive and process an input graph data set that includes a graphlet degree vector, and, optionally, features of one or more occurrences of a graphlet in the graph and/or a count of the occurrences of the graphlet in the graph.

As another example, a graph may include an indication of one or more paths and/or traversals of one or more nodes and/or one or more edges of the graph, optionally including additional details associated with a path or traversal such as a popularity, frequency, length, difficulty, cost, or the like. For example, in a graph representing a spatial arrangement of nodes, the graph may include a path or traversal of edges that connect a first node to a second node through zero or more other nodes, as well as properties of the path or traversal such as a total length, distance, time, and/or cost. The graph neural network may be configured to receive and process an input graph data set that includes additional details associated with one or more paths or traversals, including an indication (e.g., a list) of the associated nodes and/or edges and a list of one or more properties of the path and/or traversal.

As another example, a graph may include an indication of metrics or properties that relate one or more nodes and/or one or more edges. For example, in a graph including a spatial arrangement of nodes, the graph may include an indication of a shortest distance between two nodes and/or an indication of a set of nodes and/or edges that are common to two nodes. As another example, a graph representing a network of communicating devices may include a routing table of one or more routes that respectively indicate, for a particular node and a particular edge connected to the node, a list of other nodes and/or edges that can be efficiently reached by traversing based on the particular edge. As yet another example, in a graph representing a social network including nodes that represent people, the graph may indicate, for at least one pair of nodes, a measurement of similarity of the nodes based on their node properties, edges, locations in the social network, connections to other nodes, or the like (e.g., a Katz index of node similarity) and/or, for at least one pair of edges, a measurement of similarity of the edges based on their edge properties, connected nodes, locations in the social network, or the like (e.g., a Katz index of edge similarity). The graph neural network may be configured to receive and process an input graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph may include an indication of various graph properties of the graph (e.g., a graph size, graph density, graph interconnectivity, graph chronological period, graph classification, a count of subgraphs within the graph, or the like). For example, in a graph including two or more subgraphs (e.g., a social network including two or more social circles), the graph data set may include a measurement of a similarity of each subset of at least two subgraphs of the graph. The measurement of the similarity may be determined based on one or more graph kernel methods (e.g., a Gaussian radial basis function that can be applied to the graph to identify one or more clusters of similar nodes that comprise a subgraph). As another example, a graph may include a measurement of similarity with respect to another graph (e.g., an indication of whether a particular social network graph resembles other social network graphs that have been classified as representing a genealogy or lineage, a set of friendships, and/or a set of professional relationships). The graph neural network may be configured to receive and process an input graph data set that includes measurements determined by one or more graph properties (e.g., one or more measurements of similarity of one or more nodes, edges, and/or subgraphs, and/or a measurement of similarity of the graph to other graphs). Further explanation and/or examples of various graph data sets that may be provided as input to graph neural networks are presented elsewhere in this disclosure and/or will be known to or appreciated by persons skilled in the art.

Graph neural networks may be configured to perform various types of processing over such graph data sets. As previously discussed, a graph neural network can be organized as a series of layers, each of which can include one or more nodes that receive input, apply an activation function, and generate output. The output of each node of a first layer can be multiplied by a weight of a connection between the node and a node of a second layer, and then added to a bias associated with the first layer, to generate an input to the node of the second layer. The graph neural network can include various additional layers that perform other types of processing, including (without limitation) pooling, filtering, and/or latent space encoding operations, memory or stateful features, and recurrent and/or reentrant processing.

Some graph neural networks may perform label propagation among the nodes and/or edges of a graph data set. For example, in an input graph data set, one or more nodes and/or one or more edges may be associated with one or more labels of a label set, while one or more other nodes and/or one or more other edges may not be associated with any labels. A graph neural network may apply a label propagation algorithm (LPA) to assign labels to one or more unlabeled nodes and/or one or more unlabeled edges. For example, the graph neural network may assign a label to an unlabeled node based on labels associated with one or more edges connected to the node, and/or with one or more other nodes that are connected to the node by the one or more edges. The graph neural network may assign a label to an unlabeled edge based on labels associated with one or more nodes connected by the edge, and/or with one or more other edges that are also connected to the nodes connected by the edge. Some graph neural networks may perform label propagation based on a voting, consensus, weighting, and/or scoring determination. For example, a graph neural network may be unable to perform a classification of an unlabeled node and/or unlabeled edge based solely on the node properties and/or edge properties, but may be able to perform the classification based on a further consideration of the labels associated with other nodes and/or edges within a neighborhood of the unlabeled node and/or unlabeled edge.

Some graph neural sets may perform a scoring and/or ranking of nodes and/or edges of a graph data set. As an example, in a graph data set that represents the World Wide Web and that includes nodes that represent web pages and directed edges that represent hyperlinks of linking web pages to linked web pages, a graph neural network may determine one or more scores of each node (i.e., each web page) based on the scores of other nodes that hyperlink to the node. Each score may further be based on the scores of the other nodes that include a directed edge to this node (e.g., the scores of other web pages that hyperlink to this page). Additionally, each score associated with a node may represent a weight of an association between the web page and a particular topic (e.g., a particular topic or keyword that is associated with the web page, hyperlinks, and/or other pages that hyperlink to this web page). In some cases, the scores may be personalized based on the activities of a particular user (e.g., based on the hyperlinks from pages that the user frequently visits). A search engine may use the scores as rankings in order to generate search results for web searches including various topics or keywords (e.g., in response to a web search for a particular search term, present search results that correspond to the nodes with the highest scores associated with the search term, and present the search results in ranked order based on the scores). As another example, for a graph data set representing a social network, a graph neural network may generate a reputation score for each node based on other nodes that are associated with the node and the reputation scores of such other nodes. The scores of the nodes may be used to recommend new connections in the social network (e.g., recommending a first person connect with a second person, based on a high reputation score of the second person by people who are closely associated with the first person).

Some graph neural networks may perform a clustering analysis of the nodes and/or edges of a graph data set. As a first example, in a graph data set representing a social network, a graph neural network may perform a clustering analysis of the nodes representing the people of the social network, based on edges representing relationships among two or more nodes, in order to identify one or more clusters that represent social circles of highly interconnected people within the social network. Based on this clustering analysis, the graph neural network may partition the social network into subgraphs that respectively represent social circles, and may perform further, finer-grained evaluation of each social circle and the people represented by the nodes in each subgraph. As a second example, in a graph data set representing a social network, a graph neural network may perform a clustering analysis of the edges representing the relationships among people of the social network, in order to identify one or more clusters that represent different types of relationships, such as familial relationships, friendships, and professional relationships. Based on this clustering analysis, the graph neural network may partition the social network into subgraphs that respectively represent different types of social networks, and may perform further analysis of relationships among two or more individuals based on the type of relationship associated with the subgraph to which the relationship belongs. In these and other scenarios, in order to perform clustering analysis, a graph neural network may utilize a variety of clustering algorithms. As one such example, a graph neural network may apply spectral clustering techniques, wherein a similarity matrix that represents similarities among nodes and/or edges is evaluated to identify eigenvalues that indicate significant similarity relationships. Based on the similarity matrix, the graph neural network may perform a dimensionality reduction of the graph data set (e.g., reducing the features of the nodes and/or edges that are evaluated to determine clusters in order to focus on features that are highly correlated with and/or indicative of significant similarities). Dimensionality reduction of the graph data set based on the similarity matrix may enable the graph neural network to determine clusters more efficiently and/or rapidly, e.g., by reducing a high-dimensionality graph data set (wherein each node and/or edge is characterized by a multitude of node properties and/or edge properties) into a lower-dimensionality graph data set of a subset of features that are highly correlated with and/or indicative of similarity and clustering.

Some graph neural networks may perform a centrality determination among nodes and/or edges of a graph data set. For example, for a graph data set representing a social network, a graph neural network may evaluate the graph data set to identify a subset of nodes based on a centrality among the edges representing the connections of the social network, e.g., people who are at the center of each of one or more social circles within the social network. Alternatively or additionally, some graph neural networks may perform a “betweenness” determination among the nodes and/or edges of the graph data set. For example, a node may be considered to be “between” two clusters of nodes, such as a member of two or more clusters representing two or more social circles. Such “between” nodes may represent a communication bridge that conducts information between clusters (e.g., a person who can convey ideas and/or influence from a first social circle to a second social circle and vice versa). Some such graph neural networks may perform “betweenness” determinations based on a betweenness centrality measurement, e.g., based on a measurement of a shortest path between all pairs of nodes in the graph data set. As another example, a graph data set may represent a collection of text documents, wherein each node represents a document and each edge represents a relationship between documents (e.g., a unidirectional or bidirectional citation between a first document and a second document).

A graph neural network can perform a centrality determination and/or a betweenness determination to determine significant documents within the collection (e.g., a document that is heavily cited by one or more clusters of other documents, and/or a document that includes ideas or associations between the documents of a first cluster and the documents of a second cluster).

Some graph neural networks may perform analyses of structures occurring within a graph neural network. As an example, for a graph data set that represents a social network, a graph neural network may determine a notable sequence of relationships, such as a first relationship between node N1 and node N2 based on a shared interest, a second relationship between node N2 and node N3 based on the same shared interest, and a third relationship between node N3 and node N4 based on the same shared interest. Based on this sequence or chain of relationships, the graph neural network may recommend to a person represented by node N1 some further relationships with the people represented by nodes N3 and N4, due to the combination of shared interests and mutual relationships. In some such cases, a graph neural network may perform such structural analysis based on a traversal algorithm that traverses a sequence of nodes connected by one or more edges, and/or that traverses a sequence of edges connected by one or more nodes. As an example, a graph neural network may perform a random walk within the graph data set, such as starting with a first node (e.g., a first person of a social network) and following a limited set of edges that connect the first node to other nodes. In some cases, the traversal may be random (e.g., traversing from a node based on a random selection among the edges that connect the node to other nodes). In some other cases, the traversal may be weighted (e.g., each edge may include an edge property including a weight that represents a strength of a relationship among two or more nodes, and the traversal may be based on a weighted random selection that preferentially selects higher-weighted connections over lower-weighted connections). In some cases, the traversal can include a restart probability, e.g., a probability of retrying the traversal beginning with the original node or another node, based on a score such as a distance of the traversal with respect to the original node. In these and other cases, the results of a random walk can be used in further analyses and/or activities of the graph neural network (e.g., presenting recommendations for new social connections among the nodes of a social network).

Some graph neural networks may perform an analysis of a graph data set based on an attention model. For example, in a social network, the influence of a particular person P1 may not be determined by the connectedness of person P1 to other people in the social network, but based on a perception of person P1 by other people of the social network as being knowledgeable, skilled, influential, or the like. Thus, a graph neural network may be configured to evaluate a graph data set representing a social network in which nodes represent people and edges represent relationships, but may be unable to determine influence based only on graph concepts such as connectedness of the nodes based on the edges. Rather, the graph neural network might model influence as an attention of each node (i.e., a second person P2 of the social network) upon each other node (e.g., person P1 of the social network). Thus, a particular opinion of person P2 of the social network may depend not only on the connections of person P2 to other people of the social network (including person P1), but also upon the attention that person P2 accords to such other people of the social network (including person P1). That is, even though person P2 is closely connected to certain people of the social network by various edges, the opinion of person P2 may be heavily shaped by person P1 and other people to whom person P2 is only indirectly connected in the social network. As a second such example, in a graph data set that represents traffic flow within a region, an edge E1 (e.g., a first road) may be directly connected to other edges of the graph data set, but an edge property of the edge E1 (e.g., a traffic volume and/or congestion of the road) may be impacted more heavily by edge properties of other edges to which edge E1 is not directly connected (e.g., roads in other parts of the geographic region for which traffic volume and/or congestion is highly determinative of the traffic volume and/or congestion of this road). Thus, in order to predict and/or estimate a traffic volume and/or congestion of a particular road, a graph neural network may evaluate not only the traffic volume and/or congestion of other roads that are directly connected to the particular road, but also other roads for which traffic volume and/or congestion is highly determinative of corresponding conditions of this road. In these and other scenarios, a graph neural network may evaluate a graph data set based on an attention model, in which analyses and updates of the state of nodes and/or edges of the graph data set are based, at least in part, on an attention of each node and/or edge upon other nodes and/or edges of the graph data set. For example, the graph neural network may include an attention layer that determines, for a particular node and/or edge of an input graph data set, which other nodes and/or edges of the input graph data set are likely to be relevant to determining an updated state of the particular node and/or edge. Various attention models may be used by such graph neural networks, including multi-head attention models in which each node and/or edge is related to a plurality of other nodes and/or other edges with varying weighted attention values (e.g., by each of a plurality of attention layers). Multi-head attention models can allow a graph neural network to consider the influences upon a particular node and/or edge of a plurality of other nodes and/or edges, which may (or may not) be further related to one another by the graph structure and/or attention. Based on the attention model and the attention layers included in the graph neural network, the graph neural network can perform a more sophisticated graph analysis that is based on more than the structural relationships of the graph.

Some graph neural networks may be configured to process a graph data set in order to determine, and optionally output, various types of data (e.g., measurements, calculations, inferences, explanations, or the like) that relate to one or more nodes, one or more edges, and/or one or more subgraphs of the input graph data set and/or to the input data graph set as a whole. Some graph neural networks are configured to generate, and optionally output, various types of representations of graph neural networks. For example, the graph neural network may be configured to determine, and optionally output, an output vector including an array of data representing each of the one or more nodes followed by an array of data representing each of the one or more edges, either as an adjacency matrix of possible edges between pairs of nodes or an adjacency list of existing edges. The output vector may encode the nodes and/or edges in a particular order (e.g., a priority order of nodes and/or a weight order of edges, or corresponding to a corresponding order of the nodes and/or edges in the input graph data set) or in an unordered manner. Alternatively or additionally, the graph neural network may be configured to determine, and optionally output, other types of information about each of one or more nodes and/or each of one or more edges of the graph data set. For example, the graph neural network may be configured to determine, and optionally output, a hierarchical organization of nodes and/or edges relative to one another and/or to a fixed reference point. Alternatively or additionally, the graph neural network may be configured to determine, and optionally output, an output graph data set that includes an indication of the arrangement of one or more nodes and/or one or more edges in the hierarchical organization.

As another example, a graph neural network may be configured to determine, and optionally output, an indication of a centrality of one or more nodes and/or edges within the input graph data set (e.g., a graph of a social network including nodes that are ranked based on a centrality of each node to a cluster). Alternatively or additionally, the graph neural network may be configured to determine, and optionally output, an output graph data set that includes an indication of a centrality of one or more nodes and/or one or more edges in the graph.

As another example, a graph neural network may be configured to determine, and optionally output, an indication of a degree of connectivity of one or more nodes and/or edges of an input graph data set (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). Alternatively or additionally, the graph neural network may be configured to determine, and optionally output, an output graph data set that includes an indication of a degree of one or more nodes and/or one or more edges in the output graph data set.

As another example, a graph neural network may be configured to detect, identify, and/or analyze one or more clusters occurring within an input graph data set. For example, a graph neural network may be configured to perform a clustering analysis of an input graph data set to determine, and optionally output, a determination of k clusters within the input graph data set and an identification of the nodes and/or edges that are included in each cluster. The graph neural network may be configured to determine clusters based on a k-means clustering analysis, a Gaussian mixture model of with variable numbers of clusters and variable Gaussian orders, or the like. The graph neural network may be configured to determine, and optionally output, an indication of a clustering coefficient of one or more nodes and/or one or more edges of an input graph data set (e.g., a measurement of a degree to which at least some of the nodes and/or edges of a subgraph of the graph are clustered based on similarity and/or activity). Alternatively or additionally, the graph neural network may be configured to determine, and optionally output, an output graph data set that includes an indication of one or more clusters including one or more nodes and/or one or more edges in the output graph data set or a subgraph thereof (e.g., a result of a k-means clustering analysis of an output graph data set, a Gaussian mixture model of an output graph data set, and/or one or more clustering coefficients of an output graph data set).

As another example, a graph neural network may be configured to determine, and optionally output, an indication of a graphlet degree vector that indicates a graphlet that is represented one or more times in an input graph data set. For example, for a graph representing atoms in a regular structure such as a crystal, the graph neural network may be configured to determine, and optionally output, a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet in the input graph data set. Alternatively or additionally, the graph neural network may be configured to determine, and optionally output, an output graph data set that includes a graphlet degree vector, and, optionally, features of one or more occurrences of a graphlet in the output graph data set and/or a count of the occurrences of the graphlet in the output graph data set.

As another example, a graph neural network may be configured to determine, and optionally output, an indication of one or more paths and/or traversals of one or more nodes and/or one or more edges of the input graph data set, optionally including additional details associated with a path or traversal such as a popularity, frequency, length, difficulty, cost, or the like. For example, for an input graph data set representing a spatial arrangement of nodes, the graph neural network may be configured to determine, and optionally output, a path or traversal of edges that connect a first node to a second node through zero or more other nodes of the input graph data set, as well as properties of the path or traversal such as a total length, distance, time, and/or cost. Alternatively or additionally, the graph neural network may be configured to determine, and optionally output, an output graph data set that includes additional details associated with one or more paths or traversals, including an indication (e.g., a list) of the associated nodes and/or edges of the output graph data set and a list of one or more properties of each such path and/or traversal.

As another example, a graph neural network may be configured to determine, and optionally output, an indication of metrics or properties that relate one or more nodes and/or one or more edges of an input graph data set. For example, for an input graph data set including a spatial arrangement of nodes, the graph neural network may be configured to determine, and optionally output, an indication of a shortest distance between two nodes and/or an indication of a set of nodes and/or edges that are common to two nodes of the input graph data set. As another example, for an input graph data set representing a network of communicating devices, the graph neural network may be configured to determine, and optionally output, a routing table of one or more routes that respectively indicate, for a particular node of the input graph data set and a particular edge connected to the node, a list of other nodes and/or edges of the input graph data set that can be efficiently reached by traversing based on the particular edge. As yet another example, for an input graph data set representing a social network including nodes that represent people, the graph neural network may be configured to determine, and optionally output, an indication for at least one pair of nodes of a measurement of similarity of the nodes of the input graph data set based on their node properties, edges, locations in the social network, connections to other nodes, or the like (e.g., a Katz index of node similarity) and/or, for at least one pair of edges of the input graph data set, a measurement of similarity of the edges based on their edge properties, connected nodes, locations in the social network, or the like (e.g., a Katz index of edge similarity). Alternatively or additionally, the graph neural network may be configured to determine, and optionally output, an output graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph neural network may be configured to determine, and optionally output, an indication of various graph properties of an input graph data set (e.g., a graph size, graph density, graph interconnectivity, graph chronological period, graph classification, a count of subgraphs within the graph, or the like). For example, for an input graph data set including two or more subgraphs (e.g., a social network including two or more social circles), the graph neural network may be configured to determine, and optionally output, a measurement of a similarity of each subset of at least two subgraphs of the input graph data set. The measurement of the similarity may be determined based on one or more graph kernel methods (e.g., a Gaussian radial basis function that can be applied to the input graph data set to identify one or more clusters of similar nodes that comprise a subgraph). As another example, a graph neural network may be configured to determine, and optionally output, a measurement of similarity of an input graph data set with respect to another graph data set (e.g., an indication of whether a particular social network graph resembles other social network graphs that have been classified as representing a genealogy or lineage, a set of friendships, and/or a set of professional relationships). Alternatively or additionally, the graph neural network may be configured to determine, and optionally output, an output graph data set that includes measurements determined by one or more graph properties of an output graph data set (e.g., one or more measurements of similarity of one or more nodes, edges, and/or subgraphs, and/or a measurement of similarity of the output graph data set to the input graph data set and/or other graph data sets). Further explanation and/or examples of various types of processing that graph neural networks can determine, and optionally output, for various input graph data sets and/or output graph data sets are presented elsewhere in this disclosure and/or will be known to or appreciated by persons skilled in the art.

Graph neural networks may be configured to generate various forms of output that correspond to various tasks. For example, graph neural networks can generate output that represents node-level predictions that relate to one or more nodes of an input graph data set. The node-level predictions can include a discovery of a new node that was not included in the input graph data set. For example, in a graph data set including edges that represent travel of individuals in a region, the nodes can represent points of interest, and the graph neural network can discover a new node that corresponds to a new point of interest. The node-level predictions can include an exclusion of a node that is included in the input graph data set. For example, in a graph data set including edges that represent travel of individuals in a region, the nodes can represent points of interest, and the graph neural network can exclude an existing node that no longer represents a point of interest. The node-level predictions can include a classification of a node that is included in the input graph data set, or of a newly discovered node that was not included in the input graph data set (e.g., a classification of the node as being of a node type selected from a set of node types, as being associated with one or more labels of a classification label set, and/or as belonging to zero or more subgraphs of the graph data set). For example, in a graph data set representing locations within a geographic region, the graph neural network can generate a prediction of a classification of a location of interest as one or more particular types of locations of interest (e.g., a source of food, a source of fuel, a lodging location, and/or a tourist destination). The node-level predictions can include an identification of a node from among the nodes of the input graph data set based on various features, or of a newly discovered node. For example, in a graph data set representing a social network and including nodes that represent people, the graph neural network can identify a particular node that corresponds to a particular person, such as an influential person of the social network. The node-level predictions can include a determination and/or updating of one or more node properties of one or more existing and/or newly discovered nodes, such as a prediction of a demographic feature, opinion, or interest of a node representing a person in a social network.

As another example, graph neural networks can generate output that represents edge-level predictions that relate to one or more edges of an input graph data set. The edge-level predictions can include a discovery of a new edge that was not included in the input graph data set. For example, in a graph data set representing a social network that includes nodes that represent people, a graph neural network can output a prediction (e.g., a recommendation) of a relationship between two nodes that correspond to two people in a small social circle of highly interconnected people. The node-level predictions can include an exclusion of a node that is included in the input graph data set. For example, in a graph data set representing a social network that includes nodes that represent people, a graph neural network can output a prediction of a no-longer-existing edge that corresponds to a relationship that no longer exists (e.g., a lost connection based on a splitting of a social circle). The edge-level predictions can include a classification of an edge that is included in the input graph data set, or of a newly discovered edge that was not included in the input graph data set (e.g., a classification of an edge as being a of an edge type selected from a set of edge types, as being associated with one or more labels of a classification label set, and/or as belonging to zero or more subgraphs of the graph data set). For example, in a graph data set representing a social network, a graph neural network can generate a predicted classification of an edge as representing a relationship between two people as of one or more relationship types (e.g., a familial relationship, a friendship, or a professional relationship). The edge-level predictions can include an identification of an edge from among the edges of the input graph data set based on various features, or of a newly discovered edge. For example, in a graph data set representing a social network and including edges that represent relationships, the graph neural network can identify a particular edge that corresponds to a potential relationship to be recommended to the associated people, such as two people of the social network who are not yet connected but who share common personal or professional interests. The edge-level predictions can include a determination and/or updating of one or more edge properties of one or more existing and/or newly discovered edges, such as a prediction of a demographic feature, opinion, or interest that serves as the basis for a relationship between two people of the social network.

As another example, graph neural networks can generate output that represents graph-level predictions that relate to one or more graph properties of the input graph data set. The graph-level predictions can include a discovery of a new graph property that was not associated with the input graph data set. For example, in a graph data set representing a social network that includes nodes that represent people and edges that represent relationships, a graph neural network can output a prediction of a demographic trait, opinion, or interest that is common or popular among the people of the social network, or a relationship behavior that is exhibited in the relationships among the people of the social network. The graph-level predictions can include an exclusion of a graph property that was associated with the input graph data set. For example, in a graph data set representing a social network that includes a graph property based on a shared interest, a graph neural network can output a prediction that the interest no longer appears to be common and/or popular among the people of the social network, or of a relationship behavior that is no longer exhibited among the relationships of the people of the social network. The graph-level predictions can include a classification of the input graph data set (e.g., a classification of the graph data set, or at least a portion thereof, as being associated with one or more labels of a classification label set). For example, in a graph data set representing a social network, a graph neural network can generate a predicted classification of the graph as representing a familial social network, a friendship social network, and/or a professional social network. The graph-level predictions can include an identification of one or more subgraphs of the graph based on common features of the nodes and/or edges included in the subgraph. For example, in a graph data set representing a social network, the graph neural network can subgraphs that correspond to various social circles of highly interconnected people. The graph-level predictions can include a determination and/or updating of one or more graph properties of the graph, such as an updating of a frequency of communication and/or a strength of relationships among the people of a social network.

As another example, graph neural networks can perform graph-to-graph translation by receiving an input graph data set and generating output that represents a different graph data set. For example, a graph neural network can receive an input graph data set and can generate an output graph data set that includes one or more newly discovered nodes and/or edges; an exclusion of one or more nodes and/or edges; a classification of one or more nodes and/or edges; an identification of one or more nodes and/or edges; and/or an update of one or more node properties, edge properties, and/or graph properties. A graph neural network can receive an input graph data set and can generate an output graph data set that shares various similarities with the input graph data set. For example, a graph neural network can receive, as input, a first graph representing a first geographic region (e.g., a real geographic region) and can generate, as output, a first graph representing a different geographic region (e.g., a fictitious geographic region) that shares similarities with the first graph and that has some dissimilarities with respect to the first graph. A graph neural network can receive, as input, an input graph data set and can generate, as output, a subgraph of the input graph data set. A graph neural network can receive, as input, an input graph data set and can generate, as output, an expanded graph including a first subgraph corresponding to the input graph data set and a second subgraph that is newly generated. A graph neural network can receive, as input, a first graph that corresponds to a first time and can generate, as output, a second graph that corresponds to a different time than the first time. For example, the graph neural network can receive, as input, a graph data set that corresponds to a state of a geographic region at a current time, and can generate, as output, a graph data set that predicts the state of the geographic region at a past time or a future time.

As another example, graph neural networks can generate graphs from non-graph input data. For example, a graph neural network can receive, as input, locations of travelers within a geographic region over a period of time, and can generate, as output, graph data that includes one or more nodes that represent points of interest among the travelers and edges that represent paths between the points of interest (e.g., roads that connect the points of interest). As another example, a graph neural network can receive, as input, a description of a graph (e.g., a natural-language description of a geographic location) and can generate, as output, graph data that corresponds to the description of the graph (e.g., a graph of a region that includes one or more nodes representing locations and one or more edges representing roads that interconnect the locations). The graph neural network may receive both graph data and non-graph data (e.g., a graph representing a social network and an indication of a particular person in the social network) and can generate, as output, graph data based on the input (e.g., a subgraph of the people who consider the identified person to be influential).

As another example, graph neural networks can receive an input graph data set and can generate, as output, non-graph data. For example, a graph neural network can receive, as input, a graph representing a social network including nodes that represent people and edges that represent relationships, and can generate, as output, one or more metrics of the social network (e.g., an average number of connections among the people of the social network, an identification of a person of high influence within the social network, or a description of a relationship behavior that commonly occurs within the social network). As another example, a graph neural network can receive, as input, a graph representing a geographic region including nodes that represent locations and edges that represent roads connecting the locations, and can generate, as output, one or more predictions and/or measurements of traffic within the geographic region. The graph neural network may receive both graph data and non-graph data (e.g., a graph representing a social network and an indication of a particular person in the social network) and can generate, as output, non-graph data based on the input (e.g., a summary and/or prediction of the social behaviors of the identified person). For example, a graph neural network that evaluates traffic patterns within a geographic region may process, and optionally output, both an output graph data set that includes nodes that represent cities and edges that represent roads interconnecting the cities, and also non-graph output data representing predictions and/or inferences of traffic and/or weather features within the geographic region (e.g., traffic volume estimates and current or forecasted weather conditions that affect the traffic patterns).

As another example, some graph neural networks may be configured to determine, and optionally output, an indication of zero or more cycles occurring among the nodes and/or edges of an input graph data set. For example, for a directed and/or undirected input graph data set, a graph neural network may determine, and optionally output, an indication that a particular cycle exists within the input graph data set and includes a particular subset of nodes and/or edges. Alternatively, for a directed and/or undirected graph data set, a graph neural network may determine, and optionally output, an indication that the graph is acyclic and does not include any cycles. A graph neural network may be configured to determine, and optionally output, an output graph data set that includes an indication of zero or more cycles.

As another example, graph neural networks can receive an input graph data set and can generate, as output, an interpretation and/or explanation of the input graph data set. For example, a graph neural network can receive, as input, a graph representing a collection of devices, including nodes that respectively represent a device and edges that respectively represent an instance of communication and/or interaction among two or more devices. The graph neural network can generate, as output, an interpretation and/or explanation of the communications and/or interactions represented in the graph, such as an explanation of a set of interactions as being part of a collective and/or collaborative effort among the two or more devices and/or a related series of interactions that are associated with a particular activity. The explanation and/or interpretation may include, for example, a classification of one or more nodes, edges, patterns of activity, and/or the graph; a natural-language summary or narrative explanation of one or more nodes, edges, patterns of activity, and/or the graph; a data set that characterizes one or more nodes, edges, patterns of activity, and/or the graph; and/or a presentation (e.g., a static or motion visualization) of one or more nodes, edges, patterns of activity, and/or the graph. As one such example, a graph neural network may identify, within an input graph data set, one or more subgraphs (e.g., one or more clusters of related nodes and/or edges), and may output an interpretation and/or explanation of the subgraph (e.g., a description of the set of features that characterize the subgraph or cluster). As another example, a graph neural network may generate a visualization of a subgraph of an input graph data set, wherein the visualization depicts, highlights, and/or illustrates a structure and/or an anomalous feature of the subgraph. Some such graph neural networks may be configured to generate interpretations and/or explanations of any input graph data set, e.g., based on an identification of features of an input data set that inform such interpretations and/or explanations, such as clusters, outliers, or determinations of apparent structure and/or data relationships. Other such graph neural networks may be configured to generate domain-specific interpretations and/or explanations of domain-specific graph data sets. For example, a graph neural network may be configured to analyze a graph data set representing a social network identify both a subset of the social network corresponding to an influential cluster of people of the social network and also an interpretation and/or explanation of why this cluster of people appears to be influential within the social network. Graph neural networks can generate interpretations and/or explanations using a variety of techniques, including “white-box” analysis techniques that can be applied to various properties of graph data sets and components thereof. Examples of graph neural networks that include instance-level explanations based on gradients and/or features include, without limitation, Guided BP, class activation mapping (CAM), and GradCAM. Examples of graph neural networks that include instance-level explanations based on perturbations include, without limitation, GNNExplainer, PGExplainer, ZORRO, and Graphmask. Examples of graph neural networks that include instance-level explanations based on decomposition include, without limitation, layer-wise relevance propagation (LRP), Excitation BP, and GNN LRP. Examples of graph neural networks that include instance-level explanations based on surrogate analysis include, without limitation, GraphLIME, RelEX, and PGMExplainer. Examples of graph neural networks that include model-level explanations include XGNN. Further explanation and/or examples of various interpretable and/or explainable features of graph data sets or components thereof that may be generated by graph neural networks are presented elsewhere in this disclosure and/or will be known to or appreciated by persons skilled in the art.

### Graph Neural Networks—Architectures and Frameworks

Graph neural networks may be designed and/or organized according to various architectures. For example, a multilayer graph neural network may include a number of layers, each layer including a number of neurons. In each layer of the graph neural network, the neurons may be configured to receive, as input, at least a portion of an input data set (e.g., an input graph data set) and/or at least a portion of an output of at least one neuron of one or more layers of the graph neural network. Additionally, in each layer of the graph neural network, the neurons may be configured to generate, as output, at least a portion of an output data set of the graph neural network (e.g., an output graph data set of graph neural network) and/or at least a portion of an input to at least one neuron of one or more layers of the graph neural network.

In some graph neural networks, an architecture of the graph neural network is based on the input to the graph neural network. For example, a fixed-size graph of N nodes and E edges interconnecting the nodes may be received and processed by a graph neural network that includes an input layer featuring N neurons respectively configured to receive input from one of the N nodes and/or E neurons respectively configured to receive input from one of the E edges. A graph including an adjacency list having a maximum of E edges may be received and processed by a graph neural network that includes an input layer featuring E neurons respectively configured to receive and process one of the E edges represented in the adjacency list. A graph including two subgraphs may be received and processed by a graph neural network that includes an input layer featuring a first set of neurons that are configured to process the nodes and/or edges of the first subgraph and a second set of neurons that are configured to process the nodes and/or edges of the second subgraph. In some graph neural networks, an architecture of the graph neural network may be based on non-graph input data that is received and processed by the graph neural network. For example, a graph neural network may be configured to receive, as input, a description of a graph (e.g., a number of nodes and/or edges and one or more properties of the graph). The graph neural network may be further configured to generate a graph corresponding to the description, and to process and optionally output the graph according to various graph neural network processing techniques.

In some graph neural networks, an architecture of the graph neural network is based on an output of the graph neural network. For example, a graph neural network may be configured to determine, and optionally output, a fixed-size output graph data set including N nodes and E edges. The graph neural network may therefore include an output layer featuring N neurons respectively configured to generate output corresponding to one of the N nodes and/or E neurons respectively configured to generate output corresponding to one of the E edges. A graph neural network may be configured to determine, and optionally output, an adjacency list having a maximum of E edges. The graph neural network may therefore include an output layer featuring E neurons that respectively generate output corresponding to one of the E edges represented in the adjacency list. A graph neural network may be configured to determine, and optionally output, an output graph data set including two subgraphs. The graph neural network may therefore include an output layer featuring a first set of neurons that are configured to generate output corresponding to the nodes and/or edges of the first subgraph and a second set of neurons that are configured to process the nodes and/or edges of the second subgraph. In some graph neural networks, an architecture of the graph neural network may be based on non-graph output data that is determined, and optionally output, by the graph neural network. For example, a graph neural network may be configured to determine, and optionally output, a description of an input graph data set and/or an output graph data set (e.g., a number of nodes and/or edges and one or more properties of the input graph data set and/or the output graph data set), according to various graph neural network processing techniques.

In some graph neural networks, an architecture of the graph neural network may be based on a directionality of one or more edges included in an input data set and/or an output data set. For example, an input graph data set including a undirected edge that connects a first node N1 and a second node N2 may be received and processed by a graph neural network including a first neuron NN1 and a second neuron NN2 that are bidirectionally connected to one another, such that message passing can occur from the first node NN1 to the second node NN 2 and, concurrently or consecutively, from the second node NN2 to the first node NN1. An input graph data set including a unidirectional edge that connects a first node N1 to a second node N2 may be received and processed by a graph neural network including a first neuron NN1 (e.g., a neuron in a first layer of a feed-forward graph neural network) that is unidirectionally connected to a second neuron NN2 (e.g., a neuron in a second layer of a feed-forward graph neural network), such that message passing can occur from the first node NN1 to the second node NN 2 but not from the second node NN2 to the first node NN1. An input graph data set including an edge that connects three or more nodes may be received and processed by a graph neural network in which three or more nodes are correspondingly connected.

Some graph neural networks may be configured to receive and process an input graph data set including a homogeneous set of nodes and/or a homogeneous set of edges. For example, a first neuron of the graph neural network that corresponds to a first node and/or edge of the input graph data set may include a same or similar number of inputs, a same or similar activation function, and/or a same or similar number of outputs as a second neuron of the graph neural network that corresponds to a second node and/or edge of the input graph data set.

Some graph neural networks may be configured to receive and process an input graph data set including a heterogeneous set of nodes and/or a heterogeneous set of edges. For example, different nodes of an input graph data set may be associated with different labels that respectively indicate different classifications of the nodes, and/or different edges of the input graph data set may be associated with different labels that respectively indicate different classifications of the edges. An architecture of the graph neural network may exhibit variations corresponding to the heterogeneity of the nodes and/or edges. For example, a first neuron of the graph neural network that corresponds to a first node and/or edge of the input graph data set that is associated with a first label or classification may include a different number of inputs, a different activation function, and/or a different number of outputs as a second neuron of the graph neural network that corresponds to a second node and/or edge of the input graph data set that is associated with a second label or classification. As another example, a graph neural network may include a first layer that receives and processes, as input, a first portion of an input data set that includes a first subset of neurons and/or edges that are associated with a first label or classification, and a second layer that receives and processes, as input, a second portion of an input data set that includes a second subset of neurons and/or edges that are associated with a second label or classification. The first layer and the second layer may be processed concurrently or consecutively. The first layer and the second layer may be processed independently (e.g., each layer providing a different portion of an output graph data set). Alternatively, the first layer and the second layer may be processed together (e.g., an output of the first layer may be additionally provided as input to the second layer, and/or an output of the second layer may be additionally provided as input to the first layer).

Some graph neural networks may include an architecture that is based on one or more node properties of one or more nodes of an input graph data set, one or more edge properties of one or more edges of the input graph data set, and/or one or more graph properties of the input graph data set. As an example, in some input graph data sets, one or more nodes may include a node property indicating a weight of the node (e.g., an indication of a centrality and/or betweenness of a node among at least a portion of the nodes of the input graph data set). The graph neural network may include a neuron that corresponds to the node, wherein one or more weights of synapses that connect the neuron to other neurons of the graph neural network is based on the weight of the node. As another example, in some input graph data sets, one or more edges may include an edge property indicating a weight of the edge (e.g., an indication of a significance and/or priority of a relationship among two or more nodes of the input graph data set). The graph neural network may include two or more nodes that are connected by a synapse, wherein a weight of the synapse connecting the two or more nodes is based on a weight of an edge of the input graph data set. Examples of node-based graph neural networks include, without limitation, GraphSAGE, PinSAGE, and VR-GCN. Examples of layer-based graph neural networks include, without limitation, FastGCN and LADIES. Examples of subgraph-based graph neural networks include, without limitation, ClusterGCN and GraphSAINT.

Some graph neural networks may be configured to receive and process fixed input graph data sets, wherein a number and arrangement of nodes and edges of an input data set that is received and processed by the graph neural network does not vary for different instances of processing the input data set. The architecture of such graph neural networks may be configured based on the invariance of the input graph data set. For example, the graph neural network may feature a fixed number and/or arrangement of neurons and/or layers, wherein the fixed architecture of the graph neural network corresponds to the fixed nature of the input graph data set.

Some graph neural networks may be configured to receive and process dynamic input graph data sets, wherein a number and arrangement of nodes and edges of an input data set that is received and processed by the graph neural network during a first instance of processing can differ from a number and arrangement of nodes and edges of an input data set that is received and processed by the graph neural network during a second instance of processing. As an example, a graph neural network may be configured to perform node and/or edge discovery of an input graph data set and to generate, as output, an output graph data set that includes at least one more node and/or at least one more edge than the input graph data set. Further, the graph neural network may be configured to receive the output graph data set from a first processing as input for a second processing, wherein a number of nodes and/or edges received as input during the second processing is greater than a corresponding number of nodes and/or edges received as input during the first processing. In such cases, an architecture of such graph neural networks may be fixed, but may be configured to receive and process a variety of different input graph data sets (e.g., input graph data sets with a variable number of nodes and/or connections). For example, the graph neural network may include an input layer featuring N input neurons, each corresponding to a node of an input graph data set. Such a graph neural network may be configured to use the fixed architecture to receive and process input graph data sets featuring a variable number of nodes up to, but not exceeding, N. For example, in order to receive and process an input graph data set featuring fewer than N nodes, the graph neural network may activate only a number of input neurons of the input layer that correspond to the number of nodes in the input graph data set, and to deactivate remaining neurons of the input layer that do not correspond to a node of the input graph data set (e.g., refraining from processing the remaining neurons, and/or processing the neurons but zeroing the weights of the synapses that connect the neurons to other neurons of the graph neural network). As another example, the graph neural network may perform a first processing of a first input graph data set including N nodes, and, accordingly, may deactivate one or more neurons of the input layer. The graph neural network may then perform a second processing of a second input graph data set including more than N nodes (e.g., an output of the first processing may include an output graph data set that includes one or more newly discovered nodes). During the second processing, the graph neural network may activate one or more of the previously deactivated neurons of the input layer in order to receive and process input from the additional nodes of the second input graph data set. For example, the graph neural network may enable or reenable the processing of one or more neurons of the input layer, and/or may reset (e.g., restore and/or initialize) the weights of one or more synapses that connect one or more neurons of the input layer to other neurons of the graph neural network. In some cases, an architecture of such graph neural networks may dynamic, and may change in correspondence with a dynamic nature of the input graph data set. For example, a graph neural network may include an input layer with a variable number of neurons, and may select, adapt, and/or change the number of neurons in the input layer based on a dynamic property of an input graph data set (e.g., a number of nodes and/or edges in the input graph data set). Such graph neural networks may generate new neurons of the input layer (e.g., initializing and/or selecting weights of the synapses of the new neurons, such as copying the weights from the synapses of other neurons of the input layer) based on a larger number of nodes and/or edges of an input graph data set to be received and processed as input. Alternatively or additionally, such graph neural networks may be configured to eliminate and/or merge neurons of the input layer (e.g., initializing and/or selecting weights of the new neurons) based on a smaller number of nodes and/or edges of an input graph data set to be received and processed as input.

In some graph neural networks, an architecture of the neural network may be selected and/or adapted based on a topology of one or more input graph data sets and/or output graph data sets. For example, a bipartite input graph data set may include two more subgraphs, and a graph neural network may include two or more distinct subsets of neurons that are respectively configured to receive and process data associated with the nodes and/or edges included in one of the subgraphs. As another example, a multigraph input graph data set may include a plurality of edges connecting two or more nodes. For example, a graph representing a social network may include various types of edges that represent various types of relationships (e.g., familial relationships, friendships, and/or professional relationships), and two or more nodes may be connected by a plurality of edges (e.g., a first edge indicating a friendship among the two or more nodes and a second edge indicating a professional relationship among the two or more nodes). An architecture of the graph neural network may correspond to the multigraph nature of the input graph data set. For example, a graph neural network may include two or more distinct subsets of neurons that are respectively configured to receive and process data associated with a subset of edges of the input graph data set that are of a particular edge type (e.g., a first subset of neurons that is configured to receive and process nodes connected by edges that represent friendships, and a second subset of neurons that is configured to receive and process nodes connected by edges representing professional relationships). As yet another example, an input hypergraph data set may include one or more hyperedges that interconnect three or more nodes. An architecture of a graph neural network that is configured to receive and process the input hypergraph data set may include one or more neurons with synapses that interconnect to two or more other neurons in correspondence with one or more hyperedges of the input hypergraph data set.

As another example, an architecture of some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. Examples of graph neural networks that include one or more direct pooling layers include, without limitation, SimplePooling, Set2Set, and SortPooling. Examples of graph neural networks that include one or more hierarchical pooling layers include, without limitation, Coarsening, ECC, DiffPool, TopK, gPool, E1 genpooling, and SAGPool.

As another example, some graph neural networks (e.g., graph convolution networks) include one or more convolutional layers, each of which performs a convolution operation to an output of neurons of a preceding layer of the graph neural network.

As another example, an architecture of some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells. In some graph neural networks, these features may be further adapted to accommodate graph processing, such as gated graph neural networks (GGRUs), tree LSTM networks, graph LSTM networks, and/or sentence LSTM networks.

As another example, an architecture of some graph neural networks includes one or more recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input.

As another example, an architecture of some graph neural networks includes two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In some cases, an architecture of a graph neural network may be designed by a user. For example, a user may choose one or more hyperparameters of a graph neural network (e.g., a number of layers, a number of neurons in each layer, an activation function used by at least some neurons, and the like) in order to process an input graph data set. In some cases, the selected one or more hyperparameters may be based on domain-specific knowledge, e.g., a specific data type, internal organization or structure, and/or task associated with an input graph data set.

Alternatively or additionally, in some cases, an architecture of a graph neural network may be selected by an automated process. For example, a hyperparameter search process may determine one or more hyperparameters of a graph neural network based on an analysis of an input graph data set to be received and processed by the graph neural network and/or an analysis of an output graph data set to be generated and provided as output by the graph neural network. The hyperparameter search process may determine various combinations of hyperparameters for variations of the graph neural network (e.g., graph neural networks with different numbers of layers, different numbers of neurons within each layer, graph neural networks including neurons with different activation functions, and/or graph neural networks with different sets of synapses interconnecting the neurons of various layers). The hyperparameter search process may process an input graph data set (e.g., a training input graph data set) using different graph neural networks that correspond to different sets of hyperparameters. The hyperparameter search process may compare the output of the different graph neural networks (e.g., determining a performance measurement for the output of each graph neural network, and comparing the performance measurements of the different graph neural networks) in order to determine and select a graph neural network that generates desirable output (e.g., output that most closely corresponds to a target output associated with the training input graph data set). The hyperparameter search process may discard the other graph neural networks and may use the selected graph neural network to process input graph data sets. In some cases, the hyperparameter search process may iteratively generate and test refined combinations of hyperparameters. For example, after selecting a graph neural network in a first hyperparameter search processing the hyperparameter search process may perform a second hyperparameter search processing by generating additional graph neural networks based on combinations of hyperparameters that are closer to the hyperparameters of the selected graph neural network, and evaluating the output of the additional graph neural networks. In some cases, the hyperparameter search process may perform a grid search over the set of valid hyperparameter combinations. Iterative refinement of the hyperparameters may enable the hyperparameter search process to determine an architecture of a graph neural network that is well-tuned to a particular task (e.g., an architecture of a graph neural network that demonstrates consistently high performance on input graph data sets within a particular domain of data and/or a particular task). In some cases, a hyperparameter search process may communicate with a user to determine combinations of hyperparameters to evaluate and/or to select for the graph neural network. For example, the hyperparameter search process may present, to a user, a result of a first hyperparameter evaluation (e.g., an output of a graph neural network that was selected through a first hyperparameter search processing). Based on an evaluation of the output by the user, the hyperparameter search process may perform a second or further hyperparameter search processing (e.g., choosing a small refinement of the hyperparameters based on a positive response of the user to the output of a selected graph neural network, and/or choosing a larger refinement of the hyperparameters based on a negative response of the user to the output of the selected graph neural network).

As another example, some graph neural networks include architectures based on graph convolutional networks (GCNs), wherein a convolutional layer applies a convolution operation to outputs of one or more filters of a previous filter layer of the graph convolutional network. Graph convolutional networks may include spectral convolutional networks that are configured to receive, as input, a spectral representation of an input graph data set, and to apply processing (including one or more convolutional operations) to various spectral components of the spectral representation of the input graph data set. Examples of spectral convolutional networks include, without limitation ChebNet and diversified graph convolutional networks (DGCNs). As another example, some graph convolutional networks include architectures based on spatial convolutional networks (SCNs) that are configured to receive, as input, spatial representations of an input graph data set (e.g., spatial information that represents one or more neighborhoods of nodes and/or edges of the input graph data set), and to apply processing (including one or more convolutional operations) to various spatial components of the spatial representation of the input graph data set. Examples of spatial convolutional networks include, without limitation, spatial convolutional neural networks (SCNNs), spatial and/or spatial-temporal GraphSAGE networks, and some deep convolutional neural networks (DCNNs).

Graph neural networks can be generated by a variety of machine learning platforms, frameworks, and/or tools, including, without limitation, PyTorch Geometroc, Deep Graph Library, TensorFlow GNN, Graph Nets, Spektral, and Jraph. Frameworks for graph convolutional networks include, without limitation, message passing neural networks (MPNNs), non-local neural networks (NLNNs), mixture model neural networks (MoNet), and Graph Networks (GN).

Further explanation and/or examples of various architectures of graph neural networks, including the design and implementation of designs and architectures of such graph neural networks, are presented elsewhere in this disclosure and/or will be known to or appreciated by persons skilled in the art.

### Graph Neural Networks—Training and Performance Evaluation

Like other types of neural networks, graph neural networks are typically generated with arbitrarily selected parameters (e.g., synaptic weights that are initially set to randomized values). Also, like other types of neural networks, an initialized graph neural network to evaluate input graph data sets through training, in which the parameters of the graph neural network are adjusted to promote desirable processing that produces expected and/or desirable outputs.

The training of graph neural networks may involve one or more training data sets. For graph neural networks that receive and process input graph data sets, the training data may include one or more training input graph data sets. Alternatively or additionally, for graph neural networks that receive and process input non-graph data, the training data may include one or more sets of training non-graph data.

The training data for a graph neural network may be based on authentic input data that was previously collected and/or analyzed, or that was collected and analyzed for the purpose of training the graph neural network. For example, in order to process graphs that represent an industrial environment, the training data may include sensor data that was previously and/or is currently received from one or more sensors associated with the industrial environment. Alternatively or additionally, the training data may include partially and/or fully synthetic data. For example, a first portion of training data may include data derived from an analysis of authentic data; authentic data that has been supplemented with synthetic data (e.g., an image of a real-world scene including an inserted artificial object); authentic data that has been modified by a suer (e.g., an image of a real-world scene that has been modified by a user); and/or data generated by one or more algorithms (e.g., other machine learning models and/or simulations of real-world processes). In some cases, the training data set may include both authentic training data and synthetic training data that is based on the authentic training data (e.g., both a real-world image and a modified version of the real-world image that has been adjusted in brightness, contrast, size, resolution, scale, shape, aspect ratio, color depth, or the like).

The training data for a graph neural network may be limited to a selected data domain. For example, training data for a graph neural network that analyzes social networks may include one or more samples of individuals from within one or more selected social networks. In other cases, the training data for a graph neural network may be generated from a variety of data domains. For example, training data for a graph neural network that analyzes geographic data may include one or more samples of locations of interest and interconnecting pathways from natural outdoor geographic regions (e.g., forests), artificial outdoor geographic regions (e.g., road networks), indoor geographic regions (e.g., caves or shopping malls), historic geographic regions (e.g., maps from ancestral eras and/or civilizations), and/or synthetic geographic regions (e.g., geographic maps from videogames).

The training data for a graph neural network may be wholly or partially unlabeled. For example, the training data set for an industrial environment may include sensor measurements collected from the industrial environment, but may not include any data indicating an analysis, classification, metadata, interpolations, extrapolations, interpretation, explanation, and/or user reaction associated with the sensor measurements. Alternatively or additionally, the training data for a graph neural network may be wholly or partially labeled. For example, the training data set for an industrial environment may include sensor measurements collected from the industrial environment, and one or more subsets of sensor measurements may be associated with one or more analyses, classification labels, metadata, interpolations, extrapolations, determinations, interpretations, explanations, and/or user reactions associated with the subset of sensor measurements. Training data may associate labels, metadata, or the like with one or more nodes and/or node properties of a training input graph data set; one or more edges and/or edge properties of a training input graph data set; one or more graph properties of the training input graph data set; and/or one or more portions of non-graph data of a training input data set. In some cases, the labels, data, metadata, or the like associated with at least a portion of a training input data set are selected by one or more users (e.g., a human classification of at least a portion of the training data set). In some cases, the labels, data, metadata, or the like associated with at least a portion of a training input data set are selected by another algorithm (e.g., a simulation or another machine learning model). In some cases, the labels, data, metadata, or the like associated with at least a portion of a training input data set are selected by a cooperation of a human and an algorithm (e.g., a determination by a simulation or another machine learning model that is verified by a reviewing human user).

Graph neural networks can be trained based on one or more training data sets and one or more learning techniques. As an example, some graph neural networks are trained through an unsupervised learning technique. For example, a training input data set may not include any labels, data, metadata, or the like associated with various portions of the training input data set. The graph neural network may be trained to identify patterns arising within the training input data sets. For example, a training input data set may include data that indicates one or more anomalies (e.g., nodes and/or edges that appear to represent outliers in a data distribution of the nodes and/or edges of the graph) and/or distinctive patterns or structures arising in the data (e.g., cycles arising in a directed and/or undirected graph). The graph neural network may be trained to detect such anomalies, patterns, and/or structure in the training input data sets. The results of unsupervised learning of a graph neural network may be evaluated based on an evaluation of the output of the graph neural network (e.g., a confusion matrix that includes determinations of true positive determinations, true negative determinations, false positive determinations, and/or false negative determinations) and/or performance scores (e.g., an F1 performance score based on ratios of true positives, false positives, true negatives, and false negatives). The weights of various parameters of the graph neural network can be automatically adjusted, corrected, refined, or the like, such that subsequent processing of the same input training data set and/or other input training data sets generates improved evaluations and/or performance scores.

As another example, some graph neural networks are trained through a supervised learning technique. For example, a training input data set may associate respective portions (e.g., respective training data samples, such as different training input graph data sets) with one or more labeled outputs that are expected and/or desirable of the trained graph neural network. As an example, a graph neural network may be trained to output a classification of a training input graph data set and/or one or more nodes and/or edges thereof. During a supervised learning process, the training input graph data set may be provided as input to the graph neural network and processed by the graph neural network to generate a predicted classification of a training input graph data set and/or one or more nodes and/or edges thereof. The predicted classifications may be compared with one or more labeled outputs associated with the training input graph data set (e.g., one or more labels associated with an expected and/or desirable classification of the training input graph data set and/or one or more nodes and/or edges thereof). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more accurate predictions of one or more labels associated with an expected and/or desirable classification of the training input graph data set and/or one or more nodes and/or edges thereof). As another example, a graph neural network may be trained to generate, as output, an output graph data set that is based on a processing of a training input graph data set. During a supervised learning process, the training input graph data set may be provided as input to the graph neural network and processed by the graph neural network to generate an output graph data set. The output graph data set generated by the graph neural network may be compared with one or more expected and/or desirable output graph data sets corresponding to the training input graph data set (e.g., one or more output graph data sets that are expected and/or desired as output when the graph neural network processes the training input graph data set). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more desirable and/or expected output graph data sets).

As another example, some graph neural networks are trained through a blended training process that includes both supervised and unsupervised learning. For example, a blended training process may evaluate the performance of a graph neural network in training based on both a comparison of predicted outputs of the graph neural network to expected and/or desirable outputs corresponding to an input training data set, and based on one or more automatically determined performance metrics, such as a confusion matrix and/or F1 scores. Some blended training processes may include a round of supervised learning following by a round of unsupervised learning, or may perform rounds of training that include both supervised and unsupervised learning techniques (e.g., optionally with different weights and/or performance thresholds associated with the evaluation of the graph neural network and the updating of the parameters).

As another example, some graph neural networks are trained through a semi-supervised learning process. For example, a training data set may include a large number of samples, of which only a small number of samples are labeled (e.g., associated with expected and/or desirable outputs) and a large remainder of the samples are unlabeled (e.g., not associated with expected and/or desirable outputs). The graph neural network may be trained based on the labeled and/or unlabeled training data, and a performance of the graph neural network may be evaluated based on the labels and/or other metrics. In particular, some unlabeled portions of the input training data may be identified as being incorrectly evaluated by the graph neural network (e.g., the graph neural network may generate incorrect outputs such as predictions or classifications, incorrect and/or malformed output graph data sets, or the like). At least a portion of such unlabeled portions of the input training data (e.g., training data samples that appear to be difficult to classify correctly and/or with high confidence) may be submitted to a human reviewer, and the semi-supervised learning process may receive, from the human reviewer, one or more labels that correspond to an expected and/or desirable output of the graph neural network for such portions of the input training data. Training or retraining of the graph neural network may involve the newly labeled portions of the input training data, as well as other portions of the input training data. Semi-supervised learning may enable graph neural networks to be trained based on a smaller degree of human involvement (e.g., a smaller number of labels associated with portions of the input training data set by human reviewers), and may therefore improve a speed, cost, and/or performance of training the graph neural network.

A training of a graph neural network may occur in one or more epochs. For example, for each epoch, the graph neural network may be provided with input comprising each portion of a training data set, a performance of the graph neural network may be determined based on the output of the graph neural network for each portion of the training data set. Based on the determined performance, and one or more parameters of the graph neural network may be updated. For example, weights of the synapses between neurons of the graph neural network may be adjusted such that a performance of the graph neural network over each portion of the training data set. During the training of a graph neural network, various techniques may be used to evaluate the performance of the graph neural network. As a first example, outputs of the graph neural network (e.g., output graph data sets and/or predictions, such as classifications of the graph, one or more nodes, and/or one or more edges) may be compared with expected and/or desirable outputs. Differences between the outputs and the expected and/or desirable outputs may be used to determine an entropy and/or loss of the output of the graph neural network as compared with corresponding expected and/or desirable outputs. In some variations, the entropy or loss of the graph neural network determined during or after a current epoch may be compared with an entropy or loss of the graph neural network determined during or after a previous epoch to determine a differential and/or marginal entropy or loss. A negative differential and/or marginal entropy or loss may indicate that the training of the graph neural network is productive (e.g., the performance of the graph neural network improved in the current epoch as compared with a previous epoch). A zero or positive differential and/or marginal entropy or loss may indicate that the training of the graph neural network is unproductive (e.g., the performance of the graph neural network did not improve, or diminished, in the current epoch as compared with a previous epoch). Training of the graph neural network may therefore continue as long as the differential and/or marginal entropy or loss remains negative and, optionally, exceeds a threshold magnitude that indicates significant training progress.

As another example, outputs of the graph neural network (e.g., output graph data sets and/or predictions, such as classifications of the graph, one or more nodes, and/or one or more edges) may be classified as one of a true positive, a false positive, a true negative, or a false negative. The performance of the graph neural network may be evaluated as a confusion matrix, e.g., based on a calculation of the performance over the incidence of true positive, false positive, true negative and false negative outputs. In some cases, the calculation may be weighted based on a risk matrix that applies different weights to each classification of the output. For example, in a graph neural network that generates classifications of graphs that correspond to diagnoses of medical conditions, it may be determined false negatives (e.g., missed diagnoses) are very harmful or costly, while false positives (e.g., misdiagnoses that can be corrected by further evaluation) may be determined to be comparatively harmless. Accordingly, the performance of the graph neural network may be determined based on a weighted calculation over the confusion matrix that more severely penalizes the performance based on false negatives than false positives.

As another example, the training of a graph neural network may involve an improvement of an objective function that serves as a basis for measuring the performance of the graph neural network. For example, the objective function may include (without limitation) a loss minimization, an entropy minimization, a precision maximization, a recall maximization, an error minimization, or a consistency maximization. The objective function may include a comparison of the performance of the graph neural network over various distributions of the input data set (e.g., a minimax optimization, such as minimizing a maximum loss over any portion of the input data set, or a maximin optimization, such as maximizing a minimum loss over any portion of the input data set). In some training scenarios that involve reinforcement learning, the output of a graph neural network may include and/or may be interpreted as a policy, e.g., a set of responses of an agent based on respective conditions. The performance of the graph neural network may be based on various objective functions that evaluate various properties of the generated and/or interpreted policy. For example, in a q-learning reinforcement learning process, the objective function applied to the policy may include a maximization of an action value of each behavior that may be performed in response to various conditions.

As another example, the training of graph neural networks may occur concurrently with the hyperparameter search and/or selection. For example, a hyperparameter search process may initially identify a first set of combinations of hyperparameters of graph neural networks to be evaluated using a training data set. Based on each such combination of hyperparameters, a graph neural network may be generated and at least partially trained to determine its performance. Based on the evaluation of the outputs of the graph neural networks corresponding to respective combinations of hyperparameters, the hyperparameter search process may identify a candidate graph neural network with the highest performance. The hyperparameter search process may then generate a second set of combinations of hyperparameters based on the hyperparameters of the candidate graph neural network, and may further (at least partially) train and evaluate the performance of additional graph neural networks based on the second set of combinations of hyperparameters. A comparison of the performance of the additional graph neural networks may cause the hyperparameter search process to retain the candidate graph neural network or to choose a new candidate graph neural network from among the additional graph neural networks. The hyperparameter search process may continue until additional improvements in the performance of candidate graph neural networks are not achievable and/or are below a threshold performance improvement. In this selection process, a variety of performance metrics may be used. As previously discussed, the performance metrics may include an evaluation of the outputs of the graph neural networks (e.g., a loss or entropy, a differential or marginal loss or entropy, a confusion matrix, an F1 score, or the like). Alternatively or additionally, the performance metrics may include other features of the output, such as a consistency of the output of the graph neural network over the distribution of data in the training data set and/or a bias in the performance the output of the graph neural network for selected data distributions of the training data set, and/or a smoothness or oversmoothness of the graph nodes represented in the graph neural network. Alternatively or additionally, the performance metrics may include one or more measurements of computational resource expenditures to perform training and/or inference of input data sets with the graph neural network (e.g., CPU and/or GPU utilization, memory usage, training time and/or complexity, processing latency between receiving input and generating output, or the like). Aggregate performance measurements may be based on a variety of such considerations, and may enable a human designer and/or a hyperparameter search process to perform a selection of a graph neural network based on various performance tradeoffs (e.g., a preference for a first graph neural network that produces high-accuracy, high-consistency, and/or high-confidence results but that requires a large amount of computational resources, time, and/or cost, vs. a preference for a second graph neural network that produces reasonable-accuracy, reasonable-consistency, and/or reasonable-confidence results using a smaller amount of computational resources, time, and/or cost). For example, a measurement of computational resource utilization by a particular graph neural network may correspond to a numeric penalty in various measurement of the performance of the graph neural network (e.g., a loss, entropy, and/or objective function output).

In various forms of graph neural network training based on these and other learning techniques, various training methods can be used to update the parameters of a graph neural network in training and/or to evaluate the performance of a graph neural network in training. For example, optimizers that may be used during the training of graph neural networks may include (without limitation) linear regression; root mean squared propagation (RMSprop); stochastic gradient descent; adaptive stochastic gradient descent (Adagrad); adaptive stochastic gradient descent with adaptive learning (Adadelta); adaptive moment estimation (Adam); Nesterov accelerated adaptive moment estimation (Nadam); Nesterov accelerated gradient and momentum (NAG); Monte Carlo simulations involving various variance reduction techniques, such as control variates; or the like, including variations and/or combinations thereof. Training techniques for particular types of graph neural networks may include optimizers that are specialized for such particular types of graph neural networks (e.g., graph convolutional networks may be trained using a FastGCN optimizer and/or receptive field control (RFC) optimizers).

As further examples, graph neural network training may include a variety of techniques that are also applicable to non-graph machine learning models, including non-graph neural networks. As a first such example, training may occur in batches and/or mini-batches of the training data set, wherein the graph neural network evaluates a batch (e.g., plurality of input data sets) of an input training data set, and the parameters of the graph neural network are updated based on an aggregation of the evaluation of the outputs of the graph neural network for the batch of input data sets. In various training techniques, batches may be selected at random from the training input data set or may be selected in an organized manner, e.g., as various subsets that are representative of one or more data distributions of the training input data set. For example, if the graph neural network in training exhibits good performance over some data distributions of the training input data and poor performance over other data distributions of the training input data, the continued training of the graph neural network may focus on, prioritize, and/or overweight the training based on batches of training input data that reflect the data distributions associated with poor performance. In various training techniques, a batch size of batches of training input data sets may be fixed, or the batch size may vary based on a progress of the training of the graph neural network.

As another example, in various training techniques for graph neural networks, an entire set of training input data may be partitioned into a training data set that is used only to train the graph neural network and update its parameters; a validation data set that is used only to evaluate a prospective and/or in-training graph neural network; and/or a test data set that is used to only evaluate a final performance of the fully trained graph neural network. The partitioning of the training input data may be based on one or more ratios (e.g., a 90/5/5 partitioning of the training input data into a training data set, a validation data set, and a test data set, or a 98/1/1 partitioning of the training input data into a training data set, a validation data set, and a test data set). For example, during an epoch, the performance of the graph neural network may be evaluated based on various portions of the training data set, and the parameters of the graph neural network may be adjusted based on the determined performance. However, continued training and updating of the graph neural network based on the training data set may result in overfitting, e.g., “memoization” of correct outputs that correspond to various portions of the training data set. Due to such overfitting, the performance of the graph neural network in evaluating previously evaluated input data sets may improve, but performance of the graph neural network on previously unevaluated input data sets may decline. Instead, at the conclusion of an epoch, the performance of the graph neural network may instead be evaluated based on various portions of the validation data set, which is not otherwise used to update the parameters of the graph neural network. Evaluation of the performance of the graph neural network on previously unseen data can indicate that the performance of the graph neural network is genuinely improving (e.g., based on learned principles of data evaluation that apply consistently to both previously seen and previously unseen input data sets), resulting in a continuation of training. Alternatively, Evaluation of the performance of the graph neural network on previously unseen data can indicate that the performance of the graph neural network is resulting in overfitting to the training data set (e.g., based on “memoization” of correct outputs for previously seen input data sets that do not inform the correct evaluation of previously unseen input data sets), resulting in a conclusion of training. Such conclusion may be referred to as “early stopping” of training to reduce overfitting of the graph neural network to the training data set and to preserve the performance of the graph neural network on previously unsee input data sets.

As another example, various training techniques for graph neural networks may include one or more regularization techniques, in which the inputs to the graph neural network and/or the processing of the input are adjusted to reduce overfitting. As a first example, the training of a graph neural network may include a dropout regularization technique, in which some neurons of the graph neural network are disabled for some instances of processing input data sets. In various regularization techniques, neurons to be disabled are selected randomly (e.g., 5% of the neurons during each epoch) and/or can be selected in a sequence (e.g., a round-robin selection of deactivated neurons). The selected neurons may be disabled by refraining from processing the inputs of the neurons and setting the outputs of the selected neurons to zero, and/or by processing the selected neurons but temporarily setting the weights of the synapses of the neurons to zero. As a second example, the training of a graph neural network may include a dropnode and/or dropedge regularization technique, in which portions of an input graph data set that include some nodes and/or some edges of the input graph data set are disabled. In various regularization techniques, nodes and/or edges to be disabled for an instance of processing are selected randomly (e.g., 5% of the nodes and/or edges during each epoch) and/or can be selected in a sequence (e.g., a round-robin selection of deactivated nodes and/or edges). The selected nodes and/or edges may be disabled by refraining from processing portions of the input data set that correspond to the selected nodes and/or edges, and/or by deactivating neurons of an input layer of the graph neural network that are configured to receive input data from the selected nodes and/or edges. As a third example, the performance of a graph neural network may be subjected to various forms of regularization, including L1 (“lasso”) regularization and/or L2 (“ridge”) regularization. These and other forms of regularization may be used, alone or in combination, to reduce overfitting of a graph neural network to an input training data set. For example, regularization may reduce an overweighting of a subset of nodes, edges, and/or neurons in the processing of various input data sets (e.g., by reducing and/or penalizing neurons having synaptic weights with magnitudes that are disproportionately large compared to the synaptic weights of other neurons of the graph neural network).

As another example, various training techniques for graph neural networks may combine a graph neural network with one or more other machine learning models, including one or more other graph neural networks and/or one or more non-graph neural networks. For example, a bootstrap aggregation (“bagging”) training technique involves a determination of a decision tree as an ensemble of machine learning models based on different bootstrap samples of the training input data set. Each machine learning model, including one or more graph neural networks, may be trained based on a random subsample of the training input data set. For a particular input data set, many of the trained machine learning models of the ensemble, including one or more graph neural networks, may present poor or only adequate performance. However, one or a few of the trained machine learning models may generate high-performance output for the particular input data set and others like it (e.g., for input data sets that share one or more properties, such as a select graph property, a select node property, and/or a select edge property). Thus, for any particular input data set, an evaluation of the specific properties of the particular input data set may enable a selection among the available models of the ensemble that may be used to evaluate the particular input data set. That is, a machine learning model (e.g., a graph neural network) that is generally a poorly performing model on most input data sets may exhibit good performance over a small neighborhood of input data sets that includes the particular data set, and may therefore be selected to evaluate the particular data set. Alternatively or additionally, the bootstrap aggregation may involve an evaluation of an input data set by a plurality of machine learning models (optionally including one or more graph neural networks of the ensemble) and a combination of the outputs of the selected machine learning models. In such scenarios, it is possible the individual outputs of the individual machine learning models exhibit poor performance (e.g., incorrect and/or low-confidence classifications of an input data set), but a determination of a consensus over the outputs of the multiple machine learning models may exhibit high performance (e.g., accurate and/or high-confidence classifications of the input data set).

As another example, various training techniques for graph neural networks may include a boosting ensemble technique, in which an output of a first trained machine learning model (e.g., a first graph neural network) is evaluated by a second trained machine learning model (e.g., a second graph neural network) to predict an accuracy and/or confidence of the prediction of the first trained machine learning model. For example, a first trained graph neural network may be evaluated to determine that it generates accurate and/or high-confidence output for a first group of input data sets (e.g., input graph data sets that include a first graph property, a first node property, and/or a first edge property), but inaccurate and/or low-confidence output for a second group of input data sets (e.g., input graph data sets that include a second graph property, a second node property, and/or a second edge property). A particular input data set may initially be processed by the first trained graph neural network to determine a first output (e.g., an output graph neural network or a prediction, such as a classification). A second trained graph neural network may evaluate the input data set and/or the output of the first graph neural network to predict an accuracy and/or confidence of the first graph neural network over input data sets that resemble the particular input data set. If the second trained graph neural network predicts that the output of the first graph neural network is likely to be of high accuracy and/or confidence, then the second trained graph neural network may provide the output of the first trained graph neural network as its output. However, if the second trained graph neural network predicts that the output of the first graph neural network is likely to be of low accuracy and/or confidence, then the second trained graph neural network may adjust, correct, and/or discard the output of the first trained graph neural network, or preferentially select an output of a different machine learning model (e.g., a third trained graph neural network) to be provided as output instead of the output of the first trained graph neural network. In such scenarios, it is possible that the individual outputs of the individual machine learning models exhibit poor performance (e.g., incorrect and/or low-confidence classifications of an input data set), but the review and validation of the output of some machine learning models by other machine learning models may enable a determination of a consensus over the outputs of the multiple machine learning models that exhibits high performance (e.g., accurate and/or high-confidence classifications of the input data set).

As another example, following conclusion of training a graph neural network, the graph neural network may be deployed for use (e.g., transferred to one or more devices, deployed into a production environment, and/or connected to a source of production input data). The performance of the graph neural network over input data sets may continue to be evaluated and monitored to verify that the graph neural network continues to perform well over various inputs.

In some cases, the performance of the graph neural network may change between training and deployment. For example, a distribution of production input data processed by the graph neural network may differ from the distribution of training input data that was used to train the graph neural network. Alternatively or additionally, a distribution of production input data may change over time, e.g., between a time of deploying the graph neural network and a later time after such deployment. Such instances of changes in the performance of a fully trained and deployed graph neural network may be referred to as “drift.” In some such cases, “drift” may be reduced or eliminated by retraining or continuing training of the graph neural network, e.g., using additional training input data that corresponds to an actual or current distribution of the production input data. Alternatively or additionally, “drift” may be reduced or eliminated by training a substitute graph neural network to replace the initially deployed graph neural network. For example, the substitute graph neural network may include a different set of hyperparameters than the initially deployed graph neural network (e.g., additional layers and/or neurons to provide greater learning capacity; additional regularization techniques to reduce overfitting to the training data set; and/or the inclusion of specialized layers, such as pooling, filtering, memory, and/or attention layers). As another example, the initially deployed graph neural network may be added to an ensemble of other machine learning models, optionally including other graph neural networks, to generate improved outputs (e.g., higher-accuracy predictions) based on a consensus determined over the outputs of a number of machine learning models.

As another example, the training and/or use of graph neural networks may be susceptible to various forms of adversarial attack. For example, in an adversarial attack scenario, a particularly designed and/or selected input to a graph neural network (an “adversarial input,” such as an unusual, malformed, and/or anomalous) may cause the graph neural network to generate output that is incorrect, inconsistent with other outputs, and/or surprising. As an example, in a form of graph modification adversarial attack that may be referred to as node injection poisoning adversarial attack (NIPA), one or more nodes of an input graph data set are selected and/or altered to shift an output of the graph neural network based on the adversarial input (e.g., altering a classification and/or prediction of the input graph data set, or altering an output graph data set based on the adversarial input graph data set). As another example, in a form of graph modification adversarial attack that may be referred to as an edge perturbing adversarial attack (NIPA), one or more edges of an input graph data set are selected and/or altered to shift an output of the graph neural network based on the adversarial input (e.g., altering a classification and/or prediction of the input graph data set, or altering an output graph data set based on the adversarial input graph data set). As another example, in a training data injection attack, one or more portions of training input data on which a graph neural network is trained are designed and/or altered to alter the training of the graph neural network (e.g., a mislabeling of a particular training data input that causes the graph neural network to misclassify other inputs that correspond to the mislabeled training data input, and/or an injection of data samples into a training data set that alter a data distribution of the training data set upon which the graph neural network is trained). As another example, in a membership inference adversarial attack, properties and/or outputs of a graph data set are evaluated to identify properties of one or more training data inputs on which the graph data set was trained (e.g., an influential property of an input data set that causes the graph data set to select a particular classification for the any input data sets that include the property). As another example, in a property inference adversarial attack, properties and/or outputs of a graph data set are evaluated to identify general properties of training data inputs on which the graph data set was trained (e.g., a distribution of data included in the training data set, which may indicate particular distributions of input data over which the graph neural network was not trained, or over which the graph neural network was incompletely and/or incorrectly trained). As another example, in a model inversion adversarial attack, outputs of a graph neural network are examined to identify properties of corresponding input data sets that cause the graph neural network to generate such outputs.

Based on these and other forms of adversarial attack, the training and/or evaluation of a graph neural network may be adjusted to protect the graph neural network from such adversarial attack. For example, before an input to a graph neural network is processed, the input may be evaluated and/or classified (e.g., by another machine learning model, including another graph neural network) in order to determine whether the input is adversarial. If so, the graph neural network may refrain from processing the adversarial input, may process the adversarial input in more limited conditions (e.g., processing only a portion of the adversarial input, and/or replacing a malformed or anomalous portion of the adversarial input with a corresponding non-malformed and/or non-anomalous portion). As another example, during processing of an input data set, the internal behavior of the graph neural network may be evaluated and/or classified (e.g., by another machine learning model, including another graph neural network) to determine whether the behavior indicates a processing of adversarial input (e.g., unusual neuron activations, unusual outputs of one or more neurons, and/or updates of internal states of memory units). If so, the processing of the adversarial input may be halted and/or an internal state of the graph neural network may be restored to a time before the adversarial input was processed. As another example, before output of a graph neural network is provided in response to an input data set, the output may be examined and/or classified (e.g., by another machine learning model, including another graph neural network) to determine whether it is incorrect, inconsistent with other inputs, and/or surprising. If so, the output of the graph neural network may be discarded and/or altered before being provided in response to the input data set. Further explanation and/or examples of various techniques for training and performance evaluation of graph neural networks are presented elsewhere in this disclosure and/or will be known to or appreciated by persons skilled in the art.

### Graph Neural Networks—Applications

Graph neural networks can be applied to input data sets (including input graph data sets and/or input non-graph data sets) in various applications, and can be configured and/or trained to generate outputs (including output graph data sets and/or output predictions, such as classifications) that are relevant to various tasks within such applications.

For example, in the field of social networking, a graph data set may represent at least a portion of a social network, including nodes that represent people and that are connected by edges that represent relationships among two or more people. The graph data set representing a social network may be provided, as input, to a graph neural network that is configured to receive and process the input graph data set. The graph neural network may generate, as output, an output graph data set. For example, the output graph data set may include one or more new nodes that correspond to one or more newly discovered people within the social network, and/or one or more new edges that correspond to one or more newly discovered relationships that connect two or more people of the social network. The output graph data set may include one or more subgraphs and/or clusters that represent highly interconnected people of the social network, e.g., a social circle. The output graph data set may include a prediction of a recommendation of a relationship among two or more nodes corresponding to two or more people of the social network who share common personal traits, interests, and/or connections to other people. The output graph data set may include a prediction of a classification of a node corresponding to a person of the social network, e.g., a prediction of a personal interest of the person or a demographic trait of the person. The output graph data set may include a prediction of a classification of an edge that connects nodes representing two or more people of the social network, e.g., a prediction of a criminal association among two or more people of the social network. The output graph data set may include a determination of a relationship within the social network based on an attention model, e.g., an identification of a first node corresponding to a first person of the social network that appears to be influential to a second person of the social network represented by a second node of the graph. The output graph data set may include a prediction of a graph property of the graph, e.g., a classification of the social network as one or more types (e.g., a genealogy or familial social network, a friendship social network, and/or a professional relationship social network).

As another example, in the field of pharmaceuticals, a graph data set may represent at least a portion of a molecule (e.g., a protein or a DNA sequence), including nodes that represent atoms of the molecule and that are connected by edges that represent bonds and/or spatial relationships among two or more atoms. The graph data set representing a molecule may be provided, as input, to a graph neural network that is configured to receive and process the input graph data set. The graph neural network may generate, as output, an output graph data set. For example, the output graph data set may include one or more new nodes that correspond to one or more newly discovered atoms that may be added to the molecule, and/or one or more new edges that correspond to one or more newly discovered atoms of the molecule. The output graph data set may include one or more subgraphs and/or clusters that represent highly interconnected subregions of the molecule, such as carbon atoms that form a benzene ring or a binding site for a protein. The output graph data set may include a prediction of a classification of one or more nodes corresponding to one or more atoms of the molecule, e.g., a prediction that a subset of atoms of the molecule include a binding site for an enzyme that may active and/or deactivate a protein. The output graph data set may include a prediction of a classification of an edge that connects nodes representing atoms of the molecule, e.g., a prediction of a chemically reactive bond that can be altered to alter a property of the molecule. The output graph data set may include a prediction of a graph property of the graph, e.g., a prediction of a shape or organization of the molecule, a classification of the molecule as an enzyme, and/or a prediction of a potential side-effect of a drug due to an undesirable interaction with another drug.

As another example, in the field of software, a graph data set may represent at least a portion of a marketplace, including nodes that represent products and that are connected by edges that represent relationships between products. The graph data set representing a marketplace may be provided, as input, to a graph neural network that is configured to receive and process the input graph data set. The graph neural network may generate, as output, an output graph data set. For example, the output graph data set may include one or more new nodes that correspond to one or more newly discovered product, and/or one or more new edges that correspond to one or more newly discovered products. The output graph data set may include one or more subgraphs and/or clusters that represent highly interconnected products (e.g., two or more products that are often purchased and/or used together, or that compete in a particular market sector). The output graph data set may include a prediction of a recommendation of a relationship among two or more nodes corresponding to two or more products. The output graph data set may include a prediction of a classification of a node corresponding to a product, e.g., a prediction of an appeal, value, and/or demand of a product in a particular market segment, such as a particular subset of users. The output graph data set may include a prediction of a classification of an edge that connects nodes representing products, e.g., a prediction of a functional relationship between two or more products. The output graph data set may include a prediction of a graph property of the graph, e.g., a classification of the marketplace as increasing and/or decreasing in terms of supply, demand, size, prognosis, and/or public interest.

As another example, in the field of logistics, a graph data set may represent at least a portion of a supply chain, including nodes that represent locations where resources are generated, manufactured, stored, exchanged, and/or consumed and that are connected by edges that represent means of transport of resources between two or more locations. The graph data set representing a supply chain may be provided, as input, to a graph neural network that is configured to receive and process the input graph data set. The graph neural network may generate, as output, an output graph data set. For example, the output graph data set may include one or more new nodes that correspond to one or more newly discovered location of interest, and/or one or more new edges that correspond to one or more newly discovered locations of interest. The output graph data set may include one or more subgraphs and/or clusters that represent highly interconnected locations of interest, such as locations between which certain resources are frequently transported. The output graph data set may include a prediction of a recommendation of a relationship among two or more nodes corresponding to two or more locations of interest. The output graph data set may include a prediction of a classification of a node corresponding to a location of interest, e.g., a prediction of an availability, supply, demand, value, and/or appeal of a resource in the location of interest. The output graph data set may include a prediction of a classification of an edge that connects nodes representing locations of interest, e.g., a prediction of a volume of utilization of a mode of transport between two locations of interest. The output graph data set may include a prediction of a graph property of the graph, e.g., a classification of a stability of the supply chain based on social, economic, political, and/or environmental changes.

As another example, in the field of energy, a graph data set may represent at least a portion of an energy grid, including nodes that represent energy generators, stores, distributors, and/or consumers, and that are connected by edges that represent relationships among energy generators, stores, distributors, and/or consumers. The graph data set representing an energy grid may be provided, as input, to a graph neural network that is configured to receive and process the input graph data set. The graph neural network may generate, as output, an output graph data set. For example, the output graph data set may include one or more new nodes that correspond to one or more newly discovered energy generators, stores, distributors, and/or consumers, and/or one or more new edges that correspond to one or more newly discovered energy generators, stores, distributors, and/or consumers. The output graph data set may include one or more subgraphs and/or clusters that represent highly interconnected energy generators, stores, distributors, and/or consumers. The output graph data set may include a prediction of a recommendation of a relationship among two or more nodes corresponding to two or more energy generators, stores, distributors, and/or consumers. The output graph data set may include a prediction of a classification of a node corresponding to energy generators, stores, distributors, and/or consumers, e.g., a prediction of a current or future state or property of the energy generator, store, distributor, and/or consumer. The output graph data set may include a prediction of a classification of an edge that connects nodes representing energy generators, stores, distributors, and/or consumers, e.g., a prediction of a transaction between two or more energy generators, stores, distributors, and/or consumers. The output graph data set may include a prediction of a graph property of the graph, e.g., a classification of a stability of the energy grid to sustain energy generation and to support energy demands based on social, economic, political, and/or environmental changes.

As another example, in the field of civil engineering, a graph data set may represent at least a portion of a geographic region, including nodes that represent locations of interest and that are connected by edges that represent roads. The graph data set representing a geographic region may be provided, as input, to a graph neural network that is configured to receive and process the input graph data set. The graph neural network may generate, as output, an output graph data set. For example, the output graph data set may include one or more new nodes that correspond to one or more newly discovered locations of interest, and/or one or more new edges that correspond to one or more newly discovered locations of interest. The output graph data set may include one or more subgraphs and/or clusters that represent highly interconnected locations of interest. The output graph data set may include a prediction of a recommendation of a relationship among two or more nodes corresponding to two or more locations of interest. The output graph data set may include a prediction of a classification of a node corresponding to location of interest, e.g., a prediction of a current or future volume of visitors to a location of interest and/or a volume of traffic at or through the location of interest. The output graph data set may include a prediction of a classification of an edge that connects nodes representing locations of interest, e.g., a prediction of a volume of traffic on a road that connects two or more locations of interest. The output graph data set may include a prediction of a graph property of the graph, e.g., a classification of a sufficiency of a road network of the geographic region to support a current or future volume of traffic.

As another example, in the field of industrial systems, a graph data set may represent at least a portion of an industrial plant, including nodes that represent machines of the industrial plant and that are connected by edges that represent functional relationships among the machines. The graph data set representing the industrial plant may be provided, as input, to a graph neural network that is configured to receive and process the input graph data set. The graph neural network may generate, as output, an output graph data set. For example, the output graph data set may include one or more new nodes that correspond to one or more newly discovered machines, and/or one or more new edges that correspond to one or more newly discovered machines. The output graph data set may include one or more subgraphs and/or clusters that represent highly interconnected machines. The output graph data set may include a prediction of a recommendation of a relationship among two or more nodes corresponding to two or more machines. The output graph data set may include a prediction of a classification of a node corresponding to a machine, e.g., a prediction of a current or future maintenance state of a machine. The output graph data set may include a prediction of a classification of an edge that connects nodes representing machines, e.g., a prediction of a functional relationship between a first machine and a second machine that may significantly impact an efficiency, output, cost, or the like of the industrial plant. The output graph data set may include a prediction of a graph property of the graph, e.g., a classification of the industrial plant as belonging to a particular industry, such as raw material processing, semiconductor fabrication, tool manufacturing, vehicle manufacturing, textile manufacturing, and/or pharmaceuticals manufacturing. The output graph data set may include a prediction of a future and/or optimized state of the industrial plant, e.g., a reorganization of the machines of the industrial plant to optimize machine placement and/or floor planning.

As another example, in the field of cybersecurity, a graph data set may represent at least a portion of a device network, including nodes that represent devices and that are connected by edges that represent communication and/or interactions among two or more devices. The graph data set representing the device network may be provided, as input, to a graph neural network that is configured to receive and process the input graph data set. The graph neural network may generate, as output, an output graph data set. For example, the output graph data set may include one or more new nodes that correspond to one or more newly discovered devices, and/or one or more new edges that correspond to one or more newly discovered devices. The output graph data set may include one or more subgraphs and/or clusters that represent highly interconnected devices. The output graph data set may include a prediction of a recommendation of a relationship among two or more nodes corresponding to two or more devices. The output graph data set may include a prediction of a classification of a node corresponding to a device, e.g., a prediction of a security status of the device as being safe, vulnerable, or corrupted. The output graph data set may include a prediction of an activity occurring among the nodes of the graph data set, e.g., an occurrence of an intrusion or an attack based on anomalous activities represented by the edges of the graph data set. The output graph data set may include a prediction of a classification of an edge that connects nodes representing devices, e.g., a prediction that a particular interaction between two or more devices is associated with a security vulnerability or attack. The output graph data set may include a prediction of a graph property of the graph, e.g., a classification of the set of devices as safe from security flaws or vulnerable to one or more attack mechanisms, such as denial-of-service (DoS) attacks, distributed-denial-of-service (DDoS) attacks, social engineering attacks such as phishing, eavesdropping attacks such as man-in-the-middle attacks, or the like. The output graph data set may include a prediction of a theoretical state of the graph data set, e.g., a security state of the device network in response to a particular type of attack, and/or a security state of the device network based on the inclusion of additional devices in the future. The output graph data set may include a recommendation to modify the graph neural network based on one or more security considerations, e.g., a recommendation to reorganize the device network to reduce susceptibilities to one or more security risks. The output graph data set may include a technique to defend the graph neural network from various types of adversarial attack, e.g., training-time attacks that affect the manner in which the graph neural network learns to evaluate and/or classify the graph data set, one or more nodes, and/or one or more edges. For example, the message passing operations of the graph neural network may be modified to reduce a susceptibility of the graph neural network to adversarial perturbation during training, while preserving the learning capabilities of the graph neural network.

Examples of additional applications of various graph neural networks to various graph data sets include, without limitation: graph mining applications (e.g., graph matching and/or clustering); physics (e.g., physical systems modeling and/or evolution over time); chemistry (e.g., molecular fingerprints and/or chemical reaction predictions); biology (e.g., protein interface predictions, side effects predictions, and/or disease classification); knowledge graphs (e.g., knowledge graph completion and/or knowledge graph alignment); generation (e.g., output graph data set generation that corresponds to an expression, an image, a video, a music sample, or a scene graph); combinatorial optimization; traffic networks (e.g., traffic state prediction); recommendation systems (e.g., user-item interaction predictions and/or social recommendations); economic networks (e.g., stock markets); software and information technology (e.g., software defined networks, AMR graph-to-text tasks, and program verification); text processing (e.g., text classification, sequence labeling, machine translation, relation extraction, event extraction, fact verification, question answering, and/or relational reasoning); and image processing (e.g., social relationship understanding, image classification, visual question answering, object detection, interaction detection, region classification, and/or semantic segmentation). Further examples of applications for processing various graph data sets by various graph neural networks are presented elsewhere in this disclosure and/or will be known to or appreciated by persons skilled in the art.

### Attention

In embodiments, an artificial intelligence system, machine learning model, or the like, of any of the types disclosed herein, may comprise, integrate, link to, or include an attention feature. Attention may be generally described as a determination, among a set of inputs, of the relatedness of each input to the other inputs in the set of inputs. In “self-attention,” the input includes a sequence of elements, and attention is determined between each pair of elements in the sequence. As a first example, the set of inputs includes a sequence of words in a language, and attention is applied to determine, for each word in the sequence, the relatedness of the word to each other word in the sequence. As a second example, an input includes an image comprising a set of pixels, and attention is applied to determine, for each group of pixels in the image, the relatedness of the group of pixels to each other group of pixels in the image. Attention can also be applied between sets of input, wherein attention is determined between each element of a first set of input and each element of a second set of input. For example, the set of inputs can include a first sequence of words in a first language and a second sequence of words in a second language, and attention can be determined to indicate how each word in the first sequence is related to each word in the second sequence.

FIG. 16 presents an example of a determination of attention by a machine learning model. In the example of FIG. 16, an input sequence 1602 includes a set of tokens, each representing a word (“The”, “Furry”, “Dog”, “Chased”, “The”, “Cat”). Each token includes an indicator of a position of the token in the sequence. In various embodiments, the tokens of the input sequence may include complete words, portions of words (e.g., a first token indicating a word root and a second token indicating a modifier of the word root), punctuation, or the like. Some tokens may indicate metadata, such as a start-of-sequence token, an end-of-sequence token, or a null token indicating a padding of the sequence or a mask that hides a token of the sequence.

The input sequence is processed by a position encoder that determines, for each token, an encoding of the position. In some embodiments, the position encoding may include an ordinal numerical value that indices the ordinal position of each token in the sequence, such as an index beginning at zero or one. In some embodiments, the position encoding may include a relative numerical value that indicates a position of each token in the sequence relative to a fixed position, such as a current word (encoded position 0), an immediately preceding word (encoded position −1), or an immediately following word (encoded position 1). In some embodiments, the position encoding may include non-integer values and/or multiple values, such as a first index indicating a sine calculation (with a given frequency) of the position of each token and a second index indicating a cosine calculation (with a same or different frequency) of the position of each token.

The input sequence is also processed by an embedding model. The embedding model determines, for each token in the input sequence, a mapping of the token into a latent space representation of the input (e.g., a latent space representation of a language). The latent space may position each token along a plurality of n dimensions, wherein each dimension represents a distinct type of relationship among the elements of the language. The embedding model clusters the tokens such that related tokens are positioned closer to each other within the latent space. For example, along one dimension of the latent space, the words “Cat” and “Dog” may be positioned close together as being words that describe animals, while also being positioned apart from words that do not describe animals, such as “Baseball” and “School.” Along another dimension of the latent space, the words “Dog” and “Furry” may be positioned close together as words that commonly occur in the context of dogs, while also being positioned apart from words that do not describe dogs, including “Cat.” For each token of the input sequence, the embedding model generates one or more values that indicate the position of the token within the latent space. In some embodiments, the values are encoded as a vector, and the proximity of two tokens within the latent space may be determined based on vector proximity calculations, such as cosine similarity.

Based on the positions encoded by the position encoder and the embeddings determined by the embedding model, a model input 1610 can be generated for the input sequence. As shown in FIG. 16, the model input includes a query, a set of keys, and a set of values. As an example, the query may include an indicator of a particular token in the input sequence, such as the sixth token (“Cat”). The keys may include the position encodings of respective tokens of the input sequence, as determined by the position encoder 1604, and a corresponding embedding of the respective token as determined by the embedding model 1606. The values may indicate additional data features of the tokens. As an example, the values may indicate, for each token of the input sequence, a determined sentiment (e.g., a ranking between −1, indicating very negative words, and +1, indicating very positive words). In some embodiments, no additional data features are available, and the values are identical to the keys.

The model input is received and processed by an attention layer 1612. In FIG. 16, the attention layer first includes a set of fully-connected layers: a first fully-connected layer processes the query of the model input; a second fully-connected layer processes the keys of the model input; and a third fully-connected layer processes the values of the model input. Each fully-connected layer includes a bias and a set of weights that adjust the values of the query, key, or value, respectively. The bias and weights of each fully-connected layer are model parameters that are initialized (e.g., to random values) and then incrementally adjusted during training.

Optionally, in some embodiments, the outputs of the fully-connected layers are further processed by a masking layer. The masking layer removes one or more values from the model input adjusted by the fully-connected layers. As a first example, the masking layer can reduce to zero the values of the key and/or value at a given position, such as a token at a current position to be predicted, or a token at a position following the current position that is to be hidden from the model. As a second example, the masking layer can reduce to zero the values of particular keys and/or values, such as padding values that are provided to adapt the size of the model input to a size of input that the attention layer is configured to receive and process. The masking layer can produce output for certain tokens (e.g., reduced to zero) for the indicated tokens (e.g., the current token, future tokens, and/or padding tokens) and that is the same as the input for the remaining tokens.

Optionally, in some embodiments, the outputs of the masking layer are further processed by a multi-head reshaping layer. The multi-head reshaping layer can reshape an input vector comprising the weighted and/or masked model input such that subsets of the input can be processed in parallel by different attention heads. As an example, an attention layer may include two attention heads, and the input can be reshaped such that each attention head is applied to only half of the inputs. The multi-head attention model can enable attention determinations over different subsets of the input (e.g., a first attention head can determine the relatedness of a first token to a first subset of tokens of the input sequence, and a second attention head can determine the relatedness of the same first token to a second subset of tokens of the input sequence). Alternatively or additionally, the multi-head attention model can enable different types of attention determinations among the tokens of the input sequence (e.g., a first attention head can determine a first type of relatedness of a first token to a subset of tokens of the input sequence, and a second attention head can determine a second type of relatedness of the same first token to the same or different subset of tokens of the input sequence). The multi-head attention model may enable parallel processing of the input sequence (e.g., the input for each attention head can be processed by a different processing core).

The attention layer includes an attention calculation that determines, based on the model input, the attention of a token of the input sequence with respect to other tokens of the input sequence. In some embodiments, the attention calculation includes an additive attention (“Bahdanau Attention”) calculation, in which attention is determined as a sum of weighted calculations of the distances of the tokens along each dimension of the latent space. In some embodiments, the attention calculation includes a dot product determination, as a comparison of the distances between the vectors of the tokens within the latent space. In some embodiments, the attention calculation is performed over the query, keys, and values of the model input, optionally after processing with a masking layer. In some embodiments, the attention calculation is performed for each of a plurality of attention heads, each of which processes a particular subset of the tokens of the input sequence.

In embodiments that include multi-head reshaping, the output of the attention calculation is further processed by a merge operation that merges the attention calculations for the respective attention heads. In some embodiments, the merge operation includes a concatenation and/or interleaving of the attention calculations of the attention heads. In some embodiments, the merge operation includes an arithmetic operation applied to the attention calculations of the attention heads, such as an arithmetic mean, median, min, and/or max calculation.

The attention layer outputs, for at least one token of the input sequence, a determination of attention between the token and at least one other token of the input sequence. The output of the attention calculation may include a vector that indicates, for at least one token of the input sequence, the determinations of attention between the token and a set of other tokens of the input sequence. The output of the attention calculation may include a set of vectors that indicate, for respective tokens of the input sequence, the determinations of attention between the respective token and at least one other token of the input sequence. The output of the attention calculation may indicate, for a token of a first sequence, the attention of the token to one or more tokens of a second sequence. As shown in FIG. 16, the output of the attention layer includes pairwise determinations of relatedness between pairs of tokens (e.g., each pair including a current token in an input sequence and each preceding token in the input sequence). In some embodiments, the pairwise determinations may be further processed. For example, a softmax calculation can be applied to normalize the pairwise attention determinations based on a desired range of output values (e.g., probability values between 0.0 and 1.0, with a 1.0 sum over all output values).

The attention layer may be trained by providing sets of training input sequences and comparing the outputs of the attention layer with expected outputs. Alternatively or additionally, the attention layer may be trained by incorporating the attention layer into a larger model (e.g., a transformer model) and adjusting the parameters of the attention layer (e.g., the parameters of the fully-connected layers) for a given training input sequence in order to adjust the output of the attention layer toward a desired output for the training input sequence. As an example, in a backpropagation training process, the output of the attention layer is provided as input to a succeeding layer. The output of the model including the attention layer and the succeeding layer may be compared with a desired output for the training input sequence. Based on this comparison, adjustments of the output of the succeeding layer (e.g., based on an error calculation) may inform a determination of desired adjustments of the input of the succeeding layer, which correspond to adjustments of the output of the attention layer. The adjustments of the output may be achieved by internally adjusting the parameters of the attention layer (e.g., the weights and/or biases of the fully-connected layers shown in FIG. 16) such that the attention layer subsequently generates output for the training input sequence that more closely corresponds to the desired input for the succeeding layer. Incremental training over a set of training input sequences can cause the attention layer to generate output that corresponds to the desired output for the training input sequences. As an example, if the input sequences are sentences in a language and the desired output of the model includes the probabilities of words in the language that could follow a given set of input words, the attention layer can be incrementally adjusted to indicate the attention (e.g., relatedness) between the next word in the input sequence and the preceding words in the input sequence.

It is to be appreciated that the attention layer shown in FIG. 16 presents only one example, and that attention layers may include a variety of variations with respect to the example of FIG. 16. For example, attention layers may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the attention layer shown in FIG. 16 may vary in numerous respects. For example, masking may be applied to the model input instead of to the outputs of the fully-connected layers. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in attention layers that are incorporated in a variety of machine learning models to process a variety of types of input sequences.

### Transformer Models

In embodiments, an artificial intelligence system, machine learning model, or the like, of any of the types disclosed herein, may comprise, integrate, link to, or include a transformer model, that is, a neural network that learns context and meaning by tracking relationships in a set of sequential data inputs. Transformer models may include one or more attention layers, including (but not limited to) the attention layer shown in FIG. 16.

FIG. 17 presents an example of a transformer model. The transformer model of FIG. 17 is based on an encoder-decoder architecture in which an encoder processes an input sequence 1702 and a decoder processes an output sequence 1704 to generate output probabilities. As a first example, the input sequence may include a sequence of words in a first language; the output sequence may include a sequence of words in a second language corresponding to a translation of the input sequence; and the output probabilities may include the probabilities of words in the second language for a particular position in the translation. As a second example, the input sequence may include a sequence of words in a language that represent a query or prompt; the output sequence may include a sequence of words in the same language that represent a response to the query or prompt; and the output probabilities may include the probabilities of words in the second language for a particular position in the response. In some cases, the output sequence includes only the tokens up to a particular position (e.g., the first n−1 tokens of the output sequence), and the output probabilities represent the probabilities of tokens in the language of the output sequence that could follow the output sequence (e.g., the nth token in the output sequence). In some cases, the output sequence includes all of the tokens except the token a particular position (e.g., all of the tokens except the nth token of the output sequence), and the output probabilities represent the probabilities of tokens in the language of the output sequence that could represent the missing token in the output sequence (e.g., the nth token in the output sequence).

The encoder 1710 receives an input sequence comprising a set of tokens. The input sequence may be padded to a given length corresponding to a configured input size for the encoder. The input sequence is processed by a position encoder to encode the positions of the respective tokens of the input sequence. The input sequence is also processed by an embedding model to determine the embeddings of the tokens of the input sequence. The encoded positions and embeddings are used to generate an encoder model input, including a query (e.g., a position of one or more tokens in the input sequence), a set of keys (e.g., the encoded positions and embeddings for each token of the input sequence), and a set of values (e.g., additional language features of the tokens such as outputs of sentiment analysis). The set of values may be a copy of the set of keys if no additional data features are available. The encoder model input is processed by a multi-head attention layer, such as an instance of the attention layer shown in FIG. 16. The multi-head attention layer determines self-attention within the input sequence (e.g., the relatedness of a respective token of the input sequence to each other token of the input sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The encoder also includes a feed-forward layer (e.g., a fully-connected layer and/or a sparsely-connected layer) including a set of trainable parameters. The output of the feed-forward layer is provided to another layer normalization component, along with the output of the preceding layer normalization component via a skip layer. The encoder outputs an input sequence attention, which indicates, for each of one or more tokens of the input sequence, the relatedness of each other token of the input sequence.

The decoder 1712 features an architecture that is similar to the encoder, but that includes additional components to incorporate the input sequence attention generated by the encoder. The decoder receives an output sequence comprising a set of tokens. The output sequence may be padded to a given length corresponding to a configured input size for the decoder. The output sequence is processed by a position encoder to encode the positions of the respective tokens of the output sequence. The output sequence is also processed by an embedding model to determine the embeddings of the tokens of the output sequence. The encoded positions and embeddings are used to generate a decoder model input, including a query (e.g., a position of one or more tokens in the output sequence), a set of keys (e.g., the encoded positions and embeddings for each token of the output sequence), and a set of values (e.g., additional language features of the tokens such as outputs of sentiment analysis). The set of values may be a copy of the set of keys if no additional data features are available. The decoder model input is processed by a masked multi-head attention layer, such as an instance of the attention layer shown in FIG. 16. In addition to determining attention, the masked multi-head attention layer masks the input values of a current token of the output sequence and any tokens of the output sequence that follow the current token. The masked multi-head attention layer determines self-attention within the output sequence (e.g., the relatedness of a respective token of the output sequence to each preceding token of the output sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The decoder further includes an encoder-decoder multi-head attention layer that receives both the output of the preceding layer normalization component and the input sequence attention generated by the encoder. The encoder-decoder multi-head attention layer does not determine self-attention within the output sequence, but, rather, determines the attention between the tokens of the output sequence and the corresponding tokens of the input sequence.

The output of the encoder-decoder multi-head attention unit is also received and processed by a second layer normalization component. Additionally, a skip layer is provided that passes the input to the encoder-decoder multi-head attention layer through to the second layer normalization component. The second layer normalization component combines the output of the multi-head attention layer with the input to the encoder-decoder multi-head attention unit (e.g., via arithmetic mean, median, min, max, addition, multiplication, or the like) and normalizes the combined output to within a desired range. The decoder also includes a feed-forward layer (e.g., a fully-connected layer and/or a sparsely-connected layer) including a set of trainable parameters. The output of the feed-forward layer is provided to a third layer normalization component, along with the output of the preceding layer normalization component via a skip layer. The output of the decoder is processed by a fully-connected layer and a softmax normalization layer based on a cross-entropy determination.

The output of the softmax normalization layer includes a set of probabilities for each possible token of a language of the output sequence for the current token. As a first example, the input sequence may include a sequence of words in a first language; the output sequence may include a sequence of words in a second language corresponding to a translation of the input sequence, up to a current (nth) word in the translation; the output probabilities may include the probabilities of words in the second language for the nth word in the translation. As a second example, the input sequence may include a sequence of words in a language that represent a query or prompt; the output sequence may include a sequence of words in the same language that represent a response to the query or prompt, up to a current (nth) word in the response; and the output probabilities may include the probabilities of words in the language for the nth word in the response.

During training, the transformer model may be provided with a set of input sequences and complete corresponding output sequences. As a first example involving language translation, the transformer model may be provided with a training data set including a first corpus of sentences in a first language and a second corpus of sentences in a second language that respectively correspond to the sentences in the first language. As a second example involving a generative model, the transformer model may be provided with a training data set including a first corpus of queries or prompts in a language and a second corpus of responses in the language that correspond to the respective queries or prompts. For each training data input, a pair of sentences of the first corpus and second corpus are selected. The encoder is provided with the first (input) sentence, and the model is processed to determine the first word in the second (output) sentence. In this case, the output sequence provided to the decoder is completely masked so that the decoder cannot make predictions based on the expected words in the second sentence. The word probabilities determined by the decoder are compared with the actual first word in the output sequence, and backpropagation is applied through the decoder and encoder to increase the likelihood of outputting the expected word. The backpropagation includes adjusting the parameters of the attention layers to increase the attention between the first word and related words of the input sequence. The encoder is then provided again with the first (input) sentence, and the model is processed to determine the second word in the second (output) sentence. In this case, the output sequence provided to the decoder includes the unmasked first word, but masks all words after the first word. The word probabilities determined by the decoder are compared with the actual second word in the output sequence, and backpropagation is applied through the decoder and encoder to increase the likelihood of outputting the expected word. The backpropagation includes adjusting the parameters of the attention layers to increase the attention between the second word, the known first word of the output sequence, and related words of the input sequence. In this manner, the transformer model performs an autoregressive prediction, wherein the output probability of each nth token of the output sequence is based on the input sequence, the previously predicted tokens of the output sequence, and the encoder-decoder attention therebetween. Training continues over the entirety of the first and second corpora to improve the output predictions.

In many cases, the training of the transformer model occurs in batches. For example, the previous (simplified) training example described an incremental training of the transformer model over each corresponding pair of sentences of the first and second corpora, wherein the parameters of the transformer model are adjusted via backpropagation after each instance of processing. In batch training, the input and output sequences are vectorized, as are the layers of the transformer model, such that predictions over each word of the output sequence are predicted in parallel. Backpropagation parameter adjustment is performed for each batch of the training data set, based on the outputs for all of the pairwise inputs of each batch of the training data set.

After training, the transformer model can be used to predict an output sequence based on an input sequence. First, the input sequence is processed by the encoder, while the decoder processes a null output sequence (e.g., an output sequence in which all outputs are initially nulled and/or masked by the masked multi-head attention layer). The output probability of the decoder is used to determine a first token of the output sequence. In some embodiments, the first token is chosen as the token having the highest probability. In other embodiments, the first token is chosen based on a random sampling over the output probabilities. In either case, the transformer is then applied to the same input sequence and an output sequence including only the determined first token of the output sequence, and the output of the decoder determines the second token of the output sequence. This process continues until reaching an output token cap and/or upon determining, as the output of the decoder, an end-of-sequence token. In this manner, the transformer model is applied over the input sequence to determine, in serial and autoregressive manner, the tokens of the output sequence.

It is to be appreciated that the transformer model shown in FIG. 17 presents only one example, and that transformer models may include a variety of variations with respect to the example of FIG. 17. For example, the architecture of the encoder and/or decoder may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the encoder and/or decoder shown in FIG. 17 may vary in numerous respects. For example, masking may be applied directly to the output sequence instead of within the multi-head attention models. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in transformer models to process a variety of types of input and output sequences.

Transformer models, including the example shown in FIG. 17, may be applied in a variety of circumstances.

As an example, transformer models may be trained on and/or configured to process a variety of types of input sequences and/or output sequences. Sequential data inputs and/or outputs can include a wide variety of types described herein, such as strings of text, sequences of sensor data from or about an entity, sequences of steps in a process (e.g., chemical, physical, biological, and many others) or flow (e.g., a human workflow, information technology traffic flow, physical traffic flow, sequences of user behavior (e.g., attention to content, clickstream behavior, shopping behavior (digital and real world), and many others. Any of these, and others can be provided as inputs to train a transformer model, which may be alternatively described herein as a self-attention model, a foundation model, or the like. A range of mathematical self-attention techniques can be applied to detect how data elements in sequential data mutually affect each other (such as in feed forward, feedback, and other forms of influence and dependency). In various embodiments described herein and in the documents incorporated by reference herein, a set of transformer models may be deployed for a wide range of use cases, including for predictive text applications (e.g., generating a next token of text based on a previous set of tokens, such as for intelligent agent dialog, responses to queries, and the like); for extraction of information (such as extraction of meaningful elements from sensor data, signal data, and the like, such as analog signal data from sensors on machines, wearable devices, infrastructure sensors, edge and IoT devices, and many others); for analysis of human factors, such as emotional response, sentiment, satisfaction, opinion, and the like; for summarizing data (such as providing summaries of text, images, video, sensor data, and many other streams of data of the type collected and processed as described herein); for trend detection, prediction and forecasting (and hence also for anomaly detection, such as fraud in financial transactions), including for a wide range of trends, including health (human, animal, mental, financial, machine condition, and others), performance (wellness, financial, physical, and many others), and many others; for recognition of entities and behaviors (such as objects appearing in video or image data, objects captured in LIDAR and other point-cloud rendering systems, objects located by SLAM systems, and many others); for generation and execution of instructions (e.g., recipes, control instructions, rules, regulations, governance instructions, and many others); and for many other uses.

In embodiments, an input data set, such as an analog or digital sensor data stream, a body of text, a set of images, a set of structured data (such as data from a graph database or other form of database noted herein, a sequence of blockchain or distributed ledger entries (or other ledger data, such as accounting, financial, health or other data), a set of signals (of the various types noted herein), is provided in order to train a transformer model. In embodiments, initial training may include a step of facilitating compression of the input data, such as by constraining the size of the transformer neural network and/or its outputs, to dimensionality that is significantly smaller (or less granular, etc.) than that of the input data. By requiring the output of the constrained transformer model to match, within a required metric of fidelity, the input data, the transformer model is caused to generate an “embedding” of the input data into a more compressed, efficient format. A decoding neural network may then be trained to operate on the output of the constrained, embedding transformer model, such that it can reproduce the input data from the output of the constrained model within the required metric, thereby assuring that the data is compressed without losing critical meaning.

Once the embedding transformer model is so trained, the decoding neural network can be removed and replaced by one or more of a set of use-case driven decoding models, each of which is trained to operate on the output of the embedding model to produce a target outcome, such as performing any of the use cases noted above to a satisfactory degree. These use-case decoding models can be fine-tuned iteratively over time with feedback from users, outcomes, or the like. Thus, a trained embedding foundation/transformer model, once created, can be used across many different use cases that may benefit from understanding the meaning of the input data set.

In embodiments, one type of use-case decoder can be trained to allow the embedding transformer model to operate on lower quality data than was originally supplied to train the model. To accomplish this, both low quality and high quality data (such as high granularity sensor data and low granularity sensor data, or high dimensionality signal data and low dimensionality signal data, or noisy acoustic data and filtered acoustic data, or the like) can be simultaneously fed to a pair or more of instances of the trained, embedding transformer model, and a decoder for the instance of low quality data can be trained to generate an output that matches, within a metric of fidelity, the output of the instance of the embedding transformer model that is fed the high quality data. As an example, gap-free analog waveform data from a three-axis vibration sensor on a machine component can be captured simultaneously with less granular data from a single- or two-axis accelerometer on the same component, and a decoder, operating on the output of the instance of the embedding transformer model that takes the single- or two-axis input, can be trained to match (within a tolerance) the output of the instance of the embedding transformer model that takes the more granular data as an input. Once created, the resulting decoder, coupled with the embedding transformer model, serves as a projection transformer model, effectively projecting lower quality data into higher quality data, which can then be used by other decoders to enable use cases. This class of projecting transformer models can be applied to a wide range of use cases where high quality data can be obtained during a training phase (often at higher expense), but lower quality data can be used as an input during a deployment phase (such as where lower quality data is more widely or cheaply available, such as in the case of vibration data noted above). Among other things, these projecting transformer models allow powerful, real-time, low latency use cases for AI even when input data is sparse, noisy, of low dimensionality, or the like.

In embodiments, feedback from various decoder models can be used to improve instances of an embedding foundational or transformer model. In embodiments, a set of transformer models, a set of decoders, or both, can be arranged in a workflow, which may be directed/acyclical or with processing loops, to create higher-level use cases that benefit from multiple applications of AI. For example, one model may be used to classify a condition, another used to generate a recommendation, and another used to generate a control instruction, among a huge range of possible embodiments. This may include serial, parallel, iterative, feed forward, feedback and other configurations.

In embodiments, a set of models may be trained to generate instructions for configuration of other models.

In embodiments, transformer models may be deep learning, self-learning, self-organizing, or the like, and may be used for any of the embodiments of self-learning, self-organization, or other self-referential capabilities noted throughout this disclosure or the documents incorporated by reference herein. They may also be supervised, semi-supervised, or the like. Transformer models may be coupled with, integrated with, linked to, or the like, in series, parallel or other more complex workflows, with other AI types, such as other neural network types (e.g., CNNs, RNNs, and others). For example, in embodiments, a transformer model operating on sequential data may be coupled with a model suited to operate on non-sequential data (e.g., for pattern recognition) to achieve a use case.

In embodiments, transformer models discover patterns in large bodies of data by application of a set of mathematical functions, optionally operating in parallel processing configurations, thereby eliminating or reducing the need for human labeling (and thereby greatly expanding the set of available data that can be used to train a model).

Self-attention may be accomplished in a transformer model by introducing a set of positional encoders that tag data elements entering and exiting a neural network and inserting a set of attention units at appropriate places in the encoding and decoding framework of an AI system. The attention units generate a mathematical map of interrelationships among data elements. In embodiments multi-headed attention units are deployed, executing a matrix of equations in parallel to determine the interrelationships. Transformer models, using self-attention, have displayed strong capabilities to provide outputs that are consistent with how humans find patterns and meaning in data.

In embodiments, transformer models may be embodied with very large numbers of parameters (e.g., hundreds of millions, billions, trillions, or more) operating on very large sets of parallel processors. For example, the Megatron-Turing Natural Language Generation Model by NVIDIA and Microsoft is reported to have 530 billion parameters. As noted above, from a foundational model, various use-case specific models (decoders, projections, and the like) can be purpose-built for specific applications. Accordingly, in embodiments a set of transformer models may be deployed using advanced computational techniques and/or processing architectures, such as ones that simplify or converge processors, simplify I/O, and the like. For example, 3D chipset or chiplet architectures may facilitate much higher density, faster computation, making transformer models more cost-effective. Quantum computation may also facilitate massively parallel processing in form factors that are faster, more energy efficient, or the like. Similarly, embodiments may use a tensor-engine GPU chip with a specific transformer engine, such as the NVIDIA H100 Tensor Core GPU. Another example of a transformer model is Google's switch transformer model, a trillion-parameter model that uses sparsity and a mixture-of-experts architecture to enable gains in performance and reductions in training speed.

As noted above, in embodiments smaller or more constrained transformer models may be trained to generate embeddings, particularly for very complex data sets, such as granular analog data.

In embodiments a set of transformer models may be configured to operate on structured data processing systems, such as on results from queries that are directed to a database, results of inputs directed to a set of APIs, or the like. This may facilitate better understanding of what meaning a transformer model is recognizing in a data pattern, which can be critical to ensuring quality (e.g., where a model may, due to flaws in underlying data, generate poor conclusion, such as replicating historical racial bias, missing critical balancing information, failing to understand formal logical constructs, or the like). As noted elsewhere in this disclosure and the documents incorporated herein, governance of AI in general, is a need, and the scale and complexity of transformer models likely compounds problems recognized with other neural networks, including their “black box” nature, uncertainty about input quality, and the like. Thus, governance concepts disclosed herein and in documents incorporated by reference should be understood to apply to various embodiments that use transformer models, as with other types of AI. One example is in the training of models, where models may be trained, in embodiments, in various disciplines, optionally similar to the educational frameworks by which humans are trained not just to sense pattern meaning, but also how to test and govern those abilities with formal reasoning and logic, mathematics, probability, and frameworks of ethics and morality.

### Financial Infrastructure

Referring now to FIG. 18, a financial infrastructure system 1800 is illustrated in accordance with some embodiments. Financial infrastructure module 1806 is increasingly enabled at various layers 1802 by the convergence of AI capabilities 1804 with other technologies, impacting front and back-office operations for enterprises, marketplaces, and exchanges. In some cases, entirely new products and offerings are made possible.

Technology convergence enables various financial modules, which support use cases or converging technology stack examples 1808 for a given market, industry, or category.

The financial infrastructure modules 1806 include automated governance of transactions at the governance layer 1810, AI-based enterprise transactional decision support at the enterprise layer 1812, automated targeting and customized offer configuration at the offering layer 1814, automated transaction orchestration at the transaction layer 1816, converged AI-based transaction workflow orchestration at the operations layer 1818, intelligent edge for distributed transactions at the network layer 1820, context aware sensor fusion to inform transaction analytics and AI at the data layer 1822, and financial and computational resource optimization at the resource layer 1824.

At the governance layer 1810, AI capabilities 1804 for embedded policy and governance enable a financial infrastructure module 1806 for automated governance of transactions. Converging technology stack examples 1808 at the governance layer 1810 include policy automation, regulatory compliance automation, and reporting automation. Automated governance of transactions infrastructure addresses how increasingly digitized and networked transactional workflows can be governed by transactional policy automation that keeps in step with ever-shifting regulatory frameworks that apply to financial providers, marketplaces, exchanges, and their respective customers.

In embodiments, Automated Governance of Transactions modules address how increasingly digitized and networked transactional workflows can be governed by transactional policy automation that keeps in step with ever-shifting regulatory frameworks that apply to financial providers, marketplaces, exchanges, and their respective customers. In embodiments, an automated governance of transactions financial infrastructure module is underpinned by advanced embedded policy and governance artificial intelligence (AI) capabilities. The module may be designed to autonomously enforce compliance and governance standards across financial transactions by leveraging a sophisticated AI framework. The AI system is adept at interpreting and applying a comprehensive array of regulatory requirements, internal control policies, and industry standards to real-time transactional data flows. The module utilizes machine learning algorithms to continuously monitor, analyze, and make determinations on the compliance status of each transaction, thereby ensuring adherence to the pertinent legal and regulatory frameworks. The AI-driven module may dynamically adapt to regulatory changes, thereby maintaining up-to-date compliance. Furthermore, the module may automate the generation of detailed compliance reports and maintain an immutable audit trail for each transaction, facilitating transparency and accountability. By embedding these AI capabilities directly within the transactional infrastructure, the module significantly enhances the efficiency, accuracy, and reliability of the governance process, while simultaneously mitigating risk and reducing the operational burden associated with manual governance and compliance checks.

At the enterprise layer 1812, AI capabilities 1804 for contextual simulation and forecasting enable a financial infrastructure module 1806 for AI-based enterprise transactional decision support. Converging technology stack examples 1808 at the enterprise layer 1812 include financial executing digital twins, enterprise transaction systems integration, and enterprise access layers. AI-based enterprise transactional decision support infrastructure provides capabilities for strategic resource and transaction planning and simulation, such as based on integration of disparate operational and marketplace data sources into intelligent dashboards and digital twins.

In embodiments, AI-Based Enterprise Transactional Decision Support modules provide capabilities for strategic resource and transaction planning and simulation, such as based on integration of disparate operational and marketplace data sources into intelligent dashboards and digital twins. In embodiments, an AI-based enterprise transactional decision support infrastructure module is empowered by contextual simulation and forecasting capabilities. This module integrates a sophisticated artificial intelligence framework that utilizes contextual data analysis to simulate various transactional scenarios and forecast potential outcomes. By processing vast datasets, including historical transaction records, current market trends, and predictive indicators, the AI system can generate comprehensive models that provide deep insights into the potential ramifications of different transactional strategies.

The module's forecasting engine employs advanced algorithms to predict future market conditions, financial performance, and risk exposure, thereby enabling enterprises to make informed decisions. The contextual simulation aspect allows for the creation of virtual environments where hypothetical transactional decisions can be tested, providing a sandbox for strategic planning without the risk of actual financial commitment. This AI-driven decision support tool is designed to assist enterprises in optimizing their transactional workflows, aligning financial strategies with business objectives, and proactively managing risks, thereby enhancing the overall efficacy and strategic agility of the enterprise's financial operations.

At the offering layer 1814, AI capabilities 1804 for expert systems and generative AI enable a financial infrastructure module 1806 for automated targeting and customized offer configuration. Converging technology stack examples 1808 at the offering layer 1814 include enterprise wallets, transaction systems user interface, and targeting and recommendation. Automated targeting and customized offer configuration infrastructure leverages user profiles, behavior, marketplace, and other data to enable highly targeted and customized configuration of offering and promotions.

In embodiments, Automated Targeting and Customized Offer Configuration modules leverage user profiles, behavior, marketplace, and other data to enable highly targeted and customized configuration of offering and promotions. In embodiments, an automated targeting and customized offer configuration financial infrastructure module leverages the combined strengths of expert systems and generative artificial intelligence (AI) to deliver personalized and strategic financial offerings. Expert systems within the module utilize a rule-based approach to analyze customer profiles and transaction histories, enabling the identification of customer needs and preferences. Concurrently, generative AI algorithms may synthesize this data to create and propose tailored financial products and services. This dual-faceted AI approach ensures that offers are not only relevant but also creatively adapted to individual circumstances. The module seamlessly integrates with enterprise wallets, allowing for the direct and secure application of offers to customer accounts, thereby streamlining the acceptance process. The transaction systems user interface is designed to be intuitive, providing customers with a clear and interactive platform to view and manage these personalized offers. Furthermore, the targeting and recommendation use cases may be implemented through a dynamic feedback loop, where customer interactions with the offers are continuously fed back into the system, refining the AI models to enhance future offer accuracy and customer satisfaction. This sophisticated module thus represents a significant advancement in the customization and delivery of financial services, driving engagement and value for both the enterprise and its customers.

At the transaction layer 1816, AI capabilities 1804 for discovery, generation, and optimization enable a financial infrastructure module 1806 for automated transaction orchestration. Converging technology stack examples 1808 at the transaction layer 1816 include counterparty discovery, smart contract configuration, and automated transaction orchestration. Automated transaction orchestration infrastructure enables advance configuration of transaction terms in smart contracts, such that counterparties can be discovered, and desired transactions can be initiated, completed, and reconciled automatically when triggered by marketplace conditions or other input data.

In embodiments, Automated Transaction Orchestration modules enable advanced configuration of transaction terms in smart contracts, such that counterparties can be discovered, and desired transactions can be initiated, completed, and reconciled automatically when triggered by marketplace conditions or other input data. In embodiments, an automated transaction orchestration financial infrastructure module is fundamentally enabled by artificial intelligence (AI) capabilities specializing in discovery, generation, and optimization. This module employs AI to intelligently navigate the vast landscape of potential transactional partners, utilizing data-driven insights to facilitate counterparty discovery. The module analyzes market behaviors, transactional histories, and compatibility metrics to recommend optimal transactional matches, thereby streamlining the process of identifying suitable counterparties. Once a counterparty is identified, the module may leverage generative AI to configure smart contracts that encapsulate the terms of the transaction, ensuring that all contractual obligations are met with precision and in accordance with predefined regulatory and compliance standards. The optimization AI may further refine this process by assessing various transactional parameters and adjusting the smart contract terms in real-time to maximize efficiency and minimize risk. The automated transaction orchestration use case is implemented through a combination of machine learning algorithms that predict transactional outcomes, natural language processing for contract generation, and neural networks that adaptively learn from each transaction to enhance future performance. Technical solutions for the implementation may include blockchain technology for secure and transparent smart contract execution, distributed ledgers for maintaining a consistent and immutable record of transactions, and cloud-based computing resources that provide the necessary scalability and computational power to process complex AI algorithms. This module thus represents a convergence of AI and financial technology, offering a robust solution for automating and optimizing transactional workflows within the financial sector.

At the operations layer 1818, AI capabilities 1804 for routing, control, optimization, and generation enable a financial infrastructure module 1806 for converged, AI-based transaction workflow orchestration. Converging technology stack examples 1808 at the operations layer 1818 include automated transaction monitoring, automated underwriting, and robotics and process automation. Converged, AI-based transaction workflow orchestration infrastructure enables automated completion of transaction steps (such as automated lending) via AI agents that operate on input data, trigger processing, and manage direction of outputs through a series of transaction steps.

In embodiments, Converged, AI-Based Transaction Workflow Orchestration modules enable automated completion of transaction steps (such as automated lending) via AI agents that operate on input data, trigger processing, and manage direction of outputs through a series of transaction steps. In embodiments, a converged, AI-based transaction workflow orchestration financial infrastructure module is enabled by sophisticated artificial intelligence (AI) capabilities in routing, control, optimization, and generation. This module utilizes AI to oversee and manage the entire lifecycle of a financial transaction, from initiation to completion. For automated transaction monitoring, the module may deploy AI algorithms that track the progress of transactions in real-time, identifying bottlenecks and anomalies that could indicate potential issues, such as fraud or non-compliance, and automatically initiating corrective actions. For automated underwriting, the module may apply machine learning techniques to assess the risk profiles of applicants by analyzing vast datasets, thereby streamlining the approval process and reducing the likelihood of default. Robotics and process automation may be implemented to execute repetitive and rule-based tasks within the transaction workflow, such as data entry and compliance checks, with robotic process automation (RPA) bots acting as digital workers that interact with various systems and databases. Technical solutions may include deep neural networks for pattern recognition and predictive analytics, natural language processing for interpreting unstructured data within transaction documents, and blockchain technology for secure and immutable transaction recording. Additionally, cloud computing may provide the scalable infrastructure necessary to support the computational demands of the AI models, while API integrations may facilitate seamless communication between disparate financial systems.

Collectively, these AI-driven capabilities and technical solutions may empower the module to orchestrate complex transaction workflows with enhanced efficiency, accuracy, and compliance.

At the network layer 1820, AI capabilities 1804 for adaptive networking enable a financial infrastructure module 1806 for intelligent edge for distributed transactions. Converging technology stack examples 1808 at the network layer 1820 include edge and cloud, communications (e.g., cellular, WiFi, ORAN, Bluetooth), and Internet of Things. Intelligent edge for distributed transactions infrastructure uses AI and expert systems in edge devices to enable localized transactions at points of sale or use.

In embodiments, Intelligent Edge for Distributed Transactions modules use AI and expert systems in edge devices to enable localized transactions at points of sale or use. In embodiments, an intelligent edge for distributed transactions financial infrastructure module is innovatively enabled by adaptive networking artificial intelligence (AI). This module is designed to facilitate seamless and secure financial transactions across a distributed network by leveraging AI to dynamically adapt network configurations and optimize data flow. The integration of edge computing with cloud services ensures that transaction processing can occur closer to the data source, reducing latency and enhancing real-time decision-making capabilities. The module's AI algorithms are capable of intelligently routing transaction data through the most efficient network paths, whether they be cellular, WiFi, Open Radio Access Network (ORAN), Bluetooth, or other IoT communication protocols. For implementation, the module may utilize technical features such as machine learning for predictive network traffic management, ensuring bandwidth is allocated where needed most, and cryptographic techniques for securing data at the edge. Additionally, the module may employ AI-driven anomaly detection systems to monitor network health and preemptively address potential disruptions. The use of containerization and microservices architectures allows for rapid deployment and scaling of transaction processing capabilities across the network. By integrating these technical features, the intelligent edge module provides a robust infrastructure capable of supporting the complex requirements of modern distributed financial transactions, ensuring that they are executed swiftly, reliably, and in compliance with regulatory standards.

At the data layer 1822, AI capabilities 1804 for sensor fusion enable a financial infrastructure module 1806 for context aware sensor fusion to inform transaction analytics and AI. Converging technology stack examples 1808 at the data layer 1822 include sensor data, social and web data, and APIs, SOA and distributed data. Context aware sensor fusion to inform transaction analytics and AI modules integrate disparate sensor data and feed AI to classify, predict, and optimize various parameters for analytic reporting and transaction automation.

In embodiments, Context Aware Sensor Fusion to Inform Transaction Analytics and AI modules integrate disparate sensor data and feed AI to classify, predict, and optimize various parameters for analytic reporting and transaction automation. In embodiments, a financial module for context aware sensor fusion to inform transaction analytics and AI is enabled by the integration of sensor fusion technology. This module is adept at synthesizing diverse data streams, including real-time sensor data, social media analytics, and web data, to provide a comprehensive view of transactional environments. By employing sensor fusion, the module may aggregate and process data from various sources, such as IoT devices, user interaction logs, and online behavior patterns, to generate a multidimensional context for each transaction. The use of APIs and Service-Oriented Architecture (SOA) facilitates the seamless integration and exchange of data across distributed systems, ensuring that the module has access to the most relevant and up-to-date information. Technical features for implementation may include advanced data normalization techniques to harmonize disparate data formats, machine learning algorithms for pattern recognition and predictive analytics within the fused data sets, and robust data security protocols to protect sensitive transactional information. The module's AI component may utilize the enriched data to enhance transaction analytics, providing insights into customer behavior, market trends, and potential fraud risks. By leveraging these technical features, the context aware sensor fusion module may significantly improve the accuracy and reliability of financial transaction analytics, enabling businesses to make data-driven decisions with greater confidence and strategic foresight.

At the resource layer 1824, AI capabilities 1804 for resource optimization enable a financial infrastructure module 1806 for financial and computational resource optimization. Converging technology stack examples 1808 at the resource layer 1824 include advanced computation, leverage optimization, and risk shifting and optimization. Financial and computational resource optimization infrastructure automates and optimizes transactions involved in acquiring, using, and/or selling energy, computational, and other resources needed for enterprise activities.

In embodiments, Financial and Computational Resource Optimization modules automate and optimize transactions involved in acquiring, using, and/or selling energy, computational, and other resources needed for enterprise activities. In embodiments, a financial and computational resource optimization financial infrastructure module is enhanced by resource optimization AI. The module may be designed to optimize the allocation and utilization of both financial and computational resources through the application of advanced AI algorithms. In the context of advanced computation, the module may employ AI to dynamically allocate processing power and memory resources across various financial applications, ensuring optimal performance and cost-efficiency. For leverage optimization, the AI may analyze financial leverage ratios in real-time, adjusting investment strategies and capital distributions to balance returns against risk exposure. Risk shifting and optimization may be achieved through AI-driven models that predict market volatility and credit risk, enabling proactive rebalancing of portfolios to mitigate potential losses. Technical features enabling these implementations may include deep learning networks for complex financial modeling, real-time analytics engines for monitoring resource utilization, and evolutionary algorithms that adapt financial strategies to changing market conditions. Additionally, the module may incorporate distributed ledger technology for transparent tracking of resource allocation decisions and smart contracts for the automated execution of optimization strategies. By integrating these technical features, the resource optimization modules provide a sophisticated framework for maximizing the efficiency and effectiveness of financial and computational resource management within the financial sector.

The evolution of digital assets has created a growing demand for enterprises to efficiently manage these assets. Just as enterprises have historically managed physical goods transactions and logistics, they now face similar challenges with digital transactions, along with unique issues specific to digital assets.

Digital assets present distinct challenges compared to physical assets. While counterfeit physical goods are possible, the energy, expertise, and equipment requirements often inherently limit copying and help maintain authenticity. In contrast, digital assets are typically easier to replicate due to the fundamental read/write functionality of computing systems, allowing effortless duplication with minimal loss. This ease of duplication creates complications when digital assets are widely copied and modified, making it difficult to determine valid versions among many variants. These provenance and validity challenges are further complicated by dynamic digital assets like smart contracts and dynamic objects that update automatically through network connections, often through linkages to other dynamic objects of uncertain origin.

The platform provides comprehensive transaction support through a layered architecture that includes governance, enterprise, offering, transactions, operations, network, data and resource layers. This architecture enables automated transaction orchestration, counterparty discovery, transaction fulfillment and reconciliation while maintaining compliance through embedded policy and governance capabilities.

The system implements intelligent transaction engines and forecasting engines that leverage various data sources including social media, automated agent behavioral data, human behavioral data, entity behavioral data, and IoT data to inform transaction decisions. Advanced capabilities like automated spot market testing, arbitrage transaction execution, and intelligent resource allocation help optimize transaction outcomes.

The transaction layer includes modules for API integration, authentication and security, transaction execution, orchestration, discovery, fulfillment and reconciliation. These modules work together to enable comprehensive transaction management across spot markets, forward markets, and other trading venues while maintaining security and regulatory compliance.

The operations layer provides capabilities for AI system generation, training, adaptation, orchestration, monitoring and governance to ensure optimal transaction processing. This is complemented by network layer modules that enable adaptive routing, edge computing, and integration with various communication protocols and networks.

Through this architecture, the platform enables enterprises to efficiently manage digital asset transactions while addressing key challenges around asset validity, provenance tracking, and automated execution within a secure and compliant framework.

In embodiments, the transaction system may integrate with open banking and banking-as-a-service capabilities through the enterprise access layer to enable expanded financial services functionality. The system may leverage APIs and secure integration frameworks to connect with banking institutions, payment service providers, and financial marketplaces while maintaining compliance through automated governance checks.

In embodiments, the transaction orchestration system may coordinate with banking-as-a-service providers to facilitate various payment processes including payment authorization, transaction routing, and settlement tasks. The system may electronically connect entities such as payment service providers, acquirers, and banks to communicate appropriate information for executing transactions.

In embodiments, the system may implement digital wallets that interface with open banking APIs to access account information, initiate payments, and manage financial transactions across multiple institutions. The digital wallets may be configured as either custodial or non-custodial depending on security requirements and enterprise preferences.

In embodiments, the transaction system may employ a wallet-of-wallets configuration to partition and manage different types of banking and financial assets. The system may associate digital assets with specific wallets based on attributes such as business unit, marketplace, transaction type, or geographic region. This enables segregated management of open banking integrations and banking-as-a-service capabilities across different parts of the enterprise.

In embodiments, the system may leverage artificial intelligence capabilities to optimize banking transactions and services. This may include using machine learning models for automated transaction monitoring, fraud detection, and routing optimization across multiple banking networks and marketplaces. The system may analyze liquidity pools, calculate optimal transaction costs, and determine efficient routing paths between financial institutions.

In embodiments, the transaction system may implement automated governance through embedded policy and governance AI capabilities when interfacing with banking services, ensuring continuous compliance monitoring and automated reporting across open banking and banking-as-a-service integrations. The system may enforce regulatory standards and enterprise policies while maintaining detailed audit trails of all banking transactions.

### Enterprise Layer

In embodiments, the techniques described herein relate to a computer-implemented system for managing a set of machine learning systems, a set of artificial intelligence systems, and/or set of neural networks within an enterprise ecosystem, the system including: a processor; a memory storing instructions that, when executed by the processor, cause the system to: integrate a set of machine learning systems, a set of artificial intelligence systems, and/or set of neural networks with an enterprise access layer (EAL) that interfaces with a plurality of enterprise resources; automate the collection, storage, presentation, streaming, monitoring and analysis of data, content, processing protocols and the like, and related metadata by interfacing the a set of machine learning systems, a set of artificial intelligence systems, and/or set of neural networks within workflow systems of the enterprise; utilize a data services system to manage enterprise management and control platforms; implement an intelligence system to provide predictive analytics for trends and demand forecasting within the enterprise management and control platforms; enforce security and compliance through a permissions system that controls access to functions of the enterprise management and control platforms; manage digital transactions via a wallets system that interfaces with the enterprise management and control platforms; and generate reports on platform activity through a reporting system that is communicatively coupled with the enterprise management and control platforms

In embodiments, the techniques described herein relate to a computer-implemented system for facilitating actions within enterprise management and control platforms, including: a processor; a memory storing instructions that, when executed by the processor, cause the system to: integrate enterprise management and control platforms with an enterprise's digital infrastructure; automate transactional processes by interfacing the enterprise management and control platforms with a workflow system of the enterprise; manage listings, transactions, and user profiles using a data services system; provide analytics and insights for strategic decision-making within the enterprise management and control platforms through an intelligence system; enforce security and compliance protocols via a permissions system that controls access to the enterprise management and control platforms; and facilitate digital transactions through a wallets system that interfaces with the enterprise management and control platforms.

In embodiments, the EAL may be configured to interact with the platform users (and the ecosystem(s) in which they interact) in a variety of ways. For example, the EAL may be integrated or associated with one or more marketplaces or platforms such that the EAL functions as its own market or platform participant on behalf of the enterprise. By being associated with potentially numerous marketplaces or platforms, the EAL can perform complex or multi-stage actions, including but not limited to transactions, with enterprise assets (e.g., in a series or sequence of timed stages, simultaneously in a set of parallel transactions, or a combination of both).

In addition to marketplaces, the EAL may interact with platform users via third-party systems, some or all of which may be implemented as third-party services.

In embodiments, the EAL may include a number of EAL systems (also referred to as modules or EAL modules herein) that enable the functionality of the EAL. In some examples, these EAL systems may be deployed in a container that is specific to the EAL. When deployed in a container for the EAL, this containerized instance means that the EAL may include the necessary tools and computing resources to operate (i.e., host) the EAL systems without reliance on other computing resources associated with the enterprise (e.g., computing resources such as processors and memory dedicated to the EAL). For example, the container for the EAL may include a set of one or more systems, such as software development kits, application programming interfaces (APIs), libraries, services (including microservices), applications, data stores, processors, etc. to execute the functions of the EAL systems that may enable the EAL to provide enterprise management and other functions and capabilities described throughout this disclosure. References herein to “EAL systems” should be understood to encompass any of the foregoing except where context dictates otherwise.

In some implementations, a set of the EAL systems may leverage computing resources considered to be external to the EAL (e.g., separate from computing resources that have been dedicated to the EAL, such as, in embodiments, computing resources shared with other enterprise applications or systems). In these implementations, the set of EAL systems leveraging external computing resources may be in communication with computing resources specific to the EAL. This type of arrangement may be advantageous when one or more of the EAL systems are computationally expensive and would increase the computational requirements for an entirely contained EAL, such as when one or more of the EAL systems causes the EAL to be a relatively expensive EAL deployment. For instance, an arrangement leveraging external (e.g., shared) systems may be beneficial for EAL systems that are infrequently utilized. To illustrate, a first enterprise may rarely use an EAL system, such as a reporting system. Here, instead of ensuring that the EAL has the computational capacity to support a reporting system by itself, the enterprise may configure the reporting system to be hosted by and/or supported by computing resources external to the EAL to deploy a relatively lean form of the EAL (i.e., an EAL container that does not include resources dedicated to a reporting system or that includes only limited resources dedicated to the reporting system with the capability to access additional, external resources as needed).

In some configurations, the EAL or a set of the EAL systems may leverage computing resources considered to be external to the EAL for support. An example of this support may be that the EAL or the set of EAL systems demands greater computing resources at some point in time (e.g., over a resource intensive time period) —for instance, greater may mean more computing resources than a normal or baseline operation state. In this example, for instance, an enterprise resource not dedicated to the EAL or EAL systems can assist or augment the services provided by some aspect of the EAL.

In embodiments, the deployment of the EAL may be configurable. For example, the enterprise or some associated developer can function as a type of architect for the EAL that best serves the particular enterprise. Additionally, or alternatively, the deployed location of the EAL may influence its configuration. For instance, the EAL may be embedded within an enterprise (e.g., non-dynamically) where it can be specifically configured using various module libraries, interface tools, etc. (e.g., as described in later detail). In some examples, the configuring entity is able to select what EAL systems will be included in its EAL. For instance, the enterprise selects from a menu of EAL systems. Here, when an EAL system is selected by the configuring entity, a configuration routine may request the appropriate resources for that EAL system including SDKs, computing resources, storage space, APIs, graphical elements (e.g., graphical user interface (GUI) elements), data feeds, microservices, etc. In some implementations, in response to the request, the configuring entity can dedicate the identified resources of each selected EAL system. For instance, the configuring entity associates the dedicated resources to a containerized deployment of the EAL that includes the selected EAL systems.

In embodiments, the EAL may include a set of EAL systems. The set may include an interface system, a data services system, an intelligence system, a scoring system, a data pool system, a workflow system, a transaction system (also referred to as a wallet system or a digital wallet system), a governance system, a permissions system, a reporting system, and a digital twin system. Additionally, although particular types of EAL systems are described herein, the functionality of one or more EAL systems is not limited to only that particular EAL system but may be shared or configured to occur at another EAL system. For instance, in some configurations, some functionality of a transaction system may be performed by the data services system or functionality of the governance system may be incorporated with an intelligence system. In this respect, the EAL systems may be representative of the capabilities of the EAL more broadly. In embodiments, the set of EAL systems involved in any particular configuration of the EAL may include any of the systems described throughout this disclosure and the documents incorporated by reference herein, such as systems for counterparty discovery, opportunity mining, automated contract configuration, automated negotiation, automated crowdsourcing, automated facilitation of robotic process automation, one or more intelligent agents, automated resource optimization, resource tracking, and others.

In some embodiments, one or more of these systems may be configurable. The configurations may be done by selecting pre-defined configurations/plugins, by building customized modules, and/or by connecting to third party services that provide certain functionalities.

In some embodiments, aspects of a configured EAL may be dynamically reconfigured/augmented. In some examples, reconfiguration/augmentation may include updating certain data pool configurations, redefining certain workflows, changing scoring thresholds, or the like. Reconfiguration may be initiated autonomously (for example, the EAL periodically tests configurations of certain aspects of the EAL configuration using the digital twin simulation system and analytics system) or may be expert-driven (e.g., via interactions between an EAL “expert” and an interactive agent via a GUI of the interface system).

In embodiments, the data services system may perform data services for the EAL, which may include a data processing system and/or a data storage system. This may range from more generic data processing and data storage to specialty data processing and storage that demands specialty hardware or software. In some examples, the data services system includes a database management system to manage the data storage services provided by the data services system. In some configurations, the database management system may be able to perform management functions such as querying the data being managed, organizing data for, during, or upon ingestion, coordinating storage sequences (e.g., chunking, blocking, sharding), cleansing the data, compressing or decompressing the data, distributing the data (including redistributing blocks of data to improve performance of storage systems), facilitating processing threads or queues, etc. In some examples, the data services system couples with other functionality of the EAL. As an example, operations of the data services system, such as data processing and/or data storage, may be dictated by decision-making or information from other EAL systems such as an intelligence system, a workflow system, a transaction system, a governance system, a permissions system, a reporting system, and/or some combination thereof.

It is appreciated that workflows may be deployed in any number of scenarios. Examples of scenarios where workflows may be deployed by an EAL include permission workflows, access workflows, data collection workflows, data pool workflows, machine learning workflows, artificial intelligence workflows, governance workflows, scoring workflows, transaction workflows, governance workflows, industry or vertical-specific workflows, enterprise-specific workflows, and other suitable workflows. It is appreciated that the example types of workflows provided above may overlap (e.g., a governance workflow may be an industry-specific and/or enterprise-specific workflow). Furthermore, some workflows may trigger one or more other workflows. For example, when a certain type of transaction is executed by a transaction system of an EAL, a transaction workflow corresponding to the type of transaction may define a series of tasks that are performed before the transaction is executed. In another example, as part of a data pool workflow that establishes a data pool that is accessible by third-parties, the data processing workflow may trigger a governance workflow that ensures that any enterprise data being added to the data pool confirms with certain data sharing rules (e.g., obfuscation of sensitive data, complying with privacy rules, scrubbing metadata, and/or the like) and may trigger a scoring workflow that scores each third-party that will access the data pool. Furthermore, EAL workflows may share a common framework for respective EAL functions and scenarios; however, individual workflows deployed with respect to respective EAL instances may vary in complexity from very basic workflow implementations (e.g., configured to execute on a user device or sensor device) to complex workflows with multiple dependencies and/or embedded “sub-workflows” (e.g., configured to execute by a central server system and/or by multiple enterprise devices).

In embodiments, a digital twin system may perform simulations of the enterprise's products and services that incorporate real-time data obtained from the various entities of the enterprise or third parties. In some of these embodiments, the digital twin system may recommend decisions to a user interacting with the enterprise digital twins.

In embodiments, an artificial intelligence module may include and/or provide access to a digital twin module. The digital twin module may encompass any of a wide range of features and capabilities described herein In embodiments, a digital twin module may be configured to provide, among other things, execution environments for and different types of digital twins, such as twins of physical environments, twins of robot operating units, logistics twins, executive digital twins, organizational digital twins, role-based digital twins, and the like. In example embodiments, a digital twin module may be configured to generate digital twins that are requested by intelligence clients. Further, the digital twin module may be configured with interfaces, such as APIs and the like for receiving information from external data sources. For instance, the digital twin module may receive real-time data from sensor systems of a machinery, vehicle, robot, or other device, and/or sensor systems of the physical environment in which a device operates. In embodiments, the digital twin module may receive digital twin data from other suitable data sources, such as third-party services (e.g., weather services, traffic data services, logistics systems and databases, and the like). In embodiments, the digital twin module may include digital twin data representing features or states, as well as demand entities, such as customers, merchants, stores, points-of-sale, points-of-use, and the like. The digital twin module may be integrated with or into, link to, or otherwise interact with an interface (e.g., a control tower or dashboard), for coordination of supply and demand, including coordination of automation within supply chain activities and demand management activities.

In embodiments, a digital twin module may provide access to and manage a library of digital twins. A plurality of artificial intelligence modules may access the library to perform functions, such as a simulation of actions in a given environment in response to certain stimuli.

In example embodiments, the digital twin(s) may be implemented with smart contracts, such as for digital twin transactions enabled by smart contracts (e.g., using smart contract orchestration engines).

In embodiments, an enterprise access layer system of systems (ELS) may manage and integrate EAL methods and systems, technological systems, data streams, platforms, and operational processes. Current enterprises face challenges in coordinating across different business units and technology stacks, creating a need for an intelligent enterprise access layer capable of parallel task execution and advanced analytics capabilities. The ELS, as described herein, implements a comprehensive architecture that enables parallel processing of intelligence tasks across multiple domains while maintaining data consistency and security protocols. The system's core architecture comprises processing unit(s) integrated with memory system(s) storing executable instructions, multiple machine learning systems, artificial intelligence engines, and neural network arrays, supported by data storage systems, communication interfaces, security modules and connections or associations with third party systems, platforms or operations.

In embodiments, the ELS may execute system simulations utilizing neural network models to provide predictive analytics for business forecasting. The system may continuously update simulations in real-time based on, for example, operational data, enabling dynamic scenario modeling and analysis for enhanced decision-making processes.

In embodiments, the ELS may implement digital twin and management capabilities, generating Metaverse environments, such as industrial Metaverse environments, that enable real-time synchronization between physical and digital assets. These digital representations may facilitate virtual testing and validation of industrial systems before physical implementation.

In embodiments, the ELS may establish centralized value chain network control tower operations while simultaneously managing distributed mini control towers for local optimization purposes. This hierarchical approach may enable comprehensive real-time supply chain visibility and control, supported by sophisticated automated decision support systems for network optimization.

In embodiments, the ELS may incorporate big data processing and analytics capabilities, seamlessly integrating with Industrial Internet of Things platforms. This integration may include real-time sensor data analysis and predictive maintenance optimization across industrial operations.

In embodiments, the ELS may deliver automated industrial operational control through AI-driven process optimization systems. The ELS may continuously performs real-time adjustments of manufacturing parameters while maintaining comprehensive quality control and compliance monitoring protocols.

In embodiments, the ELS may enable enterprise system integration through AI-enhanced transaction processing capabilities. This integration may facilitate automated workflow management and ensures precise cross-system data synchronization across the enterprise environment.

In embodiments, the ELS may implement intelligent supply chain optimization algorithms coupled with sophisticated demand shaping and forecasting capabilities. The system may provide comprehensive inventory management optimization while facilitating effective supplier relationship management processes.

In embodiments, the ELS may deploy executive digital twins for fleet management, enabling vehicle simulation and design optimization. The ELS may manage complex fleet transaction processing while integrating with software-defined vehicle systems for enhanced operational control.

In embodiments, the ELS may incorporate energy operations digital twins within a system of systems integration framework for comprehensive energy management. The system may process energy transactions while performing AI-based energy optimization across the enterprise.

In embodiments, the ELS may implement multiple machine learning approaches, including supervised learning algorithms for pattern recognition and unsupervised learning systems for anomaly detection. The ELS may utilize reinforcement learning for optimization processes and deep learning capabilities for complex analysis tasks.

In embodiments, the ELS may deploy specialized neural network architectures, including convolutional neural networks for image processing applications and recurrent neural networks for sequence analysis. The system may utilize transformer networks for natural language processing tasks and implements graph neural networks for relationship analysis.

In embodiments, the ELS may coordinate multiple AI systems through a hierarchical task distribution framework, implementing parallel processing optimization and resource allocation management. The ELS may enable cross-system learning integration for enhanced operational efficiency.

In embodiments, the ELS may implement comprehensive security measures including role-based access control systems and multi-factor authentication protocols. The system may maintain detailed activity monitoring and logging while enforcing robust security policies.

In embodiments, the ELS may implement end-to-end encryption protocols and secure data transmission mechanisms. The system may incorporate privacy preservation techniques while maintaining compliance monitoring and reporting capabilities.

In embodiments, the ELS may integrate with existing enterprise resource planning systems, customer relationship management platforms, manufacturing execution systems, and supply chain management systems. This integration may enable data flow and process coordination across the enterprise environment.

In embodiments, the ELS may maintain connections with cloud services, partner networks, and external data sources while enabling integration with third-party applications. This connectivity may ensure data access and process coordination across the extended enterprise ecosystem.

In embodiments, the ELS may implement horizontal and vertical scaling capabilities supported by dynamic resource allocation mechanisms. The ELS may maintain load balancing capabilities while performing continuous performance monitoring to ensure optimal system operation.

In embodiments, the ELS may incorporate fault tolerance mechanisms and redundancy management systems.

The implementation may include disaster recovery capabilities and continuous system health monitoring to ensure sustained operational reliability.

In embodiments, in manufacturing operations, the ELS may enable production optimization through real-time monitoring and adjustment of manufacturing parameters. The system may continuously analyze production data to automatically optimize resource allocation and scheduling, while maintaining quality control standards. For example, in an automotive manufacturing facility, the ELS may monitor assembly line operations in real-time, automatically adjusting robotic systems and process parameters to maintain optimal production efficiency and product quality.

In embodiments, the ELS may implement predictive maintenance scheduling by analyzing equipment sensor data through its IoT integration capabilities. This may allow manufacturing facilities to prevent unexpected downtime by identifying potential equipment failures before they occur. The ELS may coordinate maintenance activities across multiple production lines while optimizing resource utilization and minimizing operational disruptions.

In embodiments, in supply chain applications, the ELS may implement optimization through real-time monitoring and analysis of stock levels, demand patterns, and supplier performance. The system may utilize its forecasting capabilities to predict demand fluctuations and automatically adjust inventory levels across multiple distribution centers. For instance, in a consumer goods supply chain, the system may continuously analyze point-of-sale data, weather patterns, and seasonal trends to optimize stock levels and distribution patterns. The system's value chain network control capabilities may enable logistics planning through its centralized control tower operations. The ELS may coordinate multiple distribution nodes, optimizing delivery routes and transportation resources while maintaining real-time visibility of all shipments. The system may automatically adjust logistics plans based on real-time conditions, such as weather disruptions or transportation delays, ensuring efficient delivery operations.

In embodiments, The ELS may create digital twin representations of manufacturing facilities and supply chain networks, enabling virtual testing and optimization before physical implementation. For example, in a pharmaceutical manufacturing environment, the system may simulate production processes and supply chain operations, allowing operators to test different scenarios and optimize procedures without disrupting actual operations. These digital twins may maintain real-time synchronization with physical assets, providing accurate representations of current operational states.

In embodiments, the ELS may implement AI-driven process optimization across manufacturing and supply chain operations through its machine learning and neural network architectures. For example, in a chemical manufacturing facility, the ELS may continuously analyze process parameters and product quality data, automatically adjusting production variables to maintain optimal output while ensuring compliance with quality standards. The system's reinforcement learning capabilities may enable continuous improvement of operational parameters based on historical performance data.

In embodiments, within manufacturing environments, the ELS may optimize energy consumption patterns through its energy management capabilities. The system may analyze production schedules, energy pricing, and operational requirements to optimize energy usage while maintaining production efficiency. For example, in an industrial processing facility, the system may automatically adjust production scheduling to take advantage of off-peak energy rates while ensuring production targets are met.

In embodiments, the ELS may demonstrate integration capabilities by connecting manufacturing execution systems, supply chain management platforms, and enterprise resource planning systems. This integration may enable data flow and coordination across all operational aspects. For instance, in a consumer electronics manufacturing operation, the system may coordinate production planning with supply chain logistics and inventory management, ensuring efficient resource utilization and timely delivery of finished products.

In embodiments, the ELS may implement a multi-layered neural network architecture that combines multiple specialized networks for different processing tasks. The system may utilize convolutional neural networks specifically designed for image processing applications, while implementing recurrent neural networks for analyzing sequential data patterns. Additionally, transformer networks may handle natural language processing tasks, and graph neural networks process relationship analysis across the system. In embodiments, the ELS may coordinate these neural networks through a machine learning integration framework that implements multiple advanced approaches. The system may utilize supervised learning algorithms for pattern recognition tasks, while simultaneously deploying unsupervised learning systems for anomaly detection. Reinforcement learning capabilities may be implemented for continuous optimization processes, while deep learning systems may handle complex analysis tasks requiring sophisticated pattern recognition. In embodiments, the ELS may manage the practical implementation of these systems through a hierarchical task distribution framework that enables efficient parallel processing optimization. The system may implement sophisticated resource allocation management protocols to ensure optimal utilization of computing resources across different AI subsystems. This framework facilitates cross-system learning integration, allowing different AI components to share and leverage insights across various operational domains.

In embodiments, the ELS may include a central processing unit that coordinates various AI and machine learning components through integrated memory systems storing executable instructions. The system architecture may enable parallel processing of intelligence tasks across different domains while maintaining data consistency through synchronization protocols. The implementation may include dedicated data storage systems and communication interfaces that facilitate interaction between different neural network and machine learning components.

In embodiments, the ELS may implement real-time processing capabilities through its neural network arrays and AI engines. These components may work in concert to process operational data, enabling continuous updates to simulations and forecasting models. The system may maintain real-time synchronization between physical and digital assets through its digital twin implementation, allowing for immediate feedback and adjustment of operational parameters.

In embodiments, the ELS may include neural network and machine learning systems that operate within a comprehensive security framework that implements end-to-end encryption and secure data transmission protocols. The system may maintain privacy preservation techniques while enabling the AI components to process and analyze data without compromising security protocols.

In embodiments, the ELS may enable enterprise system integration through dedicated communication interfaces that connect with ERP systems, CRM platforms, manufacturing execution systems, and supply chain management systems. For external connectivity, the ELS may maintain connections with cloud services, partner networks, external data sources, and third-party applications through its communication interfaces and integration modules.

The system architecture may include communication interfaces and security modules that enable data synchronization while maintaining security protocols. This may include end-to-end encryption for data transmission and privacy preservation techniques for sensitive information exchange.

In embodiments, the ELS may include an integration framework that supports automated workflow management and cross-system data synchronization capabilities to ensure consistent data flow across connected enterprise systems. For performance optimization, the system may implement horizontal and vertical scaling capabilities along with dynamic resource allocation and load balancing to maintain efficient system integration and data exchange. The system's reliability features may include fault tolerance mechanisms and redundancy management to ensure consistent integration performance, while system health monitoring maintains stable connectivity with integrated enterprise systems.

Example embodiments include, but are not limited to the ELS having a set of machine learning systems, a set of artificial intelligence systems, and/or set of neural networks configured to 1) execute a set of intelligence tasks associated with a set of simulations, and 2) execute a set of intelligence tasks associated with forecasting, and 3) execute a set of intelligence tasks associated with a set of digital twins, and 4) execute a set of intelligence tasks associated with the Industrial Metaverse, and 5) execute a set of intelligence tasks associated with a value chain network control tower, and 6) execute a set of intelligence tasks associated with a set of value chain network mini control towers, and 7) execute a set of intelligence tasks associated with big data and/or analytics, and 8) execute a set of intelligence tasks associated with a set of executive digital twins, and 9) execute a set of intelligence tasks associated with an industrial internet of things (IIoT) platform, and 10) execute a set of intelligence tasks associated with AI-based industrial operational control, and 11) execute a set of intelligence tasks associated with an AI-driven Industrial Metaverse, and 12) execute a set of intelligence tasks associated with a set of financial executive digital twins, and 13) execute a set of intelligence tasks associated with enterprise transaction systems integration, 14) execute a set of intelligence tasks associated with an enterprise access layer, and 15) execute a set of intelligence tasks associated with AI-based enterprise transactional decision support, and 16) execute a set of intelligence tasks associated with a set of supply chains, and 17) execute a set of intelligence tasks associated with demand shaping integration, and 18) execute a set of intelligence tasks associated with a value chain network system of systems, and 19) execute a set of intelligence tasks associated with a set of executive digital twins for vehicle fleet operations, and 20) execute a set of intelligence tasks associated with a set of vehicle digital twins for design and simulation, and 21) execute a set of intelligence tasks associated with an enterprise access layer for fleet transactions, and 22) execute a set of intelligence tasks associated with software defined vehicle management, and 23) execute a set of intelligence tasks associated with a set of executive digital twins for enterprise energy operations, and 24) execute a set of intelligence tasks associated with enterprise energy system of systems integration, and 25) execute a set of intelligence tasks associated with an enterprise access layer for energy transactions, and 26) execute a set of intelligence tasks associated with AI-based enterprise transactional decision support for energy management.

### Building Trust and Distributing Decisions in Digital Twins

Throughout this disclosure and the documents incorporated by reference herein, various embodiments are provided of digital twin platforms and systems that leverage sensors and other information sources, robust connectivity, and intelligence systems to allow users to experience accurate representations of the states and activities of the many entities that are involved in the workflows of an individual, group or enterprise (e.g., a company, business unit, department, government, household, non-profit, or other enterprise). These include, among others, role-based digital twins that can be configured, or that self-configure, how data is collected, stored, processed and/or presented in ways that account for the roles of respective users (e.g., ones directed to financial users, strategic users, operational users, many others). Digital twins also include adaptive digital twins that leverage intelligence systems, such as artificial intelligence, analytic systems, expert systems, or hybrids involving various permutations and combinations thereof, to adapt how data is collected, stored, processed and/or presented based on context, such as based on the content of the information that is collected and processed. Among these adaptive digital twins, a subset, AI-driven digital twins, may use component artificial intelligence systems at any of the stages of the pipeline of information from a sensor or other basic information source to the presentation of content to a user. Artificial intelligence systems can provide outputs along a spectrum of autonomy, including: a) presenting reports, alerts, classifications, predictions, recommendations, analyses and other outputs for human review and action; b) undertaking human-supervised control of one or more aspects of a workflow, where the artificial intelligence system (acting as a co-pilot, assistant, intelligent agent, or the like to a human user) outputs a prediction and/or a recommendation for an action (which may be embodied in an instruction that can be processed by a system), and a human confirms, or adjusts, the nature of the action before it is implemented; and c) undertaking autonomous control of one or more systems or subsystems, where the artificial intelligence processes relevant information, completes necessary classifications, predictions and other decision-making steps (including where applicable, confirming risk management, governance, self-reflection or other steps) and triggers an action (such as by providing an instruction, control signal, or the like) to a system or component.

Along this spectrum from basic reporting to full autonomy, there is a varying extent to which there is a human being in the decision-making loop. Artificial intelligence systems have enormous promise to automate individual, group and enterprise workflows, providing more reliable, seamless monitoring of ongoing activities, faster response times to unexpected events, and more efficient execution of many types of tasks, among many other benefits. However, the extent to which AI systems can be trusted can vary widely, such as based on: a) the stakes involved (e.g., are there risks to human life, health or property in making a wrong decision?); b) how the AI system was trained (e.g., are there reasons to believe that there is bias in the training data that will be carried forward into the outputs of the AI system); c) how the AI system is governed or supervised (e.g., is in compliance with regulatory, legal or other governance frameworks embedded in the workloads of the system as contemplated in this disclosure and the documents incorporated by reference herein, or is there a need for separate governance or supervision?); d) how the AI system performs, in absolute terms and relative to other available systems, including other AI systems, analytic systems, or human beings (experts, other individuals, groups, or crowds, for example); e) the quality, type and/or availability of data (which can include factoring in the cost of the data); f) the quality, type and/or availability of connectivity (which can include factoring in the cost of the connectivity); g) the quality, type and/or availability of computational resources (which can include factoring in the cost of the computational resources); h) the quality, type and/or availability of other necessary resources (e.g., energy); i) environmental or contextual parameters of the workflow to which the AI system will be applied (such as the complexity of a physical environment, the presence of human beings in proximity, or the like); and other factors. As an example among many, a well-trained AI system may be highly capable of driving a vehicle down a highway during daylight, doing so more safely than a human being who could be prone to sleepiness or distraction, but if computational, networking, or other resources are uncertain, it may be decided that the AI system should not be trusted to perform the task. Decisions about the extent to which one can trust an artificial intelligence system can be very difficult, and the extent of trust is a major factor in determining whether or not AI systems, and their many benefits, can be unlocked.

A major benefit of the various digital twin systems disclosed herein is that a digital twin platform, particularly one that is adaptive and self-configuring, can provide an ideal environment for decision making. Good decisions usually need a combination of a) fresh, accurate, relevant information; b) application of some degree of expertise; c) use of judgment to consider tradeoffs of risks; and/or d) leadership to cause implementation (which may encompass, among other things, taking on the consequences when outcomes are unfavorable). Each of these attributes can be supported by the data collection, storage and processing systems, connectivity systems, computational systems and intelligence systems described throughout this disclosure and the documents incorporated by reference herein. For example, a pipeline of IoT and edge devices and high QoS networks (adaptive networking) can pass granular, real-time sensor data about all entities in an operating environment (machines, components, humans, infrastructure, etc.), which manifests in visibility, such as for big data analytics and consulting use cases, as well as data for machine learning. Data architectures (e.g., adaptive sensing and data collection; edge query language; intelligent data storage and processing layers) and advanced computational architectures (hybrid cloud, edge, and quantum computing) can be used to optimize conditions for application of human and machine intelligence. For example, data architectures can adapt visual representations for human cognitive processing (including based on the skillset, role, experience, expertise, or cognitive parameters of a human, such measured by neurometrics, psychometrics, or other systems) and/or prepare and stage data for artificial intelligence systems (including by cleansing, deduplication, generation of synthetic data, entity resolution, normalization and other processing, generation of various embeddings that use one AI system (e.g., a trained neural network) to transform and/or compressed input data into outputs that are suitable for efficient processing by AI systems, and the like). Computational architectures can be adapted to use an appropriate mix of cloud, edge and on-device processing systems (including various chipsets described herein, such as AI chipsets and hybrid chipsets involving AI and other functions integrated together). This can include quantum computing where beneficial. Systems integration, including various configurations of systems, systems-of-systems and the like into platform and infrastructure solutions (including PaaS and IaaS configurations), with various architectures, including service-oriented architectures, microservices architectures, and the like, can integrate all relevant systems across an individual's or group's set of activities, an enterprise, or an entire business ecosystem, such that a digital twin can have access to current state and activity parameters for many relevant entities. Data and sensor fusion, such as involving sensor data and many other data sets can assist in tracking or predicting outcomes (environmental data, market data, transaction data and many others). Advanced artificial intelligence techniques can combine with human insight to generate expert systems and models that understand and predict operational states, flows and more complex behaviors reflected in data (big data analytics and advanced artificial intelligence techniques), including compact models that are capable of operating effectively on sparse data and/or constrained computational architectures at the edge, as well as generative AI outputs that provide summaries, creative content, instructions, reports, and many other outputs from various inputs, including text, image, video, audio and multi-modal generative AI systems. AI-driven stakeholder interfaces can adaptively filter, prioritize, and distribute information for planning, simulation, decision making and operational action to appropriate stakeholders across an entire enterprise.

With the above stack of integrated systems, taking the form of the many embodiments disclosed herein and in the document incorporated herein by reference, distribution of control, of the various disparate systems, systems-of-systems, components, platforms, infrastructure elements, and other entities involved in the activities of an individual, group, or various levels and roles of enterprise can be enabled, with consideration being given, as noted above, to factors such as latency, security, safety, operational efficiency, reliability and trust.

The untapped power of the digital twin is its ability to enable collaboration, and to distribute decision making, to the right mix of human beings, artificial intelligence systems and other systems, whether in an enterprise or in the activities of an individual or group. The digital twin allows incremental change, experimentation, and easily reversible implementation, removing fear of closing the loop. For example, a digital twin can include a simulation environment that simulates, based on actual historical and current data, what outcomes most likely ensue from deployment of particular configurations of human and artificial intelligence elements in decision making and control loops. The digital twin can also provide a planning environment for deployment of artificial intelligence systems, as well as the data collection, data processing, networking, connectivity, energy, and computational systems and architectures that support them; for example, an enterprise can, using the digital twin, plan various scenarios for obtaining resources to enable more powerful AI systems, comparing projected outcomes at various resource levels and mixes. The digital twin can enable graceful migration among humans, human-AI mixes (e.g., with agents and co-pilots) and autonomous AI systems, including deploying them in ways that can be rapidly adjusted, or reversed, such as based on changing performance capabilities, contextual and environmental factors, and events; for example, an AI system might be permitted to control transactions during normal daily operations, but it could be removed from the loop, or provided with greater human supervision, in the case of major shifts in an environment, such as during severe swings in the market, after an environmental catastrophe, or the like. Thus, provided herein is a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity. Also provided herein is a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. The resources may include ones for data collection, data processing, networking, connectivity, energy, and computational systems and architectures that support them.

As noted throughout this disclosure and the documents incorporated by reference herein disclose the training of machine learning systems in various configurations, including deep learning, supervised learning, semi-supervised learning, and the like. In many such embodiments, a human expert provides input data that is used to train the AI system, such as by tagging data sets to assist in AI classification systems; by producing code, text, images, audio, video and other inputs that are used to train generative AI systems to predict a set of outputs from a prompt; by undertaking activities and behaviors that indicate preferences to train AI systems to generate recommendations; by configuring systems, platforms and architectures that can be used to train AI systems to generate similar configurations and recommendations; by undertaking decisions in various contexts and environments that are used to train AI systems to produce recommendations, make decisions and/or output control signals in similar contexts and environments, among others. In embodiments, any of the machine learning systems or other artificial intelligence systems disclosed herein or in the documents incorporated by reference herein may be embedded in a digital twin for the purpose of enabling training of the digital twin. This may include designating a set of users (such as domain experts, managers, operational supervisors, executives, or the like) as trainers for the AI system, including based on the role, core competency, expertise, experience, or other aspects of the set of users. In embodiments, this may include designating one set of users to provide input data for initial training of a particular AI system and another set of users (possibly overlapping in part with the first set) to supervise the outputs of the AI system. Thus, disclosed herein is a digital twin system with an interface system for designating a set of users as trainers for the creation of an artificial intelligence system that is represented in the digital twin, wherein the artificial intelligence system operates on the data that is used to populate the digital twin. Also disclosed herein is a digital twin system with an interface system for designating a set of users as supervisors for an artificial intelligence system that is represented in the digital twin, wherein the artificial intelligence system operates on the data that is used to populate the digital twin.

In embodiments, provided herein is a digital twin system that displays a set of options for distribution of decision making authority or control across various systems, systems-of-systems or components across a set of entities and workflows. This may be implemented at the level of an individual component or system, such as by allowing a user to configure, within the digital twin, the conditions under which a human (or group of humans, a combined system (human and AI co-pilot, for example), or an AI system alone will be designated as the authority for making a decision. This can include permanent settings (“never” or “always”), semi-permanent settings (e.g., ones that are reviewed on a systematic or episodic basis) and dynamic settings (i.e., where contextual conditions, environmental conditions, or other factors are processed in real time to determine what set of entities will be designed at the decision making authority). In embodiments, decision making authority may be distributed within the digital twin based on a broader decision making framework, such as a hierarchical framework (such as an enterprise hierarchy in which individual workers are organized into groups, with lines of reporting and supervision), a rules-based framework (such as a set of voting rules by which disputes about a decision are resolved), a collaborative framework (such as where prospective alternatives are presented and discussed by a set of contributors seeking a consensus recommendation, optionally involving simulations and planning capabilities noted above), a simulation framework (where, as noted above, the digital twin can simulate outcomes based on historical and real-time data), an enterprise planning framework (which may include integration of the digital twin with enterprise planning systems and dashboard), a competitive framework (such as where alternative options are configured to compete with each other to determine which is superior, optionally involving genetic programming or other evolutionary computing systems, as noted elsewhere in this disclosure), a peer-to-peer framework (e.g., where decisions are negotiated bi-laterally or multi-laterally among entities involved); an algorithmic framework (such as where decisions are reached by a defined set of stages, possibly involving various other frameworks as hybrids in parallel, in series, in iterative loops, or the like), a principles-based framework (such as where a set of personal, group, or enterprise principles (e.g., ethical principles, values, mission statements, or the like) are codified for use when certain contextual decisions are presented), or others. As an example, many daily operational decisions might be configured to be executed autonomously by AI systems, but if those decisions are determined to have an aggregate impact on an element of the mission of an enterprise (such as a mission to continue to develop and employ a set of individuals), then the digital twin can highlight the need to bring an appropriate set of human decision makers into the loop. Thus, in embodiments, provided herein is a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework.

In embodiments, a digital twin may display various metrics to facilitate decisions about what sets and configurations of human and AI systems should be selected for a given system, system-of-systems, component, or the like. These metrics may be calculated using the data available to the digital twin through its processing functions (such as real time information about the user, available human workers, resource availability for AI systems, contextual and environmental information, information about states and activities of the entities involved in various workflows and the like) as well as by using external data sources, such as data indicating performance metrics for individuals (which may include the general population or domain experts, groups (which may include expert groups, crowds (including by crowdsourcing as disclosed elsewhere herein)) or for AI systems (including how the systems perform under various resource conditions). Metrics may include indicators of training history, such as educational experience, work experience, and job reviews, among many others, for humans. Metrics may include training data or metadata for artificial intelligence systems, including the size of the training data set, the vintage of the training data set, the configuration of neural networks used in training, the presence or absence of synthetic data in the training data set, metrics indicating the quality of the training data set (including indicators of bias, autocorrelation, heteroskedasticity or other statistical or econometric indicators), metrics about the expertise or capabilities of the human beings used to seed and/or supervise the AI systems, and many others. As an example, two similar generative AI systems may be presented along with indicators of the time period over which they were trained, allowing a user to evaluate whether the AI systems are likely to miss important context (e.g., where training data from a time period outside one of the sets is likely to have a major influence on the outcome) or generate hallucinations (such as where a spike in unusual training data during a training period may have unduly swayed results). Thus, in embodiments, provided herein is a digital twin system that displays a set of training metrics for a set of humans that are available to perform a set of decision making tasks for a set of entities presented in the digital twin. Also provided herein, in embodiments, is a digital twin system that displays a set of training metrics for a set of hybrid human-AI systems that are available to perform a set of decision making tasks for a set of entities presented in the digital twin. Also provided herein, in embodiments, is a digital twin system that displays a set of training metrics for a set of AI systems that are available to perform a set of decision making tasks for a set of entities presented in the digital twin.

In embodiments, metrics provided within the digital twin may include performance metrics for one or more sets of human and AI entities. Human performance metrics may include metrics for individuals, experts, and groups (including crowds) of the many types, and collected by the many methods and systems, disclosed herein and in the documents incorporated by reference. For individuals, these may include various cognitive, neurometric, psychometric, emotional, attention and other metrics, including ones disclosed herein and in the documents incorporated herein, including collected by neuro-metric measurement systems (e.g., EEG, fMRI and other scanning systems), genomic and transportomics systems, psychometric testing, physiological monitoring systems (including wearable sensors, cameras, IoT systems and many others as disclosed throughout this disclosure), systems for detecting emotional state (e.g., anxiety, distress, anger, calm and others, and others), systems for measuring attention, and others. Human performance metrics may also include metrics of task performance, including quality metrics, output metrics, job assessment metrics, indicators of specific skills, expertise or competencies (e.g., educational credentials, publications and certifications), indicators of success (e.g., rates of return of a business led by the individual) and many others. Human metrics can include metrics for groups, including crowds; for example, outcome metrics from a crowdsourcing system that accumulates the “wisdom of the crowd” for a set of predictions, ideas, solutions, or the like can be compared to those of individual experts and those of various AI systems (including standalone systems and human-AI combinations). AI performance metrics may include a wide range of metrics, including metrics of predictive accuracy, metrics indicating outcomes from use of the systems (including ones accounting for context of use), metrics of computational speed and latency, metrics of resource utilization (e.g., computation, energy, network resources, and the like), and many others. In embodiments, the digital twin may present comparative metrics across human, human-AI combinations and autonomous AI systems (including multiple options for each), so that a user of the digital twin can select, accounting for context of use, an appropriate configuration. Thus, provided herein, in embodiments, is a digital twin system that displays a set of performance metrics for a set of humans that are available to perform a set of decision making tasks for a set of entities presented in the digital twin. Also provided herein, in embodiments, is a digital twin system that displays a set of performance metrics for a set of hybrid human-AI systems that are available to perform a set of decision making tasks for a set of entities presented in the digital twin. Also provided herein, in embodiments, is a digital twin system that displays a set of performance metrics for a set of AI systems that are available to perform a set of decision making tasks for a set of entities presented in the digital twin. Also provided herein, in embodiments, is a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin.

It should be noted that an intelligent agent (referred to in some cases herein as an opportunity miner) can be used to discover sets of available sets of humans, human-AI combinations, and/or artificial intelligence systems that may be capable of improving outcomes of one or more systems, systems-of-systems or other entities represented in the digital twin. In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence. Thus, a digital twin system may be used as a tool for exploration of applications of artificial intelligence as well as for configuring decisions around deployment of artificial intelligence once discovered. Thus, provided herein is an intelligent agent that automatically discovers sets of available systems, among human systems, combined human-AI systems and standalone artificial intelligence systems that are capable of performing a desired function. Also provided herein is a digital twin system having an embedded intelligent agent system that automatically discovers sets of available systems, among human systems, combined human-AI systems and standalone artificial intelligence systems that are capable of performing a desired function.

In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence.

In embodiments, an artificial intelligence system may be trained, such as based on a set of human decisions, a set of outcomes, or the like, and used to configure (or recommend configuration of) deployment of one or more appropriate sets of human, human-AI combinations and autonomous AI systems. This deployment configuration system for artificial intelligence may be integrated or embedded as an enabling service or utility within a digital twin, or it may be a standalone system used to determine what options are to be presented to a user of a digital twin. Thus, provided herein is an intelligent agent that operates as a deployment configuration system to at least one of recommend a set of deployment configuration parameters for or automatically configure a set of deployment parameters for a set of human, human-AI combinations or autonomous AI systems. Also provided herein is a digital twin system having an integrated intelligent agent that operates as a deployment configuration system to at least one of recommend a set of deployment configuration parameters for or automatically configure a set of deployment parameters for a set of human, human-AI combinations or autonomous AI systems.

In embodiments, the various discovery and configuration systems noted above may be based on general metrics of performance (e.g., comparing how humans in general perform relative to artificial intelligence systems at performing particular tasks). In other embodiments, the comparison may be highly contextual and situational, such as comparing the capabilities of specific sets of individuals that will be available at the time of decision making and the capabilities of artificial intelligence systems that will be available, either to operate as standalone systems or to work in human-AI combinations (including the general performance capabilities of the AI systems, and also the available computational, networking, energy and other resources that will be needed to run them). Situational comparison can include contextual factors, such as time of day, workforce availability, market and environmental data, and many others, such that a discovery or configuration system can recommend an appropriate configuration for a particular system, at a given place and time. For example, a moderately expensive AI system that performs well autonomously may be recommended or selected for an overnight control task, where human experts are not likely to be available and where computational, energy, or other resources are less constrained (and less expensive). An intelligent agent, as noted above, may be configured to generate a recommendation, or a configuration, based on multi-factor optimization, using various decision frameworks noted above, including being trained on a set of human decisions and/or on feedback of outcomes from past configuration actions.

Thus, provided herein is an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed.

In embodiments, as noted throughout this disclosure, smart contracts can be integrated with one or more systems of a digital twin, such that they operate on input data (e.g., detection of various events) and produce outputs that reflect transactional terms embedded in the smart contract. This may include, for example, a set of smart contracts that set liability terms relating to the consequences of the outputs of a system to which the smart contract relates. For example, a smart contract may be configured such that the provider of an AI system embedded in the digital twin (or in a system to which the digital twin has access) agrees to provide indemnification, proof of insurance, acceptance of liability, or the like for some set of consequences of using the AI system. Such terms can also include various limitations (e.g., constraints on permitted use; limitations of liability), exclusions, restrictions, and the like, thus providing, in the digital twin, a mechanism for expressly allocating the consequences of selection of a particular mix of human and AI systems to the appropriate person or organization. By referencing the performance metrics noted above, operating in real time on operational and other data, a decision maker can be aided to make a rational decision about implementation of AI, guided by a more reliable estimation of the expected value of implementing a particular mix of human and AI systems, rather than being governed by emotional factors. Thus, provided herein are methods and systems having a smart contract system embedded in a digital twin that sets terms and conditions for liability resulting from the output of a system that is displayed in the digital twin. The system displayed in the digital twin may be an artificial intelligence system.

As good decisions made within a digital twin environment or other decision making platform lead to better outcomes, trust in the reliability of machine recommendations increases, which can be tested and validated by outcome metrics. Individuals, groups and enterprises can gradually migrate decision making from centralized authority to the operating environment and from human action through various degrees of supervision to autonomy, with appropriate checks and balances at all stages (automated governance), reversing direction when the situation calls for it. Over time as trust builds in the capabilities of artificial intelligence, or human-AI combinations, to outperform humans alone, an enterprise can increasingly close loops among information technology, operations technology, and artificial intelligence technologies, enabling low-latency, highly efficient, well governed autonomous response to changing conditions at the operational level. Operators that don't ultimately close the loop will be slower than their competitors to respond to changing conditions, less efficient in their operations, and less effective in their decision making.

Individuals, groups and enterprises can unlock great benefits by properly distributing decision making and control where and when it is most effective throughout an enterprise, enabled by the integrated stack of technologies that enable a digital twin, each enhanced by artificial intelligence as described throughout this disclosure and the documents incorporated by reference herein. The true power of the convergence of information technology and operations technology (IT/OT convergence) can be realized when decision making is optimally distributed across humans and machines, an outcome that is achieved by progressively building trust in intelligence technologies and the people who supervise them. Organizations that progress more rapidly to a more optimal state will have significant competitive advantages in operational efficiency (particularly through closed loop automation) and agility to respond to shifting market and competitive dynamics.

In embodiments, various embodiments of digital twins, intelligent agents for discovery and configuration, decision making frameworks and other methods and systems disclosed herein may be used to facilitate configuration and allocation of decision making across the various resources, entities, activities, operations, transactions, offerings and workflows involved in various financial infrastructure, marketplace, exchange and transactional environments described throughout this disclosure and the documents incorporated by reference herein.

In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system with an interface system for designating a set of users as trainers for the creation of an artificial intelligence system that is represented in the digital twin, wherein the artificial intelligence system operates on the data that is used to populate the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of options for distribution of decision making authority or control across various systems, systems-of-systems or components across a set of entities and workflows. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of training metrics for a set of humans that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of training metrics for a set of hybrid human-AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of training metrics for a set of AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of performance metrics for a set of humans that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of performance metrics for a set of hybrid human-AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of performance metrics for a set of AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and an intelligent agent that automatically discovers sets of available systems, among human systems, combined human-AI systems and standalone artificial intelligence systems that are capable of performing a desired function. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity and a smart contract system embedded in a digital twin that sets terms and conditions for liability resulting from the output of a system that is displayed in the digital twin.

In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system with an interface system for designating a set of users as trainers for the creation of an artificial intelligence system that is represented in the digital twin, wherein the artificial intelligence system operates on the data that is used to populate the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of options for distribution of decision making authority or control across various systems, systems-of-systems or components across a set of entities and workflows. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of training metrics for a set of humans that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of training metrics for a set of hybrid human-AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of training metrics for a set of AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of performance metrics for a set of humans that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of performance metrics for a set of hybrid human-AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of performance metrics for a set of AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and an intelligent agent that automatically discovers sets of available systems, among human systems, combined human-AI systems and standalone artificial intelligence systems that are capable of performing a desired function. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations and a smart contract system embedded in a digital twin that sets terms and conditions for liability resulting from the output of a system that is displayed in the digital twin.

In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of options for distribution of decision making authority or control across various systems, systems-of-systems or components across a set of entities and workflows. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of training metrics for a set of humans that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of training metrics for a set of hybrid human-AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of training metrics for a set of AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of performance metrics for a set of humans that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of performance metrics for a set of AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system with an interface system for designating a set of users as trainers for the creation of an artificial intelligence system that is represented in the digital twin, wherein the artificial intelligence system operates on the data that is used to populate the digital twin and a smart contract system embedded in a digital twin that sets terms and conditions for liability resulting from the output of a system that is displayed in the digital twin.

In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of options for distribution of decision making authority or control across various systems, systems-of-systems or components across a set of entities and workflows. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of training metrics for a set of humans that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of training metrics for a set of hybrid human-AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of training metrics for a set of AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of performance metrics for a set of humans that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of performance metrics for a set of AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system with an interface system for designating a set of users as supervisors for an artificial intelligence system that is represented in the digital twin, wherein the artificial intelligence system operates on the data that is used to populate the digital twin and a smart contract system embedded in a digital twin that sets terms and conditions for liability resulting from the output of a system that is displayed in the digital twin.

In embodiments, provided herein is an AI-based platform having a digital twin system that displays a set of options for distribution of decision making authority or control across various systems, systems-of-systems or components across a set of entities and workflows. In embodiments, provided herein is an AI-based platform having a digital twin system that displays a set of options for distribution of decision making authority or control across various systems, systems-of-systems or components across a set of entities and workflows and a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin system that displays a set of options for distribution of decision making authority or control across various systems, systems-of-systems or components across a set of entities and workflows and a digital twin system that displays a set of training metrics for a set of humans that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of training metrics for a set of hybrid human-AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of training metrics for a set of AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of performance metrics for a set of humans that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of performance metrics for a set of AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of options for distribution of decision making authority or control across various systems, systems-of-systems or components across a set of entities and workflows and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of options for distribution of decision making authority or control across various systems, systems-of-systems or components across a set of entities and workflows and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of options for distribution of decision making authority or control across various systems, systems-of-systems or components across a set of entities and workflows and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of options for distribution of decision making authority or control across various systems, systems-of-systems or components across a set of entities and workflows and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of options for distribution of decision making authority or control across various systems, systems-of-systems or components across a set of entities and workflows and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of options for distribution of decision making authority or control across various systems, systems-of-systems or components across a set of entities and workflows and a smart contract system embedded in a digital twin that sets terms and conditions for liability resulting from the output of a system that is displayed in the digital twin.

In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of training metrics for a set of humans that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of training metrics for a set of hybrid human-AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of training metrics for a set of AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of performance metrics for a set of humans that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of performance metrics for a set of hybrid human-AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of performance metrics for a set of AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and an intelligent agent that automatically discovers sets of available systems, among human systems, combined human-AI systems and standalone artificial intelligence systems that are capable of performing a desired function. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework and a smart contract system embedded in a digital twin that sets terms and conditions for liability resulting from the output of a system that is displayed in the digital twin.

In embodiments, provided herein is an AI-based platform having a digital twin system that displays a set of training metrics for a set of humans that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of training metrics for a set of hybrid human-AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of training metrics for a set of AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of performance metrics for a set of humans that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of training metrics for a set of humans that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of humans that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of humans that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of training metrics for a set of humans that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of training metrics for a set of hybrid human-AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of training metrics for a set of AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of performance metrics for a set of humans that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of training metrics for a set of hybrid human-AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of hybrid human-AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of hybrid human-AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of training metrics for a set of hybrid human-AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of training metrics for a set of AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of performance metrics for a set of humans that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of training metrics for a set of AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of training metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of training metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of training metrics for a set of AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of performance metrics for a set of humans that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of performance metrics for a set of humans that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of humans that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of humans that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of humans that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of performance metrics for a set of humans that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of performance metrics for a set of hybrid human-AI systems that are available to perform a set of decision making tasks for a set of entities presented in the digital twin. In embodiments, provided herein is an AI-based platform having a digital twin system that displays a set of performance metrics for a set of hybrid human-AI systems that are available to perform a set of decision making tasks for a set of entities presented in the digital twin and a digital twin system that displays a set of performance metrics for a set of AI systems that are available to perform a set of decision making tasks for a set of entities presented in the digital twin. In embodiments, provided herein is an AI-based platform having a digital twin system that displays a set of performance metrics for a set of hybrid human-AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of performance metrics for a set of hybrid human-AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of hybrid human-AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of hybrid human-AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of hybrid human-AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of performance metrics for a set of hybrid human-AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of performance metrics for a set of AI systems that are available to perform a set of decision making tasks for a set of entities presented in the digital twin. In embodiments, provided herein is an AI-based platform having a digital twin system that displays a set of performance metrics for a set of AI systems that are available to perform a set of decision making tasks for a set of entities presented in the digital twin and a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of performance metrics for a set of AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of performance metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of performance metrics for a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of performance metrics for a set of AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and an intelligent agent that automatically discovers sets of available systems, among human systems, combined human-AI systems and standalone artificial intelligence systems that are capable of performing a desired function. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin and a smart contract system embedded in a digital twin that sets terms and conditions for liability resulting from the output of a system that is displayed in the digital twin.

In embodiments, provided herein is an AI-based platform having an intelligent agent that automatically discovers sets of available systems, among human systems, combined human-AI systems and standalone artificial intelligence systems that are capable of performing a desired function. In embodiments, provided herein is an AI-based platform having an intelligent agent that automatically discovers sets of available systems, among human systems, combined human-AI systems and standalone artificial intelligence systems that are capable of performing a desired function and a digital twin system having an embedded intelligent agent system that automatically discovers sets of available systems, among human systems, combined human-AI systems and standalone artificial intelligence systems that are capable of performing a desired function. In embodiments, provided herein is an AI-based platform having an intelligent agent that automatically discovers sets of available systems, among human systems, combined human-AI systems and standalone artificial intelligence systems that are capable of performing a desired function and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that automatically discovers sets of available systems, among human systems, combined human-AI systems and standalone artificial intelligence systems that are capable of performing a desired function and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that automatically discovers sets of available systems, among human systems, combined human-AI systems and standalone artificial intelligence systems that are capable of performing a desired function and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having an intelligent agent that automatically discovers sets of available systems, among human systems, combined human-AI systems and standalone artificial intelligence systems that are capable of performing a desired function and a smart contract system embedded in a digital twin that sets terms and conditions for liability resulting from the output of a system that is displayed in the digital twin.

In embodiments, provided herein is an AI-based platform having a digital twin system having an embedded intelligent agent system that automatically discovers sets of available systems, among human systems, combined human-AI systems and standalone artificial intelligence systems that are capable of performing a desired function. In embodiments, provided herein is an AI-based platform having a digital twin system having an embedded intelligent agent system that automatically discovers sets of available systems, among human systems, combined human-AI systems and standalone artificial intelligence systems that are capable of performing a desired function. and an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system having an embedded intelligent agent system that automatically discovers sets of available systems, among human systems, combined human-AI systems and standalone artificial intelligence systems that are capable of performing a desired function. and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system having an embedded intelligent agent system that automatically discovers sets of available systems, among human systems, combined human-AI systems and standalone artificial intelligence systems that are capable of performing a desired function. and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system having an embedded intelligent agent system that automatically discovers sets of available systems, among human systems, combined human-AI systems and standalone artificial intelligence systems that are capable of performing a desired function. and a smart contract system embedded in a digital twin that sets terms and conditions for liability resulting from the output of a system that is displayed in the digital twin.

In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems and a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems and a smart contract system embedded in a digital twin that sets terms and conditions for liability resulting from the output of a system that is displayed in the digital twin.

In embodiments, provided herein is an AI-based platform having a digital twin system having an integrated intelligent agent that operates as a deployment configuration system to at least one of recommend a set of deployment configuration parameters for or automatically configure a set of deployment parameters for a set of human, human-AI combinations or autonomous AI systems. In embodiments, provided herein is an AI-based platform having a digital twin system having an integrated intelligent agent that operates as a deployment configuration system to at least one of recommend a set of deployment configuration parameters for or automatically configure a set of deployment parameters for a set of human, human-AI combinations or autonomous AI systems. and an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having a digital twin system having an integrated intelligent agent that operates as a deployment configuration system to at least one of recommend a set of deployment configuration parameters for or automatically configure a set of deployment parameters for a set of human, human-AI combinations or autonomous AI systems. and a smart contract system embedded in a digital twin that sets terms and conditions for liability resulting from the output of a system that is displayed in the digital twin.

In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed. In embodiments, provided herein is an AI-based platform having an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed and a smart contract system embedded in a digital twin that sets terms and conditions for liability resulting from the output of a system that is displayed in the digital twin.

In embodiments, provided herein is an AI-based platform having a smart contract system embedded in a digital twin that sets terms and conditions for liability resulting from the output of a system that is displayed in the digital twin.

### Visual Search Within Digital Twin

In embodiments, a visual search engine may be embedded within a digital twin, wherein a user may enter an image-based query (such as by pasting an image, a set of image metadata, or the like, by drawing or otherwise creating the image, or by describing the image with a set of keywords), and the visual search engine will process the query and a set of data structures supporting the digital twin to find a set of potentially matching elements in the digital twin (such as by finding matching image identifying information, matching tags, matching or correlated metadata, or the like, or by finding images having characteristics (such as shape, color, semantic or symbolic meaning, or other attributes) that match or are correlated to the query. In embodiments, matching elements may be listed (such as in a menu bar) and/or highlighted in the visual representation of the digital twin, such as by changes in font, color, brightness, or the like. In one non-limiting example, a user of a digital twin of a building, such as an architect, designer, builder, owner, operator, tenant, visitor, or other users, may enter a picture of a space that is believed to be within the building, containing elements such as fixtures, furnishings, equipment and the like, and the visual search engine may parse the picture, find matching elements in the digital twin of the building, and present one or more options that represent likely location of the space, along with other data or representations of the space, including guidance how to reach the space, additional data on contents, and the like. For example, a visiting maintenance professional may enter a picture of a machine that was captured on an earlier visit by a colleague or by a customer, and the visual search engine may find where the machine is now located in the digital twin and route the professional to the current location. In embodiments, the visual search engine may use artificial intelligence, in one of the many forms described herein or in the documents incorporated by reference, such as to parse queries (in natural language or in image formats); to recognize and classify objects, faces, spaces, and other visual elements, to match or correlate images and image content, text, or the like; to rank results or recommendations, such as based on the likelihood of relevance, including based on past user responses, ratings, utilization, or other measures of feedback; to optimize the presentation of results; and many other elements.

In embodiments, a digital twin of an environment, such as the interior of a home, may be automatically constructed from an arbitrary set of photos that are taken over time, such as snapshots of people, pets, and other subjects contained in the photo library of a consumer, whereby common elements within the photographs are linked by a set of artificial intelligence systems, such as object recognition systems, subsequent to which the comment elements enable a user to orient, resize, and otherwise manipulate image elements to provide a stitched view of the environment. In embodiments, a large training data set may be captured as expert users stitch view of multiple environments, such that a robotic process automation system may be trained to automatically stitch a digital twin of an environment upon receiving an input data set. In embodiments, incremental information may be added to the digital twin, such as additional images as they are captured and other content, such as information from other data sources about the environment, including data about or from IoT devices in the environment, about objects purchased for the environment, about workflows in the environment, about individuals in the environment (such as user behavior data) and the like. In embodiments, image information and other information about the environment may be captured in a blockchain. The blockchain may support a distributed ledger of transactions or events related to the environment. The blockchain may support a smart contract as described elsewhere in this disclosure. The blockchain may be augmented by a set of interfaces, such as for controlling access to the information, such as to enable private portions and public portions. In embodiments, public portions may allow third parties, such as vendors, suppliers, service providers, technology providers and others to obtain sufficient relevant information from the digital twin to meet specific needs of an owner or operator of the environment, or a worker within it, without providing access to the entire set of information contained in the digital twin.

### AI Convergence System of Systems

Referring to FIG. 19, an AI convergence system of systems 1900 is illustrated in accordance with some embodiments. The AI convergence system of systems 1900 represents a sophisticated multi-layered technological framework where platforms are enhanced through the deep integration of AI capabilities with other advanced technologies. This convergence fundamentally transforms how enterprise entities operate by enabling intelligent automation, data-driven decision making, and adaptive responses across all system layers. The system architecture is designed to support complex interactions between different technological components while maintaining operational efficiency and security across the enterprise environment.

The governance layer 2000 implements comprehensive automated governance and policy enforcement through specialized governance modules 2002. This layer utilizes generative AI technology to ensure proper oversight and compliance while adapting to changing regulatory requirements. The governance modules can automatically implement and enforce policies, manage digital rights infrastructure, monitor content and data flows, and ensure compliance with relevant regulations, contracts, and licensing requirements. The layer also incorporates digital twins and reporting automation capabilities to provide real-time oversight and transparency.

The enterprise layer 2100 supports various enterprise functions by integrating enterprise management and control platforms with digital infrastructure. This layer enables automated transactional processes, manages listings and user profiles, provides analytics and insights for strategic decision-making, and enforces security and compliance protocols through sophisticated permissions systems.

The offering layer 2200 leverages an intelligent systems architecture to create, manage and enable system offerings through specialized offering modules 2202. This layer employs advanced content generation intelligence, personalization capabilities, and domain-specific knowledge processing to deliver highly customized experiences. The layer can generate and adapt content based on user profiles, behaviors, current states, environmental factors, and specific requests, while maintaining coherence and quality across multiple formats and domains.

The transactions layer 2300 provides sophisticated transaction management capabilities through a set of hardware and software-defined transaction modules. This layer implements AI models for automating, optimizing, and executing digital transactions, including digital payments and asset management. It incorporates secure integration frameworks for interfacing with financial institutions, digital marketplaces, and blockchain networks, while maintaining robust authentication and security measures.

The operations layer 2400 orchestrates the comprehensive management and execution of AI systems through specialized operations modules. These modules handle critical functions including AI system generation, training data set creation, model verification, deployment optimization, and governance oversight. The layer implements sophisticated capabilities for training AI systems using supervised, unsupervised, and reinforcement learning techniques while maintaining performance metrics and simulated data validation. Through its orchestration capabilities, this layer enables dynamic resource allocation, load balancing, and automated governance of AI workloads across the enterprise ecosystem.

The network layer 2500 delivers advanced networking capabilities through intelligent adaptation to changing conditions and requirements. This layer facilitates communications among smart network-capable systems while leveraging AI to dynamically adapt network configurations and optimize data flow. It integrates edge computing with cloud services to enable data processing and workflow orchestration closer to data sources, reducing latency and enhancing real-time decision-making capabilities. The layer employs AI algorithms for intelligent routing of various data types through optimal network paths across cellular, WiFi, ORAN, Bluetooth and other protocols.

The data layer 2600 provides comprehensive data management and intelligence services through a sophisticated system of systems architecture. This layer implements machine learning systems, artificial intelligence systems, and neural networks configured to operate on fused data from diverse sources including sensors, wearables, social media, crowdsourced data, websites, APIs, edge devices, industrial systems, and enterprise platforms. It enables real-time monitoring and analysis while maintaining data sovereignty and security through federated learning techniques.

The resource layer 2900 enables automated and optimized provisioning of resources across various operational environments through AI-driven capabilities. This layer implements machine learning systems, artificial intelligence systems, and neural networks to optimize allocation of computational, networking, material, and energy resources. It provides dynamic resource management that can adapt to the specific demands of diverse environments like industrial settings, transportation infrastructure, energy facilities, and datacenters while maintaining operational efficiency.

This interconnected architecture creates a comprehensive technology stack that enables multiple scenarios and use cases across various enterprise contexts. The convergence of AI capabilities throughout these layers establishes an intelligent, adaptive system that can respond to diverse operational requirements while maintaining security, efficiency, and compliance. The system's modular design allows for continuous evolution and enhancement of capabilities across all layers, ensuring sustained value delivery to enterprise operations.

### Governance Layer

An example system such as a multi-layered intelligent system (e.g., AI convergence system of systems 1900) may provide automated governance (e.g., using governance layer 2000 including governance modules 2002) and execution of transactions. In example embodiments, this system may use generative AI technology to provide users and/or organizations with offerings and content that may be customized and personalized based on a profile, behavior, current state (physiological, emotional, or other), environment, location, content, and/or request. For example, a user may use this system to request a particular type of experience with a preferred theme (e.g., including music, video, characters, etc.) or a particular type of organization or presentation of content may be generated to fit with the user's style, mood and current environment.

In example embodiments, the system (e.g., AI convergence system of systems 1900) may include systems for automated governance (e.g., using governance layer 2000 including governance modules 2002) and execution of transactions (e.g., using transactions layer 2300 that may include transactions modules 2302). For example, a rights infrastructure system may be included in the AI convergence system of systems 1900 (e.g., specifically in the governance layer 2000).

In some example embodiments, the system (e.g., system of systems such as SoS and more specifically AI convergence system of systems 1900) may include a governance layer 2000 that performs various governance tasks for the system. In example embodiments, the governance layer 2000 may be deployed to enforce various governance standards, workflows, or rules with respect to AI-driven tasks of the system. The types of governance standards, workflows, and rules that may be deployed in a specific configuration of the system may vary depending on the configuration of the system.

In example embodiments, the governance layer 2000 may include the set of governance modules 2002 that may be configured to perform a respective governance task. As discussed in the disclosure, governance may be configured for various purposes and in various manners. In some example embodiments, governance modules may be configured to ensure an entity is complying with a set of standards (e.g., internal standards, industry standards, recommended standards, or the like), regulations (e.g., jurisdictional regulations, professional regulations, industry regulations or the like), rules (e.g., internal rules, jurisdictional rules, international rules, or the like), or the like. Examples of the different types of analyses that a governance module may be configured to perform are described throughout the disclosure and may include risk analyses, security analyses, decision tree analyses, ethics analyses, failure mode and effects (FMEA) analyses, hazard analyses, quality analyses, safety analyses, regulatory analyses, legal analyses, and/or other suitable analyses.

In some example scenarios, a governance module may be configured to ensure an automated task is performed in a manner that complies with jurisdictional and/or governmental rules. In some example embodiments, a governance module may be configured to apply certain workflows or checklists after completion or before performance of an AI-driven task. For example, after a certain type of transaction is completed, a governance module may be configured to ensure that any required post transaction reconciliation, fulfillment, and/or reporting are completed properly. In another example, before a counterparty is transacted with, a governance module may be configured to initiate a “know-your-customer” workflow to determine whether the counterparty has a white-listed account, and if not, to determine whether to approve the counterparty transactor. In another example, a governance module may be configured and deployed to monitor a supply chain to ensure compliance with regulations relating to imported materials (e.g., tariffs are paid, regulated materials are reported, or the like).

In some example embodiments of the disclosure, a governance module may be configured and deployed to monitor the performance of an AI model (e.g., an LLM, a neural network, a machine learning model, and/or the like). In these example embodiments, a governance module may be configured to analyze the output of an AI model with respect to one or more governance parameters to determine whether the AI model is producing output that exhibits bias, drift, or the like, as described elsewhere in the disclosure. In some example embodiments, a governance module may halt use of an AI model that is determined to be exhibiting drift or bias. Additionally or alternatively, it may initiate a retraining of the model and/or alert a human user.

In some example embodiments, a governance module may be configured to analyze an input to a particular AI model. In some example embodiments, a governance module may be configured to analyze a prompt being provided to a large language model to ensure that the prompt is not requesting something that would violate a governance standard of an entity or the model. For example, a governance module may be configured to analyze a user prompt to ensure that the user is not asking the large language model to violate another party's intellectual property rights, use data sets that are not permitted to be used, or otherwise perform tasks that would put the enterprise at risk.

In such example scenarios, the governance module may prevent the prompt from being processed by the LLM. Additionally or alternatively, analyzing input to an AI model may include analyzing the data being provided to the model to make a prediction or recommendation to determine whether the data is reliable data. Assuming the input data is reliable, the AI model may be provided with the input data. If, however, the data is deemed to be unreliable (e.g., fake data injection or data from a faulty sensor), a corrective measure may be initiated by the governance module (e.g., preventing the data from being used and/or alerting a human user).

### Ownership and Rights Management

In example embodiments, AI agents may be configured for identifying and tracking offerings, content, systems, and services ownership for licensing. This may involve ownership of two or more entities for providing one service or multiple services relating to particular data or content. For example, the AI agents may navigate different pathways in governing ownership of services offered. The ownership may relate, for example, to copyright of media such as software, video, photos, music, and/or scripts or based on companies or individuals that provide at least a portion of the games and/or entertainment. With other services described, the ownership may relate, for example, to the roles of an individual or organization in providing service(s). There may be other logical rules used for determining ownership of content. The AI convergence system of system of systems 1900 may include management platforms that may use fully autonomous software, such as fully autonomous AI, to proceed through steps or a co-pilot software such as an AI co-pilot with a user approving and proceeding with at least some portions of the following process manually.

### Content Analysis and Monitoring

In example embodiments, AI convergence system of systems 1900 may be configured for tracking and monitoring services or content going into a data model for identifying ownership of portions of the services across integrated system components or layers (e.g., across offering layer 2200 that may use offering modules 2202, enterprise layer 2100 that may include enterprise modules 2102, and governance layer 2000). In other examples, system 1900 may use various machine learning techniques and artificial intelligence capabilities, such as neural networks, to analyze content before the content data is inputted into a model for a source of the data (e.g., via offering layer 2200 and/or enterprise layer 2100). The source may indicate ownership of different parts of the content that may be assigned to one or more owners. In example embodiments, system 1900 may use intelligent processing (e.g., AI) to analyze the data going into the model as compared against continuously updated reference databases and knowledge models (e.g., a constantly updated Internet model such as a “world” model of all public data) for identifying source information that may be used to find ownership. System 1900 may use the intelligent analysis to identify ownership from various types of information or source information associated with the content. Alternatively, in other example embodiments, automated data collection and analysis tools (e.g., a web crawler, spider, or search engine bot with AI) may be utilized to find ownership. This source information may be based on any portion of the software being used, hardware being used, and other systems being used such as relating to services and content.

### Policy and Licensing Management

In example embodiments, system 1900 may use identified owners as a trigger to find any policies and/or licensing information (including e.g., contracts) that are associated with the content being inputted and/or the owners involved (e.g., using the governance layer 2000). The system 1900 may leverage the AI to find and/or locate the associated policies and/or licensing information by querying the continuously updated reference databases and knowledge models and/or querying publicly available web sources (e.g., using a web crawler, spider, or search engine bot). This querying process may find these policies and/or licensing information through direct or indirect associations to the owners identified and the related or associated content that is being inputted. In example embodiments, the querying process may also find policies and/or contractual information related to owners or at least partial owners of the related or associated services that may be requested by a user of system 1900 (e.g., owner or partial owner of services).

### Transaction Management

In example embodiments, automated transaction and contract management systems (e.g., using smart contracts or other similar semi-autonomous contract systems) may be triggered via intelligent processing modules to provide transactions with a particular use of the content in modeling based on, at least partially, the associated policies, contracts, and/or licensing information discovered from querying. These automated contractual arrangements may be executed through the transaction processing components (e.g., at the transactions layer 2300 of the system 1900). In some examples, the smart contracts may be configured using distributed ledger technology (e.g., blockchain). Alternatively, in other example embodiments, communications may be automated for users to review/approve and/or automated between the system 1900 and identified owners (e.g., copyright owners of content or owners based on other factors such as development of content) to obtain approval and/or contractual information (e.g., based on, at least partially, the associated policies, contractual, and/or licensing information discovered) before proceeding with particular modeling.

### Rights Compliance and Infringement

In example embodiments, system 1900 may compare results and/or output from content generation systems (e.g., generative models) against the reference knowledge bases for identifying potential rights infringement (e.g., copyright infringement) based on any substantive similarities (e.g., based on copyright law), trademark infringement, and/or infringing ownership of other rights associated with results outputted from generative models. In example embodiments, the results and/or output from generative models may be various types of services and/or other content data generated as requested via a user interface. In order to compare results, for example, system 1900 may identify similarities between a generative model result and a “world” model and/or compared against a repository of known copyrighted works (e.g., all copyrighted media stored here with fair use data being excluded from this repository). System 1900 may use AI and/or modeling of various laws and/or regulations relating to services (e.g., statutes, rules, and case law as well as copyright law statutes, rules, and case law that relate to region(s) where the generative models are being used) for determining what is considered substantive similarities. System 1900 may use AI and/or modeling to determine whether any thresholds of infringement (e.g., copyright infringement or other ownership infringement) may have been crossed (e.g., based on the legal models or data such as statutes, rules, and case law relating to relevant jurisdiction(s)). The models used to run this analysis may be based on service-related laws and/or copyright laws (e.g., statutes, rules, and case law based on jurisdiction(s) impacted) and then may use case law examples to understand the thresholds between infringement and non-infringement. System 1900 may identify owners for portions of services being infringed or potentially infringed. System 1900 may use identified copyright owners as a trigger to find any policies, contractual, and/or licensing information (including associated contracts) that are associated with the content and/or the owners involved. Identifying owners along with associated policies and/or licensing information may occur using the same or similar approaches as described elsewhere in this disclosure. In example embodiments, system 1900 may run this process across one or more services such as comparing results and/or output from generative models against the continuously updated reference databases and knowledge models for identifying potential ownership infringement through using one or more services. The models used to run this analysis may be based on various service ownership-related laws (e.g., statutes, rules, and case law based on jurisdiction(s) impacted) and then may use case law examples to understand the thresholds between infringement and non-infringement. System 1900 may identify owners for portions of services being infringed or potentially infringed. System 1900 may use identified service owners as a trigger to find any policies, contractual, and/or licensing information (including associated contracts) that are associated with the services and/or the owners involved.

In example embodiments, system 1900 (e.g., using transactions layer 2300) may trigger smart contracts (or other similar semi-autonomous contracts) to provide transactions for particular use of resulting generative media going forward (e.g., personal use, display to a company, display to friends/family, display via internet social media channels, display on cable channels, display on streaming channels, etc.) and based on a portion of the generative result potentially infringing. In some examples, the smart contracts may be configured using distributed ledger technology (e.g., blockchain). Alternatively, communications may be generated for users to review/approve and/or automated between the system 1900 and owners to obtain approval and/or contractual information to proceed with particular use of resulting generated media based on a portion potentially infringing. This may also occur with use of resulting generated or suggested services that relate to one or more owners.

In example embodiments, system 1900 may relate to transactions layer 2300 and operations layer 2400 (e.g., that may use operations modules 2402) by use of automation software technologies to execute various systems.

### Compensation and Ownership Distribution

In example embodiments, system 1900 (e.g., using enterprise layer 2100 and/or offering layer 2200) trains and deploys AI expert agents/co-pilots that can fill various artistic/creative roles within a service project. The AI expert agents may be configured to determine how to compensate rights holders that created content. For example, the AI expert agent may, when a generative work is created, determine who should be compensated and how based on identification of specific data used to train a model or similarity of the output to identified parties. In example embodiments, different components may have different licensing/compensation models. For example, gaming royalties may be different from music, video, characters, etc. For music, royalties may be awarded to individual rights holders, for example. In example embodiments, the compensation may be determined by the AI based on any combination of a potentially infringing portion of created content used, owners, as well as policies, contractual, and/or licensing information associated with the relevant owners. In some example embodiments, these ownership issues may result in fractional ownership of slot machines that may change or vary based on each instance user request as the content output may change and change during each of these instances. In example embodiments, similar processes may be executed for determining ownership percentages for services being provided especially where there may be two or more owners contributing to an offered service and/or content. Given the different ownership shares that may exist, in some example embodiments, tokenization technologies may be utilized to divide up the ownership as well as allow for the use to pay multiple owners automatically via portions of a token. In these examples, a virtual wallet may be utilized with tokens. Overall, this allows for a customized or personalized result or output based on each user's request from an interface. With services, this allows for a customized or personalized result or output based on each user's request regarding offerings, content, systems and services.

### Prediction

In some example embodiments, the generative AI may suggest and/or automatically provide services to a user based on intelligent analysis of historical data and user preferences (e.g., using a prediction model). This allows the user to use any machine that is able to connect to a personalized custom model of the user for insights on the user's preferences based on historical data of previous usage and requests. The prediction process may be able to improve its prediction based on a variety of factors such as time usage of services, number of times service(s) is/are requested, success rate with some services, selection, time of day preferences, preferred spending, biometric data (e.g., using sensors to check various data points from users that can indicate likes/dislikes such as relating to relaxation vs. stress levels and/or improved focus), etc. In example embodiments, the generative AI may also suggest and/or automatically provide suggested services to a user based on a prediction model from historical data.

### Model Selection

In example embodiments, the converging technology stack system 1900 selects a model for a particular task (e.g., appropriate processing models). For example, the system 1900 may determine the genus of model to use and within the genus, which specific model to use. System 1900 may select between, for example, a diffusion model or a large language model (LLM). Once a genus is selected, then the system 1900 may select a specific model (e.g., a specific diffusion model or specific LLM) to perform the task.

### Digital Asset Management

In example embodiments, the system 1900 (e.g., via the transactions layer 2300) may provide for digital payment and asset management capabilities (e.g., using virtual wallets) that may include tokens and/or other payment options for transactions.

### Embedded Policy and Governance, Policy Automation, and Compliance Automation

In example embodiments, the governance layer 2000 of system 1900 may include a set of machine learning systems, artificial intelligence systems, and/or neural networks configured to execute intelligence tasks associated with embedded policy and governance, policy automation, and/or compliance automation. These capabilities may work in conjunction or separately with system 1900 and other subsystems (e.g., rights infrastructure system) as described in the disclosure to provide comprehensive governance across the platform. The governance layer 2000 may automatically implement and enforce policies while ensuring compliance with relevant regulations, contracts, and/or licensing requirements.

### Digital Twins and Reporting Automation

Building upon the system's ability to track ownership and manage rights, the governance layer 2000 may include and/or use digital twins (e.g., executive digital twins) and/or reporting automation capabilities that provide oversight and transparency. These digital twins may monitor governance processes in real-time, while automated reporting may ensure all stakeholders receive appropriate updates about policy implementation, compliance status, and/or system activities.

### Safety Automation

The governance layer 2000 may include safety automation capabilities that may work across all operational domains. This safety automation may integrate with the system's existing monitoring and compliance features to ensure safe operations while maintaining regulatory compliance. The safety automation capabilities may adapt to different operational contexts, whether in industrial settings, healthcare environments, or transportation systems.

### Enterprise Layer

In embodiments, the techniques described herein relate to a computer-implemented system for managing a set of machine learning systems, a set of artificial intelligence systems, and/or set of neural networks within an enterprise ecosystem, the system including: a processor; a memory storing instructions that, when executed by the processor, cause the system to: integrate a set of machine learning systems, a set of artificial intelligence systems, and/or set of neural networks with an enterprise access layer (EAL) that interfaces with a plurality of enterprise resources; automate the collection, storage, presentation, streaming, monitoring and analysis of data, content, processing protocols and the like, and related metadata by interfacing the a set of machine learning systems, a set of artificial intelligence systems, and/or set of neural networks within workflow systems of the enterprise; utilize a data services system to manage enterprise management and control platforms; implement an intelligence system to provide predictive analytics for trends and demand forecasting within the enterprise management and control platforms; enforce security and compliance through a permissions system that controls access to functions of the enterprise management and control platforms; manage digital transactions via a wallets system that interfaces with the enterprise management and control platforms; and generate reports on platform activity through a reporting system that is communicatively coupled with the enterprise management and control platforms

In embodiments, the techniques described herein relate to a computer-implemented system for facilitating actions within enterprise management and control platforms, including: a processor; a memory storing instructions that, when executed by the processor, cause the system to: integrate enterprise management and control platforms with an enterprise's digital infrastructure; automate transactional processes by interfacing the enterprise management and control platforms with a workflow system of the enterprise; manage listings, transactions, and user profiles using a data services system; provide analytics and insights for strategic decision-making within the enterprise management and control platforms through an intelligence system; enforce security and compliance protocols via a permissions system that controls access to the enterprise management and control platforms; and facilitate digital transactions through a wallets system that interfaces with the enterprise management and control platforms.

In embodiments, the EAL may be configured to interact with the platform users (and the ecosystem(s) in which they interact) in a variety of ways. For example, the EAL may be integrated or associated with one or more marketplaces or platforms such that the EAL functions as its own market or platform participant on behalf of the enterprise. By being associated with potentially numerous marketplaces or platforms, the EAL can perform complex or multi-stage actions, including but not limited to transactions, with enterprise assets (e.g., in a series or sequence of timed stages, simultaneously in a set of parallel transactions, or a combination of both).

In addition to marketplaces, the EAL may interact with platform users via third-party systems, some or all of which may be implemented as third-party services.

In embodiments, the EAL may include a number of EAL systems (also referred to as modules or EAL modules herein) that enable the functionality of the EAL. In some examples, these EAL systems may be deployed in a container that is specific to the EAL. When deployed in a container for the EAL, this containerized instance means that the EAL may include the necessary tools and computing resources to operate (i.e., host) the EAL systems without reliance on other computing resources associated with the enterprise (e.g., computing resources such as processors and memory dedicated to the EAL). For example, the container for the EAL may include a set of one or more systems, such as software development kits, application programming interfaces (APIs), libraries, services (including microservices), applications, data stores, processors, etc. to execute the functions of the EAL systems that may enable the EAL to provide enterprise management and other functions and capabilities described throughout this disclosure. References herein to “EAL systems” should be understood to encompass any of the foregoing except where context dictates otherwise.

In some implementations, a set of the EAL systems may leverage computing resources considered to be external to the EAL (e.g., separate from computing resources that have been dedicated to the EAL, such as, in embodiments, computing resources shared with other enterprise applications or systems). In these implementations, the set of EAL systems leveraging external computing resources may be in communication with computing resources specific to the EAL. This type of arrangement may be advantageous when one or more of the EAL systems are computationally expensive and would increase the computational requirements for an entirely contained EAL, such as when one or more of the EAL systems causes the EAL to be a relatively expensive EAL deployment. For instance, an arrangement leveraging external (e.g., shared) systems may be beneficial for EAL systems that are infrequently utilized. To illustrate, a first enterprise may rarely use an EAL system, such as a reporting system. Here, instead of ensuring that the EAL has the computational capacity to support a reporting system by itself, the enterprise may configure the reporting system to be hosted by and/or supported by computing resources external to the EAL to deploy a relatively lean form of the EAL (i.e., an EAL container that does not include resources dedicated to a reporting system or that includes only limited resources dedicated to the reporting system with the capability to access additional, external resources as needed).

In some configurations, the EAL or a set of the EAL systems may leverage computing resources considered to be external to the EAL for support. An example of this support may be that the EAL or the set of EAL systems demands greater computing resources at some point in time (e.g., over a resource intensive time period) —for instance, greater may mean more computing resources than a normal or baseline operation state. In this example, for instance, an enterprise resource not dedicated to the EAL or EAL systems can assist or augment the services provided by some aspect of the EAL.

In embodiments, the deployment of the EAL may be configurable. For example, the enterprise or some associated developer can function as a type of architect for the EAL that best serves the particular enterprise. Additionally, or alternatively, the deployed location of the EAL may influence its configuration. For instance, the EAL may be embedded within an enterprise (e.g., non-dynamically) where it can be specifically configured using various module libraries, interface tools, etc. (e.g., as described in later detail). In some examples, the configuring entity is able to select what EAL systems will be included in its EAL. For instance, the enterprise selects from a menu of EAL systems. Here, when an EAL system is selected by the configuring entity, a configuration routine may request the appropriate resources for that EAL system including SDKs, computing resources, storage space, APIs, graphical elements (e.g., graphical user interface (GUI) elements), data feeds, microservices, etc. In some implementations, in response to the request, the configuring entity can dedicate the identified resources of each selected EAL system. For instance, the configuring entity associates the dedicated resources to a containerized deployment of the EAL that includes the selected EAL systems.

In embodiments, the EAL may include a set of EAL systems. The set may include an interface system, a data services system, an intelligence system, a scoring system, a data pool system, a workflow system, a transaction system (also referred to as a wallet system or a digital wallet system), a governance system, a permissions system, a reporting system, and a digital twin system. Additionally, although particular types of EAL systems are described herein, the functionality of one or more EAL systems is not limited to only that particular EAL system but may be shared or configured to occur at another EAL system. For instance, in some configurations, some functionality of a transaction system may be performed by the data services system or functionality of the governance system may be incorporated with an intelligence system. In this respect, the EAL systems may be representative of the capabilities of the EAL more broadly. In embodiments, the set of EAL systems involved in any particular configuration of the EAL may include any of the systems described throughout this disclosure and the documents incorporated by reference herein, such as systems for counterparty discovery, opportunity mining, automated contract configuration, automated negotiation, automated crowdsourcing, automated facilitation of robotic process automation, one or more intelligent agents, automated resource optimization, resource tracking, and others.

In some embodiments, one or more of these systems may be configurable. The configurations may be done by selecting pre-defined configurations/plugins, by building customized modules, and/or by connecting to third party services that provide certain functionalities.

In some embodiments, aspects of a configured EAL may be dynamically reconfigured/augmented. In some examples, reconfiguration/augmentation may include updating certain data pool configurations, redefining certain workflows, changing scoring thresholds, or the like. Reconfiguration may be initiated autonomously (for example, the EAL periodically tests configurations of certain aspects of the EAL configuration using the digital twin simulation system and analytics system) or may be expert-driven (e.g., via interactions between an EAL “expert” and an interactive agent via a GUI of the interface system).

In embodiments, the data services system may perform data services for the EAL, which may include a data processing system and/or a data storage system. This may range from more generic data processing and data storage to specialty data processing and storage that demands specialty hardware or software. In some examples, the data services system includes a database management system to manage the data storage services provided by the data services system. In some configurations, the database management system may be able to perform management functions such as querying the data being managed, organizing data for, during, or upon ingestion, coordinating storage sequences (e.g., chunking, blocking, sharding), cleansing the data, compressing or decompressing the data, distributing the data (including redistributing blocks of data to improve performance of storage systems), facilitating processing threads or queues, etc. In some examples, the data services system couples with other functionality of the EAL. As an example, operations of the data services system, such as data processing and/or data storage, may be dictated by decision-making or information from other EAL systems such as an intelligence system, a workflow system, a transaction system, a governance system, a permissions system, a reporting system, and/or some combination thereof.

It is appreciated that workflows may be deployed in any number of scenarios. Examples of scenarios where workflows may be deployed by an EAL include permission workflows, access workflows, data collection workflows, data pool workflows, machine learning workflows, artificial intelligence workflows, governance workflows, scoring workflows, transaction workflows, governance workflows, industry or vertical-specific workflows, enterprise-specific workflows, and other suitable workflows. It is appreciated that the example types of workflows provided above may overlap (e.g., a governance workflow may be an industry-specific and/or enterprise-specific workflow). Furthermore, some workflows may trigger one or more other workflows. For example, when a certain type of transaction is executed by a transaction system of an EAL, a transaction workflow corresponding to the type of transaction may define a series of tasks that are performed before the transaction is executed. In another example, as part of a data pool workflow that establishes a data pool that is accessible by third-parties, the data processing workflow may trigger a governance workflow that ensures that any enterprise data being added to the data pool confirms with certain data sharing rules (e.g., obfuscation of sensitive data, complying with privacy rules, scrubbing metadata, and/or the like) and may trigger a scoring workflow that scores each third-party that will access the data pool. Furthermore, EAL workflows may share a common framework for respective EAL functions and scenarios; however, individual workflows deployed with respect to respective EAL instances may vary in complexity from very basic workflow implementations (e.g., configured to execute on a user device or sensor device) to complex workflows with multiple dependencies and/or embedded “sub-workflows” (e.g., configured to execute by a central server system and/or by multiple enterprise devices).

In embodiments, a digital twin system may perform simulations of the enterprise's products and services that incorporate real-time data obtained from the various entities of the enterprise or third parties. In some of these embodiments, the digital twin system may recommend decisions to a user interacting with the enterprise digital twins.

In embodiments, an artificial intelligence module may include and/or provide access to a digital twin module.

The digital twin module may encompass any of a wide range of features and capabilities described herein In embodiments, a digital twin module may be configured to provide, among other things, execution environments for and different types of digital twins, such as twins of physical environments, twins of robot operating units, logistics twins, executive digital twins, organizational digital twins, role-based digital twins, and the like. In example embodiments, a digital twin module may be configured to generate digital twins that are requested by intelligence clients. Further, the digital twin module may be configured with interfaces, such as APIs and the like for receiving information from external data sources. For instance, the digital twin module may receive real-time data from sensor systems of a machinery, vehicle, robot, or other device, and/or sensor systems of the physical environment in which a device operates. In embodiments, the digital twin module may receive digital twin data from other suitable data sources, such as third-party services (e.g., weather services, traffic data services, logistics systems and databases, and the like). In embodiments, the digital twin module may include digital twin data representing features or states, as well as demand entities, such as customers, merchants, stores, points-of-sale, points-of-use, and the like. The digital twin module may be integrated with or into, link to, or otherwise interact with an interface (e.g., a control tower or dashboard), for coordination of supply and demand, including coordination of automation within supply chain activities and demand management activities.

In embodiments, a digital twin module may provide access to and manage a library of digital twins. A plurality of artificial intelligence modules may access the library to perform functions, such as a simulation of actions in a given environment in response to certain stimuli.

In example embodiments, the digital twin(s) may be implemented with smart contracts, such as for digital twin transactions enabled by smart contracts (e.g., using smart contract orchestration engines).

In embodiments, an enterprise access layer system of systems (ELS) may manage and integrate EAL methods and systems, technological systems, data streams, platforms, and operational processes. Current enterprises face challenges in coordinating across different business units and technology stacks, creating a need for an intelligent enterprise access layer capable of parallel task execution and advanced analytics capabilities. The ELS, as described herein, implements a comprehensive architecture that enables parallel processing of intelligence tasks across multiple domains while maintaining data consistency and security protocols. The system's core architecture comprises processing unit(s) integrated with memory system(s) storing executable instructions, multiple machine learning systems, artificial intelligence engines, and neural network arrays, supported by data storage systems, communication interfaces, security modules and connections or associations with third party systems, platforms or operations.

In embodiments, the ELS may execute system simulations utilizing neural network models to provide predictive analytics for business forecasting. In example embodiments, the system may continuously update simulations in real-time based on, for example, operational data, enabling dynamic scenario modeling and analysis for enhanced decision-making processes.

In embodiments, the ELS may implement digital twin and management capabilities, generating Metaverse environments, such as industrial Metaverse environments, that enable real-time synchronization between physical and digital assets. In example embodiments, these digital representations may facilitate virtual testing and validation of industrial systems before physical implementation.

In embodiments, the ELS may incorporate big data processing and analytics capabilities, seamlessly integrating with Industrial Internet of Things platforms. In example embodiments, this integration may include real-time sensor data analysis and predictive maintenance optimization across industrial operations.

In embodiments, the ELS may deliver automated industrial operational control through AI-driven process optimization systems. In example embodiments, the ELS may continuously perform real-time adjustments of manufacturing parameters while maintaining comprehensive quality control and compliance monitoring protocols.

In embodiments, the ELS may enable enterprise system integration through AI-enhanced transaction processing capabilities. In example embodiments, this integration may facilitate automated workflow management and ensures precise cross-system data synchronization across the enterprise environment.

In embodiments, the ELS may deploy executive digital twins for fleet management, enabling vehicle simulation and design optimization. In example embodiments, the ELS may manage complex fleet transaction processing while integrating with software-defined vehicle systems for enhanced operational control.

In embodiments, the ELS may incorporate energy operations digital twins within a system of systems integration framework for comprehensive energy management. In example embodiments, the system may process energy transactions while performing AI-based energy optimization across the enterprise.

In embodiments, the ELS may implement multiple machine learning approaches, including supervised learning algorithms for pattern recognition and unsupervised learning systems for anomaly detection. In example embodiments, the ELS may utilize reinforcement learning for optimization processes and deep learning capabilities for complex analysis tasks.

In embodiments, the ELS may deploy specialized neural network architectures, including convolutional neural networks for image processing applications and recurrent neural networks for sequence analysis. In example embodiments, the system may utilize transformer networks for natural language processing tasks and implements graph neural networks for relationship analysis.

In embodiments, the ELS may coordinate multiple AI systems through a hierarchical task distribution framework, implementing parallel processing optimization and resource allocation management. In example embodiments, the ELS may enable cross-system learning integration for enhanced operational efficiency.

In embodiments, the ELS may implement comprehensive security measures including role-based access control systems and multi-factor authentication protocols. In example embodiments, the system may maintain detailed activity monitoring and logging while enforcing robust security policies.

In embodiments, the ELS may implement end-to-end encryption protocols and secure data transmission mechanisms. In example embodiments, the system may incorporate privacy preservation techniques while maintaining compliance monitoring and reporting capabilities.

In embodiments, the ELS may integrate with existing enterprise resource planning systems, customer relationship management platforms, manufacturing execution systems, and supply chain management systems. In example embodiments, this integration may enable data flow and process coordination across the enterprise environment.

In embodiments, the ELS may maintain connections with cloud services, partner networks, and external data sources while enabling integration with third-party applications. In example embodiments, this connectivity may ensure data access and process coordination across the extended enterprise ecosystem.

In embodiments, the ELS may implement horizontal and vertical scaling capabilities supported by dynamic resource allocation mechanisms. In example embodiments, the ELS may maintain load balancing capabilities while performing continuous performance monitoring to ensure optimal system operation.

In embodiments, the ELS may incorporate fault tolerance mechanisms and redundancy management systems.

In example embodiments, the implementation may include disaster recovery capabilities and continuous system health monitoring to ensure sustained operational reliability.

In embodiments, in manufacturing operations, the ELS may enable production optimization through real-time monitoring and adjustment of manufacturing parameters. In example embodiments, the system may continuously analyze production data to automatically optimize resource allocation and scheduling, while maintaining quality control standards. For example, in an automotive manufacturing facility, the ELS may monitor assembly line operations in real-time, automatically adjusting robotic systems and process parameters to maintain optimal production efficiency and product quality.

In embodiments, the ELS may implement predictive maintenance scheduling by analyzing equipment sensor data through its IoT integration capabilities. In example embodiments, this may allow manufacturing facilities to prevent unexpected downtime by identifying potential equipment failures before they occur. The ELS may coordinate maintenance activities across multiple production lines while optimizing resource utilization and minimizing operational disruptions.

In embodiments, the ELS may demonstrate integration capabilities by connecting manufacturing execution systems, supply chain management platforms, and enterprise resource planning systems. This integration may enable data flow and coordination across all operational aspects. For instance, in a consumer electronics manufacturing operation, the system may coordinate production planning with supply chain logistics and inventory management, ensuring efficient resource utilization and timely delivery of finished products.

In embodiments, the ELS may implement a multi-layered neural network architecture that combines multiple specialized networks for different processing tasks. In example embodiments, the system may utilize convolutional neural networks specifically designed for image processing applications, while implementing recurrent neural networks for analyzing sequential data patterns. Additionally, transformer networks may handle natural language processing tasks, and graph neural networks process relationship analysis across the system. In these example embodiments, the ELS may coordinate these neural networks through a machine learning integration framework that implements multiple advanced approaches. For example, the system may utilize supervised learning algorithms for pattern recognition tasks, while simultaneously deploying unsupervised learning systems for anomaly detection, and/or vice versa. Reinforcement learning capabilities may be implemented for continuous optimization processes, while deep learning systems may handle complex analysis tasks requiring sophisticated pattern recognition. In embodiments, the ELS may manage the practical implementation of these systems through a hierarchical task distribution framework that enables efficient parallel processing optimization. The system may implement sophisticated resource allocation management protocols to ensure optimal utilization of computing resources across different AI subsystems. This framework facilitates cross-system learning integration, allowing different AI components to share and leverage insights across various operational domains.

In embodiments, the ELS may include a central processing unit that coordinates various AI and machine learning components through integrated memory systems storing executable instructions. In these embodiments, the system architecture may enable parallel processing of intelligence tasks across different domains while maintaining data consistency through synchronization protocols. The implementation may include dedicated data storage systems and communication interfaces that facilitate interaction between different neural network and machine learning components.

In embodiments, the ELS may implement real-time processing capabilities through its neural network arrays and AI engines. In example embodiments, these components may work in concert to process operational data, enabling continuous updates to simulations and forecasting models. In these example embodiments, the system may maintain real-time synchronization between physical and digital assets through its digital twin implementation, allowing for immediate feedback and adjustment of operational parameters.

In embodiments, the ELS may include neural network and machine learning systems that operate within a comprehensive security framework that implements end-to-end encryption and secure data transmission protocols. In example embodiments, the system may maintain privacy preservation techniques while enabling the AI components to process and analyze data without compromising security protocols.

In embodiments, the ELS may enable enterprise system integration through dedicated communication interfaces that connect with ERP systems, CRM platforms, manufacturing execution systems, and supply chain management systems. For external connectivity, the ELS may maintain connections with cloud services, partner networks, external data sources, and third-party applications through its communication interfaces and integration modules. In these example embodiments, the system-of-systems architecture may include communication interfaces and security modules that enable data synchronization while maintaining security protocols. This may include end-to-end encryption for data transmission and privacy preservation techniques for sensitive information exchange.

In embodiments, the ELS may include an integration framework that supports automated workflow management and cross-system data synchronization capabilities to ensure consistent data flow across connected enterprise systems. For performance optimization, the system may implement horizontal and vertical scaling capabilities along with dynamic resource allocation and load balancing to maintain efficient system integration and data exchange. In these example embodiments, the system's reliability features may include fault tolerance mechanisms and redundancy management to ensure consistent integration performance, while system health monitoring maintains stable connectivity with integrated enterprise systems.

Example embodiments include, but are not limited to the ELS having a set of machine learning systems, a set of artificial intelligence systems, and/or set of neural networks configured to 1) execute a set of intelligence tasks associated with a set of simulations, and 2) execute a set of intelligence tasks associated with forecasting, and 3) execute a set of intelligence tasks associated with a set of digital twins, and 4) execute a set of intelligence tasks associated with the Industrial Metaverse, and 5) execute a set of intelligence tasks associated with a value chain network control tower, and 6) execute a set of intelligence tasks associated with a set of value chain network mini control towers, and 7) execute a set of intelligence tasks associated with big data and/or analytics, and 8) execute a set of intelligence tasks associated with a set of executive digital twins, and 9) execute a set of intelligence tasks associated with an industrial internet of things (IIoT) platform, and 10) execute a set of intelligence tasks associated with AI-based industrial operational control, and 11) execute a set of intelligence tasks associated with an AI-driven Industrial Metaverse, and 12) execute a set of intelligence tasks associated with a set of financial executive digital twins, and 13) execute a set of intelligence tasks associated with enterprise transaction systems integration, 14) execute a set of intelligence tasks associated with an enterprise access layer, and 15) execute a set of intelligence tasks associated with AI-based enterprise transactional decision support, and 16) execute a set of intelligence tasks associated with a set of supply chains, and 17) execute a set of intelligence tasks associated with demand shaping integration, and 18) execute a set of intelligence tasks associated with a value chain network system of systems, and 19) execute a set of intelligence tasks associated with a set of executive digital twins for vehicle fleet operations, and 20) execute a set of intelligence tasks associated with a set of vehicle digital twins for design and simulation, and 21) execute a set of intelligence tasks associated with an enterprise access layer for fleet transactions, and 22) execute a set of intelligence tasks associated with software defined vehicle management, and 23) execute a set of intelligence tasks associated with a set of executive digital twins for enterprise energy operations, and 24) execute a set of intelligence tasks associated with enterprise energy system of systems integration, and 25) execute a set of intelligence tasks associated with an enterprise access layer for energy transactions, and 26) execute a set of intelligence tasks associated with AI-based enterprise transactional decision support for energy management.

### Offering Laver

In embodiments, the system of systems 1900 includes an offering layer 2200 configured to create, manage, and enable offerings of the system of systems 1900 via a plurality of offering modules 2202. The offering layer includes an intelligent systems architecture that includes multiple sophisticated components configured to work together to deliver advanced capabilities across various domains. Referring to FIG. 20, the offering layer may include one or more of a content generation intelligence module 2204, a content personalization module 2206, a smart products intelligence framework module 2208, an AR processing module 2210, an immersive environment generation module 2212, a reality-virtuality fusion module 2214, a cross-reality integration module 2216, an audience segmentation module 2218, a domain-specific knowledge processing module 2220, a large language model (LLM) module 2222, a collaborative filtering module 2224, or an integration architecture module 2226.

In embodiments, the content generation intelligence module 2204 is configured to leverage natural language processing (NLP) models that enable automated creation of diverse content types. The NLP models employ advanced transformer architectures to understand context, maintain coherence, and generate human-like text across multiple domains and styles. One or more deep learning networks dedicated to image and video generation may utilize generative adversarial networks (GANs) and diffusion models to create high-fidelity visual content, incorporating style transfer capabilities and content-aware generation features. One or more transformer-based architectures for multi-modal content synthesis enable seamless integration of text, images, audio, and video, creating cohesive multi-format content. One or more quality assurance and content validation mechanisms employ specialized neural networks that evaluate generated content against predefined quality metrics, ensuring consistency, accuracy, and appropriateness of all outputs.

In embodiments, the content personalization module 2206 implements sophisticated collaborative filtering neural networks that analyze user interactions and preferences across multiple dimensions. These networks utilize matrix factorization techniques enhanced with deep learning capabilities to identify complex patterns in user behavior. The user behavior analysis models incorporate both explicit and implicit feedback mechanisms, processing real-time interaction data to continuously refine user profiles. Real-time content adaptation engines employ reinforcement learning algorithms to dynamically adjust content presentation based on user responses and contextual factors. The personalization optimization algorithms utilize multi-armed bandit approaches combined with deep learning to balance exploration and exploitation in content recommendations.

In embodiments, the smart products intelligence framework module 2208 includes product behavior prediction models that utilize recurrent neural networks to forecast usage patterns and potential issues before they arise. The usage pattern recognition systems employ unsupervised learning techniques to identify clusters of similar usage behaviors and anomaly detection to flag unusual patterns. Adaptive learning mechanisms continuously update product parameters based on real-world usage data, optimizing performance through reinforcement learning approaches. The real-time performance monitoring neural networks process sensor data streams to maintain optimal product functionality and predict maintenance needs.

In embodiments, the AR processing module 2210 includes one or more computer vision neural networks configured to utilize advanced convolutional architectures for real-time object recognition and tracking. Spatial mapping and tracking algorithms combine SLAM (Simultaneous Localization and Mapping) techniques with deep learning to create accurate environmental models. Real-time environment understanding models process multiple sensor inputs to maintain consistent AR experiences across varying conditions. The AR content placement optimization engines use sophisticated algorithms to determine optimal positioning of virtual elements within the physical space, considering both spatial and contextual factors.

In embodiments, the immersive environment generation module 2212 includes one or more models within the VR intelligence layer configured to create photorealistic virtual spaces using advanced rendering techniques combined with neural radiance fields. Physics simulation neural networks ensure realistic object behavior and interactions within virtual environments. User interaction prediction systems anticipate user actions to reduce latency and improve responsiveness. Experience optimization algorithms continuously adjust rendering parameters and content delivery based on hardware capabilities and user preferences.

In embodiments, the reality-virtuality fusion module 2214 enables seamless integration of virtual elements with physical environments through sophisticated scene understanding and rendering techniques. Environmental understanding neural networks process multiple sensor inputs to create accurate representations of physical spaces. Real-time scene analysis systems continuously update environmental models to maintain consistent mixed reality experiences. Interactive element placement algorithms optimize the positioning and behavior of virtual objects within the physical space.

In embodiments, the cross-reality integration module 2216 includes one or more models configured to enable consistent experiences across different reality platforms through unified representation models. Universal XR content adaptation networks automatically optimize content for different display types and interaction methods. Experience synchronization algorithms maintain temporal and spatial consistency across multiple users and devices. Multi-modal interaction processing systems handle various input methods including gesture, voice, and traditional controls.

In embodiments, the audience segmentation module 2218 includes one or more neural networks configured to utilize deep learning techniques to identify and categorize user groups based on behavioral and demographic data. Ad performance prediction models employ ensemble learning approaches to forecast campaign effectiveness across different channels. Real-time bidding optimization systems use reinforcement learning to maximize advertising ROI. Campaign effectiveness learning algorithms continuously update targeting strategies based on performance data.

In embodiments, the domain-specific knowledge processing module 2220 includes one or more models configured to utilize sophisticated knowledge representation schemes combined with neural networks for efficient information retrieval and processing. Decision support neural networks combine traditional rule-based systems with modern deep learning approaches for improved accuracy. Inference engine optimization systems employ probabilistic reasoning techniques enhanced by machine learning. Rule-based learning algorithms automatically extract and update domain rules from new data.

In embodiments, the LLM module 2222 includes one or more models configured to incorporate transformer architectures with multiple (e.g., billions) of parameters for sophisticated text generation capabilities. Diffusion models for media creation utilize advanced noise prediction networks for high-quality image and video generation. Multi-modal synthesis networks enable coordinated generation of content across different modalities. Output quality validation systems employ specialized neural networks to ensure generated content meets quality and safety standards.

In embodiments, the collaborative filtering neural networks module 2224 includes one or more models configured to implement hybrid approaches combining memory-based and model-based techniques for accurate recommendations. Content-based recommendation models utilize deep learning for feature extraction and similarity computation. Hybrid recommendation systems combine multiple approaches through sophisticated ensemble techniques. Real-time preference learning algorithms continuously update user models based on interaction data.

In embodiments, the integration architecture module 2226 is configured to implement components through a microservices-based deployment model, where each intelligence component operates as an independent service with clearly defined interfaces. Container orchestration manages resource allocation and scaling, while the API-first design ensures consistent interaction patterns across all components. The event-driven architecture enables real-time processing and communication between components through a sophisticated message broker system.

In embodiments, the offering layer includes an enterprise wallet intelligence framework that includes a suite of artificial intelligence systems designed to manage and optimize digital asset operations within enterprise environments. The framework employs deep learning models for real-time transaction monitoring and fraud detection, utilizing pattern recognition to identify suspicious activities while maintaining high throughput for legitimate transactions. Advanced encryption neural networks ensure secure key management and transaction signing while adapting to emerging security threats. The system includes behavioral analysis models that learn normal transaction patterns for different enterprise roles and departments, automatically flagging anomalous activities for review. Natural language processing systems enable intuitive wallet interactions through voice commands and conversational interfaces while maintaining strict security protocols. The framework employs reinforcement learning algorithms to optimize transaction routing and fee management across multiple blockchain networks. Predictive analytics models forecast liquidity needs and recommend optimal asset allocation strategies. The system utilizes federated learning techniques to share threat intelligence across enterprise wallets while preserving transaction privacy. Multi-signature management systems powered by AI coordinate approval workflows while adapting to organizational structures and policies.

In embodiments, the offering layer includes a transaction system user interface intelligence platform that incorporates neural networks and AI systems designed to deliver personalized and intuitive transaction experiences. The platform employs computer vision networks for secure biometric authentication and document processing during high-value transactions. Deep learning models analyze user interaction patterns to dynamically adjust interface layouts and workflows for optimal efficiency. The system includes natural language processing engines that enable conversational interaction with transaction systems while maintaining precise control over financial operations. Adaptive learning algorithms continuously optimize interface elements based on user behavior and feedback while maintaining consistency with enterprise standards. The platform utilizes attention mechanisms to highlight critical transaction information and potential issues requiring user review. Recommendation systems suggest optimal transaction paths and parameters based on historical patterns and current conditions. The system employs reinforcement learning to optimize multi-step transaction workflows while reducing error rates. Real-time translation networks enable seamless operation across multiple languages and regional formats while maintaining transaction accuracy.

In embodiments, the offering layer includes a customized offer configuration intelligence system that includes artificial intelligence systems for dynamic offer generation and optimization. The system employs deep learning models that analyze customer data and transaction history to generate personalized offer parameters. Natural language processing networks enable automated extraction of offer requirements from unstructured communications and documents. The system includes neural networks for real-time pricing optimization based on market conditions and customer segments. Reinforcement learning algorithms continuously optimize offer terms while maintaining profitability constraints. The system utilizes collaborative filtering techniques to identify effective offer patterns across similar customer segments. Predictive analytics models forecast offer acceptance probabilities and potential revenue impact. The system employs genetic algorithms to evolve and optimize offer structures based on performance data. Advanced classification networks automatically categorize customer needs and match them with appropriate offer templates. The system includes simulation capabilities that enable testing of offer strategies before deployment.

### Transactions Layer

In some example embodiments, a system-of-systems (SOS) (e.g., system of systems 1900) may include a transaction layer 2300 that includes a set of hardware and/or software-defined transaction modules that may interact with one another and/or other layers of the SOS to automate, optimize, execute, and/or otherwise facilitate digital transactions on behalf of an entity, such as an enterprise. In example embodiments, a transaction layer 2300 may deploys and/or leverages various types of AI models (e.g., generative AI models, neural networks, machine-learning models, and/or other types of models) to perform various tasks associated with a transaction (e.g., transaction execution, transaction fulfillment, transaction reconciliation, opportunity discovery, and/or the like).

In example embodiments, the transaction layer 2300 may interfaces with other layers of system of systems 1900. In these example embodiments, the transaction layer 2300 may provide a set of services to one or more layers modules of the SOS and/or request services from the other layers. For example, an enterprise layer 2100 may initiate a transaction in response to receiving an invoice from a third-party service or goods provider by requesting a transaction from the transaction layer. In a related example, the transaction layer 2300 may request approval services from a governance layer 2000 before the transaction layer 2300 executes a requested transaction on behalf of the enterprise using a digital wallet controlled by the transaction layer. Other examples relating to the transaction layer 2300 are discussed below.

FIG. 21 illustrates an example set of modules of an example transaction layer 2300. These may include API integrations modules 2316, authentication and security modules 2304, transaction execution modules 2306, transaction orchestration modules 2308, transaction discovery modules 2310, transaction fulfillment modules 2312, transaction reconciliation modules 2314, and/or other suitable modules.

In example embodiments, the transaction layer modules may include and/or leverage cloud-based virtualized containerization capabilities and services, such as without limitation a container deployment and operation controller, such as Kubernetes or the like. Cloud-based virtualized containers may provide for data layers to be deployed close to source data, thereby potentially reducing network bandwidth consumption or the potential for network disturbances in a data workflow, especially when addressing voluminous local situations such as in industrial and commercial environments.

In example embodiments, technologies may be provided by and/or enabled by the data layer 2600 include intelligence services 2720, such as artificial intelligence, machine learning and the like. These intelligence services 2720 may be provided by the data layer 2600, or accessed (e.g., as third-party services) via one or more. The data layer control 2706 may be provided access to the intelligence services 2720. In example embodiments, the data layer control 2706 may provide its own set of intelligence services.

In example embodiments, the transaction layer 2300 may implement a secure integration framework for interfacing with external systems, such as financial institutions, digital marketplaces, and/or blockchain networks. In example embodiments, the secure integration framework may include one or more authentication and security module(s) 2306 that manage and facilitate secure connections with external systems. In example embodiments, an authentication and security module 2306 may implement respective security capabilities such as, but not limited to, multi-factor authentication, public key infrastructure (PKI) based certificate management, hardware security modules (HSMs) for cryptographic key storage and management, encrypting communication channels (e.g., using TLS 1.3 or higher), OAuth 2.0 and OpenID Connect for API authorization, IP address whitelisting, API key rotation mechanisms, and/or the like. It is appreciated that the authentication and security module 2306 may implement other respective security capabilities

In example embodiments, the transaction layer 2300 may implements an API integration framework that may provide standardized interfaces for connecting to different types of external systems (e.g., 3rd party data sources, financial institution platforms, digital marketplaces, blockchains, user devices, IoT devices, and/or the like). In these example embodiments, the transaction layer 2300 may include one or more API integration modules 2316 that implement various types of APIs and protocols including RESTful APIs for financial institution connections, WebSocket implementations for real-time market data streams, FIX protocol integration for trading systems, ISO 20022 message formats for financial transactions, GraphQL interfaces for flexible data querying, webhook handlers for asynchronous transaction notifications, and/or the like.

### Transaction Execution Modules

In example embodiments, the transaction layer 2300 may include one or more transaction execution modules 2306. In example embodiments, a transaction execution module 2306 may be configured to execute transactions on behalf of an entity. In these example embodiments, a transaction execution module 2306 may be configured to control one or more accounts of the entity. In some of these example embodiments, a transaction execution module 2306 may control one or more entity digital wallets, where each digital wallet may be configured to execute transactions from an entity account and/or one or more marketplaces. For example, a digital wallet may be configured to facilitate blockchain transactions on behalf of the entity using the credentials (e.g., private key and/or public key) of a blockchain account of the entity. In another example, a second digital wallet may be configured to securely interface with the virtual infrastructure of a respective financial institution (e.g., using an API of the financial institution and account credentials of a respective entity) to transfer funds from an account of the entity to another entity (e.g., via a bank-to-bank wire, an account transfer within the bank, or the like). In another example, a digital wallet may interface with one or more digital marketplaces or exchanges (e.g., using an API of the marketplace/exchange). In these example embodiments, the digital wallet may be configured to transact for assets. Examples of assets that may be transacted for via a marketplace may include financial assets (e.g., foreign currencies, stocks, bonds, commodities, and/or the like), physical items (e.g., real estate, fungible goods, collectible items, and/or the like), resources (e.g., energy resources, computing resources, network resources, and/or the like). Examples of the types of transactions (or related actions) that may be performed by a digital wallet on a marketplace may include selling an asset of the entity, purchasing an asset, offering an asset for sale, making a bid on an asset, and/or the like.

In example embodiments, a transaction execution module 2306 may cause a digital wallet to perform a specific transaction (e.g., instructing a financial institution to transfer a specific amount from a specific account of the entity to a specific recipient/account; instructing a crypto wallet to generate and digitally sign a transfer request for a specific amount of cryptocurrency on a blockchain using the public key and/or private key corresponding to a specific account of the entity on the blockchain; instructing a digital wallet to purchase a specific amount of stock on an exchange; instructing a digital wallet to purchase an amount of a resource on a future or spot resource market; and/or the like).

In example embodiments, a transaction execution module 2306 may implement specialized digital wallet capabilities that execute different types of transactions using respective transaction channels. For example, blockchain transactions, a transaction execution module 2306 may implement multi-signature wallet capabilities with configurable M-of-N schemes, transaction signing (e.g., using elliptic curve cryptography), gas optimization algorithms, smart contract interaction through Application Binary Interface (ABI) encoding/decoding, and/or the like. For traditional financial transactions, a transaction execution module 2306 may implement Automated Clearing House (ACH) transaction processing with NACHA file format support, Society for Worldwide Interbank Financial Telecommunication (SWIFT) message generation for international wire transfers, real-time payment system integration, automated reconciliation using ISO 20022 messages, and/or payment card processing through tokenization services. For example, digital marketplace transactions, a transaction execution module 2306 may implement order book management systems, price discovery algorithms, automated trading interfaces, position management and risk monitoring capabilities, market making functionality with configurable spreads, and/or liquidity aggregation across multiple venues.

In example embodiments, a security module 2304 may allow a transaction execution module to interface with a respective transaction channel. In these example embodiments, when a transaction execution module 2306 receives a request to execute a transaction, the security module 2304 may authenticate the transaction request and establish a secure connection with the respective transaction channel corresponding to the transaction request. For example, when executing a blockchain transaction, the authentication and security module 2304 may retrieve the private key of the respective blockchain account from a secure credential vault, which may allow a transaction execution module to digital sign the requested transaction that may be provided to a blockchain network to complete the transaction. In another example, when executing a bank transfer, the security module 2406 may retrieve the account credentials from the secure credential vault, verify the authenticity of the transaction request using various authentication protocols, and establish a secure connection with the bank's API. In example embodiments, a secure credential vault may store and manages authentication credentials used by the transaction execution modules 2306. The credential vault may implement hardware-backed key storage, an encrypted credential database, key rotation policies, access control lists, audit logging of credential usage, and/or secure credential injection into API calls.

In example embodiments, the transaction execution module 2306 may receive an instruction to perform a transaction from another transaction module, another layer of the SoS, and/or from a user associated with the entity. In example embodiments, the transaction execution module 2306 may receive a set of transaction parameters that specify information needed to execute the transaction, such as the account/digital wallet involved in the transaction, the type of transaction (e.g., sending funds, requesting funds, bidding on an item, and/or the like), the transaction amount, the account and/or digital wallet to use for the transaction, and/or any other suitable information. In response, the transaction execution module 2306 may generate an instruction to a selected enterprise digital wallet based on the transaction parameters. In response, the digital wallet may attempt to execute the transaction. In example embodiments, the digital wallet may return an outcome of the transaction (e.g., whether the transaction was successful or unsuccessful) as well as any other relevant metadata (e.g., timestamp, a receipt, an amount transferred, etc.). In response, the transaction execution module 2306 may provide the transaction outcome to various modules of the transaction layer and/or another layer of the SoS.

### Transaction Orchestration

In example embodiments, the transaction layer 2300 may include one or more transaction orchestration modules 2308 that may be configured and trained to automate and/or manage one or more tasks of a transaction workflow on behalf of an enterprise. In example embodiments, the transaction orchestration module 2308 may be configured to determine a transaction orchestration workflow, initiate various tasks within a transaction orchestration workflow (which may be performed by other transaction modules of the transaction layer 2300), monitor outcomes of those tasks, and/or selectively initiate subsequent tasks based on the outcomes. In example embodiments, a transaction orchestration module 2308 may be configured to deploy an intelligent agent that may be configured and trained to orchestrate the tasks of a transaction on behalf of an enterprise, which may be referred to as a transaction orchestration agent. For example, a transaction orchestration agent transaction orchestration module 2308 may initiate a transaction discovery task that identifies a potential transaction and/or one or more potential counterparties for the potential transaction. In this example, the transaction orchestration agent may be granted authority to selectively initiate a next stage of a transaction workflow based on an outcome of the transaction discovery task or the transaction orchestration agent may be instructed by a user to initiate the next stage. In either scenario, the intelligent transaction orchestration agent may then initiate the generation of a transaction. In some transaction workflows, the generation of a transaction may include determining a set of transaction parameters corresponding to the transaction. For example, if the transaction involves cryptocurrencies and/or a smart contract, the transaction parameters may include the blockchain address of the accounts and/or smart contract involved in the transaction (e.g., the recipient and/or sender of the cryptocurrency and/or the smart contract that is facilitating the blockchain transaction), an amount of cryptocurrency to be sent, a transaction request that is generated for digital signature, an object of the transaction (e.g., an identifier of the digital or real-world asset being transacted for, an identifier of a service being paid for, and/or the like), and/or other suitable transaction parameters. In an example of a real estate transaction, the transaction parameters may include an identifier of the property being transferred, purchaser information, seller information, a purchase price, and/or other supplemental information that may be used to generate documents relating to the real estate transaction and/or transfer of ownership of the property from one entity to a purchasing entity, and/or the like. In some example embodiments, the transaction orchestration agent may automate a contract negotiation with a counterparty to the transaction to determine the set of transaction parameters. Additionally, or alternatively, a user of the system may provide some or all of the transaction parameters (e.g., via a user interface).

In some example embodiments and some types of transaction workflows, the user may designate (e.g., via a user interface) an enterprise account and/or digital wallet to perform the transaction. Alternatively, a transaction orchestration agent may be trained to select appropriate accounts for particular transactions. In some of these example embodiments, a transaction orchestration agent may be trained to determine which accounts to use for a particular transaction by analyzing various transaction parameters and conditions. For example, the transaction orchestration agent may analyze the marketplace and/or location (e.g., country, state, city) where the transaction will take place to determine whether specialized accounts are needed (e.g., accounts that are pre-approved or whitelisted for the location or are compatible with the marketplace). The transaction orchestration agent may also analyze whether the transaction involves blockchain or traditional financial transaction rails to select an account that may be configured for the respective transaction channel. The transaction orchestration agent may also analyze the transaction amount to determine whether the selected account has sufficient funds or whether the transaction amount exceeds predefined transaction limits for the account. The transaction orchestration agent may also analyze the purpose of the transaction (e.g., whether it is for operational expenses, investment purposes, or other business purposes) to select an account that may be designated for that type of transaction. The transaction orchestration agent may also analyze historical transaction patterns, risk parameters, compliance requirements, and/or enterprise policies to ensure the selected account aligns with enterprise guidelines and risk tolerance levels. In response to determining which account/digital wallet to use, the transaction orchestration module 2308 may then instruct a transaction execution module 2306 to generate and execute the transaction.

It is appreciated that a transaction orchestration agent may be trained to orchestrate other types of tasks within a transaction workflow. For example, in some example embodiments a transaction orchestration agent may initiate transaction discovery tasks. In this example, the orchestration agent may be deployed to initiate a transaction discovery task (e.g., using a transaction discovery module), and in response to being provided a transaction opportunity, determine whether to proceed with the transaction. In another example, a transaction orchestration agent may initiate post-transaction tasks, such as fulfillment and reconciliation.

### Transaction Discovery

In example embodiments, the transaction layer 2300 may include one or more transaction discovery modules. In example embodiments, a transaction discovery module 2310 may be configured to analyze data from disparate data sources for purposes of identifying potential transactions on behalf of an entity. For instance, the transaction discovery module 2310 may be configured and trained to discover potential in-bound transactions that align with an asset class or a strategy/transaction profile provided by a user. Additionally or alternatively, the transaction discovery module 2310 may be configured and trained to discover potential outbound transactions for an asset or class of assets in response to receiving an indicator of the asset or class of asset. It is appreciated that a transaction discovery module 2310 may be configured to discover different types of transactions that involve different types of asset classes. For example, in some example implementations, a transaction discovery module 2310 may be configured to identify potentially distressed assets that may be potential transaction targets. In another example, a transaction discovery module 2310 may monitor various marketplaces to identify potential arbitrage opportunities and/or opportunities to purchase energy, raw materials, and/or other resources that an enterprise may require in the future.

In example embodiments, the transaction discovery module 2310 may request or subscribe to data feeds and/or event notifications from the data layer—which may deploy intelligent agents that monitor a large number of data sources from which the data feeds and/or event notifications are mined and/or curated. The transaction discovery module 2310 may include one or more intelligence models (e.g., a set of machine learning models, neural networks, and/or other types of artificial intelligence models) and/or may interface with an intelligence system that may collectively process the data feeds and/or event notifications received from the data layer and may identify potential in-bound or outbound transactions based on the monitored data feeds and/or event notifications. In some of these example embodiments, the transaction discovery module 2310 may parse, structure, vectorize, and analyze the curated data feeds and/or event data. The transaction discovery module 2310 may then feed this data into its intelligence models, which may output potential transactions that may align with a requested asset class or transaction profile.

In example embodiments, the transaction discovery module 2310 may utilizes data from disparate sources to identify potential transactions. For example, in the context of arbitrage opportunities on decentralized cryptocurrency exchanges, the transaction discovery module 2310 may monitor real-time price feeds and order book data from multiple decentralized exchanges to identify price discrepancies that may present arbitrage opportunities. In these example embodiments, the transaction discovery module 2310 may analyze liquidity pools, calculate potential arbitrage spreads while accounting for transaction costs (e.g., gas fees, slippage), identify optimal routing paths between exchanges, monitor pending transactions in a memory pool that may impact arbitrage opportunities, and track historical price correlations and volatility patterns. The transaction discovery module 2310 may feed this data into its intelligence models to identify and score potential arbitrage opportunities.

In another example focused on discovery of real estate transaction opportunities, the transaction discovery module 2310 may monitor multiple data sources including property listings, foreclosure notices, tax records, satellite imagery, property condition reports, building permits, construction activity, comparable sales data, demographic data, and economic indicators. The transaction discovery module 2310 may analyze this data to identify properties that may match specific investment criteria (e.g., distressed properties, properties in developing areas, properties with potential for value appreciation). The transaction discovery module 2310 may use its intelligence models to parse and structure the raw data feeds, vectorize text and numerical data, apply natural language processing to unstructured content, identify patterns and correlations across data sources, generate opportunity scores and risk assessments, and rank potential transactions based on their alignment with enterprise investment criteria, etc. In identifying a potential property, the transaction discovery module 2310 may also determine an estimated value of the property and/or a proposed purchase price. In some example embodiments, the transaction discovery module 2310 may output the potential transaction opportunity to a transaction orchestration module 2308, which in turn may notify a decision maker regarding the opportunity, configure an offer to purchase the property, submit a bid on the property (e.g., if for sale or being auctioned), and/or the like.

### Transaction Fulfillment and Reconciliation

In example embodiments, the transaction layer 2300 may include one or more transaction fulfillment modules 2312 that may be configured to manage and automate post-execution requirements of a transaction. In example embodiments, a transaction fulfillment module 2312 may be configured to monitor the status of a transaction after the transaction has been initiated by a transaction execution module 2306. For example, after a transaction execution module 2306 initiates a transfer of funds via a financial institution, the transaction fulfillment module 2312 may monitor the status of the transfer to determine whether the transfer was successful. In another example, after a transaction execution module 2306 initiates a blockchain transaction, the transaction fulfillment module 2312 may monitor the status of the blockchain transaction (e.g., by monitoring the number of block confirmations) to determine whether the transaction has been confirmed on the blockchain. In example embodiments, the transaction fulfillment module 2312 may generate notifications regarding the status of transactions and/or may trigger subsequent actions based on transaction status. For example, the transaction fulfillment module 2312 may generate a notification when a transaction is confirmed or may trigger the generation of transaction documentation (e.g., receipts, confirmations, transfer records, settlement instructions) when a transaction is completed.

In example embodiments, the transaction layer 2300 may include one or more transaction reconciliation modules 2314 that may be configured to verify and validate completed transactions across multiple systems of record. In example embodiments, a transaction reconciliation module 2314 may compare transaction records across internal and external systems to identify and flag any discrepancies. For example, a transaction reconciliation module 2314 may compare transaction records in an enterprise accounting system with transaction records from a financial institution to ensure that the records match. In another example, a transaction reconciliation module 2314 may compare blockchain transaction records with internal transaction records to verify that blockchain transactions were executed as intended. In example embodiments, the transaction reconciliation module 2314 may implement one or more machine learning models that may be configured and trained to detect patterns in transaction data, identify potential reconciliation issues, automate the classification of transaction exceptions, and/or suggest resolution actions for common reconciliation scenarios.

In example embodiments, the transaction reconciliation module 2314 may interface with enterprise accounting systems, financial reporting systems, and/or regulatory compliance systems to ensure accurate transaction recording and reporting. The transaction reconciliation module 2314 may implement standardized reconciliation protocols (e.g., ISO 20022) and may support various data formats (e.g., MT940, BAI2, SWIFT) for automated reconciliation processes. In example embodiments, the transaction reconciliation module 2314 may maintain audit trails of reconciliation activities and may generate exception reports for transactions that require manual review.

### Transaction Discovery System

In example embodiments, transaction layer 2300 may implement multiple specialized transaction systems that work together to form a comprehensive transaction management framework. The transaction discovery system may leverage artificial intelligence capabilities to identify and analyze potential transaction opportunities across multiple data sources. This system may process real-time market feeds, historical patterns, and/or other data to identify opportunities like arbitrage or resource acquisition needs, while providing automated compliance checks through integration with the governance layer 2000.

In example embodiments, a transaction discovery system may leverages artificial intelligence capabilities across multiple layers to identify and analyze potential transaction opportunities. The system may employ contextual simulation and forecasting capabilities from the enterprise layer to evaluate transaction scenarios and predict outcomes, while utilizing expert systems and generative AI from the offering layer to customize and configure transaction parameters. The system may process data from various sources (e.g., real-time market feeds, books, and historical transaction patterns) to identify opportunities such as arbitrage, distressed assets, or resource acquisition needs. Deep learning networks may analyze market trends and transaction patterns while reinforcement learning algorithms may optimize transaction routing and execution strategies. The system may interface with the governance layer to ensure automated compliance checks and regulatory adherence for discovered transactions, while leveraging the operations layer for automated monitoring and execution workflows. For financial use cases, the system may monitor multiple marketplaces simultaneously to identify price discrepancies, analyze liquidity pools, calculate potential spreads while accounting for transaction costs, and determine optimal routing paths between exchanges. The system may also employ predictive analytics to forecast resource needs and market conditions, enabling proactive transaction discovery for enterprise resource planning and strategic asset acquisition. Implementation may utilize distributed computing resources at both edge and cloud levels to ensure real-time processing capabilities, with AI-driven anomaly detection systems monitoring network health and transaction patterns for potential opportunities or risks.

### Transaction Generation System

Building on discovery capabilities, a transaction generation system may employ smart contract orchestration engines and generative AI to create and configure digital transactions. This system may automatically configure transaction parameters, including blockchain addresses, cryptocurrency amounts, and/or digital signatures, while implementing security protocols through AI-driven authentication systems.

In example embodiments, a transaction generation system may integrates multiple layers of AI capabilities to create and configure digital transactions. The system may employs smart contract orchestration engines to automate transactional workflows and may leverages generative AI to propose transaction parameters and configurations. The system may utilize deep learning models to analyze transaction parameters, determine optimal routing paths, and generate appropriate transaction documentation. The system may interface with enterprise wallets and digital infrastructure to execute transactions across multiple platforms, marketplaces, and exchanges through a common point of access. For financial transactions, the system may automatically configure transaction parameters including blockchain addresses, cryptocurrency amounts, digital signatures, and/or smart contract interactions. The system may employ natural language processing for automated extraction of transaction requirements from unstructured communications, while implementing security protocols through AI-driven authentication systems that may ensure secure access while enabling rapid response to market opportunities. In example embodiments, the transaction generation system may differs from the transaction discovery system by focusing on the creation and configuration of transaction parameters and documentation rather than opportunity identification, utilizing distinct AI capabilities such as smart contract orchestration and automated parameter generation rather than market monitoring and opportunity analysis. The system may also tokenize digital assets to digitally represent transactions within the enterprise ecosystem and may employ blockchain technology to manage and secure the generated transactions. Implementation may include integration with governance systems to ensure automated compliance checks during transaction generation, while maintaining audit trails through immutable transaction recording.

### Transaction Optimization System

In example embodiments, a transaction optimization system may integrates AI capabilities across multiple layers to maximize efficiency and effectiveness of transaction execution. The transaction optimization system may maximize efficiency by employing resource optimization AI to dynamically allocate processing power and may optimize transaction parameters. For financial transactions, the system may analyze liquidity pools, calculate optimal transaction costs, and/or determine efficient routing paths between exchanges, leveraging the intelligence system for model-based market predictions. The system may employ resource optimization AI to dynamically allocate processing power and optimize transaction parameters while analyzing leverage ratios in real-time to balance returns against risk exposure. The system may utilize predictive analytics and machine learning models to optimize transaction routing, fee management, and/or timing across multiple networks and marketplaces. For financial transactions, the system may analyze liquidity pools, calculate optimal transaction costs including gas fees and slippage, and determine the most efficient routing paths between exchanges. The system may leverage the intelligence system to provide model-based market predictions, including currency exchange rates, future prices, transaction volumes, and/or interest rates to optimize transaction timing and execution. The optimization system may specifically concentrate on enhancing transaction efficiency through real-time analytics and dynamic parameter adjustment. The system may employ deep learning networks for pattern recognition and predictive analytics, while utilizing distributed ledger technology for transparent tracking of optimization decisions. Implementation may include integration with the operations layer for automated monitoring and the resource layer for computational resource optimization, while maintaining compliance through automated governance checks. The system may also optimize multi-step trading workflows while reducing error rates and may employ AI-driven models to predict market volatility and credit risk, enabling proactive optimization of transaction parameters.

### Transaction Reconciliation System

In example embodiments, a transaction reconciliation system may leverages multiple layers of AI capabilities to verify and validate completed transactions across multiple systems of record. The system may implement machine learning models configured and trained to detect patterns in transaction data, identify potential reconciliation issues, automate the classification of transaction exceptions, and suggest resolution actions for common reconciliation scenarios. Working with the transaction optimization system, the transaction reconciliation system may verify completed transactions across multiple systems of record using machine learning models trained to detect patterns and identify potential reconciliation issues. This system may interface with enterprise accounting systems and may implement standardized reconciliation protocols while maintaining detailed audit trails. The system may interface with enterprise accounting systems, financial reporting systems, and/or regulatory compliance systems to ensure accurate transaction recording and reporting, while implementing standardized reconciliation protocols and supporting various data formats for automated reconciliation processes. For financial transactions, the system may compare transaction records across internal and external systems, such as comparing enterprise accounting records with financial institution records or blockchain transaction records with internal transaction records to verify execution accuracy. The reconciliation system specifically may concentrates on post-execution verification and validation. The system may employ the intelligence system's capabilities for pattern recognition and anomaly detection, while leveraging the governance layer to ensure compliance with regulatory requirements during reconciliation. Implementation may include maintaining detailed audit trails of reconciliation activities and generating exception reports for transactions requiring manual review, while utilizing the operations layer for automated monitoring and workflow orchestration. The system may also interface with digital wallets and blockchain systems to verify cryptocurrency transactions and smart contract executions, ensuring comprehensive reconciliation across both traditional and digital asset transactions.

### Transaction Fulfillment System

In example embodiments, a transaction fulfillment system may integrates AI capabilities across multiple layers to manage and automate post-execution requirements of transactions. The system may monitor transaction status after initiation, such as tracking fund transfers through financial institutions or monitoring blockchain transaction confirmations, while generating automated notifications regarding transaction statuses and triggering subsequent actions based on completion milestones. The transaction fulfillment system may manage post-execution requirements by monitoring transaction status and generating automated notifications. The system may track fund transfers, verify blockchain confirmations, and/or automatically generate transaction documentation, while interfacing with payment service providers and banks to facilitate execution. For financial transactions, the system may monitor the status of transfers, verify block confirmations for blockchain transactions, and automatically generate transaction documentation including receipts, confirmations, transfer records, and/or settlement instructions when transactions are completed. In an example embodiment, the fulfillment system specifically may concentrates on post-execution monitoring and documentation management. The system may leverage the operations layer for automated monitoring and workflow orchestration, while utilizing the intelligence system for predictive analytics to anticipate potential fulfillment issues. Implementation may include integration with enterprise digital wallets and blockchain interfaces to monitor cryptocurrency transactions and smart contract executions, while maintaining compliance through automated governance checks. The system may also interface with payment service providers (PSPs), acquirers, and banks to communicate appropriate information for facilitating and executing transaction fulfillment, while employing AI-driven anomaly detection to identify potential fulfillment issues requiring attention.

### Counterparty Discovery System

In example embodiments, a counterparty discovery system may integrate AI capabilities across multiple layers to identify and evaluate potential transaction partners. The system may leverage model-based counterparty predictions and discovery capabilities from the intelligence system to predict liquidity of counterparties and identify parties likely to buy or sell given assets. The counterparty discovery system may identify and evaluate potential transaction partners using model-based predictions to assess liquidity and compatibility. The system may analyze market behaviors and transaction histories while leveraging scoring systems to assess reliability through know-your-customer technology. For financial transactions, the system may analyze market behaviors, transactional histories, and compatibility metrics to recommend optimal transactional matches, while utilizing deep learning networks to assess various parameters including counterparty risk profiles and transaction volumes. The counterparty discovery system may specifically focus on identifying and/or evaluating potential transaction partners. The system may employ natural language processing for analyzing unstructured data about potential counterparties, while leveraging the scoring system to assess reliability through know-your-customer technology and determine counterparty identities. Implementation may include integration with blockchain scoring systems to assess the reliability of potential counterparties on distributed ledgers, while maintaining compliance through automated governance checks and risk management protocols. The system may also interface with social data and IoT data sources to gather additional insights about potential counterparties, while utilizing predictive analytics to forecast the likelihood of successful transaction execution with identified parties.

### Transaction Orchestration System

In example embodiments, a transaction orchestration system may integrate AI capabilities across multiple layers to automate and manage transaction workflows within the transaction layer. The system may employ transaction orchestration agents configured and trained to determine transaction orchestration workflows, initiate various tasks within those workflows, monitor outcomes, and selectively initiate subsequent tasks based on those outcomes. The transaction orchestration system may coordinate various components by employing AI-configured agents to determine workflows, initiate tasks, and/or monitor outcomes. The system may manage end-to-end orchestration of transactions while interfacing with multiple transaction rails and digital wallets. For financial transactions, the system may manage end-to-end orchestration of payment transactions, including payment authorization, transaction routing, transaction settlement/execution, and/or post-transaction tasks. In example embodiments, the transaction orchestration system may specifically coordinates the entire transaction lifecycle across multiple systems and processes. The system may leverage the intelligence system to obtain model-based market predictions, counterparty predictions, and/or transaction recommendations, while utilizing content generation services for customized offer generation and document review.

Implementation may include integration with payment service providers, acquirers, and/or banks to communicate appropriate information for facilitating transactions, while maintaining compliance through automated governance checks. The system may interface with multiple transaction rails and digital wallets, selecting optimal transaction methods based on factors such as transaction type, volume, format, location, financing, and associated costs. The system may employ AI-driven models to analyze currency needs and automate currency conversion tasks when transactions require conversion to target currencies.

### Contract Configuration System

In example embodiments, a contract configuration system may integrate AI capabilities across multiple layers to automate and manage the creation, customization, and configuration of transaction-related contracts. The system may employ expert systems and generative AI from the offering layer to analyze transaction parameters and automatically generate appropriate contract terms, while utilizing natural language processing for automated extraction of contract requirements from unstructured communications and documents. The contract configuration system may automate the creation and management of transaction-related contracts using expert systems and generative AI. The system may analyze parameters to generate appropriate contract terms while ensuring compliance through automated checks and maintaining detailed audit trails. For financial transactions, the system may automatically configure contract parameters including payment terms, interest terms, licensing terms, and other contractual obligations, while dynamically adjusting terms based on changes in regulatory requirements or enterprise policies. In example embodiments, the contract configuration system may specifically concentrates on contract creation and management. The system may leverage the intelligence system to provide content generation services for customized contract generation and document review, while utilizing the governance layer to ensure automated compliance checks during contract configuration. Implementation may include integration with enterprise document management systems and workflow systems to manage contract versions and approval processes, while maintaining detailed audit trails of contract modifications. The system may also employ AI-driven models to analyze historical contract data and propose optimal terms based on enterprise objectives and risk parameters, while utilizing federated learning techniques to share contract intelligence across enterprise systems while preserving confidentiality.

### Market Orchestration System

In example embodiments, a market orchestration system may integrates AI capabilities across multiple layers to manage and coordinate market activities within the transaction layer. The system may employ AI-based market predictions and analytics to provide insights for strategic decision-making within marketplaces, while utilizing intelligence services to optimize market operations and transaction flows. The market orchestration system may coordinate market activities using AI-based predictions and analytics for strategic decision-making. The system may manage various transactional systems including asset valuation, collateralization, and/or market governance while leveraging intelligence services to optimize market operations. For financial transactions, the system may manage various transactional systems including asset valuation, collateralization, tokenization, market making, and market governance and trust systems, while leveraging the functionality of configured intelligence services to execute market-related tasks. In example embodiments, the market orchestration system may specifically focuses on market-level coordination and management. The system may leverage configured intelligence service systems to process intelligence requests and generate responses including decisions, recommendations, reports, instructions, classifications, pattern recognition, predictions, and optimizations. Implementation may include integration with various market types, such as lending marketplaces, where the system performs tasks requiring external information for functions like asset valuations, inventory access, business profile management, and market analysis. The system may employ AI-driven models to analyze market conditions, automate market-making activities, and manage market governance through automated compliance checks and risk management protocols. The system may utilize federated learning techniques to share market intelligence across enterprise systems while preserving confidentiality, and implement market orchestration workflows that define sets of tasks performed given specific market parameters.

### Automated Transaction Orchestration System

In example embodiments, an automated transaction orchestration system may integrates AI capabilities across multiple layers to provide end-to-end automation of transaction processes within the transaction layer. The system may employ robotic process automation (RPA) modules configured to automate procurement processes based on inventory levels and predictive demand analysis, while interfacing with vendor management systems to streamline supply chain operations. The automated transaction orchestration system may provide end-to-end automation using robotic process automation modules for processes such as procurement and payment authorization. The system may interface with vendor management systems and may implement automated governance through embedded policy capabilities. For financial transactions, the system may automate payment processes including payment authorization, transaction routing, and settlement tasks, while coordinating with payment service providers, acquirers, and banks to communicate appropriate transaction information. In example embodiments, the automated transaction orchestration system may specifically concentrates on fully autonomous execution of transaction workflows. The system may leverage the intelligence system to implement automated targeting and customized offer configuration, while utilizing AI algorithms to predict user needs and proactively present relevant marketplace services. Implementation may include integration with enterprise resource planning (ERP) systems to identify procurement needs, customer relationship management (CRM) systems to tailor marketplace services based on customer profiles, and IoT devices to offer maintenance and repair services based on sensor data. The system may employ AI-driven models for automated spot market testing and arbitrage transaction execution, while utilizing artificial intelligence capabilities for routing, control, optimization, and generation to manage the entire lifecycle of financial transactions. The system may implement automated governance through embedded policy and governance AI capabilities, ensuring continuous compliance monitoring and automated reporting.

### Transaction System-of-Systems

In example embodiments, a transaction system-of-systems may integrates multiple specialized transaction subsystems to create a comprehensive transaction management framework within the transaction layer. The system may coordinate and manage interactions between transaction discovery, generation, optimization, reconciliation, fulfillment, counterparty discovery, smart contract orchestration, market orchestration, and automated transaction orchestration subsystems, while leveraging AI capabilities across multiple layers to ensure seamless integration and operation. The transaction system-of-systems may integrate all of the systems of the transaction layer into a comprehensive framework that may enable enterprises to interface with multiple markets through a common access point. The system may implement converged AI-based workflow orchestration while maintaining comprehensive reporting capabilities and may enable distributed transactions through intelligent edge capabilities. For financial transactions, the system may provide a unified framework that enables enterprises to interface with multiple markets, marketplaces, exchanges, and platforms through a common point of access, while simplifying bilateral or multilateral transactions involving the enterprise. In example embodiments, the transaction system of systems specifically provides comprehensive orchestration and coordination across all transaction-related functions. The system may leverage the intelligence system to implement AI-based enterprise transactional decision support through contextual simulation and forecasting, while utilizing embedded policy and governance AI capabilities for automated compliance monitoring. Implementation may include integration with enterprise access layers that interface with enterprise resources, workflow systems, data services systems, permissions systems, and wallets systems, while maintaining comprehensive reporting capabilities. The system may implement converged AI-based transaction workflow orchestration at the operations layer and intelligent edge capabilities for distributed transactions at the network layer, enabling comprehensive transaction management across the enterprise ecosystem.

### Operations Layer

In embodiments, the techniques described herein relate to a computer-implemented system for managing operations of a set of artificial intelligence systems. In embodiments, the computer-implemented system includes a processor and a memory storing instructions that, when executed by the processor, cause the system to store a set of operations, wherein each operation of the set of operations is associated with at least one artificial intelligence system of the set of artificial intelligence systems, and initiate at least one operation of the stored set of operations with at least one artificial intelligence system of the set of artificial intelligence systems that is associated with the least one operation.

In embodiments, the AI convergence system of systems 1900 includes an operations layer 2400 that causes the AI convergence system of systems 1900 to store a set of operations. For example, each operation may include a description of the operation to be performed. The description may include computer-readable instructions that are executable by one or more processors of one or more devices (e.g., a server, a workstation, a mobile device, an edge device, a virtual device, or the like, or a combination thereof), which may be internal to and/or external to the AI convergence system of systems 1900. The description may include human-readable instructions that describe an operation in a natural language, such as English. The description may be provided at a high level of detail and/or a low level of abstraction (e.g., a sequence of computer-executable instructions in machine language or a compilable programming language, a script of computer-interpretable expressions in an interpreted programming language, a declarative description of the operation in a declarative language such as XML, a flowchart, a mathematical description of an algorithm, or the like) that a processor may follow to perform the operation. The description may be provided at a low level of detail and/or a high level of abstraction (e.g., a summary or overview of an operation that the AI convergence system of systems 1900 may interpret, design, generate, and execute). The description may include an indication of one or more artificial intelligence systems that may be associated with the operation, such as artificial intelligence systems that may perform the operation, upon which the operation may be performed, and/or that may participate in the design, development, generation, execution, monitoring, and/or refinement of the operation. The description may include an indication of one or more resources associated with the operation (e.g., data sources that provide or receive data associated with the operation, storage devices or locations where data associated with the operation may be stored, and/or processing devices that may participate in the operation). The description may include an indication of one or more conditions under which an operation is to be initiated, performed, and/or stopped (e.g., a schedule for initiating the operation on a periodic basis; a trigger condition that causes a device to initiate, perform, and/or stop the operation; and/or types of artificial intelligence systems that may be included and/or associated with a performance of the operation). The description may include an indication of one or more outcomes of the operation (e.g., an expected outcome when the operation is performed in certain conditions, and/or a log of outcomes of one or more previous performance of the operation). The set of operations may include one or more pregenerated operations that are available to be initiated in various contexts. The set of operations may include one or more ad-hoc operations that are generated for a particular instance, context, circumstance, device, artificial intelligence system, or the like. Following initiation and/or completion of an ad-hoc operation, the operations layer 2400 may continue storing the operation with the set of operations (e.g., converting the ad-hoc operation into a pregenerated operation for future execution) or may discard the ad-hoc operation. The set of operations may include one or more operation templates to serve as a basis for other operations (e.g., a set of device-specific stored operations that are based on a common device-independent operation template, or an ad-hoc operation that adapts an operation template for a particular instance).

In embodiments, the operations layer 2400 causes the AI convergence system of systems 1900 to initiate at least one operation of the set of operations with at least one artificial intelligence system. For example, the initiating may involve initiating execution of the operation on an artificial intelligence system (e.g., a training operation that trains the artificial intelligence system, or an optimization operation that modifies the artificial intelligence system to optimize at least one feature). The initiating may involve invoking an artificial intelligence system to initiate the operation on another aspect of the AI convergence system of systems 1900, such as another artificial intelligence system, software based on a closed-form algorithm, an operating process, a device, a user, or the like. The initiating may involve invoking an artificial intelligence system to generate the operation (e.g., invoking an artificial intelligence system to translate a description of an operation at a low level of detail/high level of abstraction into an executable operation at a high level of detail/low level of abstraction, such as an interpretable script or an executable binary). The initiating may involve invoking an artificial intelligence system to adapt an operation template into an ad-hoc operation based on a set of circumstances, which may be provided as input to the artificial intelligence system and/or may be generated by the artificial intelligence system. The initiating may involve invoking an artificial intelligence system to perform the operation, such as a robotic process automation (RPA) artificial intelligence system that is capable of performing a learned sequence of steps comprising a task. The initiating may involve invoking an artificial intelligence system to monitor a performance of the operation (e.g., an artificial intelligence system that serves as a watchdog over the operation to ensure progress and to detect and address problems). The initiating may involve invoking an artificial intelligence system to validate a performance of the operation (e.g., an artificial intelligence system that evaluates one or more outcomes of the operation to ensure that the operation has met one or more objectives for which the operation was initiated). The initiating may involve invoking an artificial intelligence system to record a performance of the operation (e.g., an artificial intelligence system that records the performance of the outcome, documents one or more features of the performance of the operation, and/or summarizes a performance of an operation, one or more measures).

In embodiments, the operations layer 2400 associates resources of the AI convergence system of systems 1900 with a performance of an operation. For example, the operations layer 2400 may identify one or more artificial intelligence systems, devices, processors, storage locations, data sources, or the like that are to be included in a performance of an operation. The operations layer 2400 may secure the availability of the one or more artificial intelligence systems, devices, processors, storage locations, data sources, or the like to be included in the operation, such as reserving resources from the set of available resources of the AI convergence system of systems 1900 and/or executing transactions to acquire resources for the AI convergence system of systems 1900 for the performance of the operation. The operations layer 2400 may schedule the performance of the operation (e.g., choosing a time to perform the operation in view of the execution of other planned and/or unplanned operations by the AI convergence system of systems 1900). The operations layer 2400 may organize the resources to cause the operation to be performable and/or performed (e.g., communicating with a set of devices to notify the devices of their participation in the performance of the operation, and/or exchanging data among the devices that is involved in the operation). The operations layer 2400 may measure the allocation of resources to operations (e.g., as a high-level planning feature to allocate the resources of the AI convergence system of systems 1900 to perform all of the planned and/or unplanned operations, to load-balance the operations in view of the resources of the AI convergence system of systems 1900, and to acquire additional resources as may be needed or desired to perform the operations).

In embodiments, the operations layer 2400 may include a set of operations modules 2402, each of which may be configured to perform and/or capable of performing one or more operations for the operations layer 2400. For example, each operations module 2402 may be specialized for various types of operations, such as a first operations module 2402 that generates artificial intelligence models; a second operations module 2402 that evaluates artificial intelligence models; a third operations module 2402 that deploys artificial intelligence models; and a fourth operations module 2402 that invokes artificial intelligence modules to perform various operations. The operations modules 2402 may be specialized for particular types of artificial intelligence modules (e.g., a first operations module 2402 may be specialized for operations involving traditional artificial neural networks such as perceptron networks, a second operations module 2402 may be specialized for operations involving convolutional neural networks that include convolutional layers, and a third operations module 2402 may be specialized for operations involving large language models that include transformer layers). The operations modules 2402 may be specialized for particular types of artificial intelligence tasks (e.g., a first operations module 2402 may be specialized for performing operations that involve data classification, a second operations module 2402 may be specialized for performing operations that involve computer vision, and a third operations module 2402 may be specialized for performing operations that involve content generation). The operations modules 2402 may be specialized for particular types of data and/or use cases (e.g., a first operations module 2402 may be specialized for performing operations that involve healthcare data or healthcare-related use cases, a second operations module 2402 may be specialized for performing operations that involve information technology data or information technology use cases, and a third operations module 2402 may be specialized for performing operations that involve industrial data and/or industrial use cases). In embodiments, the operations modules 2402 of the operations layer 2400 may interoperate to perform operations involving artificial intelligence systems (e.g., two or more operations modules 2402 may each perform a portion of an operation involving an artificial intelligence system, such as a first operations module 2402 that trains the artificial intelligence system and a second operations module 2402 that evaluates an outcome of the training of the artificial intelligence system).

FIG. 22 is an illustration of an example operations layer 2400 that includes a set of operations modules 2402. In the example operations layer 2400 of FIG. 22, each operations module 2402 is provided to perform one set and/or type of operations. Each operations module 2402 may be implemented as one or more artificial intelligence systems, algorithms, devices, processors, data sets, or the like. Although the example operations layer 2400 of FIG. 22 depicts a particular factoring of operations to discrete modules, it is to be appreciated that some embodiments may include a different factoring of the operations to operations modules 2402. For example, in various embodiments, the operations modules 2402 of the operations layer 2400 may be merged, combined, omitted, factored into multiple modules, duplicated, repurposed, or the like. In various embodiments, the operations modules 2402 may be organized based on a different factoring principle, such as operations modules 2402 that each perform various sets of operations for particular types of artificial intelligence systems, and/or operations modules 2402 that each perform various sets of operations for particular use cases. In various embodiments, the operations modules 2402 may be organized for the operations layer 1818 in various ways, such as a centralized set of operations modules 2402 in a data center, a distributed set of operations modules 2402 provided in data centers in different geographic regions, and/or a decentralized set of operations modules 2402 that respectively perform some of the operations of the operations layer 2400 for various subsets of the AI convergence system of systems 1900, such as on behalf of different geographic regions and/or for different clients.

In embodiments, the operations modules 2402 include an AI system generation module 2404 that is configured and/or provided to generate and store artificial intelligence systems. For example, the AI system generation module 2404 may be configured and/or provided to generate artificial intelligence systems of different types and/or architectures. For example, the AI system generation module 2404 may generate artificial neural networks (ANNs) including various layers, each layer including a number of neurons and a set of interconnections to other neurons. The AI system generation module 2404 may determine the hyperparameters of the artificial neural networks, such as the number and types of inputs received by the artificial neural network, numbers and types of neural layers, the numbers and interconnections of neurons, the features of the neurons such as activation functions, additional layer features such as per-layer biases, and the number and types of outputs of the artificial neural network. For an artificial intelligence system including a random forest, the AI system generation module 2404 may determine the number and types of inputs to the random forest, the number of decision trees included in the random forest, the sequence of features to be processed by each decision, a manner of combining the outputs of the decision trees, and the number and types of outputs of the random forest. For an artificial intelligence system including a reinforcement learning (RL) network, the AI system generation module 2404 may determine the number and types of inputs to the reinforcement learning network, the organization and capacity of the reinforcement learning network, an optimization policy to guide the functioning of the reinforcement learning network, and the number and types of outputs to the reinforcement learning network. In embodiments, the AI system generation module 2404 generates and stores artificial intelligence systems in advance of a need or use of the generated artificial intelligence systems, such as a pregenerated set of foundation artificial intelligence systems that are available for future tasks. In embodiments, the AI system generation module 2404 generates and stores artificial intelligence systems in response to a determination of a need for an artificial intelligence system to perform a task, such as determination that a software architecture in development could include an artificial intelligence system to perform a particular task such as data classification or pattern recognition. In embodiments, the AI system generation module 2404 generates and stores artificial intelligence systems in response to a request from another component of the AI convergence system of systems 1900, a processor, a device, a user, or the like, such as a request for an artificial neural network. In embodiments, the AI system generation module 2404 receives a set of hyperparameters describing a type of artificial intelligence system and generates the artificial intelligence system according to the received set of hyperparameters. In embodiments, the AI system generation module 2404 receives or determines a high-level description of an artificial intelligence system (e.g., a convolutional neural network that is capable of detecting images of a selected size, resolution, bit depth, or the like), determines a set of hyperparameters of an artificial intelligence system that matches the high-level description, and generates the artificial intelligence system based on the determined set of hyperparameters. In embodiments, the AI system generation module 2404 generates a set of artificial intelligence systems that are capable of performing a task in different ways (e.g., a set of convolutional neural networks configured to perform a same or similar type of computer vision task, wherein each convolutional neural network is configured to operation on images of a particular size, resolution, bit depth, or the like). In embodiments, the AI system generation module 2404 stores, in a data store of the AI convergence system of systems 1900 or elsewhere, the resources of a generated artificial intelligence system (e.g., as a model file including a set of hyperparameters and parameters that comprise an artificial neural network). In embodiments, the AI system generation module 2404 provisionally reserves, in a data store of the AI convergence system of systems 1900 or elsewhere, storage capacity for the resources of an artificial intelligence system that may be generated in the future (e.g., a reservation of data storage that may be sufficient for an artificial intelligence system of a particular type). In embodiments, the AI system generation module 2404 stores, in a data store of the AI convergence system of systems 1900 or elsewhere, resources for generating one or more artificial intelligence systems in the future (e.g., an interpretable script, a compilable source code repository, an executable code module, or a declarative set of hyperparameters), wherein an occurrence of a future need or desire for an artificial intelligence system may be fulfilled using the resources stored by the AI system generation module 2404. In embodiments, the AI system generation module 2404 curates a set of stored artificial intelligence systems (e.g., reorganizing the stored artificial intelligence systems based on use or demand, discarding unused or underperforming artificial intelligence systems, and/or generating new artificial intelligence systems to replace less performant artificial intelligence systems).

In embodiments, the AI system generation module 2404 may generate one or more generative AI systems that are configured to generate content. For example, in response to a request to generate content of a particular type (e.g., text, an image, a video, a sound, a data file, or the like) and/or having certain subjects (e.g., one or more entities such as people or animals, one or more objects, one or more scenes such as a story, one or more events such as a timeline, and/or one or more interactions such as a conversation), the AI system generation module 2404 may select one or more generative AI systems that correspond to the requested content type and/or subjects. In embodiments, the AI system generation module 2404 generates a plurality of generative AI systems that produce content that is to be combined (e.g., an audio generative AI system that generates audio such as music, speech, and/or sound effects, and a video generative AI system that generates still images and/or motion video, wherein the output of the combined AI systems includes a video with corresponding audio). In embodiments, the AI system generation module 2404 generates one or more AI systems to generate primary content (e.g., speech) and one or more AI systems to generate supplemental content for the primary content (e.g., captions and/or a transcript of the speech). In embodiments, the AI system generation module 2404 generates one or more AI systems to generate content (e.g., an image) and one or more AI systems to generate metadata associated with the content (e.g., a description of the content of the image). In embodiments, the AI system generation module 2404 generates one or more AI systems to generate content (e.g., an image) and one or more AI systems to modify, extend, and/or otherwise further process the content (e.g., one or more image filters applied to the image). In embodiments, the AI system generation module 2404 generates one or more AI systems to generate a description of content to be generated (e.g., a narrative of a story) and one or more AI systems to generate content based on the description (e.g., images, videos, and/or sounds that convey the story according to the narrative). In embodiments, the AI system generation module 2404 generates one or more AI systems to generate content (e.g., an image) and one or more AI systems to review (e.g., critique, rate, score, rank, analyze, compare, and/or verify) the content (e.g., a discriminator network that identifies artifacts of the content that indicate its synthetic provenance). The AI system generation module 2404 may further configure the one or more generative AI systems to alter the content to address one or more issues indicated in the review; to generate replacement content that replaces initially generated content; and/or to be retrained to address issues identified in the review. In these and other scenarios, the AI system generation module 2404 may generate AI systems, including combinations of AI systems that operate independently and/or together, to plan, generate, supplement, review, and/or present content.

In embodiments, the AI system generation module 2404 may generate one or more AI agents that are configured to act in an autonomous manner. For example, the AI system generation module 2404 may generate an AI agent that is configured to monitor a set of conditions (e.g., rules, heuristics, reflexes, or the like) and to take responsive actions based on a detected fulfillment of the conditions, even if the AI agent has not received a request, instruction, prompt, or the like to perform the responsive action. In embodiments, the AI system generation module 2404 generates an AI agent that includes a policy, heuristic, objective, goal, or the like, that identifies actions that may be taken to promote and/or maintain the policy, heuristic, objective, goal, or the like, and to initiate and/or perform the actions to promote and/or maintain the policy, heuristic, objective, goal, or the like, even if the AI agent has not received a request, instruction, prompt, or the like to perform the responsive action. The policy, heuristic, objective, goal, or the like may be specified by the AI system generation module 2404; may be specified by one or more users; and/or may be received from a data source (e.g., a law, regulation, or policy defined by a government, organization, the AI convergence system of systems 1900, or the like). In embodiments, the AI system generation module 2404 configures the AI agent to learn a policy, heuristic, objective, goal, or the like based on experience (e.g., by monitoring an environment such as the AI convergence system of systems 1900; by monitoring the actions of a human and the consequences of such actions (e.g., robotic process automation (RPA)); by monitoring the actions of AI agents, including itself, and the consequences of such actions; or the like. In embodiments, the AI system generation module 2404 configures an AI agent to reflect on one or more policies, heuristics, objectives, goals, or the like to identify synergy (e.g., actions that promote two or more policies); positive feedback loops (e.g., a first policy that, if achieved, positively affects or promotes a second policy); conflicts and/or negative feedback loops (e.g., a first policy that, if achieved, negatively affects or interferes with a second policy). In embodiments, the AI system generation module 2404 configures an AI agent to modify a policy, heuristic, objective, goal, or the like (e.g., reducing or discarding a policy that negatively affects another policy). The AI system generation module 2404 may configure the AI agent to identify, alter, and/or operate according to priorities among two or more policies, heuristics, objectives, goals, or the like (e.g., determining that a first policy is of higher priority than a second policy, and preferentially selecting actions that promote the first policy over actions that promote the second policy). In embodiments, the AI system generation module 2404 configures an AI agent to communicate about policies, heuristics, objectives, goals, or the like with AI systems or other AI agents (e.g., sharing and/or comparing experiences and/or learned features) and/or to adapt policies, heuristics, objectives, goals, or the like based on information received from AI systems or other AI agents. In embodiments, the AI system generation module 2404 configures an AI agent to report on its policies, heuristics, objectives, goals, or the like, and/or about actions taken and/or not taken based on policies, heuristics, objectives, goals, or the like, to one or more AI systems (e.g., supervising AI systems that occasionally review the autonomous actions of an AI agent for verification, correction, auditing, logging, or the like).

In embodiments, the operations modules 2402 include an AI system training data set generation module 2406 that is configured and/or provided to generate training data sets for training artificial intelligence systems. For example, the AI system training data set generation module 2406 may be configured and/or provided to collect data from one or more data sources for inclusion in a training data set. In embodiments, the AI system training data set generation module 2406 collects data for training data sets from one or more other modules or resources of the AI convergence system of systems 1900 (e.g., from the transaction layer 2300, the network layer 2500, the data layer 2600, or the like). In embodiments, the AI system training data set generation module 2406 collects data for training data sets from other entities, facilities, or resources associated with the AI convergence system of systems 1900 (e.g., from edge devices included in an industrial facility that is managed by the AI convergence system of systems 1900). In embodiments, the AI system training data set generation module 2406 collects data for training data sets from one or more external data repositories, such as news services, information repositories such as libraries, public data sources such as public databases, social networks including social media networks, communication channels, and/or the Internet. In embodiments, the AI system training data set generation module 2406 organizes and/or routes collected data into one or more training data sets. For example, the training data sets may be organized to serve the training of one or more artificial intelligence systems (e.g., a first training data set for traditional artificial neural networks, a second training data set for random forests, and a third training data set for graph neural networks). The training data sets may be organized by data types (e.g., a first training data set including text, a second training data set including mathematical equations or numeric measurements, and a third training data set including images). The training data sets may be organized by sources (e.g., a first training data set for data collected from other modules of the AI convergence system of systems 1900, a second training data set for data collected from a local area network or a facility, a third training data set for data collected from the Internet). The training data sets may be organized by trust or reliability (e.g., a first training data set of verified reliable data, a second training data set of verified unreliable data, and a third training data set of unverified data). The training data sets may be organized by provenance (e.g., a first training data set of authentically generated content, a second training data set of synthetically generated content, and a third training data set of data of unknown provenance). The training data sets may be organized by use cases (e.g., a first training data set including data associated with industrial manufacturing, a second training data set including data associated with healthcare, and a third training data set including data associated with a service industry). In embodiments, the AI system training data set generation module 2406 curates the training data included in each training data set (e.g., normalizing, regularizing, standardizing, anonymizing, and/or cleaning the data to be included in each training data set). In embodiments, the AI system training data set generation module 2406 partitions each training data set into one or more partitions (e.g., a training data set, a validation data set for periodic evaluation during training, and a test data set for use in a tiered training regimen). In embodiments, the AI system training data set generation module 2406 analyzes the training data sets for training issues (e.g., underrepresentation, overrepresentation, bias, and/or inconsistency). In embodiments, the AI system training data set generation module 2406 requests and/or directs a collection and/or creation of data to address one or more training issues associated with one or more training data sets (e.g., a request or instruction to collect more data related to a particular class that is underrepresented in a training data set). In embodiments, the AI system training data set generation module 2406 generates training data sets for use with a particular training regimen, such as bootstrap aggregation (“bagging”) training data sets that are partitioned in different ways for combinatorial training of an AI system In embodiments, the AI system training data set generation module 2406 stores training data sets for various training uses (e.g., a first training data set for training mobile devices to perform computer vision tasks, a second training data set for training workstations to perform computer vision tasks, and a third training data set for training supercomputers to perform computer vision tasks).

In embodiments, the operations modules 2402 include an AI system training data set augmentation module 2408 that is configured and/or provided to augment training data sets for training artificial intelligence systems. For example, the AI system training data set augmentation module 2408 may be configured and/or provided to generate synthetic data to augment one or more training data sets. In embodiments, the AI system training data set augmentation module 2408 generates synthetic data in response to a request or instruction from an AI system training data set generation module 2406 (e.g., based on a determination that a particular class is underrepresented in a training data set, the AI system training data set augmentation module 2408 may receive some data samples of the particular class and may generate additional synthetic data samples of the class that are similar to the received data samples of the class). In embodiments, the AI system training data set augmentation module 2408 generates synthetic data to address a particular issue with a training data set (e.g., in response to a determination that a training data set of images includes too few images in low-light-level environments, the AI system training data set augmentation module 2408 may synthetically modify some existing high-light-level images to simulate low-light-level conditions). In embodiments, the AI system training data set augmentation module 2408 generates synthetic data using various augmentation techniques. For example, for training data sets including text, the AI system training data set augmentation module 2408 may generate synthetic text that modifies words and/or word ordering of authentic text; that modifies passages of text by generating replacement text; that supplements the text with generated text; and/or that combines two or more authentic passages of text to generate a synthetic text. For training data sets including images, the AI training data set augmentation module 2408 may crop, mirror, scale, shear, adjust colors, increase or decrease noise, insert or remove objects, and/or distort an authentic image to produce one or more synthetic images. For training data sets including data collected from sensors connected to industrial machines, the AI training data set augmentation module 2408 may generate synthetic data based on simulation of the sensors and/or industrial machines. The AI system training data set augmentation module 2408 may evaluate synthetic data for hallmarks of synthetic data (e.g., using a discriminator network of a generative adversarial network (GAN) to determine whether synthetic data can be distinguished from authentic data) and may adapt the augmentation techniques to reduce artifacts of synthetic data. The AI system training data set augmentation module 2408 may transmit synthetic and/or augmented data to the AI system training data set generation module 2406 for inclusion in one or more training data sets.

In embodiments, the operations modules 2402 include an AI system training module 2410 that is configured and/or provided to train artificial intelligence systems. For example, the AI system training module 2410 may be configured and/or provided to train one or more artificial intelligence systems for a particular task, such as classification, pattern recognition, object detection, and/or content generation. The AI system training module 2410 may be configured to pretrain standard models for common tasks (e.g., pretraining a convolutional neural network to detect generic objects, and/or pretraining a large language model to understand common features of a natural language such as English). The AI system training module 2410 may be configured to train a generated artificial intelligence system for a particular task (e.g., in response to the AI system generation module 2404 receiving a request for an artificial neural network to perform a particular classification task, the AI system generation module 2404 may generate the artificial neural network with a suitable set of hyperparameters, and the AI system training module 2410 may train the generated artificial neural network to perform the classification task). The AI system training module 2410 may be configured to train a generated artificial intelligence system using a particular training data set (e.g., in response to the AI system training data set generation module 2406 receiving and/or collecting data for a particular training data set, such as a corpus of text in a particular language, the AI system training module 2410 may initiate training of a large language model train using the corpus of text). The AI system training module 2410 may be configured to adapt a pretrained model to perform a particular task (e.g., upon receiving a request for a large language model that can generate a specialized type of text in a natural language, the AI system training module 2410 may identify a large language model that has previously been pretrained on the natural language and may conduct additional training of the pretrained large language model using examples of the specialized type of text). The AI system training module 2410 may use one or more types of training techniques to train AI systems, such as backpropagation, zero-shot and/or few-shot learning, supervised learning, semi-supervised learning, unsupervised learning, bootstrap aggregation (“bagging”) of training data sets, reinforcement learning, genetic training, or the like. The AI system training module 2410 may evaluate a performance of an AI system during training to detect progression of the training, completion of the training, mistraining (e.g., loss of performance during training), and/or training problems such as overtraining, and may adapt the training according to the evaluation (e.g., ending training when the AI system exhibits performance that at least satisfies a minimum performance threshold). The AI system training module 2410 may restart training to address problems (e.g., reinitiating training with a different training regimen, and/or with a different training data set, to address mistraining or overtraining of an AI system). The AI system training module 2410 may test a performance of a trained AI system (e.g., validating performance of the trained models using a validation data set, and/or verifying a trained performance of an AI system using a test data set). The AI system training module 2410 may holistically allocate the resources of the AI convergence system of systems 1900 (e.g., planning, scheduling, and/or adapting training of the AI systems based on performance, demand, the availability and/or costs of compute and/or storage, or the like) to meet the need to train a set of AI systems for the set of operations of the AI convergence system of systems 1900.

In embodiments, the operations modules 2402 include an AI system verifying module 2412 that is configured and/or provided to verify generated artificial intelligence systems. For example, the AI system verifying module 2412 may be configured and/or provided to test one or more trained and/or untrained AI systems based on various criteria, such as accuracy, precision, recall, F1 score, bias, consistency, efficiency, latency, or the like. For generative AI systems such as large language models and diffusion networks, the AI system verifying module 2412 may be configured to evaluate content generated by the AI system based on features such as coherence, creativity, and variance. In embodiments, the AI system verifying module 2412 compares, scores, ranks, or otherwise considers the output of multiple AI systems (e.g., to determine comparative strengths and weaknesses of the respective AI systems for performing various operations, such as generating content for particular uses). In embodiments, the AI system verifying module 2412 generates recommendations for saving, using, modifying, combining, and/or discarding various AI systems based on the verifying (e.g., a first recommendation for an AI system generation module 2404 to store a first AI system that is verified as performing well; a second recommendation for an AI system training module 2410 to train or retrain a second AI system that is performing inadequately; and a third recommendation for an AI system generation module 2404 to discard and/or replace an AI system that is performing poorly). In embodiments, the AI system verifying module 2412 identifies one or more deficiencies in various AI models (e.g., poor performance of the AI systems on a particular type of data, or poor performance of the AI systems in satisfying a particular task) and generates recommendations for addressing the identified deficiencies (e.g., recommending an AI system training data set generation module 2406 to include additional data that is associated with an underrepresented and/or inconsistently represented class; recommending an AI system training data set augmentation module 2408 to generate certain types of augmented data, or to refrain from augmenting data in a certain way, for inclusion in training data sets; and/or recommending an AI system training module 2410 to adjust a training regimen and/or scoring model to focus on a particular issue exhibited by the AI systems).

In embodiments, the operations modules 2402 include an AI system adaptation module 2414 that is configured and/or provided to adapt a set of artificial intelligence systems to perform various operations and/or tasks. The adapting may include optimizing one or more AI systems in the performance of various operations and/or tasks, such as performing with improved accuracy, precision, recall, F1 scores, bias, consistency, efficiency, latency, or the like. Herein, the term “optimizing” may mean an improvement either to a globally optimal or best state, locally optimal or best state within a given domain, improving relative to a previous state, or the like. For example, the AI system adaptation module 2414 may be configured and/or provided to receive a request to adapt a pretrained AI system (e.g., a partially trained large language model) for a specific task, device, data type, deployment, use case, or the like. For example, the AI system adaptation module 2414 may be configured to adapt an AI system that is configured to receive, process, and output a first type of data (e.g., images of a first size, resolution, bit depth, or the like) so that the AI system can process a second type of data (e.g., images of a second size, resolution, bit depth, or the like). The AI system adaptation module 2414 may be configured to adapt an AI system that is configured to receive, process, and output data in a first context (e.g., text associated with documents of a first type) so that the AI system can process a second type of data (e.g., text associated with documents of a second type). The AI system adaptation module 2414 may be configured to adapt an AI system that is configured to receive, process, and output data in a first context (e.g., data received from sensors in an industrial environment) so that the AI system can process data in a second context (e.g., data received from sensors in a healthcare environment). The AI system adaptation module 2414 may be configured to adapt an AI system that is configured to receive, process, and output data on a first type of device (e.g., a workstation including a graphics processing unit (GPU)) so that the AI system can process data on a second type of device (e.g., an embedded device featuring only a traditional central processing unit (CPU) and/or a field-programmable gate array (FPGA)). The AI system adaptation module 2414 may be configured to adapt an AI system that is configured to receive, process, and output data to perform a first task on a data set (e.g., data classification) so that the AI system can process data on a second task on the same data set (e.g., pattern detection). In view of these and other types of adaptations, the AI system adaptation module 2414 may identify one or more AI systems stored by an AI system generation module 2404 and one or more adaptations of the one or more AI systems that may adapt the AI system according to a request or instruction. The adaptation may include preprocessing an input to an AI system to alter the input received by the AI system, such as adding a preprocessing denoising filter to the input of an AI system to reduce noise and improve the processing, output, and performance of the denoised data. The adaptation may include altering an AI system to receive a different type of input, such as adapting a convolutional neural network to receive and process images of a different size, resolution, color depth, or the like than the images on which the convolutional neural network was previously trained. The adaptation may include reconfiguring an architecture of an AI system, such as adding one or more architectural features (e.g., a long short-term memory (LSTM) unit, a gated recurrence unit (GRU), a transformer layer, a filter layer, a pooling layer, or the like), removing one or more architectural features, replacing one or more architectural features with a different architectural feature, or the like. The adaptation may include altering an AI system to process data differently, such as appending one or more fine-tuning layers to a pretrained artificial neural network to provide additional processing for a specific set of data. The adaptation may include altering an AI system to generate different output, such as adapting an artificial neural network that processes input to select a class from a first set of classes, such that the artificial neural network performs the same or similar processing of the input to select a class from among a second, different set of classes. The adaption may include postprocessing an output generated by the AI system to alter an output of the AI system, such as adding a postprocessing denoising feature to reduce noise in content generated by a generative AI system. The adaptation may include selectively limiting a processing of input by the AI system to a subset of input for which the AI system is determined to perform well. The adaptation may include requesting a continued training or retraining of an AI system by the AI system training module 2410, comparing a performance of the additionally trained AI system with the original AI system, and determining one or more adaptations of the AI system based on the comparison. The adaptation may include altering a set of resources provided to the AI system (e.g., altering an amount of memory allocated for the AI system, an amount or type of computation performed by or for the AI system, such as to reduce latency of a time-sensitive model and/or a context window size of a time series model or a large language model to improve memory and/or performance). In embodiments, the AI system adaptation module 2414 may consider a set of possible adaptations of an AI system for addressing one or more issues or problems of the AI system (e.g., poor accuracy, poor consistency, poor coherence, high latency, or the like), comparing the predicted and/or determined effects of various adaptations and combinations thereof of the AI system, selecting one or more adaptations to apply to the AI system based on the comparison, and adapting the AI system based on the selection.

In embodiments, the operations modules 2402 include an AI system aggregation module 2416 that is configured and/or provided to aggregate artificial intelligence systems. The AI system aggregation module may combine two or more AI systems into a hybrid AI system that combines the heterogeneous processing capabilities of AI systems with different architectures. For example, the AI system aggregation module 2416 may combine an AI system with one or more other AI systems to produce a hybrid system that generates aggregated and improved output as compared with the individual AI systems (e.g., a “boosted” ensemble of inadequately performing AI systems, from which a consensus output may be derived that presents higher-performance output than from any of the individual AI systems). The aggregation may include adding an AI system to a set of AI systems, each of which may be determined to perform well over a subset of input, wherein a particular input to the set of AI systems may be selectively processed by a particular AI system that is recognized to perform well over the subset of input that includes the particular input.

In embodiments, the AI system aggregation module combines two or more AI systems into an ensemble AI system that features a collection of homogeneous or heterogeneous AI systems that together generate an output (e.g., by consensus). In embodiments, the AI system aggregation module combines two or more AI systems into a sequence or chain of AI systems, wherein an output of a first AI system is received as input by a second AI system. The aggregation may include connecting at least one output of a first AI system to at least one input of a second AI system (e.g., a chain-of-processing generative system in which data generated by a generative AI system is refined, expanded, reformatted, verified, analyzed, augmented, edited, or otherwise further processed by a second AI system). In some embodiments, the AI system aggregation module 2416 generates a swarm of AI systems that operate independently of one another but collectively to achieve a task, such as a set of AI agents that are configured to operate individually but that interact with other AI agents and shared resources to achieve the task. In some embodiments, the AI system aggregation module 2416 aggregates AI systems by inserting at least a portion of a first AI system into a second AI system (e.g., inserting one or more layers of a classifier network between two layers of a convolutional neural network to inform further processing of the convolutional neural network based on the classification of the partially-processed input data). The aggregation may include conditioning the processing of data by a first AI system based on the processing of the data by a second AI system (e.g., partially generating content by a generative AI system, and then conditioning a completion of the generated content on an initial assessment of the partially generated content by a second AI system, such as a discriminator network). The aggregation may include combining a first AI system to select, design, and/or validate a processing of data by a combination of one or more other AI systems (e.g., an expert determining AI system that determines, from a set of AI systems that are respectively experts in various domains, one or more AI systems that are to be invoked to process input data that is relevant to one or more domains). The aggregation may include attaching a first AI system as an administrator, regulator, controller, or the like of a second AI system (e.g., a content moderation AI system that determines whether a generative AI system is permitted to process certain kinds of prompts and/or generate certain kinds of data, and that controls the processing of the generative AI system based on the determined permission). In embodiments, the AI system aggregation module 2416 identifies one or more aggregations of pregenerated AI systems for various contexts (e.g., combinations of pregenerated AI systems that may be specialized and/or proficient at certain types of processing, such as generating certain forms of content, generating classifications above a classification threshold, and/or completing processing within a latency window). In embodiments, the AI system aggregation module 2416 generates and stores one or more descriptions of techniques for selecting and aggregating AI systems for various contexts (e.g., an interpretable script for selecting and combining AI systems to generate chain-of-thought reasoning for various contexts), wherein a particular task or invocation of the AI systems may be fulfilled by applying one of the aggregation techniques generated by the AI system aggregation module 2416 to select and aggregate AI systems for the indicated context. Such aggregating may be advantageous, for example, for ad-hoc aggregations of AI systems for unusual, specialized, and/or previously unseen processing tasks (e.g., a request to aggregate AI systems to generate a hybrid large language model for execution on a particular device and/or over a particular type of data).

In embodiments, the operations modules 2402 include an AI system deployment module 2418 that is configured and/or provided to deploy artificial intelligence systems. For example, the AI system deployment module 2418 may be configured and/or provided to deploy one or more AI systems generated by the AI system generation module 2404 to one or more devices, such as a set of workstations, servers, or mobile devices. For example, the AI system deployment module 2418 may receive a request to deploy a large language model to a device having a certain set of computational resources, such as processing cores operating at a defined clock rate, memory, and storage. The AI system deployment module 2418 may review a set of AI systems generated by the AI system generation module 2404 to identify a suitable large language model in view of the computational resources of the device. The AI system deployment module 2418 may select the large language model for deployment, determine a location of the resources of the selected large language model, package the resources of the large language model for deployment (e.g., retrieving and compressing a description of the architecture of the large language model and a set of parameters of the large language model), and transmit the packaged resources for deployment on the device. In embodiments, the AI system deployment module 2418 is configured to deploy an AI system for a particular type of task, such as a particular classification task, pattern recognition task, computer vision task, or content generation task. The AI system deployment module 2418 may select a particular AI system from the set of AI systems generated by the AI system generation module 2404 to identify an AI system that is suitable for the identified task. The AI system deployment module 2418 may package the identified AI system for deployment to the device and/or environment for the identified task, and may transmit the packaged AI system to the device and/or environment. In embodiments, the AI system deployment module 2418 is configured to deploy an AI system to include a particular feature set, such as a large language model that supports a particular natural language and features a particular context window size, and may deploy a pregenerated or adapted AI system to fulfill the deployment that features the indicated feature set. In embodiments, the AI system deployment module 2418 is configured to deploy an AI system for execution in a particular execution environment, such as within a defined memory space, using a particular AI framework such as TensorFlow or Torch, and/or using a particular set of hardware that is available to the device, such as a particular graphics processing unit (GPU), neural processing unit (NPU), tensor processing unit (TPU), or the like. In embodiments, the AI system deployment module 2418 is configured to adapt an AI system for deployment to a particular device and/or context (e.g., identifying an AI system that is suitable for a particular task but that is based on a TensorFlow environment, adapting the AI system for execution in a Torch environment, and transmitting a packaged version of the Torch-based AI system to a device featuring a Torch execution environment).To achieve the adapting for the deployment, the AI system deployment module 2418 may transmit a request to the AI system adaptation module 2414 to adapt a stored AI system in view of the details of a particular deployment, may receive an adapted AI system from the AI system adaptation module 2414 based on the request, and may package and deploy the adapted AI system to satisfy the deployment. In embodiments, the AI system deployment module 2418 may transmit the resources of one or more AI systems to one or more devices that are intended to execute the AI systems. In embodiments, the AI system deployment module 2418 may transmit the resources of an AI system to two or more devices for redundant and/or distributed execution of the AI system (e.g., as a primary system and a failover system, as two or more devices that provide scalable capacity for execution of the AI systems, as a distributed system in which a first system executes a first AI system that transmits an output to a second device for input to a second AI system, and/or as a federated system in which respective devices execute a portion of the AI system). In embodiments, the AI system deployment module 2418 may deploy an AI system within the AI convergence system of systems 1900, such as by reserving resources (e.g., processing capacity, storage, one or more dedicated devices, or the like) for the execution of an AI system to serve a particular context, and/or by transmitting the resources of an AI system (e.g., the parameters of an artificial neural network) to one or more devices within the AI system deployment module 2418. In embodiments, the AI system deployment module 2418 may deploy an AI system by transmitting an interface to the AI system to one or more devices, such as end-user devices that are configured to collect input, transmit input through the interface to one or more AI systems executed on other devices, and/or receive and present output received from one or more AI systems.

For example, the AI system deployment module 2418 may retrieve, generate, and/or transmit an application programming interface (API) to the one or more devices in order to interconnect the one or more devices with the AI system. The AI system deployment module 2418 may reserve one or more communication endpoints to enable one or more devices to communicate with the AI system. The AI system deployment module 2418 may configure permissions and/or security tokens to enable one or more external devices to communicate securely with one or more AI systems.

In embodiments, the operations modules 2402 include an AI system invocation module 2420 that is configured and/or provided to invoke artificial intelligence systems to perform various operations and/or tasks. For example, the AI system invocation module 2420 may be configured and/or provided to receive one or more requests to perform a task. The request may be initiated by another component of the AI convergence system of systems 1900; by a device, software process, or entity that is served by the AI convergence system of systems 1900; and/or by an external device, software process, or entity. The request may be spontaneously initiated by the AI system invocation module 2420 (e.g., based on a set of conditions monitored by the AI system invocation module 2420, wherein fulfillment of a condition instructs the AI system invocation module 2420 to invoke an AI system). The request may indicate one or more AI systems that are to be invoked to execute the request. Alternatively or additionally, the request may indicate one or more tasks, and the AI system invocation module 2420 may determine one or more AI systems that may be invoked to fulfill the task. In some cases, the request may specify a request that includes one or more non-AI systems (e.g., a hardware component or a traditional software component, such as a graphics rendering or simulation system), and the AI system invocation module 2420 may identify one or more AI systems that may be invoked to perform the task in place of the one or more non-AI systems. In embodiments, the AI system invocation module 2420 verifies a permission and/or security of a request to invoke an AI system before initiating the invocation of the AI system. In embodiments, the AI system invocation module 2420 initiates the invocation of the AI system in response to the request (e.g., by instantiating the AI system, by transmitting input to the AI system, and/or by securing the resources for the invocation of the AI system). In embodiments, the AI system invocation module 2420 notifies a requester of the status of a request to invoke an AI system (e.g., indicating a status, progress, estimated completion time, and/or outcomes of the processing of the request by the AI systems). In embodiments, the AI system invocation module 2420 mediates communication between the AI system and the requester (e.g., by transmitting the request and/or input received from the requester and/or another source to the AI system to invoke the AI system for the request, and/or by transmitting one or more outputs of the AI system to the requester and/or another destination to fulfill the request). In embodiments, the AI system invocation module 2420 translates the request and/or one or more inputs received from the requester and/or another source for intake and processing by the AI system, and/or translates one or more output of the AI system for transmission to the requester and/or another destination).

In embodiments, the AI system invocation module 2420 may invoke one or more generative AI systems that are configured to generate content in response to a request. For example, in response to a request to generate content of a particular type (e.g., text, an image, a video, a sound, a data file, or the like) and/or having certain subjects (e.g., one or more entities such as people or animals, one or more objects, one or more scenes such as a story, one or more events such as a timeline, and/or one or more interactions such as a conversation), the AI system invocation module 2420 may select and invoke one or more generative AI systems that correspond to the requested content type and/or subjects. In embodiments, the AI system invocation module 2420 invokes a plurality of generative AI systems that produce content that is to be combined (e.g., an audio generative AI system that generates audio such as music, speech, and/or sound effects, and a video generative AI system that generates still images and/or motion video, wherein the output of the combined AI systems includes a video with corresponding audio). In embodiments, the AI system invocation module 2420 invokes one or more AI systems to generate primary content (e.g., speech) and one or more AI systems to generate supplemental content for the primary content (e.g., captions and/or a transcript of the speech). In embodiments, the AI system invocation module 2420 invokes one or more AI systems to generate content (e.g., an image) and one or more AI systems to generate metadata associated with the content (e.g., a description of the content of the image). In embodiments, the AI system invocation module 2420 invokes one or more AI systems to generate content (e.g., an image) and one or more AI systems to modify, extend, and/or otherwise further process the content (e.g., one or more image filters applied to the image). In embodiments, the AI system invocation module 2420 invokes one or more AI systems to generate a description of content to be generated (e.g., a narrative of a story) and one or more AI systems to generate content based on the description (e.g., images, videos, and/or sounds that convey the story according to the narrative). In embodiments, the AI system invocation module 2420 invokes one or more AI systems to generate content (e.g., an image) and one or more AI systems to review (e.g., critique, rate, score, rank, analyze, compare, and/or verify) the content (e.g., a discriminator network that identifies artifacts of the content that indicate its synthetic provenance). Based on the review, the AI system invocation module 2420 may invoke one or more AI systems to alter the generated content to address one or more issues indicated in in the review; to generate replacement content that replaces initially generated content; and/or to retrain the generative AI systems to address issues identified in the review. In these and other scenarios, the AI system invocation module 2420 may invoke AI systems, including combinations of AI systems that operate independently and/or together, to plan, generate, supplement, review, and/or present content.

In embodiments, the operations modules 2402 include an AI system data set orchestration module 2422 that is configured and/or provided to orchestrate a set of artificial intelligence systems to perform various operations and/or tasks. For example, the AI system orchestration module 2422 may be configured and/or provided to orchestrate operation of at least a portion of the set of AI systems of the AI convergence system of systems 1900 to fulfill a set of requests. In embodiments, the AI system orchestration module 2422 interconnects two or more AI systems to perform a particular task (e.g., interconnecting the output of a first AI system, such as a pattern recognition system, to the input of a second AI system, such as a large language model that can generate summaries and/or descriptions of the detected patterns). In embodiments, the AI system orchestration module 2422 performs scheduling of the invocation of AI systems (e.g., based on processing loads or queues and/or throughput of the AI systems and/or the urgency and/or priority of the requests to invoke the AI systems). In embodiments, the AI system orchestration module 2422 performs load-balancing of the requests to invoke AI systems for various tasks (e.g., by monitoring a processing load and/or processing queue of each of the AI systems, and by routing requests to AI systems that have available capacity based on the load-balancing). In embodiments, the AI system orchestration module 2422 maps or remaps requested tasks to AI systems based on load-balancing, scheduling, or the like (e.g., remapping a task from a first AI system that is overloaded to a second AI system that is capable of equivalently performing the task and that has available capacity). In embodiments, the AI system orchestration module 2422 adjusts allocations, provisions, and/or reservations of resources of the AI convergence system of systems to enable the AI systems to fulfill the requested invocations (e.g., by acquiring more computational capacity, storage, devices such as servers or processing cores, or the like to handle an increased number of requests and/or an increased computational load of the requests, and/or by reallocating computational capacity, storage, devices such as servers or processing cores, or the like to handle a decreased number of requests and/or a decreased computational load of the requests). In embodiments, the AI system orchestration module 2422 plans and/or manages the acquisition, retention, location, installation, use, maintenance, reallocation, and/or decommissioning of the resources of the AI convergence system of systems 1900 in view of future scheduled and/or predicted demands, volumes of requests, and/or computational loads. In embodiments, the AI system orchestration module 2422 reorganizes the resources of the AI convergence system of systems 1900 based on changes in the demand for processing by the AI systems (e.g., based on new types of requests that the AI systems are capable of handling, such as low-latency AI system processing requests in particular real-time contexts and/or the processing of new types of data, such as LIDAR point-cloud data). In embodiments, the AI system orchestration module 2422 reorganizes the resources of the AI convergence system of systems 1900 based on changes in the available and/or feasible AI systems (e.g., allocating increased computation and/or storage for large language models and hybrid systems of increased size and/or computational complexity).

In embodiments, the AI system orchestration module 2422 may include routing data and/or interactions between and/or among data sources, clients, AI systems, hardware and/or software components, or the like. In embodiments, the AI system orchestration module 2422 determines and implements a route between a source of a request or task (e.g., a client, user, requesting device, or the like) to one or more AI systems that are capable of fulfilling the request and/or performing the task (e.g., AI systems that exhibit capabilities that correspond to requirements of the request and/or task). the AI system orchestration module 2422 determines and implements a route from a first AI system (e.g., a generative AI system that outputs generated content) as input to a second AI system (e.g., a reviewing AI system that reviews content generated by the generative AI system). In embodiments, the AI system orchestration module 2422 determines and implements a route between a data source of data (e.g., a sensor, a database, a camera, or the like) and one or more AI systems that are configured to process the data (e.g., a convolutional neural network that is configured to analyze images generated by camera). In embodiments, the AI system orchestration module 2422 determines and implements a route between one or more AI systems that generate output (e.g., a classifier network) and a consumer of the output (e.g., a client, database, or another AI system that stores, uses, or otherwise consumes the output). In embodiments, the AI system orchestration module 2422 partitions data into portions and determines and implements routes between a source of the data and a plurality of AI systems that respectively process a portion of the data (e.g., two or more AI systems that operate in parallel and/or in tandem), which may reduce latency of processing the data. In embodiments, the AI system orchestration module 2422 routes data to each of two or more AI systems, each of which may perform a same or similar type of processing (e.g., redundant processing of the data by redundant AI systems) and/or different types of processing (e.g., performing different tasks on the data, such as a first task of verifying the data and a second task of supplementing the data). In embodiments, the AI system orchestration module 2422 determines and implements routes between and/or among AI systems to enable interoperation to complete the task (e.g., a communication path between two or more AI agents that operate independently to perform different portions of a task, such as a transaction negotiating AI agent that identifies and negotiates transactions and a transaction execution AI agent that generates and executes smart contracts to complete the transactions). In embodiments, the AI system orchestration module 2422 determines and implements routes between and/or among AI systems based on a set of available routes, such as a set of candidate communication paths by which the AI systems may communicate (e.g., various network paths in a wide-area network, and/or different communication modalities such as Bluetooth, Wi-Fi, cellular, infrared, wired connections such as Ethernet, or the like). In embodiments, the AI system orchestration module 2422 determines and implements routes based on an evaluation of the requirements of a request and/or task (e.g., a priority, a deadline, an amount of data, a budget, a security consideration, or the like) and corresponding features of candidate routes (e.g., throughput, availability, cost, reliability, security, or the like, of various communication modalities such as Bluetooth, Wi-Fi, cellular, infrared, wired connections such as Ethernet, or the like). In embodiments, the AI system orchestration module 2422 determines and implements routes between and/or among AI systems by acquiring, purchasing, developing, reserving, provisioning, dedicating, and/or allocating one or more routes or the like (e.g., reserving a communication path between two or more AI systems that are intended to communicate with high performance).

In embodiments, the operations modules 2402 include an AI system monitoring module 2424 that is configured and/or provided to analyze the performance of artificial intelligence systems while performing various operations and/or tasks. For example, the AI system monitoring module 2424 may be configured and/or provided to analyze a performance of one or more AI systems of the AI convergence system of systems 1900 to measure and compare various performance metrics, such as accuracy, precision, recall, F1 score, bias, consistency, efficiency, latency, or the like. The AI system monitoring module 2424 may perform such evaluation using training data on which an AI system was previously trained, new training data that the AI system has not previously processed (e.g., a test data set), live data that is associated with a deployment of the AI system, and/or synthetic data generated for the monitoring. The AI system monitoring module 2424 may perform such evaluation using data that is the same as or similar to data that the AI system was deployed to process and/or based on new data that the AI system was not deployed to process (e.g., based on new data types that are different than those associated with the training and/or initial deployment of the AI system). The AI system monitoring module 2424 may compare the performance of an AI system at a current time with a performance of the same or similar AI system at a previous time (e.g., at a time of completion of training and/or deployment). The AI system monitoring module 2424 may compare the performance of an AI system operating under a first set of conditions (e.g., on a first device and/or with a first set of computational resources) with a performance of the same or similar AI system under a second set of conditions (e.g., on a second device and/or with a second set of computational resources). The AI system monitoring module 2424 may compare the performance of an AI system at a current time with a simulated performance of the AI system at the current time (e.g., a digital twin of the AI system). The AI system monitoring module 2424 may compare the performance of an AI system on a first data set (e.g., a first set of images depicting items of a first class) with the performance of the AI system on a second data set (e.g., a second set of images depicting items of a second class) The AI system monitoring module 2424 may compare the performance of an AI system with the performance of another AI system of the same or similar type (e.g., comparing a performance of an artificial neural network classifier trained with a first training data set with a performance of an artificial neural network classifier trained with a second training data set). The AI system monitoring module 2424 may compare the performance of an AI system with the performance of another AI system of a different type (e.g., comparing a performance of an artificial neural network classifier on a data set with a performance of a Bayesian classifier on the same data set). In embodiments, the AI system monitoring module 2424 performs comparisons using two or more performance metrics (e.g., accuracy, precision, and recall) and, optionally, based on relative priorities of the performance metrics (e.g., associating different relative weights and/or penalties to measurements of accuracy, precision, and recall). In embodiments, the AI system monitoring module 2424 tracks changes in the performance metrics over time and identifies trends in the performance metrics (e.g., the development of AI system “drift” due to trends in the features of the data processed by the AI system, changes in the execution of the AI system, and/or the continued training of the AI system). In embodiments, the AI system monitoring module 2424 invokes a first AI system to evaluate a second AI system, and receives, from the first AI system, an indication of the performance of the second AI system. In embodiments, the AI system monitoring module 2424 monitors each AI system according to a schedule (e.g., periodically testing the AI system and recording performance measurements for each period). In embodiments, the AI system monitoring module 2424 collects information from one or more other components or systems that are associated with an AI system (e.g., a sensor whose functionality depends upon the performance of an AI system) and determines a performance measurement of the AI system based on the performance of the other components or systems. In embodiments, the AI system monitoring module 2424 solicits, collects, and/or receives information from one or more entities that are associated with an AI system (e.g., feedback from users or clients) and determines a performance of an AI system based on the solicited, collected, and/or received information. In embodiments, the AI system monitoring module 2424 monitors each AI system in response to a detected event or condition (e.g., upon receiving an indication that a performance of an AI system may have changed, such as when an execution context of the AI system changes, or when another system detects a change in a performance of the AI system). In embodiments, the AI system monitoring module 2424 records measurements, changes, trends, and the like of the AI systems. In embodiments, the AI system monitoring module 2424 stores the measurements, changes, trends, or the like in one or more data stores or repositories, such as a database or a performance log. In embodiments, the AI system monitoring module 2424 stores the measurements, changes, trends, or the like, such as to an AI system analyzing module 2428 of the operations modules 2402.

In embodiments, the operations modules 2402 include an AI system analyzing module 2426 that analyzes the performance of the AI systems. For example, the AI system analyzing module 2426 may be configured and/or provided to analyze the performance metrics collected stored by the AI system monitoring module 2424 for various AI systems. In embodiments, in response to a detected or determined change in a performance of an AI system, the AI system analyzing module 2426 initiates a further evaluation of the AI system to determine a cause for the change in the performance (e.g., a change in the data provided as input to the AI system; a change in an execution environment of the AI system; and/or a change in a performance of the AI system due to continued training). The AI system analyzing module 2426 may use a variety of techniques to determine a cause of a change in performance, such as simulation of the AI system by one or more digital twins, Monte Carlo analysis based on sampling the effects of changes to the operation of the AI system, and/or root cause analysis that involves a determination of causal relationships among various elements of the AI system and the AI convergence system of systems 1900. In embodiments, in response to a detected or determined change in a performance of an AI system, the AI system analyzing module 2426 changes an execution environment of the AI system to improve performance (e.g., increasing computational resources allocated to the AI system, such as computational load, memory, and/or storage to improve performance). In embodiments, in response to a detected or determined change in a performance of an AI system, the AI system analyzing module 2426 adjusts an allocation of AI systems of the AI convergence system of systems 1900 to the requests for invocations of the AI systems (e.g., optionally by interoperating with the AI system orchestration module 2422) such that requests are handled by AI systems that are capable of meeting performance requirements of the requests. In embodiments, in response to a detected or determined change in a performance of an AI system, the AI system analyzing module 2426 initiates a redevelopment of the AI system by an AI system redevelopment module 2434 (e.g., a retraining and/or replacement of the AI system with another AI system).

In embodiments, the operations modules 2402 include an AI system updating module 2428 that is configured and/or provided to update deployed artificial intelligence systems. In embodiments, in response to a detected or determined change in a performance of an AI system, the AI system updating module 2428 causes input to the AI system to be changed (e.g., reformatting, annotating, curating, editing, or otherwise changing the input to the AI system to improve the performance of the AI system). In embodiments, in response to a detected or determined change in a performance of an AI system, the AI system updating module 2428 causes an architecture of an AI system to be changed to improve the performance of the AI system (e.g., increasing a context window size of an AI system to process more data, and/or increasing a number of layers of the AI system to increase learning capacity). In embodiments, in response to a detected or determined change in a performance of an AI system, the AI system updating module 2428 causes output of the AI system to be changed (e.g., reformatting, annotating, curating, editing, or otherwise changing the output to the AI system to improve the performance of the AI system). In embodiments, the AI system updating module 2428 experimentally evaluates potential updates to an AI system to determine effects of the updates on the performance of the AI system (e.g., experimentally increasing the computational resources allocated to AI system and measuring an effect of the increased computational resources on one or more performance metrics of the AI system). In embodiments, the AI system updating module 2428 experimentally adjusts the inputs and/or processing of an AI system, or of a simulation of the AI system (e.g., of a digital twin), to determine the effect of the adjustments on the AI system. If the adjustments result in improved performance of the AI system, the AI system updating module 2428 may apply and/or commit the update to the AI system to realize and/or maintain the improvement in performance. In embodiments, in response to a detected or determined improvement in a performance of an AI system, the AI system updating module 2428 applies one or more features of the AI system that is associated with the improved performance to at least one other AI system, thereby enabling the at least one other AI system to exhibit a same or similar performance improvement.

In embodiments, the operations modules 2402 include an AI system governance module 2430 that is configured and/or provided to maintain governance of deployed artificial intelligence systems. For example, the AI system governance module 2430 may be configured and/or provided to govern one or more AI systems based on legal, social, practical, and/or regulatory policies (e.g., policies relating to truthfulness and/or avoidance of harm). In embodiments, the AI system governance module 2430 monitors invocations of one or more AI systems to detect and prevent unauthorized, unintended, and/or harmful uses of the AI systems (e.g., requests that are not permitted or that may contribute to harm and/or the violation of policies). In embodiments, the AI system governance module 2430 monitors input to one or more AI systems to detect and prevent unauthorized, unintended, and/or harmful inputs to the AI systems (e.g., inputs that include or are associated with objectionable and/or harmful content). In embodiments, the AI system governance module 2430 monitors the processing of one or more AI systems to detect and prevent unauthorized, unintended, and/or harmful processing by the AI systems (e.g., the avoidance of reasoning that may be considered deceptive or illegal). In embodiments, the AI system governance module 2430 monitors output of one or more AI systems to detect and prevent unauthorized, unintended, and/or harmful outputs of the AI systems (e.g., outputs that include or are associated with objectionable and/or harmful content). In embodiments, the AI system governance module 2430 monitors uses of the output of the AI systems by requesters and/or systems to determine unauthorized, unintended, and/or harmful uses of the AI systems (e.g., malicious use of the processing capabilities and/or output of the AI systems). In embodiments, the AI system governance module 2430 responds to detected requests, inputs, processing, outputs, and/or uses of the AI systems in various ways, such as modifying, censoring, editing, redacting, and/or blocking a request, input, processing, output, and/or use of the AI system. In embodiments, the AI system governance module 2430 receives, generates, adjusts, and/or reports policies based on the monitoring and governance, such as generating guidelines and/or tests to evaluate the requests, inputs, processing, outputs, and/or uses of the AI systems that may be associated with malicious, unauthorized, unintended, and/or harmful content or activities. In embodiments, the AI system governance module 2430 generates, adapts, and/or monitors one or more governance mechanisms applied to an AI system, such as monitoring an effectiveness of a rule set applied to the requests and/or inputs of an AI system to ensure that the processing and/or outputs of the AI system do not include unauthorized, unintended, and/or harmful content. In embodiments, the AI system governance module 2430 is configured to detect attempts to circumvent, subvert, remove, or otherwise avoid governance mechanisms applied to one or more AI systems (e.g., attempts to present input that is unauthorized, unintended, and/or harmful, but that is disguised to avoid detection by a governance rule set) and to update the policies and/or governance mechanisms of the AI systems to detect, reduce, alleviate, prevent, report, and/or penalize such avoidance. In embodiments, the AI system governance module 2430 is configured to detect attempts to violate the security, integrity, and/or availability of the AI systems (e.g., denial-of-service attacks, AI system “poisoning” attacks, and/or AI system exploration, eavesdropping, or data exfiltration) and to take steps to reduce, alleviate, prevent, report, and/or penalize such attacks.

In embodiments, the AI system governance module 2430 configures and/or provides supervision of one or more AI systems. For example, the AI systems may include one or more generative AI systems, and the AI system governance module 2430 may supervise the generation of content to promote positive features (e.g., quality, accuracy, coherence, or the like) and/or to reduce or prevent negative features (e.g., inaccuracy, incoherence, harmfulness, or the like). The AI system governance module 2430 may apply such supervision to the inputs to the generative AI systems (e.g., prompts and/or content sources provided as input), to the processing of the generative AI systems (e.g., to particular forms of information and/or reasoning used by the generative AI system), to the output of the generative AI systems (e.g., to content generated based on prompts and/or input), and/or to the uses of the generative AI systems (e.g., to the purposes for which generated content is used). The AI system governance module 2430 may apply such supervision based on rules, guidelines, heuristics, principles, comparisons with positive and negative content and/or processing, or the like. The AI system governance module 2430 may apply such supervision by generating and/or applying a supervising AI system to another AI system (e.g., a classifier network that classifies the output of a generative AI system as potentially negative). AI system governance module 2430 may apply such supervision with input from human reviewers (e.g., the AI system governance module 2430 may involve humans for spot-checking content, for scoring or rating content, for reviewing content generated by the AI systems that has been flagged as potentially negative, and/or for responding to reports of negative content generated by the AI systems). The AI system governance module 2430 may use the results of automated and/or human supervision to modify generated content; to modify the AI systems (e.g., training, retraining, and/or replacing the AI systems); to create, modify, and/or refine the supervision (e.g., modifying the rules, heuristics, principles, or the like to prevent the generation of further negative content by the AI systems); to create, modify, and/or refine supervising AI systems that are connected to other AI systems (e.g., training, retraining, and/or replacing a supervising AI system with an improved supervising AI system); and/or to generate reports about the AI systems (e.g., reports of the prompts, performance, types, and/or uses of content generated by the AI systems).

In embodiments, the operations modules 2402 include an AI system redevelopment module 2432 that is configured and/or provided to redevelop deployed artificial intelligence systems. For example, in response to the AI system analyzing module 2426 detecting reduced performance of an AI system, the AI system redevelopment module 2432 may be configured and/or provided to initiate retraining of the AI system using additional training data (e.g., additional synthetic training data generated by the AI system training data set augmentation module 2408 corresponding to new data that the AI system has not previously been trained to receive and process). In embodiments, in response to the AI system analyzing module 2426 detecting reduced performance of an AI system, the AI system redevelopment module 2432 causes the AI system training module 2410 to train a replacement AI system, and causes the AI system verifying module 2412 to verify that the replacement AI system addresses the reduced performance of the AI system. Based on such verifying, the AI system redevelopment module 2432 may cause the AI system deployment module 2418 to deploy the replacement AI system to substitute for the original AI system. In embodiments, the AI system redevelopment module 2432 may experimentally task the AI system training module 2410 with developing candidate AI systems that might replace an existing AI system. As compared with an existing AI system, a candidate AI system may be trained on different training data, with a different training regimen, with a different AI system type and/or architecture. A candidate AI system may be trained in a same or similar manner as an existing AI system, but may result in different and possibly improved performance due to the stochastic nature of AI system training. The AI system redevelopment module 2432 may initiate the redevelopment and/or experimental testing of candidate AI systems in response to a change of priority of tasks related to an AI system (e.g., an updated indication that a particular type of error is more harmful and/or more common than was previously initiated). The AI system redevelopment module 2432 may initiate the redevelopment and/or experimental testing of candidate AI systems in response to a change in the resources of the AI convergence system of systems 1900 (e.g., increased computational capacity may enable a candidate AI system with greater learning capacity to outperform an existing AI system). The AI system redevelopment module 2432 may initiate the redevelopment and/or experimental testing of candidate AI systems in response to advances in AI systems research or technology (e.g., a development of new model types, a new training regimen, new types of AI system hardware and/or software, or scientific discoveries relating to AI system performance and/or performance optimization techniques). Based on a candidate AI system exhibiting improved performance relative to an existing AI system, the AI system redevelopment module 2432 may initiate a deployment of the candidate AI system to replace the existing AI system.

In embodiments, the operations modules 2402 include an AI system logging module 2434 that is configured and/or provided to log the activities of artificial intelligence systems and/or operations modules 2402 while performing various operations and/or tasks. In embodiments, the AI system logging module 2434 is configured and/or provided to detect and log the operations of the AI system generation module 2404 in generating and/or storing new AI systems. In embodiments, the AI system logging module 2434 is configured and/or provided to detect and log the operations of the AI system training data set generation module 2406 in generating training data sets for the training of various AI systems. In embodiments, the AI system logging module 2434 is configured and/or provided to detect and log the operations of the training data set augmentation module 2408 in the number, kinds, sources, techniques, and examples of synthetic data generated for various training data sets, as well as the circumstances for such augmentation (e.g., the issues with a training data set that synthetic data was generated to address). In embodiments, the AI system logging module 2434 is configured and/or provided to detect and log the operations of the AI system training module 2410 in selecting, initiating, monitoring, validating, and completing the training of the AI systems of the AI convergence system of systems 1900, as well as the resulting performance of the trained AI systems (e.g., the performance, accuracy, recall, F1 score, bias, consistency, efficiency, and/or latency of respective trained AI systems). In embodiments, the AI system logging module 2434 is configured and/or provided to detect and log the operations of the AI system verifying module 2412 in verifying the generated AI systems (e.g., measurements of the performance of trained AI models on test data sets). In embodiments, the AI system logging module 2434 is configured and/or provided to detect and log the operations of the AI system adaptation module 2414 in adapting AI systems for particular devices, execution environments, data types, tasks, contexts, use cases, or the like. In embodiments, the AI system logging module 2434 is configured and/or provided to detect and log the operations of the AI system aggregation module 2416 in aggregating AI systems to generate and interconnect two or more AI systems to form hybrids, ensembles, sequences or chains, managed AI systems, AI system swarms, or the like. In embodiments, the AI system logging module 2434 is configured and/or provided to detect and log the operations of the AI system deployment module 2418 to deploy AI systems in response to various requests, which may originate within the AI convergence system of systems 1900 or external to the AI convergence system of systems 1900. In embodiments, the AI system logging module 2434 is configured and/or provided to detect and log the operations of the AI system invocation module 2420 to invoke one or more AI systems to fulfill one or more requests. In embodiments, the AI system logging module 2434 is configured and/or provided to detect and log the operations of the AI system orchestration module 2422 to organize the invocations of the AI systems of the AI convergence system of systems 1900 to meet the requirements of the requests and/or tasks, such as changes due to load-balancing or scheduling. In embodiments, the AI system logging module 2434 is configured and/or provided to detect and log the operations of the AI system monitoring module 2424 to monitor the performance of the AI systems of the AI convergence system of systems 1900, such as the planned and/or completed schedule of measuring and monitoring the performance of the AI systems and/or the results of the performance measurements. In embodiments, the AI system logging module 2434 is configured and/or provided to detect and log the operations of the AI system analyzing module 2426 to analyze the measured performance of the AI systems and the steps taken by the AI system analyzing module 2426 or other modules to respond to changes in performance (e.g., retraining AI systems, replacing AI systems, and/or adapting some AI systems to include features that resulted in performance improvements of other AI systems). In embodiments, the AI system logging module 2434 is configured and/or provided to detect and log the operations of the AI system updating module 2428 to update various AI systems in response to the analyses performed by the AI system analyzing module 2428. In embodiments, the AI system logging module 2434 is configured and/or provided to detect and log the operations of the AI system governance module 2430 to manage and/or govern the AI systems based on legal, social, practical, and/or regulatory policies (e.g., policies relating to truthfulness and/or avoidance of harm). In embodiments, the AI system logging module 2434 is configured and/or provided to detect and log the operations of the AI system redevelopment module 2432 to redevelop the AI systems based on the performance of the AI systems, the resources of the AI convergence system of systems 1900, and/or the development of new AI systems. In embodiments, the AI system logging module 2434 correlates the activities of various modules to determine causal relationships between the operations modules 2402 (e.g., a first event involving a deployment of an AI system in an environment that is associated with a second event involving a performance measurement of another AI system in the same environment; a first event involving an adaptation of an AI system followed by a second event involving a performance measurement of the adapted AI system; or a first event involving a reorganization of the AI convergence system of systems 1900 by the AI system orchestration module 2422 followed by a second event involving a change in a performance measurement of an AI system by the AI system monitoring module 2424). In embodiments, the AI system logging module 2434 logs the operations of the AI models and/or the operations modules 2402 in one or more event logs.

In embodiments, the operations modules 2402 are configured to serve one or more smart asset operations. For example, an asset may comprise a fund, an amount of currency such as an accumulation of cryptocurrency, a digital contract, a valuable object, or the like. Such assets may be made “smart” by supplementing the asset with intelligent functions that resemble cognition and that improve the features of the asset, such as value, security, and/or longevity. For example, a fund may be made “smart” by predicting or detecting events that may positively or negatively affect the value of the fund, identifying steps that may be taken responsive to the events, and/or executing the steps. A digital contract may be made “smart” by predicting or detecting events that may positively or negatively affect the execution of the smart contract by one or more parties, identifying steps that may be taken responsive to the events, and/or executing the steps. A valuable object may be made “smart” by predicting or detecting events that may positively or negatively affect the value of the object, identifying steps that may be taken responsive to the events, and/or executing the steps. In such contexts, and in embodiments, the operations modules 2402 are configured to generate and/or invoke one or more AI systems to provide “smart” features for such assets. In embodiments, the operations modules 2402 generate and/or invoke one or more AI systems to add a predictive “smart” feature to an asset, such as an AI system that monitors social, political, economic, scientific, and/or technical events and extrapolates positive and/or negative effects of the current events on a current and/or future value of the asset. In embodiments, the operations modules 2402 generate and/or invoke one or more AI systems to add a reactive “smart” feature to an asset, such as an AI system that identifies actions that can be taken regarding the asset in response to social, political, economic, scientific, and/or technical events. In embodiments, the operations modules 2402 generate and/or invoke one or more AI systems to add an executive “smart” feature to an asset, such as an AI system that executes actions to promote the value, security, and/or longevity of the asset in response to social, political, economic, scientific, and/or technical events.

In embodiments, the operations modules 2402 are configured to serve one or more deployments of smart infrastructure. For example, the infrastructure of an organization such as a government, a university, a hospital, or the like may include a set of interconnected infrastructure systems, such as power, communication, information technology, inventory management, transportation, maintenance, cleaning, and auditing. Each infrastructure system may include a set of resources, such as power infrastructure including power storage, wiring, regulation such as circuit breakers, switches for failover and load-balancing, and the like. The infrastructure may be made “smart” by supplementing the infrastructure with intelligent functions that resemble cognition and that improve the functionality of the infrastructure, such as availability, security, efficiency, and/or maintenance. For example, power infrastructure may be made “smart” by predicting and proactively addressing potential power failures due to events such as weather patterns, climate change, events in energy markets, and/or changes in the availability of energy-related supplies such as wiring and batteries. In such contexts, and in embodiments, the operations modules 2402 are configured to generate and/or invoke one or more AI systems to provide “smart” features to infrastructure. In embodiments, the operations modules 2402 generate and/or invoke one or more AI systems to add a predictive “smart” feature to infrastructure, such as an AI system that monitors social, political, economic, scientific, and/or technical events and extrapolates positive and/or negative effects of the current events on a current and/or future operation of various systems of the infrastructure. In embodiments, the operations modules 2402 generate and/or invoke one or more AI systems to add a reactive “smart” feature to the infrastructure, such as an AI system that identifies actions that can be taken to promote and/or maintain the availability, security, efficiency, and/or maintenance of the infrastructure system. In embodiments, the operations modules 2402 generate and/or invoke one or more AI systems to add an executive “smart” feature to the infrastructure, such as an AI system that executes actions to promote the availability, security, efficiency, and/or longevity of the infrastructure in response to social, political, economic, scientific, and/or technical events.

In embodiments, the operations modules 2402 are configured to serve one or more smart machines. For example, an industrial machine in a mining facility may include a number of mining-related functions, such as extracting a mineral, refining a mineral, and assessing the refined mineral for quality, quantity, purity, and/or value. The machine may be made “smart” by supplementing the machine with intelligent functions that resemble cognition and that improve the functionality of the machine, such as performance, efficiency, and/or longevity. For example, the machine may be made “smart” by adapting the manner of extracting minerals to promote the speed, efficiency, completeness, security, and/or integrity of the extraction process. In such contexts, and in embodiments, the operations modules 2402 are configured to generate and/or invoke one or more AI systems to provide “smart” features to the machine. In embodiments, the operations modules 2402 generate and/or invoke one or more AI systems to add a predictive “smart” feature to the machine, such as an AI system that predicts how changes in the mine and/or other machines of the mine may impact the current and/or future operation of the machine. In embodiments, the operations modules 2402 generate and/or invoke one or more AI systems to add a reactive “smart” feature to the machine, such as an AI system that identifies actions that can be taken to promote and/or maintain the performance, efficiency, and/or longevity of the machine (e.g., physical changes or upgrades of the machine, changes to the manner and/or timing of operation of the machine, and/or maintenance actions regarding various components of the machine). In embodiments, the operations modules 2402 generate and/or invoke one or more AI systems to add an executive “smart” feature to the machine, such as an AI system that executes actions to promote the performance, efficiency, and/or longevity of the machine (e.g., automatically arranging maintenance of components of the machine that are at risk of wear and/or failure).

In embodiments, the operations modules 2402 are configured to serve one or more robotic operations. For example, a robotic operation may include a fleet of robots, each having a set of capabilities (e.g., sensors, modes of transportation, tools, end effectors, and the like) and requirements (e.g., fuel or power storage, protection from elements such as water or electrical shock, and periodic maintenance), and each being assigned to perform one or more tasks (e.g., transporting materials, monitoring a location, and/or serving a user). The robotic operation may be made “smart” by supplementing the robotic operation with intelligent functions that resemble cognition and that improve the functionality of the robotic operation, such as the assignment of robots to tasks, the maintenance and upgrading of the robotic fleet, and the performance of tasks by the robots. In such contexts, and in embodiments, the operations modules 2402 are configured to generate and/or invoke one or more AI systems to provide “smart” features to the robotic operation. In embodiments, the operations modules 2402 generate and/or invoke one or more AI systems to add a predictive “smart” feature to the robotic operation, such as an AI system that predicts how changes in the location, orientation, environment, climate, cargo, and/or containers of the robotic operation may impact the performance of the tasks by the robotic fleet, such as obstacles or interruptions of service that might prevent the robots from completing one or more tasks. In embodiments, the operations modules 2402 generate and/or invoke one or more AI systems to add a reactive “smart” feature to the robotic operation, such as an AI system that identifies actions that can be taken to promote the performance, reliability, efficiency, and/or completion of the tasks by the robotic fleet, including adapting the assignment, scheduling, and/or prioritization of the robots of the robotic fleet to the set of available tasks.

In embodiments, the operations modules 2402 generate and/or invoke one or more AI systems to add an executive “smart” feature to the robotic operation, such as an AI system that executes actions to promote the performance, reliability, efficiency, and/or completion of the tasks by the robotic fleet, such as automatically deploying, assigning, reassigning decommissioning, and/or upgrading robots to perform the tasks of the robotic operation, and/or automatically maintaining and/or upgrading the robotic fleet to preserve and/or add capabilities to the robotic fleet.

In embodiments, the operations modules 2402 are configured to serve one or more UAV operations. For example, a UAV operation may include a fleet of unmanned aerial vehicles, such as drones, light aircraft, helicopters, balloons, dirigibles, airships, rockets, satellites, or the like. The unmanned aerial vehicles may be autonomously controlled by onboard or remote AI systems to perform the takeoff, route selection and correction, airborne maneuvers, status monitoring, and landing of the aircraft. The UAV operation may assign various UAVs of the UAV fleet to various tasks, such as monitoring or measuring a particular geographic region or a subject such as a field of crops, livestock, or an industrial or military operation; deploying substances such as water, fire suppression substances, fertilizer, or pesticide; transporting cargo between various locations; delivering fuel and/or power to other UAVs; or providing first-responder services such as transporting first responders or equipment to address health emergencies or public safety events. In such contexts, and in embodiments, the operations modules 2402 are configured to generate and/or invoke one or more AI systems to provide “smart” features to the UAV operation. In embodiments, the operations modules 2402 generate and/or invoke one or more AI systems to add a predictive “smart” feature to the UAV operation, such as an AI system that predicts how changes in the environment, climate, traffic, wildlife, population, and/or equipment may impact the performance of the tasks by the UAV fleet, such as obstacles or interruptions of service that might prevent the UAVs from completing one or more tasks. In embodiments, the operations modules 2402 generate and/or invoke one or more AI systems to add a reactive “smart” feature to the UAV operation, such as an AI system that identifies actions that can be taken to promote the performance, reliability, efficiency, and/or completion of the tasks by the UAV fleet, including adapting the assignment, scheduling, and/or prioritization of the UAVs of the UAV fleet to the set of available tasks. In embodiments, the operations modules 2402 generate and/or invoke one or more AI systems to add an executive “smart” feature to the UAV operation, such as an AI system that executes actions to promote the performance, reliability, efficiency, and/or completion of the tasks by the UAV fleet, such as automatically deploying, assigning, reassigning decommissioning, and/or upgrading UAVs to perform the tasks of the UAV operation, and/or automatically maintaining and/or upgrading the UAV fleet to preserve and/or add capabilities to the UAV fleet.

In embodiments, the operations modules 2402 are configured to serve one or more human-machine cooperative operations. For example, a human-machine cooperative operation may involve one or more tasks that are performed by one or more humans cooperating with one or more machines in fields such as mining, manufacturing, surveying, construction, healthcare, education, emergency response, or the like. A human and a machine may cooperate to perform a physical task together, such as carrying a piece of equipment, furniture, or a material such as a pane of glass. A human and a machine may cooperate to choose a plan for completing a task, such as surveying a geographic region to measure a population of wildlife. A human and a machine may cooperate by the human supervising the performance of a task by a machine, such as a robot engaging in a manufacturing or construction operation while a human monitors the operation of the robot to detect and address problems. A human and a machine may cooperate by the robot observing the human during the performance of a task to learn how to perform the task, such as a robotic process automation (RPA) task that enables the robot to perform the task autonomously in the future. A human and a machine may cooperate by the human observing the robot during the performance of a task to learn how to perform the task, such as a skill-sharing operation where a robot teaches a human to perform a task, which may have been learned from another human. The human-machine cooperative operation may be made “smart” by supplementing the human-machine cooperative operation with intelligent functions that resemble cognition and that improve the functionality of the human-machine cooperative operation, such as the mapping of tasks to combinations of one or more humans and one or more machines. In such contexts, and in embodiments, the operations modules 2402 are configured to generate and/or invoke one or more AI systems to provide “smart” features to the human-machine cooperative operation. In embodiments, the operations modules 2402 generate and/or invoke one or more AI systems to add a predictive “smart” feature to the human-machine cooperative operation, such as an AI system that predicts which humans and which machines will cooperate well together to perform a particular task. In embodiments, the operations modules 2402 generate and/or invoke one or more AI systems to add a reactive “smart” feature to the human-machine cooperative operation, such as an AI system that identifies the occurrence and/or causes of current and/or future disagreements between a human cooperating with a machine. In embodiments, the operations modules 2402 generate and/or invoke one or more AI systems to add an executive “smart” feature to the human-machine cooperative operation, such as an AI system that executes actions to address disagreements between a human cooperating with a machine, such as conversations, mediation by the AI system or by another human and/or machine, clarification of communication between the human and the machine, review and analysis of previous interaction between the human and the machine that resulted in the disagreement, and/or adjustments of the assignment of humans and machines to various cooperative tasks.

In embodiments, the operations modules 2402 are configured to serve one or more finance and/or banking operations. For example, a finance and/or banking operation may involve one or more lending, borrowing, currency transfer, currency exchange, investment, divestment, asset acquisition, asset sale, and/or financial advising tasks. The finance and/or banking operation may be made “smart” by supplementing the finance and/or banking operation with intelligent functions that resemble cognition and that improve the functionality of the finance and/or banking operation, such as the yield, reliability, stability, liquidity, and/or availability of investments and/or assets. In such contexts, and in embodiments, the operations modules 2402 are configured to generate and/or invoke one or more AI systems to provide “smart” features to the finance and/or banking operation. In embodiments, the operations modules 2402 generate and/or invoke one or more AI systems to add a predictive “smart” feature to the finance and/or banking operation, such as an AI system that predicts how social, political, economic, scientific, and/or technical events may positively or negatively impact the yield, reliability, stability, liquidity, and/or availability of investments and/or assets. In embodiments, the operations modules 2402 generate and/or invoke one or more AI systems to add a reactive “smart” feature to the finance and/or banking operation, such as an AI system that identifies actions that can be taken to avoid financial risks arising from events, such as redistributing investments and/or assets such as currency to protect against volatility risks such as inflation, deflation, shortage, theft, and/or disadvantageous leverage. In embodiments, the operations modules 2402 generate and/or invoke one or more AI systems to add an executive “smart” feature to the finance and/or banking operation, such as an AI system that executes transactions to redistribute investments and/or assets such as currency to protect against volatility risks such as inflation, deflation, shortage, theft, and/or disadvantageous leverage.

In embodiments, the operations modules 2402 are configured to serve one or more transaction operations. For example, a transaction operation may involve the determination, formulation, negotiation, commitment, execution, monitoring, and/or resolution of transactions among two or more parties, wherein respective transactions include one or more of a transfer of ownership of currency and/or assets, a delivery of goods and/or services, an assumption of obligations to perform or not perform certain actions, a dispensation or release of an existing obligation, or the like. The transaction operation may be made “smart” by supplementing the transaction operation with intelligent functions that resemble cognition and that improve the functionality of the transaction operation, such as the clarity, understanding, security, auditing, execution, recordation, and/or regulatory review of the transaction, as well as related services such as mediation of disputes, due diligence, and compliance with legal, political, and/or regulatory requirements or policies. In such contexts, and in embodiments, the operations modules 2402 are configured to generate and/or invoke one or more AI systems to provide “smart” features to the transaction operation. In embodiments, the operations modules 2402 generate and/or invoke one or more AI systems to add a predictive “smart” feature to the transaction operation, such as an AI system that predicts how social, political, economic, scientific, and/or technical events may positively or negatively impact the negotiation, understanding, commitment, execution, monitoring, and/or resolution of transactions. In embodiments, the operations modules 2402 generate and/or invoke one or more AI systems to add a reactive “smart” feature to the transaction operation, such as an AI system that identifies actions that can be taken to reduce risks to the completion of transactions arising from various events, such as securing additional guarantees or verifying compliance of a party to the transaction with one or more contractual obligations. In embodiments, the operations modules 2402 generate and/or invoke one or more AI systems to add an executive “smart” feature to the transaction operation, such as an AI system that executes actions to reduce risks to the completion of transactions, such as initiating an audit of a contract to ensure compliance of a party with contractual obligations under a transaction or acquiring insurance and/or guarantees to hedge against a failure of the transaction.

In embodiments, the operations modules 2402 are configured to serve one or more automated machine monitoring operations. For example, an automated machine monitoring operation may involve monitoring operations of a machine to detect the occurrence, progress, and/or quality of the performance of tasks, the status of the machine (e.g., temperature, inventory of consumables, and/or freedom from defects and/or anomalous behavior), and interactions between the machine and other machines of a facility. The automated machine monitoring operation may be made “smart” by supplementing the automated machine monitoring operation with intelligent functions that resemble cognition and that improve the functionality of the automated machine monitoring operation, such as monitoring the completion of tasks by the machine, monitoring the status of the machine, and monitoring the interactions between the machine and other machines of a facility. In such contexts, and in embodiments, the operations modules 2402 are configured to generate and/or invoke one or more AI systems to provide “smart” features to the automated machine monitoring operation. In embodiments, the operations modules 2402 generate and/or invoke one or more AI systems to add a predictive “smart” feature to the automated machine monitoring operation, such as an AI system that predicts how changes to a facility (e.g., the locations, orientations, and byproducts of other machines of a facility) may positively or negatively impact the monitoring of the performance, status, or interaction of a machine with other machines of a facility (e.g., organization of a facility that resulted in a blockage of a view of a machine by a monitoring camera and/or interference with the monitoring of the machine by a sensor). In embodiments, the operations modules 2402 generate and/or invoke one or more AI systems to add a reactive “smart” feature to the automated machine monitoring operation, such as an AI system that identifies causes of problems with the monitoring of the performance of tasks by the machine, the status of the machine, and/or the interaction of the machine with other machines of the facility (e.g., determining that the location of materials in a facility interferes with a monitoring of a machine of the facility by the AI system). In embodiments, the operations modules 2402 generate and/or invoke one or more AI systems to add an executive “smart” feature to the automated machine monitoring operation, such as an AI system that executes actions to address, reduce, and/or prevent problems with the monitoring of the performance of tasks by the machine, the status of the machine, and/or the interaction of the machine with other machines of the facility (e.g., autonomously instructing a robot of the facility to relocate materials in the facility to address a blockage of a monitoring process).

In embodiments, the operations modules 2402 are configured to serve one or more maintenance operations.

For example, a maintenance operation may involve surveying, testing, resupplying, repairing, reprogramming, refreshing, cleaning, and/or replacing a machine or one or more components of a machine. The maintenance operation may be made “smart” by supplementing the maintenance operation with intelligent functions that resemble cognition and that improve the functionality of the maintenance operation, such as refining the maintenance operations for improved efficiency, speed, availability, reliability, completion, and/or recordation of the maintenance operations. In such contexts, and in embodiments, the operations modules 2402 are configured to generate and/or invoke one or more AI systems to provide “smart” features to the maintenance operation. In embodiments, the operations modules 2402 generate and/or invoke one or more AI systems to add a predictive “smart” feature to the maintenance operation, such as an AI system that predicts how changes to the machine or an environment of the machine may positively or negatively impact the relevance, urgency, timeliness, extent, and/or completeness of maintenance operations for the machine.

In embodiments, the operations modules 2402 generate and/or invoke one or more AI systems to add a reactive “smart” feature to the maintenance operation, such as an AI system that improves the diagnostic accuracy, reliability, and/or efficiency of the maintenance operations of the machine in view of changes to the machine, uses of the machine (e.g., the materials and/or tasks for which the machine is used), and/or an environment of the machine. In embodiments, the operations modules 2402 generate and/or invoke one or more AI systems to add an executive “smart” feature to the maintenance operation, such as an AI system that executes actions to improve the diagnostic accuracy, reliability, and/or efficiency of the maintenance operations, such as automatically adjusting a maintenance schedule in response to changes to the machine, uses of the machine (e.g., the materials and/or tasks for which the machine is used), and/or an environment of the machine.

In embodiments, the operations modules 2402 are configured to serve one or more robotic process automation (RPA) operations. For example, an RPA operation may involve a learning software process that observes a human during the performance of a task (e.g., a physical task, a cognitive process, and/or an interaction between the human and one or more other humans, robots, and/or software processes such as user interfaces) in order to learn to perform the task in a corresponding and/or equivalent autonomous manner using software, hardware, and/or robotic processes. The RPA operation may be made “smart” by supplementing the RPA operation with intelligent functions that resemble cognition and that improve the functionality of the RPA operation, such as improving the accuracy, clarity, reliability, and/or situational awareness of the learning software process while learning and/or autonomously performing the task. In such contexts, and in embodiments, the operations modules 2402 are configured to generate and/or invoke one or more AI systems to provide “smart” features to the RPA operation. In embodiments, the operations modules 2402 generate and/or invoke one or more AI systems to add a predictive “smart” feature to the RPA operation, such as an AI system that predicts deficiencies in the learning process, such as features of the task that may not be or may not have been adequately conveyed to and/or learned by a learning software process (e.g., lack of clarity, incomplete explanations, confusion, inconsistency, and/or incomplete records of the performance of the task by the human). In embodiments, the operations modules 2402 generate and/or invoke one or more AI systems to add a reactive “smart” feature to the RPA operation, such as an AI system that identifies ways to address deficiencies in the learning process (e.g., requests that may be presented to the human, such as requests to explain certain aspects of the task or the context of the task and/or requests for an additional performance of the task). In embodiments, the operations modules 2402 generate and/or invoke one or more AI systems to add an executive “smart” feature to the RPA operation, such as an AI system that executes actions to address, reduce, and/or prevent problems with the performance of tasks by the machine, the status of the machine, and/or the interaction of the machine with other machines of the facility.

In embodiments, the operations modules 2402 are configured to serve one or more converged information technology/operational technology (IT/OT) operations. For example, a converged IT/OT operation may involve a combination of a traditional, general-purpose information technology environment and resource set (e.g., general-purpose networking, data storage, software and device deployment, and an information security model) with operation-specific resources and operations (e.g., specific industrial machines, controllers, communication protocols, and monitoring). The converged IT/OT operation may be made “smart” by supplementing the converged IT/OT operation with intelligent functions that resemble cognition and that improve the functionality of the converged IT/OT operation, such as improving the synergy, adaptability, reliability, and robustness of the mapping of IT resources to specific industrial operations and resources. In such contexts, and in embodiments, the operations modules 2402 are configured to generate and/or invoke one or more AI systems to provide “smart” features to the converged IT/OT operation. In embodiments, the operations modules 2402 generate and/or invoke one or more AI systems to add a predictive “smart” feature to the converged IT/OT operation, such as an AI system that predicts how changes to the industrial environment may affect the industrial operations and the assignment of information technology resources thereto (e.g., increases of new industrial machines and/or workloads that could potentially create shortages of information technology resources, such as network capacity and/or storage capacity). In embodiments, the operations modules 2402 generate and/or invoke one or more AI systems to add a reactive “smart” feature to the converged IT/OT operation, such as an AI system that identifies opportunities to acquire, map, provision, reserve, deploy, configure, and/or use generic IT resources for specific industrial operations in order to provide capabilities, improve features, and/or address potential problems of the industrial operations such as yield, quality, and/or efficiency. In embodiments, the operations modules 2402 generate and/or invoke one or more AI systems to add an executive “smart” feature to the converged IT/OT operation, such as an AI system that executes actions to address, reduce, and/or prevent problems with the mapping of information technology resources to specific industrial operations, such as automatically acquiring and/or reassigning information technology resources to the industrial operations based on demand, requirements, priorities, timing, side-effects, statuses, and/or outcomes of the industrial operations.

In embodiments, the operations modules 2402 are configured to serve one or more insurance, underwriting, and/or risk management operations. For example, an insurance, underwriting, and/or risk management operation may involve a determination of one or more risks related to an entity, resource, asset, operation, venture, objective, or the like, wherein the risks may affect a condition, value, availability, suitability, longevity, functionality, and/or reputation of the entity, resource, asset, operation, venture, objective, or the like. The insurance, underwriting, and/or risk management operation may also involve an assessment of an overall risk profile, options that may mitigate such risks, and/or the availability, security, reliability, cost, and/or value of insurance and/or underwriting of such entity, resource, asset, operation, venture, objective, or the like, including options for predicting, detecting, mitigating, compensating, and/or alleviating such risks. The insurance, underwriting, and/or risk management operation may be made “smart” by supplementing the insurance, underwriting, and/or risk management operation with intelligent functions that resemble cognition and that improve the functionality of the insurance, underwriting, and/or risk management operation, such as improving the accuracy, likelihood, clarity, extent, and/or outcomes of predicted risks and/or the availability, security, reliability, cost, and/or value of insurance and/or underwriting of such risks. In such contexts, and in embodiments, the operations modules 2402 are configured to generate and/or invoke one or more AI systems to provide “smart” features to the insurance, underwriting, and/or risk management operation. In embodiments, the operations modules 2402 generate and/or invoke one or more AI systems to add a predictive “smart” feature to the insurance, underwriting, and/or risk management operation, such as an AI system that predicts how social, political, economic, scientific, and/or technical developments are likely to affect predictions of risks and/or insurance and/or underwriting thereof. In embodiments, the operations modules 2402 generate and/or invoke one or more AI systems to add a reactive “smart” feature to the insurance, underwriting, and/or risk management operation, such as an AI system that recommends adjustments to an entity, resource, asset, operation, venture, objective, or the like to reduce or mitigate a risk profile in view of social, political, economic, scientific, and/or technical developments, and/or adjustments to an insurance and/or underwriting policy (e.g., informing individuals of changes to risk profiles regarding an entity, resource, asset, operation, venture, objective, or the like, and/or generating and presenting recommendations to adjust a scope, redundancy, and/or cost of coverage by insurance and/or underwriting in response to social, political, economic, scientific, and/or technical developments). In embodiments, the operations modules 2402 generate and/or invoke one or more AI systems to add an executive “smart” feature to the insurance, underwriting, and/or risk management operation, such as an AI system that executes actions to adjust an entity, resource, asset, operation, venture, objective, or the like (e.g., changing a level of security of an entity, resource, asset, operation, venture, objective, or the like, and/or automatically executing transactions to scale a level, scope, redundancy, and/or cost of coverage by insurance and/or underwriting in response to social, political, economic, scientific, and/or technical developments).

In embodiments, the operations modules 2402 are configured to serve one or more payment operations. For example, a payment operation may involve a determination of one or more payment obligations, such as payments associated with payroll, purchasing, investment distribution, and/or lottery or gambling operations. The payment operation may involve determining and verifying a payment event, determining an availability of funds in a fund source, verifying a recipient and/or destination of the payment, initiating a payment event such as a transfer of currency, verifying receipt and/or execution of the payment, and logging and/or auditing the payment. The payment operation may be made “smart” by supplementing the payment operation with intelligent functions that resemble cognition and that improve the functionality of the payment operation, such as improving the security, accuracy, efficiency, and/or auditing of such payments. In such contexts, and in embodiments, the operations modules 2402 are configured to generate and/or invoke one or more AI systems to provide “smart” features to the payment operation. In embodiments, the operations modules 2402 generate and/or invoke one or more AI systems to add a predictive “smart” feature to the payment operation, such as an AI system that predicts security issues that might arise in the payment operation such as fraudulent inducement, impersonation, interception, redirection, fabrication, manipulation, duplication, obscuring, and/or illegality of payments. In embodiments, the operations modules 2402 generate and/or invoke one or more AI systems to add a reactive “smart” feature to the payment operation, such as an AI system that recommends additional security processes to reduce, detect, and/or prevent fraudulent inducement, impersonation, interception, redirection, fabrication, manipulation, duplication, obscuring, and/or illegality of payments. In embodiments, the operations modules 2402 generate and/or invoke one or more AI systems to add an executive “smart” feature to the payment operation, such as an AI system that executes actions to monitor, verify, block, audit, record, audit, and/or report occurrences of payments and/or problems related thereto, such as fraudulent inducement, impersonation, interception, redirection, fabrication, manipulation, duplication, obscuring, and/or illegality of payments.

### Network Layer

Referring to FIG. 19 and FIG. 23, the AI convergence system of systems 1900 may include a network layer 2500 having a set of network modules 2502. In embodiments, the network modules 2502 may include an adaptive network routing module 2504, an adaptive error correction module 2506, an adaptive network storage module 2508, an adaptive protocol selection module 2510, an adaptive block size module 2512, an adaptive transmission window module 2514, an edge networking module 2516, a cloud networking module 2518, a communication network module 2520, a cellular module 2522, a WiFi module 2524, an ORAN module 2526, a Bluetooth module 2528, a satellite module 2530, an IoT network module 2532, a mesh network module 2534, a social network module 2536, and an insurance network module 2538. In embodiments, the set of network modules 2502 may further include a power grid module, a shipping network module, a delivery network module, a distributed energy network module, a healthcare network module, an IoT-in-a-box module, an industrial IT/OT module, a transaction network module, a financial network module, a payments network module, a transportation network module, a value chain network module, and a supply chain network module.

In some embodiments, each network module of the network layer 2500 may include one or more processors and one or more memories storing computer-executable instructions that, when executed by the one or more processors, cause the one or more processors to implement a set of machine learning systems, a set of artificial intelligence systems, and/or a set of neural networks configured to perform an intelligence task related to that particular network module. Such intelligence tasks may relate to optimization tasks, generative tasks, predictive tasks, detection and/or identification tasks, decision support tasks, automation tasks, configuration and/or control tasks, and the like.

The machine learning systems may be trained using supervised, unsupervised, or reinforcement learning techniques on diverse types of data, including simulated data (e.g., data generated from a simulation engine, a foundation world model, a set of digital twins, or the like). The neural networks may comprise multiple layers including, but not limited to, convolutional layers, recurrent layers, and fully connected layers. The artificial intelligence systems may implement various algorithms including decision trees, random forests, and gradient boosting machines. The network layer 2500 may further include a simulation engine or set of foundation world models operating in parallel with the machine learning systems, artificial intelligence systems, and/or neural networks, wherein the simulation engine and/or set of foundation world models are configured to generate real-time simulations of scenarios associated with each intelligence task, validate decisions, and provide feedback to the machine learning models for continuous improvement and adaptation to changing conditions. In embodiments, the simulation engine may employ physics-based modeling, discrete event simulation, or agent-based modeling techniques to accurately represent the dynamics of real-world behavior.

For example, an adaptive network routing module 2504 of the network layer 2500 may implement a set of machine learning systems, a set of artificial intelligence systems, and/or a set of neural networks configured to optimize network routing paths in real time. Additional and/or alternative intelligence tasks may involve predictive tasks like forecasting traffic patterns across nodes, detection and identification tasks to recognize network bottlenecks or anomalies, automation tasks to dynamically adjust routing configurations based on current network conditions, decision support tasks by recommending optimal paths for high-priority data and configuration tasks to enforce changes across the network infrastructure to ensure efficient data flow and minimized latency, and the like.

In another example, an adaptive error correction module 2506 of the network layer 2500 may implement a set of machine learning systems, a set of artificial intelligence systems, and/or a set of neural networks configured to identify, predict, and/or correct errors in network communication in real time. Additional and/or alternative intelligence tasks may involve predictive tasks like anticipating potential error-prone scenarios based on historical data, detection and identification tasks to isolate and classify errors in data packets or transmissions, automation tasks to dynamically apply error correction protocols or retransmission strategies, decision support tasks to recommend optimal recovery mechanisms for maintaining data integrity, and configuration tasks to adjust system parameters to prevent future errors, among many others.

In yet another example, an adaptive network storage module 2508 of the network layer 2500 may implement a set of machine learning systems, a set of artificial intelligence systems, and/or a set of neural networks configured to optimize the allocation, retrieval, and management of storage resources across the network. Additional and/or alternative intelligence tasks may involve predictive tasks like forecasting storage capacity requirements based on historical usage patterns, detection and identification tasks to monitor and address storage bottlenecks or underutilized resources, automation tasks to dynamically allocate or reallocate storage to maintain optimal performance, decision support tasks to recommend data replication or tiering strategies for improved efficiency and reliability, configuration tasks to enforce policies for storage redundancy and access control, and the like.

In yet another example, an adaptive protocol selection module 2510 of the network layer 2500 may implement a set of machine learning systems, a set of artificial intelligence systems, and/or a set of neural networks configured to dynamically select the most appropriate communication protocols based on real-time network conditions and requirements. Additional and/or alternative intelligence tasks may involve predictive tasks like forecasting protocol performance under varying loads, detection and identification tasks to assess protocol compatibility or inefficiencies, automation tasks to switch protocols during transmission, decision support tasks to recommend protocols for specific scenarios, configuration tasks to optimize protocol settings for maximum efficiency, and the like.

In yet another example, an adaptive block size module 2512 of the network layer 2500 may implement a set of machine learning systems, a set of artificial intelligence systems, and/or a set of neural networks configured to determine and adjust block sizes dynamically to optimize data transfer efficiency. Additional and/or alternative intelligence tasks may involve predictive tasks like estimating optimal block sizes based on network latency and bandwidth, detection and identification tasks to flag inefficiencies caused by suboptimal block sizes, automation tasks to adjust block sizes in real time during data transfers, decision support tasks to recommend configurations for specific network conditions, configuration tasks to enforce block size policies across the network, and the like.

In yet another example, an adaptive transmission window module 2514 of the network layer 2500 may implement a set of machine learning systems, a set of artificial intelligence systems, and/or a set of neural networks configured to dynamically adjust transmission windows to optimize data flow and minimize congestion. Additional and/or alternative intelligence tasks may involve predictive tasks like forecasting optimal transmission windows based on traffic patterns, detection and identification tasks to identify bottlenecks or excessive retransmissions, automation tasks to modify transmission windows in real time to balance throughput and reliability, decision support tasks to suggest window sizes for specific workloads, configuration tasks to apply policies for transmission efficiency, and the like.

In yet another example, an edge networking module 2516 of the network layer 2500 may implement a set of machine learning systems, a set of artificial intelligence systems, and/or a set of neural networks configured to enable localized data processing and communication at the network edge. Additional and/or alternative intelligence tasks may involve predictive tasks like anticipating traffic loads at edge nodes, detection and identification tasks to monitor edge device performance or connectivity issues, automation tasks to redistribute workloads between edge and central resources, decision support tasks to recommend edge deployment strategies, configuration tasks to manage edge resource allocation, and the like.

In yet another example, a cloud networking module 2518 of the network layer 2500 may implement a set of machine learning systems, a set of artificial intelligence systems, and/or a set of neural networks configured to optimize the connectivity and resource utilization of cloud-based infrastructures. Additional and/or alternative intelligence tasks may involve predictive tasks like forecasting bandwidth demands for cloud applications, detection and identification tasks to diagnose cloud network performance issues, automation tasks to balance traffic between virtual network nodes, decision support tasks to optimize network configurations for cloud workloads, configuration tasks to manage cloud network policies, and the like.

In yet another example, a communication network module 2520 of the network layer 2500 may implement a set of machine learning systems, a set of artificial intelligence systems, and/or a set of neural networks configured to manage and optimize end-to-end data communication across the network. Additional and/or alternative intelligence tasks may involve predictive tasks like forecasting communication delays or outages, detection and identification tasks to locate and resolve data packet loss, automation tasks to reroute traffic for maximum efficiency, decision support tasks to enhance network configurations for specific use cases, configuration tasks to implement fault tolerance strategies, and the like.

In yet another example, a cellular module 2522 of the network layer 2500 may implement a set of machine learning systems, a set of artificial intelligence systems, and/or a set of neural networks configured to optimize the performance and reliability of cellular network communication. Additional and/or alternative intelligence tasks may involve predictive tasks like estimating cellular network load during peak times, detection and identification tasks to monitor signal quality or interference, automation tasks to adjust handover mechanisms between cells, decision support tasks to improve frequency allocation, configuration tasks to enhance network scalability, and the like.

In yet another example, a WiFi module 2524 of the network layer 2500 may implement a set of machine learning systems, a set of artificial intelligence systems, and/or a set of neural networks configured to optimize wireless local area network (WLAN) connectivity and performance. Additional and/or alternative intelligence tasks may involve predictive tasks like forecasting WiFi congestion in high-density areas, detection and identification tasks to analyze signal strength or interference sources, automation tasks to dynamically adjust channel allocations or access point settings, decision support tasks to enhance network configurations for specific environments, configuration tasks to enforce security protocols, and the like.

In yet another example, an ORAN (Open Radio Access Network) module 2526 of the network layer 2500 may implement a set of machine learning systems, a set of artificial intelligence systems, and/or a set of neural networks configured to optimize and manage ORANs. Additional and/or alternative intelligence tasks may involve predictive tasks like forecasting traffic loads across base stations, detection and identification tasks to monitor ORAN performance, automation tasks to adjust radio resource allocations dynamically, decision support tasks to enhance multi-vendor ORAN configurations, configuration tasks to optimize spectrum usage, and the like.

In yet another example, a Bluetooth module 2528 of the network layer 2500 may implement a set of machine learning systems, a set of artificial intelligence systems, and/or a set of neural networks configured to optimize short-range wireless communication for connected devices. Additional and/or alternative intelligence tasks may involve predictive tasks like anticipating device pairing or traffic patterns, detection and identification tasks to analyze signal interference or connectivity issues, automation tasks to adjust device priorities dynamically, decision support tasks to enhance Bluetooth mesh configurations, configuration tasks to manage device security, and the like.

In yet another example, a satellite module 2530 of the network layer 2500 may implement a set of machine learning systems, a set of artificial intelligence systems, and/or a set of neural networks configured to optimize satellite communication. Additional and/or alternative intelligence tasks may involve predictive tasks like forecasting weather-related signal degradation, detection and identification tasks to monitor satellite link performance, automation tasks to reroute traffic dynamically between satellites, decision support tasks to recommend satellite placement strategies, configuration tasks to optimize bandwidth utilization, and the like.

In yet another example, an IoT network module 2532 of the network layer 2500 may implement a set of machine learning systems, a set of artificial intelligence systems, and/or a set of neural networks configured to manage and optimize connectivity for Internet of Things (IoT) devices. Additional and/or alternative intelligence tasks may involve predictive tasks like estimating device activity patterns, detection and identification tasks to flag malfunctioning or compromised devices, automation tasks to dynamically allocate network resources for IoT traffic, decision support tasks to improve IoT gateway configurations, configuration tasks to enforce security measures, and the like.

In yet another example, a mesh network module 2534 of the network layer 2500 may implement a set of machine learning systems, a set of artificial intelligence systems, and/or a set of neural networks configured to optimize and manage a set of decentralized and/or mesh networks. Additional and/or alternative intelligence tasks may involve predictive tasks like forecasting node connectivity or load imbalances, detection and identification tasks to locate failing or underperforming nodes, automation tasks to reroute traffic dynamically within the mesh, decision support tasks to improve network scalability and resilience, configuration tasks to optimize node configurations, and the like.

In yet another example, a social network module 2536 may implement a set of machine learning systems, a set of artificial intelligence systems, and/or a set of neural networks configured to optimize user engagement, content delivery, and network connectivity across a social network. Additional and/or alternative intelligence tasks may involve predictive tasks like forecasting user activity patterns or viral content trends, detection and identification tasks to flag illegal content, automation tasks to curate personalized content feeds dynamically, decision support tasks to recommend moderation or community management strategies, configuration tasks to enforce privacy and security policies, and the like.

In yet another example, a delivery network module may implement a set of machine learning systems, a set of artificial intelligence systems, and/or a set of neural networks configured to optimize last-mile logistics, package tracking, and delivery efficiency across a delivery network. Additional and/or alternative intelligence tasks may involve predictive tasks like estimating delivery times and forecasting traffic patterns, detection and identification tasks to monitor delivery route bottlenecks or failed deliveries, automation tasks to dynamically reroute delivery vehicles for improved efficiency, decision support tasks to enhance fleet management strategies, configuration tasks to prioritize high-value or time-sensitive deliveries, and the like.

In yet another example, an insurance network module 2538 may implement a set of machine learning systems, a set of artificial intelligence systems, and/or a set of neural networks configured to optimize policy management, claims processing, and risk assessment within an insurance network. Additional and/or alternative intelligence tasks may involve predictive tasks like estimating policyholder risk profiles or fraud likelihood, detection and identification tasks to flag fraudulent claims or discrepancies, automation tasks to streamline underwriting and claims approval processes, decision support tasks to recommend pricing or policy bundling strategies, configuration tasks to align operations with regulatory compliance, and the like.

In yet another example, an IoT-in-a-box module may implement a set of machine learning systems, a set of artificial intelligence systems, and/or a set of neural networks configured to simplify the deployment, management, and integration of IoT-in-a-box systems within a network. Additional and/or alternative intelligence tasks may involve predictive tasks like forecasting device connectivity needs or resource consumption, detection and identification tasks to monitor device health or security vulnerabilities, automation tasks to configure and optimize IoT communication protocols, decision support tasks to enhance IoT deployment strategies, configuration tasks to standardize IoT device policies, and the like.

In yet another example, a transaction network module may implement a set of machine learning systems, a set of artificial intelligence systems, and/or a set of neural networks configured to manage and optimize a transactions network. Additional and/or alternative intelligence tasks may involve predictive tasks like forecasting transaction volumes or fraud likelihood, detection and identification tasks to monitor suspicious activity or errors, automation tasks to streamline transaction approvals or settlements, decision support tasks to recommend fraud prevention strategies, configuration tasks to ensure compliance with financial regulations, and the like.

In yet another example, a financial network module may implement a set of machine learning systems, a set of artificial intelligence systems, and/or a set of neural networks configured to optimize the management and processing of financial data and transactions across the network. Additional and/or alternative intelligence tasks may involve predictive tasks like forecasting market trends or transaction patterns, detection and identification tasks to monitor anomalies or compliance risks, automation tasks to dynamically adjust trading or settlement processes, decision support tasks to recommend investment or liquidity management strategies, configuration tasks to enhance financial reporting accuracy, and the like.

In yet another example, a payments network module may implement a set of machine learning systems, a set of artificial intelligence systems, and/or a set of neural networks configured to optimize payment processing, fraud detection, and transaction settlement within a payments network. Additional and/or alternative intelligence tasks may involve predictive tasks like estimating peak payment volumes or fraud trends, detection and identification tasks to monitor failed transactions or anomalies, automation tasks to streamline payment routing and reconciliation, decision support tasks to enhance payment gateway configurations, configuration tasks to enforce security measures for sensitive financial data, and the like.

### Adaptive Networking and QoS Platform

At the network layer 2500, AI capabilities for adaptive networking enable a platform for providing integrated, adaptive networking and quality of service (QoS) (“the adaptive networking and QoS platform”) for various enterprise and/or operational environments (in some implementations having various sets of facilities and/or environments contained therein). For example, enterprise and/or operational environments may include industrial environments, manufacturing environments, warehouse environments, shipping environments (e.g., container ports, shipping containers, shipyards, and the like), energy environments (e.g., fossil fuel energy environments such as oil rigs, pipelines, and refineries or nuclear energy environments such as nuclear power plants), retail environments, transportation environments (e.g., airports, train stations, bus stops, airplanes, train cars, and the like), transaction and banking environments, datacenter environments, compute environments, hospitality environments, gaming environments, and entertainment environments, among many others.

The adaptive networking and QoS platform may include, without limitation, caching of AI content and generative AI content (e.g., pre-generated instructions for operating machinery, customer risk assessments, pre-generated customer support responses, pre-generated explanations of medical conditions, optimal delivery routes for recurring logistics paths, path optimization results for robot pickers in commonly used zones, workload distribution recommendations, predictions for server failure risks, customer preference data, product recommendation results for repeat customers, pre-generated personalized marketing emails, and pre-generated maintenance instructions or escalation workflows for hardware issues, among many others); caching of AI models (e.g., predictive AI models such as predictive maintenance models for specific machinery, recommendation models, optimization models such as for optimizing factory floor layouts, credit risk assessment models, fraud detection models, load forecasting models, anomaly detection models, diagnostic models, inventory tracking models, pathfinding models, workload balancing models, pricing optimization models, resource allocation models, and the like) and generative AI models (such as for efficient, localized generation of AI content based on localized, contextual inputs and/or for localized, customized use); handling via edge capabilities of transaction events (including point-of-sale transactions, fraud detection, payment processing, energy trading, toll collection, bet placement, payouts, buy-ins, room booking, food and beverage purchases, event ticket purchases, loyalty and rewards transactions (e.g., points earning, points redemption, and membership upgrades), promotional transactions, reporting, payment resolution, and other transaction functions); execution by edge capabilities of gaming engine functions (such as enabling efficient, localized generation of AI-driven environments (e.g., large-scale foundation models for training intelligent agents), simulations, characters or personnel (including physical robots as well as software-based personnel for customer-facing interactions and/or other operations, as well as AI-based attributes, behaviors, and interactions for virtual or augmented systems, including AR/VR-enabled simulations, training modules, operational overlays, and the like); execution by edge capabilities of experience orchestration (such as generating immersive and interactive experiences tailored to localized context, operational needs, and/or personalization of generative content based on real-time understanding of target cohorts, operational conditions, or individual user preferences across various environments, including AR/VR simulations, dynamic visualizations, and situationally adaptive content delivery); and/or the like.

In embodiments, edge capabilities may be provided in edge systems, devices, switches, chipsets and other embodiments. Edge capabilities may include converged capabilities where a set of artificial intelligence capabilities, such as generative or other AI capabilities, are integrated with other networking capabilities, such as by providing them as part of the same device or system, providing them with shared or coordinated input/output channels, providing them with coordinated access to the same data, or the like.

### Adaptive Network Capabilities

In embodiments, the adaptive networking and QoS platform includes caching of AI models for operations and use cases for various environments. In embodiments, the foregoing capabilities are enabled by adaptive networking capabilities as described in this disclosure and the documents incorporated by reference herein, such as by adapting a networking capability based on one or more of network conditions, based on a set of prioritization parameters, based on the content to be generated by a sender (e.g., an edge device) and or delivered over the network from a sender, based on the capabilities of a receiver, and/or based on the nature of usage by a receiver, among others. Such adaptive networking capabilities, based on such factors, may include, without limitation: a) adaptive selection of a networking protocol (e.g., a physical layer, transport layer, media access control layer, or other networking protocol); b) adaptive generation of content by an edge or other networking device that is capable of content generation, such as by generation of content of a suitable format, file type, size (e.g., by adaptive chunking of generative content into suitable block sizes or the like); c) adaptive storage of data on a network storage device, including caching for rapid access and/or long term storage; d) adaptive routing of network traffic, including based on QoS or channel conditions, cost of routing, and other factors; e) adaptive network coding, including setting of random linear network coding or other coding parameters; f) adaptive block sizing; g) adaptive data rate (including dynamically adjusting data rate according to a linear, convex, or concave adjustment curve); h) adaptive error correction, including adaptive setting of forward error correction parameters; i) adaptive session management, including setting timing of session initiative, termination and duration; j) adaptive and/or dynamic spectrum access management, including slicing usage available cellular or other spectrum based on any of the factors noted above; k) adaptive setting of mesh networking parameters; l) adaptive setting of software filters for repeaters, switches, routers and other software-defined transmission devices; m) adaptive configuration of mobile ad hoc network parameters; and others. Any one or more of these capabilities may be provided in an adaptive networking device or system that further includes a set of other AI capabilities, including generative AI capabilities for generation of content that is to be handled by the converged device or system.

In embodiments, the network layer 2500 may be configured to facilitate communications among smart network-capable systems, their users, and the like while leveraging AI to dynamically adapt network configurations and optimize data flow. The integration of edge computing with cloud services ensures that data processing and transaction and workflow orchestration can occur closer to the data source, reducing latency and enhancing real-time decision-making capabilities. AI algorithms may be capable of intelligently routing data (e.g., IoT data, sensor data, edge data, transaction data, behavior data, social data, web data, crowdsourced data, media data, vector data, distributed data, and the like) through the most efficient network paths, whether they be cellular, WiFi, Open Radio Access Network (ORAN), Bluetooth, IoT communication protocols, and other communication protocols. For implementation, the network modules 2502 may utilize AI for predictive network traffic management, ensuring bandwidth is allocated where it is needed most, and cryptographic techniques for securing data at the edge. AI-driven anomaly detection systems may be employed to monitor network health and preemptively address potential disruptions.

In embodiments, the network layer 2500 may provide advanced computing capabilities at the edge of the network to process and manage transactions locally to improve response times, conserve bandwidth, enhance security, and the like. The network layer 2500 may be supported by edge devices, edge data centers, edge computing platforms, and the like. In embodiments, blockchain may be used to handle distributed transactions across multiple edge devices, offering security and transparency of transactions. AI may be used at the edge to make intelligent decisions based on the data processed, which may be particularly useful for personalized user experiences.

At the network layer 2500, caching of generative AI may be used for reducing the computational resources and energy consumption required for AI workloads, benefits that may optimize down to the resource layer 2900. In implementations, caching of AI workloads may involve output caching, feature caching, model state caching, and the like. Output caching may refer to storing outputs previously generated by the AI model. For example, output caching may involve caching previously generated output. Feature caching may refer to input data that has been pre-processed and transformed into a format suitable for model training or inference. Model state caching may refer to caching the state of the model at different points during its operation. Outputs, features, model states, and the like may be stored in a readily accessible storage layer, allowing for quick retrieval of information. In implementations, caching of AI workloads at the network layer 2500 may be enabled by a cache management system.

In embodiments, network layer 2500 may provide a content delivery network (CDN) for enabling the delivery of generative AI content. The integration of generative AI with CDNs can significantly enhance the functionality of CDNs with respect to content optimization, personalization, real-time content generation, and the like. For example, generative AI models may be configured to utilize user preferences, user behavior, and others to generate personalized content in real-time at the edge and/or demographic data, location data, and others to generate targeted content in real-time at the edge. In embodiments, each CDN may be configured as a network of distributed servers that are designed to deliver content. The CDNs may support caching of generative AI content, serving cached content from edge servers closest to users. The CDNs may be configured to perform load balancing during periods of high traffic. In embodiments, the CDNs may restrict access to content based on geographic locations in compliance with state laws and regulations. In some embodiments, the CDNs may use token authentication to control access to content (e.g., validating user's request to access content based on time restrictions, IP address limitations, the number of times content can be accessed, and the like).

In embodiments, content distribution may be significantly enhanced through the use of smart network-capable devices. Smart network-capable devices may include smart sensors, smart products, connected robotics, wearables, programmable logic controllers (PLCs), 3D printers, smart conveyors, smart containers, smart shelving systems, drones, distributed energy resources (DERs), smart machines, smart cooling systems, smart point-of-sale (POS) systems, smart TVs, and smart streaming devices, among many others. In embodiments, the smart network-capable devices can leverage AI functionalities for operations by analyzing user preferences, user behavior, user interactions, historical data, and the like. In embodiments, generative AI models may modify or generate content based on viewing conditions or user feedback. For example, AI can dynamically adjust video quality based on available bandwidth. In embodiments, the smart network-capable devices may use geolocation data to enforce geographic restrictions on activities, and the like.

### AI Model-Driven Gaming Engine Edge System

In embodiments, an AI model integrated with or supporting a gaming engine or other gaming system may be integrated with edge networking capabilities, such as for caching relevant content and/or producing generative AI content relevant to efficient, localized, personalized and/or or customized digital twin, virtual reality, augmented reality, metaverse or similar content experiences. This may include various edge networking device embodiments, such as by integrating the generative AI and gaming capabilities into a network box, router, switch, edge device, IoT system, mesh networking node, networking chip or chipset, networking system on chip (SoC), FPGA, or the like. Collectively these may be referred to herein, for simplified reference, as an AI model-driven gaming engine edge system.

In embodiments, the AI model-driven gaming engine edge system may be integrated with financial infrastructure systems, such as to enable embedded marketplaces and transactions, as described elsewhere in this disclosure and the documents incorporated by reference herein.

In embodiments, the AI model-driven gaming engine edge system may be configured to integrate with data handling systems that are capable of sensor and data fusion, i.e., receiving and processing content that provides an understanding of the context in which the information handled by the AI model-driven gaming engine edge system is used. This may include sensor data that provides information about a set of users (e.g., data detected from wearable devices or physiological data, data from IoT devices or cameras indicating information about the user or the user's environment, or the like); behavioral data about the user (e.g., clickstream data indicating the user's navigation patterns, transactional data, user purchases of content or other items, and other sources); demographic, psychographic and geographic data about populations users (including as determined by various similarity and clustering algorithms) and the like; and/or user-generated content data, including explicit indications of preferences, such as ratings, collaborative filtering and surveys and indirect indications, such as tastes, preferences and styles indicated by user-generated content, such as social media content (e.g., showing a style of dress or preference for a genre of music or content), written content, such as reflecting interests in particular content and/or indicators of user personality, and user interaction content, such as user interactions within interactive game play (e.g., user dialog, navigation and other choices), with digital twins, and/or within virtual reality, augmented reality and/or metaverse environments. In embodiments, data and sensor fusion provide a holistic understanding of user content that can be used to train AI models (either at the edge or in the cloud) to have an accurate understanding of a user's position, duties, status, condition, preferences, personality, or the like. Once trained, the AI models can be deployed in the AI model-driven gaming engine edge system to generate content that is highly tuned to the context and preferences of the user.

In embodiments, the AI model-driven gaming engine edge system may be configured and trained to understand a user profile across different platforms, such as traditional linear media, enterprise platforms, entertainment platforms (e.g., music, film, television, streaming, and the like), and/or interactive platforms (e.g., sports betting, gaming, digital twin, social media, metaverse, virtual reality, augmented reality, and many others). Once the profile is understood, a resulting set of models may be deployed in the AI model-driven gaming engine edge system to provide highly tuned content and experiences to the user across all such channels. Such AI models may include long-term models that provide a general understanding of stable characteristics of the user (e.g., personality, long-term interests, relationships with other users, affinity for subjects, relationships with organizations) and short-term models that provide an understanding of immediate context and interests (e.g., content that is highly relevant to the user's current location).

In embodiments, different forms of content may be cached for efficient delivery to the user at the AI model-driven gaming engine edge system, and they may be presented in a set of integrated content-access interfaces that make different content forms available. As an understanding of an individual user (stable/long-term and/or immediate/contextual) is embedded in a set of AI models as noted above (aided by data and sensor fusion), that understanding can be linked to suites of content of any and all types, which can be gathered and cached by the AI model-driven gaming engine edge system and used to organize suites of content for presentation to the user, either in a unified “home screen” type interface or in forms where links to any one type of content are embedded into the other forms of content. Once content is gathered, it may be used both to configure content offerings and to generate, locally at the AI model-driven gaming engine edge system, generative content, such as text, images, videos, audio, offers, promotions, and many others. The AI model-driven gaming edge system may thus serve as an important enabling component for a broader platform as described herein that links various multiplatform content experiences, models that are trained on a holistic understanding of the user, including based on cross-platform interactions, are deployed at the edge to configure offerings and to generate relevant content for the user.

As implied by the above, the AI model-driven gaming engine edge system may include a set of distinct models, a set of hybrid models, or the like. For example, one AI model (or component) may be used to understand a long-term profile of a user, another AI model may be used to understand a short-term context of a user, another AI model may be used to discover, gather and/or configure a set of content for the user, other models may be used to generate highly personalized or customized generative content (such as involving text, voice, music, images, videos, offers, promotions, or mixed modes of the above), and other models may be used to resolve transactions. In one such configuration, a set of models is used to predict a set of immediate preferences of the user and another set of models is used to generate a configuration of content or other content that is designed to satisfy those preferences.

In embodiments, an instance of an AI model-driven gaming engine edge system may be configured, provisioned and deployed for a single specific user, a defined set of similar users, or a defined specific group of users (such as a family or workgroup). The system may then be trained over time to learn the profile of the user or set, to gather and configure content and other content, and/or to generate highly relevant generative works.

In embodiments, the AI model-driven gaming engine edge may be trained to learn the personality of a user by observation of the user's cross-platform behavior (including various aspects noted in the discussion of sensor and data fusion above). By observing behavior (e.g., by machine vision), transactions, content consumption, interactions, and generated content, as well as by driving interactions that are designed to elicit indicators of personality (such as collaborative filtering, surveys and dialog), the AI model can classify the user according to psychometric or neurometric measures of personality (e.g., a Jungian, Myers-Briggs, or Keirsey Temperament type, other the like). These can be augmented by other indicators, such as social media and writing content by the individual, content preferences, and the like. With an understanding of personality embedded into an AI model, the personality can be used as an input to a content discovery and/or configuration system and/or a generative AI system to produce content that is appealing to the personality.

By integrating these technical features, the network layer 2500 is capable of supporting the complex networking requirements of various operational environments.

### Data Layer

In embodiments, an artificial intelligence-enabled system of systems can have a data layer system of systems, a set of machine learning systems, a set of artificial intelligence systems, and/or a set of neural networks configured to operate on fused data that can be the output of a sensor and/or data fusion system.

In embodiments, the data layer system of systems having a set of machine learning systems, a set of artificial intelligence systems, and/or a set of neural networks can be configured to operate on fused data that can include sensor data.

In embodiments, the data layer system of systems having a set of machine learning systems, a set of artificial intelligence systems, and/or a set of neural networks can be configured to operate on fused data that can include wearable device data.

In embodiments, the data layer system of systems having a set of machine learning systems, a set of artificial intelligence systems, and/or a set of neural networks can be configured to operate on fused data that can include social media data.

In embodiments, the data layer system of systems having a set of machine learning systems, a set of artificial intelligence systems, and/or a set of neural networks can be configured to operate on fused data that can include crowdsourced data.

In embodiments, the data layer system of systems having a set of machine learning systems, a set of artificial intelligence systems, and/or a set of neural networks can be configured to operate on fused data that can include website data.

In embodiments, the data layer system of systems having a set of machine learning systems, a set of artificial intelligence systems, and/or a set of neural networks can be configured to operate on fused data that can include distributed data.

In embodiments, the data layer system of systems having a set of machine learning systems, a set of artificial intelligence systems, and/or a set of neural networks can be configured to operate on fused data that can include API data.

In embodiments, the data layer system of systems having a set of machine learning systems, a set of artificial intelligence systems, and/or a set of neural networks can be configured to operate on fused data that can include edge data.

In embodiments, the data layer system of systems having a set of machine learning systems, a set of artificial intelligence systems, and/or a set of neural networks can be configured to operate on fused data that can include mobile data collector data.

In embodiments, the data layer system of systems having a set of machine learning systems, a set of artificial intelligence systems, and/or a set of neural networks can be configured to operate on fused data that can include industrial data.

In embodiments, the data layer system of systems having a set of machine learning systems, a set of artificial intelligence systems, and/or a set of neural networks can be configured to operate on fused data that can include transactional data.

In embodiments, the data layer system of systems having a set of machine learning systems, a set of artificial intelligence systems, and/or a set of neural networks can be configured to operate on fused data that can include transportation data.

In embodiments, the data layer system of systems having a set of machine learning systems, a set of artificial intelligence systems, and/or a set of neural networks can be configured to operate on fused data that can include value chain network data.

In embodiments, the data layer system of systems having a set of machine learning systems, a set of artificial intelligence systems, and/or a set of neural networks can be configured to operate on fused data that can include supply chain data.

In embodiments, the data layer system of systems having a set of machine learning systems, a set of artificial intelligence systems, and/or a set of neural networks can be configured to operate on fused data that can include demand data.

In embodiments, the data layer system of systems having a set of machine learning systems, a set of artificial intelligence systems, and/or a set of neural networks can be configured to operate on fused data that can include shipping data.

In embodiments, the data layer system of systems having a set of machine learning systems, a set of artificial intelligence systems, and/or a set of neural networks can be configured to operate on fused data that can include energy data.

In embodiments, the data layer system of systems having a set of machine learning systems, a set of artificial intelligence systems, and/or a set of neural networks can be configured to operate on fused data that can include enterprise data.

In embodiments, the data layer system of systems having a set of machine learning systems, a set of artificial intelligence systems, and/or a set of neural networks can be configured to operate on fused data that can include public data.

In embodiments, the data layer system of systems having a set of machine learning systems, a set of artificial intelligence systems, and/or a set of neural networks can be configured to operate on fused data that can include market data.

In embodiments, the data layer system of systems having a set of machine learning systems, a set of artificial intelligence systems, and/or a set of neural networks can be configured to operate on fused data that can include news data.

In embodiments, the data layer system of systems having a set of machine learning systems, a set of artificial intelligence systems, and/or a set of neural networks can be configured to operate on fused data that can include weather data.

In embodiments, the data layer system of systems having a set of machine learning systems, a set of artificial intelligence systems, and/or a set of neural networks can be configured to operate on fused data that can include contextual data.

In embodiments, the data layer system of systems having a set of machine learning systems, a set of artificial intelligence systems, and/or a set of neural networks can be configured to operate on fused data that can include health data.

In embodiments, the data layer system of systems having a set of machine learning systems, a set of artificial intelligence systems, and/or a set of neural networks can be configured to operate on fused data that can include demographic data.

In embodiments, the data layer system of systems having a set of machine learning systems, a set of artificial intelligence systems, and/or a set of neural networks can be configured to operate on fused data that can include insurance data.

In embodiments, the data layer system of systems having a set of machine learning systems, a set of artificial intelligence systems, and/or a set of neural networks can be configured to operate on fused data that can include simulation data.

In embodiments, the data layer system of systems having a set of machine learning systems, a set of artificial intelligence systems, and/or a set of neural networks can be configured to operate on fused data that can include experimental data.

In embodiments, the data layer system of systems having a set of machine learning systems, a set of artificial intelligence systems, and/or a set of neural networks can be configured to operate on fused data that can include synthetic data.

In embodiments, the data layer system of systems having a set of machine learning systems, a set of artificial intelligence systems, and/or a set of neural networks can be configured to operate on fused data that can include echoed data.

In embodiments, the data layer system of systems having a set of machine learning systems, a set of artificial intelligence systems, and/or a set of neural networks can be configured to operate on fused data that can include communication data.

In embodiments, the data layer system of systems having a set of machine learning systems, a set of artificial intelligence systems, and/or a set of neural networks can be configured to operate on fused data that can include behavioral data.

In embodiments, the data layer system of systems having a set of machine learning systems, a set of artificial intelligence systems, and/or a set of neural networks can be configured to operate on fused data that can include location data.

In embodiments, the data layer system of systems having a set of machine learning systems, a set of artificial intelligence systems, and/or a set of neural networks can be configured to operate on fused data that can include pricing data.

In embodiments, the data layer system of systems having a set of machine learning systems, a set of artificial intelligence systems, and/or a set of neural networks can be configured to operate on fused data that can include sales data.

In embodiments, the data layer system of systems having a set of machine learning systems, a set of artificial intelligence systems, and/or a set of neural networks can be configured to operate on fused data that can include tax data.

In embodiments, the data layer system of systems having a set of machine learning systems, a set of artificial intelligence systems, and/or a set of neural networks can be configured to operate on fused data that can include historical data.

In embodiments, the data layer system of systems having a set of machine learning systems, a set of artificial intelligence systems, and/or a set of neural networks can be configured to operate on fused data that can include physiological data.

In embodiments, the data layer system of systems having a set of machine learning systems, a set of artificial intelligence systems, and/or a set of neural networks can be configured to operate on fused data that can include environmental data.

In embodiments, the data layer system of systems having a set of machine learning systems, a set of artificial intelligence systems, and/or a set of neural networks can be configured to operate on fused data that can include key performance indicator (KPI) data.

In embodiments, an artificial intelligence-enabled system of systems 1900 can have a data layer 2600. With continuing reference to FIG. 24, the data layer 2600 can incorporate data modules 2602. The data layer 2600 can cooperate with a set of machine learning systems 2604, a set of artificial intelligence systems 2606, and/or a set of neural networks 2608 configured to operate on fused data 2610. By way of these examples, the fused data 2610 can be formed from the output of a sensor 2612 and/or a data fusion system 2614 each of which can be associated with one or more data sources 2696. The one or more data sources 2696 can include sensor data 2616, wearable device data 2618, social media data 2620, crowdsourced data 2622, website data 2624, and distributed data 2626. The one or more data sources 2696 can also include API data 2628 that can be accessed through various APIs at 2700 in FIG. 25. With continuing reference to FIG. 24, the one or more data sources 2696 can also include edge data 2630, mobile data collector data 2632, and industrial data 2634. In further examples, one or more data sources 2696 can include transactional data 2636 in a financial infrastructure environment. In additional examples, one or more data sources 2696 can include transportation data 2638, which can be used to support transportation systems, self-driving vehicles, software-defined vehicles, and software-enabled vehicles. In yet more examples, one or more data sources 2696 can include value chain network data 2640, supply chain data 2642, demand data 2644, and/or shipping data 2646, which can be used to further the understanding of entity demand and supply management. In additional examples, one or more data sources 2696 can include energy data 2648, which can be used to further facilitate energy delivery, compute power, and data management at various edge applications. In further examples, one or more data sources 2696 can include enterprise data 2650, public data 2652, market data 2654, news data 2656, and weather data 2658. In additional examples, one or more data sources 2696 can include contextual data 2660 in various settings. In yet further examples, one or more data sources 2696 can include health data 2662 in support of various digital health and healthcare platforms. In additional examples, one or more data sources 2696 can include demographic data 2664, insurance data 2666, simulation data 2668, experimental data 2670, synthetic data 2672, echoed data 2674, communication data 2676, behavioral data 2678, location data 2680, pricing data 2682, sales data 2684, tax data 2686, historical data 2688, physiological data 2690, environmental data 2692, and key performance indicator data 2694.

FIG. 25 depicts additional exemplary features, capabilities, and interfaces of exemplary embodiments of a data layer 2600. In embodiments, the API data 2628 can be accessed by multiple APIs at 2700. By way of these examples, the APIs at 2700 can include one each of an ingestion 2702, parse 2704, analyze 2705, and elements that can be interconnected for providing intelligence-based and other derivatives of data sources, such as the multitude of data sources 2696. These elements may be controlled, configured and adjusted by a data layer control 2706.

In embodiments, data sources may be retrieved and/or received through the APIs 2700. In embodiments, the APIs may be an open/standardized APIs that, among other things, may equip the data layer 2600 for integration with and into current and emerging ecosystems. By way of these examples, APIs can further enable data layers to integrate into a wide range of data workflows and access the API data 2628 and various data sources 2696, such as corporate internal workflows, metadata for visual content, source data, inter-jurisdiction data workflows, digital rights management and the like.

In embodiments, the data layer 2600 can include, reference, and/or provide market orchestration elements 2708 that may facilitate use of data layer capabilities for various aspects of market orchestration, including, without limitations, software orchestrated transactions, software orchestrated marketplaces, and the like. Market orchestration elements 2708 may facilitate deployment of a data layer, such as a web service embodiment, as an integrated function of a market orchestration platform, such as an automated market orchestration system of systems as described herein. In embodiments, the data layer 2600 may provide data and network pipeline capabilities for market orchestration.

The data layer 2600 can include, reference and/or provide cross-market interaction capabilities 2710 that may enable leveraging various types of intelligence data layer, computation capabilities, and storage and data sourcing capabilities, as well as intelligence capabilities for cross-market interactions. Cross-market interaction capabilities 2710 may include interfaces to one or more marketplaces, transaction environments, and the like, so that, among other things, a data layer supportive of a system of systems (SoSs) may be configured with one market in a cross-market integration deployment as a source of data and with another market in the cross-market integration deployment as a consumer of the data layer. In embodiments, a similar arrangement may be constructed between two or more markets so that data in either market can be used as one or more data sources and can be influenced by data from another market. By way of these examples, cross-market interactions may be accomplished through one or more market-to-market data layers that form data pipelines for intelligent exchange of data among markets, such as data about buyers in one market and about sellers in another.

The data layer 2600 can include functions and processes 2712, for an exemplary market-oriented deployment may include software-oriented transaction functions and processes, automatic transaction transactions and processes, and the like. Functions and processes 2712 for the data layer 2600 may include signaling availability of data (e.g., emergence of an occurrence of source data) that impacts data produced by the data layer of the platform. Other exemplary functions and processes 2712 may include embedding into smart contracts, tokens, or other occurrence (e.g., an initiation of a smart contract and the like). Yet other functions and processes may include payments between/among machines and the like.

In embodiments, the data layer 2600 may include and/or be associated with data layer technology enablers 2714, such as 5G networking, artificial intelligence, visualization technology (e.g., VR/AR/XR), distributed ledger, and the like.

In embodiments, the data layer 2600 can include and/or leverage cloud-based virtualized container 2716 capabilities and services, such as without limitation a container deployment and operation controller, such as Kubernetes 2718 and the like. Cloud-based virtualized containers 2716 provide for data layers to be deployed close to source data, thereby potentially reducing network bandwidth consumption or the potential for network disturbances in a data workflow, especially when addressing voluminous local situations such as in industrial and commercial environments.

In embodiments, technologies may be provided by and/or enabled by the data layer 2600 include intelligence services 2720, such as artificial intelligence, machine learning and the like. These intelligence services 2720 may be provided by the data layer 2600, or accessed (e.g., as third-party services) via one or more. The data layer control 2706 may be provided access to the intelligence services 2720. In embodiments, the data layer control 2706 may provide its own set of intelligence services.

In embodiments, the data layer 2600 may include transaction/market-oriented capabilities, and services that may include market platforms 2722, transaction flows 2723, users 2724, and content providers 2726. For multi-party transaction environments, the data layer 2600 may be configured and operated to satisfy a range of consumer needs for market analysis, transaction efficiencies, cost containment, buy/sell decisions and the like.

In embodiments, the data layer 2600 may include an exemplary intelligent data layer architecture 2800, as depicted in FIG. 26. The exemplary intelligent data layer architecture 2800 can include a controlled pipeline of data processing stages that process data from one of multiple data sources 2802. The controlled pipeline includes an ingestion stage 2804, an analysis stage 2806, a derived intelligence stage 2808, and a consumer visualization portal 2810. By way of these examples, the ingestion stage 2804 can receive and/or harvest data from one or more of the plurality of sources 2802. Processing at the ingestion stage 2804 may include parsing content of data sources, such as to determine structure, content, relationships among data elements, intended meaning of the data elements, relationships between data, structure, and meaning, and the like. In embodiments, an ingestion facility that may operate at the ingestion stage 2804 may be configured to be aware of data source aspects, such as structure, etc. Ingestion stage 2804 may be configured or adjusted by an operator of the layer, a platform controller, the data layer control 2706, and the like. Configuration of the ingestion stage 2804 may be based on one or more data structures that represent aspects of one or more of the data sources 2802. One such aspect is a location of the data source, such as an Internet or other type of address (e.g., URL, port number, stream identifier, publication and/or broad channel, sensor output location, and the like) from which data may be accessed, queried, pulled, downloaded, streamed or otherwise accessed. Further aspects of a data source may include interface methods and/or protocols, such as through data transfer handshakes, Internet Protocols, and/or query languages. Data block size, access rate (e.g., maximum, frequency, or other timing-related parameter related to accessing the data source), and the like may also be adjusted or configured. Yet other aspects of data source 2802 and the data layer architecture 2800 may include one or more meanings of data from the data source, such as may be represented through a data source ontology and the like. Information such as units, scalars and the like for numerical values may be provided. In an example of data sources providing measurement data, a first source may provide numerical values in inches, a second source may provide values in meters, and a third source may provide values in light years. This local data source context may prove useful for relating data sources. In an example of data sources providing reputation rating values, an ontology for each source that establishes a minimum value, maximum value, and adjustable increments between the two provide a way of establishing meaning of a data element from such a source.

In further examples, the data sources may impose or be arranged with a geometry/structure that may imbue meaning on data values, relationships among data values, and the like. Exemplary embodiments of structures that can impact the meaning and relationships of data value from a data source can be a hierarchical arrangement of the data.

In embodiments, the data layer 2600 can be configured to receive/retrieve and process data that is configured as a hierarchy and can be configured to assign a relationship attribute to a pair of data values that are configured as parent/child in the hierarchy. Likewise, a rule that may be applied in the hierarchy, such as certain types of changes to a parent data value impacting a corresponding child data value establish an immutable relationship between the data values as they are processed through the ingestion processing pipeline (e.g., ingestion, analysis, and intelligence).

In embodiments, automation can be introduced through programmatic configuration of data values in an ingestion stage execution data structure. These data values may be retrieved from, for example, an ingestion parameter portion of a data layer control data store 2812. Machine learning may facilitate training an artificial intelligence system to identify aspects of a data source that are relevant for configuring the ingestion stage 2804 to receive and process its data.

In embodiments, the data layer control 2706 may develop an understanding of data sources, such as meaning of data values. In embodiments, developing an understanding may be in context of an expected use of data from one or more data sources, such as use of the data for determining a status of a term of a smart contract, a result of a software orchestrated transaction, and the like. Further data from data sources may be understood within a context of other data sources. In an example of such understanding, a plurality of marketplace monitors may capture data regarding activity within a marketplace.

In embodiments, the data layer control 2706 may further be configured to maintain a schedule of collection activity for one or more of the data sources 2696. A collection schedule may be one of a plurality of aspects associated with ingestion that may be influenced by data sources and by data layer pipeline processing needs (e.g., to satisfy needs of a user of the data layer). Such a collection schedule may be based on a rate or occurrence of availability of new or revised data from a source. In embodiments, some data sources may produce new/updated data on a schedule determined from activities associated with the data source, such as a sample schedule of the sensor 2612, the data fusion system 2614, and the like. In an example, a rule for a system that produces data available through a data source may limit data releases periodically (e.g., such as at the end of a work shift, once per day, and the like). In another example of data source-dependent collection activity may be motivated by events, such as completion of marketplace transactions and the like. In embodiments, the data layer control 2706 may monitor a port on a data network for an indication of data availability at a data source. When an indication is detected (e.g., a change in a data value of the port), an ingestion process may commence.

By way of these examples, other information of processes related to ingestion may include costs, such as costs to perform data source access, ingestion processing and the like. Cost for data collection may include access fees charged by a data source (e.g., subscription costs, access event costs, demand-based costs, and the like). Costs for data collection may be based at least in part on an amount that a consumer (e.g., a user of capabilities and output from a data layer) pays for access to information produced by the data layer that is based at least in part on data from the data source. By way of these examples, there may be a range of cost structures for source data access, at least some of which may be based on data source reputation, relevance of data from the data source, timeliness of updates of the data from the data source, and the like. In embodiments, a data layer may access data from a data source and utilize it a plurality of times to produce layer intelligence for a plurality of users of the data layer. Costs for access and for the occurrences of use of the accessed data may be different from each other, such as a cost to access may be a multiple of (e.g., 2-time, 10-times and the like) of a cost for each subsequent occurrence of use of the accessed data.

In embodiments, the data layer 2600 may be configured as a producer of source data, so that a corresponding ingestion facility may be owned (and optionally operated) by the data producer. In an example of data source closely held within the data layer 2600, a data source may retain privacy of its source data by exposing, such as through publication and the like, an output of the owned data, which may include information derived from the source data or select portions of the source data, such as non-confidential information associated with marketplace transactions and the like.

In embodiments, further operation of the data layer architecture 2800 can include ingestion operation that may also be based on a method of data collection. In embodiments, the data sources 2802 may be part of a data supply chain. Exemplary embodiments of a data supply chain may include a physical chain, such as may be embodied by a set of physical sensors (e.g., industrial internet of things sensors) that capture physical activity (e.g., of an industrial machine, and the like) and provide a representation of that activity as a form of data. A physical connection, such as a set of networked devices (e.g., the Internet), may convey the representation of the activity produced by the sensor(s) to, for example, a physical access port (e.g., a networked computer and the like) from which a data layer may ingest this data. Other types of data collection may include logical supply chains, such as data marts, data marketplaces, aggregated data publishers, and the like. In embodiments, data representative of a physical activity, such as a production machine in an enterprise, may be provided through a physical interface that presents the data from a corresponding sensor as it changes in near real time. That same data may be provided through a logical interface, such as a data base that facilitates access to a plurality of values of data from the sensor, optionally with a capture time, capture sequence and the like to enable batched or delayed use of data from the data source.

In embodiments, the data layer control 2706 may execute in virtual containers on, for example, cloud computing systems that are distinct from a physical embodiment of the data layer control 2706.

In embodiments, the data layer architecture 2800 may include the analyze stage 2806 that may receive data from the ingestion stage 2804. The analyze stage 2806 may receive raw ingestion data, adapted ingestion data (e.g., contextually adjusted), data derived from ingestion data (e.g., differences between sequential accesses of a single data source), metadata associated with the ingestion data (e.g., validity window, units, access costs, and the like), and the like.

In embodiments, the analyze stage 2806 may perform various operations on ingestion stage parsing and other ingestion activity results based on a range of factors, such as comparing data from a plurality of sources for similarity, fitness to a purpose, differences, based on types of data within or across data sources and the like. In embodiments, analysis may include comparing sources against a target use of intelligence derived from a data source. Analysis of ingestion results may attempt to determine if one or more data elements from a data source may meet consumption target requirements, such as meeting a validity time constraint, an accuracy constraint, a frequency of update constraint, relevance to a consumption subject matter focus, and the like. In embodiments, a data layer may target providing intelligence for buyers of services in a software orchestrated transaction marketplace. The data layer architecture 2800 may include functionality to publish or otherwise convey requests for data, such as types of data, and the like that one or more data sources may attempt to meet. The data layer control 2706 may determine if ingested data meets requirements of the published request for data, such as if the data complies with one or more parameters in the request.

In embodiments, the data layer control 2706 may facilitate configuring data in the layer for publication, such as configuring one or more advertisements that characterize the ingested data in terms of potential intelligence value, relevance and the like. Examples include making data, such as derived intelligence data available on a marketplace (e.g., configuring indexing schemes and the like), making the content searchable (e.g., identifying keywords, terms, values, or the like that may facilitate discovery of intelligence derived from the ingested data through use of a search capability. The data layer control 2706 may facilitate access visibility to information of the data layer by publishing, communicating, or broadcasting samples of the data over a network, directly to potential consumers and the like.

In embodiments, the analyze stage 2806 may suggest, predict, and/or estimate value of data for a plurality of different consumers. These estimates may be used by the data layer control to impact intelligent data layer functions, such as data layer intelligence pricing and the like that may be differentiated for different users. Further, such analysis may indicate that intelligence derived from a first data source may be more or less valuable to different target consumers.

In embodiments, the data layer control 2706 may use feedback from intelligent data layer users regarding, among other things, usefulness of intelligence derived from one or more data sources 2802 to facilitate ingestion and analysis activities and the like. In an example, positive feedback on intelligence derived from a data source may result in the data layer control 2706 to make use of the data source for deriving other types of intelligence and the like.

In embodiments, the data layer control 2706 may ingest data from a plurality of data sources; each such set of data may be individually analyzed. In embodiments, data from a plurality of data sources may be parsed, so that data with similar characteristics (e.g., data that is indicative of a buyer reputation) may be aggregated and analyzed. Examples of multiple data sources that may provide data with similar characteristics include mobile devices, types of sensors, media-focused transaction systems (e.g., content buying, advertising placement, rights management and the like). As noted above, the data layer control 2706 may communicate configuration data (e.g., sets of data that enable the analyze stage 2806 to perform various analysis functions). In embodiments, the data layer control 2706 may provide a set of analysis algorithms that may execute on one or more processors.

In embodiments, the data layer architecture 2800 may include the intelligence stage 2808. By way of many examples, an intelligence stage 2808 may utilize artificial intelligence capabilities to develop an understanding about data sources including, among things, uses of data, values of data, applicability of data, collection patterns and relevance to intelligence consumption and the like. Additional intelligence that may be derived by intelligence stage may include, without limitation, layer specific data relevance, relevance of data from one layer to another, value of intelligence to a consumer, such as to a transactor. By way of many examples, intelligence stage may derive intelligence useful for forming new marketplaces from transactional data gathered from an existing marketplace.

In embodiments, the data layer architecture 2800 may include a consumer visualization portal 2810 that may communicate with elements of the data layer pipeline, such as the intelligence stage 2808 from which the consumer visualization portal may receive derived intelligence. In embodiments, the consumer visualization portal 2810 may facilitate access to derived intelligence (and optionally to other data of the data layer architecture 2800). The consumer visualization portal may announce availability of derived intelligence to a preconfigured set of consumers and candidate consumers through use of a messaging channel (e.g., SMS messaging and the like). The consumer visualization portal may announce derived intelligence through various other techniques including, broadcasting across one or more communication channels (e.g., TWITTER™, X™, and the like). The consumer visualization portal may deliver at least select derived intelligence to intelligent data layer consumers based on a subscription or similar arrangement between the consumer(s) and the data layer. In embodiments, the consumer visualization portal may reference publication configuration data that may identify which consumers are to receive which portion(s) of intelligence derived from which data source and cause the derived intelligence to be provided to (and/or made available to) one or more consumers based on this intelligence publication data. The consumer visualization portal may also communicate with the data layer control 2706, such as to receive configuration, access intelligence data, analyzed data, ingested data and the like.

In embodiments, the consumer visualization portal 2810 may further receive from one or more data layer data consumers, consumer preferences for interfacing with the consumer, requests for updates to previously communicated derived intelligence data, requests for onboarding, feedback on uses of derived intelligence data and the like. In embodiments, a consumer may communicate a derived intelligence delivery schedule to the consumer visualization portal where it may be combined with other intelligence delivery data, such as other consumer delivery schedules, and the like and utilized by the consumer visualization portal and/or the data layer control when performing derived intelligence delivery and communication functions.

In embodiments, the data layer control 2706 may provide configuration, control, storage, and processing capabilities, such as for providing access to algorithms from an algorithm portal 2814, facilitating access by the data layer control 2706 to intelligence services 2816, managing storage of a data store, managing storage of intelligent data layer ingestion data and outcomes, analysis outcomes, derived intelligence and the like in a data store 2812, and without limitation providing a mechanism by which a user, such as an owner and/or operator of the data layer architecture 2800 can configure and otherwise interface with system of the data layer 2600.

In another exemplary embodiment, the data layer control 2706 may facilitate access to analysis algorithms by the analyze stage 2806. Further the data layer control 2706 may work cooperatively with an algorithm portal 2814 to receive algorithms for analysis, ingestion, deriving intelligence, and the like. By way of many examples, the data layer control 2706 and the data source 2696 may identify and/or provide one or more ingestion algorithms for performing ingestion actions on data provided. The algorithm may be provided through the algorithm portal 2814 received and optionally vetted by the data layer control 2706 and stored in the data store 2812. In another exemplary embodiment of use of the algorithm portal 2814, a consumer may provide an algorithm for deriving intelligence from data under the consumer's control, such as in a marketplace transaction environment in which a seller provides transaction data as a source of data to the data layer for processing, optionally with other relevant data, for deriving intelligence associated with seller marketplace activities. In embodiments, deployment of a data layer as part of a data workflow for an enterprise may involve adapting existing workflow steps with intelligent data layer capabilities. By way of many examples, a purchasing department of an enterprise may have a set of algorithms that are used to process sales forecast data for generating purchasing guidelines. A data layer may be constructed for the enterprise that produces intelligence regarding the generated purchasing guidelines by utilizing sales forecast processing algorithms that have been uploaded through, for example, the algorithm portal 2814.

In embodiments, the intelligence services 2816 may include a range of intelligence functions and capabilities including, without limitation artificial intelligence functions, machine learning functions, neural network functions, prediction capabilities, and many others. In an example of intelligence services 2816 for the data layer 2600, an ingestion stage 2804 may provide data from the data sources 2802, along with associated descriptive information (e.g., metadata, structural data, ontology data and the like) to a self-learning neural network capability of the intelligence services 2816 to aid in determining an approach to parsing the data source.

In embodiments, the intelligence services 2816 may further have access to subject matter associated intelligence, such as cross-market intelligence gathered through processing, optionally external to the data layer architecture 2800, marketplace configuration, operational, and transaction outcomes for different sets of cross-market offerings. By way of further examples using intelligence services for ingestion, this subject matter intelligence can be applied when a data source is determined to be related to a product or other offering that is similar to products or offerings on which the subject matter intelligence is based. In such instances when a source of data relates to a product (e.g., mobile device) and subject matter intelligence known to the intelligence services 2816 is based on or associated with mobile device technology, the corresponding intelligence services may be utilized for enhancing/optimizing pipeline operations being performed on the source data.

In embodiments, the exemplary data layer architecture 2800 can include a user interface 2818 through which a user, such as an operator and the like, may interface with systems of the data layer and the like (e.g., query and maintain data in the data layer data store 2812). The user interface 2818 may facilitate configuring portions of the data layer, such as the algorithm portal, data retention rules for accessed by the data layer control 2706, prioritization of use of the data layer resources by data consumers, and the like.

The data layer 2600 may serve as a flexible and scalable infrastructure designed to enable the seamless integration, ingestion, and analysis of data from an extensive range of sources positioned within the artificial intelligence convergence system of systems 1900. The data layer 2600 can be positioned within the multi-layered architectures artificial intelligence convergence system of systems 1900 and can support the generation of actionable intelligence and foster integration across diverse ecosystems. The data layer 2600 supports a modular design to support corporate operations, market orchestration, and cross-functional workflows, as these systems of systems become important for organizations navigating both established and emerging technologies.

Sensor data 2616 may include real-time readings from devices monitoring environmental, industrial, or physical conditions. These sensors can provide valuable inputs for applications such as manufacturing quality control, environmental monitoring, and smart city management. For example, in an industrial setting, sensors might monitor machinery vibrations to predict maintenance needs. In environmental monitoring, air quality sensors may track pollution levels, enabling responsive public health measures. The data layer system of systems may process such high-frequency inputs, ensuring timely integration into decision-making frameworks.

Wearable devices may generate diverse datasets of Wearable Device Data 2618 ranging from health metrics, such as heart rate and activity levels, to geolocation tracking. These devices often serve applications in healthcare, fitness, and workforce management. A healthcare provider, for instance, might leverage wearable data to monitor chronic conditions and deliver personalized care plans. The data layer system of systems can analyze this data in real-time, identifying trends and generating predictive insights to improve health outcomes.

Social media platforms may produce vast volumes of unstructured and structured social media data 2620, including text, images, and videos. Businesses can use this data to gauge public sentiment, analyze trends, and optimize marketing strategies. For instance, a retail brand might monitor customer feedback on social platforms to refine its offerings. The data layer system of systems may enable sentiment analysis and predictive modeling to help businesses adapt to market demands effectively.

Crowdsourced data 2622 may encompass information contributed by a distributed network of individuals, such as reviews, surveys, and collaborative maps. This data can be crucial for applications requiring diverse perspectives, such as urban planning or product development. For example, transportation authorities might use crowdsourced traffic reports to optimize routes and reduce congestion. The data layer system of systems can aggregate and contextualize such data to provide actionable insights.

Website data 2624 may include user interactions, clickstreams, and behavioral patterns. This data is invaluable for e-commerce, digital marketing, and user experience optimization. For instance, an online retailer might analyze browsing habits to recommend products, enhancing customer satisfaction and sales. The data layer system of systems can process large volumes of web traffic data, while its intelligence services may identify patterns to improve user engagement.

Distributed data 2626 may refer to datasets stored across multiple locations, such as cloud services or decentralized networks. This type of data is essential for global enterprises and blockchain applications. For example, a supply chain management system might rely on distributed data to track goods across international borders. The data layer system of systems may harmonize distributed datasets, ensuring consistency and enabling comprehensive analysis.

API data 2628 may provide programmatic access to external systems, enabling the integration of third-party services and real-time data retrieval. Applications may include weather forecasting, financial market analysis, and social media monitoring. For example, a fintech platform might use API data to retrieve real-time stock prices and integrate them into portfolio management tools. The data layer system of systems may seamlessly ingest and process API data, supporting dynamic and responsive applications.

Edge data 2630 may originate from devices operating at the periphery of a network, such as IoT devices in remote locations. This data is often used in scenarios requiring low-latency processing, such as autonomous vehicles or industrial automation. For instance, edge devices in a factory might monitor production line conditions and trigger immediate adjustments. The data layer system of systems may process edge data locally or in the cloud, enabling rapid responses and enhanced operational efficiency.

Mobile data collectors may gather information from field operations, such as surveys, inspections, or environmental sampling. This mobile data collector data 2632 is vital for industries like agriculture, construction, and utilities. For example, agricultural researchers might use mobile devices to record soil conditions and crop health. The data layer system of systems may aggregate and analyze this data, providing actionable insights for field operations.

Industrial data 2634 may encompass metrics from manufacturing processes, such as temperature, pressure, and production rates. This data is critical for optimizing operations, ensuring quality, and predicting maintenance needs. For instance, a factory might use the data layer system of systems to monitor and analyze machine performance, reducing downtime and improving efficiency.

Transactional data 2636 may include records of financial or operational exchanges, such as purchases, sales, or payments. This data is foundational for industries like retail, finance, and logistics. A retail chain might use the data layer system of systems to analyze point-of-sale transactions, identifying trends and informing inventory strategies.

Transportation data 2638 may include vehicle telemetry, traffic patterns, and logistics tracking. This data is essential for optimizing supply chains and improving urban mobility. For example, a logistics provider might analyze transportation data to reduce delivery times and fuel consumption. The data layer system of systems may process this data in real-time, enhancing decision-making capabilities.

Value chain network data 2640 may map relationships and dependencies across suppliers, manufacturers, and distributors. This data can support strategic planning and risk management. For instance, a manufacturer might use the data layer system of systems to visualize its supply chain and identify bottlenecks, improving overall efficiency.

Supply chain data 2642 may track the movement of goods, inventory levels, and supplier performance. This data is critical for ensuring timely deliveries and managing costs. A retailer might use the data layer system of systems to monitor supply chain performance and predict potential disruptions, enabling proactive measures.

Demand data 2644 may capture customer preferences, market trends, and purchasing patterns. This data is vital for forecasting and aligning production with market needs. A consumer goods company might use the data layer system of systems to analyze demand data, optimizing product availability and marketing strategies.

Shipping data 2646 may include information about freight movements, carrier performance, and delivery timelines. This data is crucial for logistics and e-commerce. For instance, an online retailer might use the data layer system of systems to track shipments and provide real-time updates to customers.

Energy data 2648 may capture metrics from utilities, such as consumption rates, production levels, and grid performance. This data supports sustainability initiatives and operational efficiency. A smart grid operator might use the data layer system of systems to balance supply and demand, reducing energy waste.

Enterprise data 2650 may encompass internal records, such as HR files, financial statements, and operational metrics. This data is essential for decision-making and regulatory compliance. A corporation might use the data layer system of systems to integrate and analyze enterprise data, supporting strategic planning.

Public data 2652 may include datasets from government agencies, NGOs, and other public entities. This data can inform policy-making, research, and community initiatives. For example, a city planner might use the data layer system of systems to analyze public transportation data, improving service delivery.

Market data 2654 may capture financial metrics, stock prices, and commodity trends. This data is crucial for investment and trading strategies. A hedge fund might use the data layer system of systems to analyze market data, identifying opportunities and mitigating risks.

News data 2656 may include headlines, articles, and broadcasts. This data can inform sentiment analysis, trend detection, and crisis management. A public relations firm might use the data layer system of systems to monitor news coverage, shaping communication strategies.

Weather data 2658 may include forecasts, historical records, and real-time observations. This data supports agriculture, logistics, and disaster response. A logistics company might use the data layer system of systems to optimize routes based on weather conditions.

Contextual data 2660 may provide situational awareness by integrating multiple data sources. This data supports decision-making in dynamic environments. A retailer might use the data layer system of systems to combine sales data with demographic insights, tailoring marketing efforts.

Health data 2662 may include patient records, diagnostic results, and public health statistics. This data supports personalized medicine and population health management. A healthcare provider might use the data layer system of systems to analyze health data, improving care delivery.

Demographic data 2664 may capture information about populations, such as age, income, and education levels. This data informs marketing, policy-making, and resource allocation. A non-profit organization might use the data layer system of systems to target programs effectively.

Insurance data 2666 may include claims, risk assessments, and policy details. This data supports underwriting, fraud detection, and customer service. An insurance company might use the data layer system of systems to analyze claims data, reducing losses and improving customer satisfaction.

Simulation data 2668 may model hypothetical scenarios, such as financial projections or disaster response plans. For example, an organization planning for disasters from weather can continue its preparations by using simulation data processed through the data layer 2600. This data can allow the modeling of potential impacts and the development of optimized response strategies. A financial institution may also employ simulation data to project future market trends or assess the implications of new investment strategies. By integrating simulation outputs, the data layer system of systems can enable informed decision-making and facilitate the testing of complex hypotheses across diverse industries.

Experimental data 2670 may originate from controlled tests and research activities, capturing observations, measurements, and results. For instance, pharmaceutical companies may conduct clinical trials and generate experimental data related to drug efficacy. This data can then be processed and analyzed by the data layer 2600 to identify patterns and support regulatory submissions. Similarly, an automotive company might analyze experimental data from vehicle safety tests to enhance design standards. The flexibility of the data layer system allows for integration of experimental data into broader analytical frameworks, fostering innovation and development.

Synthetic data 2672 may refer to artificially generated datasets that mimic real-world data patterns. These datasets are often used in scenarios where privacy concerns limit the availability of real data, such as training machine learning models. For example, a financial institution may generate synthetic transaction data to test fraud detection algorithms. The data layer 2600 can synthesize, store, and validate such datasets, enabling organizations to derive insights while adhering to privacy regulations. This capability is particularly valuable for advancing AI and machine learning applications.

Echoed data 2674 may involve data derived from repetitions or feedback loops, often used to validate or enhance existing datasets. For instance, a recommendation system may use echoed data to refine its predictions by analyzing user responses to previous suggestions. The data layer 2600 can seamlessly manage echoed data streams, incorporating them into real-time analytics to improve service delivery and user experience.

Communication data 2676 may include emails, messages, and voice recordings, providing insights into interpersonal or organizational interactions. For example, businesses may analyze communication data to identify collaboration patterns and improve team productivity. The data layer 2600 can process such data while ensuring compliance with privacy and security standards. Applications in customer service, for instance, may benefit from sentiment analysis of customer interactions to enhance support experiences.

Behavioral data 2678 may capture individual or group actions and preferences, often derived from online activities, app usage, or consumer interactions. A retail company might analyze behavioral data to personalize marketing campaigns or optimize product recommendations. The data layer 2600 can integrate behavioral data with other sources, enabling organizations to uncover trends and enhance customer engagement strategies.

Location data 2680 may include GPS coordinates, geofencing insights, and spatial movement patterns. This data can support applications in transportation, urban planning, and retail. For instance, logistics companies may use location data to optimize delivery routes, while urban planners may analyze it to improve public infrastructure. The data layer 2600 provides a robust framework for processing and integrating location data to support geospatial analytics and decision-making.

Pricing data 2682 may encompass historical price points, market comparisons, and promotional effects.

Retailers may use this data to optimize pricing strategies, ensuring competitiveness and profitability. The data layer 2600 can process large volumes of pricing data, integrating it with demand and market data to enhance predictive pricing models.

Sales data 2684 may include transaction records, customer purchase histories, and revenue trends. Businesses can analyze sales data to identify growth opportunities and optimize inventory management. For instance, a retailer might use the data layer 2600 to track sales performance across regions and refine marketing campaigns accordingly.

Tax data 2686 may involve records of tax filings, liabilities, and regulatory compliance. Corporations can use this data to ensure accuracy in financial reporting and minimize audit risks. The data layer 2600 may facilitate the integration of tax data with financial and enterprise data, streamlining compliance processes.

Historical data 2688 may provide context by capturing trends and events from the past. This data is invaluable for forecasting, policy-making, and research. A financial institution might use historical market data to identify cycles and predict future trends. The data layer 2600 can enable efficient storage and retrieval of historical data, enhancing long-term analysis and strategic planning.

Physiological data 2690 may include metrics such as heart rate, blood pressure, and respiratory rate, often collected through medical devices or wearables. Healthcare providers may use this data for personalized treatment plans and remote monitoring. The data layer 2600 can process physiological data in real-time, supporting advanced health analytics and early detection of medical conditions.

Environmental data 2692 may encompass metrics related to air quality, temperature, and water levels, often used in sustainability and disaster response efforts. For example, environmental monitoring organizations might analyze this data to predict and mitigate climate impacts. The data layer 2600 can integrate environmental data with simulation and public datasets to support comprehensive environmental management strategies.

Key performance indicator KPI data 2694 may track metrics aligned with organizational objectives, such as customer satisfaction scores or operational efficiency rates. Businesses can use this data to evaluate performance and inform strategic initiatives. The data layer 2600 may enable real-time monitoring and analysis of KPIs, ensuring that organizations remain agile and focused on their goals.

### Resource Layer

Referring to FIG. 19 and FIG. 27, the AI convergence system of systems 1900 may comprise a resource layer system of systems (“resource layer”) 2900 having a set of resource modules 2902. In embodiments, the set of resource modules 2902 may include an advanced compute resources module 2904, a quantum computing resources module 2906, an edge computing resources module 2908, an intelligent agent resources module 2910, a model resources module 2912, an expert resources module 2914, an attention resources module 2916, a sensor resources module 2918, a robotic resources module 2920, a natural resources module 2922, a food resources module 2924, a geological resources module 2926, a physical storage resources module 2928, a physical security resources module 2930, a human resources module 2932, a machine resources module 2934, an advertising resources module 2936, a communication resources module 2938, a cloud-based resources module 2940, an enterprise resources module 2942, a facility resources module 2944, a heating resources module 2946, a cooling resources module 2948, an equipment resources module 2950, an information technology (IT) resources module 2952, a networking resources module 2954, and/or a material resources module 2956. In some embodiments, the resource modules 2902 of the resource layer 2900 may further include an energy resources module, a distributed energy resources module, and/or a renewable energy resources module. In some embodiments, the resource modules 2902 of the resource layer 2900 may further include a healthcare resources module. In implementations, the resource modules 2902 of the resource layer 2900 may include an industrial resources module. In embodiments, the resource modules 2902 may include a financial resources module and/or a transactional resources module. In some implementations, the resource modules 2902 may further include a transportation resources module, a physical delivery resources module, and/or a vehicular resources module. In some embodiments, the resource modules 2902 of the resource layer 2900 may further comprise a shipping container resources module, a shipping resources module, and/or an additive manufacturing resources module.

In embodiments, the resource layer 2900 enables the automated and optimized provisioning of resources used to support various systems and services of an enterprise and/or operational environment. For example, operational environments may include industrial environments, manufacturing environments, warehouse environments, shipping environments (e.g., container ports, shipping containers, shipyards, and the like), energy environments (e.g., fossil fuel energy environments such as oil rigs, pipelines, and refineries or nuclear energy environments such as nuclear power plants), retail environments, transportation environments (e.g., airports, train stations, bus stops, airplanes, train cars, and the like), research environments, transaction and banking environments, datacenter environments, compute environments, hospitality environments, gaming environments, and entertainment environments, among many others.

Each resource module of the resource layer 2900 may include one or more processors and one or more memories storing computer-executable instructions that, when executed by the one or more processors, cause the one or more processors to implement a set of machine learning systems, a set of artificial intelligence systems, and/or a set of neural networks configured to optimize the provisioning of the set of resources corresponding to that particular module. The machine learning systems may be trained using supervised, unsupervised, or reinforcement learning techniques on historical resource allocation data, usage patterns, performance metrics, and simulated data (e.g., data generated from a simulation engine, a foundation world model, a set of digital twins, or the like). The neural networks may comprise multiple layers including, but not limited to, convolutional layers, recurrent layers, and fully connected layers, wherein the layers are configured to process input data and generate output predictions for resource optimization. The artificial intelligence systems may implement various algorithms including decision trees, random forests, and gradient boosting machines to analyze resource utilization patterns and make real-time optimization decisions. The resource layer 2900 may further include a simulation engine or set of foundation world models operating in parallel with the machine learning systems, artificial intelligence systems, and/or neural networks, wherein the simulation engine and/or set of foundation world models are configured to generate real-time simulations of resource allocation scenarios, validate optimization decisions, and provide feedback to the machine learning models for continuous improvement and adaptation to changing conditions. In embodiments, the simulation engine may employ physics-based modeling, discrete event simulation, or agent-based modeling techniques to accurately represent the dynamics of resource utilization and system behavior. In some embodiments, each resource module of the resource layer 2900 may include one or more processors and one or more memories storing computer-executable instructions that, when executed by the one or more processors, cause the one or more processors to implement a set of machine learning systems, a set of artificial intelligence systems, and/or a set of neural networks configured to perform an intelligence task related to that particular resource module. Such intelligence tasks may include other types of optimizations, as well as predictive intelligence tasks, detection and/or identification intelligence tasks, decision support tasks, automation tasks, configuration and/or control intelligence tasks, and the like.

For example, the advanced compute resource module 2904 may implement a set of machine learning systems, a set of artificial intelligence systems, and/or a set of neural networks configured to optimize, by computing hardware, the provisioning of the set of advanced compute resources. In embodiments, advanced compute resources may include high-performance computing (HPC) systems, graphics processing units (GPUs), tensor processing units (TPUs), field-programmable gate arrays (FPGAs), AI accelerators, distributed computing systems, and the like.

In another example, the quantum computing resources module 2906 may implement a set of machine learning systems, a set of artificial intelligence systems, and/or a set of neural networks configured to optimize, by computing hardware, the provisioning of the set of quantum computing resources. In embodiments, quantum computing resources may include quantum processing units (QPUs), quantum annealers, gate-based quantum processors, quantum error correction systems, and the like.

In another example, the edge computing resources module 2908 may implement a set of machine learning systems, a set of artificial intelligence systems, and/or a set of neural networks configured to optimize, by computing hardware, the provisioning of the set of edge computing resources. In embodiments, edge computing resources may include Internet of Things (IoT) gateways, edge servers, edge AI accelerators, real-time analytics platforms, and the like.

In another example, the intelligent agent resources module 2910 may implement a set of machine learning systems, a set of artificial intelligence systems, and/or a set of neural networks configured to optimize, by computing hardware, the provisioning of the set of intelligent agent resources. In embodiments, intelligent agent resources may include autonomous agents, chatbot frameworks, multi-agent systems, decision-making algorithms, and the like.

In another example, the model resources module 2912 may implement a set of machine learning systems, a set of artificial intelligence systems, and/or a set of neural networks configured to optimize, by computing hardware, the provisioning of the set of model resources. In embodiments, model resources may include predictive models, prescriptive analytics models, simulation models, and the like.

In another example, the expert resources module 2914 may implement a set of machine learning systems, a set of artificial intelligence systems, and/or a set of neural networks configured to optimize, by computing hardware, the provisioning of the set of expert resources. In embodiments, expert resources may include rule-based systems, decision-support systems, expert knowledge bases, and the like.

In another example, the attention resources module 2916 may implement a set of machine learning systems, a set of artificial intelligence systems, and/or a set of neural networks configured to optimize, by computing hardware, the provisioning of the set of attention resources. In embodiments, attention resources may refer to the human, computational, and/or AI-driven focus allocated to specific tasks, processes, or decision-making. For example, AI models may be trained to focus on anomalies in sensor data or prioritize alerts in high-traffic environments. In embodiments, attention resources may be hybrid attention resources, such as a combination of human and AI focus, where AI filters or highlights critical information for human review.

In another example, the sensor resources module 2918 may implement a set of machine learning systems, a set of artificial intelligence systems, and/or a set of neural networks configured to optimize, by computing hardware, the provisioning of the set of sensor resources. In embodiments, sensor resources may include environmental sensors, motion sensors, imaging sensors, health sensors, and the like.

In another example, the robotic resources module 2920 may implement a set of machine learning systems, a set of artificial intelligence systems, and/or a set of neural networks configured to optimize, by computing hardware, the provisioning of the set of robotic resources. In embodiments, robotic resources may include industrial robots, collaborative robots (cobots), autonomous mobile robots (AMRs), material handling robots, pick-and-place robots, robotic arms, robotic dock workers, maintenance robots, hospitality robots, cleaning robots, pipeline inspection robots, baggage handling robots, security robots, cargo loading robots, and the like.

In another example, the natural resources module 2922 may implement a set of machine learning systems, a set of artificial intelligence systems, and/or a set of neural networks configured to optimize, by computing hardware, the provisioning of the set of natural resources. In embodiments, natural resources may include water resources, mineral resources, forest resources, and the like.

In another example, the food resources module 2924 may implement a set of machine learning systems, a set of artificial intelligence systems, and/or a set of neural networks configured to optimize, by computing hardware, the provisioning of the set of food resources. In embodiments, food resources may include agricultural produce, processed foods, perishable items, and the like.

In another example, the geological resources module 2926 may implement a set of machine learning systems, a set of artificial intelligence systems, and/or a set of neural networks configured to optimize, by computing hardware, the provisioning of the set of geological resources. In embodiments, geological resources may include minerals, fossil fuels, underground water reserves, and the like.

In another example, the physical storage resources module 2928 may implement a set of machine learning systems, a set of artificial intelligence systems, and/or a set of neural networks configured to optimize, by computing hardware, the provisioning of the set of physical storage resources. In embodiments, physical storage resources may include warehouses, cold storage facilities, data storage units, and the like.

In another example, the physical security resources module 2930 may implement a set of machine learning systems, a set of artificial intelligence systems, and/or a set of neural networks configured to optimize, by computing hardware, the provisioning of the set of physical security resources. In embodiments, physical security resources may include surveillance systems, access control systems, alarm systems, locking systems, and the like.

In another example, the human resources module 2932 may implement a set of machine learning systems, a set of artificial intelligence systems, and/or a set of neural networks configured to optimize, by computing hardware, the provisioning of the set of human resources.

In another example, the machine resources module 2934 may implement a set of machine learning systems, a set of artificial intelligence systems, and/or a set of neural networks configured to optimize, by computing hardware, the provisioning of the set of machine resources.

In another example, the advertising resources module 2936 may implement a set of machine learning systems, a set of artificial intelligence systems, and/or a set of neural networks configured to optimize, by computing hardware, the provisioning of the set of advertising resources. In embodiments, advertising resources may include digital ad placements, social media campaigns, targeted marketing systems, and the like.

In another example, the communication resources module 2938 may implement a set of machine learning systems, a set of artificial intelligence systems, and/or a set of neural networks configured to optimize, by computing hardware, the provisioning of the set of communication resources. In embodiments, communication resources may include email systems, messaging platforms, telecommunication networks, and the like.

In another example, the cloud-based resources module 2940 may implement a set of machine learning systems, a set of artificial intelligence systems, and/or a set of neural networks configured to optimize, by computing hardware, the provisioning of the set of cloud-based resources. In embodiments, cloud-based resources may include virtual machines, containerized services, distributed databases, and the like.

In another example, the enterprise resources module 2942 may implement a set of machine learning systems, a set of artificial intelligence systems, and/or a set of neural networks configured to optimize, by computing hardware, the provisioning of the set of enterprise resources. In embodiments, enterprise resources may include financial systems, operational workflows, customer relationship management (CRM) platforms, and the like.

In another example, the facility resources module 2944 may implement a set of machine learning systems, a set of artificial intelligence systems, and/or a set of neural networks configured to optimize, by facility management systems, the provisioning of the set of facility resources. In embodiments, facility resources may include factories, textile mills, assembly plants, manufacturing facilities, distribution centers, fulfillment centers, storage facilities, warehouse facilities, container ports and terminals, shipyards, freight forwarding facilities, oil rigs and offshore platforms, refineries, natural gas processing plants, pipeline pump stations, coal mining facilities, nuclear power plants, uranium enrichment facilities, retail facilities, airport facilities, bus terminal facilities, platforms and waiting areas, ticketing facilities, maintenance facilities, banking facilities, ATMs and kiosks, call center facilities, office facilities, datacenters, high-performance computing (HPC) facilities, cloud computing facilities, hospitality facilities, and entertainment facilities, among many others.

In another example, the heating resources module 2946 may implement a set of machine learning systems, a set of artificial intelligence systems, and/or a set of neural networks configured to optimize, by computing hardware, the provisioning of the set of heating resources. In embodiments, heating resources may include boilers, geothermal heating systems, district heating networks, and the like.

In another example, the cooling resources module 2948 may implement a set of machine learning systems, a set of artificial intelligence systems, and/or a set of neural networks configured to optimize, by computing hardware, the provisioning of the set of cooling resources. In embodiments, cooling resources may include HVAC systems, liquid cooling systems, evaporative cooling units, and the like.

In another example, the equipment resources module 2950 may implement a set of machine learning systems, a set of artificial intelligence systems, and/or a set of neural networks configured to optimize, by computing hardware, the provisioning of the set of equipment resources. In embodiments, equipment resources may include industrial tools, construction equipment, diagnostic machines, and the like.

In another example, the information technology (IT) resources module 2952 may implement a set of machine learning systems, a set of artificial intelligence systems, and/or a set of neural networks configured to optimize, by computing hardware, the provisioning of the set of IT resources. In embodiments, IT resources may include servers, data management systems, and the like.

In another example, the networking resources module 2954 may implement a set of machine learning systems, a set of artificial intelligence systems, and/or a set of neural networks configured to optimize, by computing hardware, the provisioning of the set of networking resources. In embodiments, networking resources may include switches, routers, hubs, bridges, network interface cards (NICs), access points (APs), modems, firewalls, network management software, virtual private networks (VPNs), network operating systems, software-defined networking (SDN) platforms, load balancers, wireless networking resources (e.g., Wi-Fi networks, cellular networks, and satellite networks), edge networking devices, IoT gateways, content delivery networks (CDNs), traffic analyzers, and many others.

In another example, the material resources module 2956 may implement a set of machine learning systems, a set of artificial intelligence systems, and/or a set of neural networks configured to optimize, by computing hardware, the provisioning of the set of material resources. In embodiments, material resources may include raw materials (e.g., metals and minerals), natural resources, processed materials, energy-related materials (e.g., fuels), construction materials, 3D printing materials, components and parts, agricultural products, biomaterials, recycled materials, and many others.

In another example, the energy resources module may implement a set of machine learning systems, a set of artificial intelligence systems, and/or a set of neural networks configured to optimize, by computing hardware, the provisioning of the set of energy resources. In embodiments, energy resources may include power grids, fossil fuel power plants, and the like.

In another example, the distributed energy resources module may implement a set of machine learning systems, a set of artificial intelligence systems, and/or a set of neural networks configured to optimize, by computing hardware, the provisioning of the set of distributed energy resources. In embodiments, distributed energy resources may include solar panels, wind turbines, battery storage systems, and the like.

In another example, the renewable energy resources module may implement a set of machine learning systems, a set of artificial intelligence systems, and/or a set of neural networks configured to optimize, by computing hardware, the provisioning of the set of renewable energy resources. In embodiments, renewable energy resources may include solar farms, wind farms, hydroelectric systems, and the like.

In another example, the health resources module may implement a set of machine learning systems, a set of artificial intelligence systems, and/or a set of neural networks configured to optimize, by computing hardware, the provisioning of the set of health resources. In embodiments, health resources may include diagnostic tools, patient records systems, telemedicine platforms, and the like.

In another example, the industrial resources module may implement a set of machine learning systems, a set of artificial intelligence systems, and/or a set of neural networks configured to optimize, by computing hardware, the provisioning of the set of industrial resources. In embodiments, industrial resources may include assembly lines, heavy machinery, manufacturing systems, and the like.

In another example, the financial resources module may implement a set of machine learning systems, a set of artificial intelligence systems, and/or a set of neural networks configured to optimize, by computing hardware, the provisioning of the set of financial resources. In embodiments, financial resources may include trading platforms, risk management tools, credit scoring systems, and the like.

In another example, the transactional resources module may include a set of machine learning systems, a set of artificial intelligence systems, and/or a set of neural networks configured to optimize, by computing hardware, the provisioning of the set of transactional resources. In embodiments, transactional resources may include payment gateways, point-of-sale systems, blockchain networks, and the like.

In another example, the transportation resources module may implement a set of machine learning systems, a set of artificial intelligence systems, and/or a set of neural networks configured to optimize, by computing hardware, the provisioning of the set of transportation resources. In embodiments, transportation resources may include trains, buses, logistics platforms, autonomous vehicles, and the like.

In another example, the physical delivery resources module may implement a set of machine learning systems, a set of artificial intelligence systems, and/or a set of neural networks configured to optimize, by computing hardware, the provisioning of the set of physical delivery resources. In embodiments, physical delivery resources may include delivery trucks, drones, parcel sorting systems, and the like.

In another example, the vehicular resources module may implement a set of machine learning systems, a set of artificial intelligence systems, and/or a set of neural networks configured to optimize, by computing hardware, the provisioning of the set of vehicular resources. In embodiments, vehicular resources may include electric vehicles, autonomous vehicles, taxis, forklifts, trucks, utility vehicles, material transport vehicles, automated guided vehicles (AGVs), refrigerated trucks, oil tanker trucks, emergency response vehicles, armored vehicles, and the like), ships, tugboats, smart containers, trains, buses, aircraft, unmanned aerial vehicles (UAVS), electric bikes, electric scooters, and the like.

In another example, the additive manufacturing resources module may implement a set of machine learning systems, a set of artificial intelligence systems, and/or a set of neural networks configured to optimize, by computing hardware, the provisioning of the set of additive manufacturing resources. In embodiments, additive manufacturing resources may include 3D printers, 3D printer subsystems, and the like.

At the resource layer 2900, AI capabilities for resource optimization enable a platform for providing multi-factor optimization of resources (“the multi-factor resource optimization platform”). Multi-factor resource optimization may refer to the process of achieving the best possible resource allocation outcome and/or solution that meets several objectives simultaneously. Multi-factor resource optimization objectives for operations of may include profitability, cost reduction, improved customer experience and satisfaction, employee satisfaction, sustainability, market expansion, innovation, operational efficiency, risk management, fraud prevention, safety, corporate social responsibility, and the like.

In some implementations, the resource layer 2900 may have AI capabilities for financial resource optimization associated with the use of AI workloads, including generative AI workloads in various applications. Generative AI workloads may refer to a set of tasks and/or processes that are handled or augmented by generative intelligence technologies. These workloads may comprise a range of activities where generative AI systems generate, enhance, or modify offerings and communications, content, experiences, and the like. Generative AI media workloads may also include personalization and/or localization workloads, such as when generative AI is used for tailoring content or experiences to individual or regional preferences, editing workloads, visual effects workloads, marketing generation workloads, or any other workloads described throughout this disclosure.

For example, generative AI may be utilized to generate maintenance instructions, reports, product designs, production plans, marketing materials, training materials, simulations, AR/VR experiences and the like; simulate process flows, vehicle routes, foot traffic, layouts, product demand scenarios, and the like; and many others. In embodiments, generative AI may be used to provide personalized and/or localized content, offers, promotions, experiences, and many others. In embodiments, financial costs for the use of generative AI workloads may include compute costs associated with generative AI, licensing costs associated with the use of generative AI (such as for the use of generative AI models trained on copyrighted data sets), and the like.

In embodiments, the compute costs may refer to the expenses associated with the computational resources needed to train and run AI models, including generative AI models. These costs may vary depending on model complexity, training data volume, training duration, hardware requirements (e.g., GPUs, TPUs, or the like), and cloud services/infrastructure, energy consumption, maintenance, scaling, software and/or development tools (e.g., such as software and development tools that facilitate generative AI model training and deployment), and the like.

In embodiments, the resource layer 2900 may have AI capabilities for computational resource optimization of generative AI workloads. In embodiments, the computational resources for generative AI media workloads may include hardware resources such as graphics processing units (GPUs), tensor processing units (TPUs), central processing units (CPUs), high-performance computing (HPC) clusters, and the like; software and frameworks such as machine learning frameworks, AI development platforms, data processing software, and the like; data storage solutions; networking infrastructure (e.g., high bandwidth networks); cloud computing platforms; and energy resources; among others.

In some implementations, the resource layer 2900 may have AI capabilities for computational resource optimization for workloads involving other types of computation, including, but not limited to HPC, quantum computing, distributed computing, gaming engines (e.g., the Unreal Engine), cloud computing, edge computing, other types of artificial intelligence models, neural networks, deep learning, and many others. In embodiments, these computational resources may be used in tandem with generative AI computational resources. For instance, generative AI models may be used with the Unreal Engine to generate casino gaming experiences and/or content.

Strategies for computational resource optimization (e.g., for advanced computation) at the resource layer 2900 may include the use of parallelization (e.g., data parallelization, model parallelization, pipeline parallelization, and hybrid parallelization), efficient algorithms (e.g., optimization algorithms, data sampling techniques, dimensionality reduction, quantization and pruning, sparse representations and the like), dynamic resource allocation based on computational load, optimization based on energy efficiency, load balancing, caching, and many others.

In embodiments, quality of service (QoS) optimization may converge with AI capabilities of resource layer 2900 to enable resource optimization for AI workloads. Performance optimization may ensure that the AI models meet speed and responsiveness requirements, which may involve model simplification, efficient algorithms, hardware acceleration (e.g., using GPUS and TPUs), load balancing, and resource allocation. To achieve scalability, techniques such as elastic scaling may be leveraged to dynamically adjust computational resources based on demand. Failover mechanisms, redundancy, and error handling may be used to ensure the reliability and availability of the AI models. Latency management may be utilized to minimize delays in AI processing to meet real-time requirements. Techniques such as computational resource scheduling, job queue management, caching, and the like may be used to optimize the use of AI and other computational resources. Monitoring and analytics tools, AI model management techniques, and load testing and simulation may also be used to optimize the use of computational resources for AI workloads.

In some implementations, blockchain risk management may converge with AI capabilities of resource layer 2900 to enable resource optimization for generative AI workloads. Blockchain can facilitate the use of decentralized computational resources and decentralized computational resource marketplaces. Further, smart contracts can be used to automatically manage the allocation of computational resources based on predefined requirements and/or real-time needs. Computational resource usage and computational resource-related transactions may be recorded on a blockchain, providing a record of how resources are being used.

At the resource layer 2900, AI capabilities for resource optimization may utilize AI-driven predictive analytics, machine learning algorithms, AI-driven optimization algorithms, AI-driven digital twins that use simulations to test different scenarios or strategies, AI-driven autonomy, and any of the AI capabilities discussed throughout this disclosure.

In embodiments, the resource layer 2900 may manage and optimize a common set of resources that are used across different sets of enterprise and/or operational applications and/or use cases. This may include dynamic resource allocation and optimization strategies applicable to complex and varied environments such as industrial settings (e.g., manufacturing plants and warehouses), transportation infrastructures (e.g., airports and shipping ports), energy facilities (e.g., oil rigs and nuclear power plants), retail operations, datacenters, hospitality venues, and the like. By implementing a flexible resource management approach, the resource layer 2900 can dynamically adjust computational, logistical, and operational resources to meet the specific demands of these diverse environments.

The core functionality of the resource layer 2900 involves intelligent resource provisioning, which enables adaptability across different operational contexts. For instance, in a manufacturing environment, it might optimize machine utilization and energy consumption, while in a shipping context, it could manage container tracking, logistics routing, and real-time inventory management. Similarly, in datacenter and compute environments, the resource layer 2900 would focus on workload distribution, server resource allocation, and energy efficiency.

### AI Subsystem Integrator System

Referring now to FIG. 28, an AI subsystem integrator system 3000 is illustrated in accordance with embodiments described herein. Artificial intelligence (AI) and machine learning (ML) systems disclosed herein may be used to facilitate the automation of data integration, networking integration and other technology integration by system 3000. For example, the AI subsystem integrator system 3000 may train an integrator 3002 that includes at least one AI/ML system trained according to training workflows 3004 and training inputs 3006 to integrate a plurality of platforms and their respective subsystems A-n. For example, the training workflows 3004 and training inputs 3006 may utilize various methods and inputs disclosed herein and in the documents incorporated by reference (e.g., based on technical data sets, existing models, human supervision, deep learning on outcomes and/or robotic process automation learning on human execution of tasks, among others), across both the internal subsystems A-n within each of the platforms and across the different platforms and their subsystems. In the example provided, integrator 3002 includes a data integrator 3008, a network integrator 3010, an attribution integrator 3012, and other integrators 3014. For example, a set of AI systems may be trained to generate an intra-platform integration system 3016 that integrates various subsystems A-n within each of the platforms. Similarly, a set of AI systems may be trained with reference to the intra-platform integration system 3016 to generate a trans-platform integration system 3018 that facilitates interaction between the platforms. For example, integrator 3002 may learn the interfaces of a subsystem of a first platform and a subsystem of a second platform and to generate a data and network connection among them, as well as an interface by which a user, or an AI agent, may manage the data and network connection. Thus, disclosed herein is an artificial intelligence system that is configured and trained to generate a set of configurable integration capabilities across the internal subsystems and services of a set of platforms. Such an artificial intelligence system may be referred to herein as the “AI subsystem integrator system” and may integrate data and/or network communication, data storage (local and/or network), management interfaces, energy resources, and other capabilities. It may be noted that at scale an AI subsystem integrator system may generate a fully integrated or converged system that has massively parallel connectivity across the internal subsystems of the respective platforms, translating them from isolated platforms into a converged platform. This may evolve from various pairwise converged platforms among the various members of the platforms into a fully converged platform that encompasses subsystem elements of all of them.

In each case, a cross-service resource optimization system, which may comprise or employ a set of AI agents trained in ways noted above, may be used to manage, configure, deploy, provision, and/or optimize the respective subsystems or services that operate within a linked, integrated or converged system (the respective subsystems and/or services having previously been isolated to their respective standalone platform(s)).

For example, across any two or more subsystems or services across platforms may be optimized by measuring and allocating the energy that is used across the platforms, such as use of battery storage by devices, use of energy by GPUs in cloud computing or data centers (such as for generative AI workloads), and the like. Thus, in embodiments, methods and systems are provided for measuring and/or optimizing energy resources across the subsystems and services of at least two platforms.

As another example, across any two or more subsystems or services across platforms may be optimized by measuring and allocating the data storage resources that are used across the platforms, such as use of storage by devices, by cloud computing or data centers (such as for generative AI workloads), and in particular by network resources, such as use of network storage for caching content to reduce latency and improve efficiency of use of network connectivity resources. Thus, in embodiments, methods and systems are provided for measuring and/or optimizing data storage resources across the subsystems and services of at least two platforms.

As another example, across any two or more subsystems or services across platforms may be optimized by measuring and allocating the networking resources that are used across the platforms, such as use of bandwidth of network resources by devices, by cloud computing or data centers, and the like to reduce latency and improve efficiency of use of the network or connectivity resources. Thus, in embodiments, methods and systems are provided for measuring and/or optimizing network resources across the subsystems and services of at least two platforms.

As another example, across any two or more subsystems or services across platforms may be optimized by measuring and allocating the computation storage resources that are used across the platforms, such as use of computation resources by devices, by cloud computing or data centers (such as for generative AI workloads), and the like. Thus, in embodiments, methods and systems are provided for measuring and/or optimizing computation resources across the subsystems and services of at least two platforms.

In embodiments, higher level management systems may collectively optimize across multiple factors, such as energy, computation and network resources, including use of artificial intelligence systems (alone or in combination with analytic models) that are trained as noted herein to achieve multifactor optimization across resource types.

### Multiplatform Attention Management System

Referring now to FIG. 29, a higher-level multiplatform attention management system 3020 may be used to track and optimize attention across platforms (e.g., across integrated subsystems 3022, 3024, and 3026), such as by understanding where overall attention by customers (or by intelligent agents that operate on their behalf) may be increased by encouraging transitions across platforms, rather than maximizing only within a platform. This may include a multiplatform experience orchestration system 3028 for orchestrating experiences that are intentionally designed to encourage a user to move from platform to. The multiplatform attention management system 3020 may be used to monitor attention and provide input to a multiplatform attention orchestration system 3030 in order to improve the overall attention by users across the respective platforms. This may include any two platforms, or a converged platform among two or more platforms, or an overall converged platform in which the respective subsystems or services are fully integrated (including by AI as noted above).

In embodiments, a higher-level multiplatform revenue management system may be used to track and optimize revenue across platforms, such as by understanding where overall revenue by customers (or by intelligent agents that operate on their behalf) may be increased by encouraging transitions across platforms, rather than maximizing only within a platform. This may include the multiplatform experience orchestration system for orchestrating experiences (such as VR, entertainment, and other experiences) that are intentionally designed to encourage a user to move from platform to platform. The revenue management system may be used to monitor attention and other factors that drive short-term revenue and long-term customer value and provide input to the orchestration system in order to improve the overall revenue from users across the respective platforms. This may include any two platforms, or a converged platform among two or more platforms, or an overall converged platform in which the respective subsystems or services are fully integrated (including by AI as noted above).

### Hardware, Software, and Special-Purpose Systems

Special-purpose systems include hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

In this application, including the claims, the term module refers to a special-purpose system. The module may be implemented by one or more special-purpose systems. The one or more special-purpose systems may also implement some or all of the other modules. In this application, including the claims, the term module may be replaced with the terms “controller” or “circuit.” In this application, including the claims, the term platform refers to one or more modules that offer a set of functions. In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment. For example, the special-purpose system may be partially or fully hosted by a third party offering software as a service (SaaS), platform as a service (PaaS), and/or infrastructure as a service (IaaS). The special-purpose system may be implemented using agile development and operations (DevOps) principles. In example embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc. A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system. Examples of servers include a file server, print server, domain server, internet server, intranet server, cloud server, infrastructure-as-a-service server, platform-as-a-service server, web server, secondary server, host server, distributed server, failover server, and backup server.

The term hardware encompasses components such as processing hardware, storage hardware, networking hardware, and other general-purpose and special-purpose components. Note that these are not mutually-exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In example embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption, or other type of processor. Examples of co-processors include a math co-processor, a graphics co-processor, a communication co-processor, a video co-processor, and an artificial intelligence (AI) co-processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code.

The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like. The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

A processor may include one or more cores that may enhance speed and performance of a multiprocessor. In example embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application. A processor may be implemented as a packaged semiconductor die. The die includes one or more processing cores and may include additional functional blocks, such as cache. In various embodiments, the processor may be implemented by multiple dies, which may be combined in a single package or packaged separately.

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network. Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN include IEEE Standard 802.15.4, including the ZIGBEE standard from the ZigBee Alliance. Further examples of a WPAN include the BLUETOOTH™ wireless networking standard, including Core Specification versions 3.0, 4.0, 4.1, 4.2, 5.0, and 5.1 from the Bluetooth Special Interest Group (SIG). A WAN may also be referred to as a distributed communications system (DC S). One example of a WAN is the internet.

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

Examples of storage implemented by the storage hardware include a database (such as a relational database or a NoSQL database), a data store, a data lake, a column store, and a data warehouse. Examples of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware. Storage hardware may have read-only, write-once, or read/write properties. Storage hardware may be random access or sequential access. Storage hardware may be location-addressable, file-addressable, and/or content-addressable.

Examples of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM). Examples of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM). Examples of magnetic storage media include analog magnetic tape, digital magnetic tape, and rotating hard disk drive (HDDs). Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether. Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities. In example embodiments, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

The elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

Software also includes data. However, data and instructions are not mutually-exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

### Further Information and Use of Terms

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law. While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

Each publication referenced in this disclosure, including foreign and domestic patent applications and patents, is hereby incorporated by reference in its entirety as if fully set forth herein.

The terms “comprising,” “with,” “including,” and “containing” are to be construed as open-ended terms (i.e., meaning “including, but not limited to”) unless otherwise noted. Unless otherwise specified, the terms “comprising,” “having,” “with,” “including,” and “containing,” and their variants, are open-ended terms, meaning “including, but not limited to.”

The term “exemplary” simply means “example” and does not indicate a best or preferred example. The use of any and all examples, or exemplary language (e.g., “such as”) provided herein, is intended merely to better illuminate the disclosure and does not pose a limitation on the scope of the disclosure unless otherwise claimed.

The use of the terms “a,” “an,” “the,” and similar referents in the context of describing the disclosure (especially in the context of the following claims) is to be construed to cover both the singular and the plural, unless otherwise indicated herein or clearly contradicted by context.

Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The phrase “at least one of A, B, and C” should be construed to mean a logical (A OR B OR C), using a non-exclusive logical OR, and should not be construed to mean “at least one of A, at least one of B, and at least one of C.”

The term “set” may include a set with a single member. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.”

Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure.

One or more elements (for example, steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited.

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

In the drawings, reference numbers may be reused to identify identical elements or may simply identify elements that implement similar functionality. Numbering or other labeling of instructions or method steps is done for convenient reference, not to indicate a fixed order. In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As one example, for information sent from element A to element B, element B may send requests and/or acknowledgements to element A.

1-50. (canceled)

51. A system comprising:
memory hardware configured to store instructions; and
processor hardware configured to execute the instructions from the memory hardware, wherein the instructions include:
executing a transaction orchestration agent configured to orchestrate a set of tasks of a transaction workflow on behalf of an enterprise having a plurality of digital wallets, wherein each digital wallet executes transactions on behalf of the enterprise using a respective transaction channel;
determining, by the transaction orchestration agent, a transaction orchestration workflow corresponding to a transaction to be executed on behalf of the enterprise;
interfacing, by the transaction orchestration agent, with the plurality of digital wallets of the enterprise through respective application programming interfaces (APIs) of the one or more respective wallets;
receiving, via the respective APIs, a plurality of respective API responses comprising respective account data;
selecting, by the transaction orchestration agent, an enterprise digital wallet from the plurality of digital wallets based on the respective plurality of API responses received from the respective APIs of the one or more digital wallets of the enterprise;
generating, by the transaction orchestration agent, a configured transaction for the selected enterprise digital wallet, wherein the configured transaction comprises transaction information determined by the transaction orchestration agent; and
instructing the selected enterprise digital wallet to execute the configured transaction via the respective API for the selected enterprise digital wallet.

52. The system of claim 51, wherein interfacing with a respective digital wallet includes:
providing account credentials of the enterprise via the respective API of the digital wallet; and
wherein the determined transaction information including destination account, payment source, transaction amount, and payment date to the digital wallet.

53. The system of claim 51, wherein interfacing with a respective digital wallet includes:
initiating a new API session with a third-party wallet application; and
issuing commands to the third-party wallet application on behalf of the enterprise.

54. The system of claim 51, wherein the transaction orchestration agent interfaces with one or more of payment service providers, banks, and blockchain networks.

55. The system of claim 51, wherein the transaction orchestration agent:
maintains secure integration with financial institutions and marketplaces;
implements security protocols through AI-driven authentication systems; and
automatically detects and responds to potential disruptions.

56. The system of claim 51, wherein interfacing with a respective digital wallet includes:
interfacing with a blockchain digital wallet that controls a blockchain account of the enterprise on a blockchain network, wherein the blockchain digital wallet is configured to communicate with and execute blockchain transactions on a blockchain network;
retrieving a private key associated with enterprise blockchain accounts; and
digitally signing a blockchain transaction using the private keys.

57. The system of claim 51, wherein interfacing with a respective digital wallet includes:
interfacing with a hybrid wallet configured to perform both blockchain transactions and fiat currency transactions.

58. The system of claim 51, wherein the transaction orchestration agent:
controls the selected digital wallet in a wallet-of-wallets configuration;
provides a unified interface to enterprise users; and
includes additional layers managing permissions, account selection, wallet selection, and transaction execution.

59. The system of claim 51, wherein interfacing with a respective digital wallet includes:
securely interfacing with virtual infrastructure of a respective financial institution using a respective API of the respective financial institution and account credentials of the enterprise to transfer funds.

60. The system of claim 51, wherein interfacing with a respective digital wallet includes:
interfacing with a digital marketplace using a respective API of the digital marketplace, wherein the respective digital wallet facilitates transactions on the digital marketplace using a digital marketplace account of the enterprise.

61. A method comprising:
executing, by one or more processors, a transaction orchestration agent configured to orchestrate tasks of a transaction workflow on behalf of an enterprise;
establishing, by the transaction orchestration agent, API connections with multiple digital wallet systems;
receiving, by the transaction orchestration agent, real-time wallet data through the API connections, wherein the real-time wallet data comprises account balances and transaction capabilities;
determining, by the transaction orchestration agent, a set of transaction parameters for executing a transaction;
selecting, by the transaction orchestration agent, an enterprise digital wallet from the multiple digital wallet systems based on the real-time wallet data and the set of transaction parameters;
configuring, by the transaction orchestration agent, the transaction for the selected enterprise digital wallet; and
executing, by the transaction orchestration agent, the configured transaction by communicating instructions to the selected enterprise digital wallet through the API connections.

62. The method of claim 61, further comprising:
maintaining respective balances of enterprise cash reserves across the multiple digital wallet systems;
querying digital wallets and bank portals using their APIs to determine total cash positions; and
maintaining an internal ledger of all cash transactions.

63. The method of claim 61, wherein establishing API connections includes:
implementing standardized reconciliation protocols;
supporting various data formats for automated reconciliation processes; and
comparing transaction records across internal and external systems.

64. The method of claim 61, further comprising:
interfacing with blockchain systems to verify cryptocurrency transactions;
interfacing with smart contract systems to verify smart contract executions; and
ensuring comprehensive reconciliation across traditional and digital asset transactions.

65. The method of claim 61, further comprising:
implementing automated governance through embedded policy and governance AI capabilities;
ensuring continuous compliance monitoring; and
generating automated compliance reports.

66. The method of claim 61, wherein executing the configured transaction includes:
communicating with payment service providers to process payments;
coordinating with acquirers to settle transactions; and
interfacing with banks to transfer funds.

67. The method of claim 61, further comprising:
maintaining secure integration with financial institutions;
implementing AI-driven authentication systems; and
automatically detecting and responding to potential security disruptions.

68. The method of claim 61, wherein establishing API connections includes:
implementing a common point of access for multiple markets, marketplaces, exchanges, and platforms.

69. The method of claim 61, further comprising:
tokenizing digital assets to digitally represent transactions within an enterprise ecosystem; and
employing blockchain technology to manage and secure the transactions.

70. The method of claim 61, wherein configuring the transaction includes:
automatically determining transaction routing;
optimizing transaction fees; and
managing transaction timing across multiple networks and marketplaces.
